(19) United States
(12) Patent Application Publication
(10) Pub. No.: US 2026/0269404 A1
(43) Pub. Date: Sep. 10, 2026

(54) BATTERY PACKS, BATTERY PACK CHARGERS, BATTERY PACK INTERFACES AND ADAPTORS OF A CORDLESS POWER TOOL SYSTEM

(71) Applicant: Black & Decker Inc., New Britain, CT (US)

(72) Inventors: Franklin Regan, Columbia, MD (US); Mark T. Cherry, White Marsh, MD (US); Kelsey L. Barkley, Pikesville, MD (US); David J. Thiess, Fallston, MD (US); Michael L. England, Towson, MD (US)

(21) Appl. No.: 19/539,669

(22) Filed: Feb. 13, 2026

Related U.S. Application Data
(63) Continuation of application No. PCT/US2024/042983, filed on Aug. 19, 2024.
(60) Provisional application No. 63/520,315, filed on Aug. 17, 2023.
(60) Provisional application No. 63/584,755, filed on Sep. 22, 2023.
(60) Provisional application No. 63/520,316, filed on Oct. 24, 2023.
(60) Provisional application No. 63/520,317, filed on Oct. 24, 2023.
(60) Provisional application No. 63/622,460, filed on Jan. 18, 2024.

(51) Int. Cl. H01M 50/244; H01M 50/24; H01M 50/247; H01M 50/267

(52) U.S. Cl. CPC H01M 50/244; H01M 50/24; H01M 50/247; H01M 50/267; H01M 2220/30

(57) ABSTRACT

A cordless power tool system may include many and various components including a variety of power tools, a variety of battery packs, a variety of battery pack chargers, a variety of interfaces and a variety of adaptors. The various components are designed and configured to operate with each other to present an ergonomic, efficient and powerful system. The battery pack has been designed and configured to be compact and capable of discharging a vast majority of stored energy present in the battery pack when the battery pack as been fully charged. The battery pack charger has been designed and configured to be ergonomic to assist in the charging and transportation of the charger and/or a combination of the battery pack and the charger.

### CROSS-REFERENCE TO RELATED APPLICATION(S)

This application is a continuation of Patent Cooperation Treaty Application No. PCT/US 2024/042983, filed on Aug. 19, 2024, entitled “Battery Packs, Battery Pack Chargers, Battery Pack Interfaces and Adaptors of a Cordless Power Tool System”, and claims the benefit of priority thereof under 35 U.S.C. § 120, and which claims the benefit of priority to each of: U.S. Provisional Patent Application Ser. No. 63/520,315, filed Aug. 17, 2023, titled “Battery Pack”; U.S. Provisional Patent Application Ser. No. 63/520,316 filed Aug. 17, 2023, titled “Battery Pack Charger”; U.S. Provisional Patent Application Ser. No. 63/520,317 filed Aug. 17, 2023, titled “Battery Pack Adaptor”; U.S. Provisional Patent Application Ser. No. 63/584,755 filed Sep. 22, 2023, titled “Battery Pack Interface”; and U.S. Provisional Patent Application Ser. No. 63/622,460, filed Jan. 18, 2024, titled “Battery Packs, Battery Pack Chargers, Battery Pack Interfaces and Adaptors of a Cordless Power Tool System”.

### INCORPORATION BY REFERENCE

Patent Cooperation Treaty Application No. PCT/US 2024/042983, filed on Aug. 19, 2024, entitled “Battery Packs, Battery Pack Chargers, Battery Pack Interfaces and Adaptors of a Cordless Power Tool System”, is incorporated herein in its entirety by reference.

U.S. Provisional Patent Application Ser. No. 63/520,315, filed Aug. 17, 2023, titled “Battery Pack”, is incorporated herein in its entirety by reference.

U.S. Provisional Patent Application Ser. No. 63/520,316, filed Aug. 17, 2023, titled “Battery Pack Charger”, is incorporated herein in its entirety by reference.

U.S. Provisional Patent Application Ser. No. 63/520,317, filed Aug. 17, 2023, titled “Battery Pack Adaptor”, is incorporated herein in its entirety by reference.

U.S. Provisional Patent Application Ser. No. 63/584,755 filed Sep. 22, 2023, titled “Battery Pack Interface”, is incorporated herein in its entirety by reference.

U.S. Provisional Patent Application Ser. No. 63/622,460, filed Jan. 18, 2024, titled “Battery Packs, Battery Pack Chargers, Battery Pack Interfaces and Adaptors of a Cordless Power Tool System”, is incorporated herein in its entirety by reference.

This application is related to U.S. patent application Ser. No. 18/114,121, filed on Feb. 24, 2023, titled “Cordless Power Tool System”, which in turn claims the benefit of priority from U.S. Provisional Patent Application Ser. No. 63/268,451, filed on Feb. 24, 2022, titled “Cordless Power Tool System”, the contents all of which are incorporated herein in their entireties by reference.

This application also is related to Patent Cooperation Treaty Application No. PCT/US 2024/042984, filed on Aug. 19, 2024, titled “Battery Pack”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/US 2024/042979, filed on Aug. 19, 2024, entitled “Battery Pack Charger”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/US 2024/042976, filed on Aug. 19, 2024, titled “Battery Pack-Power Tool Interface”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/US 2024/042973, filed on Aug. 19, 2024, titled “Battery Pack Adaptor”, which in turn claims the benefit of priority from U.S. Provisional Patent Application Ser. No. 63/622,460, filed Jan. 18, 2024, the contents all of which are incorporated herein in their entireties by reference.

This application also is related to Patent Cooperation Treaty Application No. PCT/ US 2024/042820, filed on Aug. 16, 2024, titled “Cordless Power Tool System”, which in turn claims the benefit of priority from U.S. Provisional Patent Application Ser. No. 63/622,475, filed Jan. 18, 2024, the contents all of which are incorporated herein in their entireties by reference.

### FIELD

The patent application relates to battery packs, battery pack chargers, battery pack adaptors, and battery pack interfaces of a cordless power tool system and a method for manufacturing a battery pack, a battery pack charger, a battery pack adaptor, and a battery pack interface of a cordless power tool system.

### BACKGROUND

Removable, rechargeable battery packs are becoming ubiquitous as more and more devices become cordless to take advantage of the advances in battery technology. Such battery packs are commonly part of cordless power tool systems and are designed and configured to operate with a variety of cordless power tools.

Conventional rechargeable battery packs may include Li-Ion battery cells. Due to the nature of the chemistry of these battery packs, the United States and many other countries and international bodies, including the United Nations, have implemented special rules directed to the shipping of Li-Ion batteries. If a battery or battery pack exceeds these rules/limits, there are additional fees and shipping costs for shipping the battery pack. As such, there is an interest in keeping the Watt-hour levels below the 100 Wh limits. Today, it is common for Li-Ion batteries to exceed these limits. As battery power and capacity increases it will become more common for batteries to exceed these limits. As such, there is a great desire to keep address this issue.

Typically, shipping regulations impose limitations upon how much energy is disposed in a battery pack. For example, some regulations require that each cell have an energy equal to or less than 20 Watt-hours, and that each battery pack has an energy limit equal to or less than 100 Watt-hours. It is preferable to provide a solution that can maximize the energy available to the end user while complying with shipping regulations. Preferably, a switching system could be used to separate components of the battery pack, thus opening the battery pack circuit, limiting the energy output.

While, for ground service (highway and rail), United States Department of Transportation (USDOT) regulations allow for certain packaging and shipment exceptions for batteries below 300 watt-hours, USDOT regulations for batteries above 300 watt-hours require special packaging (e.g., “Class 9” packaging) around the battery packs for shipment to be permissible.

The present patent application describes an example battery pack for use with a power tool system utilizing pouch battery cells and an example method of manufacturing such a battery pack.

Typically, rechargeable battery packs are charged using battery pack chargers that are designed and configured to charge specific battery packs. These chargers are designed and configured to plug into a wall outlet for access to alternating current (AC) mains line (utility) power or some other source of AC power, such as a generator. The battery packs, the power tools, and the chargers generally include an interface system that enables the battery pack to couple to the power tool and the charger, as is well known in the art. Various interfaces are known for electrically and physically coupling the battery pack with an electrical apparatus such as a power tool or a battery pack charge.

While prior art power tool systems including a set of cordless power tools, a set of releasably attachable battery packs and a set of battery pack chargers all designed and configured to operate with each other by an original equipment manufacturer have proven to be more than suitable for their intended purposes, each battery pack in the set of battery packs is limited for use with an associated tool of the set of cordless power tools and an associated charger of the set of battery pack chargers. Thus, it remains desirable in the art to provide an adaptor for a first battery pack having a first configuration specifically designed and configured to operate with a first type of power tool system that enables use of the first battery pack as a substitute for a second battery pack having a second configuration specifically designed and configured to operate with a second type of power tool system. Further, the cordless power tools and the battery packs may be used in heavy contamination environments. This type of environment may expose the cordless power tools and the battery packs to water and particulate ingress that may reduce the performance and warranty life expectancy. The present patent application provides improvements in the battery pack adaptors.

### SUMMARY

One aspect of the present patent application provides a battery pack. The battery pack comprises a housing and an electronics subassembly. The battery pack housing forms a cavity. The electronics subassembly may include a terminal block and a set of battery pack terminals fixedly held in place. The set of battery pack terminals may be configured to mate with a corresponding set of terminals of an electrical device. The electrical device terminals may be received in a mating direction. A first terminal of the set of battery pack terminals may include a first portion for contacting a first electrical device contact and a second portion for contacting the first electrical device contact. The first portion and the second portion may be nested together.

In another aspect of the present patent application a battery pack is provided. The battery pack comprises a housing and a cell holder subassembly. The cell holder subassembly includes a set of battery cell modules.

Another aspect of the present patent application provides a battery pack. The battery pack includes a housing forming an internal cavity and a shipping subassembly. The shipping subassembly includes a handle having a recess forming a cavity. The cavity includes an opening to the internal cavity and an actuation component received in the handle cavity.

Another aspect of the present patent application provides a battery pack latching system for latching a battery pack to a device upon mating the battery pack to the device along a mating direction. The battery pack latching system comprises a first component with a first end for user engagement and a second end for rotation about a first rotation axis, and a second component with a first end for engagement with a portion of the device and a second end for rotation about a second rotation axis. The second rotation axis is generally parallel to the first rotation axis. The first component includes at least one shoulder between the first end and the second end and the second component includes at least one shoulder between the first end and the second end. The first component shoulder positioned to engage the second component shoulder upon rotation of the first component about the first rotation axis forcing the second component to rotate about the second rotation axis.

Another aspect of the present patent application provides a cordless power tool system. The cordless power tool system comprises a first power tool having a first power tool rated voltage and a first power tool interface; a second power tool having a second power tool rated voltage and a second power tool interface that is different from the first power tool interface; a third power tool having a third power tool rated voltage and a third power tool interface that is different from the first power tool interface and from the second power tool interface; a first battery pack having a first battery pack nominal voltage that is substantially the same as the first power tool rated voltage and the second power tool rated voltage and a first battery pack interface that is connectable to the first power tool interface to provide power to the first power tool, but that is not connectable to the second power tool interface or the third power tool interface; a second battery pack having a second battery pack interface that is connectable to the second power tool interface of the second power tool and to the third power tool interface of the third power tool but that is not connectable to the first power tool interface. The second battery pack may have a second battery pack nominal voltage that is substantially the same as the second power tool rated voltage when connected to the second power tool, and may have a third battery pack nominal voltage that is substantially the same as the third power tool rated voltage when connected to the third power tool. The second battery pack is configured to be coupled to the first power tool to provide power to the first power tool.

Implementations of the foregoing aspects may include one or more of the following features.

In an aspect of the present patent application, the cordless power tool system may further comprise an adaptor having a first adaptor interface configured to be connected to the first power tool interface of the first power tool and a second adaptor interface configured to be connected to the second battery pack interface of the second battery pack to connect the second battery pack to the first power tool.

In an aspect of the present patent application, the second battery pack interface of the second battery pack may not be able to be coupled to the first power tool interface of the first power tool without the adaptor.

In an aspect of the present patent application, the first power tool rated voltage and the second power tool rated voltage may be the same.

In an aspect of the present patent application, wherein the first battery pack nominal voltage and the second battery pack nominal voltage may be the same.

In an aspect of the present patent application, the cordless power tool system may further comprise a third battery pack having the third battery pack nominal voltage and having a third battery pack interface that is connectable to the third power tool interface of the third power tool but may not be connectable to the first power tool interface of the first power tool or the second power tool interface of the second power tool.

In an aspect of the present patent application, the first power tool may comprise at least one of a concrete drill, a concrete saw, a concrete vibrator, a plate compactor, a rammer, or a screed.

In an aspect of the present patent application, the second power tool may comprise at least one of a circular saw, a drill, a grinder, a miter saw, a reciprocating saw, a rotary hammer, or a table saw.

In an aspect of the present patent application, the third power tool may comprise at least one of a band saws, a chop saw, a circular saw, a cutout tool, a compressor, a drill, a hammer drill, a fan, a grinder, a hammer, a dust extractor, an impact driver, an impact wrench, an inflator, a jigsaw, a joiner, a light, a magnetic drill press, a nailer, an oscillating tool, a planer, a polisher, a ratchet, a reciprocating saw, a rotary hammer, a router, a sander, a screwdriver, a screwgun, a vacuum, a blower, a chain saw, an edger, a hedge trimmer, a pressure washer, a mower, a snow thrower, a string trimmer, a tiller, or an auger.

One aspect of the present patent application provides a battery pack charger. The battery pack charger comprises a housing. The housing includes a first side and a second side, opposed to the first side. The first side includes a first interface configured to receive a battery pack along a first axis. The second side includes a second interface configured to mount to a storage container. The second interface includes a coupling plate for coupling the housing to the storage container. The coupling plate is configured to be attachable to the second side of the housing in a first orientation. In a second orientation, the coupling plate second orientation is rotated 180° about a second axis generally perpendicular to the first axis from the coupling plate first orientation.

Another aspect of the present patent application provides a battery pack charger system. The battery pack charger system comprises a battery pack charger, and a storage system comprising a plurality of storage containers and an attachment system. The attachment system includes a first set of components incorporated into a first storage container of the plurality of storage containers and a second set of components incorporated into a second storage container of the plurality of storage containers. The first set of components of the first storage container is configured to mate with the second set of components of the second storage container to affix the first storage container to the second storage container. The battery pack charger system comprises a coupling plate including a third set of components configured to mate with (a) a first subset of the first set of components of the first storage container for affixing the charger to the first storage container at a first location and (b) a second subset of the first set of components of the first storage container for affixing the charger to the first storage container at a second location. The second location is adjacent to the first location.

Another aspect of the present patent application provides a battery pack charger comprising a housing and a roll cage affixed to the housing. The roll cage includes at least one handle to enable carrying the battery pack charger with a battery pack insertion direction being vertical and at least one handle to enable carrying the battery pack charger with the battery pack insertion direction being horizontal.

Another aspect of the present patent application provides a battery pack charger comprises a housing and a roll cage affixed to the housing. The roll cage provides stable support for a first orientation in which the battery pack insertion direction is generally horizontal. The roll cage provides stable support for a second orientation in which the battery pack insertion direction is generally vertical.

Another aspect of the present patent application provides a battery pack charger comprising a housing, a set of inlet vents on the first side of the housing, a set of outlet vents on the second side of the housing, a first baffle within the housing defining a first airflow pathway, and a second baffle within the housing defining a second airflow pathway. The housing includes a first side and a second side opposed the first side. The first baffle and the second baffle define a third airflow pathway. The battery pack charger comprises a plurality of power supply charging components centrally positioned within the housing along the third airflow pathway, and a fan within the housing. The fan draws air into the housing through the set of inlet vents along the first airflow pathway, along the third airflow pathway past the plurality of power supply charging components, through the fan, along the second airflow pathway and forcing the air out of the housing through the set of outlet vents.

One aspect of the present patent application provides an interface system for enabling mating and operation between a set of cordless power tools and a battery pack. The interface system comprises a housing. The housing includes an interface for mating with the battery pack. The interface may include a set of rails, a set of grooves, a terminal block including a set of terminals, and a catch. The housing includes a first attachment feature configured to attach the housing to a first cordless power tool of the set of cordless power tools in a first orientation and a second attachment feature configured to attach the housing to a second cordless power tool of the set of cordless power tools in a second orientation.

Another aspect of the present patent application provides an interface system for enabling mating and operation between a set of cordless power tools and a battery pack. The interface system comprises a first housing and a second housing. The first housing includes an interface for mating with the battery pack. The interface includes a set of rails, a set of grooves, a terminal block including a set of terminals, and a catch. The first housing includes a first attachment feature configured to attach the interface to a first cordless power tool of the set of cordless power tools in a first orientation. The second housing is attached to the first housing. The second housing includes a second attachment feature configured to attach the interface to a second cordless power tool of the set of cordless power tools in a second orientation. The second housing may be positioned between the first housing and the second cordless power tool.

One aspect of the present patent application provides an adaptor. The adaptor comprises a housing, a first gasket and a second gasket. The housing is formed of a material having a first durometer. The housing includes a first portion, a second portion coupled to the first portion, and an internal cavity. The first portion of the housing includes an inner wall in the internal cavity and an outer wall in the internal cavity. A first pocket space is formed between the first portion outer wall and the first portion inner wall. The first gasket is formed of a material having a second durometer. The second durometer is lower than the first durometer. The first gasket is insert molded in the first pocket space. The second portion of the housing includes an inner wall in the internal cavity and an outer wall in the internal cavity. A second pocket space is formed between the second portion outer wall and the second portion inner wall. The second gasket is formed of the material having the second durometer. The second gasket is insert molded in the second pocket space.

Another aspect of the present patent application provides a method of assembling a wiring assembly of an adaptor. The adaptor may include an adaptor tool terminal block having a plurality of tool engaging terminals that are configured to engage with terminals of a power tool, an adaptor battery pack terminal block having a plurality of battery pack engaging terminals that are configured to engage with terminals of a battery pack, a printed circuit board, a potting boat, a potting material, a terminal holder, and a wire harness having a plurality of power wires and a plurality of signal wires. Each power wire may include a first terminal end and a second terminal end. Each signal wire may include a first terminal end and a second terminal end. The plurality of battery pack engaging terminals of the adaptor battery pack terminal block may include power terminals and signal terminals. The plurality of tool engaging terminals of the adaptor tool terminal block may include power terminals and signal terminals. The method may comprise the steps of: connecting the first terminal ends of the power wires to the power terminals of the adaptor tool terminal block, connecting the second terminal ends of the power wires to the power terminals of the adaptor battery pack terminal block, connecting the first terminal ends of the signal wires to the printed circuit board, connecting the second terminal ends of the signal wires to the signal terminals of the adaptor battery pack terminal block, connecting the signal terminals of the plurality of tool engaging terminals to the printed circuit board, disposing the wire harness, the adaptor tool terminal block, and the adaptor battery pack terminal block in the potting boat, positioning the terminal holder over the power terminals and the signal terminals of the adaptor tool terminal block, and encapsulating the printed circuit board, either partially or entirely, by the potting material.

An aspect of the present patent application includes an electronic device, such as a battery pack adaptor, having a housing, the housing formed by a molding process, the housing including a pocket, the pocket including an inner wall and an outer wall opposed to the inner wall, a space formed between the pocket inner wall and the pocket outer wall, a seal/gasket formed, by a molding process, for example, injection molding in the space formed between the pocket inner wall and the pocket outer wall. The inner wall and the outer wall are composed of a high durometer material, for example, glass filled nylon (GFN) material, polycarbonate (PC) material, or Acrylonitrile Butadiene Styrene (ABS). The seal/gasket is composed of a low durometer material, for example, a thermoplastic elastomer (TPE) material.

The housing may include a first portion and a second portion, the second portion mated with first portion at a mating line (ML). A seal between the first portion and the second portion at the mating line. One of the first portion and the second portion including a rib along at least a portion of the mating line and the other of the first portion and the second portion including an injection molded gasket along the at least a portion of the mating line.

A wall of the first portion may extend towards the second portion in a first direction and terminating in a terminal end at or generally about the mating line. The terminal end may include a different geometries.

A second portion may include a seal assembly, an inner wall, and an outer wall, the inner wall, and the outer wall at least in part defining/forming a pocket/chamber/space. The inner wall and outer wall may be formed of a high durometer material. The seal may be formed by injection molding process. A gasket may be formed by an injection molding process of low durometer material in the pocket/chamber/space of the seal assembly.

Advantages may include one or more of the following. An innermold seal with a soft durometer seal may allow for the elimination or reduction of water and particulate ingress while being a permanent feature of the electronic device. This may reduce part complexity while upholding the need for a seal for contamination ingress. These and other advantages and features will be apparent from the description and the drawings.

These and other aspects of the present patent application, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the present patent application, the structural components illustrated herein are drawn to scale. It is to be expressly understood, however, that the drawings are for the purpose of illustration and description only and are not intended as a definition of the limits of the present patent application. It shall also be appreciated that the features of one embodiment disclosed herein can be used in other embodiments disclosed herein. As used in the specification and in the claims, the singular form of “a”, “an”, and “the” include plural referents unless the context clearly dictates otherwise.

Other aspects, features, and advantages of the present patent application will become apparent from the following detailed description, the accompanying drawings, and the appended claims.

Each of the aspects described above and in the following description can be used in any combination of one or more of these aspects, as will be understood to one of ordinary skill in the art.

### BRIEF DESCRIPTION OF THE DRAWINGS

FIGS. 1 and 2 show an example power tool system in accordance with an embodiment of the present patent application;

FIG. 3 shows a rear end view of a battery pack in accordance with an embodiment of the present patent application;

FIG. 4 shows a left side view of the battery pack;

FIG. 5 shows a front end view of the battery pack;

FIG. 6 shows a right side view of the battery pack;

FIG. 7 shows a top plan view of the battery pack;

FIG. 8 shows a bottom plan view of the battery pack;

FIGS. 9-18 show various perspective views of the battery pack;

FIG. 19 shows a perspective view of the battery pack along with its dimensions in accordance with an embodiment of the present patent application;

FIG. 20 shows an exploded view of an upper housing portion and a latch system that is configured to latch the battery pack with an electrical device;

FIGS. 21-24 show perspective views of the upper housing portion and steps for assembling the latch system;

FIG. 25 shows a rear view of the upper housing portion showing portions of the latch system and a State of Charge (SOC) indicator and a cover of a battery pack latching system;

FIGS. 26-30 show cross-sectional views of the latch system, wherein FIGS. 26 and 28A show the latch system in its latch configuration, wherein FIG. 27, and 28B-29 show the latch system in its unlatched configuration, wherein FIGS. 26-27 show the cross-sectional views of the latch system taken along an axis C-C in FIG. 25, wherein FIGS. 28A-28B show the cross-sectional views of the latch system taken along an axis D-D in FIG. 25, wherein FIG. 29 show the cross-sectional views of the latch system taken along an axis C-C in FIG. 25, and wherein, FIG. 30 shows a cross-sectional view of the latch system, in its unlatched configuration, taken along an axis E-E in FIG. 25;

FIGS. 31 and 32 show a perspective view and a front view, respectively, of the battery cell holder collection straps of a battery cell module;

FIGS. 33 and 34 show a front view and a perspective view, respectively, of a battery cell holder of the battery cell module, wherein the battery cell holder is injection molded around the battery cell holder collection straps of FIGS. 31 and 32;

FIGS. 35 and 36 show perspective views of the battery cell holder, wherein FIG. 35 shows the battery cell holder before gap pads are installed/disposed in the battery cell holder and FIG. 36 shows the battery cell holder after the gap pads are installed/disposed in the battery cell holder;

FIG. 37 shows an exploded view of the battery cell holder, battery cells, and gap pads of the battery cell module, wherein FIG. 37 shows the battery cell holder before the battery cells and the gap pads are installed/disposed in the battery cell holder;

FIG. 38 shows a front view of the battery cell holder with the battery cells and the gap pads installed/disposed therein;

FIG. 39 shows a perspective view of the battery cell holder with the battery cells and the gap pads installed/disposed therein and an end gap pad and an end insulated layer before the end gap pad and the end insulating layer are installed/disposed at the ends of the battery cell holder;

FIG. 40 shows a front view of a battery cell module of the battery pack;

FIG. 41 shows a perspective view of a module holder of the battery pack and a first battery cell module before that battery cell module is installed/disposed in the module holder;

FIG. 42 shows a perspective view of the module holder with the first battery cell module installed/disposed therein and a first end member of the module holder before the first end member is attached to the module holder;

FIG. 43 shows a perspective view of the module holder with the first battery cell module installed/disposed therein and a second battery cell module and a third battery cell module before they are installed/disposed in the module holder;

FIGS. 44 and 45 show a front view and a perspective view of the module holder with the three battery cell modules installed/disposed therein;

FIGS. 46-47 show a side view and a perspective view of a cell holder subassembly;

FIG. 48 shows a (top down) cross-sectional view of the cell holder subassembly of FIGS. 46-47;

FIG. 49 shows a perspective view of a (metal) contact stamped pattern of a shipping system subassembly of the battery pack;

FIG. 50 shows a perspective view of the stamped pattern of FIG. 49 and a base member of the shipping system subassembly;

FIG. 51 shows the stamped pattern and the base member wherein portions of the stamped pattern have been removed;

FIG. 52 shows a perspective view of contacts of the shipping system subassembly;

FIG. 53 shows a perspective view of the contacts of FIG. 52 insert molded into a contact holding member of the shipping system subassembly;

FIG. 54 shows a perspective view of the contact holding member of FIG. 53 placed in the base member of FIG. 51;

FIG. 55 shows a top plan view of the contact holding member placed in the base member of FIG. 54, wherein the contact holding member is in a use position ;

FIGS. 56 and 57 show perspective views of the shipping system subassembly of a shipping system of the battery pack, wherein the contact holding member is in the use position and the shipping system subassembly is in a use mode;

FIG. 58 shows a top plan view of the shipping system subassembly of FIG. 57;

FIG. 59 shows a top plan view of the shipping system subassembly of FIG. 58, wherein a cover is removed and the base member is transparent;

FIG. 60 shows a top plan view of the base member of FIG. 51 and the contacts of FIG. 52, wherein the base member is transparent and the contacts are in the use position;

FIG. 61 shows a cross-sectional view of the battery pack and a shipping mode actuator;

FIG. 62 shows a detail cross-sectional view of the battery pack, wherein the shipping system is in the use mode;

FIG. 63 shows a top perspective view of the lower housing with the cell holder subassembly and the shipping system subassembly (with the cover removed) received therein, wherein the shipping system subassembly is in the use mode;

FIGS. 64 and 65 show top plan views of FIG. 63, wherein the contact holding member and the contacts are removed and wherein FIG. 65 shows the base member as transparent;

FIGS. 66 and 67 show top plan views of FIG. 63, wherein FIG. 67 shows the base member as transparent;

FIGS. 68 and 69 top plan views of FIG. 63, wherein the contact holding member is removed and wherein FIG. 69 shows the base member as transparent;

FIG. 70 shows a partial side cross-sectional view of the battery pack with the shipping mode actuator being partially inserted therein, wherein the shipping system is in an intermediate position/configuration between the use mode and the shipping mode;

FIG. 71 shows a cross-sectional view of the battery pack with the shipping mode actuator inserted therein, wherein the shipping system is in the shipping mode;

FIG. 72 shows a detail cross-sectional view of FIG. 71;

FIG. 73 shows a top plan view of the battery pack, wherein the upper portion of the battery pack is not shown to better illustrate other portions of the battery pack;

FIG. 74 shows a top perspective view of the lower housing with the cell holder subassembly and the shipping system subassembly (with the cover removed) received therein, wherein the shipping system subassembly is in the shipping mode;

FIGS. 75 and 76 show top plan views of FIG. 74, wherein FIG. 76 shows the base member as transparent;

FIGS. 77 and 78 show top plan views of FIG. 74, wherein the contact holding member is removed and wherein FIG. 78 shows the base member as transparent;

FIGS. 79 and 80 show top plan views of the shipping system subassembly (with the cover removed), wherein the contact holding member is in the shipping position and wherein FIG. 80 shows the base member as transparent;

FIG. 81 shows a top plan view of FIG. 80, wherein the contact holding member is removed;

FIGS. 82-85 show perspective views of nested terminal portions of a power terminal of the battery pack;

FIGS. 86-91 show a top plan view, a bottom plan view, a left side view, a right side view, a front view, and a rear view, respectively, of the nested terminal portions of FIGS. 82-85;

FIG. 92 shows a top perspective view of a battery pack terminal block housing of the battery pack;

FIG. 93 shows a bottom perspective view of the battery pack terminal block housing including metal, insert molded terminal bases;

FIG. 94 shows a top perspective view of the battery pack terminal block housing including a set of first terminals;

FIG. 95 shows a bottom perspective view of the battery pack terminal block housing of FIG. 94;

FIGS. 96-99 show top perspective views of the battery pack terminal block;

FIG. 100 shows a top plan view of the battery pack terminal block of FIGS. 96-99;

FIG. 101 shows a bottom perspective view of the battery pack terminal block;

FIGS. 102-103 show bottom perspective views of the battery pack terminal block, wherein the battery pack terminal block housing is shown as transparent in FIG. 103;

FIG. 104 shows a top perspective view of the battery pack terminal block of FIG. 102;

FIG. 105 shows a partial right side cross-sectional view of the battery pack terminal block;

FIGS. 106-108 show perspective views of an electronics module subassembly of the battery pack, wherein FIG. 106 shows a printed circuit board of the electronics module subassembly, FIG. 107 shows electronic components disposed on the printed circuit board, FIG. 108 shows flexible circuits, connectors and electronic components disposed on the printed circuit board;

FIGS. 109-110 show a perspective view and a bottom plan view of the electronics module subassembly of the battery pack and the terminal block connected thereto;

FIGS. 111-112 show a perspective view and a bottom plan view of a subassembly holder/platform/support/base of the battery pack;

FIG. 113 shows an exploded perspective view of the subassembly holder, the shipping system subassembly and the electronics module subassembly;

FIGS. 114-115 show a top perspective view and a bottom plan view of the subassembly holder and the shipping system subassembly, wherein the subassembly holder and the shipping system subassembly are aligned with each other and before being connected to each other;

FIG. 116 shows a bottom plan view of the subassembly holder and the shipping system subassembly after the subassembly holder and the shipping system are connected to each other;

FIG. 117 shows a perspective view of the subassembly holder and the shipping system subassembly of FIG. 114, wherein spacers have been added to the subassembly holder;

FIGS. 118-119 show a top plan view and a perspective view of the subassembly holder, the shipping system subassembly, the battery pack terminal block, the electronics module subassembly and a state of charger subassembly;

FIG. 120 shows a cross-sectional view of the battery pack terminal block along with portions of the assembled subassembly holder, shipping system subassembly and electronics module subassembly;

FIG. 121 shows a cross-sectional view of the battery pack terminal block along with portions of the assembled subassembly holder, shipping system subassembly and the electronics module subassembly;

FIG. 122 shows a perspective view of the subassembly holder, the shipping system subassembly, the battery pack terminal block, the electronics module subassembly, and the state of charge subassembly, wherein potting material is applied to the electronics module subassembly and is received in the subassembly;

FIGS. 123-124 show exploded perspective views of the cell holder subassembly (e.g., the module holder with the three battery cell modules) of FIG. 47 and the assembled subassembly holder, battery pack terminal block, shipping system subassembly, electronics module subassembly, and state of charger subassembly of FIG. 122 before they are connected to each other;

FIGS. 125-129 show perspective views, a top plan view and a rear view of a corepack of the battery pack including the cell holder subassembly and the assembled subassembly holder, battery pack terminal block, shipping system subassembly, electronics module subassembly, and state of charge subassembly wherein FIG. 125 shows them after they are aligned but before they are connected to each other, wherein FIGS. 126-129 show them after they are connected to each other;

FIGS. 130-134 show a bottom perspective view, a front view, two top perspective views, a side view, respectively, of the upper housing portion of the battery pack;

FIGS. 135-137 show perspective views and a plan view, respectively, of the corepack of FIG. 127 received in and aligned with the upper housing portion;

FIG. 138 shows a plan view of the corepack received in and connected to the upper housing portion and a gasket at a mating surface of the upper housing portion;

FIG. 139 shows a top perspective view of the lower housing portion of the battery pack;

FIG. 140 shows a top perspective view of the lower housing portion of the battery pack and a gasket at a mating surface of the lower housing portion;

FIG. 141 shows a perspective view of the battery pack;

FIG. 142 shows a front perspective, cross-sectional view of the battery pack;

FIG. 143 shows a detail view of FIG. 142;

FIG. 144 shows a front perspective view of the battery pack;

FIGS. 145-146 show perspective views of the corepack received in the lower housing portion and a gasket at a mating surface of the lower housing portion, wherein the upper housing is not shown to better illustrate other portions of the battery pack;

FIG. 147 shows a partial cross-sectional view of the battery pack showing a first gasket at the mating surface between the upper housing portion and the lower housing portion and a second gasket at a mating surface between the upper housing portion and the terminal block housing;

FIG. 148 shows an example battery adaptor;

FIG. 149 shows an example power tool interface;

FIG. 150 shows an example battery pack;

FIG. 151 shows an example battery pack charger;

FIGS. 152-153 show a perspective view and a top plan view, respectively, of an example power tool (rammer);

FIG. 154 shows another perspective view of the example power tool (rammer);

FIGS. 155-156 show perspective views of another example power tool (plate compactor);

FIGS. 157-159 show perspective views of the battery pack and an example battery pack charger;

FIG. 160 shows a perspective view of an actuation component prior to being received in a handle cavity;

FIG. 161 shows a perspective view of the actuation component received in the handle cavity;

FIGS. 162 and 163 show a top perspective view and a bottom perspective view, respectively, of a latching element of a battery pack latching system in accordance with an embodiment of the present patent application;

FIGS. 164-166 show a top perspective view, a bottom perspective view, and a side perspective view, respectively, of a user actuation element of the battery pack latching system in accordance with an embodiment of the present patent application;

FIG. 167 shows a side view of the latching element of FIG. 162 and the user actuation element of FIG. 164 engaged with each other;

FIG. 168 shows a top plan view of the latching element of FIG. 162 and the user actuation element of FIG. 164 engaged with each other;

FIGS. 169-171 show top perspective views of the latching element of FIG. 162 and the user actuation element of FIG. 164 engaged with each other;

FIGS. 172-173 show bottom perspective views of the latching element of FIG. 162 and the user actuation element of FIG. 164 engaged with each other;

FIG. 174 shows a partial top plan view of the battery pack showing a cavity in the upper housing portion for receiving portions of the battery pack latching system;

FIGS. 175 and 176 show perspective views of a spring system of the battery pack latching system received in the cavity of the upper housing portion;

FIGS. 177 and 178 shows perspective views of the user actuation element of the battery pack latching system received in the cavity of the upper housing portion;

FIG. 179 show a top plan view of FIG. 178;

FIG. 180 shows a cross-sectional view taken along section line A-A of FIG. 179;

FIGS. 181 and 182 show perspective views of the latch element of the battery pack latching system received in the cavity of the upper housing portion;

FIGS. 183-184 show a perspective view and a top plan view the user actuation element and the latch element of the battery pack latching system received in the cavity of the upper housing portion;

FIG. 185 a cross-sectional view taken along section line B-B of FIG. 184, wherein the latch system is in its latched position;

FIG. 186 a cross-sectional view taken along section line B-B of FIG. 184, wherein the latch system is in its unlatched position;

FIG. 187 shows a partial perspective view of the battery pack upper housing portion showing the user actuation element, the latch element, and a latch cover of the battery pack latch system;

FIG. 188 shows a bottom perspective view of the user actuation element, the latch element, the latch cover, and the spring system of the battery pack latch system;

FIGS. 189-191 show perspective views of the spring system of the battery pack latch system;

FIGS. 192-194 show side views of another example embodiment of a battery pack latch system;

FIG. 195 shows a front end view of a battery pack charger in accordance with an embodiment of the present patent application;

FIG. 196 shows a right side view of the battery pack charger;

FIG. 197 shows a rear end view of the battery pack charger;

FIG. 198 shows a left side view of the battery pack charger;

FIG. 199 shows a top plan view of the battery pack charger;

FIG. 200 shows a bottom plan view of the battery pack charger;

FIGS. 201-208 show various perspective views of the battery pack charger;

FIGS. 209A-209B show perspective views of the battery pack charger and a roll cage, wherein the roll cage is shown separate from the battery pack charger and before the roll cage is attached to the battery pack charger;

FIG. 210 shows a front end view of the battery pack charger with the roll cage attached thereto;

FIG. 211 shows a right side view of the battery pack charger with the roll cage attached thereto;

FIG. 212 shows a rear end view of the battery pack charger with the roll cage attached thereto;

FIG. 213 shows a left side view of the battery pack charger with the roll cage attached thereto;

FIG. 214 shows a top plan view of the battery pack charger with the roll cage attached thereto;

FIG. 215 shows a bottom plan view of the battery pack charger with the roll cage attached thereto;

FIGS. 216-223 show various perspective views of the battery pack charger with the roll cage attached thereto;

FIG. 224 shows a rear end view of a battery pack;

FIG. 225 shows a right side view of the battery pack;

FIGS. 226-230 show various perspective views of the battery pack;

FIG. 231 shows a right side view of the battery pack connected to the battery pack charger with the roll cage attached to the battery charger;

FIG. 232 shows a rear end view of the battery pack connected to the battery pack charger with the roll cage;

FIG. 233A shows a left side view of the battery pack connected to the battery pack charger with the roll cage, wherein the housing of the battery pack charger provides support for a first orientation (e.g., horizontal) in which the battery pack insertion direction is generally horizontal;

FIG. 233B shows a left side view of the battery pack connected to the battery pack charger with the roll cage, wherein the roll cage provides stable support for a second orientation (e.g., vertical) in which the battery pack insertion direction is generally vertical;

FIG. 234 shows a front end view of the battery pack connected to the battery pack charger with the roll cage;

FIG. 235 shows a top plan view of the battery pack connected to the battery pack charger with the roll cage;

FIG. 236 shows a bottom plan view of the battery pack connected to the battery pack charger with the roll cage;

FIGS. 237-238 show perspective views of the battery pack connected to the battery pack charger with the roll cage;

FIG. 239 shows a top plan view of an exemplary coupling plate for coupling the battery pack charger to a storage container;

FIGS. 240A-240B show a top perspective view of the coupling plate and a detailed (top perspective) view of a first connection element of the coupling plate;

FIGS. 241A-241B show a top perspective view of the coupling plate and a detailed (top perspective) view of a second connection element of the coupling plate;

FIG. 242 shows a bottom perspective view of the coupling plate;

FIG. 243 shows a bottom plan view of the coupling plate;

FIG. 244 shows a left side view of the battery pack charger with the roll cage and the coupling plate before the coupling plate is attached to the battery pack charger;

FIGS. 245A-245B show a front, bottom, left-side isometric view and a front, top, right-side isometric view, respectively, of the battery pack charger with the roll cage and the coupling plate before the coupling plate is attached to the battery pack charger/roll cage assembly, the coupling plate in a first orientation;

FIGS. 246A-246B show a front, top, right-side isometric view and a front, bottom, left-side isometric view, respectively, of the battery pack charger with the roll cage and the coupling plate before the coupling plate is attached to the battery pack charger/roll cage assembly, the coupling plate in a second orientation;

FIGS. 247A-247D show a front elevational view, a rear elevational view, a right side elevational view, and a left, side elevational view, respectively, of the battery pack charger with the roll cage and the coupling plate after the coupling plate is attached to the battery pack charger/roll cage assembly, the coupling plate in the first orientation;

FIG. 247E shows a bottom, plan view of the battery pack charger with the roll cage and the coupling plate after the coupling plate is attached to the battery pack charger/roll cage assembly, the coupling plate in the first orientation;

FIG. 247F shows a perspective view of the battery pack charger with the roll cage and the coupling plate after the coupling plate is attached to the battery pack charger/roll cage assembly, the coupling plate in the first orientation;

FIGS. 247G-247I show perspective views of the battery pack charger with the roll cage and the coupling plate after they are connected to each other, wherein the battery pack insertion direction is along a vertical axis;

FIG. 248 shows a front, top, left-side isometric view of a first storage container of a storage system;

FIG. 249 shows a front, top, left-side isometric view of a second storage container of the storage system;

FIGS. 250A-250B show a left side elevation view and a front, top, right side isometric view, respectively, of the storage system;

FIG. 251 shows a left side isometric view of the storage system;

FIG. 252 shows a front, top, right side perspective view of the storage system and the battery pack charger with the roll cage and the coupling plate before the coupling plate is attached to the first storage container of the storage system;

FIGS. 253A-253C shows a front, top, right side perspective view, a front view and a front, top, left side perspective view, respectively, of the storage system and the battery pack charger after the coupling plate is attached to the first storage container of the storage system, wherein the battery pack charger is disposed in a first location, wherein the roll cage and the coupling plate are connected to the battery pack charger;

FIGS. 254A-254B shows a front elevation view and a front, top right side perspective view, respectively, of the storage system, the battery pack and the battery pack charger after the coupling plate is attached to the first storage container of the storage system, wherein the battery pack charger is disposed in the first location, wherein the roll cage, the battery pack and the coupling plate are connected to the battery pack charger;

FIG. 255 shows a perspective view of the storage system and two battery pack chargers before their coupling plates are attached to the first storage container of the storage system;

FIG. 256 shows a front, top, right side isometric view of the storage system and two battery pack chargers after the coupling plate of one of the battery pack chargers is attached to the first storage container of the storage system at the first location and before the coupling plate of the other of the battery pack charger is attached to the first storage container of the storage system at a second location;

FIGS. 257A-257C show a front elevational view, a top, front, right side view and a top, front, left side view, respectively, of the storage system and two battery pack chargers after the coupling plates of the two battery pack chargers are attached to the first storage container of the storage system at the first and second locations, wherein the coupling plate of the first battery pack charger is in a first orientation and the coupling plate of the second battery pack charger is in a second orientation;

FIG. 258 shows a perspective view of the storage system and two battery pack chargers after the battery pack chargers are attached to the first storage container of the storage system at the first and second locations, wherein one battery pack is connected to the first battery pack charger;

FIG. 259 shows a perspective view of the storage system and two battery pack chargers after the battery pack chargers are attached to the first storage container of the storage system at the first and second locations, wherein a battery pack is connected to each of the two battery pack chargers;

FIGS. 260A-260D show bottom perspective views of the battery pack charger with the roll cage and the coupling plate, wherein FIG. 260A shows the coupling plate attached to the battery pack charger in a first orientation, FIG. 260B shows the coupling plate removed/detached from the battery pack charger and aligned with the battery pack charger in the first orientation, FIG. 260C shows the coupling plate removed/detached from the battery pack charger and aligned with the battery pack charger in a second orientation, and FIG. 260D shows the coupling plate is attached to the battery pack charger in the second orientation;

FIGS. 261A-261F show a left side view, four perspective views, and a top plan view of the battery pack charger with the roll cage and the coupling plate and the battery pack in a first orientation such that a battery pack insertion direction is along a generally horizontal axis;

FIGS. 261G-261I show various perspective views of the battery pack charger with the roll cage and the coupling plate and the battery pack disposed in a second orientation such that a battery pack insertion direction is along a generally vertical axis;

FIG. 262 shows an example method for operation of the battery pack charger in accordance with an embodiment of the present patent application;

FIG. 263 shows an example circuit diagram of the battery pack charger in accordance with an embodiment of the present patent application;

FIGS. 264-267 show a cooling system of the battery pack charger in accordance with an embodiment of the present patent application;

FIG. 268 shows an example user interface or a display;

FIGS. 269A-269D show various views of a battery pack interface in accordance with an embodiment of the present patent application, wherein a view showing a tool engaging side of the interface is shown in FIG. 269A, a view showing a battery pack engaging side of the interface is shown in FIG. 269B, and side views of the interface are shown in FIG. 269C-269D ;

FIGS. 270A and 270B show various views of the interface of FIGS. 269A-269B with fasteners exploded out;

FIGS. 271A-271C show various exploded views of the interface of FIGS. 269A-269D;

FIG. 272 shows a detailed view of a terminal block of the interface of FIGS. 269A-269D;

FIG. 273 shows a detailed view of the terminal block of FIG. 272 and a portion of the interface, wherein FIG. 273 shows an upside down view of the portion of the interface;

FIGS. 274A-274D show various perspective views of an exemplary battery pack coupled to the interface of FIGS. 269A-269D, wherein the tool engaging side of the interface is shown in FIG. 274D;

FIG. 275 shows a cross sectional view of the battery pack and the interface of FIGS. 274A-274D;

FIGS. 276A-276F show various views of a first example power tool, FIGS. 276A and 276B show left and right side views, FIGS. 276C and 276E show front and rear views, and FIGS. 276D and 276F show perspective views, wherein the first example power tool is a core/concrete drill;

FIGS. 277A and 277B show detailed views of the power tool of FIGS. 276A-276F;

FIGS. 278A and 278B show a core block of the interface of FIGS. 269A-269D separated from and before being coupled to the power tool of FIGS. 276A-276F;

FIGS. 279A and 279B show various views of the core block mated to the power tool of FIGS. 276A-276F;

FIGS. 280A and 280B show various views of the core block fastened to the power tool of FIGS. 276A-276F;

FIGS. 281A and 281B show various views of a terminal block coupled to the core block;

FIGS. 282A and 282B show various views of a first interface housing portion mated to the core block;

FIGS. 283A and 283B show various views of the first interface housing portion fastened to the core block;

FIGS. 284A and 284B show various views of a second interface housing portion mated to the core block;

FIGS. 285A-285F show various views of the interface of FIGS. 269A-269D fastened to the power tool of FIGS. 276A-276F, FIGS. 285A and 285B show left and right side views, FIGS. 285C and 285E show front and rear views, and FIGS. 285D and 285F show perspective views;

FIGS. 286A and 286B show various detailed views of the interface of FIGS. 269A-269D fastened to the power tool of FIGS. 276A-276F;

FIGS. 287A-287F show various views of an example battery pack coupled to the interface and the power tool of FIGS. 285A-285F, FIGS. 287A and 287B show left and right side views, FIGS. 287C and 287E show front and rear views, and FIGS. 287D and 287F show perspective views;

FIG. 288 shows a detailed view of the battery pack, the interface and the power tool of FIG. 287A;

FIGS. 289A-289E show various views of a core block of an interface assembly in accordance with an embodiment of the present patent application;

FIGS. 290A-290E show various views of a terminal block coupled to the core block of FIGS. 289A-289E;

FIG. 291 shows a first interface housing portion mated to the core block of FIGS. 290A-290E;

FIGS. 292A-292C show various views of the first interface housing portion fastened to the core block of FIG. 291;

FIGS. 293A-293C show various views of a latch catch coupled to the first interface housing portion;

FIGS. 294A-294C show various views of a second interface housing portion coupled to the core block of FIGS. 290A-290E;

FIGS. 295A-295E show the second interface housing portion fastened to the core block of FIGS. 290A-290E;

FIGS. 296A and 296B show various views of a frame of a second example power tool, wherein the second example power tool is a rammer;

FIGS. 297A and 297B show detailed views of FIGS. 296A and 296B;

FIGS. 298A and 298B show various views of the interface of FIGS. 295A-295E fastened to the frame of the second example power tool of FIGS. 296A and 296B;

FIGS. 299A and 299B show detailed views of FIGS. 298A and 298B;

FIGS. 300A and 300B show various views of an example battery pack coupled to the interface and the power tool of FIGS. 298A and 298B;

FIGS. 301A and 301B show detailed views of FIGS. 300A and 300B;

FIG. 302 shows a first example wiring scheme of the interface of FIGS. 269A-269D;

FIG. 303 shows a second example wiring scheme of the interface of FIGS. 269A-269D;

FIG. 304 shows a third example wiring scheme of the interface of FIGS. 269A-269D;

FIG. 305 shows an example interface of the present patent application;

FIG. 306 shows a first example outer housing coupled to the example interface of FIG. 305;

FIG. 307 shows the combination outer housing and interface of FIG. 305 incorporated in a third example power tool;

FIG. 308 shows the combination outer housing and interface of FIG. 305 incorporated in a fourth example power tool;

FIG. 309 shows a second example outer housing coupled to the example interface of FIG. 305;

FIGS. 310A and 310B show a method of coupling an outer housing to the interface of FIG. 305;

FIG. 311 shows an example power tool system, including several example cordless power tools, battery packs, charger and battery pack adaptor, incorporating the battery pack interface of the present patent application, the cordless power tools may include screed/concrete screed, rammer, concrete vibrator power pack, concrete vibrator backpack, core drill stand, plate compactor, 12 inch cutoff saw, etc. ;

FIGS. 312A and 312B show a side view and a detailed view of an example power tool, wherein the example power tool is a rammer, wherein the battery pack is coupled to the interface;

FIG. 313 shows a perspective view of a power tool with an example interface coupled to the power tool, wherein the power tool is a core/concrete drill;

FIGS. 314-316 show exploded views showing portions of the power tool of FIG. 313, the interface, and portions of the façade/outer housing;

FIGS. 317-318 show various views of the interface of FIG. 313;

FIG. 319 shows a perspective view of an example power tool with the interface mounted therein, wherein the example power tool is a plate compactor;

FIG. 320 shows an assembled view of the portions of the power tool of FIG. 319, the interface, and portions of the façade/outer housing;

FIGS. 321A-322 show exploded views of the portions of the power tool of FIG. 319, the interface, and portions of the façade/outer housing;

FIG. 323 shows a perspective view of an example power tool with the interface mounted therein, wherein the example power tool is a rammer;

FIG. 324 shows an assembled view of the portions of the power tool of FIG. 323, the interface, and portions of the façade/outer housing;

FIGS. 325-326 show exploded views of the portions of the power tool of FIG. 323, the interface, and portions of the façade/outer housing;

FIG. 327 shows show a perspective view of the interface of FIG. 323;

FIG. 328 shows a perspective view of an example power tool with the interface mounted therein, wherein the example power tool is a screed;

FIG. 329 shows an assembled view of the portions of the power tool of FIG. 328, the interface, and portions of the façade/outer housing;

FIGS. 330-333 show exploded views of the portions of the power tool of FIG. 328, the interface, and portions of the façade/outer housing;

FIGS. 334-337 show various views of the interface of FIG. 328;

FIG. 338 shows a perspective view of an example power tool with the interface mounted therein, wherein the example power tool is a vibrator backpack, FIG. 339 shows an assembled view of the portions of the power tool of FIG. 338, the interface, and portions of the façade/outer housing;

FIGS. 340A-341 show exploded views of the portions of the power tool of FIG. 338, the interface, and portions of the façade/outer housing;

FIGS. 342-343 show various views of the interface and removably attachable portions of the power tool of FIG. 338;

FIGS. 344-345 show various views of the interface of FIG. 338;

FIG. 346 shows a perspective view of an example power tool with the interface mounted therein, wherein the example power tool is a vibrator powerpack;

FIG. 347 shows show an assembled view of the portions of the power tool of FIG. 346, the interface, and portions of the façade/outer housing;

FIGS. 348A-351 show exploded views of the portions of the power tool of FIG. 346, the interface, and portions of the façade/outer housing;

FIG. 352 shows a perspective view of an example power tool with the interface mounted therein, wherein the example power tool is a vibrator backpack;

FIG. 353 shows a perspective view of an example power tool with the interface mounted therein, wherein the example power tool is a vibrator powerpack;

FIG. 354 shows a perspective view of example power tools with the interface mounted therein, wherein the example power tools are a vibrator backpack and a vibrator powerpack;

FIG. 355 shows a rear end elevation view of a battery pack adaptor in accordance with an embodiment of the present patent application;

FIG. 356 shows a left side elevation view of the battery pack adaptor;

FIG. 357 shows a front end elevation view of the battery pack adaptor;

FIG. 358 shows a right side elevation view of the battery pack adaptor;

FIG. 359 shows a top plan view of the battery pack adaptor;

FIG. 360 shows a bottom plan view of the battery pack adaptor;

FIGS. 361-368 show various isometric views of the battery pack adaptor;

FIGS. 369-370 show a front end view and an isometric view, respectively, of the battery pack adaptor;

FIG. 371 shows an exploded isometric view of the battery pack adaptor, wherein the door of the battery pack adaptor is in the open position and before the battery pack is inserted into the internal cavity of the housing;

FIG. 372 shows an isometric view of the battery pack adaptor, wherein the door of the battery pack adaptor is in the open position and after the battery pack is inserted into and received in the internal cavity of the housing;

FIG. 373 shows an isometric view of the battery pack adaptor, wherein the battery pack is received in the internal cavity of the housing and the door of the battery pack adaptor is in one of intermediate positions, the one or more intermediate positions are between the open position and a closed position, wherein the illustrated intermediate position is closer to the closed position than the open position;

FIGS. 374-376 show isometric views of the battery pack adaptor, wherein the door is in the closed position and the over center latch of the door being coupled to the catch of the housing to retain the door in the closed position, wherein FIG. 376 also shows chamfers to push out the latch with a power tool terminal block;

FIGS. 377-378 show side/bottom and isometric views, respectively, of the battery pack adaptor;

FIG. 379A shows an example housing of the battery pack adaptor;

FIGS. 379B-379E show cross-sectional views of several example embodiments of an insert molded seal/gasket insert;

FIG. 380 shows an isometric view of a first housing portion of the battery pack adaptor and an example seal/gasket;

FIG. 381 shows an isometric view of the first housing portion of the battery pack adaptor with the first gasket insert molded into the first housing portion;

FIG. 382 shows an isometric view of a second housing portion of the battery pack adaptor and an example seal/gasket;

FIG. 383 shows an isometric view of the second housing portion of the battery pack adaptor with the outer wall removed;

FIG. 384 shows an isometric view of the second housing portion of the battery pack adaptor with the second gasket insert molded into the second housing portion;

FIG. 385 shows an isometric view of the battery pack adaptor, wherein the door is in the closed position and the over center latch on the door being coupled to the catch on the housing to retain the door in the closed position;

FIG. 386 shows an isometric view of the battery pack adaptor, wherein the door is in the open position;

FIGS. 387A and 387B show cross-sectional views of the battery pack adaptor, taken along line A-A in FIG. 356, wherein FIG. 387A shows the pocket space without the gasket and FIG. 387B shows with the gasket insert molded into the housing;

FIG. 387C shows an isometric view of the battery pack adaptor, taken along line A-A in FIG. 356, with the gasket insert molded into the housing;

FIGS. 388A and 388B show cross-sectional views of the battery pack adaptor, taken along line B-B in FIG. 356, wherein FIG. 388A shows the pocket space without the gasket and FIG. 388B shows with the gasket insert molded into the housing;

FIGS. 389A and 389B show cross-sectional views of the battery pack adaptor, taken along line C-C in FIG. 356, wherein FIG. 389A shows the pocket space without the gasket and FIG. 389B shows with the gasket insert molded into the housing;

FIG. 389C shows an isometric view of the battery pack adaptor, taken along line C-C in FIG. 356, with the gasket insert molded into the housing;

FIG. 390 shows a cross-sectional view of the battery pack adaptor, taken along line D-D in FIG. 356;

FIG. 391 shows an isometric view of the housing of the battery pack adaptor, wherein the door is not shown to better illustrate the other components of the adaptor;

FIG. 392 shows a top view of the housing of the battery pack adaptor, wherein the door is not shown to better illustrate the other components of the adaptor and the gasket insert molded in the housing is shown;

FIGS. 393A and 393B show cross-sectional views of the battery pack adaptor, taken along line E-E in FIG. 356, wherein FIG. 393A shows the pocket space without the gasket and FIG. 393B shows with the gasket insert molded into the housing;

FIG. 393C shows an isometric view of the battery pack adaptor, taken along line E-E in FIG. 356, with the gasket insert molded into the housing;

FIGS. 394A and 394B show cross-sectional views of the battery pack adaptor, taken along line F-F in FIG. 359 wherein FIG. 394A shows the pocket space without the gasket and FIG. 394B shows with the gasket insert molded into the housing;

FIG. 394C shows an isometric view of the battery pack adaptor, taken along line F-F in FIG. 359, with the gasket insert molded into the housing;

FIGS. 395A and 395B show isometric and top views, respectively, of a wire harness assembly of the battery pack adaptor at a first step of assembly;

FIGS. 396A and 396B show isometric and top views, respectively, of the wire harness assembly of the battery pack adaptor at a second step of assembly;

FIG. 397 shows an isometric view of the wire harness assembly of the battery pack adaptor at a third step of assembly;

FIGS. 398A and 398B show isometric and top views, respectively, of the wire harness of the battery pack adaptor at a fourth step of assembly;

FIGS. 399A and 399B show isometric and top views, respectively, of the wire harness of the battery pack adaptor at a fifth step of assembly; and

FIGS. 400A and 400B show isometric and top views, respectively, of the wire harness of the battery pack adaptor at a sixth step of assembly.

### DETAILED DESCRIPTION

Additional details of embodiments of various battery packs and power tools considered within the scope of the present disclosure can be found in at least U.S. Provisional Patent Application Nos. U.S. Provisional Patent Application Nos. 63/520,315 (Patent Center No. 62636395), 63/584,755 (Patent Center No. 62853694), 63/520,317 (Patent Center No. 62636568), 63/359,940, 63/533,751, 63/533,754, 63/533,755, 63/533,758, 63/578,008; U.S. patent application Ser. No. 18/114,121; U.S. Pat. No. 9,406,915; European Patent Application Nos. EP22202110.7, EP22194105.7, EP23163288.6, and EP23192793.0; PCT Patent Application Nos. PCT/EP2022/074710, PCT/EP2023/072939,PCT/EP2023/072638, and PCT/EP2023/072679; and U.K. Patent Application Nos. GB2112789.9, GB2209009.6, and GB2218350.3. The disclosures of each of the above applications and patents are hereby incorporated by reference in their entirety.

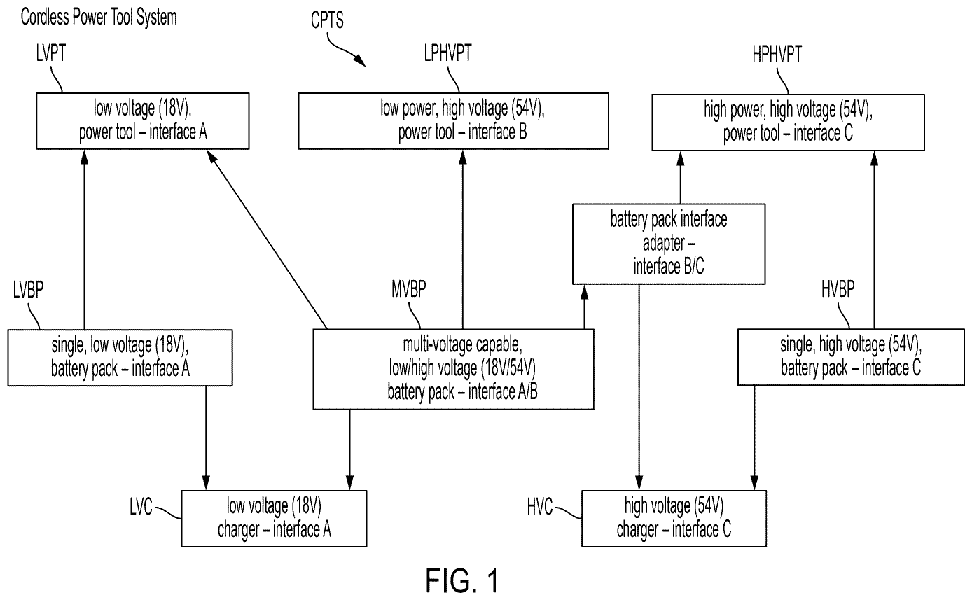

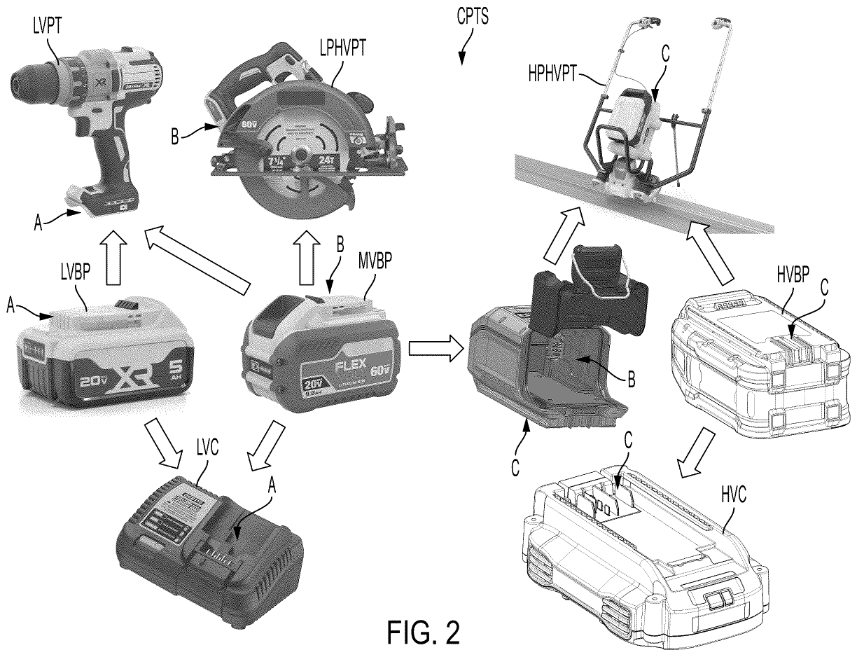

Referring to FIGS. 1-2, the present patent application provides a cordless power tool system (CPTS). The CPTS may include a first power tool, a second power tool, a third power tool, a first battery pack, second battery pack 3100. The first power tool may include a high power, high voltage power tool (HPHVPT). The HPHVPT may have a first power tool rated voltage (e.g., 54 volts (V)). The HPHVPT may have a first power tool interface (e.g., interface C). The second power tool may include a low power, high voltage power tool (LPHVPT). The LPHVPT may have the second power tool rated voltage (e.g., 54V). The LPHVPT may have a second power tool interface (e.g., interface B) that is different from the first power tool interface (e.g., interface C). The third power tool may include a low voltage power tool (LVPT). The LVPT may have a third power tool rated voltage (e.g., 18V). The LVPT may have a third power tool interface (e.g., interface A) that is different from the first power tool interface (e.g., the interface C) and the second power tool interface (e.g., the interface B).

Referring to FIGS. 1-2, in one example embodiment, the CPTS may include a high voltage battery pack (HVBP) 100 and a set of cordless HPHVPT (one shown). The CPTS also may include a high voltage charger (HVC) 5000. Each of the cordless power tools of the set of cordless power tools may be powered by the HVBP 100. The set of power tools may include, for example, a screed, a concrete plate compactor, a rammer, a concrete vibrator powerpack, a concrete vibrator backpack, and a concrete/core drill. It is understood that the HPHVPT illustrated in FIGS. 1-2 are examples and that other power devices are contemplated to be included as part of the CPTS, even though not illustrated. In one example implementation, the HPHVPT have an operating voltage of 54V. Each HPHVPT may include a receptacle for receiving the HVBP 100. The power tool receptacle may include an interface for mating with the HVBP 100. The battery pack receptacle may be configured with one interface for receiving one removable, rechargeable battery pack, for example, from the HVBP 100.

The first battery pack may be a single (fixed) voltage (high voltage) battery pack (HVBP). The HVBP may have a first nominal voltage (e.g., 54V) that is substantially the same as the first power tool rated voltage (e.g., 54V). The HVBP may have the first battery pack interface (e.g., the interface C) that is connectable to the first power tool interface (i.e., the interface C) to provide power to the HPHVPT. The first battery pack interface (e.g., the interface C) of the HVBP is not connectable to the second power tool interface (e.g., the interface B) or the third power tool interface (e.g., the interface A).

The second battery pack 3100 may be a multi-voltage capable, (low voltage/high voltage) battery pack (MVBP) 3100. The MVBP 3100 may have a second battery pack interface (e.g., the interface A/B) that is coupleable to the second power tool interface (e.g., the interface B) of the LPHVPT and that is coupleable to the third power tool interface (i.e., the interface A) of the LVPT.

The MVBP 3100 may have the first nominal voltage (e.g., 54V) that is substantially the same as the first power tool rated voltage (e.g., 54V) when the MVBP is coupled to the HPHVPT or connected to the LPHVPT and may have a second nominal voltage (e.g., 18V) that is substantially the same as the third power tool rated voltage (e.g., 18V) when the MVBP 3100 is connected to the LVPT. The MVBP 3100 may be configured to be coupled to the HPHVPT to provide power to the HPHVPT (e.g., it will require the adaptor to couple the MVBP 3100 and the HPHVPT). It is noted that, in the present patent application, the battery and the power tool may be “connected” when there is no adaptor, while the battery and the power tool may be “coupled” when there is an adaptor. The MVBP 3100 may also be configured to be connected to the LVPT to provide power to the LVPT.

The CPTS may further comprise an adaptor 3000 having a first adaptor interface (e.g., interface C) configured to be connected to the first power tool interface (e.g., the interface C) of the HPHVPT and a second adaptor interface (e.g., interface B) configured to be connected to the second battery pack interface (e.g., the interface A/B) of the MVBP to couple the MVBP to the HPHVPT.

The second battery pack interface (e.g., the interface A/B) of the MVBP is not able to be coupled to the first power tool interface (e.g., the interface C) of the HPHVPT without the adaptor 3000.

The rated voltage of the HPHVPT and the rated voltage of the LPHVPT are the same. The rated voltage of the HPHVPT and the rated voltage of the LPHVPT may be 54V.

The nominal voltage of the HVBP and the nominal voltage of the MVBP may be the same. The nominal voltage of the HVBP and the nominal voltage of the MVBP may be 54V.

The third battery pack may be a single (fixed) voltage (low voltage battery pack (LVBP). The LVBP may have the second nominal voltage (e.g., 18V) that is substantially the same as the third power tool rated voltage (e.g., 18V). The LVBP may have a third battery pack interface (e.g., the interface A) that is connectable to the third power tool interface (e.g., the interface A) of the third power tool HPHVPT. The third battery pack LVBP may have a third battery pack interface (e.g., the interface A) that is not connectable to the first power tool interface (e.g., the interface C) of the HPHVPT or the second power tool interface (e.g., the interface B) of the LPHVPT.

As used in this application, rated voltage may refer to the advertised voltage, or the operating voltage, depending on the context. The rated voltage may also encompass a single (fixed) voltage, several discrete voltages, or one or more ranges of voltages. As used in the application, rated voltage may refer to any of these types of voltages or a range of any of these types of voltages.

Advertised Voltage: With respect to power tools, battery packs, and chargers, the advertised voltage generally refers to a voltage that is designated on labels, packaging, user manuals, instructions, advertising, marketing, or other supporting documents for these products by a manufacturer or seller so that a user is informed which power tools, battery packs, and chargers will operate with one another. The advertised voltage may include a numeric voltage value, or another word, phrase, alphanumeric character combination, icon, or logo that indicates to the user which power tools, battery packs, and chargers will work with one another. In some embodiments, as discussed below, a power tool, battery pack, or charger may have a single advertised voltage (e.g., 20V or 60V), a range of advertised voltages (e.g., 20V-60V), or a plurality of discrete advertised voltages (e.g., 20V/60V). As discussed further below, a power tool may also be advertised or labeled with a designation that indicates that it will operate with both a DC power supply and an AC power supply (e.g., AC/DC or AC/60V). An AC power supply may also be said to have an advertised voltage, which is the voltage that is generally known in common parlance to be the AC mains voltage in a given country (e.g., 120 VAC in the United States and 220 VAC- 240 VAC in Europe).

Operating Voltage: For a power tool, the operating voltage generally refers to a voltage or a range of voltages of AC and/or DC power supply(ies) with which the power tool, its motor, and its electronic components are designed to operate. For example, a power tool advertised as a 120V AC/DC tool may have an operating voltage range of 92V-132V. The power tool operating voltage may also refer to the aggregate of the operating voltages of a plurality of power supplies that are coupled to the power tool (e.g., a 120V power tool may be operable using two 60V battery packs connected in series). For a battery pack and a charger, the operating voltage refers to the DC voltage or range of DC voltages at which the battery pack or charger is designed to operate. For example, a battery pack or charger advertised as a 60V battery pack or charger may have an operating voltage range of 51V-60V. For an AC power supply, the operating voltage may refer either to the root-mean-square (RMS) of the voltage value of the AC waveform and/or to the average voltage within each positive half-cycle of the AC waveform. For example, a 120 VAC mains power supply may be said to have an RMS operating voltage of 120V and an average positive operating voltage of 108V.

Nominal Voltage: For a battery pack, the nominal voltage generally refers to the average DC voltage output from the battery pack. For example, a battery pack advertised as a 60V battery pack, with an operating voltage of 51V-60V, may have a nominal voltage of 54V. For an AC power supply, the operating voltage may refer either to the root-mean-square (RMS) of the voltage value of the AC waveform and/or to the average voltage within each positive half-cycle of the AC waveform. For example, a 120 VAC mains power supply may be said to have an RMS nominal voltage of 120V and an average positive nominal voltage of 108V.

Maximum Voltage: For a battery pack, the maximum voltage may refer to the fully charged voltage of the battery pack. For example, a battery pack advertised as a 60V battery pack may have a maximum fully charged voltage of 60V. For a charger, the maximum voltage may refer to the maximum voltage to which a battery pack can be recharged by the charger. For example, a 60V charger may have a maximum charging voltage of 60V.

It should also be noted that certain components of the power tools, battery packs, and chargers may themselves be said to have a voltage rating, each of which may refer to one or more of the advertised voltage, the operating voltage, the nominal voltage, or the maximum voltage. The rated voltages for each of these components may encompass a single voltage, several discrete voltages, or one or more ranges of voltages. These voltage ratings may be the same as or different from the rated voltage of power tools, battery packs and chargers. For example, a power tool motor may be said to have its own an operating voltage or range of voltages at which the motor is designed to operate. The motor rated voltage may be the same as or different from the operating voltage or voltage range of the power tool. For example, a power tool having a voltage rating of 60V-120V may have a motor that has an operating voltage of 60V-120V or a motor that has an operating voltage of 90V-100V.

The power tools, power supplies, and chargers also may have ratings for features other than voltage. For example, the power tools may have ratings for motor performance, such as an output power (e.g., maximum watts out (MWO) as described in U.S. Pat. No. 7,497,275, which is incorporated by reference herein in its entirety—“the '275 Patent”) or motor speed under a given load condition. In another example, the battery packs may have a rated capacity, which refers to the total energy stored in a battery pack. The battery pack rated capacity may depend on the rated capacity of the individual cells and the manner in which the cells are electrically connected.

This application also refers to the ratings for voltage (and other features) using relative terms such as low, medium, high, and very high. The terms low rated, medium rated, high rated, and very high rated are relative terms used to indicate relative relationships between the various ratings of the power tools, battery packs, AC power supplies, chargers, and components thereof, and are not intended to be limited to any particular numerical values or ranges. For example, it should be understood that a low rated voltage is generally lower than a medium rated voltage, which is generally lower than a high rated voltage, which is generally lower than a very high rated voltage.

Each of the power tools—LVPT, LPHVPT or HPHVPT—may include a housing. Each power tool housing may incorporate components/elements such as a motor and a working element of the power tool. Each of the power tools LVPT, LPHVPT or HPHVPT may also include a motor control circuit and a battery pack interface that are configured to enable operation from one or more DC battery pack power supplies that together have a rated voltage that corresponds to the rated voltage of the power tool. The motor may be any brushed or brushless DC electric motor, including, but is not limited to, a permanent magnet brushless DC motor (BLDC), a permanent magnet DC brushed motor (PMDC), an induction motor, a universal motor, etc. The motor control circuit may include a power unit having one or more power switches (not shown) disposed between the power supply and the motor. The power switch may be an electro-mechanical on/off switch, a power semiconductor device (e.g., diode, FET, BJT, IGBT, etc.), or a combination thereof. The motor control circuit may further include a control unit or controller. The control unit may be arranged to control a switching operation of the power switches in the power unit. The motor control circuit may control the motor in fixed or variable speed. The control unit may include a micro-controller or similar programmable module configured to control gates of power switches. Additionally or alternatively, the control unit may be configured to monitor and manage the operation of the DC battery pack power supplies. Additionally or alternatively, the control unit may be configured to monitor and manage various tool operations and conditions.

The LVPT may include, but is not limited to, at least one of the following power tools: a band saws, a chop saw, a circular saw, a cutout tool, a compressor, a drill, a hammer drill, a fan, a grinder, a hammer, a dust extractor, an impact driver, an impact wrench, an inflator, a jigsaw, a joiner, a light, a magnetic drill press, a nailer, an oscillating tool, a planer, a polisher, a ratchet, a reciprocating saw, a rotary hammer, a router, a sander, a screwdriver, a screwgun, a vacuum, a blower, a chain saw, an edger, a hedge trimmer, a pressure washer, a mower, a snow thrower, a string trimmer, a tiller, or an auger. The LVPT may be configured to operate at a rated voltage of 18 V.

The LVPT may be configured to be powered by a single LVBP, which may be charged using an LVC that is designed and configured to charge the LVBP. The LVPT, the LVBP, and the LVC may have the same interface (e.g., the interface A). The interfaces may be configured for electrically and physically coupling the LVBP with the LVPT and/or the LVC.

The LPHVPT may be configured to operate at a rated voltage of 54 V. The power tool interface of the LPHVPT may be referred to as interface B in this patent application. The LPHVPT may include, but is not limited to, at least one of the following power tools: a circular saw, a drill, a grinder, a miter saw, a reciprocating saw, a rotary hammer, or a table saw.

The LPHVPT may be configured to be powered by a MVBP, which may be charged using a LVC. The LVC may be designed and configured to charge either the LVBP or the MVBP. The MVBP may be configured to power either the LVPT or the LPHVPT. The MVBP is also described in detail in U.S. Pat. No. 9,406,915, which is incorporated herein in its entirety.

The MVBP interface may incorporate two interfaces (e.g., the interface A and the interface B). The LPHVPT and the MVBP may both include the same interface (e.g., the interface B). The LVPT and the MVBP may both include the same interface (e.g., the interface A). The interface A may be configured for electrically and physically coupling the MVBP with the LVPT and/or LVC and the interface B may be configured for electrically and physically coupling the MVBP with the LPHVPT using the adaptor 3000.

The HPHVPT may be configured to operate at a rated voltage of 54V or higher. The power tool interface of the HPHVPT may be referred to as the interface C in this patent application. The HPHVPT may include, but is not limited to, at least one of the following power tools: a jack hammer a concrete drill, a concrete saw, a 12 inch cut-off saw, a concrete vibrator, a plate/concrete plate compactor, a rammer, or a screed/concrete screed. Such HPHV power tools are also described in detail in U.S. Patent Application Publication Number 2023-0291049, which is incorporated herein in its entirety. These power tools may require a relatively high amount of power and/or runtime compared to the LPHVPT. The HPHVPT may also include, but is not limited to, a concrete mixer, a jobsite lift, a block saw, a concrete finisher, an early entry saw, and a jobsite buggy, they may be referred to as very high power tools. These power tools may have the relatively high operating voltage. These power tools may require a relatively high amount of power and/or runtime compared to the LPHVPT.

The HPHVPT may be configured to be powered by a HVBP, which may be charged using a HVC that is designed and configured to charge the HVBP. The HPHVPT, the HVBP, and the HVC may have the same interface (e.g., the interface C). The interfaces may be configured for electrically and physically connecting the HVBP with the HPHVPT and/or the HVC.

However, it will be understood by those skilled in the art that the teachings of the present patent application are not so limited.

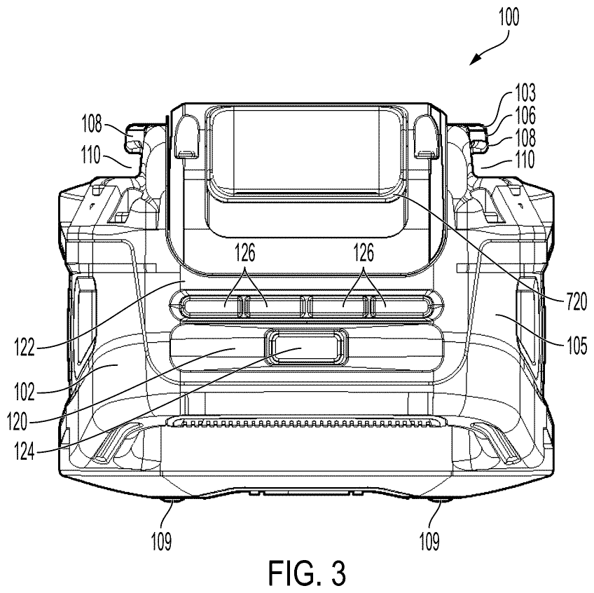

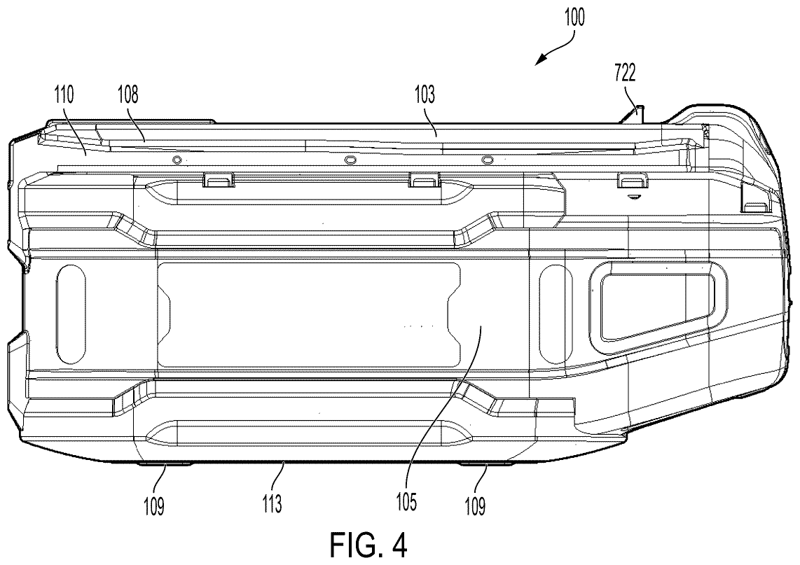

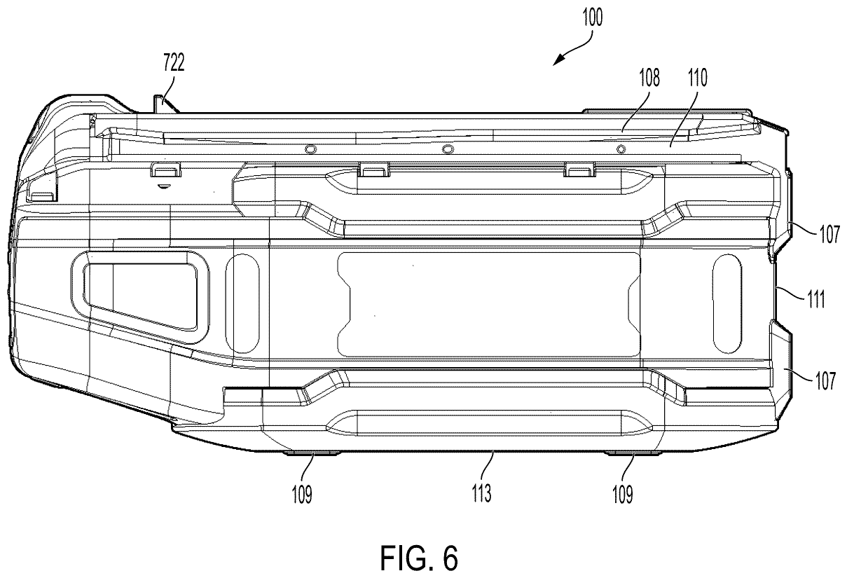

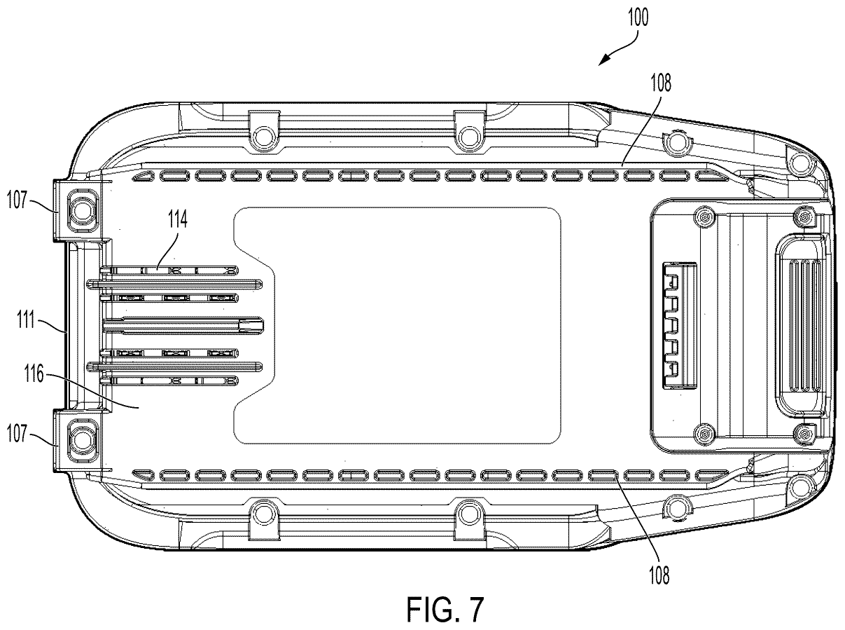

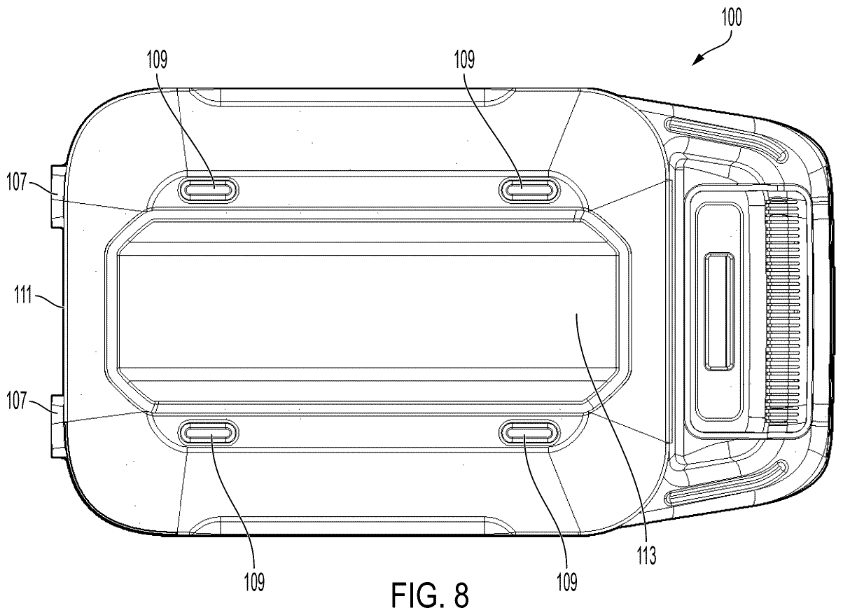

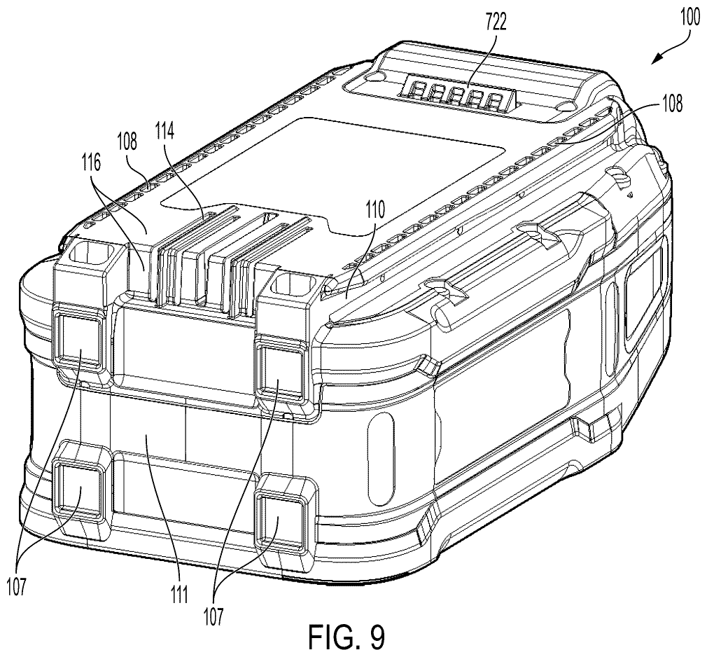

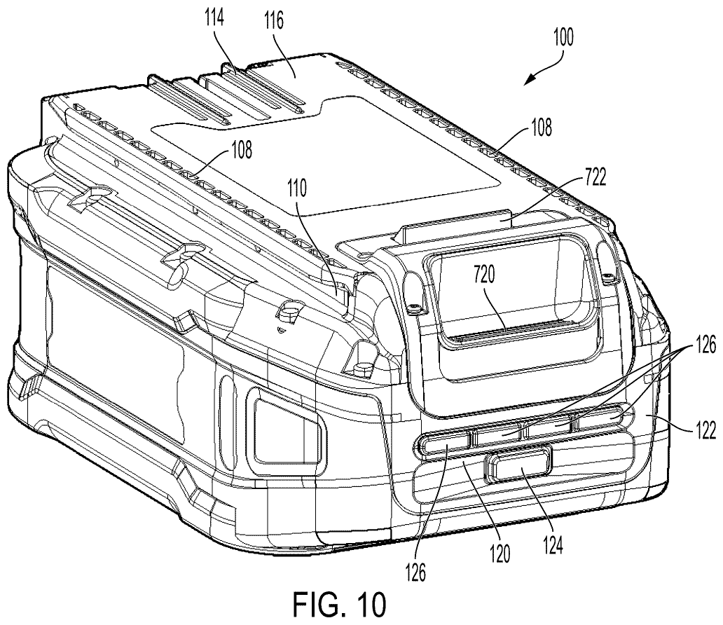

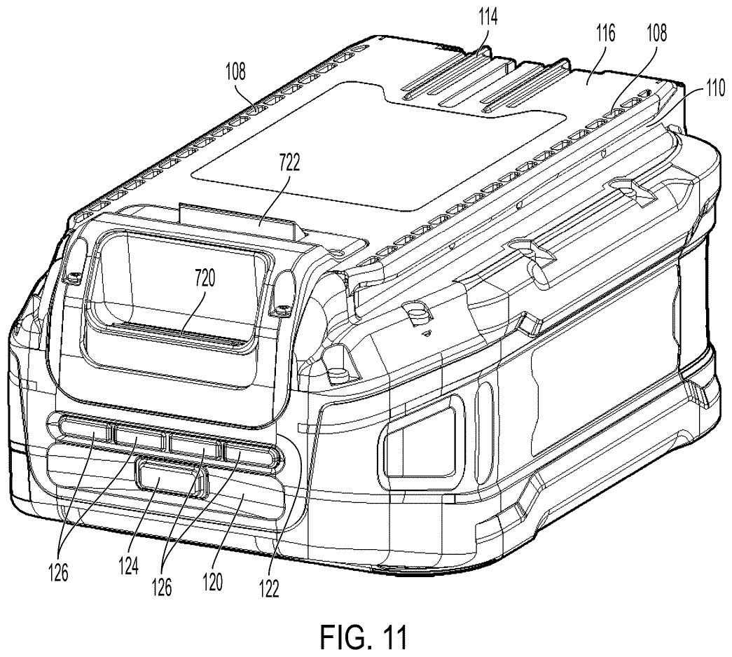

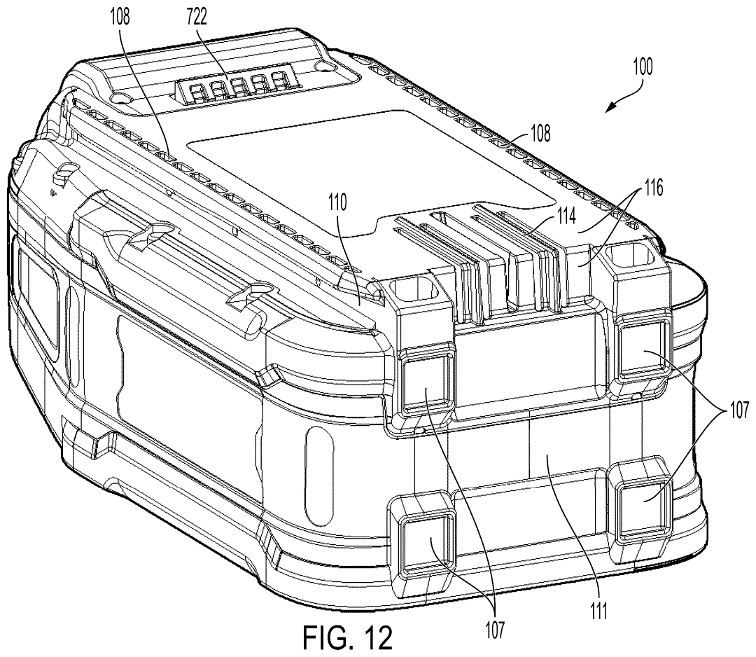

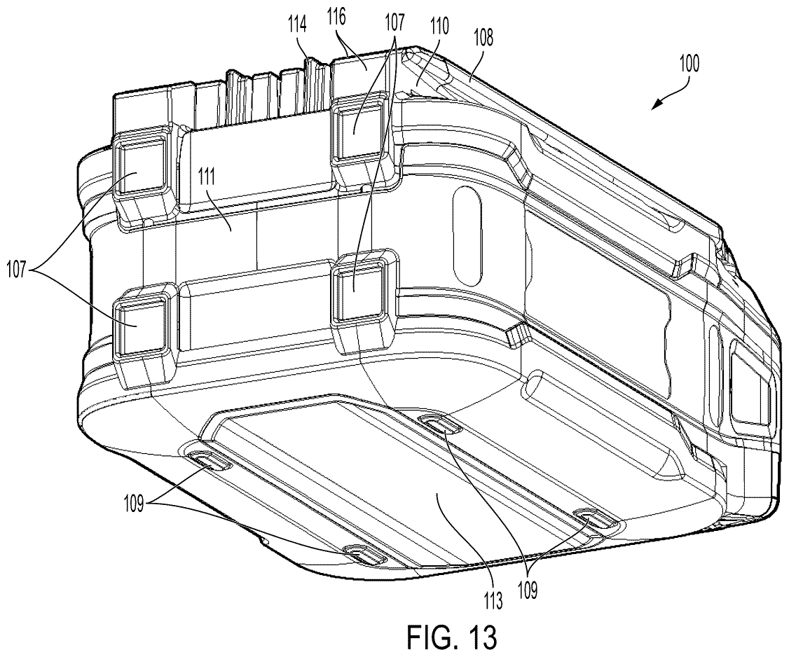

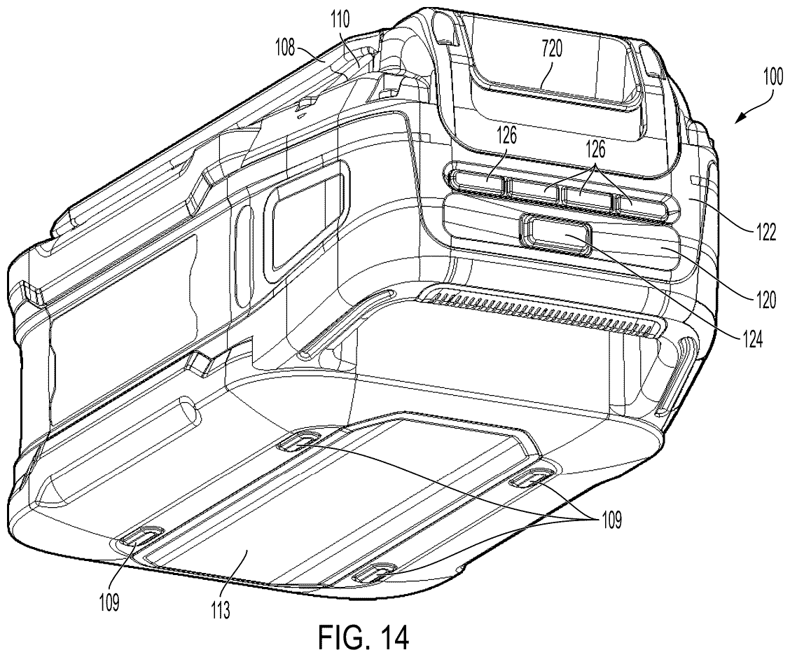

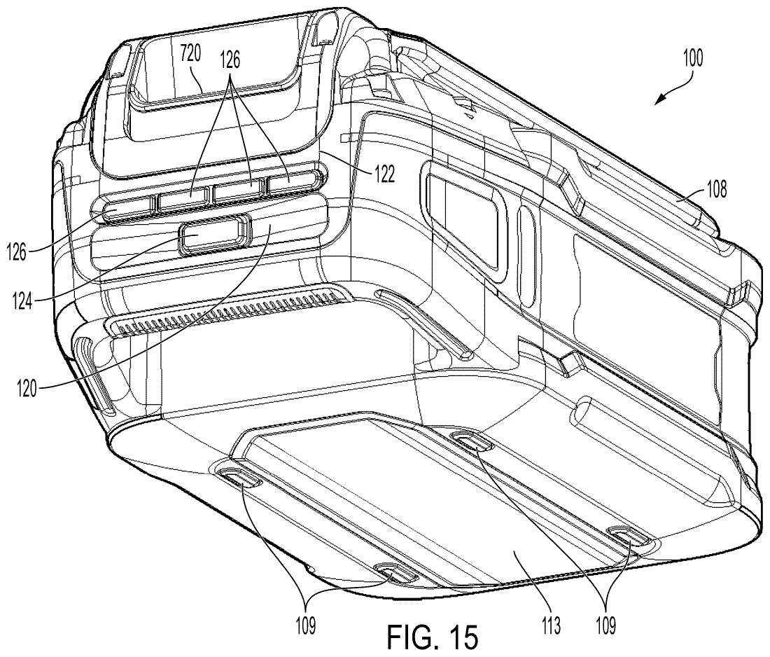

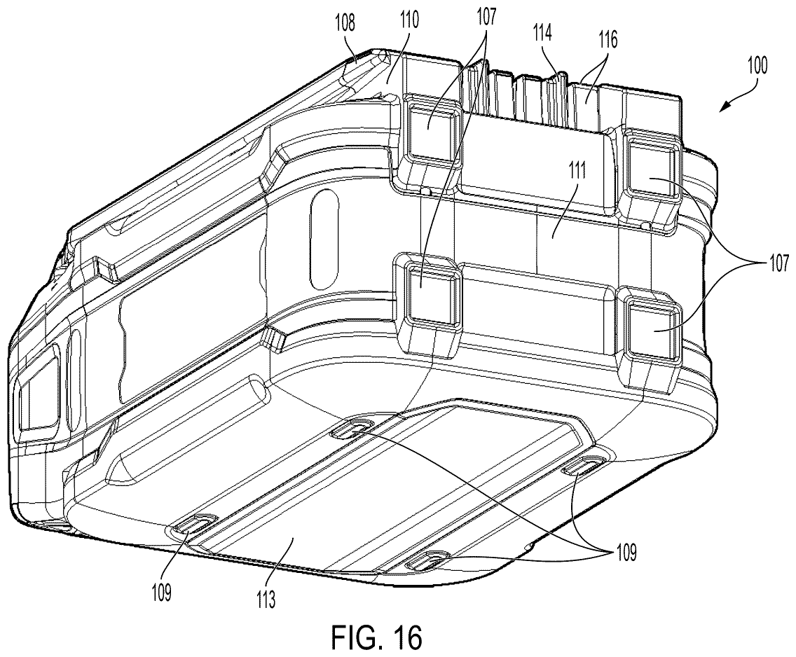

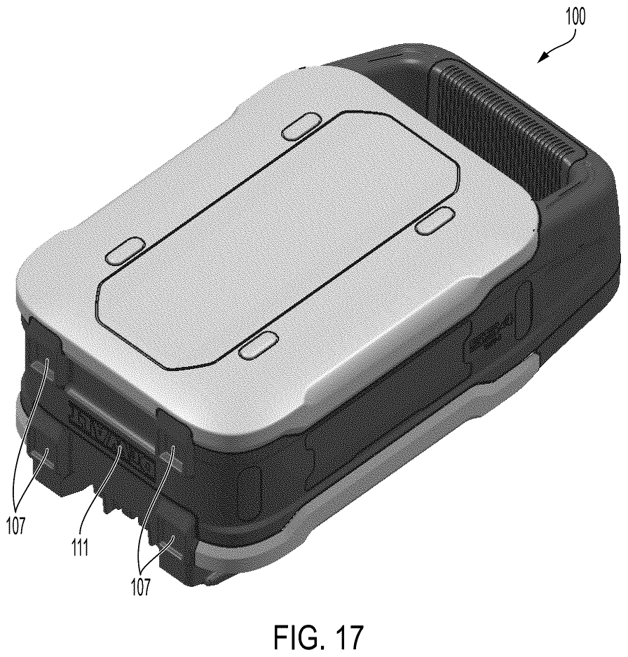

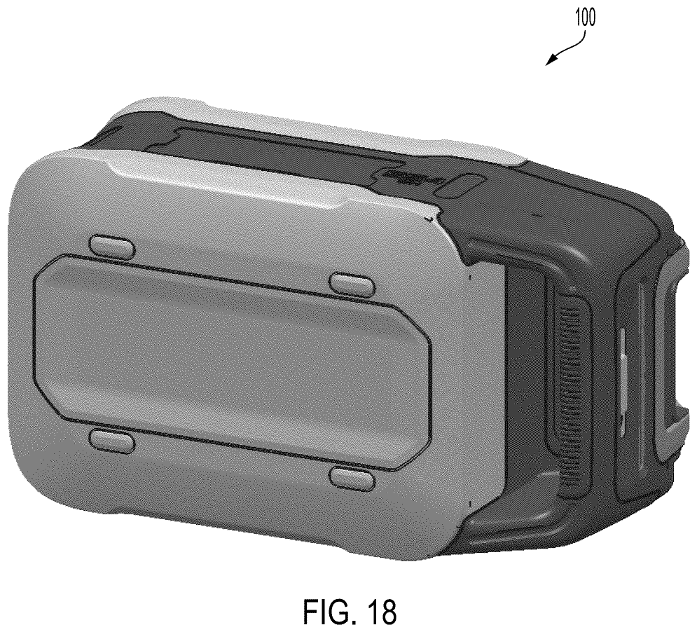

As shown in FIGS. 3-17, the battery pack 100 may include a housing 102. The housing 102 may provide a protective cover for the power source contained within the housing 102, such as one or more rechargeable battery cells, electronics and other components. The housing 102 may include alternate configurations for creating the housing. For example, a top/upper housing portion 103 and a bottom/lower housing portion 105 may be coupled/joined together at a horizontal parting line to form the housing 102. In another embodiment, two (left and right) side portions may be coupled/joined together at a vertical parting line to form the housing 102. The housing 102 may be constructed of plastic or other suitable material for the application. Along with the two sides, the housing 102 may also include a front and a back. Regardless of the structure, the housing 102 forms an interior/internal/inner cavity 104. Other configurations for forming the housing 102 are contemplated and encompassed by the present patent application. The battery pack 100 may include a capacity of 10 Ah and a nominal voltage of 54V.

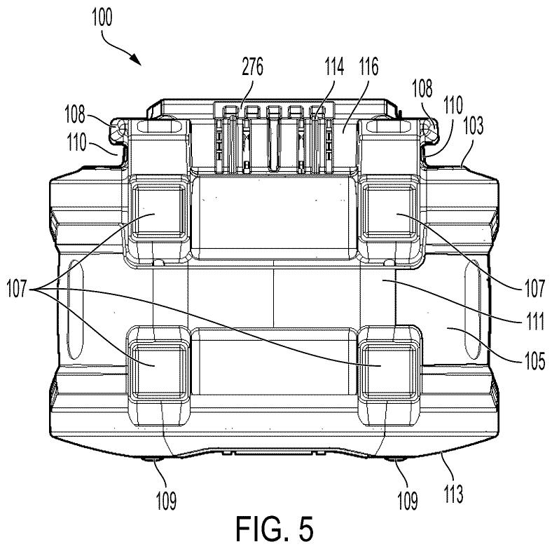

As shown in FIGS. 5-9, 12-13, and 16-17, the battery pack 100 may include a plurality of first feet portions 107 configured to provide stable support for the battery pack 100 on a surface/ground when the battery pack is in a first orientation (e.g., a vertical orientation). The feet portions 107 may extend outwardly away from a side wall/surface 111 of the housing 102 to provide stable support for the battery pack 100 when the battery pack 100 is in the first orientation. As shown in FIGS. 3-6, 8, and 13-14, the battery pack 100 may include a plurality of second feet portions 109 configured to provide stable support for the battery pack 100 on the surface/ground when the battery pack is in a second orientation (e.g., a horizontal orientation). The feet portions 109 may extend outwardly away from a bottom wall/surface 113 of the housing 102 to provide stable support for the battery pack 100 when the battery pack 100 is in the second orientation.

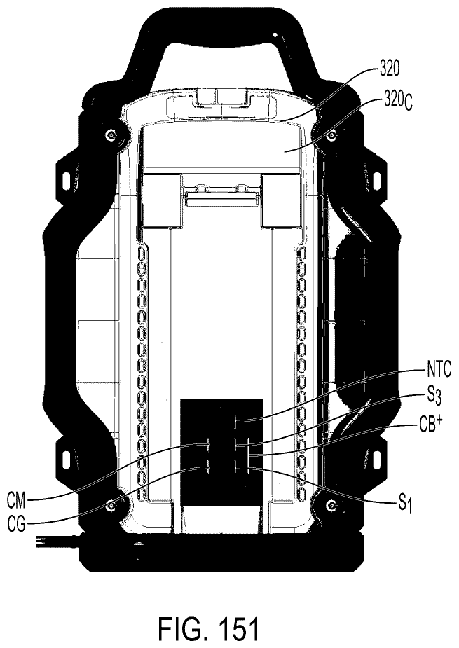

The battery pack 100 may be a rechargeable battery pack. The battery pack 100 may be generally configured to power the power tool. The battery pack 100 may be rechargeable using a battery charger (as shown in FIG. 151) after being used as a power source for the power tool (the battery pack interface of the power tool is shown in FIG. 149). Also, the present disclosure contemplates that other powered devices may be utilized with the disclosed battery pack, interfaces and may be considered other types of power tools. Examples of such powered devices that may be considered power tools can include lights, lasers, dust extractors, radios, speakers, heated garments, etc.

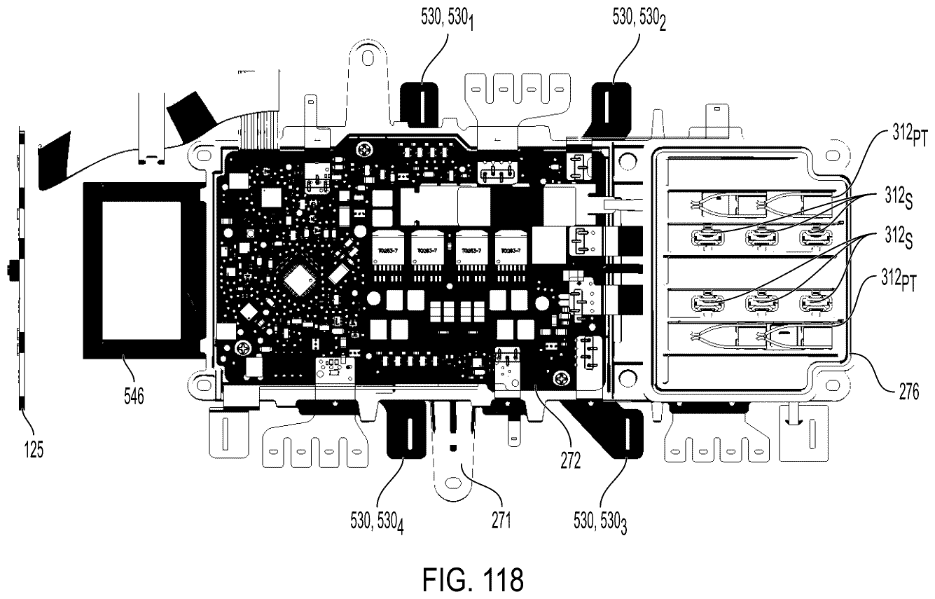

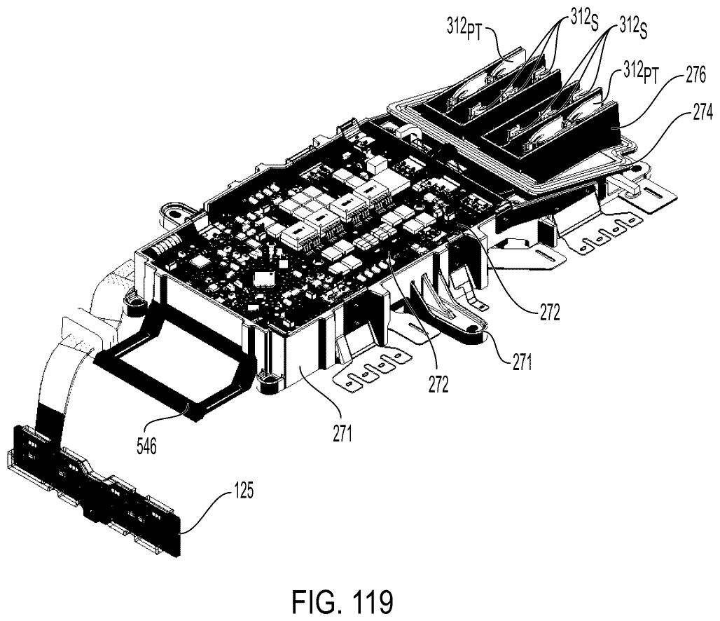

As shown in FIGS. 3, 10-11, and 15, the battery pack 100 may also include a state of charge (SOC) indicator 120 on a surface/side 122 of the housing 102. The SOC indicator 120 may include an activation button 124 and a plurality of LEDs/lights 126. The SOC indicator 120 may include or may be operatively connected to an SOC PCB 125 (as shown in FIGS. 118-119) and other components. As would be appreciated by a person of ordinary skill in the art, the SOC PCB 125 may be connected to a main PCB by a pair of wires.

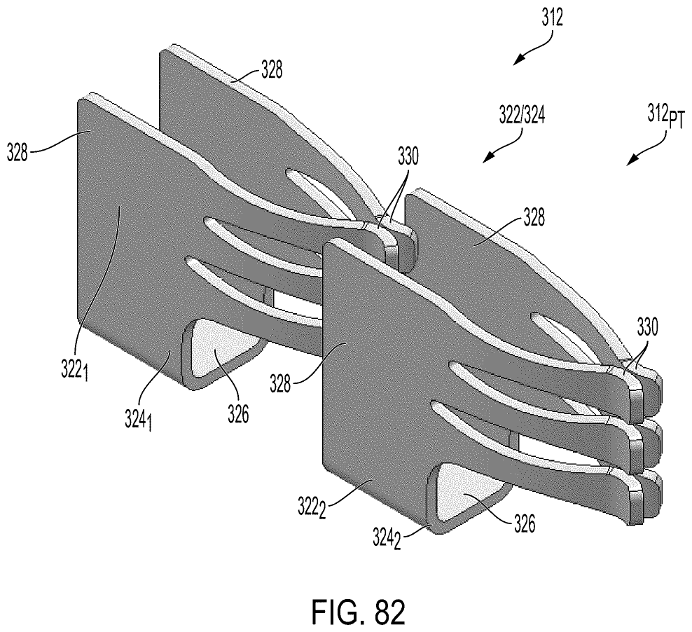

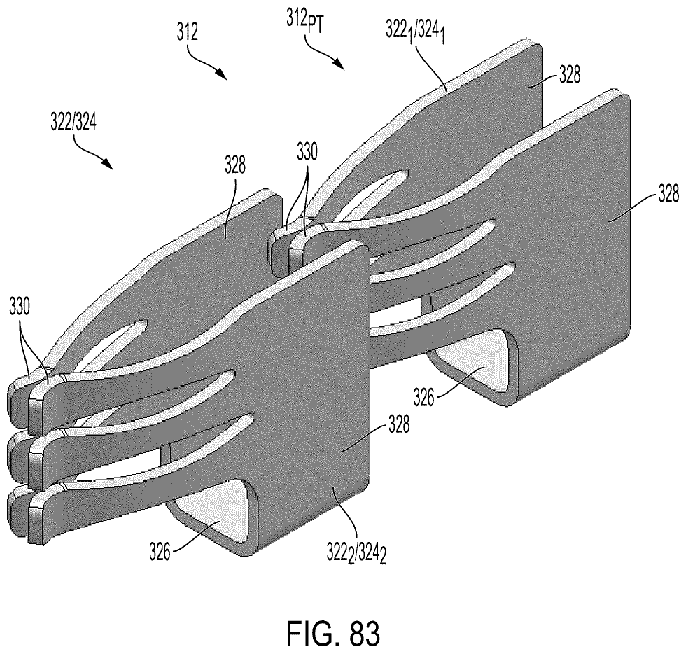

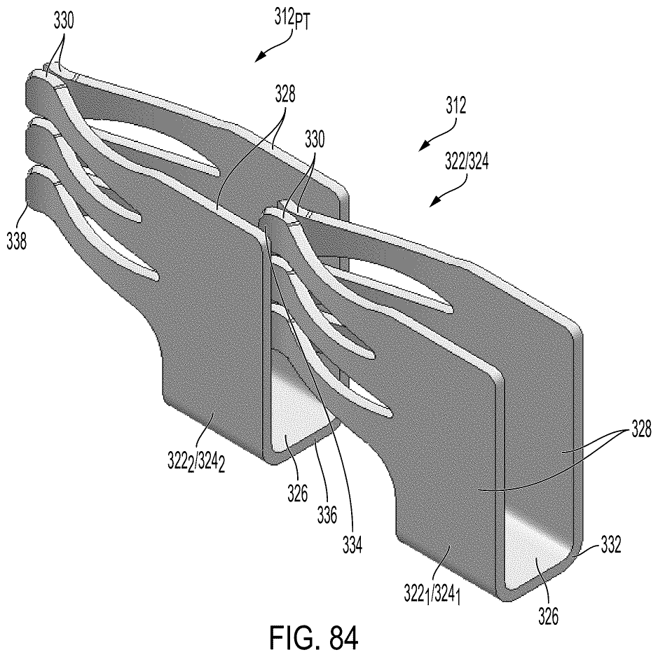

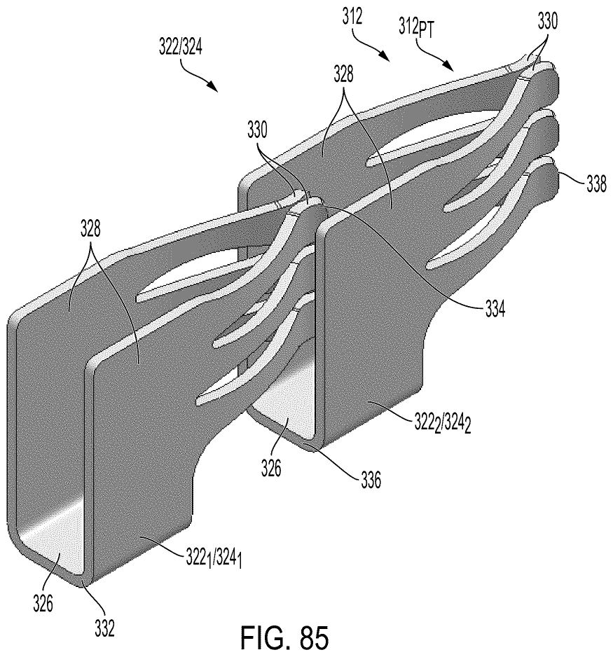

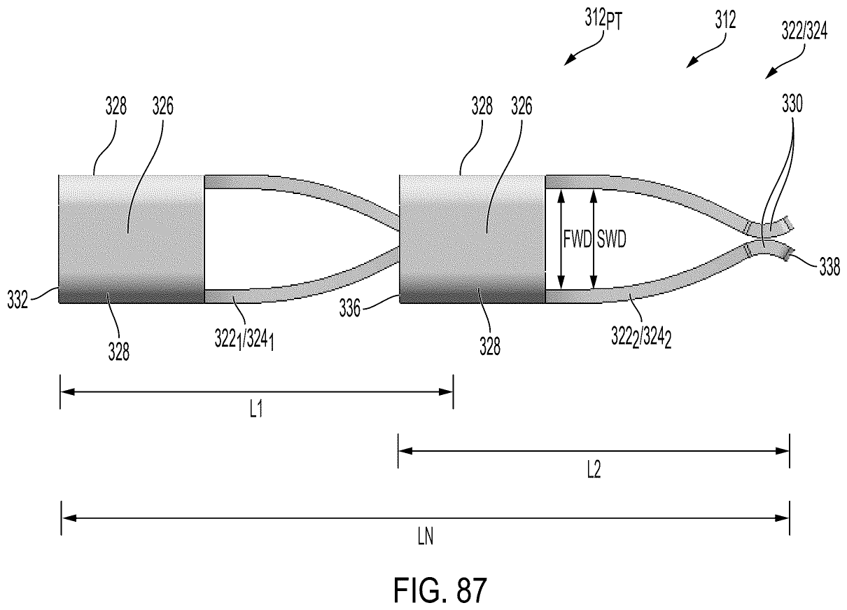

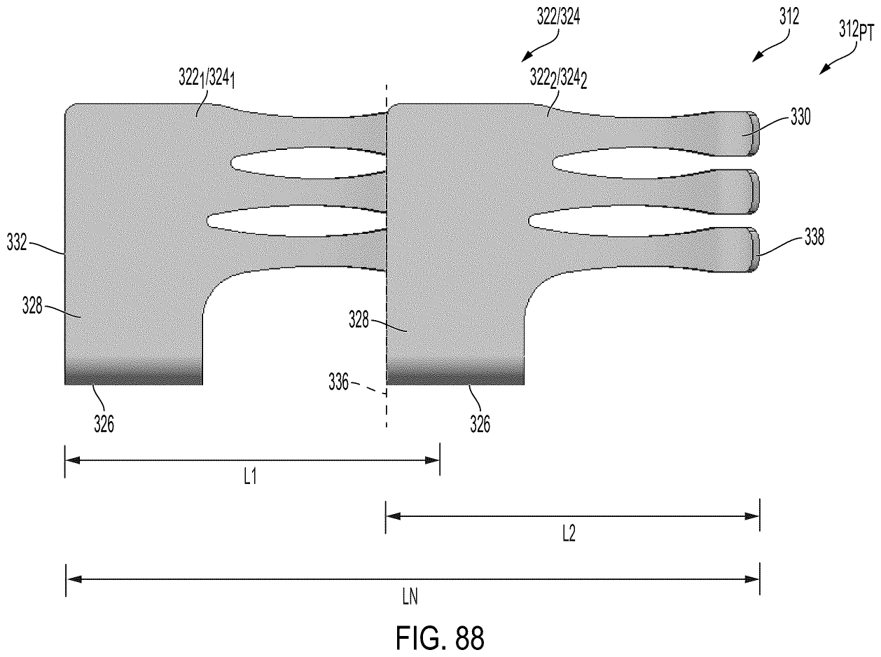

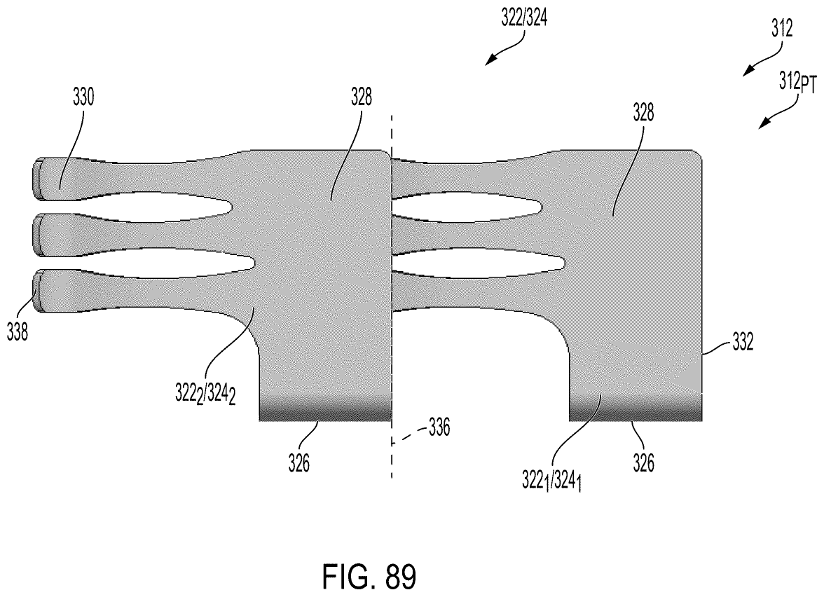

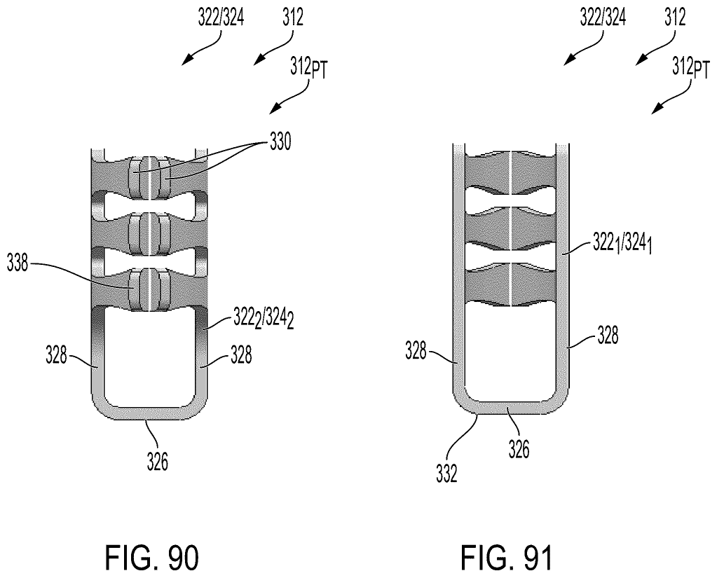

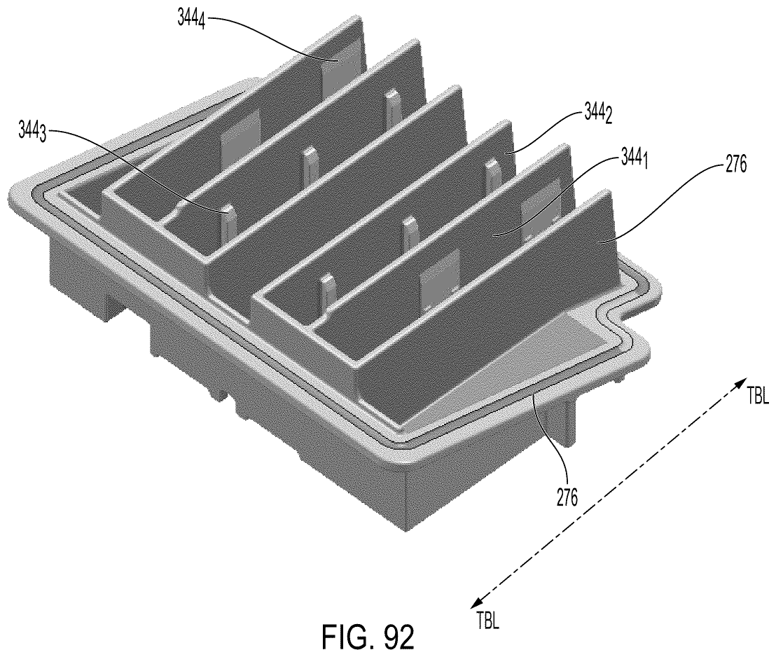

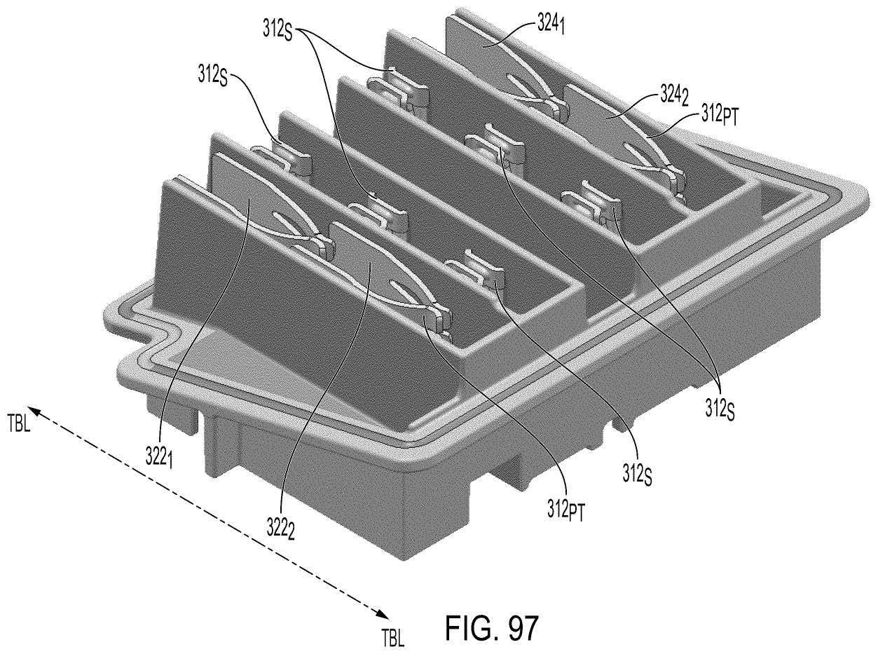

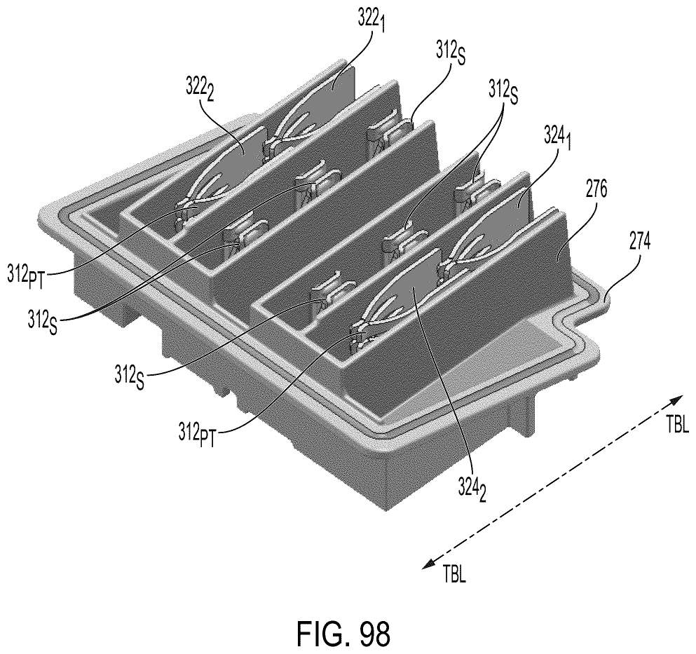

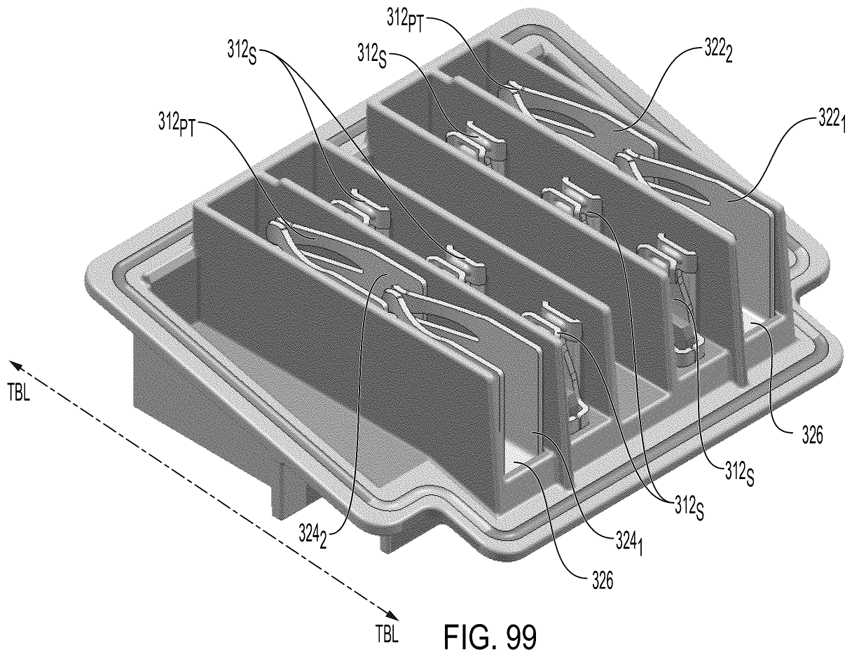

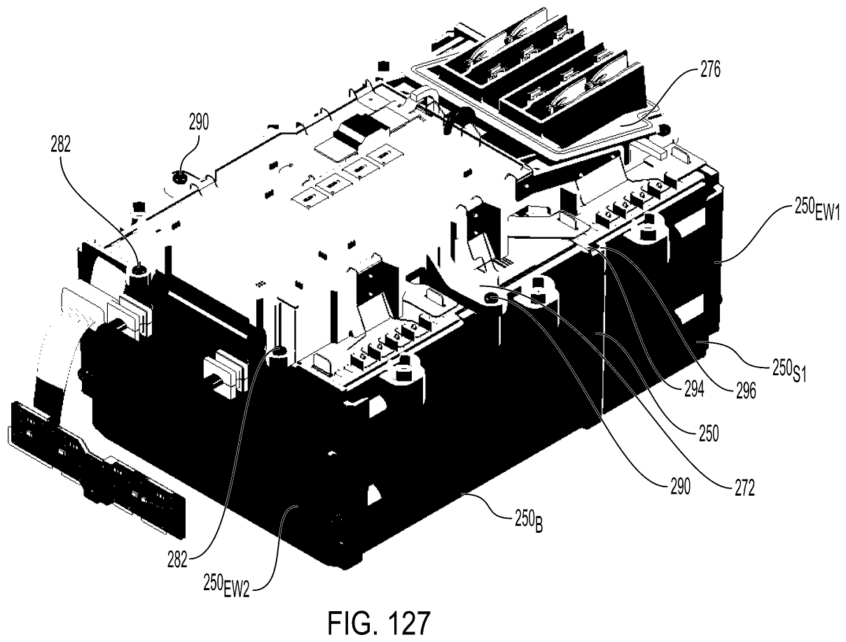

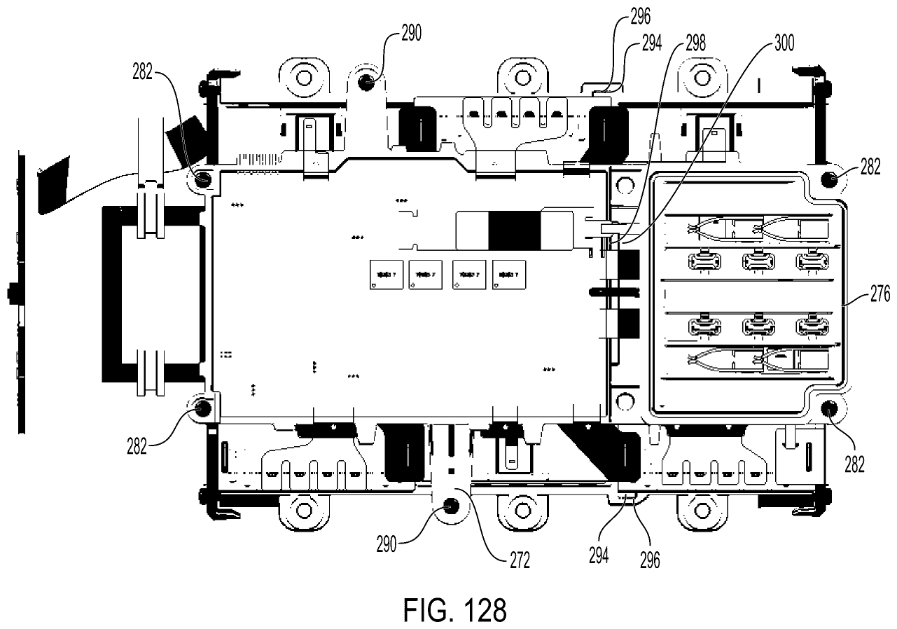

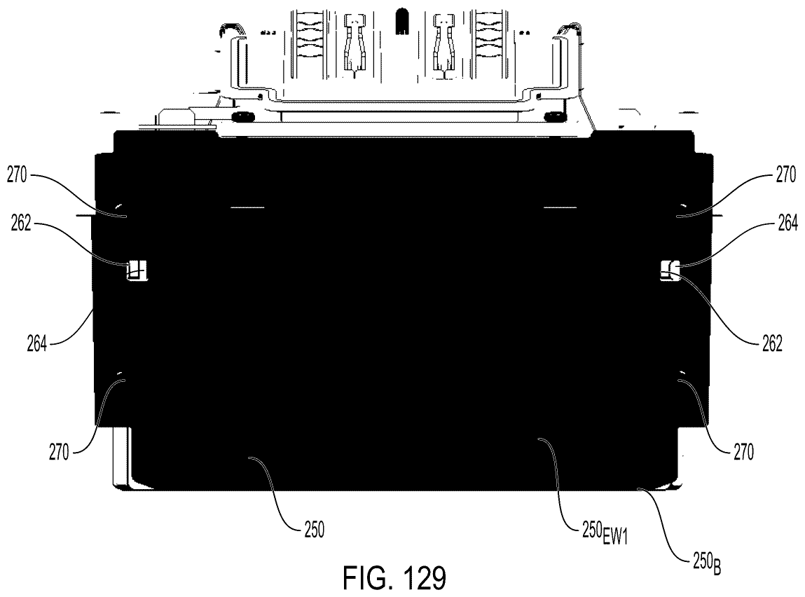

As shown in FIGS. 92-105, the battery pack 100 also includes a battery pack tool terminal block 276 including a terminal block housing 274 and a plurality of battery terminals 312 for transmitting current and signals between the battery pack 100 and the power tool/charger. The housing 102 may also include a plurality of slots 114 in a top portion 116 of the housing 102. The slots 114 may be positioned in other portions of the housing 102. The plurality of slots 114 forms a set of slots 114. The plurality of slots 114 corresponds to and are aligned with the plurality of battery terminals 312. The plurality of battery terminals 312 forms a set of battery terminals 312. The plurality of slots 114 also correspond to a plurality of (power tool or charger) terminals of the electrical device(s). The plurality of electrical device terminals forms a set of electrical device terminals. The electrical device terminals may be received by the battery terminal slots 114 and engage and mate with the battery terminals 312, as will be discussed in more detail below. The terminal block 276 and the battery terminals 312 are described in detail below with respect to, for example, FIGS. 82-129.

Further, the battery pack may be “slide-type” battery pack that is attached/connected by sliding into or onto corresponding engagement portions of the power tool or the charger. For example, the housing 102 of the battery pack 100 may include an interface 106 for mechanically coupling with a corresponding battery pack interface of an electrical device, for example, a HPHVPT or an HVC. In the illustrated example embodiment, the interface 106 may include a rail and groove system including a pair of rails 108 and a pair of grooves 110. The rail and groove system can be configured for a sliding connection of the battery pack 100 with the power tool or the charger. The power tool or the charger may include corresponding rails and grooves to mechanically connect the battery pack 100 and the power tool/charger together. Other types of interfaces are contemplated and encompassed by the present patent application. The structure of the battery pack connection to the power tool or the charger is not particularly limited and a wide variety of battery pack connection mechanisms known in the art also may be advantageously utilized with the present teachings.

The interface 106 of the battery pack 100 may also include a latch system 700 for fixing the battery pack 100 to the electrical device. The latch system 700 and/or the rail and groove system (including the pair of rails 108 and the pair of grooves 110) may form a connection mechanism that is configured for physically/mechanically coupling the battery pack 100 to the power tool or the charger.

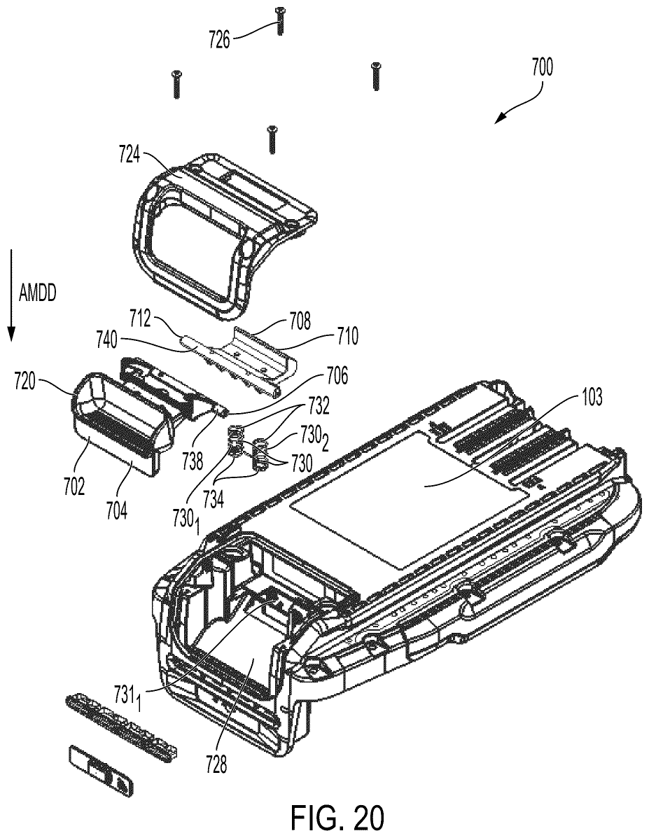

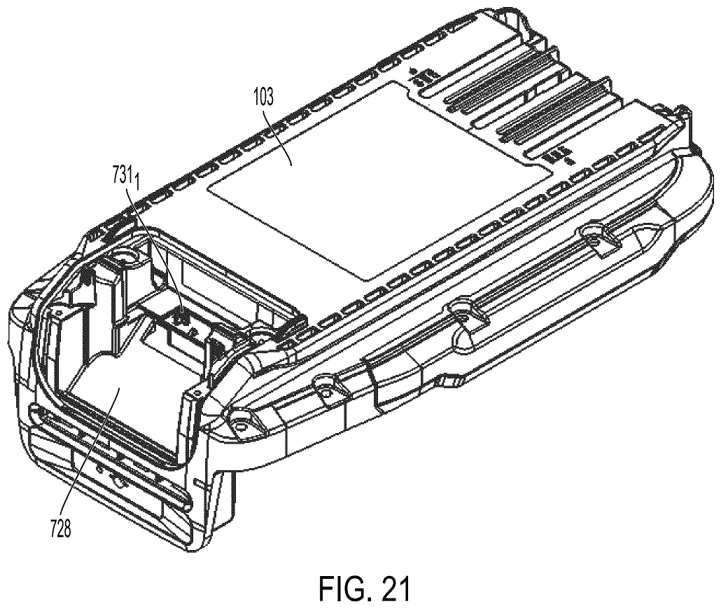

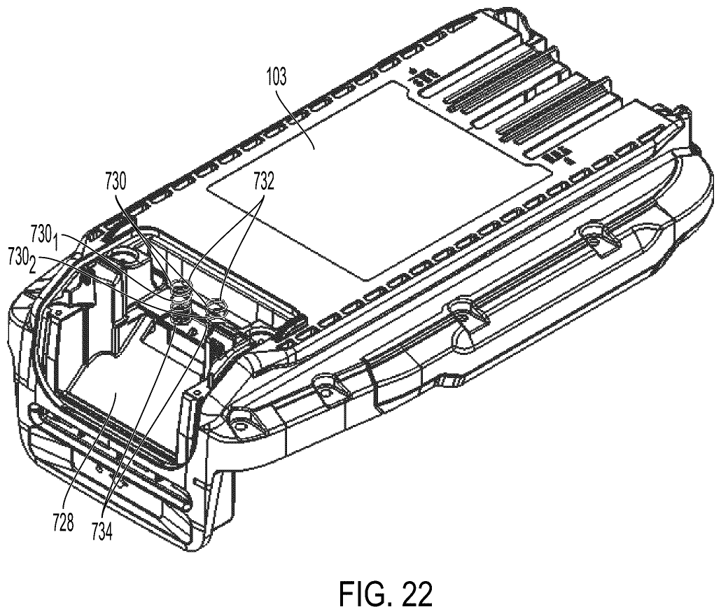

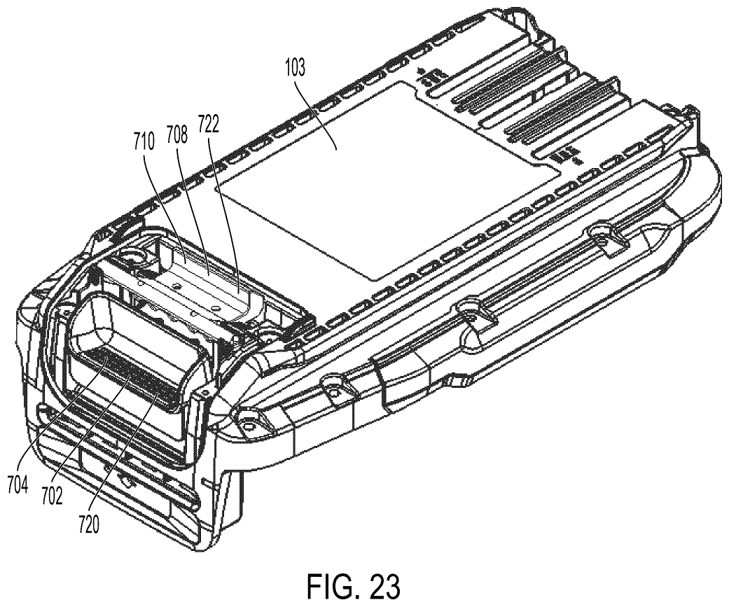

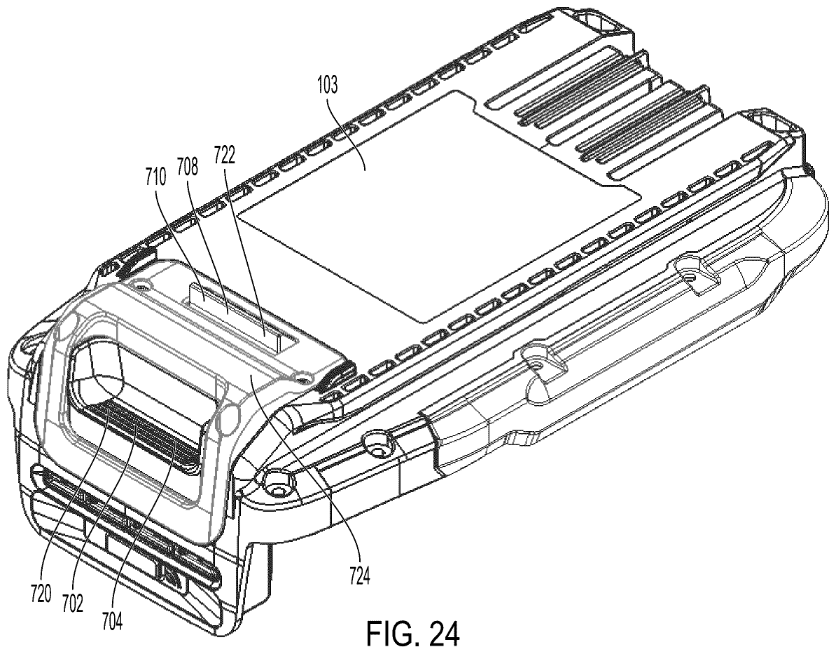

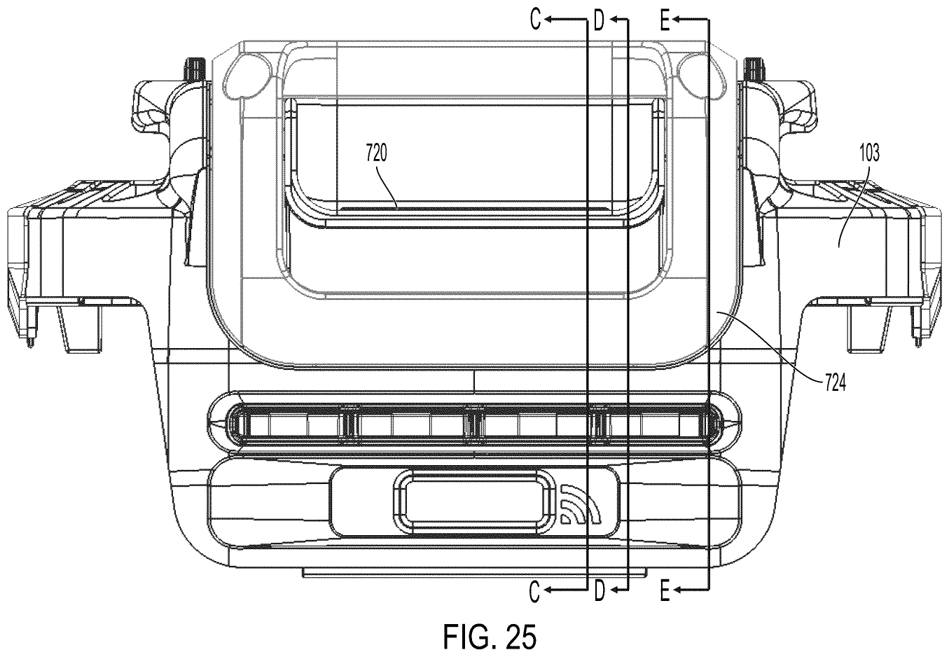

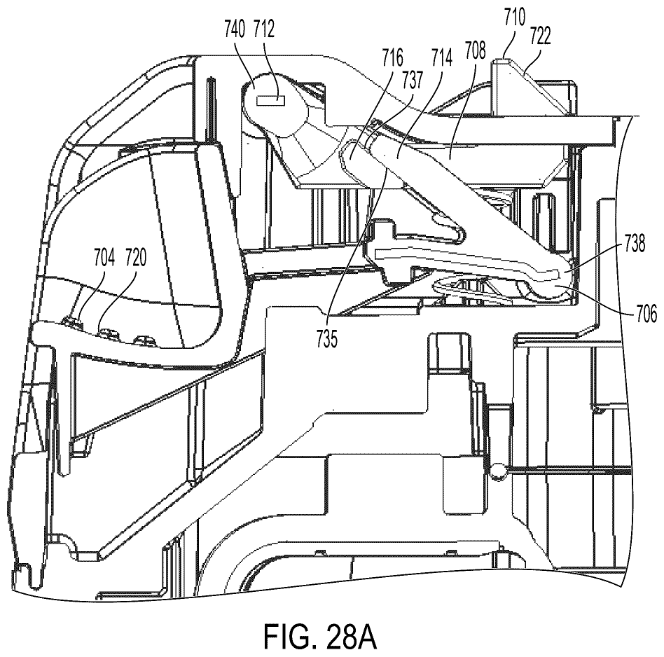

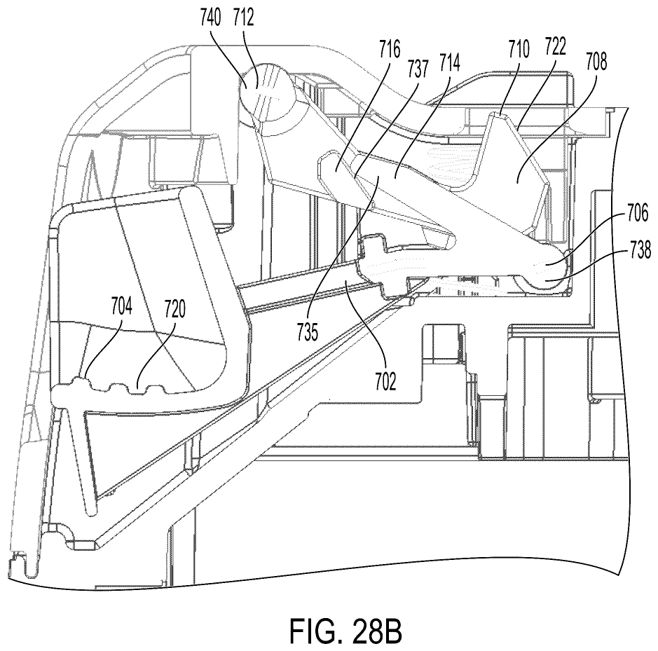

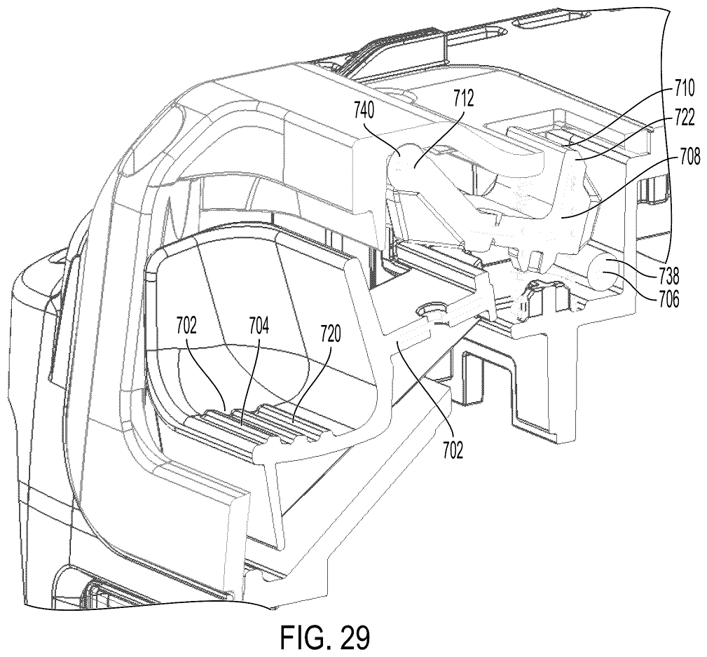

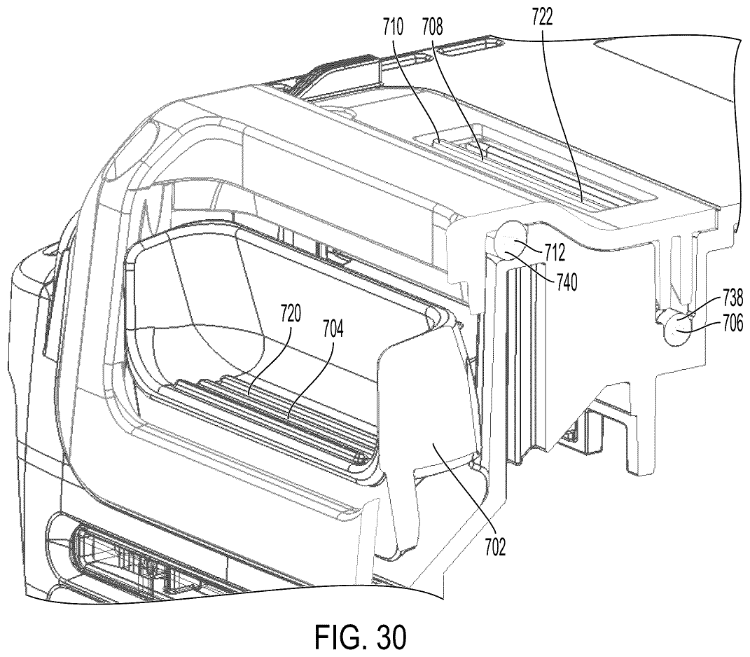

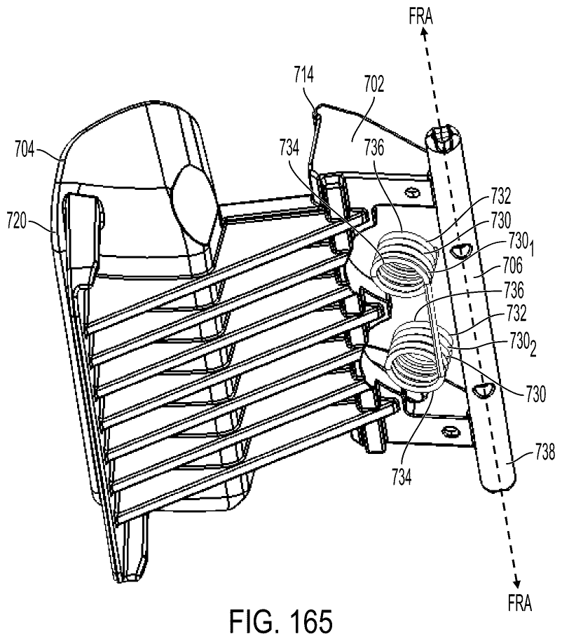

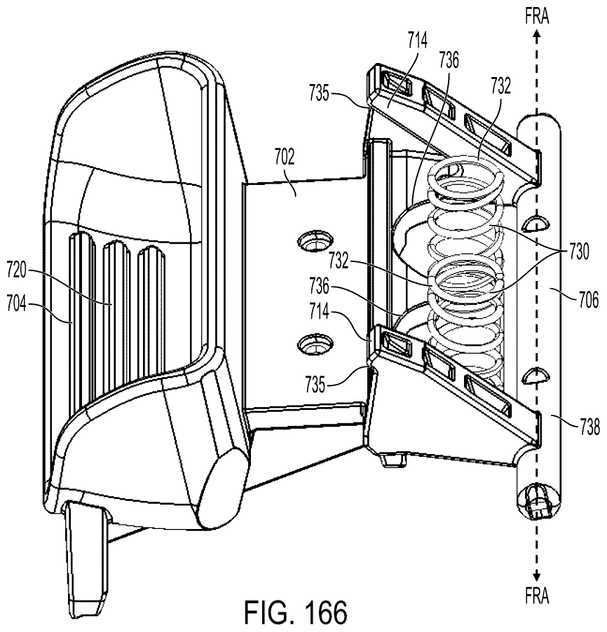

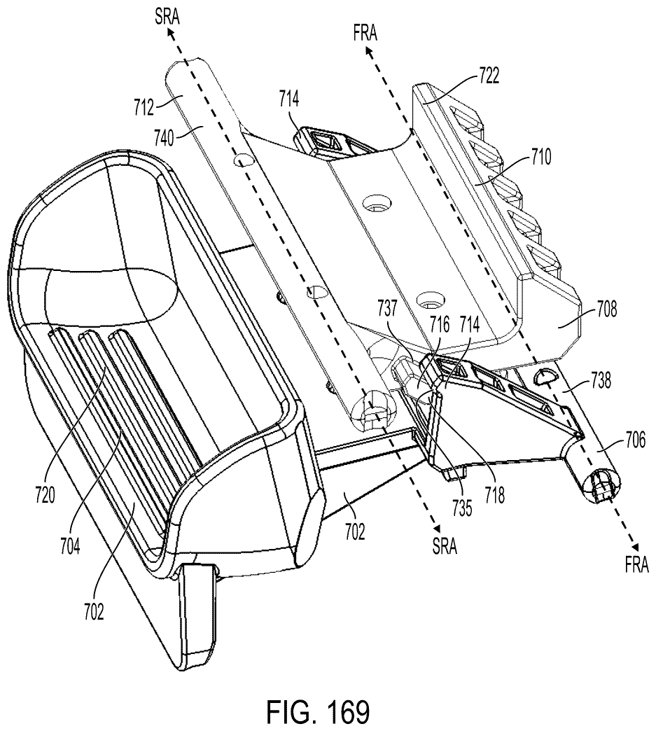

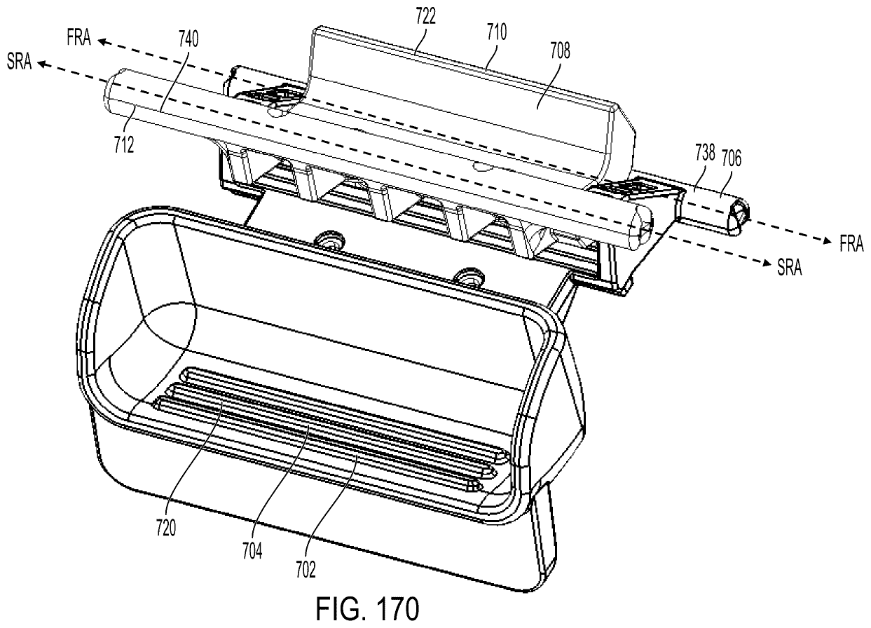

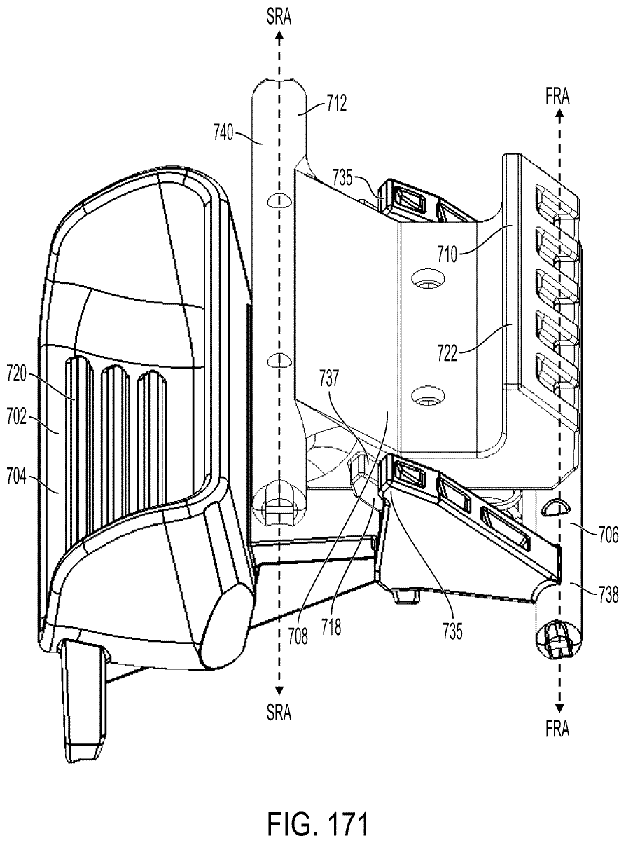

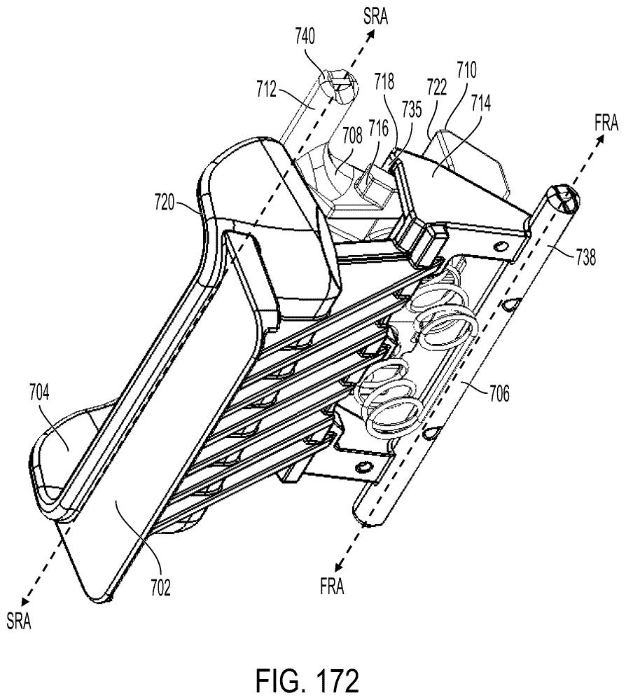

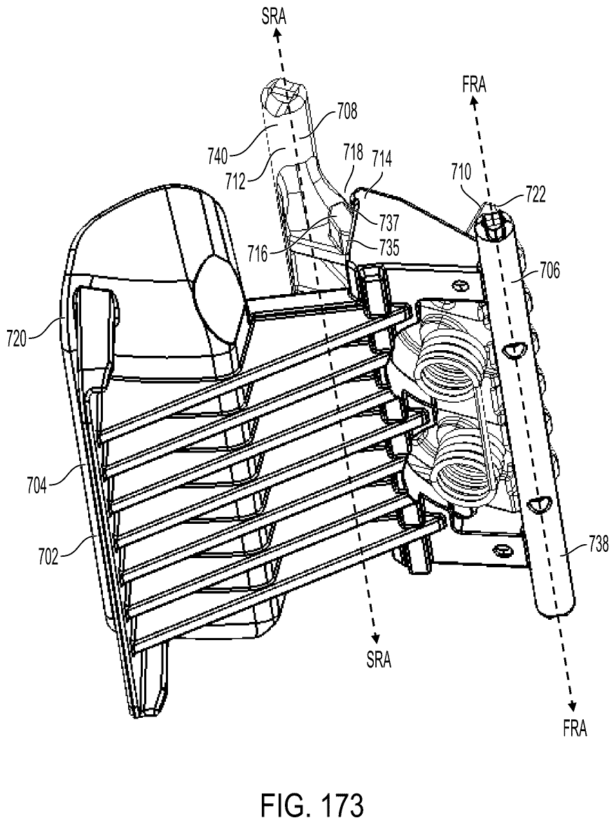

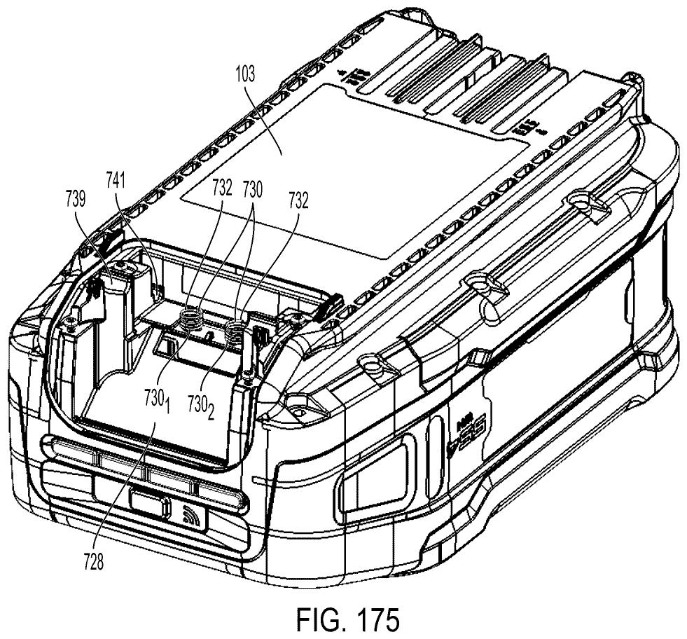

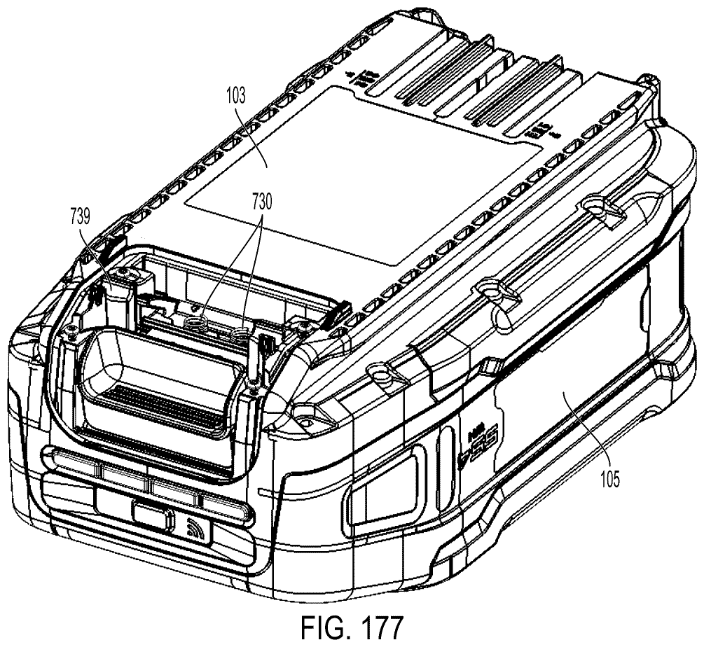

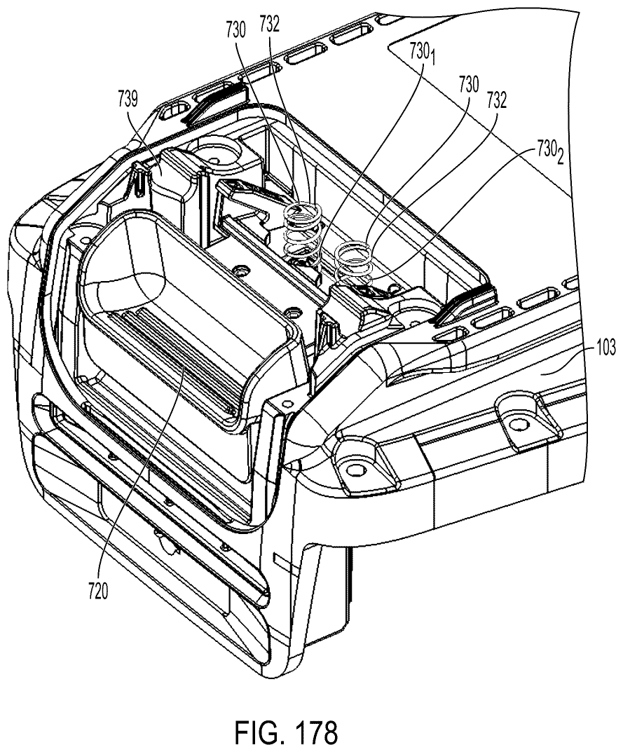

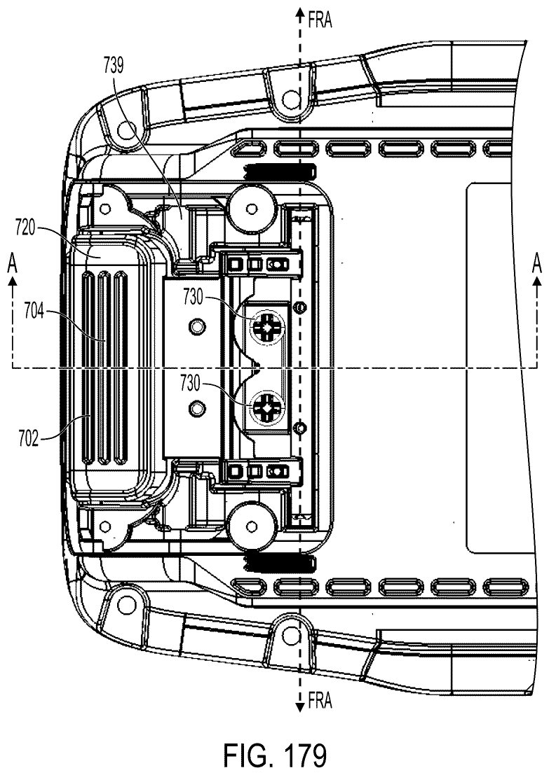

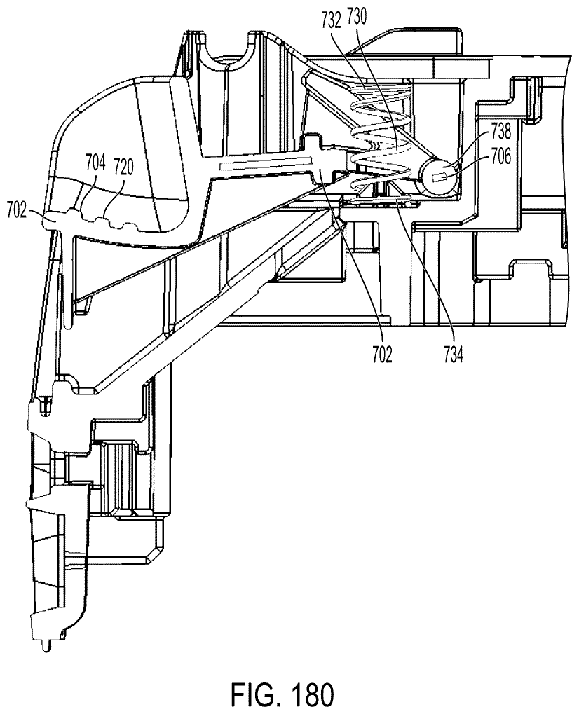

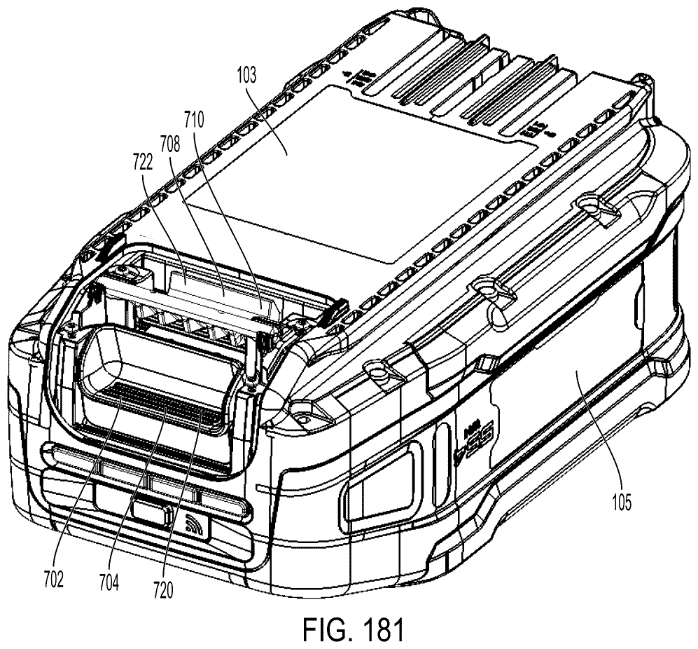

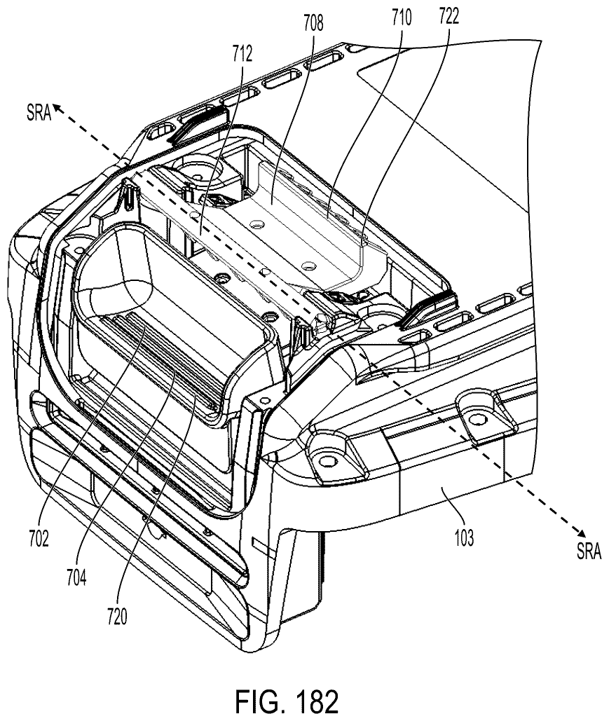

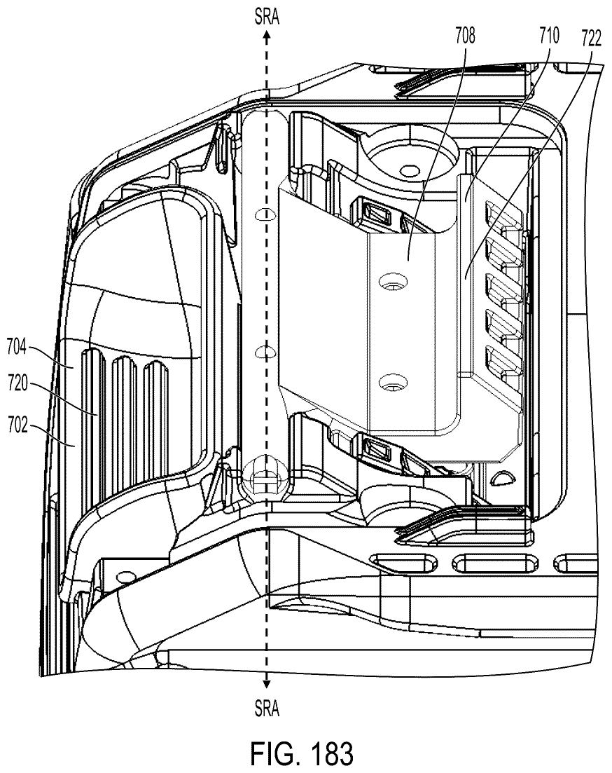

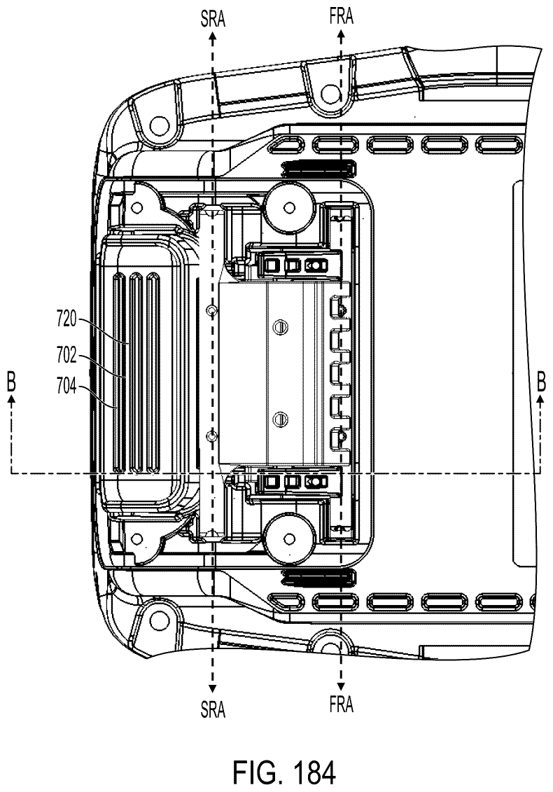

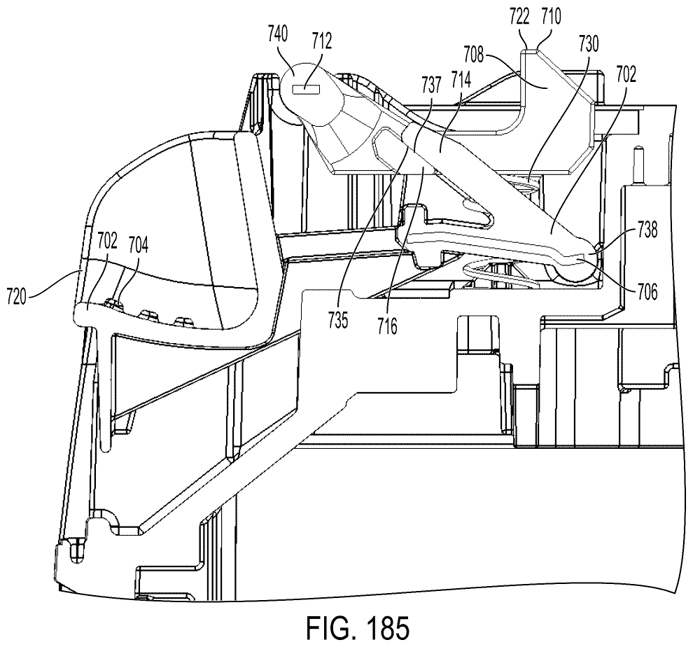

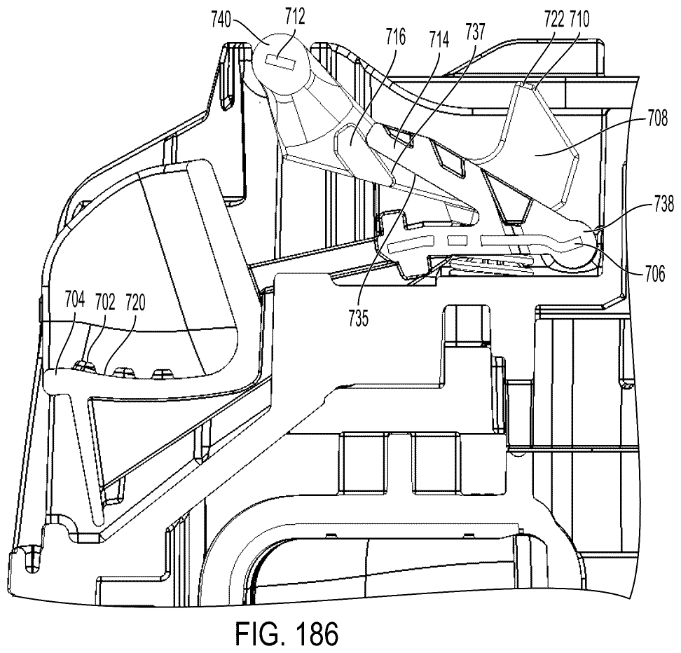

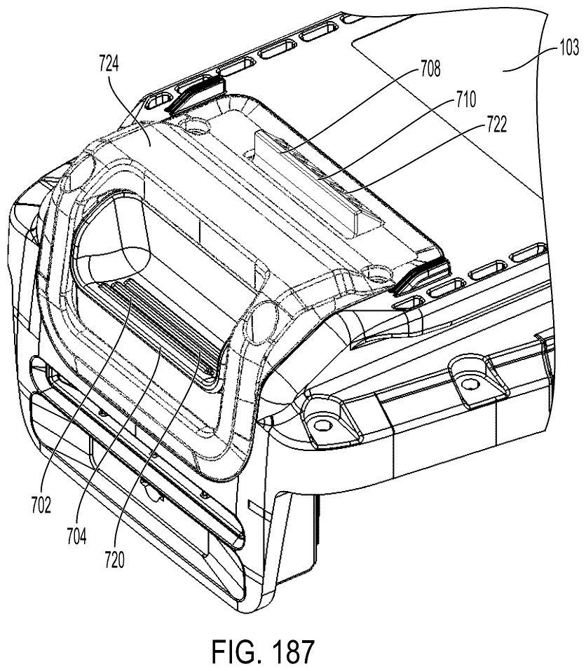

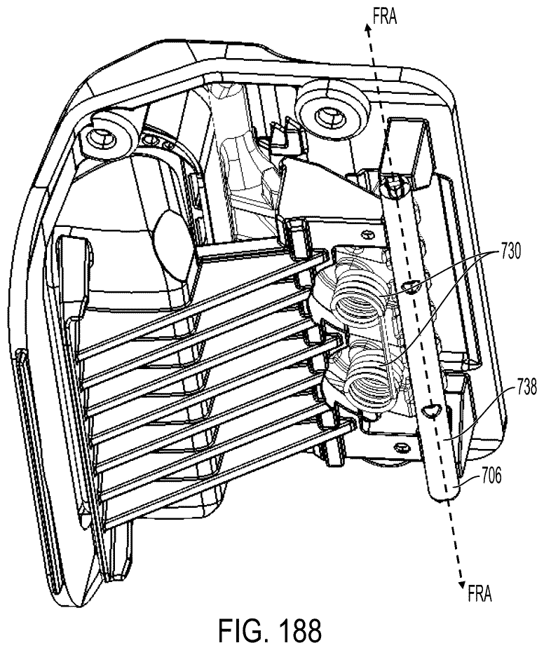

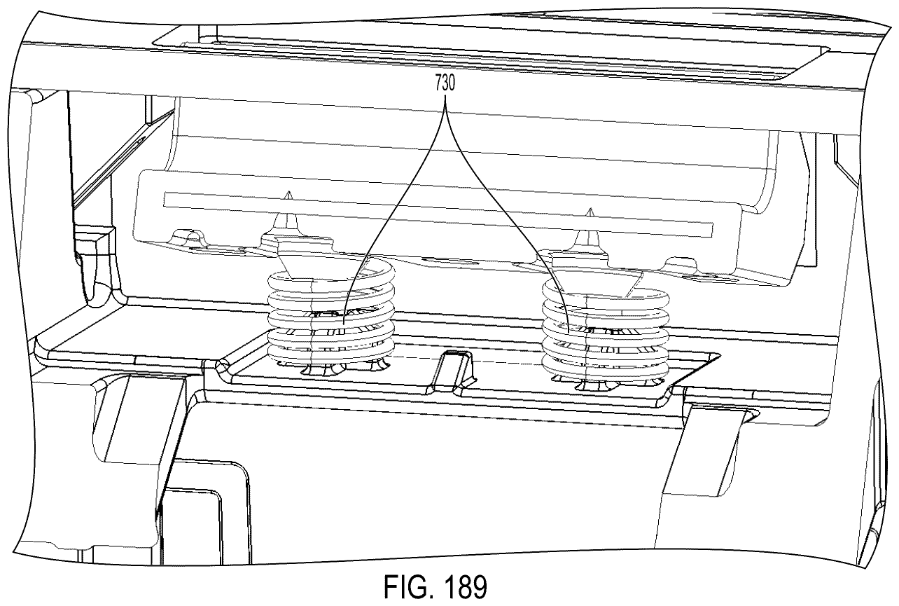

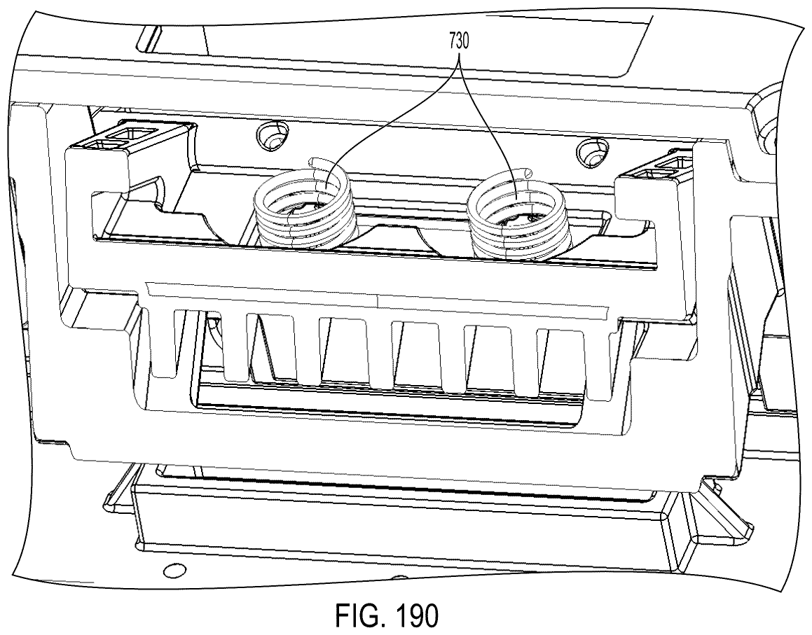

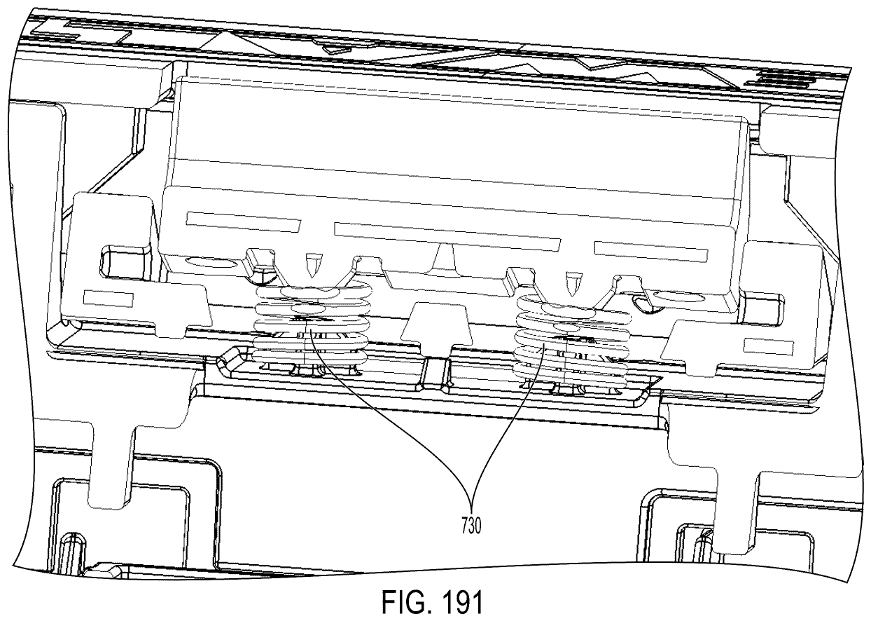

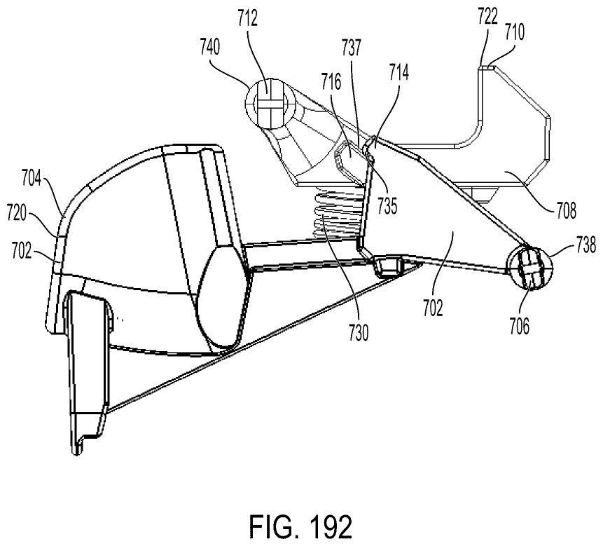

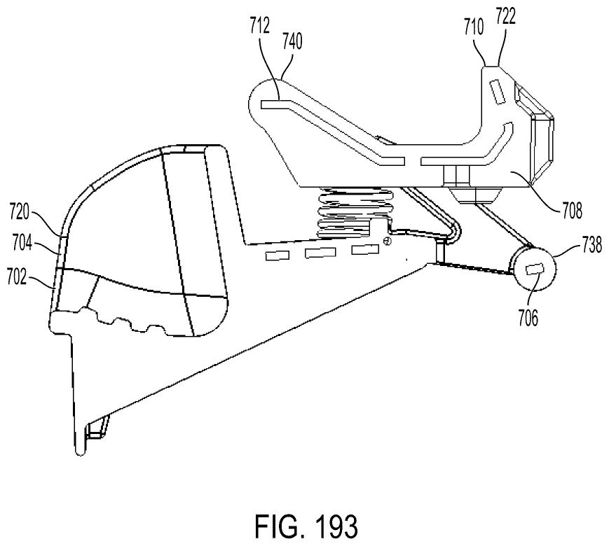

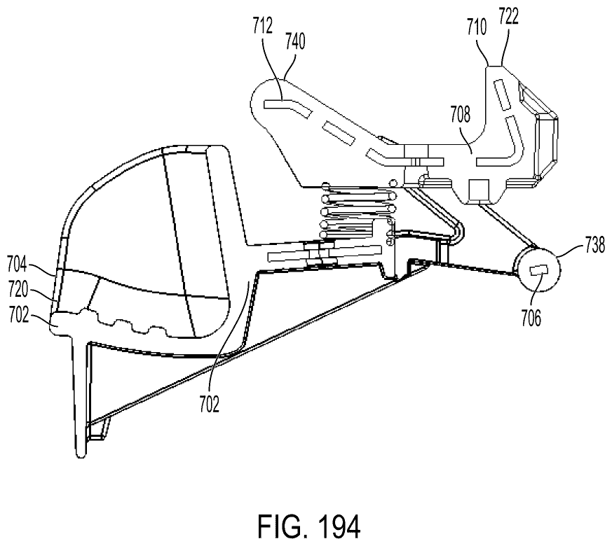

Referring to FIGS. 20-30 and 162-194, the latching system 700 of the battery pack 100 may be configured for latching the battery pack 100 to the electrical device upon mating the battery pack 100 to the electrical device along a mating direction. As noted above, the electrical device may be a power tool. The electrical device may be a charger. The latch system 700 may include a spring loaded latch.

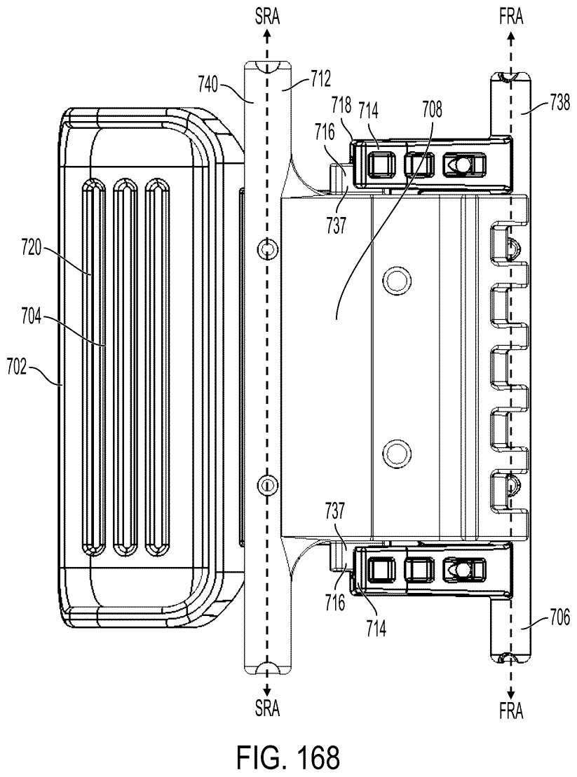

The latching system 700 may include a first component 702 with a first end 704 for user engagement and a second end 706 for rotation about a first rotation axis FRA-FRA. The latching system 700 may include a second component 708 with a first end 710 for engagement with portions of the electrical device and a second end 712 for rotation about a second rotation axis SRA-SRA. The second rotation axis SRA-SRA is generally parallel to the first rotation axis FRA-FRA as shown in FIGS. 168-173. The first component 702 may pivot about the first rotation axis FRA-FRA. The second component 708 may pivot about the second rotation axis SRA-SRA. The portions of the electrical device may include a latch engaging portions/catch as would be appreciated by a person of ordinary skill in the art.

The latch system 700 may also include a portion (e.g., user actuation member) 720 for receiving a user's finger to depress the first component 702 of the latch system 700 and a latch 722 (e.g., engaging portion) that may be received by the power tool or by the charger to maintain the battery pack 100 fixed to the power tool or the charger.

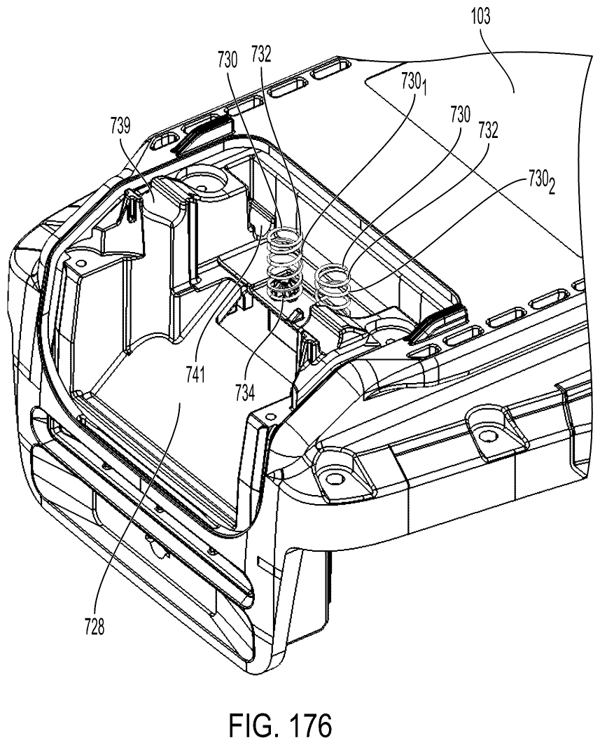

The first component 702 may include a pivot member 738 at the second end 706 and the user actuation element 720 at the first end 704. The second component 708 may include a pivot member 740 at the second end 712 and the latching element/latch 722 at the first end 710. As shown in FIG. 176, the pivot member 738 may be configured to be supported by portions 741 of the upper housing 103 of the battery pack 100 as the first component 702 is pivoted about the first rotation axis FRA-FRA. The pivot member 740 may be configured to be supported by portions 739 of the upper housing 103 of the battery pack 100 as the second component 708 is pivoted about the second rotation axis SRA-SRA. The support portions 739 and 741 may be disposed in a latch receiving cavity 728 of the upper housing 103 of the battery pack 100 and may be integrally formed with the upper housing 103 of the battery pack 100.

The latch system 700 may include a multi-/two-piece latch system having the first component 702 and the second component 708. The multi-part latch may be configured to be operable to mate and unmate the battery pack housing 102 from the power tool/the charger. As will be clear from the discussions in detail below, the first component 702 and the second component 708 may be configured to engage with each other. The first component 702 and the second component 708 may be referred to as a first latch portion and a second latch portion, respectively.

The latching system 700 may be referred to as a latch system or battery pack latching system. The first component 702 may also be referred to as user actuation element/user actuator. The second component 708 may also be referred to as a latching element/latch. The second rotation axis SRA-SRA may be referred to as a latching element/latch rotational axis. The first rotational axis FRA-FRA may be referred to as user actuation element/user actuator rotational axis.

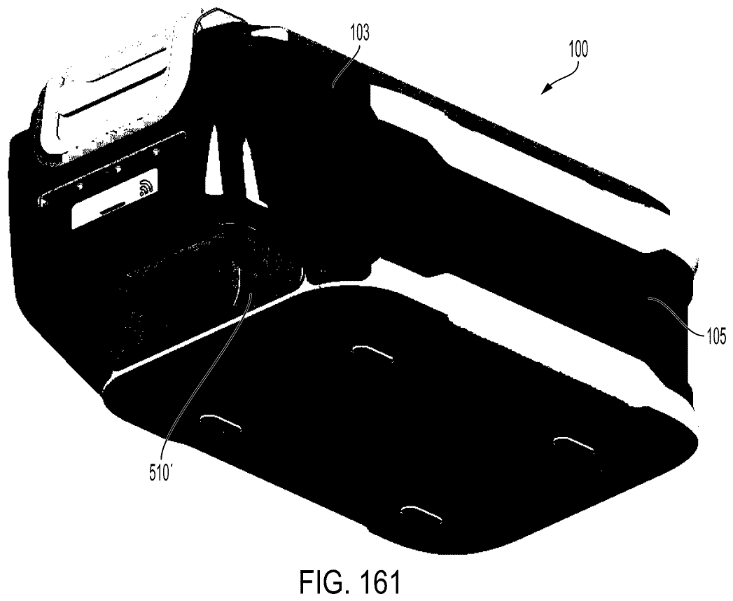

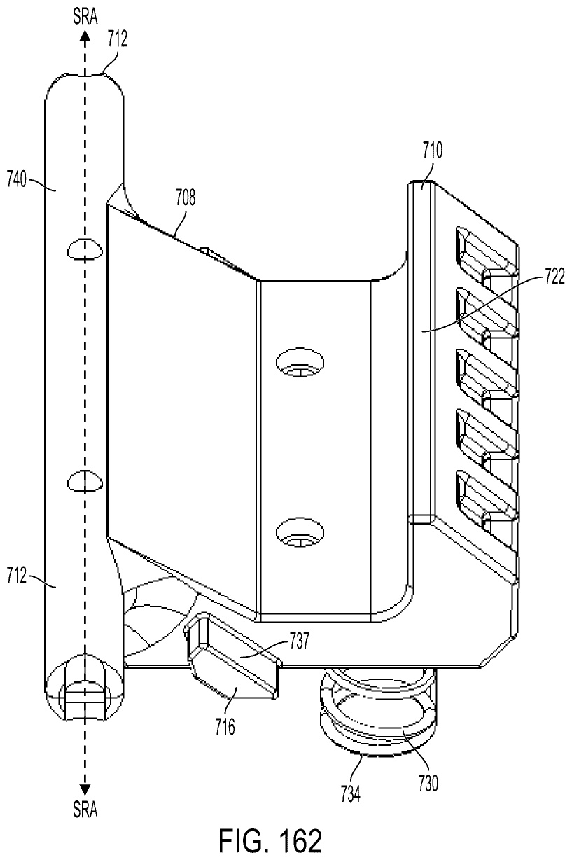

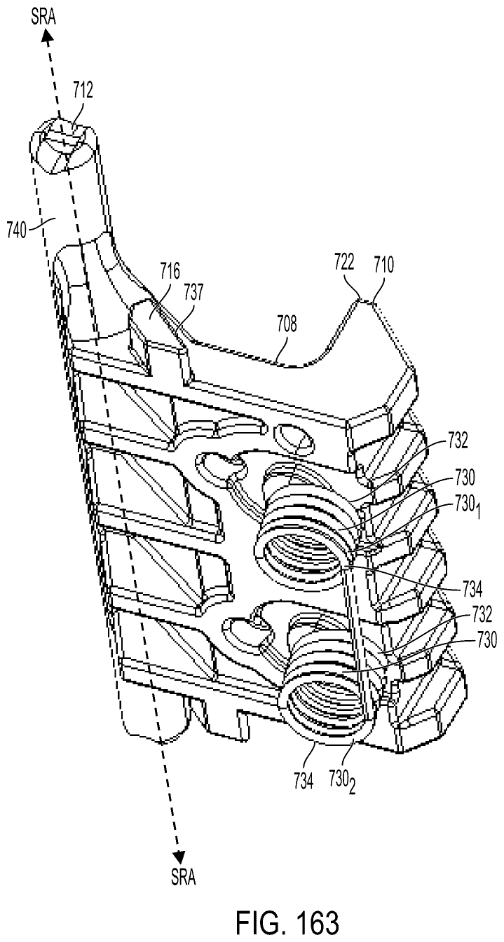

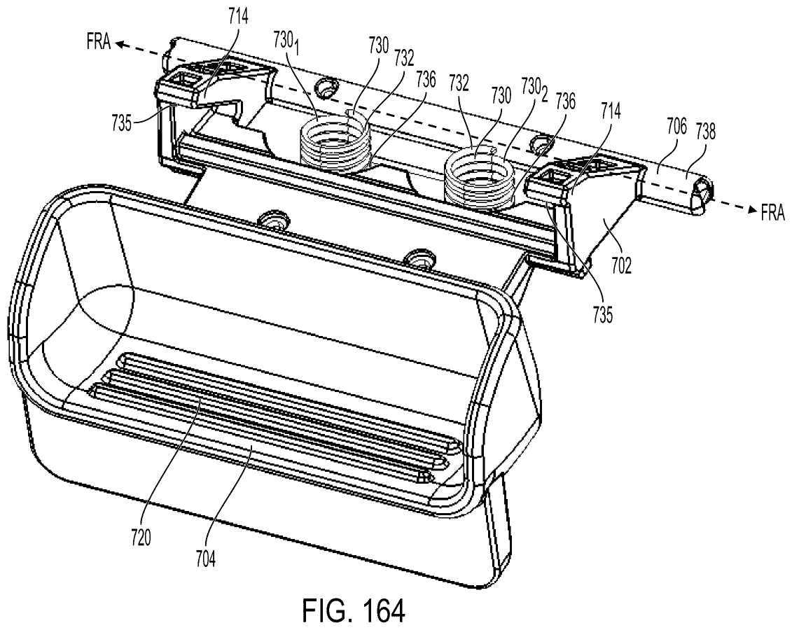

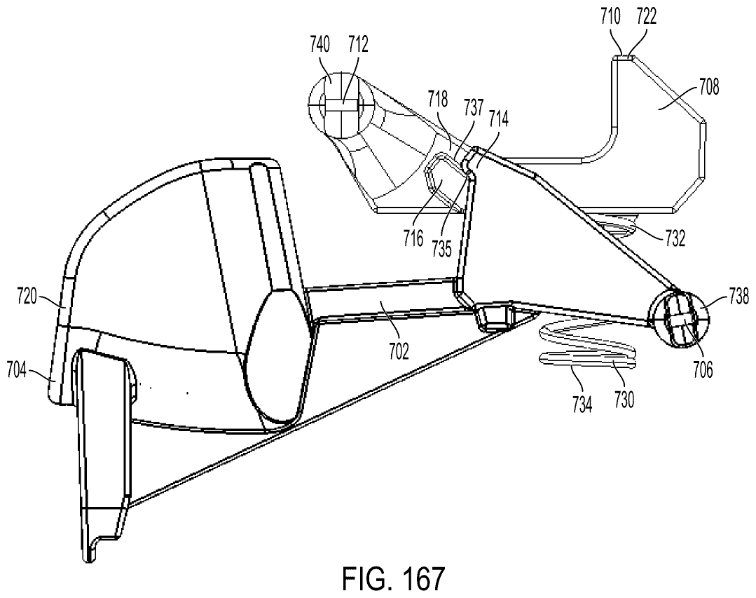

As shown in FIGS. 164-166, the first component 702 may include at least one shoulder 714 between the first end 704 and the second end 706 of the first component 702. As shown in FIGS. 162-163, the second component 708 may include at least one shoulder 716 between the first end 710 and the second end 712 of the second component 708. As shown in FIGS. 167-173, the first component shoulder 714 may be positioned to engage the second component shoulder 716 upon rotation of the first component 702 about the first rotation axis FRA-FRA forcing the second component 708 to rotate about the second rotation axis SRA-SRA.

The first component 702 may include the user actuation element 720 for user engagement. The second component 708 may include the latching element 722 configured to engage with the portions of the electrical device. The first end 710 of the second component 708 may include a latching element latching end 710 and the second end 712 of the second component 708 may include a latching element rotating end 712. The first end 704 of the first component 702 includes a user actuation element user end 704 and the second end 706 of the first component 702 includes a user actuation element rotating end 706.

As shown in FIGS. 167-173, the first component shoulder 714 engages the second component shoulder 716 in an area 718, the latching element rotating end 712 and the latching element latching end 710 are on opposite sides of a plane that is generally perpendicular to the mating direction and passes through the area 718. The latching element rotating end 712 may also be referred to as the second end 712 of the second component 708. Also, as shown in FIGS. 167-173, the first component shoulder 714 engages the second component shoulder 716 in the area 718.

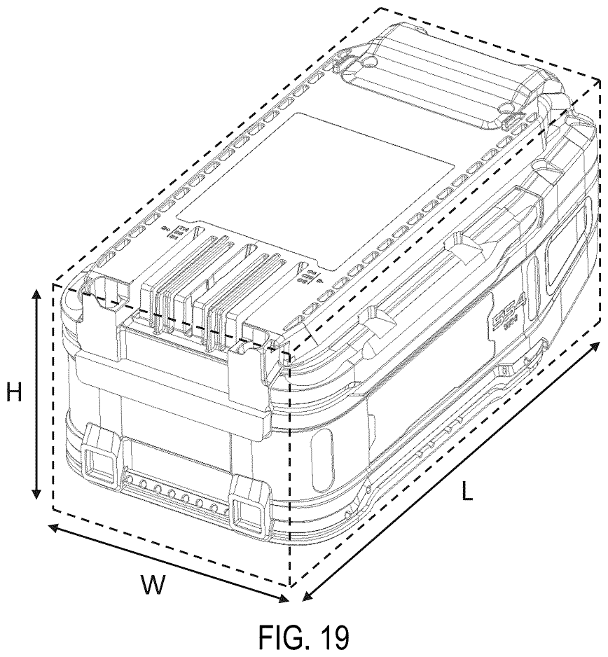

The latch system 700 also may include a cover/latch cover 724. The latch cover 724 is shown in FIGS. 19 and 23-25 and 187. The latch cover 724 may be connected to the upper housing member 103 (e.g., using mechanical fasteners 726) of the battery pack 100. The latch cover 724 may be configured to cover/enclose portions of the first component 702, portions of the second component 708, and other portions (e.g., spring system 730 that will be explained in detail below) of the latch system 700.

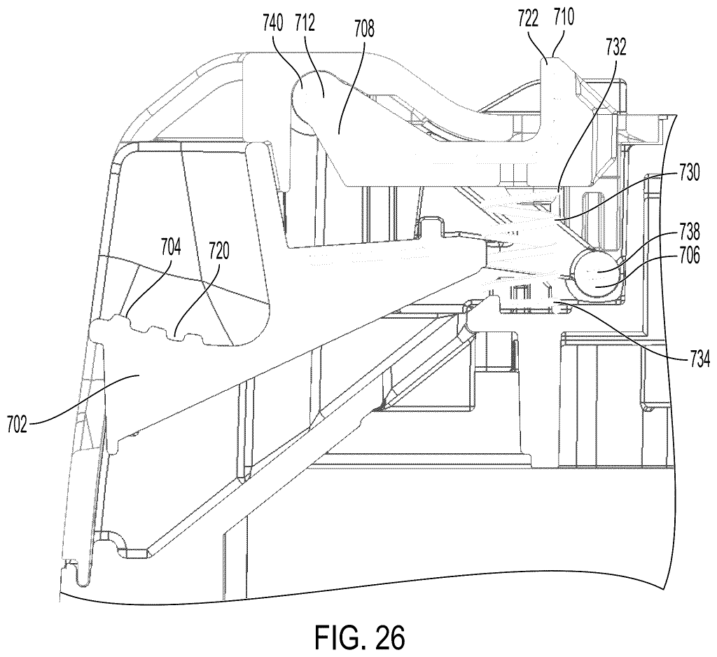

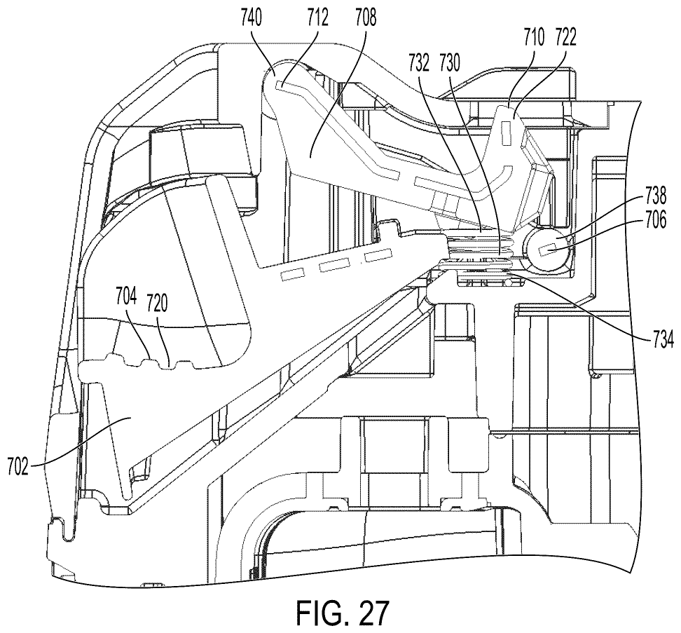

Referring to FIGS. 20-22, the latching system 700 may further comprise the spring assembly 730. The spring assembly 730 may have a first end 732 and a second end 734. The first end 732 of the spring assembly 730 may be configured to be operatively connected to the second component 708 of the latch system 700 and the second end 734 of the spring assembly 730 may be configured to be operatively connected to the housing 102 (e.g., the upper housing 103) of the battery pack 100. The spring assembly 730 may be configured to bias the second component 708 away from the housing 102 (e.g., the upper housing 103). Referring to FIG. 26, when the latching system 700 is in its unlatched configuration/position, the spring assembly 730 may be in its compressed configuration. Referring to FIG. 27, when the latching system 700 is in its latched configuration/position, the spring assembly 730 may be in its expanded configuration.

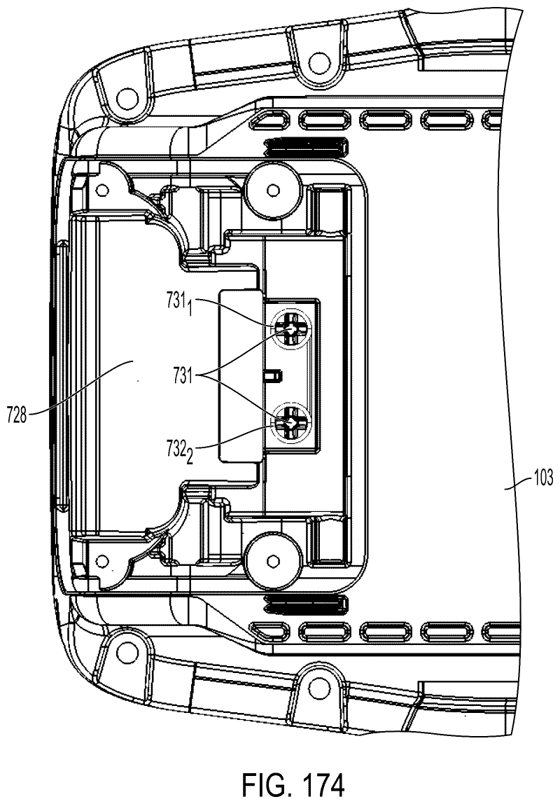

The spring assembly 730 may include two springs 730₁ and 730₂ in the illustrated embodiment. The number of springs may vary. The springs 730₁ and 730₂ may be disposed on a surface of the second component 708. The springs 730₁ and 730₂ may be disposed between the second component 708 and an inside surface of a top of the housing 102. The springs 730₁ and 730₂ may be connected to each other so they can operate simultaneously. The springs 730₁ and 730₂ may be disposed between spring supports 731₁ and 731₂ (as shown in FIG. 174) and a bottom surface of a portion of the second component 708. As shown in FIGS. 26-27 and 164-166, the springs 730₁ and 730₂ may be configured to pass through openings 736 in the first component 702 so as to engage with the bottom surface of the portion of the second component 708.

The first component 702 may be operatively associated with the actuation member 720 such the movement of the actuation member 720 causes the movement of the first component 702. When the actuation member 720 is depressed downwardly in the direction of an arrow AMDD (as shown in FIG. 20), it causes the first component 702 (i.e., operatively associated with the actuation member 720) to move along with the actuation member 720. This causes the first component 702 to pivot/rotate about the first rotation axis FRA-FRA.

As shown in FIGS. 26-27 and 185-186, when the first component shoulder 714 engages the second component shoulder 716 in the area 718, the second component 708 is forced to rotate about the second rotation axis SRA-SRA against the bias of the spring assembly 730. That is, upon rotation of the first component 702 about the first rotation axis FRA-FRA, cam surfaces 735 of the first component shoulder 714 may be configured to engage and force cam surfaces 737 of the second component shoulder 716. This forces the second component 708 to rotate about the second rotation axis SRA-SRA.

Referring to FIGS. 19-22 and 174-176, the latch system 700 (including the first component 702, the second component 708, the spring system 730) may be received in the latch receiving cavity 728. The latch receiving cavity 728 may be defined by a plurality of walls integrally formed by the upper/top housing portion 103 of the battery pack 100. The latch receiving cavity/volume/pocket 728 may be sealed off from the internal/interior cavity 104 of the battery pack 100. The sealed off latch receiving cavity/volume/pocket 728 may allow for the elimination or reduction of water and particulate ingress into the internal/interior cavity 104 of the battery pack 100. That is, the sealed off latch receiving cavity/volume/pocket 728 may be configured to maintain a seal against leaks and ingress of dust and water into the internal/interior cavity 104 of the battery pack 100.

When the user actuation element 720 is actuated by the user, the first component shoulder 714 engages the second component shoulder 716 upon rotation of the first component 702 about the first rotation axis FRA-FRA forcing the second component 708 to rotate about the second rotation axis SRA-SRA against the bias of the spring assembly 730. The rotation of the second component 708 about the second rotation axis SRA-SRA causes the latching element 722 of the second component 708 to disengage from the portions of the electrical device.

The latch element/latch 722 of the second component 708 may be configured to pass through an opening on the latch cover 724. The first component 702 including the user actuation element/user actuator 720, the second component 708 including the latching element/latch 722, and the spring assembly 730 may all be held in place in the latch receiving cavity 728 by the latch cover 724.

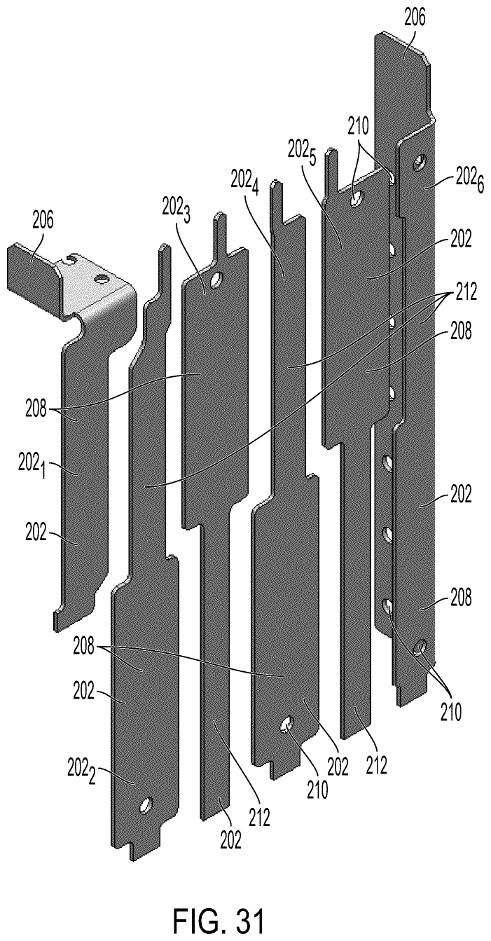

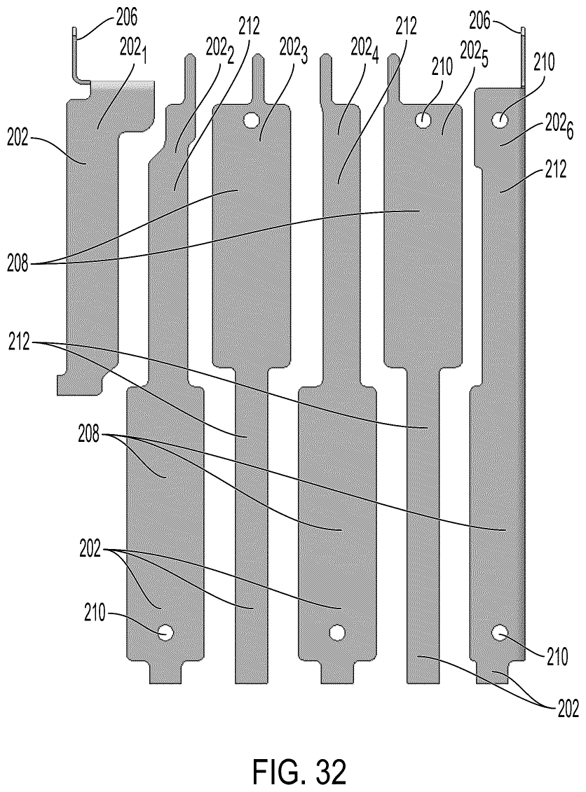

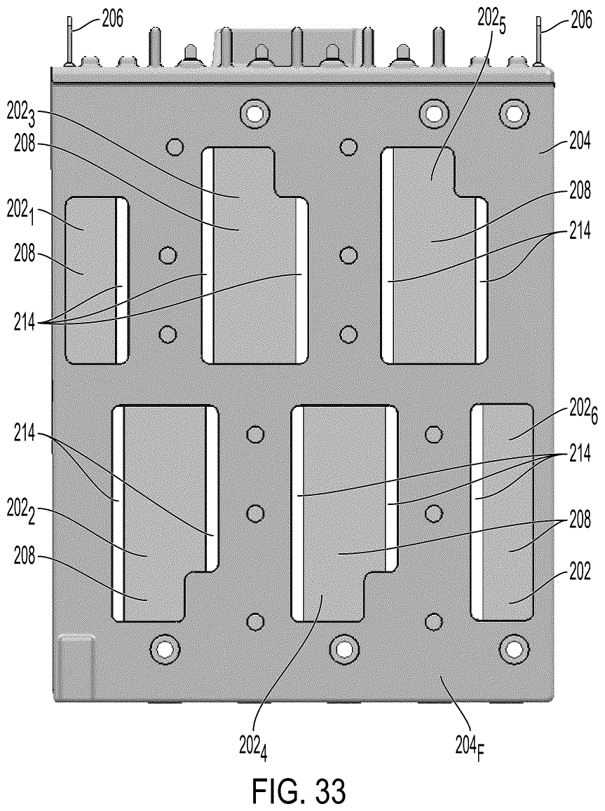

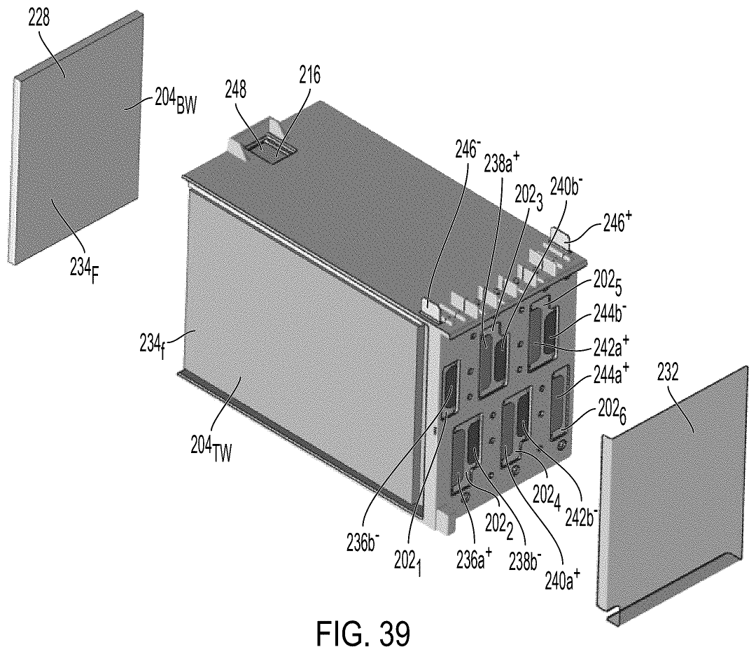

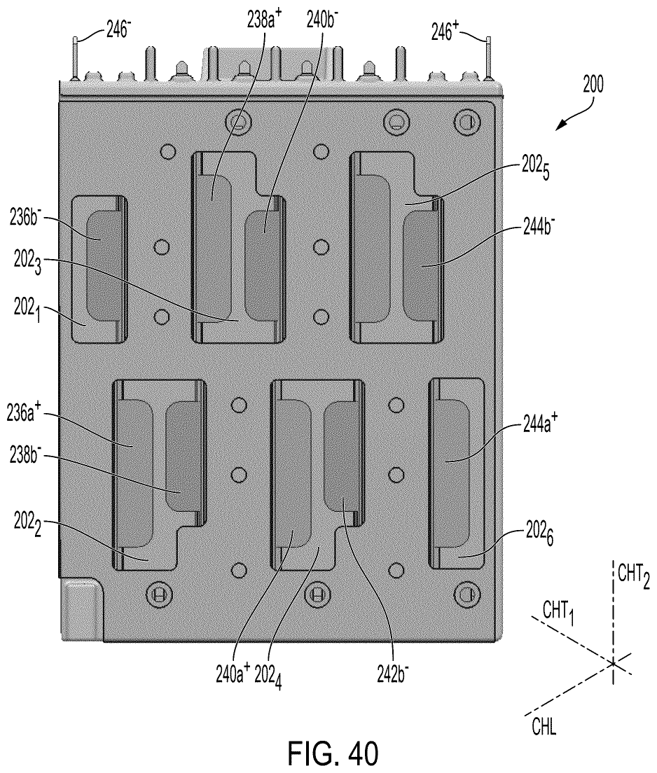

The battery pack 100 may include one or more battery cell modules 200 (as shown in FIGS. 39-40). Referring to FIGS. 31-40, the battery cell module 200 may include contacts 202. The contacts 202 may include battery cell holder collection straps 202. The battery cell module 200 may also include a battery cell holder 204 that is injection molded around the battery cell holder collection straps 202. For example, FIGS. 31-40 show various views of the battery cell holder collection straps 202 of the battery cell module 200. FIGS. 33-36 show various views of the battery cell holder 204 of the battery cell module 200, the battery cell holder collection straps 202 being fixedly held in place by the battery cell holder 204. In some embodiments, the battery cell module 200 can be laser welded to the battery cell holder 204.

As described below, due to the nature of the battery cell holder 204 and use of the battery cell holder 204 within a module holder and a cell holder subassembly, the battery cell holder 204 may be referred to and described as a battery cell holder that is modular or a modular cell holder.

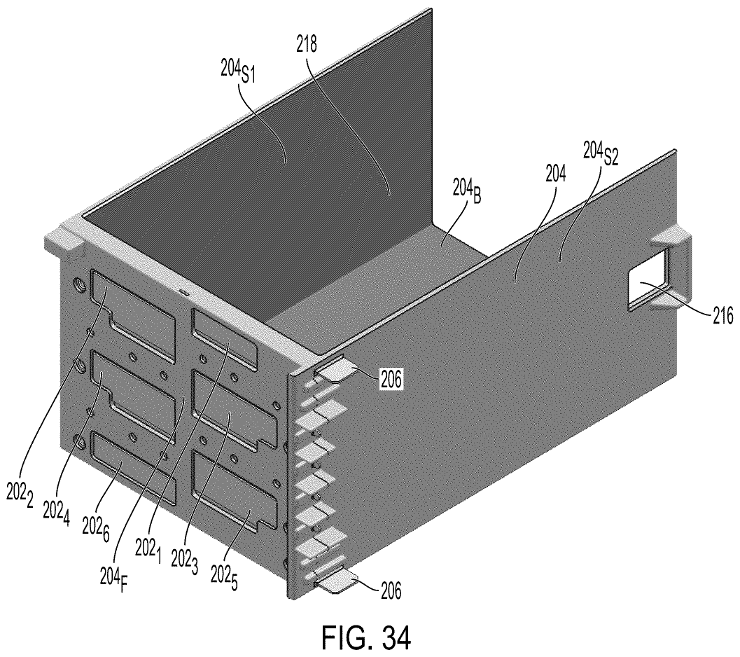

In the illustrated embodiment of FIG. 34, six battery cell holder collection straps 202₁, 202₂, 202₃, 202₄, 202₅ and 202₆ are shown. The number of the battery cell holder collection straps may vary. Each of the battery cell holder collection straps 202 may be made of a metal, electrically conductive material, as is well known in the art. The battery cell holder collection straps 2021 and 202₆ may be referred to as end battery cell holder collection straps and may include their respective tangs 206 that protrude outwardly away from the battery cell holder 204. Each of the battery cell holder collection straps 202₁, 202₂, 202₃, 202₄, 202₅, and 202₆ may include a contact region 208. As will be explained in detail in discussions below, an end of a cell tab of a pouch battery cell or ends of cell tabs of adjacent pouch battery cells may be folded to connect to an associated contact region 208. Each of the battery cell holder collection straps 202 may also include an opening 210 and thinner portions 212 to enable the battery cell holder 204 to be injection molded around the battery cell holder collection straps 202. When the battery cell holder 204 is injection molded around the battery cell holder collection straps 202, openings 214 may be formed between portions of the battery cell holder 204 and the battery cell holder collection straps 202. These openings 214 may be configured to allow the end(s) of the cell tab(s) of pouch battery cell(s) to extend therethrough so as to be folded to connect to their associated contact region. In some embodiments, individual parts can be insert molded (e.g., by a connecting frame and then cut off afterwards).

The battery cell holder 204 includes a base 204_{B}, a pair of opposing side walls 204_{S1} and 204_{S2} extending perpendicularly to the base 204_{B}, and a front wall 204_{F} extending perpendicularly to the base 204_{B} and the pair of opposing side walls 204_{S1} and 204_{S2}. The front wall 204_{F} may include the wall that is injection molded around the battery cell holder collection straps 202. The front wall 204_{F} of the battery cell holder 204 may also be referred to as front collection wall. The front wall 204_{F}, the base 204_{B} and the pair of opposing side walls 204_{S1} and 204_{S2} of the battery cell holder 204 may together form/define an internal cavity 218 in which battery cells 220 are received. Two (or more) gap pads 222 may be disposed in the internal cavity 218 and may be positioned along or adjacent to the pair of opposing side walls 204_{S1} and 204_{S2}. The gap pads may include foam. Alternatively, a foam material may be used in place of the gap pads 222.

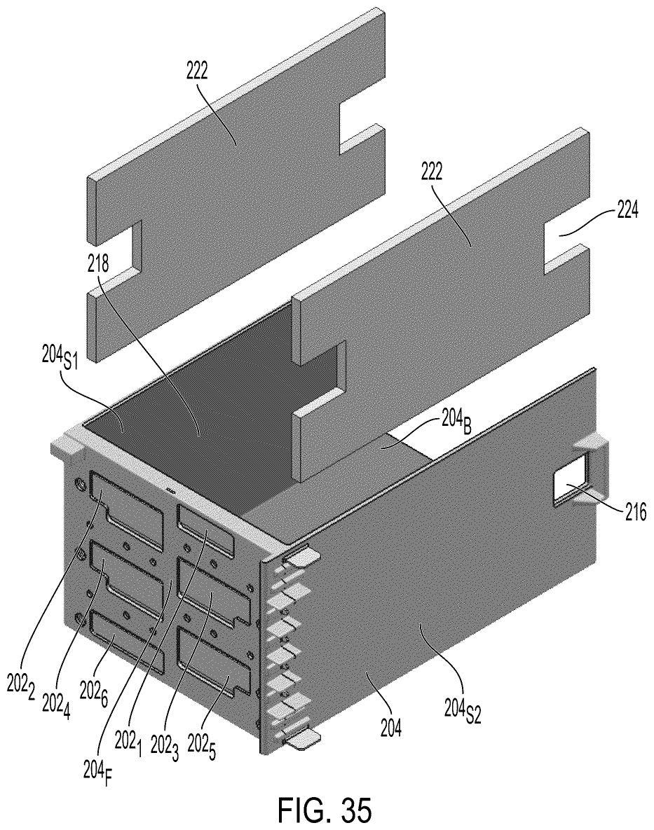

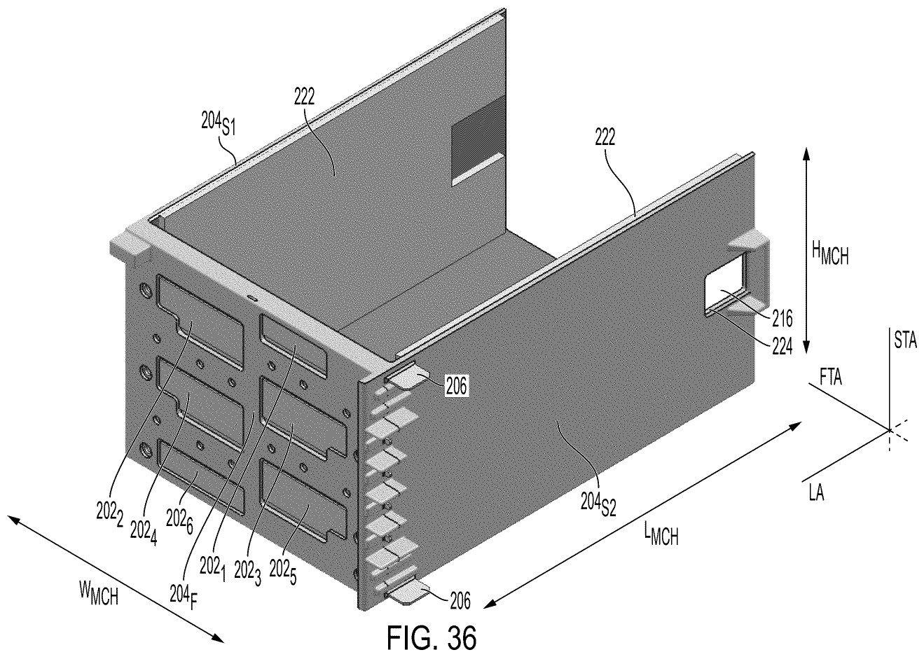

FIG. 35 shows the battery cell holder 204 before the gap pads 222 are installed/disposed in the battery cell holder 204 and FIG. 36 shows the battery cell holder 204 after the gap pads 222 are installed/disposed in the battery cell holder 204. The battery cell holder 204 may have a length L_{MCH} along a longitudinal axis LA-LA, a width W_{MCH} along a first transverse axis FTA-FTA that is perpendicular to the longitudinal axis LA-LA, and a height H_{MCH} along a second transverse axis STA-STA that is perpendicular to the longitudinal axis LA-LA and the first transverse axis FTA-FTA.

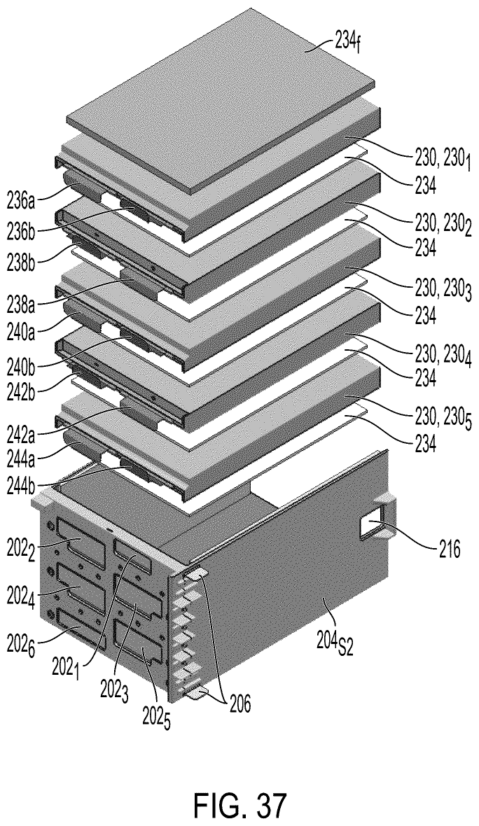

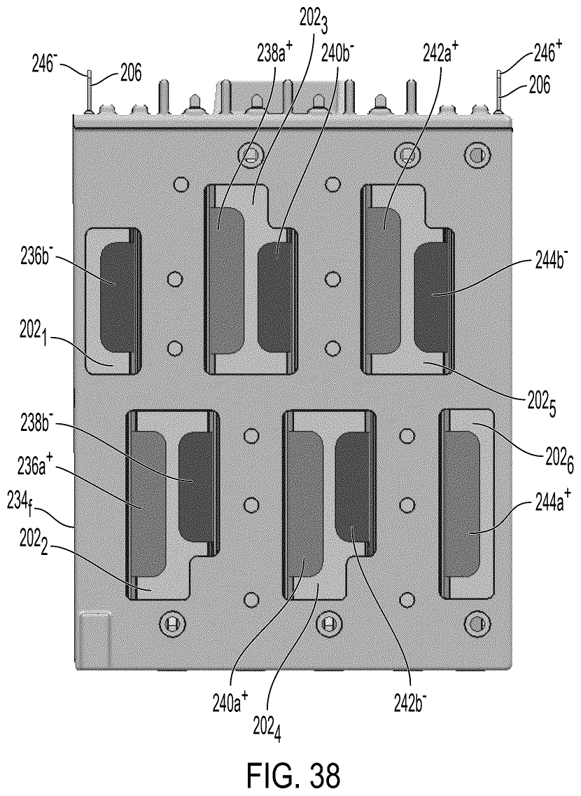

FIG. 36 shows an exploded view of the battery cell holder 204, a plurality of battery cells 230, and gap pads 234 (e.g., that are configured to be installed/disposed on each side of each battery cell 230) of the battery cell module 200. FIG. 36 shows the battery cell holder 204 before the battery cells 230 and the gap pads 234 are installed/disposed in the battery cell holder 204. The battery pad 234_{f} may be disposed at an end of the battery cell holder 204 after the battery cells 230 and the gap pads 234 are installed/disposed in the battery cell holder 204. FIG. 38 shows a front view of the battery cell holder 204 with the battery cells 230, and the gap pads 234 installed/disposed therein. FIG. 37 shows the battery cell module 200 resting on the base 204_{B} of the battery cell module 200, while FIG. 38 shows the battery cell module 200 turned to its side (i.e., resting on the side walls 204_{S1} of the battery cell holder 204).

FIG. 39 shows a perspective view of the battery cell holder 204 with the battery cells 230 and the gap pads 222, 234 installed/disposed therein. FIG. 39 also shows a thermistor connection 248, an end gap pad 228 and an end insulating layer 232 before the end gap pad 228 and the end insulating layer 232 are installed/disposed at the ends of the battery cell holder 200. The end insulating layer 232 is installed/disposed at the end of the battery cell holder 204 that has the battery cell tabs. FIG. 40 shows a front view of the battery cell module 200 of the battery pack. The battery cell module 200 includes the battery cell holder 204, the battery cells 230 with their battery cell tabs, the battery cell holder collection straps 202, all the gap pads 222, 234, 228, and the end insulating layer 232.

As shown in FIG. 39, the gap pad 234_{F} may form the top wall 204_{TW} and the gap pad 234_{f} may form the back wall 204_{BW} of the battery cell holder 204. The insulating layer 232 may be positioned on the front collection wall 204_{F}. The gap pads may generally be soft, conformable thermal pads that provide effective thermal interfaces between heat sinks and electronic devices, accommodating for uneven surfaces, air gaps, and rough surface textures. An insulating material or gap pad 234 may be positioned between two adjacent pouch battery cells 230. The insulating material may provide thermal insulation between two adjacent pouch battery cells 230. The insulating material may be thermally insulating, thermally conductive (e.g., to conduct heat away from unwanted locations), or thermally absorptive, between two adjacent pouch battery cells 230. The insulating material may also have compression properties to allow two adjacent pouch battery cells 230 to expand during charge and/or discharge of the cells 230. The insulating material may be, for example, a polyurethane or silicone foam of the closed or open cell variety, or a ceramic textile.

The battery cell holder 204 may include an opening 216 that is configured to enable a thermistor connection 248. An opening 224 of the gap pad 222 may be aligned with the opening 216 of the side wall 204_{S2} so as to facilitate the thermistor connection.

In the illustrated embodiment, referring to FIGS. 37-40, five pouch battery cells 230₁, 230₂, 230₃, 230₄, and 230₅ are shown. The number of the pouch battery cells 230 may vary. The pouch battery cells 230 are shown in a back-to-back or opposed to each other. Each of the pouch battery cells 230 may include a pouch case.

The first pouch battery cell 230₁ may include a first (positive) cell tab 236a⁺ and a second (negative) cell tab 236b⁻. The second pouch battery cell 230₂ may include a first (positive) cell tab 238a⁺ and a second (negative) cell tab 238b⁻. The third pouch battery cell 230₃ may include a first (positive) cell tab 240a⁺ and a second (negative) cell tab 240b⁻. The fourth pouch battery cell 230₄ may similarly include a first (positive) cell tab 242a⁺ and a second (negative) cell tab 242b⁻. The fifth pouch battery cell 230₅ may include a first (positive) cell tab 244a⁺ and a second (negative) cell tab 244b₋.

In the context of the present disclosure, the tabs/taps of the same cell are considered aligned in a row (and are adjacent to each other) and the tabs of different cells are aligned are in a column. Furthermore, the tabs of adjacent cells that are aligned in a column are denoted as adjacent tabs. In other words, the positive tab 236a⁺ of the first pouch battery cell 230₁ is adjacent to the negative tab 236b⁻ of the first pouch battery cell 230₁ in a first direction, and the positive tab 238a⁺ of the second pouch battery cell 230₂ is adjacent to the negative tab 238b⁻ of the second pouch battery cell 230₂ in the first direction. Also, the positive tab 236a⁺ of the first pouch battery cell 230₁ is adjacent to the negative tab 238b⁻ of the second pouch battery cell 230₂ in a second direction (generally perpendicular to the first direction) and the negative tab 236b⁻ of the first pouch battery cell 230₁ is adjacent to the positive tab 238a⁺ of the second pouch battery cell 230₂ in the second direction. The positive tab 236a⁺ of the first pouch battery cell 230, 230₁ is not considered adjacent to the positive tab 238a⁺ of the second pouch battery cell 230₂ and the negative tab 236b⁻ of the first pouch battery cell 230₁ is not considered adjacent to the negative tab 238b⁻ of the second pouch battery cell 230₂. Although not detailed here, the cell tabs of the rest of the pouch battery cells are ordered in the same manner.

The ends of the cell tabs are folded to connect to an associated metallic pad. Specifically, the first (positive) cell tab 244a⁺ of the fifth battery cell 230₅ (the most positive cell tab once all of the battery cells of the set of battery cells 230 are connected in series) is folded to overlap the metallic pad 202₆. The second (negative) cell tab 236b⁻ of the first battery cell 230₁ (the most negative cell tab once all of the battery cells of the set of battery cells 230 are connected in series) is folded to overlap the metallic pad 202₁.

The second (negative) cell tab 242b⁻ of the fourth battery cell 230₄ and the first (positive) cell tab 240a⁺ of the third battery cell 230₃ are folded to overlap the metallic pad 202₄. The second (negative) cell tab 238b⁻ of the second battery cell 230₂ and the first (positive) cell tab 236a⁺ of the first battery cell 230₁ are folded to overlap metallic pad 202₂. The first (positive) cell tab 238a⁺ of the second battery cell 230₂ and the second (negative) cell tab 240b⁻ of the third battery cell 230₃ are folded to overlap the metallic pad 202₃. The first (positive) cell tab 242a⁺ of the fourth battery cell 230₄ and the second (negative) cell tab 244b⁻ of the fifth battery cell 230₅ are folded to overlap the metallic pad 202₅.

Once all of the battery cells 230 are connected in series, the battery cell module 200 includes positive battery cell module terminal 246⁺ and negative battery cell module terminal 246⁻.

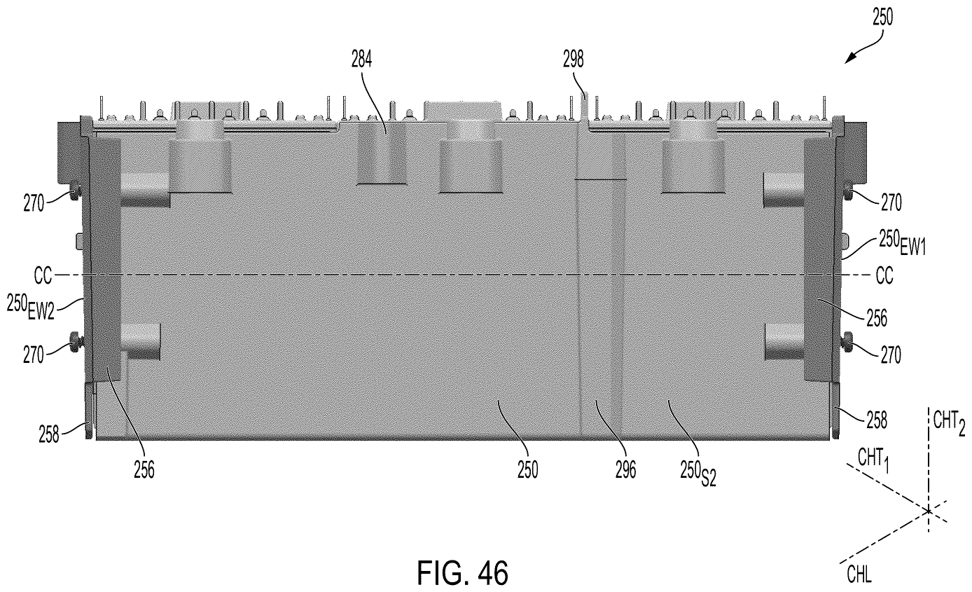

The battery pack 100 may include a cell holder subassembly 250. FIGS. 46-49 show perspective views of the assembled cell holder subassembly 250 of the battery pack 100. As will be clear from the discussions in detail below, the cell holder subassembly 250 may be received in the internal cavity 104 of the housing 102 of the battery pack 100. The cell holder subassembly 250 may also include a module(s) holder or battery cell module(s) holder 252. The module holder 252 may be configured to receive one or more battery cell modules 200 (200₁, 200₂, 200₃).

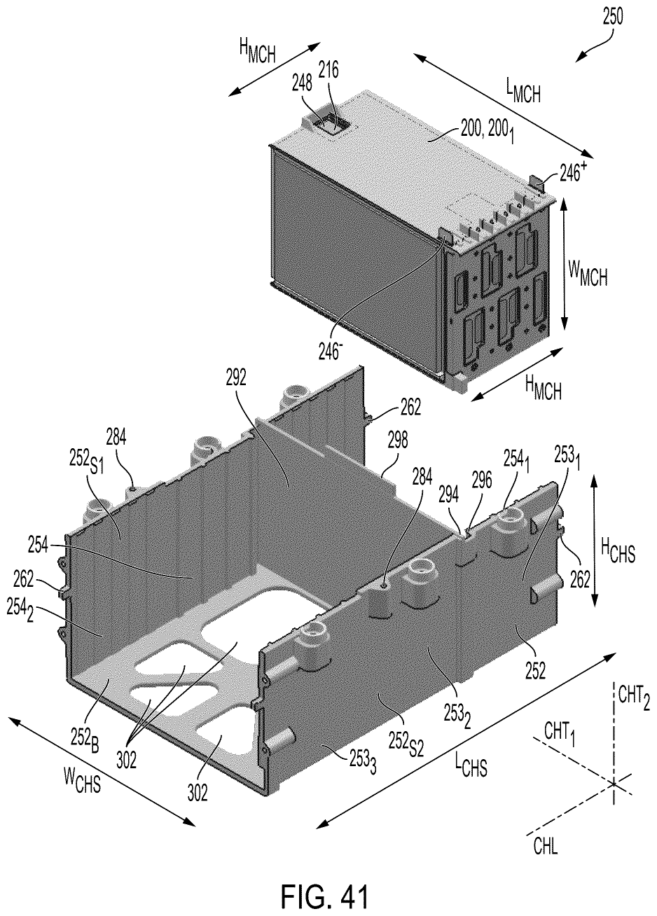

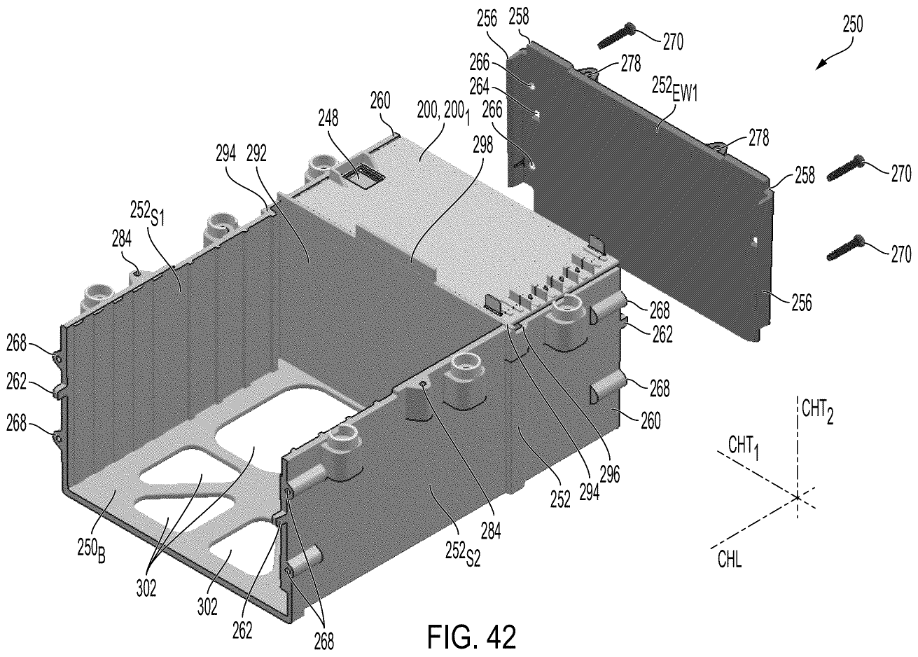

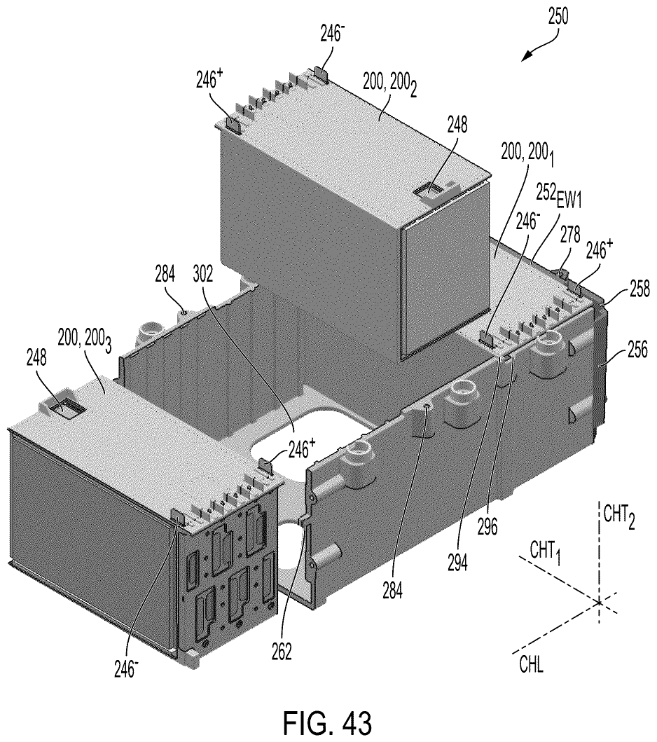

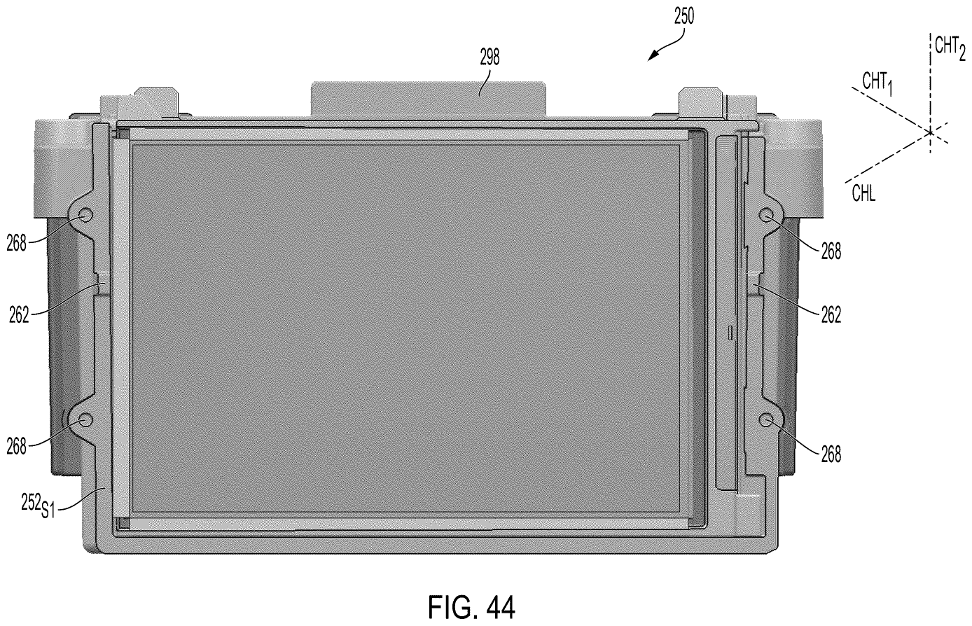

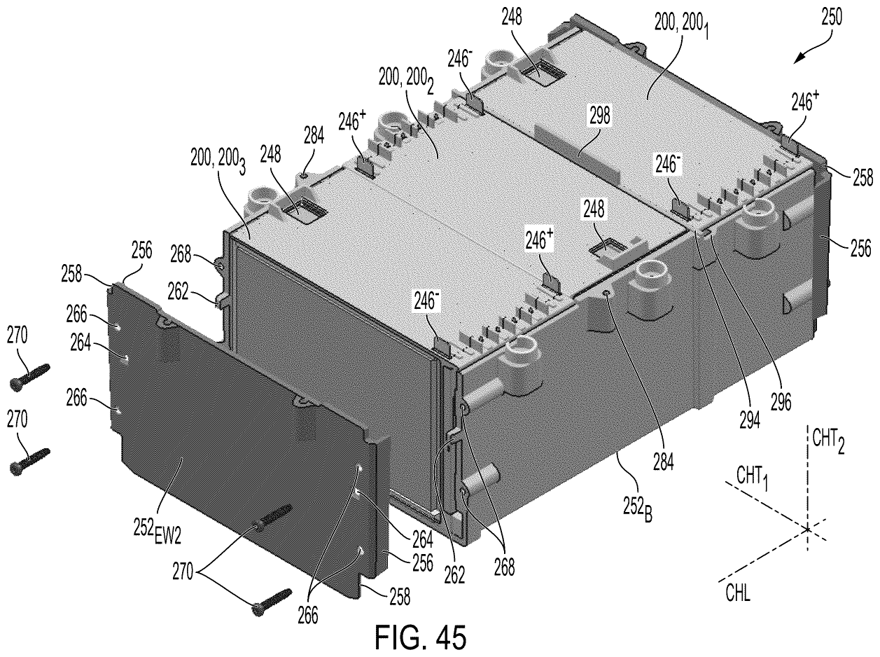

FIG. 41 shows a first battery cell module 200₁ before it is installed/disposed in the module holder 252, while FIG. 42 shows the first battery cell module 200₁ after it is installed/disposed in the module holder 252. FIG. 43 shows the first battery cell module 200₁ after it is installed/disposed in the module holder 252 and a second battery cell module 200₂ and a third battery cell module 200₃ before they are installed/disposed in the module holder 252. FIG. 43 also shows that each battery cell module 200 is disposed in reverse order/direction with respect to its adjacent battery cell modules 200. This reverse order/direction orientation of the adjacent battery cell modules is explained in detail below and can be observed by looking at battery cell module tabs 246⁺ and 246⁻ of each battery cell module 200 and thermistor connection 248 of each battery cell module 200. FIGS. 44 and 45 show with three battery cell modules 200 (200₁, 200₂, 200₃) installed/disposed in the module holder 252.

The module holder 252 may be configured to receive three battery cell modules 200 therein. That is, the module holder 252 of the cell holder subassembly 250 may include three locations 253 (253₁, 253₂, 253₃) for receiving a battery cell module 200. Each battery cell module receiving location 2532 (253₁, 253₂, 253₃) may be configured to receive one of the battery cell modules 200 (200₁, 200₂, 200₃). The number of the battery cell modules 200 received in the cell holder subassembly 250 may vary. The number of battery cell module receiving locations 253 in the cell holder subassembly 250 may vary in accordance with the number of battery cell modules 200 in the cell holder subassembly 250.

The module holder 252 includes a base 252_{B} and two opposing side walls 252_{S1} and 252_{S2} that form an interior space/storage space 254 that is configured to receive a set of battery cell modules 200. The module holder 252 may have a length dimension L_{CHS} along a longitudinal axis CHL-CHL, a width dimension W_{CHS} along a first transverse axis CHT₁-CHT₁ that is perpendicular to the longitudinal axis CHL-CHL, and a height dimension H_{CHS} along a second transverse axis CHT₂-CHT₂ that is perpendicular to the longitudinal axis CHL-CHL and the first transverse axis CHT₁-CHT₁. The two side walls 252_{S1} and 252_{S2} extend along the longitudinal axis CHL-CHL of the module holder 252.

The base 252_{B} may have a length dimension L_{CHS} along the longitudinal axis CHL-CHL of the module holder 252 and a width dimension W_{CHS} along the first transverse axis CHT₁-CHT₁ of the module holder 252. The width dimension W_{CHS} of the base 252_{B} may be the same as the length dimension L_{MCH} of the battery cell module 200. Each side wall 252_{S1}, 252_{S2} may have a length dimension L_{CHS} along the longitudinal axis CHL-CHL of the module holder 252 and a height dimension H_{CHS} along the second transverse axis CHT₂-CHT₂ of the module holder 252. The height dimension H_{CHS} of each side wall 252_{S1}, 252_{S2} may be the same as the width dimension WMCH of the battery cell module 200.

The length dimension of each side wall 252_{S1}, 252_{S2} may be the same as the length dimension of the base 252_{B}. The length dimension of each side wall 252_{S1}, 252_{S2} may be different from the length dimension of the base 252_{B}. The length dimension of each side wall 252_{S1}, 252_{S2} and/or the length dimension of the base 252_{B} may be the same as the length dimension L_{CHS} of the module holder 252. The length dimension of each side wall 252_{S1}, 252_{S2} and/or the length dimension of the base 252_{B} may be at least equal to a sum of the height dimension H_{MCH} (as the battery cell modules 200 are received on their sides in the module holder 252) of each battery cell module 200 being received in the module holder 252. For example, when three battery cell modules 200, having the same height dimension are being received in the module holder 252, the length dimension of the base 252_{B} and/or the length dimension of each side wall 252_{S1}, 252_{S2} may be configured to be equal to three times the height dimension H_{MCH} of the battery cell module 200. When one or more partition walls are received by the module holder 252, the length dimension of the base 252_{B} and/or the length dimension of each side wall 252_{S1}, 252_{S2} may be configured to be equal to a sum of a thickness dimension of each partition wall being received and a height dimension H_{MCH} of each battery cell module 200 being received.

The two side walls 252_{S1}, 252_{S2} of the module holder 252 may be separated from each other by a separation distance along the first transverse axis CHT₁-CHT₁ of the module holder 252. The separation distance may be equal to at least the length dimension L_{MCH} of the battery cell module 200 being received.

The base 252_{B} and the two side walls 252_{S1}, 252_{S2} of the module holder 252 may be integrally formed. The base 252_{B} and the two side walls 252_{S1}, 252_{S2} of the module holder 252 may form a single piece assembly. The base 252_{B} and the two side walls 252_{S1}, 252_{S2} of the module holder 252 may be molded (e.g., injection molded) together. The base 252_{B} and the two side walls 252_{S1}, 252_{S2} of the module holder 252 may be made of a plastic material, a hard plastic material or other materials that are configured to support the weight of the battery cell modules 200 being received in the module holder 252.

The cell holder subassembly 250 may include two opposing end walls 252_{EW1}, 252_{EW2} that extend perpendicular to the base 252_{B} and the two side walls 252_{S1}, 252_{S2} and that extend along the first transverse axis CHT₁-CHT₁ of the module holder 252. The two end walls 252_{EW1}, 252_{EW2} may be configured to be removably connected to the two side walls 252_{S1}, 252_{S2}.

FIG. 42 shows one of the two opposing end walls 252_{EW1}, 252_{EW2} of the cell holder subassembly 250 before it is attached to the module holder 252, while FIG. 43 shows one of the two opposing end walls 252_{EW1}, 252_{EW2} of the cell holder subassembly 250 after it is attached to the module holder 252. FIGS. 44 and 45 show the cell holder subassembly 250 before the other of the two opposing end walls 252_{EW1}, 252_{EW2} is attached to the module holder 252. FIGS. 46-48 show the cell holder subassembly 250 after two opposing end walls 252_{EW1}, 252_{EW2} are attached to the module holder 252.

Each end wall 252_{EW1}, 252_{EW2} may include flange portions 256 at their ends 258. The flange portions 256 are configured to extend along the longitudinal axis CHL-CHL of the cell holder subassembly 250 to overlap with end portions 260 of the two side walls 252_{S1}, 252_{S2}. The flange portions 256 may be optional. Each side wall 252_{S1}, 252_{S2} may include aligning members 262 that protrude therefrom and may be configured to be received in a corresponding openings 264 of the end walls 252_{EW1}, 252_{EW2} so as to align the end walls 252_{EW1}, 252_{EW2} with respect to the side walls 252_{S1}, 252_{S2}. The end walls 252_{EW1}, 252_{EW2} may include fastener openings/holes 266 in a pattern corresponding to fastener openings/holes 268 of the side walls 252_{S1}, 252_{S2}. Mechanical fasteners (e.g., screws, etc.) 270 may be inserted through the fastener openings/holes 266, 268 after they are aligned, for connecting the end walls 252_{EW1}, 252_{EW2} to the side walls 252_{S1}, 252_{S2}.

Referring to FIG. 41-48, the cell holder subassembly 250 may include one or more partition walls 292 that extend parallel to the two end walls 252_{EW1}, 252_{EW2} and along the first transverse axis CHT₁-CHT₁ of the cell holder subassembly 250. The one or more partition walls 292 may be configured to be removably connected to the two side walls 252_{S1}, 252_{S2}. When installed, the one or more partition walls 292 may be configured to divide the interior storage space 254 of the cell holder subassembly 250 into two or more storage spaces 254₁, 254₂. Each of the two or more storage spaces 254₁, 254₂ may be configured to receive one or more of the set of battery cell modules 200.

In the illustrated embodiment, only one partition wall 292 is shown. This partition wall 292 separates the internal storage space 254 of the cell holder subassembly 250 into a first storage space 254₁ and a second storage space 254₂. In the illustrated embodiment, the first storage space 254₁ receives a single battery cell module 200, while the second storage space 254₂ may be configured to receive two battery cell modules 200.

In another embodiment, the cell holder subassembly 250 may be configured to receive two partition walls 292 that are configured to separate the internal storage space 254 of the cell holder subassembly 250 into three storage spaces. Each storage space may be configured to receive one battery cell module 200. The partition wall 292 is optional.

The partition wall 292 may include end portions 294 (e.g., ridges, etc.) that are configured to slide into and out of mating grooves or end receiving portions 296 disposed on the side wall 252_{S1}, 252_{S2} to removably or slidably connect the partition wall 292 to the cell holder subassembly 250. In another embodiment, the partition wall 292 may be integrally molded with the base 252_{B} and the two side walls 252_{S1}, 252_{S2} of the module holder 252.

The partition wall 292 may include an aligning member 298 that protrudes away from the partition wall 292 and extends along the second transverse axis CHT₂-CHT₂ of the module holder 252 (when the partition wall 292 is installed in the cell holder subassembly 250).

Referring to FIGS. 41-48, when received in the module holder 252/cell holder subassembly 250, each battery cell module 200 may be configured to be positioned to be parallel to the first transverse axis CHT₁-CHT₁ of the module holder 252/cell holder subassembly 250. The battery cell module 200 may be configured to be positioned on its side as the battery cell module 200 is being disposed in the module holder 252.

The battery cell module 200 may include a plurality of battery cells 230 that are stacked in the battery cell module 200 along the longitudinal axis CHL-CHL of the cell holder subassembly 250. Each battery cell 230 of the battery cell module 200 may be in a plane that is parallel to the first transverse axis CHT₁-CHT₁ of the cell holder subassembly 250.

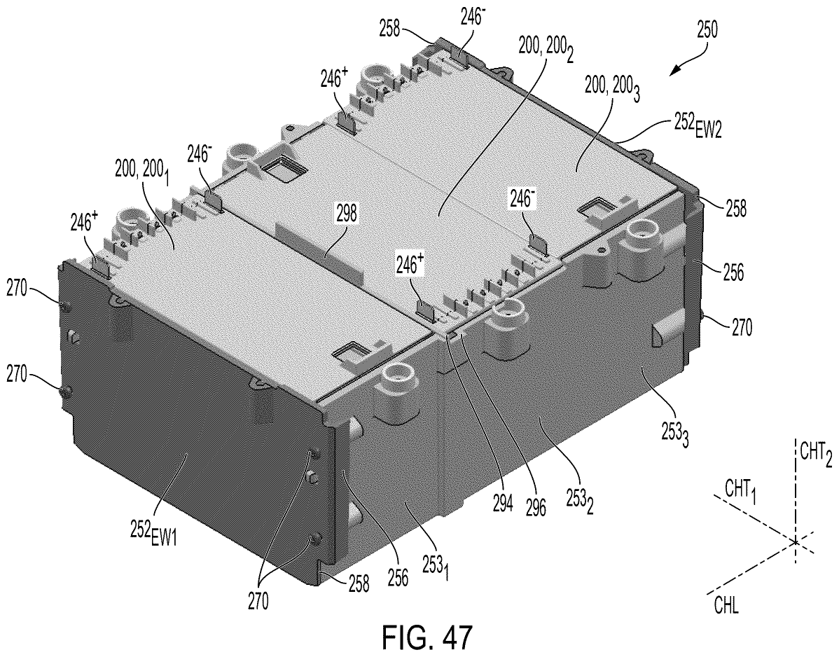

Referring to FIGS. 43, 45 and 47, the battery cell module tabs 246⁺ and 246⁻ of each battery cell module 200 may be disposed to be offset by 180 degrees with respect to its adjacent battery cell modules 200. The battery cell module tabs 246⁺ and 246⁻ of each battery cell module 200 may be configured to face away from the base 252_{B} and may be disposed in a plane that is parallel to the base 252_{B} of the module holder 252. It can also be seen from these figures that the thermistor connection 248 of each battery cell module 200 is disposed to be offset by 180 degrees with respect to its adjacent battery cell modules 200. Referring to FIGS. 45 and 47, the thermistor connection 248 and the battery cell module tabs 246⁺ and 246⁻ for each battery cell module 200 (200₁, 200₂, 200₃) may be disposed on their opposing sides/ends. Also, the thermistor connection 248 of the first battery cell module 200₁ may be disposed to be offset by 180 degrees with respect to the thermistor connection 248 of the second battery cell modules 200₂ and the thermistor connection 248 of the second battery cell module 200₂ may be disposed to be offset by 180 degrees with respect to the thermistor connection 248 of the third battery cell modules 200₃. Similarly, the battery cell module tabs 246⁺ and 246⁻ of the first battery cell module 2001 may be disposed to be offset by 180 degrees with respect to the battery cell module tabs 246⁺ and 246⁻ of the second battery cell modules 200₂ and the battery cell module tabs 246⁺ and 246⁻ of the third battery cell module 200₂ may be disposed to be offset by 180 degrees with respect to the battery cell module tabs 246⁺ and 246⁻ of the second battery cell modules 200₃.

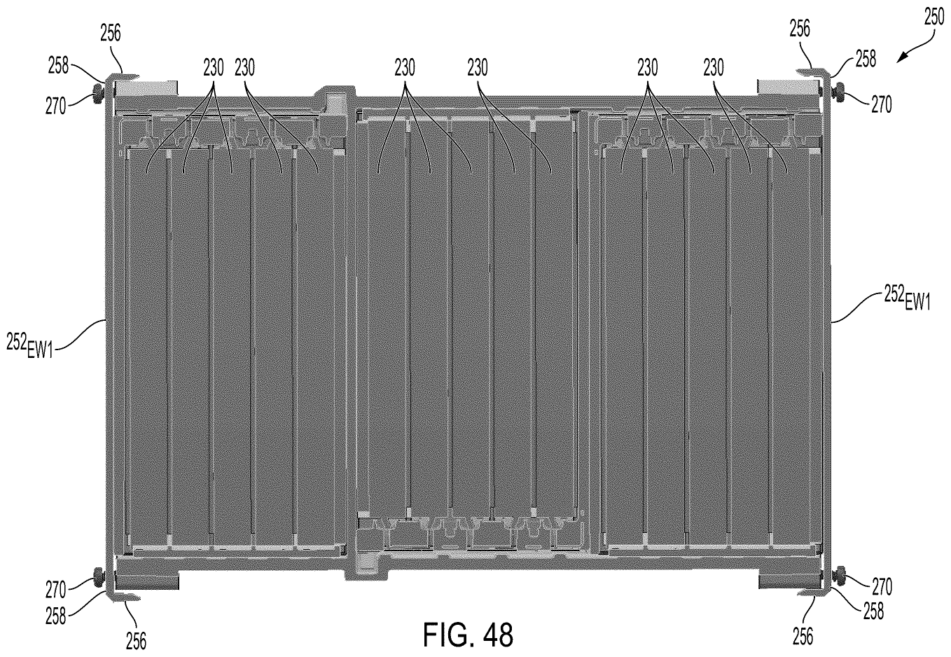

FIG. 48 shows an elevation (top down) cross-sectional view of the cell holder subassembly 250 with three battery cell modules 200 installed/disposed therein. As shown in FIG. 48, each battery cell module 200 may include five battery cells 230. The number of battery cells 230 in the battery cell module 200 may vary. A person of ordinary skill in the art would readily appreciate that the plurality of battery cells 230 disposed in the battery cell module 200 may include more or fewer pouch battery cells, depending upon the requirements of the battery pack or an associated tool platform.

The battery cells 230 in the battery cell module 200 may be pouch battery cells. The type/configuration of battery cells 230 in the battery cell module 200 may vary. A person of ordinary skill in the art would readily appreciate that the type of battery cells 230 disposed in the battery cell module 200 may include other battery cell types/configuration, depending upon the requirements of the battery pack or an associated tool platform.

The present patent application addresses various USDOT regulatory issues via a special shipping mode configuration of a shipping mode actuation switch (an internal switch or switches or switching network) operating with an actuation member/element. The switch or switching network opens and closes the power path in battery pack. The switch or switching network may separate fifteen battery cells into three groups of five battery cells. A plurality of contacts, for example, a leaf spring style contacts, may be disposed in the power path. The contacts will be described in detail in the discussions below. The shipping solution may be configured to provide a signal to the module that activates a low power shipping mode state for circuits. The shipping solution may be configured to pass through housing seals to be actuated by user input. Disclosed is the design for the battery pack shipping system, a shipping mode actuation switch, which is able to connect or disconnect three sub-core cell assemblies internal to the battery pack. By internally disconnecting the three sub-core cell assemblies, the battery is able to ship under the USDOT “smaller cells or batteries-transportation by highway or rail only” exception outlined in 49 CFR 173.185(c)(1)(iv). The shipping mode actuation switch may be actuated by an externally inserted shipping card (e.g., access to the pack internals is not required to actuate the shipping mode assembly switch). Internal access to the battery pack is not required to activate shipping mode. The battery module electronics are set to a low-power mode (e.g., shipping mode).

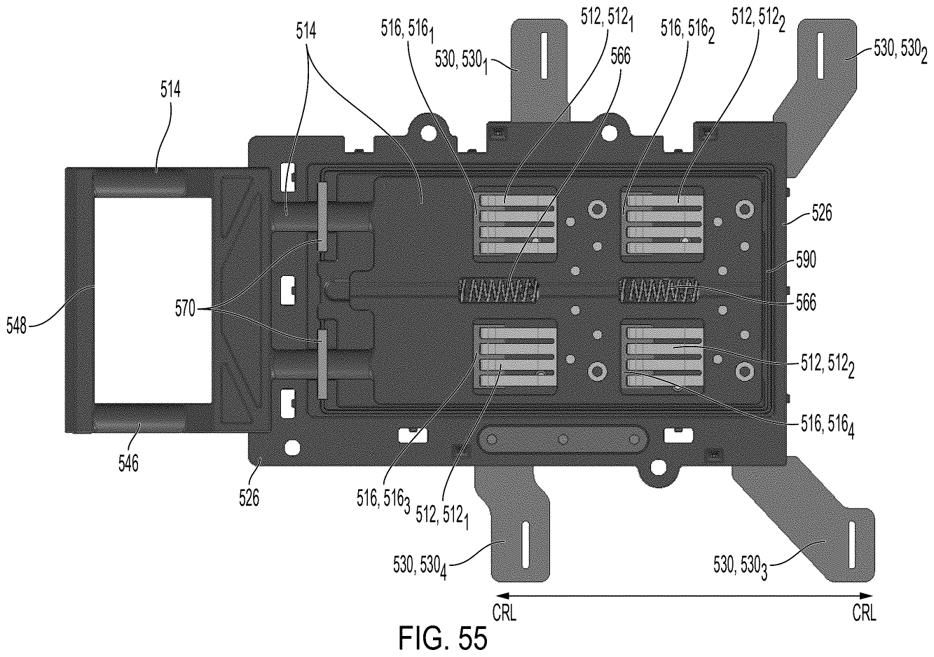

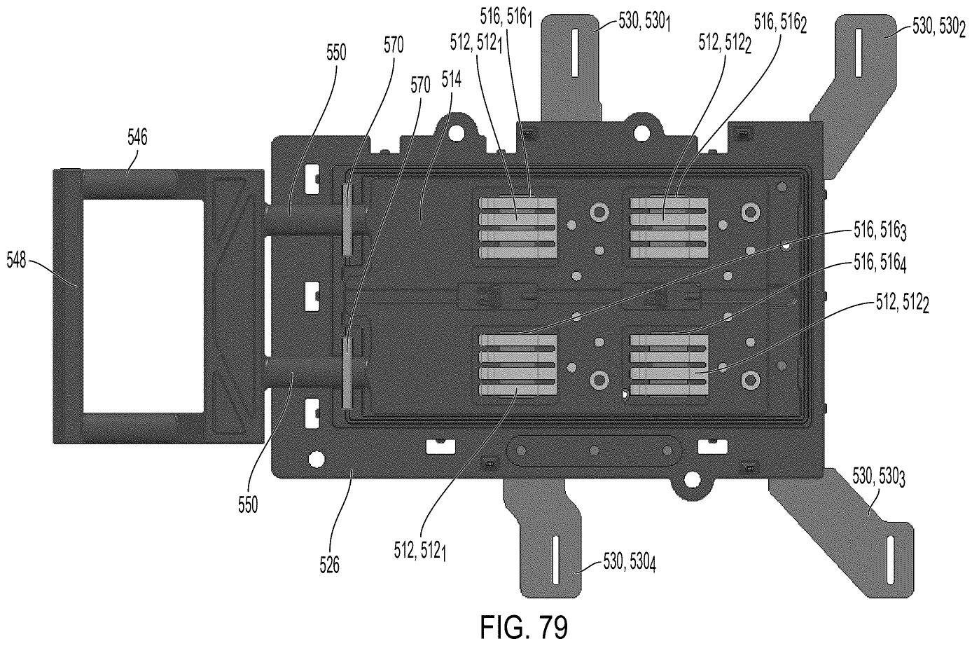

The shipping subassembly may include a set of (at least one) leaf springs that is insert-molded into a plastic card. The plastic card is constrained such that it can slide transversely in the shipping system subassembly and the battery pack. The shipping solution includes a base. The leaf springs are used to engage/disengage contact pads that, when connected, complete a power path (all the cells (for example, fifteen cells) of the battery pack are connected together in series). The plastic card is able to translate the leaf springs on to and off of the contact pads that are connected to cell taps. Internal coil springs allow the device to automatically return itself to the “ON”/active position. The user is able to remove a shipping actuator from the external area of the battery pack which allows the shipping mode actuation switch to return to the “ON”/active position. In a default/use mode/state/configuration, the internal springs are configured to assert a force (in direction Y as shown in FIG. 55) to hold the contacts in the use position. In the shipping mode/state/configuration, the shipping mode actuator is configured to move the bar in direction X, as shown in FIG. 79, against the internal springs, to move contacts into shipping position.

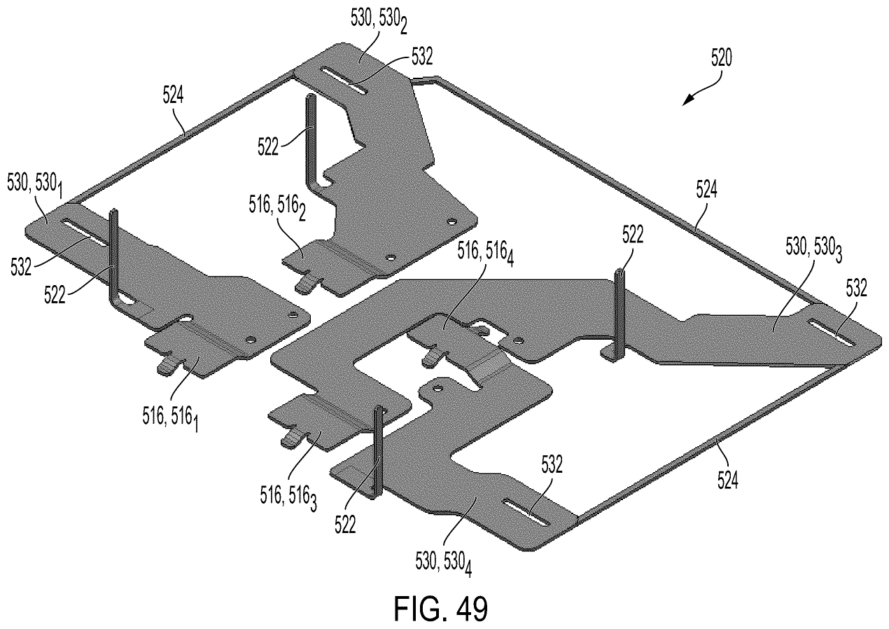

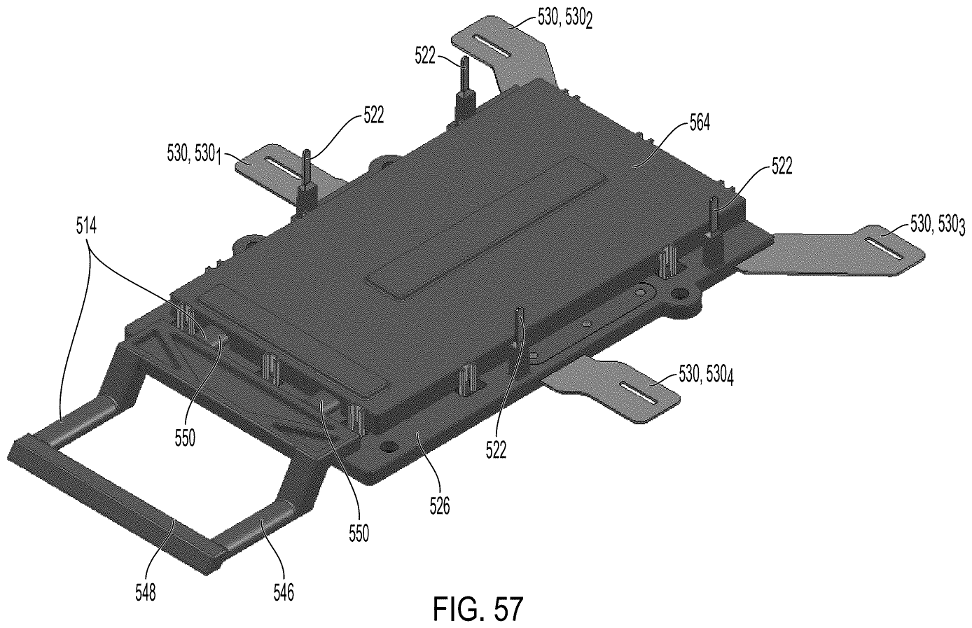

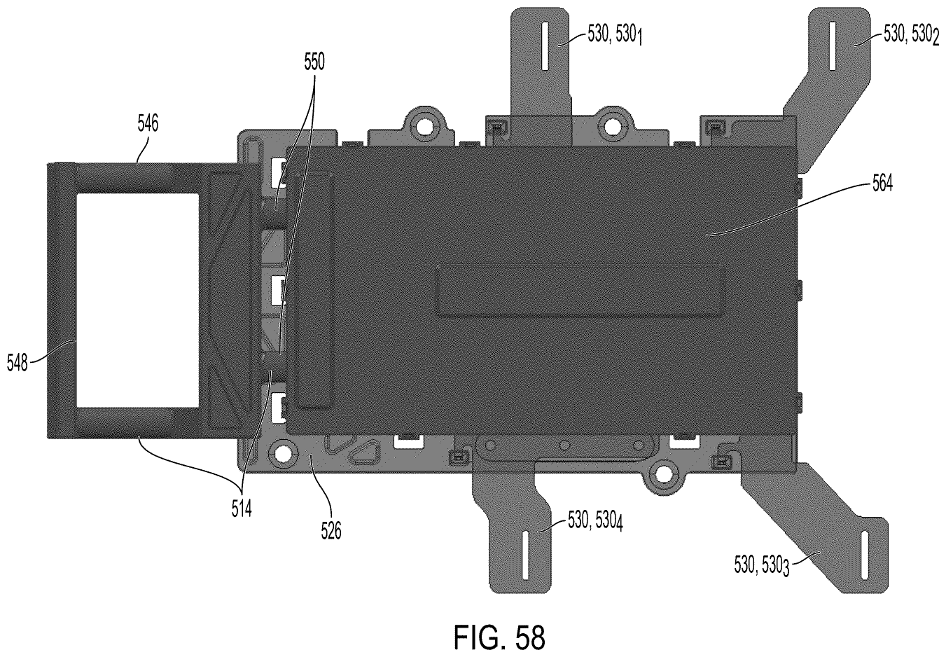

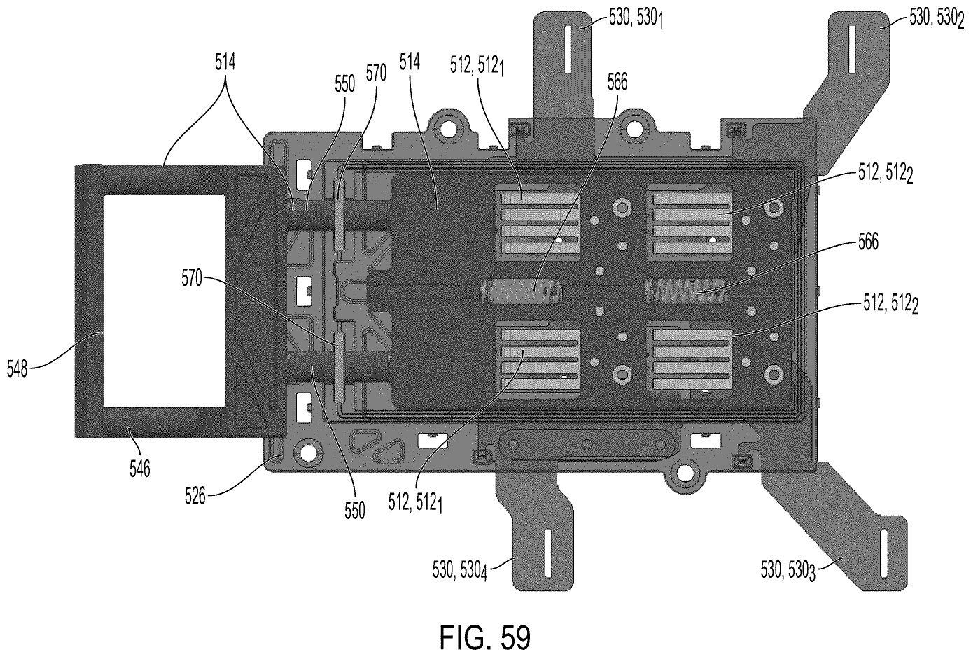

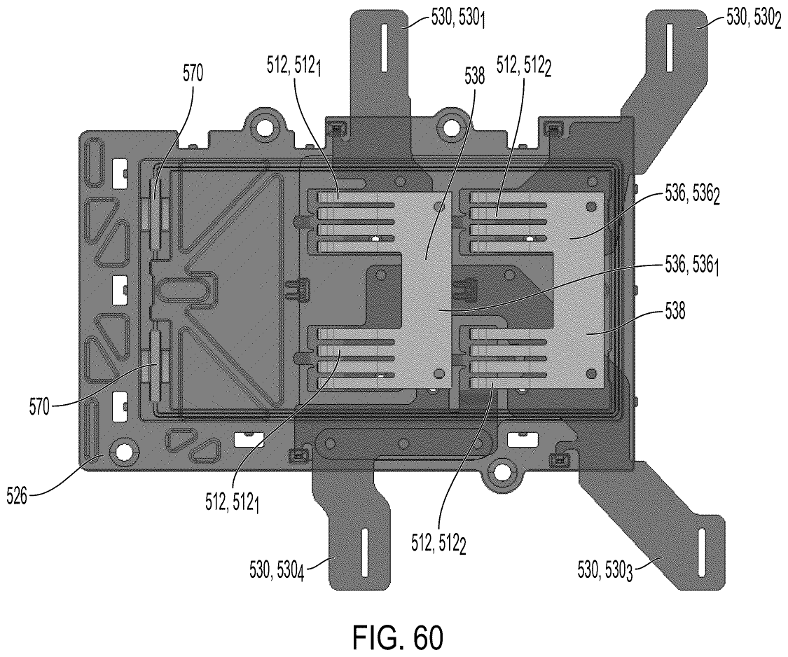

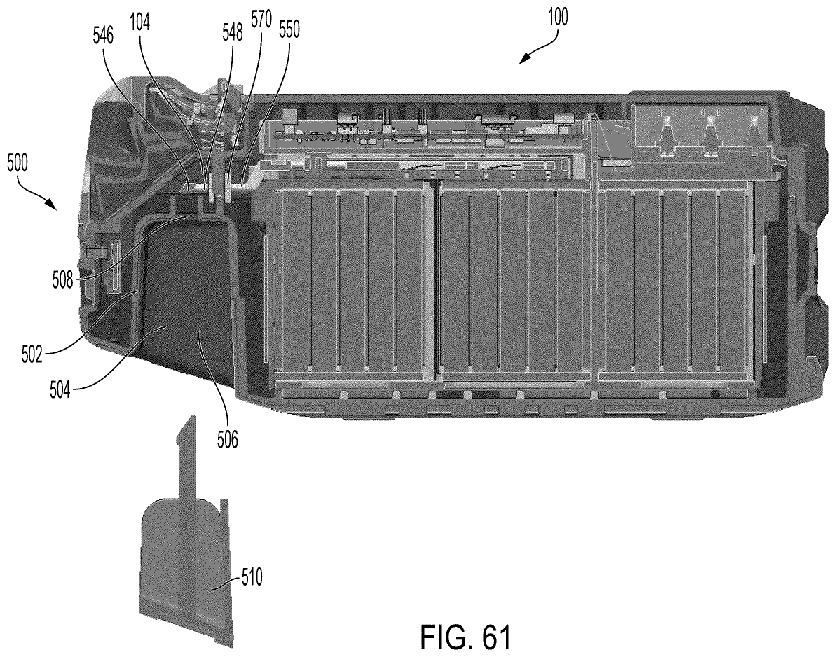

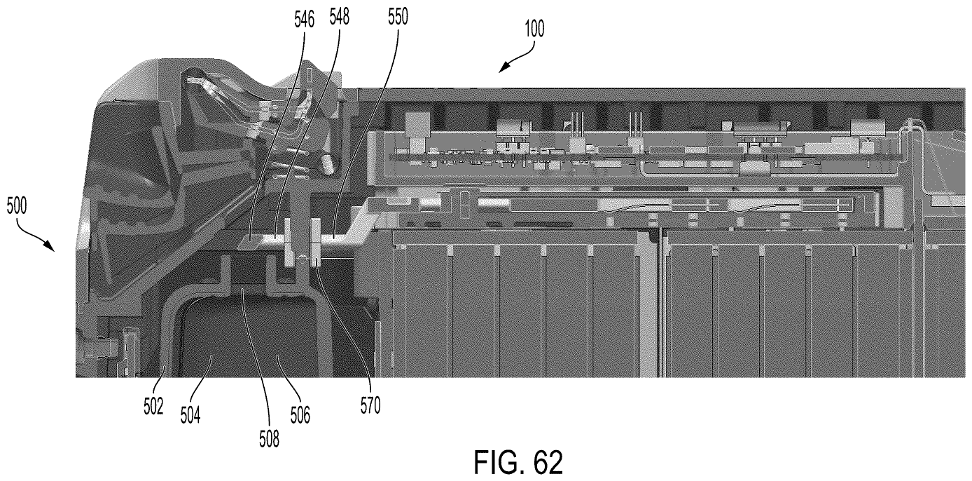

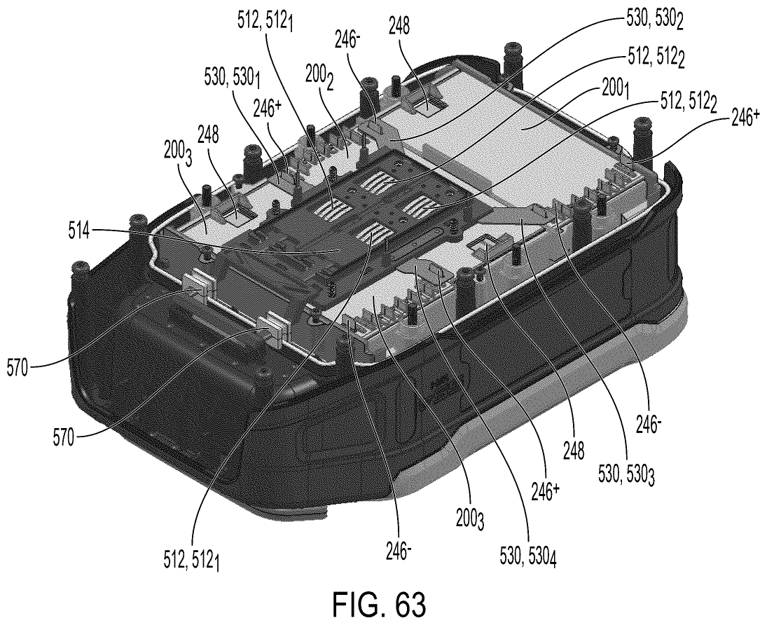

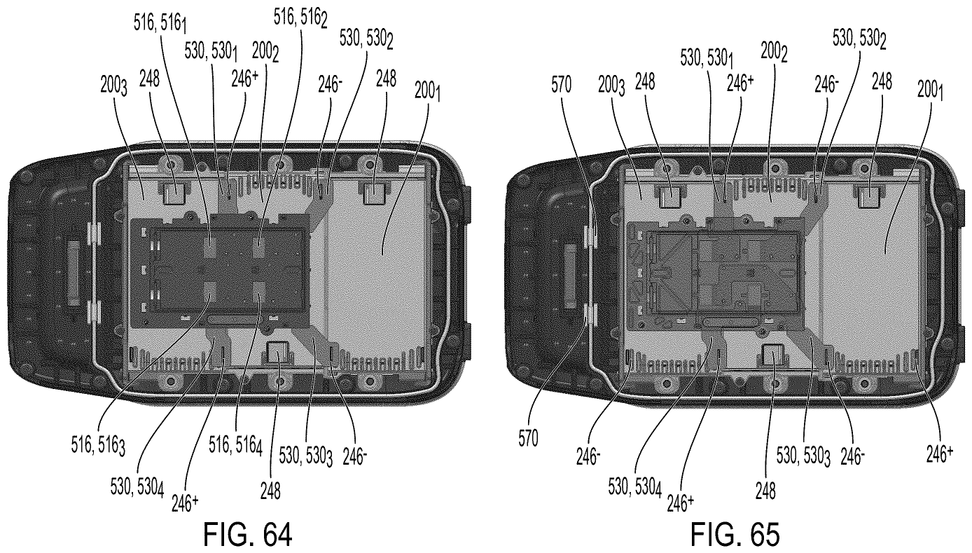

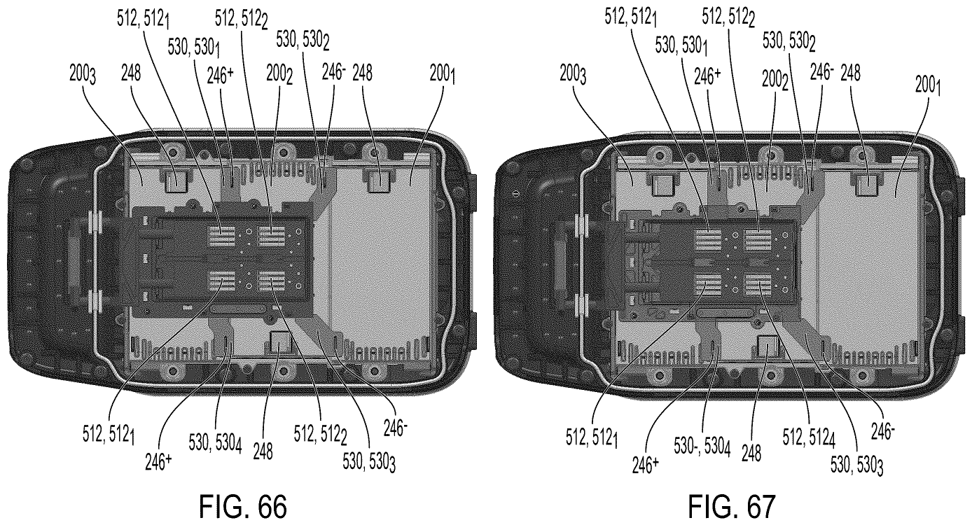

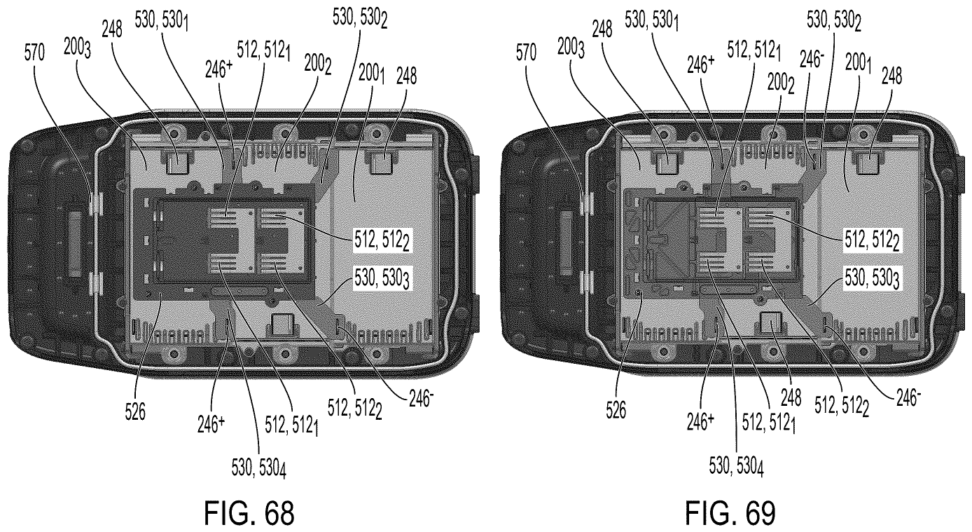

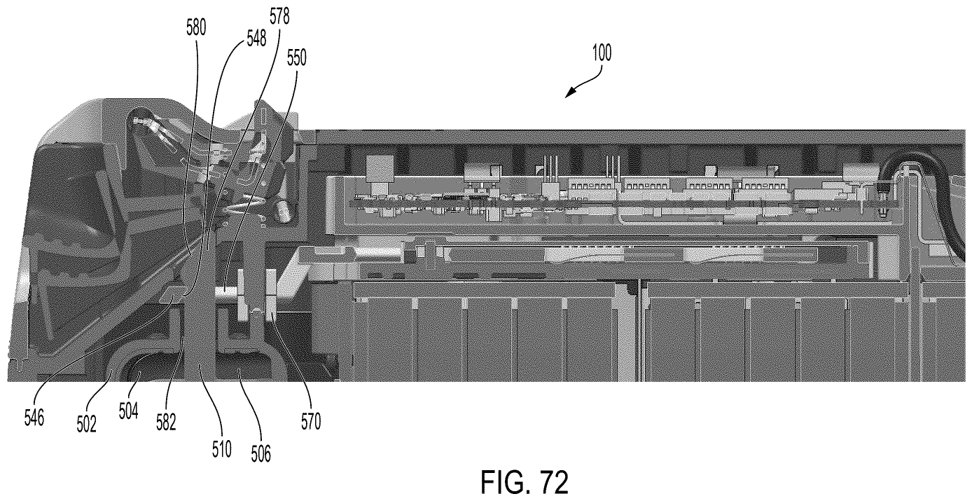

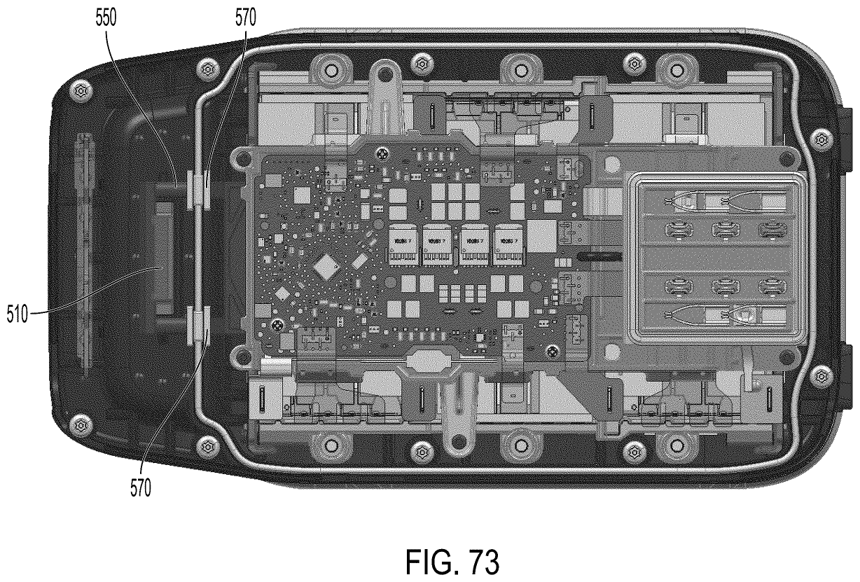

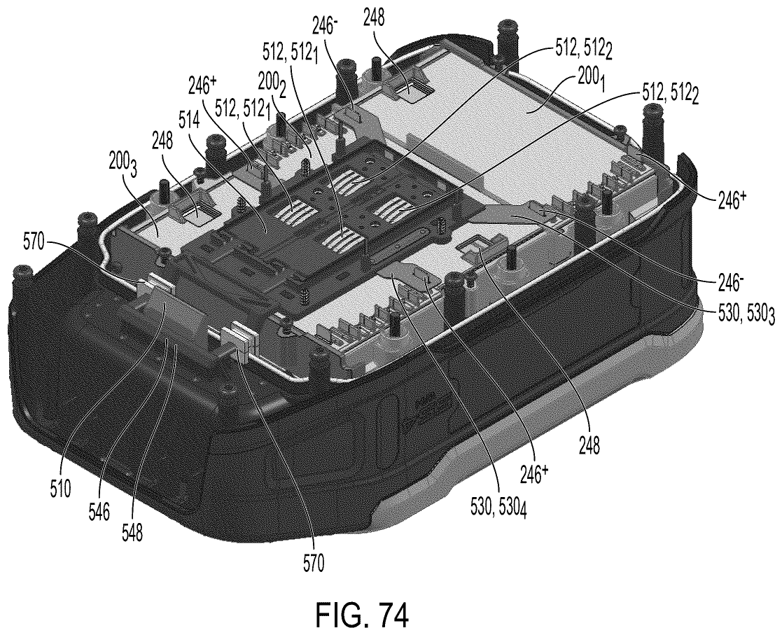

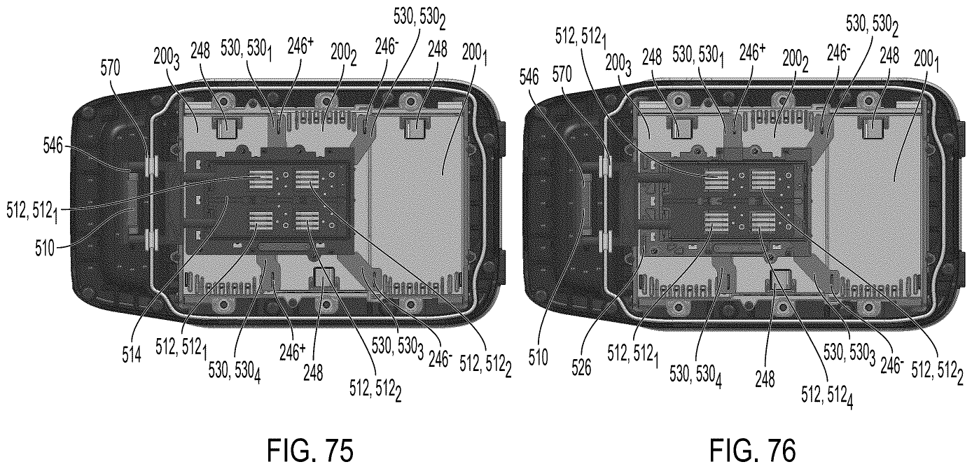

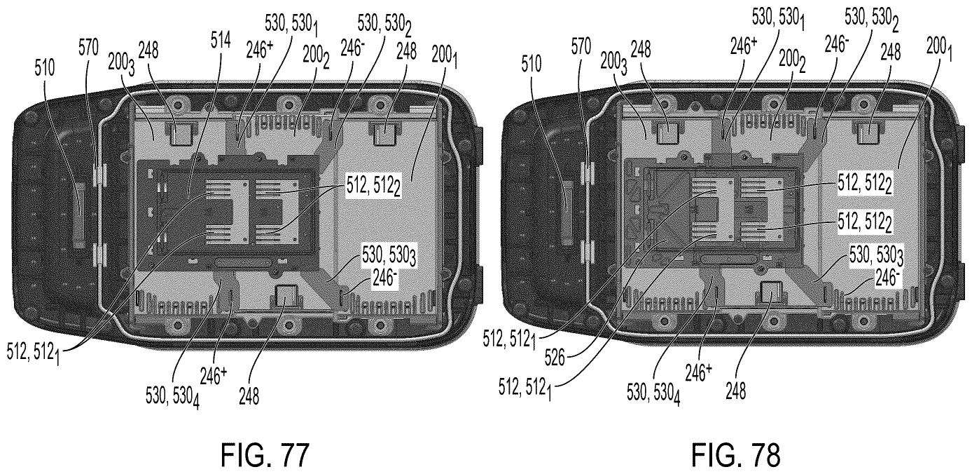

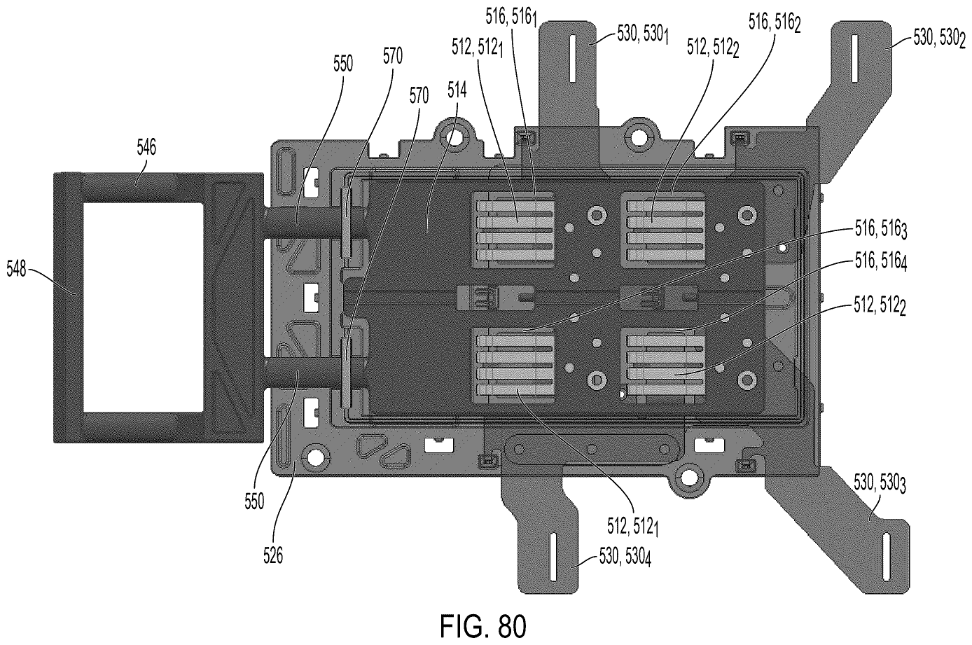

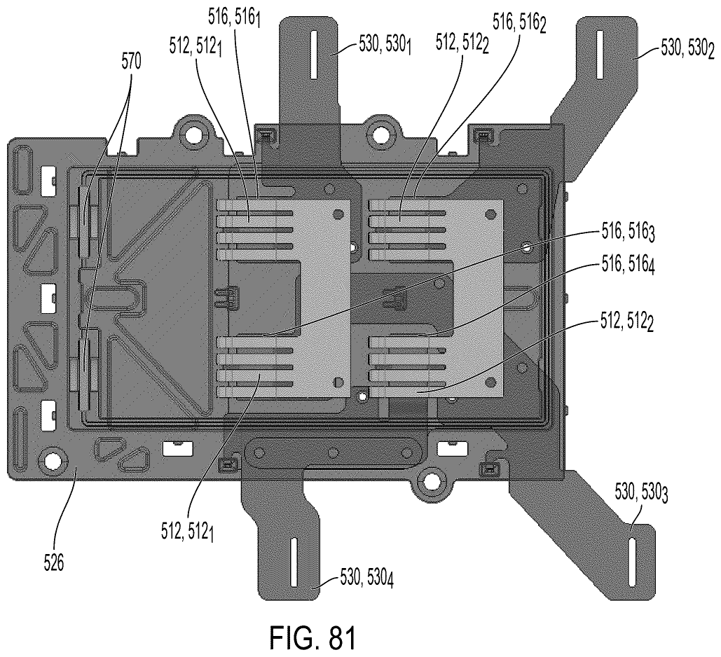

Referring to FIGS. 49-81, the battery pack 100 may include a shipping solution/system subassembly 500. As shown in FIG. 61, the shipping system subassembly 500 may include a handle 502 having a recess 504 forming a cavity 506. The handle cavity 506 may include an opening 508 to the internal cavity 104 of the battery pack 100 and an actuation component 510 that is received in the handle cavity 506.

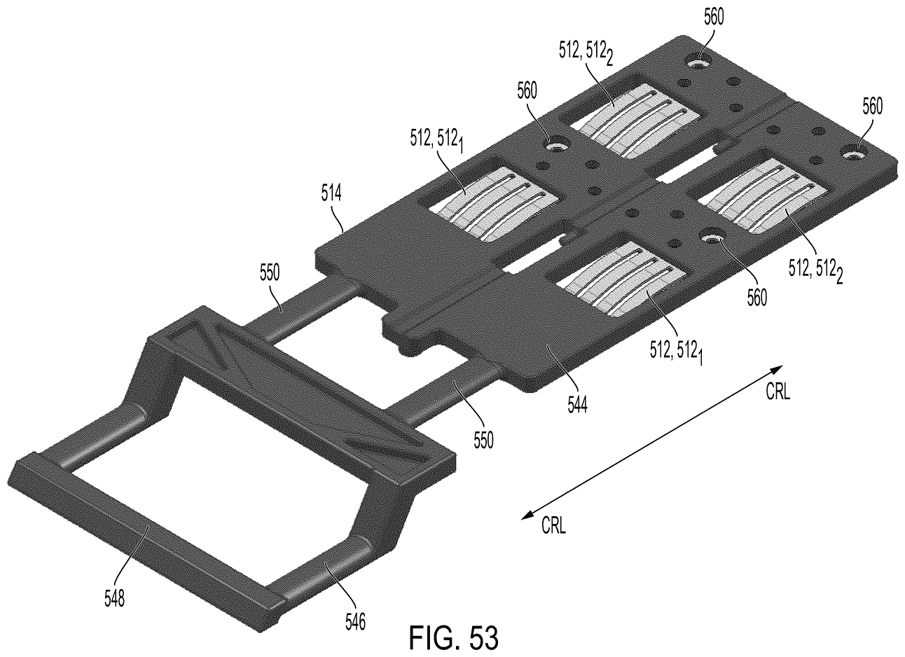

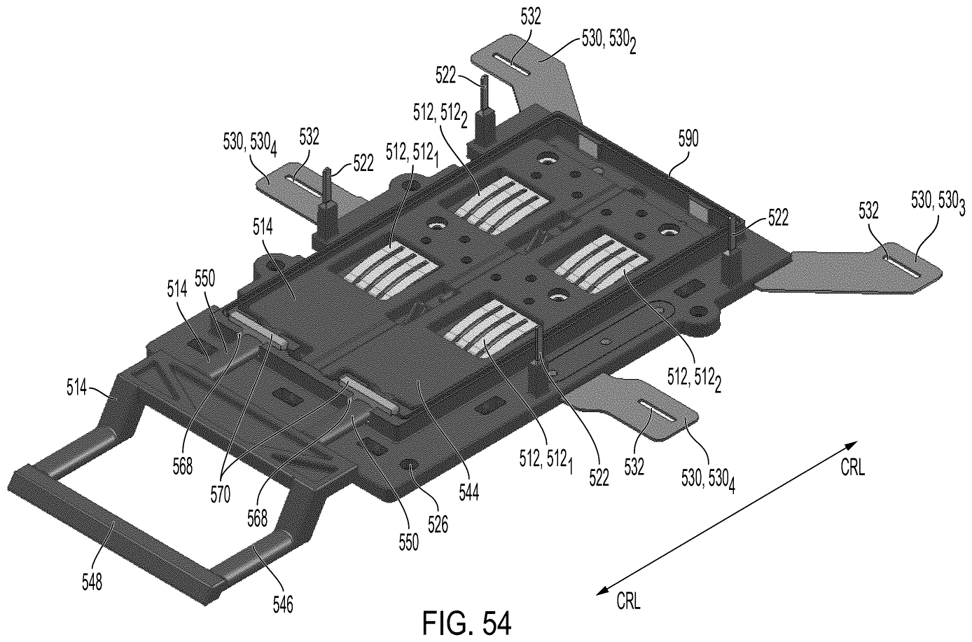

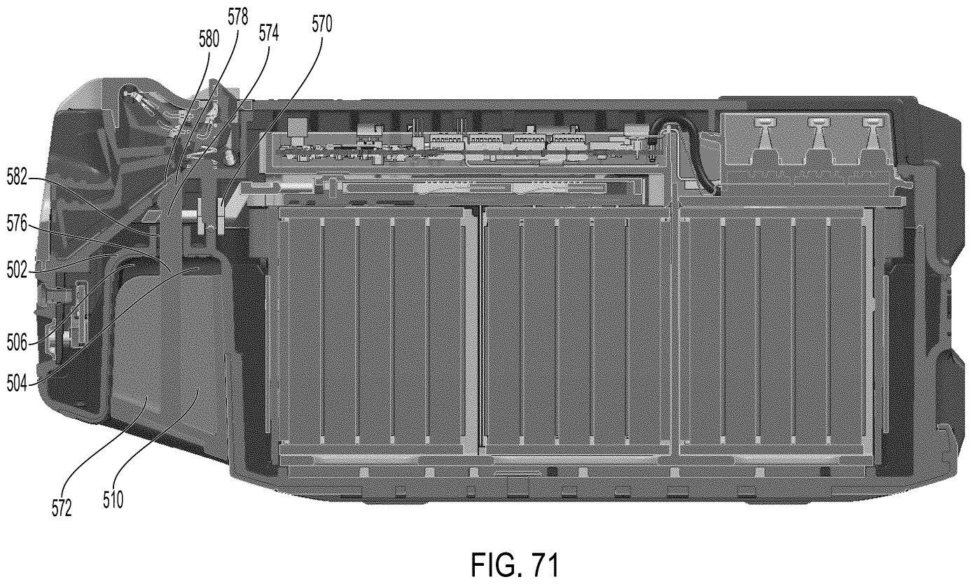

Referring to FIGS. 49-60, the shipping system subassembly 500 may include a plurality of contacts 512 and a contact holding member 514 that is configured to house the contacts 512. The contact holding member 514 may be configured to be translated along a longitudinal axis (e.g., along an axis CRL-CRL as shown in FIGS. 53-54 that is parallel to the longitudinal axis) of the battery pack 100 between a first position (as shown in FIGS. 55, 59-62, and 66-69) and a second position (as shown in FIGS. 71-73 and 75-81). When the contact holding member 514 is in the first position, the contacts 512 are configured to engage with contact pads 516 of the battery pack 100 to complete a power path between battery cells 230 of the battery pack 100 and to connect the battery cells 230 of the battery pack 100 together in series. The contact pads 516 of the battery pack 100 may be configured to be connected to cell taps 518 of the battery pack 100. When the contact holding member 514 is in the second position, the contacts 512 are configured to be disengaged from the contact pads 516 of the battery pack 100 to break the power path between battery cells 230 of the battery pack 100 and to disconnect the battery cells 230 of the battery pack 100. The contacts 512 may include leaf spring style contacts 512.

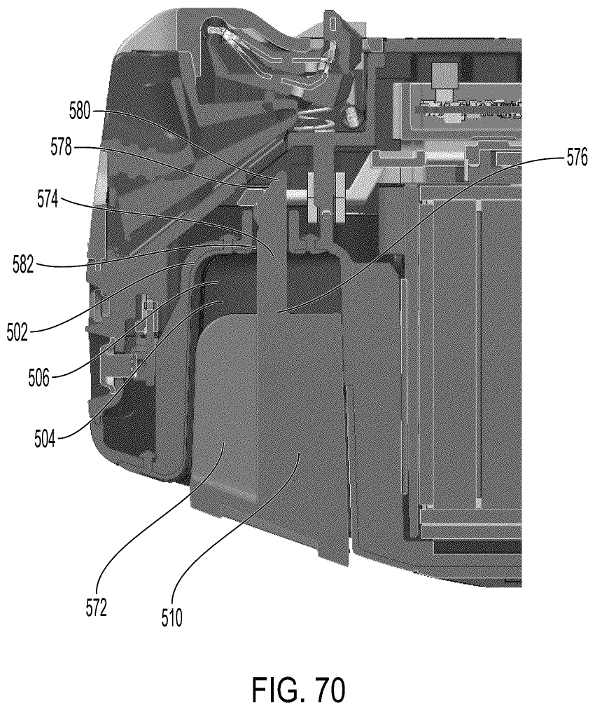

When the contact holding member 514/subassembly 500 is in the first position the battery pack 100 may be referred to as in a use or default mode/configuration/position/state. When the contact holding member 514/subassembly 500 is in the second position the battery pack 100 may be referred to as in the shipping mode/configuration/position/state (e.g., for transportation of the battery pack 100). As shown in FIG. 70, the contact holding member 514 may also have one or more intermediate positions between the first and the second position. The battery pack 100 may include a shipping mode for transportation of the battery pack from a manufacturing facility to a retail facility, a transportation mode where the user of the battery pack may carry the battery pack from one location to the other location, and a use/operation mode.

The contact pads 516 of the battery pack 100 may also be referred to as contacts. The contact pads 516 may be formed as part of a contact pad member 520. The contact pad member 520 is shown in FIG. 49. The contact pad member 520 may be made of a metal material. The contact pad member 520 may have a stamped pattern. Four contact pads 516 (516₁, 516₂, 516₃, and 516₄) are shown in the illustrated embodiments. The number of contact pads 516 in the contact pad member 520 may vary.

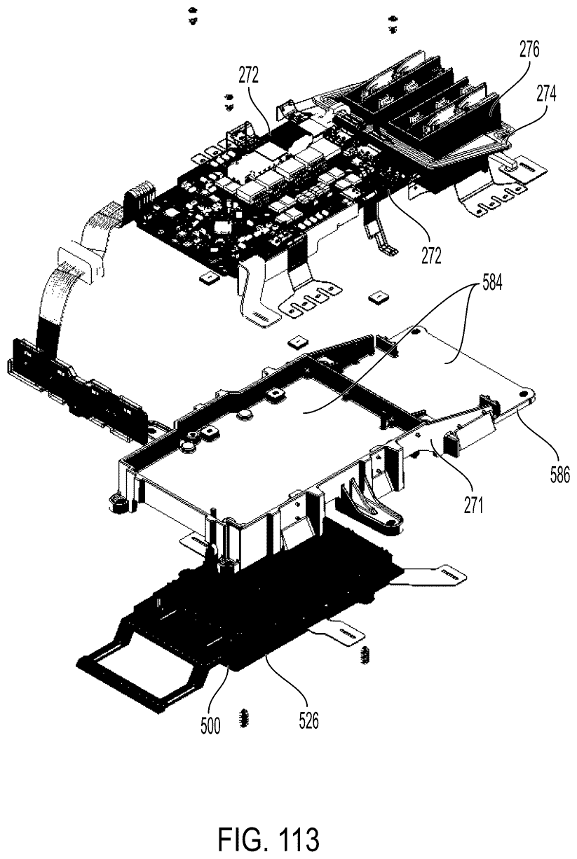

The contact pad member 520 may also include aligning members 522. Four aligning members 522 are shown in the illustrated embodiments. The number of aligning members 522 in the contact pad member 520 may vary. The aligning members 522 may extend generally perpendicular to the contact pad member 520. As will be clear from the discussions in detail with respect to FIGS. 113-119, the aligning portions 522 of the contact pad member 520 may be configured to align and extend through portions 528 of a shipping subassembly base member 526 and also align and extend through portions 592 of the subassembly support 271 to secure the contact pad member 520, the shipping subassembly base member 526 and the subassembly support 271 together.

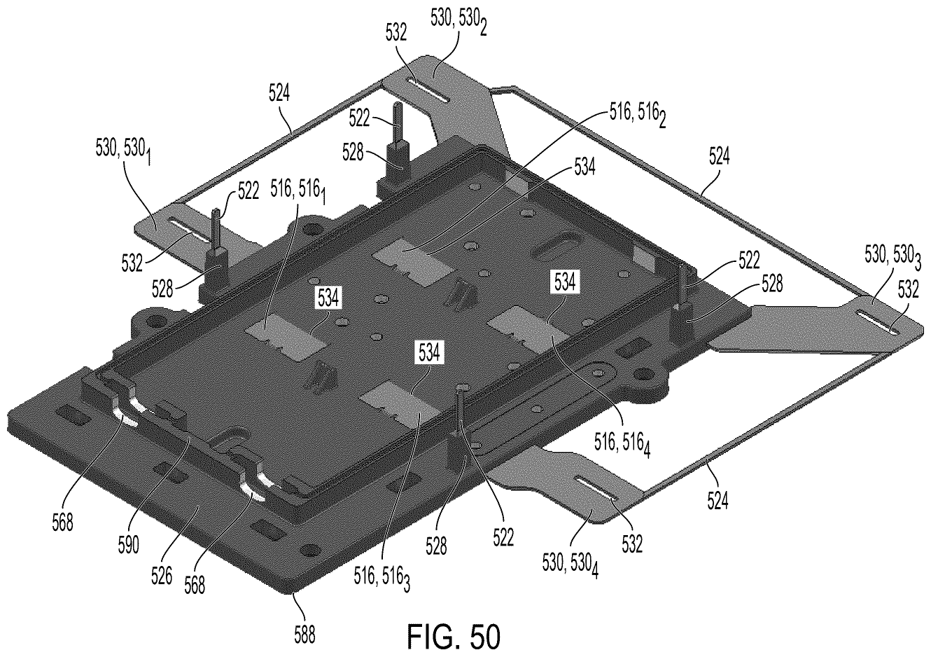

As shown in FIGS. 50-51 and 54-55, the shipping subassembly base member 526 may be disposed on and connected with the contact pad member 520 on a bottom surface 588 thereof. The shipping subassembly base member 526 may be connected to the shipping subassembly cover member 564 on a top surface 590 thereof to enclose the springs 566, the seal members 570, and the contact holding member 514 along with the contacts 512 between the shipping subassembly base member 526 and the shipping subassembly cover member 564.

The contact pad member 520 may also include terminals 530 (5301, 530₂, 530₃, and 530₃). Four terminals 530 are shown in the illustrated embodiments. The number of terminals 530 in the contact pad member 520 may vary. Each of the terminals 530₁, 530₂, 530₃, and 530₄ may include a slot 532 through which a tang of collection strap or terminals 246 +/246⁻ of the battery modules 200 may be received. The first terminal 530₁ may be configured to be connected to the B⁺/246⁺ terminal of the second battery cell module 200₂ and the second terminal 530₂ may be configured to be connected to the B⁻/246⁻ terminal of the second battery cell module 200₂. The third terminal 530₃ may be configured to be connected to the B⁻/246⁻ terminal of the first battery cell module 200₁ and the fourth terminal 530₄ may be configured to be connected to the B⁺/246⁺ terminal of the third battery cell module 200₃.

Each terminal 530 may be configured to be associated with a corresponding contact pad 516. For example, the first terminal 530₁ may be configured to be associated with the first contact pad 516₁, the second terminal 530₂ may be configured to be associated with the second contact pad 516₂, the third terminal 530₃ may be configured to be associated with the third contact pad 516₃, and the fourth terminal 530₄ may be configured to be associated with the fourth contact pad 516₄.

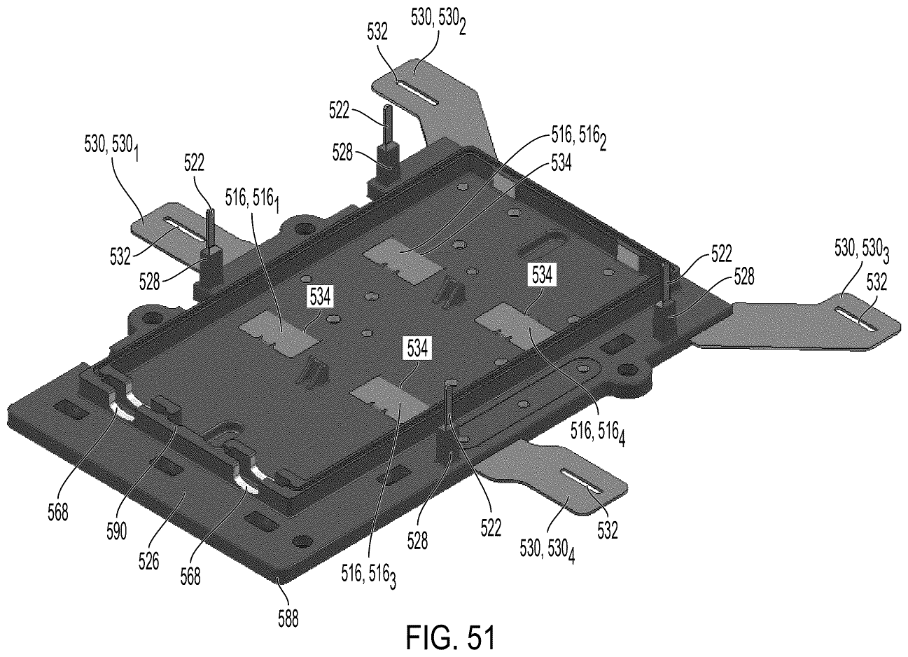

The contact pad member 520 may further include a plurality of connecting structures 524. Three connecting structures 524 are shown in the illustrated embodiments. The number of connecting structures 524 in the contact pad member 520 may vary. The connecting structures 524 of the contact pad member 520 may be configured to connect the terminals 530 (530₁, 530₂, 530₃, and 530₃) to each other (as the contact pad member 520 is being formed as a metal stamped pattern). Comparing FIGS. 50 and 51, the connecting structures 524 of the contact pad member 520 may be removed after the contact pad member 520 is insert molded within the base member 526. The shipping subassembly base member 526 may also be referred to as a base. The shipping subassembly base member 526 may be molded about the contact pad member 520 such that the portions 528 of the shipping subassembly base member 526 are aligned with the aligning portions 522 of the contact pad member 520. The aligning portions 522 of the contact pad member 520 may be configured to align and extend through the portions 528 of the shipping subassembly base member 526 to secure the contact pad member 520 and the shipping subassembly base member 526 together.

The shipping subassembly base member 526 may have openings 534 through which the contact pads 516 of the contact pad member 520 are exposed so as to engage with or disengaged from the contacts 512.

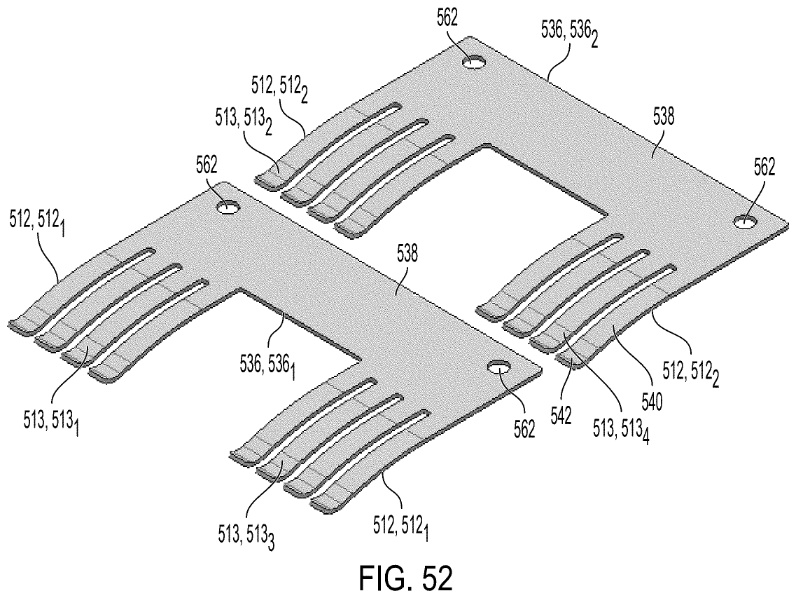

Referring to FIG. 52, the plurality of contacts 512 may include at least two contacts 512 (512₁ and 512₂). Each contact 512 may be configured to contact/engage with two corresponding contact pads 516 of the battery pack 100 to complete a power path between battery cells 230 of the battery pack 100 and to connect the battery cells 230 of the battery pack 100 together in series. For example, the first contact 5121 may be configured to contact/engage with two corresponding contact pads 516₁, 516₃ and the second contact 512₂ may be configured to contact/engage with two corresponding contact pads 516₂, 516₄.

Each of the contacts 512 may include a contact body 536. The contact body 536 may include the at least two contact pad contact portions 513 and a connector portion 538 that is configured to connect the at least two contact pad contact portions 513. The connector portion 538 may also be referred to a connecting leg.

In the illustrated embodiment, as shown in FIG. 50, the first contact 512₁ may include a first contact pad contact portion 513₁ and a second contact pad contact portion 513₃ and the second contact pad 512₂ may include a first contact pad contact portion 513₂ and a second contact pad contact portion 513₄. Each contact pad contact portion 513 may include four leaf spring style contacts. Each contact 512 may include at least one curved tine 540 terminating in a mating portion/tulip 542. A person of ordinary skill in the art would readily appreciate that other configurations, sizes, and shapes of the contacts 512 may be used. Each contact 512 may be referred to as a leg. For example, the contact 512 may include a first leg 513 and a second leg 513. The contacts 512 may also be referred to as sliding jumper contacts as they are configured to be moved/slid along with the contact holding member 514 and they are configured to either engage/contact with or disengage from the contact pads 516 of the battery pack 100.

As shown in FIG. 53, the contact holding member 514 may include a body portion 544 configured to be connected with the contacts 512 and configured to retain the contacts 512 in place, a handle portion 546 having first cam surfaces 548, and connector portions 550 that are configured to connect the handle portion 546 and the body portion 544. As will be clear from the discussions in detail below, the handle portion 546 may be configured to engage with the actuation component 510. The handle portion 546 may be referred to as an engaging bar/arm as it is configured to engage with the actuation component 510. The body portion 544/contact holding member 514 may be referred to as a slider housing as it is configured to be connected to the contacts 512 and as it is configured to slide/move between its first position and its second position.

The contact holding member 514 may include fastener openings/holes 560 in a pattern corresponding to fastener openings/holes 562 of the body 536. Mechanical fasteners (e.g., screws, etc.) may be inserted through the fastener openings/holes 560, 562 after they are aligned, for connecting the contact holding member 514 to the body 536.

As shown in FIG. 53, the shipping subassembly base member 526 may be configured to receive the contact holding member 514 along with the contacts 512 therein.

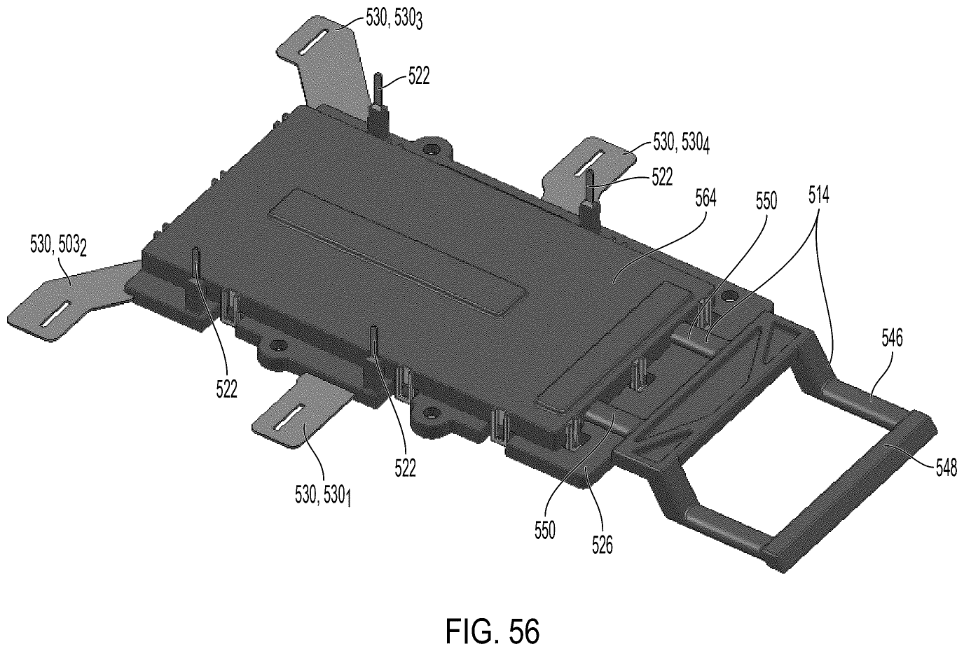

Referring to FIGS. 55-56, the shipping system subassembly 500 may include a shipping subassembly cover member 564 that is configured to connect with the shipping subassembly base member 526 and springs 566 configured to be connected between the contact holding member 514 and the shipping subassembly base member 526. The shipping subassembly cover member 564 may be configured to cover the contact holding member 514 and the contacts 512 received in the shipping subassembly base member 526. The spring 566 may also be referred to as internal springs. The springs 566 are configured to bias (exert a force against) the contact holding member 514 in a first direction (in the direction Y as shown in FIG. 55) along the longitudinal direction (e.g., the axis CRL-CRL) of the battery pack 100 and with respect to the shipping subassembly base member 526 so as to position and hold the contact holding member 514 in the first (use) position. As shown in FIG. 79, the handle 546 of the contact holding member 514 may be moved in the X direction, against the springs 566, by the actuation element 510 so as to move the contacts 512 into the shipping configuration/mode/state/position.

The actuation component 510 may be configured to engage with the contact holding member 514 to translate the contact holding member 514 from the first position to the second position against the bias of the springs 566 and in an opposing second direction (as shown by the X direction in FIG. 79) along the longitudinal axis (e.g., the axis CRL-CRL) of the battery pack 100.

The actuation component 510 may include an actuation component body 572 sized and configured to be received in the cavity 506 of the handle 502 of the shipping system subassembly 500. The actuation component 510 may also include an actuation element 574 having a first end 576 and second end 578. The actuation element 574 may be configured to be connected to the actuation component body 572 at the first end 576. The actuation element 574 may include second cam surfaces 580 at the second end 578.

Portions (e.g., near the second end 578) of the actuation element 574 may be configured to extend into an opening 582 to the internal cavity 104, when the actuation component body 572 is received in the cavity 506 of the handle 502 of the battery pack 100, such that the second cam surfaces 580 at the second end 578 of the actuation element 574 engages with the first cam surfaces 548 of the handle portion 546 of the contact holding member 514. Surface interactions between the second cam surfaces 580 of the actuation element 574 and the first cam surfaces 548 of the handle portion 546 of the contact holding member 514 cause the contact holding member 514 to translate from the first position to the second position against the bias of the springs 566 and in the opposing second direction (as shown by the X direction in FIG. 79) along the longitudinal axis (e.g., the axis CRL-CRL) of the battery pack 100.

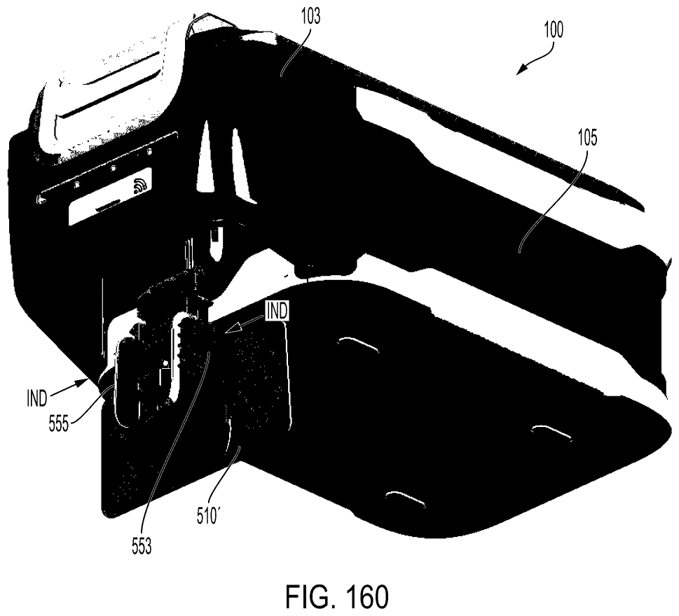

FIGS. 160-161 show another embodiment of the actuation component 510′. FIG. 160 shows the actuation component 510′ before being received in the handle cavity 506, while FIG. 161 shows the actuation component 510′ after being received in the handle cavity 506. For example, the actuation component 510′ may be configured to be held by the user using the user's thumb (e.g., engaging a portion 553 of the actuation portion 510′) and the user's finger (e.g., engaging a portion 555 of the actuation portion 510′) and may be configured to be pressed inwardly (e.g., in the direction IND) so as to release the actuation component 510′ from the handle cavity 506.

The handle 502 may be integrally formed in the housing 102 of the battery pack 100. The handle 502 may be used by a user to carry the battery pack 100 from one location to another location between use.

As shown in FIGS. 50-51 and 54-55, the shipping subassembly base member 526 may include grooves 568 that are configured to receive the connector portions 550 of the contact holding member 514 to allow the contact holding member 514 to translate along the longitudinal axis (e.g., the axis CRL-CRL) of the battery pack 100 and with respect to the shipping subassembly base member 526. Referring to FIGS. 54-55 and 59-60, the shipping subassembly base member 526 may include seal members 570 that are configured to be positioned adjacent the grooves 568 of the shipping subassembly base member 526 and the connector portions 550 of the contact holding member 514 so as to seal the internal cavity 104 of the battery pack 100. The shipping subassembly cover member 564 and the shipping subassembly base member 526 are configured to enclose the springs 566, the seal members 570, and portions of the contact holding member 514 (along with the contacts 512). That is, the handle 546 and some portions of the connector portions 550 of the contact holding member 514 are not disposed between the shipping subassembly cover member 564 and the shipping subassembly base member 526.

Referring to FIGS. 82-105, an electronics subassembly 272 may include the terminal block 276 and a set of battery pack terminals 312 fixedly held in place to the terminal block 276. The set of battery pack terminals 312 may be configured to mate with a corresponding set of terminals 318 of an electrical device 320.

The electrical device 320 may include a charger 320_{C} as shown in FIG. 151. As shown in FIG. 151, the charger 320_{C} may include a set of terminals 318 (e.g., including power terminal CB+, CG and signal terminals CM, S1, S3 and NTC). The electrical device 320 may include a power tool 320_{PT} as shown in FIG. 149. As shown in FIG. 149, the power tool 320_{PT} may include a set of terminals 318 (e.g., including power terminals PTB+, PTB−, signal terminals C4, CM, S1, S3 and NTC). The electrical device terminals 318 of the electrical device 320 may be received in a mating direction by the battery pack 100.

The set of battery pack terminals 312 may include power terminals 312_{PT} and signal terminals 312_{S}. For example, the power terminals 312_{PT} may include a first terminal 322 and a second terminal 324. One of the first terminal 322 and the second terminal 324 may be a positive (battery pack) terminal and the other of the first terminal 322 and the second terminal 324 may be a negative (battery pack) terminal. The first terminal 322 and the second terminal 324 are parallel to each other and extend along a longitudinal axis TBL-TBL (as shown in FIGS. 92-104) of the terminal block 276. For example, as shown in FIG. 150, one of the first terminal 322 and the second terminal 324 may be a positive (battery pack) terminal (i.e., BPB+) and the other of the first terminal 322 and the second terminal 324 may be a negative (battery pack) terminal (i.e., BPB-). Referring to FIG. 149, the signal terminals 312_{S} may include six signal or communication terminals. The signal terminals 312_{S} may include BPS1, BPS3, BPCM, BPNTC, and BPC4. During discharge, the power path may be through the terminal BPB+ and the terminal BPB-. During charge, the power path may be through the terminal BPB+ and the terminal CG (i.e., charge ground).

The terminal block 276 may be referred to as battery/battery pack terminal block. The terminal block 276 may include the (battery pack) terminal block housing 274. Referring to FIGS. 92-105, the terminal block housing 274 may include receiving portions 344₁, 344₂, 344₃, and 344₄. The receiving portions 344₁ and 344₄ may be disposed at the outer ends of the terminal block 276 and may be configured to receive the power terminals 312_{PT} (i.e., first terminal 322 and second terminal 324). The receiving portions 344₂ and 344₃ may be disposed between the receiving portions 344₁ and 344₄ and may be configured to receive the signal terminals 312_{S} (e.g., BPS1, BPS3, BPCM, BPNTC, and BPC4 as shown in FIG. 150) and the negative charging terminal CG. The terminal block housing 344 may be made of a plastic material.

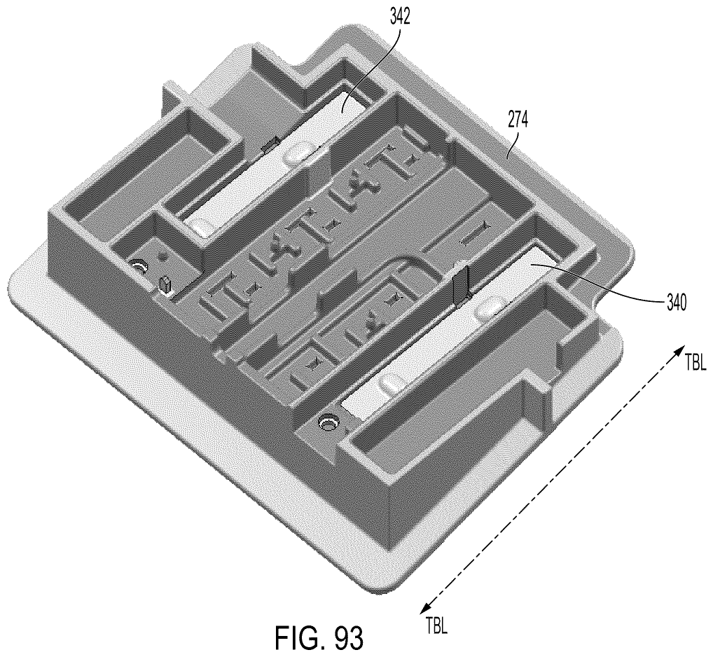

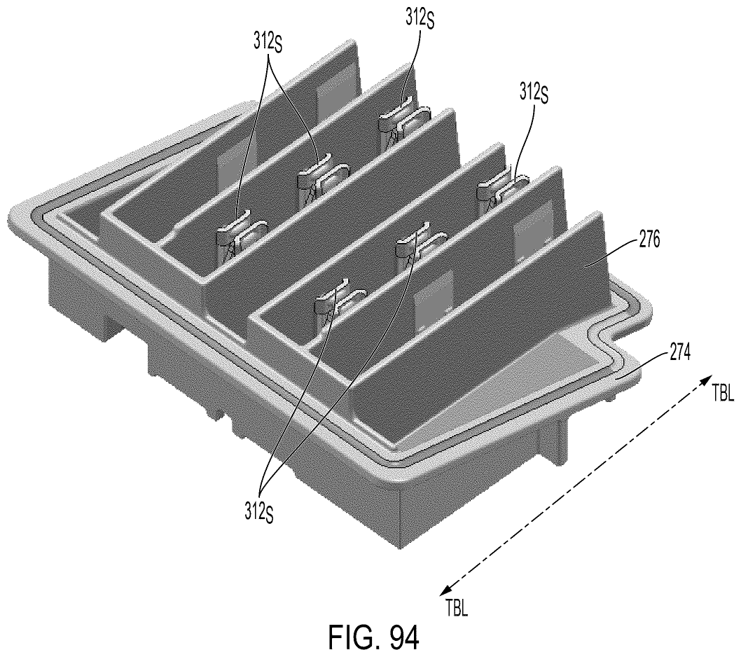

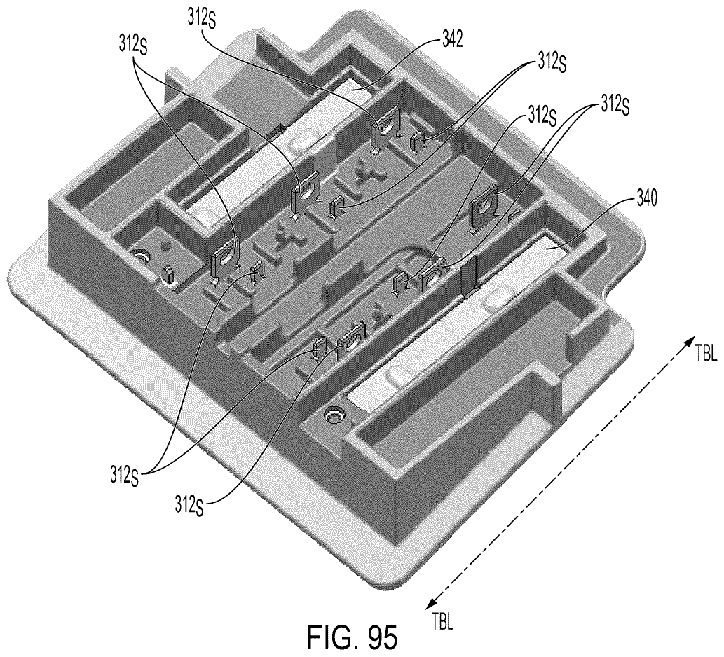

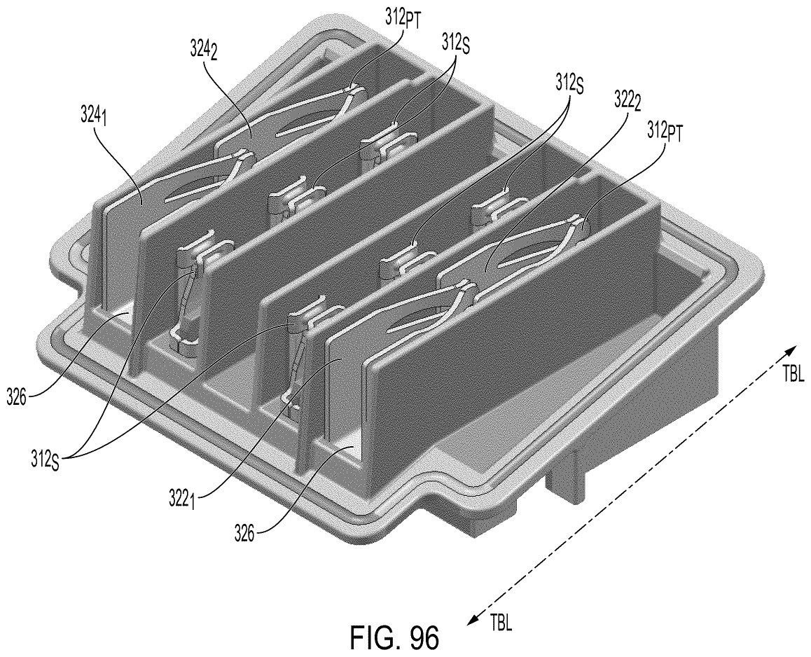

FIGS. 92 and 94 show top perspective views of the terminal block 276 of the battery pack 100, while FIGS. 93 and 95 show bottom perspective views of the terminal block 276 of the battery pack 100. FIGS. 92 and 93 show the terminal block housing 274 without the power terminals 312_{PT} and the signal terminals 312_{S} disposed therein. FIGS. 94 and 95 show the terminal block housing 274 (without the power terminals 312_{PT} disposed therein but) with the signal terminals 312_{S} disposed therein. FIGS. 96-99 show top perspective views of the battery pack terminal block, wherein the signal terminals 312_{S} and the power terminals 312_{PT} are both shown.

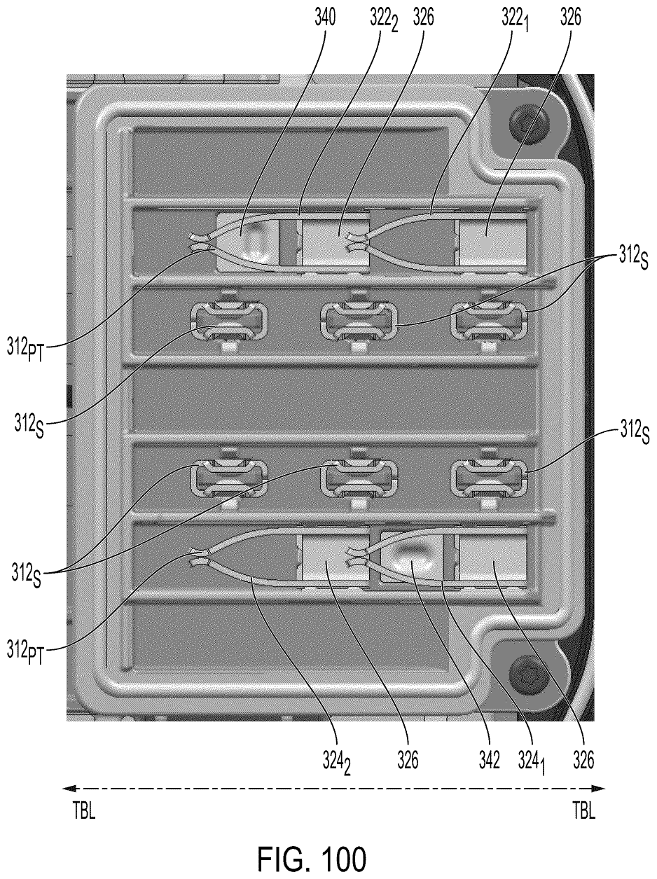

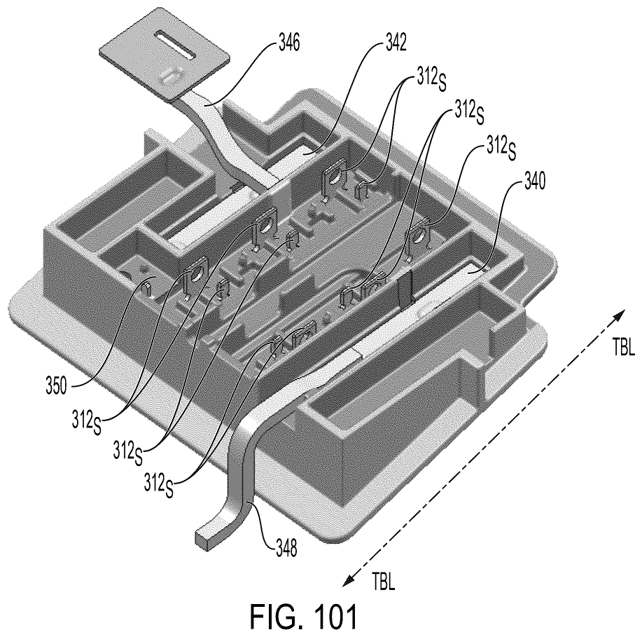

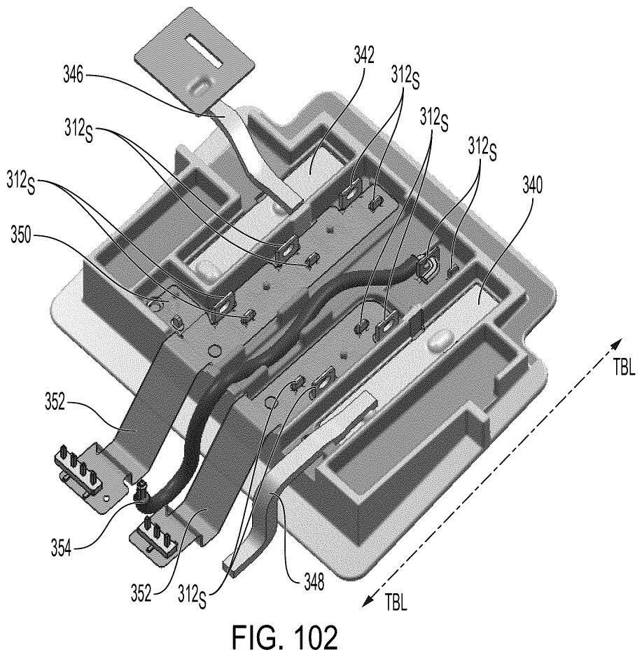

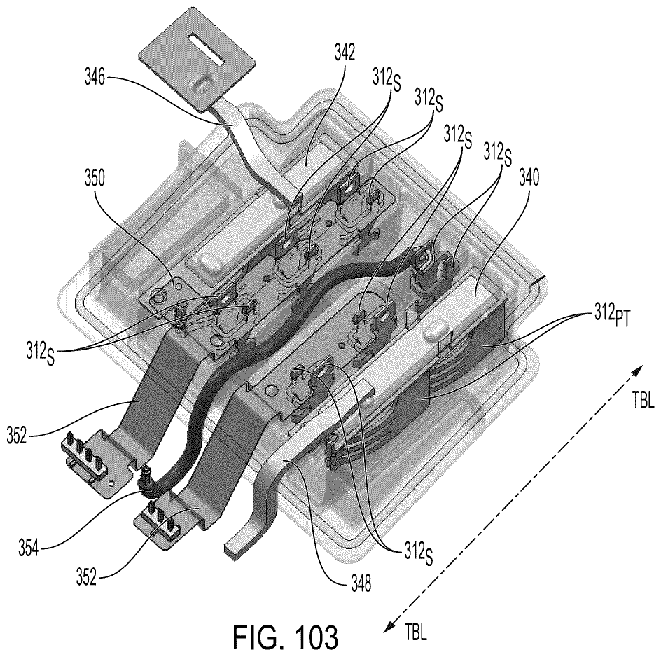

FIGS. 100-101 show top and bottom elevational views of the battery pack terminal block 276, wherein the metal, insert molded terminal base 340, 343, (portions of) the signal terminals 312_{S} and (portions of) the power terminals 312_{PT} are shown. FIGS. 102-103 show bottom plan views of the battery pack terminal block 276. Portions of the signal terminals 312_{S}, portions of the power terminals 312_{PT}, terminal block power path terminals 346, 348, flex circuits 352, wire 354, and soldered tang 350 for the flex circuit on insert molded metal are all shown. The battery pack terminal block housing 274 is shown as transparent in FIG. 103 so as to better illustrate other portions of the signal terminals 312_{S}, and other portions of the power terminals 312_{PT}.

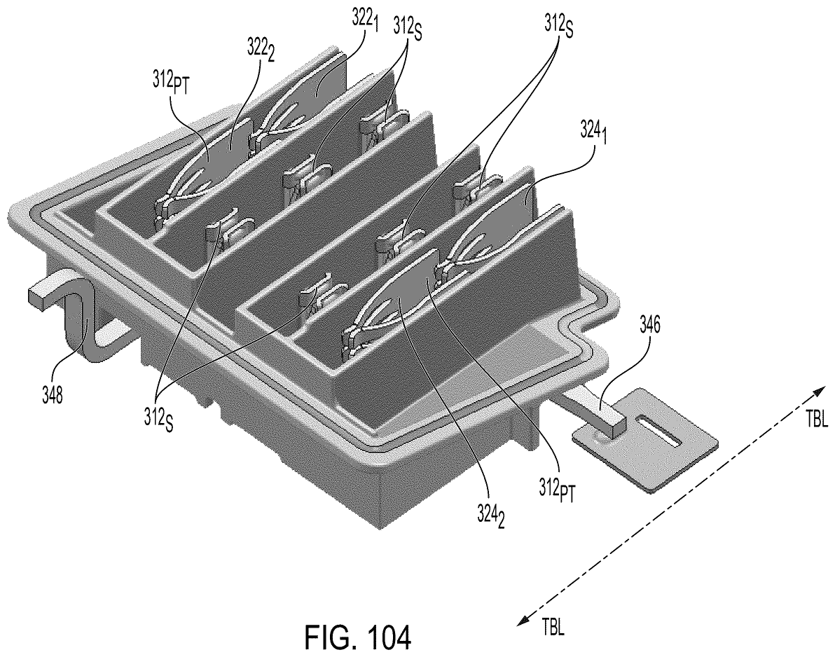

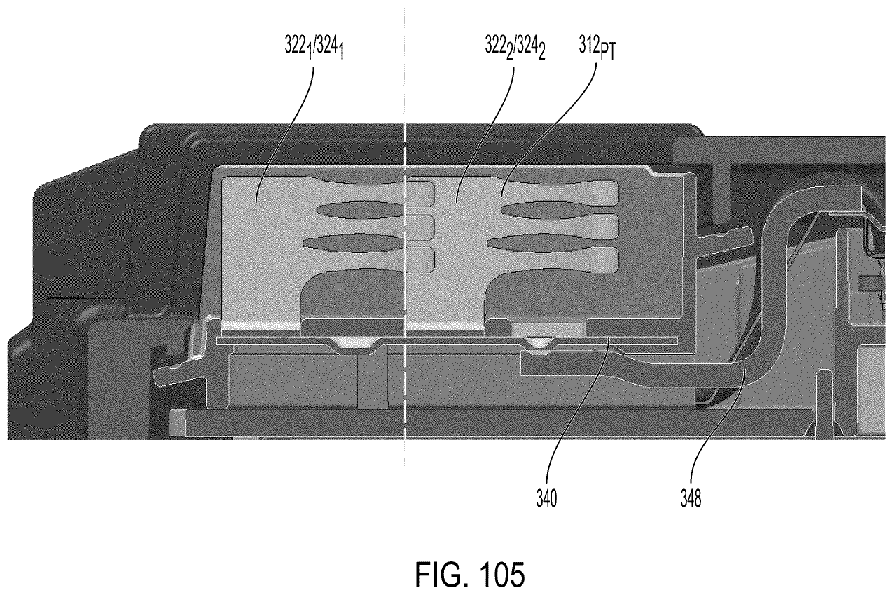

FIG. 104 shows a top plan view of the battery pack terminal block 276. Portions of the signal terminals 312_{S}, portions of the power terminals 312_{PT} and the terminal block power path terminals 346, 348 are shown. FIG. 105 shows a partial right side cross-sectional view of the battery pack terminal block 276 disposed in the battery pack 100. The portions of the power terminals 312_{PT}, the metal, insert molded terminal base 340, 342, and the terminal block power path terminals 346, 348 are shown. For example, the bases 326 of the first terminal 322/324 may be laser welded to the corresponding metal, insert molded terminal base 340, 342.

The first terminal 322 of the set of battery pack terminals 312 may include a first portion 322₁ for contacting a first electrical device contact (e.g., power terminal PTB+ or power terminals PTB− as shown in FIG. 149) and a second portion 322₂ for contacting the first electrical device contact (e.g., power terminal PTB+ or power terminals PTB− as shown in FIG. 149). The first portion 322₁ and the second portion 322₂ are nested together. FIGS. 82-91 show various views of the nested power terminals 322/324 of the battery pack 100.

The second terminal 324 of the set of battery pack terminals 312 includes a first portion 324₁ for contacting a second electrical device contact (e.g., power terminals PTB− or power terminal PTB+ as shown in FIG. 149) and a second portion 324₂ for contacting the second electrical device contact (e.g., power terminals PTB− or power terminal PTB+ as shown in FIG. 149). The first portion 324₁ and the second portion 324₂ of the second terminal 324 are nested together.

Each of the first portion 322₁ and the second portion 322₂ of the first terminal 322 and each of the first portion 324₁ and the second portion 324₂ of the second terminal 324 include (a) a base portion 326, (b) opposing side walls 328 that are spaced apart from each other and extend perpendicular to the base portion 326, and (c) terminal contacts 330 that extend forwardly, along the longitudinal axis of TBL-TBL of the terminal block 276, of the side walls 328 and the base portion 326.

For each of the first terminal 322 and the second terminal 324, the terminal contacts 330 of the first portion 322₁/324₁ is configured to be received between the opposing side walls 328 of the second portion 322₂/324₂, when the first portion 322₁/324₁ and the second portion 322₂/324₂ are nested together.

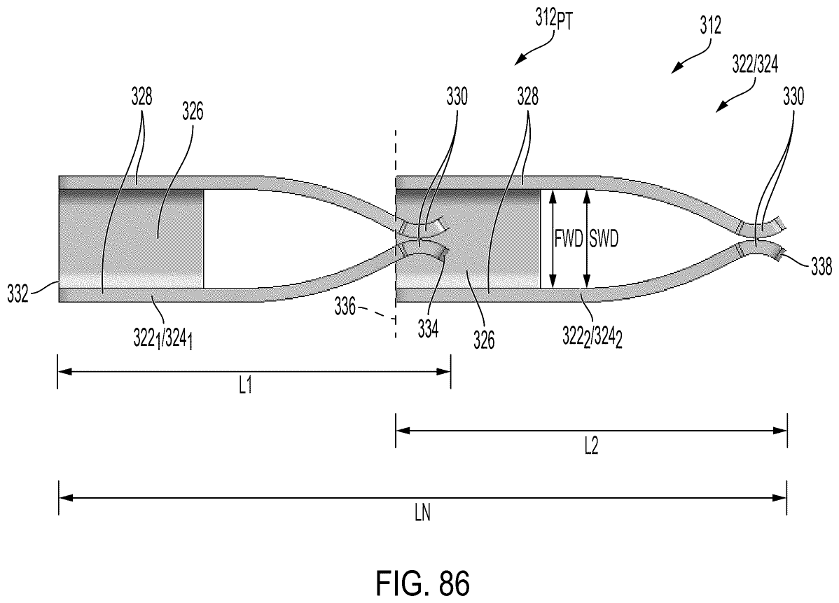

Referring to FIGS. 86-88, for each of the first terminal 322 and the second terminal 324, the first portion 322₁/324₁ includes a first length dimension L₁ measured, along the longitudinal axis TBL-TBL of the terminal block 276, from a first end 332 to a second end 334 of the first portion 322₁/324₁. The second portion 322₂/324₂ may include a second length dimension L₂ measured, along the longitudinal axis TBL-TBL of the terminal block 276, from a first end 336 to a second end 338 of the second portion 322₂/324₂. When the first portion 322₁/324₁ and the second portion 322₂/324₂ are nested together, a nested length dimension L_{N} is measured, along the longitudinal axis TBL-TBL of the terminal block 276, from the first end 332 of the first portion 322₁/324₁ to the second end 338 of the second portion 322₂/324₂. The nested length dimension L_{N} is less than a sum of the first length dimension L₁ of the first portion 322₁/324₁ and the second length dimension L₂ of the second portion 322₂/324₂.

The first length dimension L₁ of the first portion 322₁/324₁ may be the same as the second length dimension L₂ of the second portion 322₂/324₂. The first length dimension L₁ of the first portion 322₁/324₁ may be different from the second length dimension L₂ of the second portion 322₂/324₂.

Referring to FIGS. 92-105, the base portion 326 of the first portion 322₁ of the first terminal 322 may be configured to connect the first portion 322₁ of the first terminal 322 to a first contact portion 340 of the terminal block 276. The base portion 326 of the second portion 322₂/324₂ of the first terminal 322 is configured to connect the second portion 322₂/324₂ of the first terminal 322 to the first contact portion 340 of the terminal block 276.

The base portion 326 of the first portion 324₁ of the second terminal 324 is configured to connect the first portion 324₁ of the second terminal 324 to a second contact portion 342 of the terminal block 276. The base portion 326 of the second portion 324₂ of the second terminal 324 is configured to connect the second portion 324₂ of the second terminal 324 to the second contact portion 342 of the terminal block 276. FIG. 93 shows a bottom perspective view of the battery pack terminal block 276, where the metal, insert molded terminal base contacts 340, 342 are shown.

The first contact portion 340 and the second contact portion 342 of the terminal block 276 may be made of a metal material. The first contact portion 340 and the second contact portion 342 of the terminal block 276 may be insert molded into the terminal block housing 344.

The terminal contacts 330 of the first portion 322₁ and the second portion 322₂ of the first terminal 322 are configured to engage with the first electrical device contact (e.g., power terminal PTB+ or power terminals PTB− as shown in FIG. 149).

The terminal contacts 330 of the first portion 324₁ and the second portion 324₁ of the second terminal 324 are configured to engage with the second electrical device contact (e.g., power terminal PTB+ or power terminals PTB− as shown in FIG. 149).

The terminal contacts 330 of the first portion 322₁ and the second portion 322₂ of the first terminal 322 include tulip terminal contacts 330 that are configured to be separated from each other to receive portions of the first electrical device contact (e.g., power terminal PTB+ or power terminals PTB− as shown in FIG. 149) therebetween. The terminal contacts 330 of the first portion 324₁ and the second portion 324₂ of the second terminal 324 include tulip terminal contacts 330 that are configured to be separated from each other to receive portions of the second electrical device contact (e.g., power terminal PTB+ or power terminals PTB− as shown in FIG. 149) therebetween.

The opposing side walls 328 of the second portion 322₂ of the first terminal 322 are separated from each other by a first width dimension FWD. The first width dimension FWD is configured such that, when the first portion 322₁ and the second portion 322₂ of the first terminal 322 are nested together, the first width dimension FWD is configured to allow for separation of the tulips terminal contacts 330 of the first portion 322₁ of the first terminal 322 to receive the portions of the first electrical device contact (e.g., power terminal PTB+ or power terminals PTB− as shown in FIG. 149) therebetween.

The opposing side walls 328 of the second portion 324₂ of the second terminal 324 are separated from each other by a second width dimension SWD. The second width dimension SWD is configured such that, when the first portion 324₁ and the second portion 324₂ of the second terminal 324 are nested together, the second width dimension SWD is configured to allow for separation of the tulips terminal contacts 330 of the first portion 324₁ of the second terminal 324 to receive the portions of the second electrical device contact (e.g., power terminal PTB+ or power terminals PTB− as shown in FIG. 149) therebetween.

The first width dimension FWD of the second portion 322₂ of the first terminal 322 may be the same as the second width dimension SWD of the second portion 324₂ of the second terminal 324.

The first width dimension FWD of the second portion 322₂ of the first terminal 322 may be different from the second width dimension SWD of the second portion 324₂ of the second terminal 324.

The first portion 322₁ and the second portion 322₂ of the first terminal 322 are at the same potential. The first portion 324₂ and the second portion 324₂ of the second terminal 324 are at the same potential.

Referring to FIGS. 82-89, for each of the first terminal 322 and the second terminal 324, the terminal contacts 330 at the second end 334 of the first portion 322₁/324₁ are configured to overlap with the base portion 326 at the first end 336 of the second portion 322₂/324₂ when the first portion 322₁/324₁ and the second portion 322₂/324₂ are nested together. For each of the first terminal 322 and the second terminal 324, portions (e.g., near the terminal contacts 330) of the first portion 322₁/324₁ are configured to overlap, along the longitudinal direction TBL-TBL of the terminal block 276, with portions (e.g., near the base 326) of the second portion 322₂/324₂ when the first portion 322₁/324₁ and the second portion 322₂/324₂ are nested together.

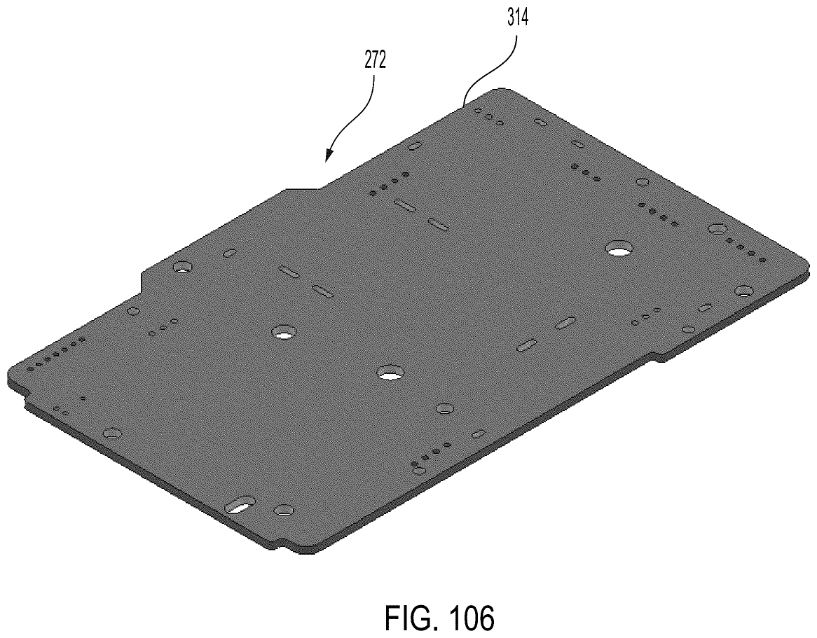

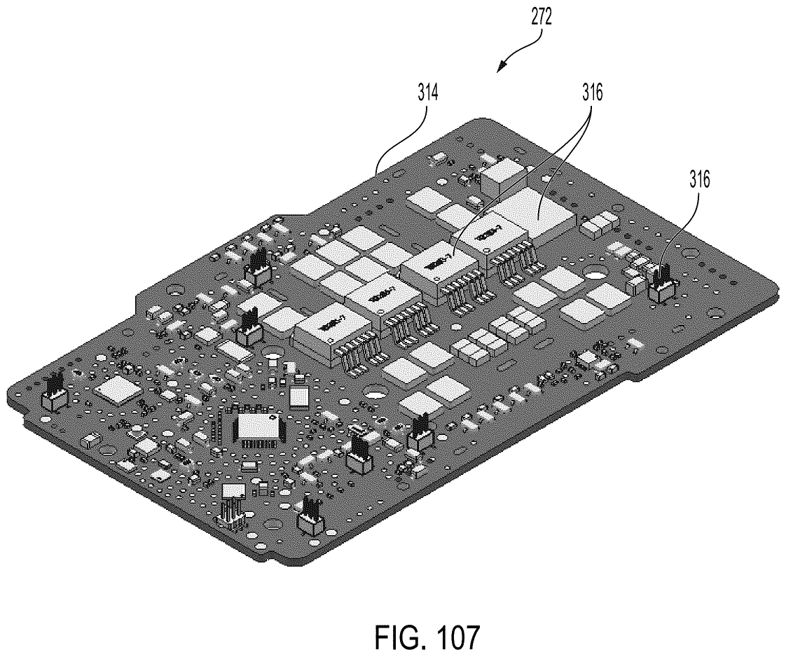

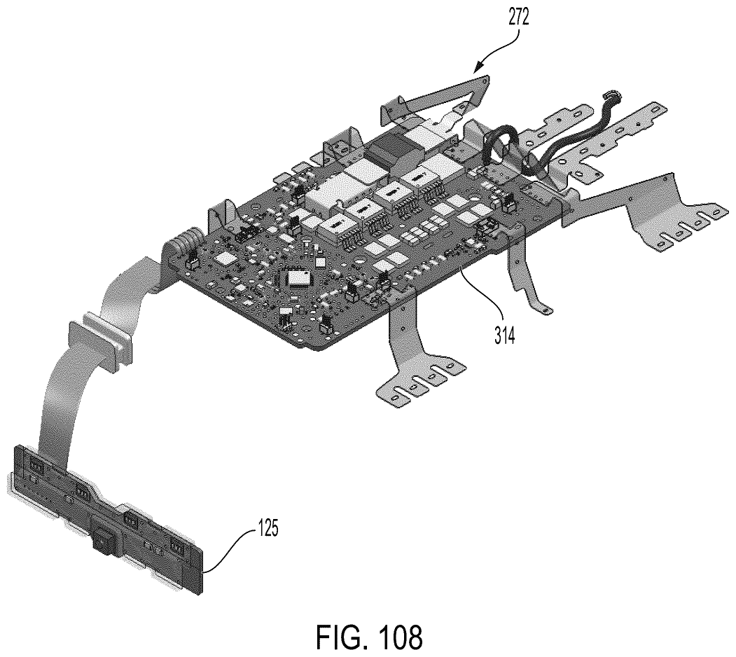

FIGS. 106-108 show perspective views of the electronics module subassembly 272 of the battery pack 100. FIG. 106 shows a base member 314 of the electronics module subassembly 272. The base member 314 may be a printed circuit board (PCB). FIG. 107 shows electronics 316 disposed on the PCB 314. FIG. 108 shows flexible circuits, wires, other connectors, and electronics 316 disposed on the PCB 314. The printed circuit boards may be replaced by other types of circuits, including but is not limited to flexible printed circuits. The electronics subassembly 272 may also be referred to as electronics module subassembly 272.

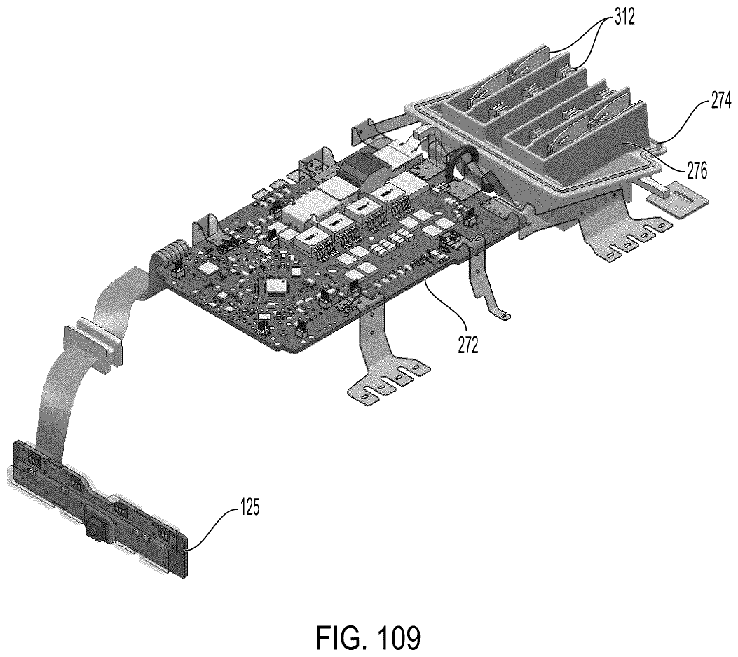

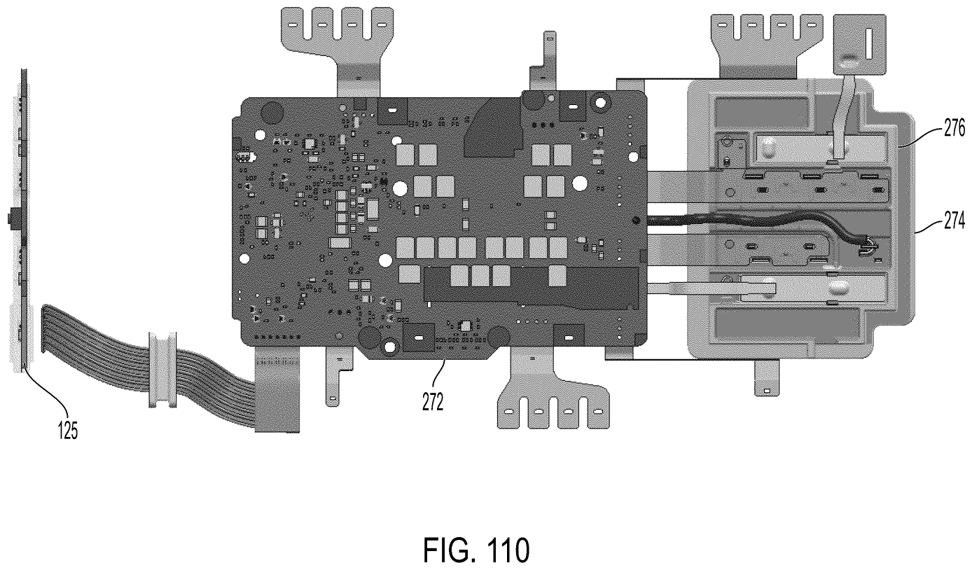

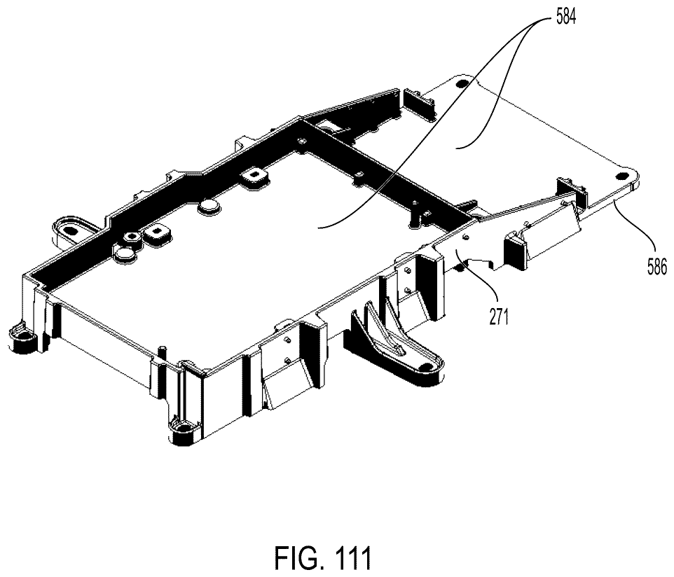

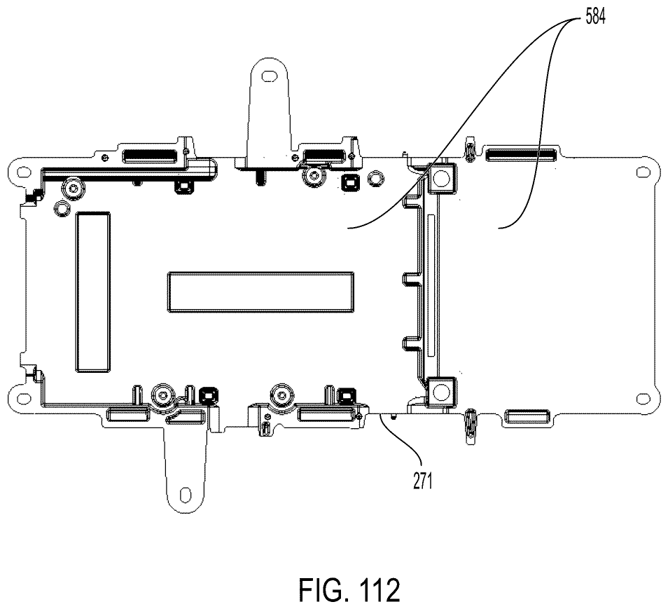

FIGS. 109-110 show views of the electronics module subassembly 272 of the battery pack 100 and the terminal block housing 274 connected thereto. As shown in FIGS. 111-112, the battery pack 100 may further include a subassembly support 271. The subassembly support 271 may be configured to support the electronics module subassembly 272 and the terminal block 276. FIGS. 109-110 also show the SOC PCB 125.

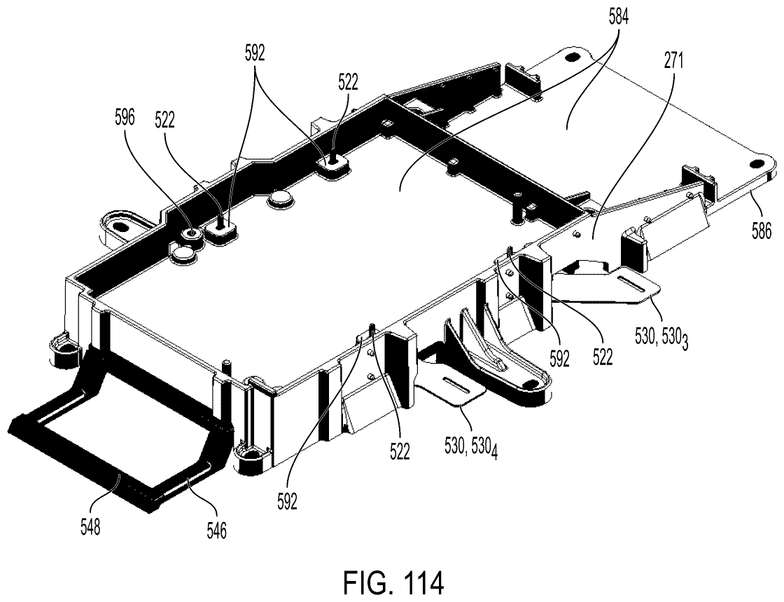

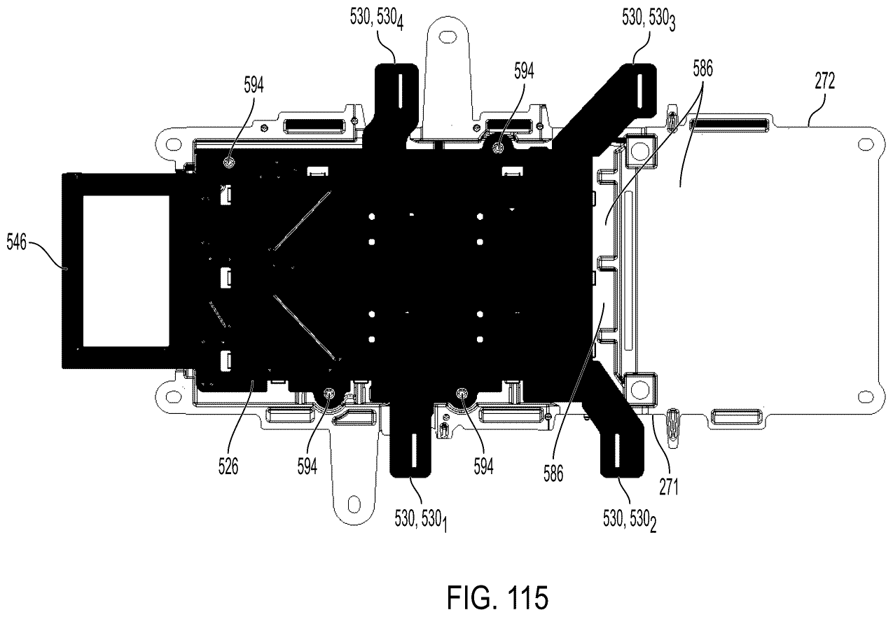

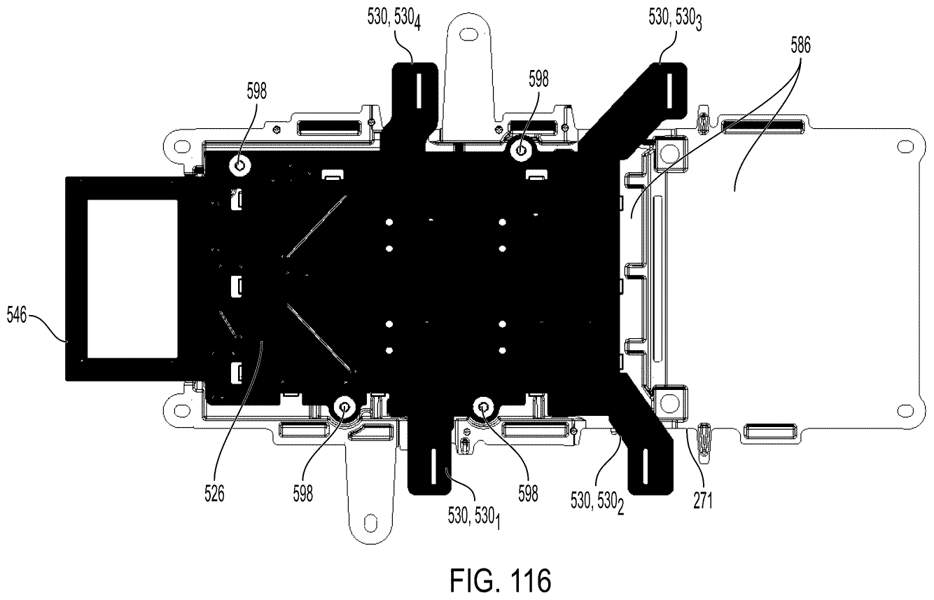

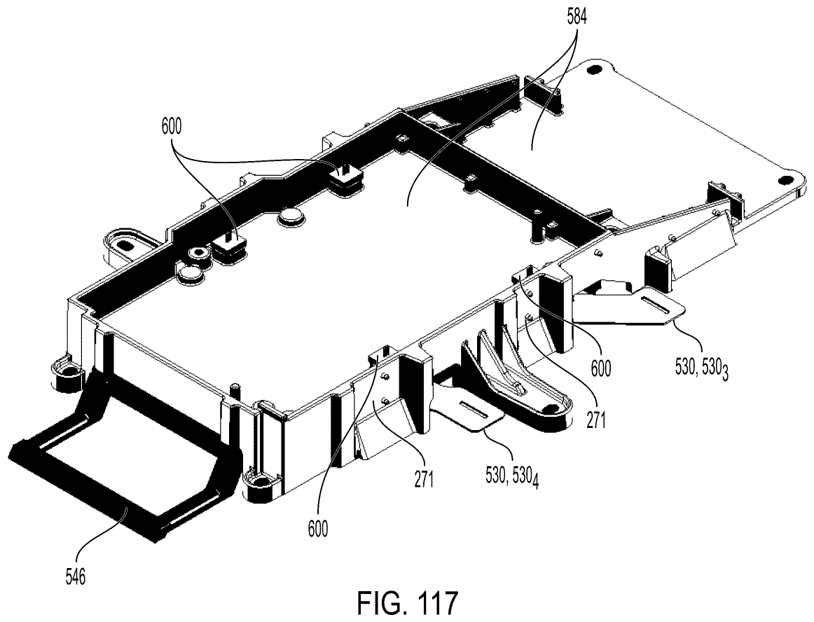

FIG. 113 shows an exploded perspective view of the subassembly holder/support 271, the shipping system 500 and the electronics module subassembly 272 and the terminal block 276. FIGS. 114-115 show views of the subassembly holder/support 271 and the shipping system 500, where the subassembly holder/support 271 and the shipping system 500 are aligned with each other and they are shown before being connected to each other. FIG. 116 shows a bottom plan view of the subassembly support 271 and the shipping system 500, where the subassembly support 271 and the shipping system 500 are shown after they are connected to each other. FIG. 117 shows a perspective view of the subassembly support 271 and the shipping system 500, where the subassembly support 271 and the shipping system 500 are shown after they are connected to each other. Portions of the shipping system 500 may extend through the subassembly support 271, as will be described in discussions below. These portions may be engaged with portions of the electronics module subassembly 272 to monitor the current of the battery pack 100. FIGS. 118-119 show views of the subassembly support 271, the shipping system 500, the battery pack terminal block 276, and the electronics module subassembly 272 after all are connected to each other.

Referring to FIGS. 111-119, the subassembly support 271 may be configured to support the electronics module subassembly 272 and the terminal block 276 on a top surface 584 thereof and may be configured to be connected with a shipping subassembly base member 526 on a bottom surface 586 thereof. The shipping subassembly base member 526 may include fastener openings/holes 594 in a pattern corresponding to fastener openings/holes 596 of the subassembly support 271. Mechanical fasteners (e.g., screws, etc.) 598 may be inserted through the fastener openings/holes 594, 596 after they are aligned, for connecting the shipping subassembly base member 526 to the subassembly support 271. The shipping subassembly base member 526 may be positioned under the subassembly support 271.

As shown in FIG. 117, spacers or support members 600 may be disposed on the portions 592 of the subassembly support 271. The spacers 600 may be configured to align with the aligning portions 522 of the contact pad member 520 of the shipping system 500. The aligning portions 522 of the contact pad member 520 (e.g., protruding/extending through the portions 528 of the shipping subassembly base member 526, the portions 592 of the subassembly support 271, and the spacers 600) may be configured to align the electronics module subassembly 272 and the terminal block 276 on the top surface 584 of the subassembly support 271.

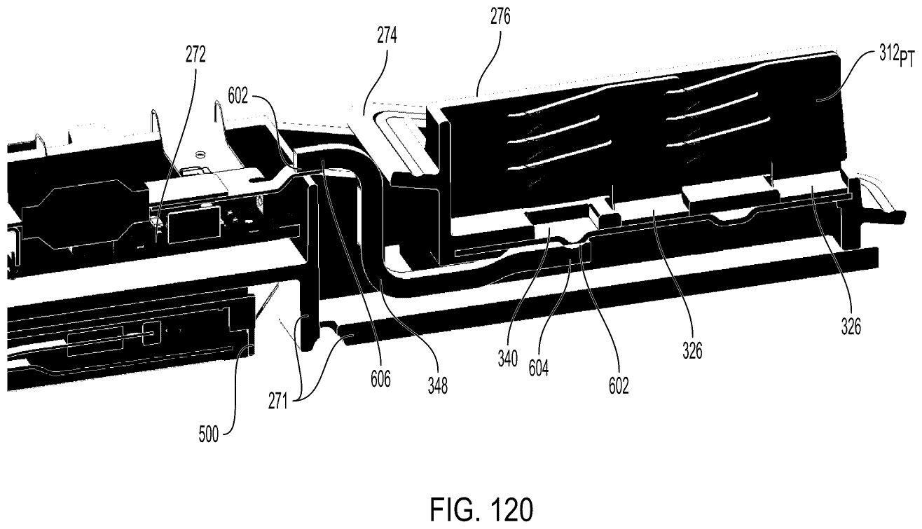

FIG. 120 shows a cross-sectional view of the battery pack terminal block 276 along with portions of the assembled subassembly support 271, the shipping system 500 and the electronics module subassembly 272. Resistance welds 602 may be formed between one end 604 of the terminal block power path terminal (e.g., copper strap) 348 and the metal, insert molded terminal base 340 and also between the other end 606 of terminal block power path terminal 348 and portions of the electronics module subassembly 272.

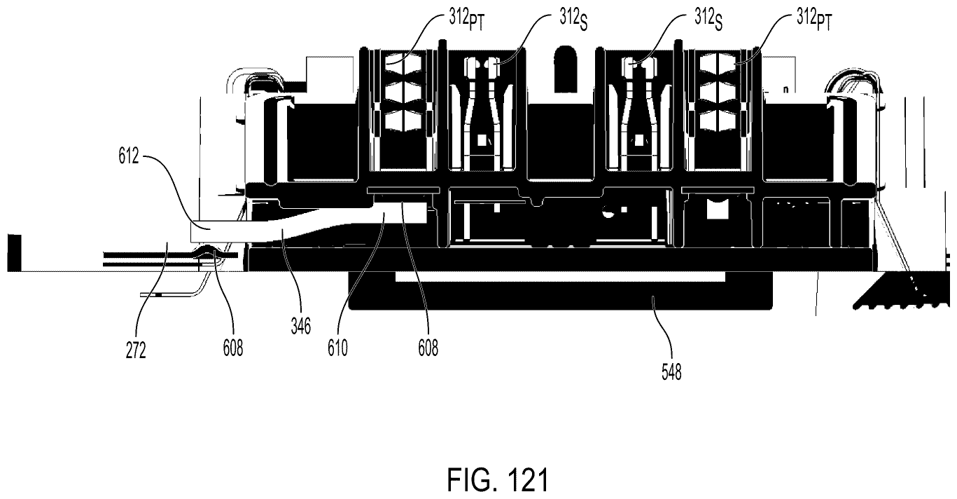

FIG. 121 shows a rear cross-sectional view of the battery pack terminal block 276 along with portions of the assembled subassembly support 271, the shipping system 500 and the electronics module subassembly 272. Resistance welds 608 between one end 610 of the terminal block power path terminal 346 and the metal, insert molded terminal base 342 and between the other end 612 of the terminal block power path terminal 346 and portions of the electronics module subassembly 272 are shown.

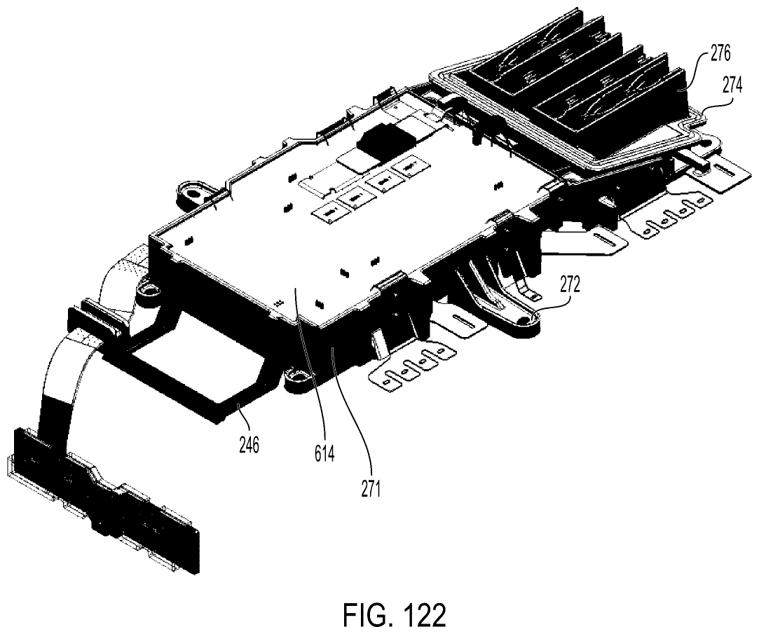

FIG. 122 shows a perspective view of the subassembly support 271, the shipping system 500, the battery pack terminal block 276, and the electronics module subassembly 272 after all are connected to each other. Potting material 614 may be received on the electronics module subassembly 272 that is received in the subassembly support 271.

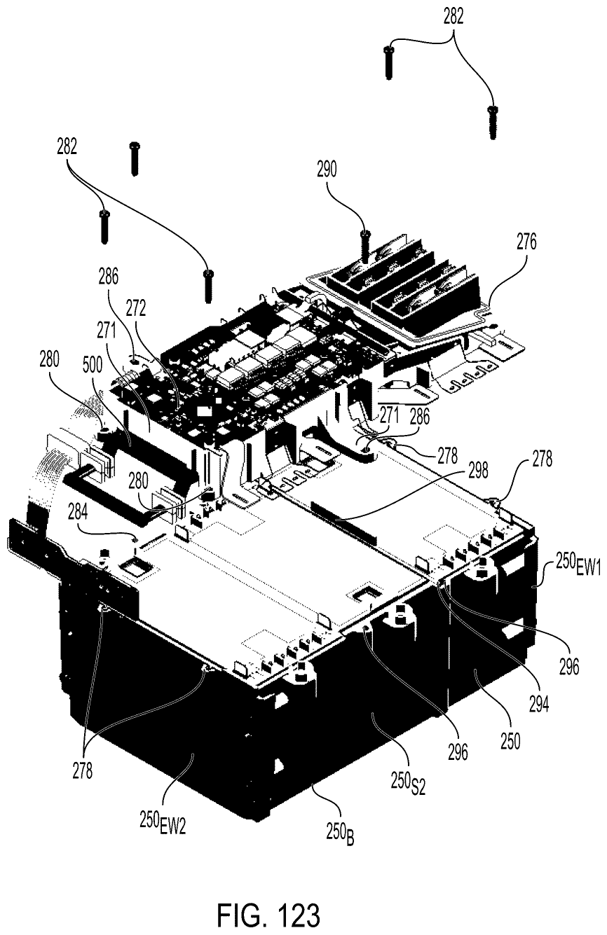

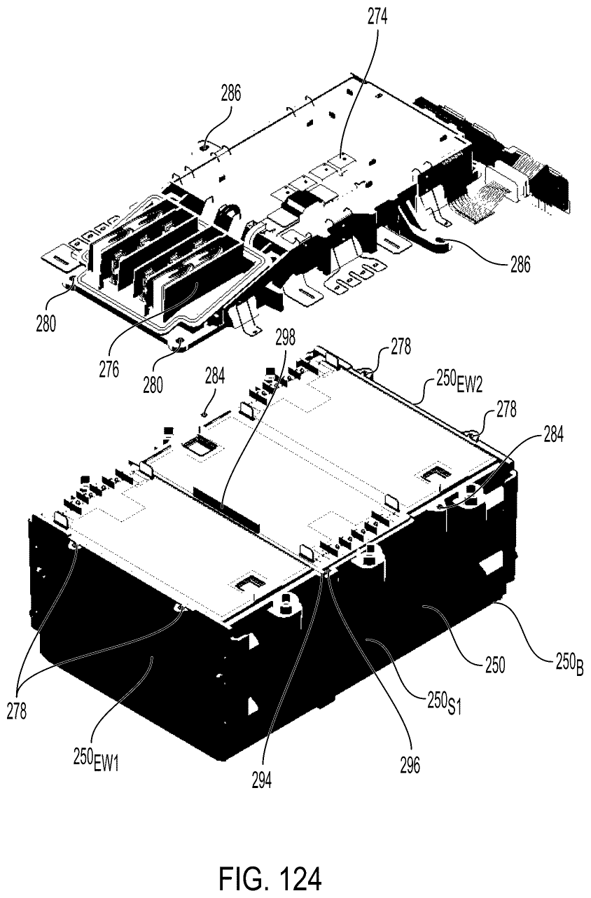

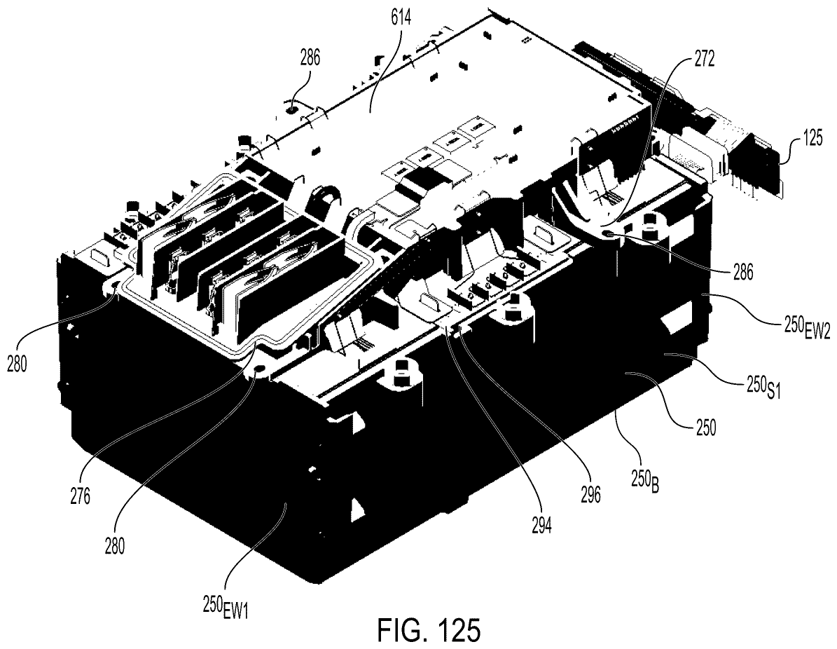

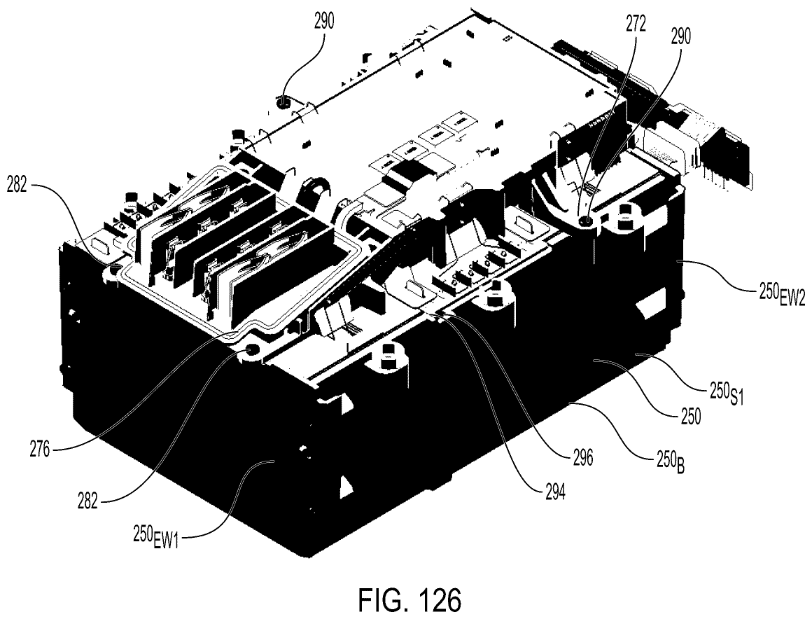

FIGS. 123-124 show various views of the assembled subassembly support 271, the battery pack terminal block 276, the shipping system 500 and the electronics module subassembly of FIG. 122 and the cell holder subassembly 250 of FIG. 47 before they are connected to each other. FIGS. 125-129 show various views of the cell subassembly 250 and the assembled subassembly support 271, the battery pack terminal block, the shipping system 500 and the electronics module subassembly 272. FIG. 125 shows them after they are aligned but before they are connected to each other, while FIGS. 126-129 show them after they are connected to each other. A core pack of the battery pack 100 may include the cell subassembly 250 with the cell modules 200, the subassembly support 271, the shipping system 500, the battery pack terminal block 276, and the electronics module subassembly 271 all connected to each other.

Referring to FIGS. 41-48, 124, and 128, the aligning member 298 of the partition wall 292 of the cell holder subassembly 250 may be configured to be received in a corresponding opening 300 of the subassembly support 271 so as to align the subassembly support 271 with respect to the cell holder subassembly 250.

Referring to FIGS. 123-129, the subassembly support 271 may be configured to be positioned parallel to the base 252_{B} of the cell holder subassembly 250 to form a top of the cell holder subassembly 250. The subassembly support 271 may be configured to be removably connected to the two side walls 252_{S1}, 252_{S2} and the two end walls 252_{EW1}, 252_{EW2} of the cell holder subassembly 250.

The end walls 252_{EW1}, 252_{EW2} may include fastener openings/holes 278 in a pattern corresponding to fastener openings/holes 280 of the subassembly support 271. Mechanical fasteners 282 (e.g., screws, etc.) may be inserted through the fastener openings/holes 278, 280 after they are aligned, for connecting the subassembly support 271 to the end walls 252_{EW1}, 252_{EW2}. The side walls 252_{S1}, 252_{S2} may include fastener openings/holes 284 in a pattern corresponding to fastener openings/holes 286 of the subassembly support 271. Mechanical fasteners 290 (e.g., screws, etc.) may be inserted through the fastener openings/holes 284, 286 after they are aligned, for connecting the subassembly support 271 to the side walls 252_{S1}, 252_{S2}.

FIGS. 46-48 show the module holder 252 with the battery modules 200 received therein and with the two end walls 252_{EW1}, 252_{EW2} attached thereto. The cell holder subassembly 250 of FIGS. 46-48 is then attached to the subassembly support 271 (i.e., configured to support the electronics module subassembly 272 and the terminal block 276 and to be attached to the shipping subassembly/system 500) of FIGS. 118-119. FIGS. 124-129 show the procedures of attachment between the subassembly support 271 of FIGS. 118-119 and the cell holder subassembly 250 of FIGS. 46-48.

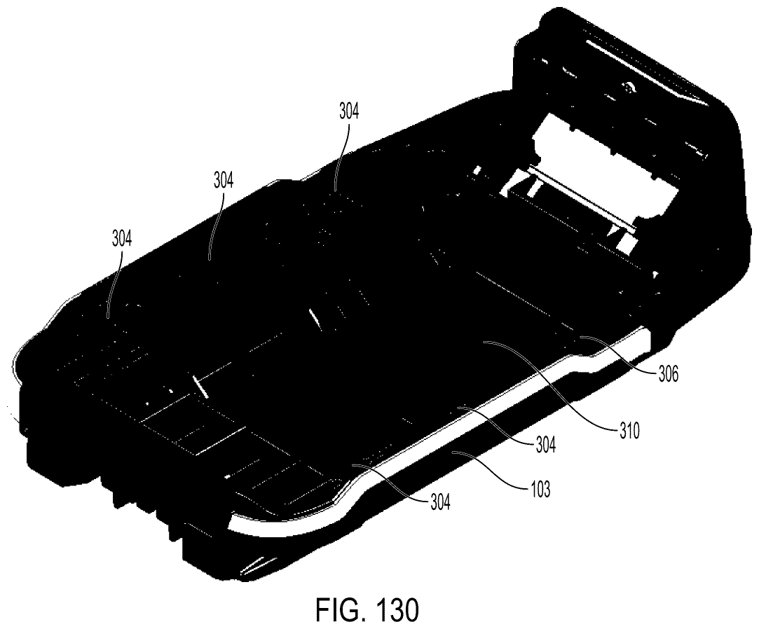

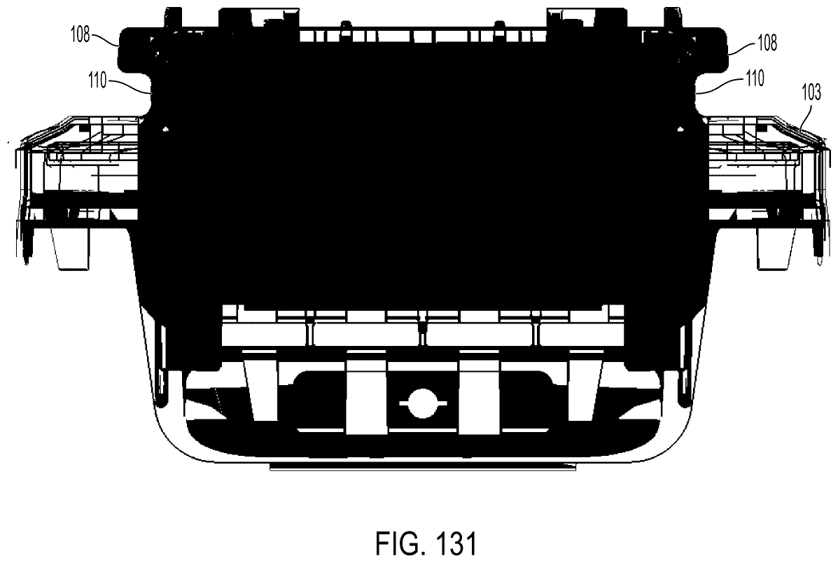

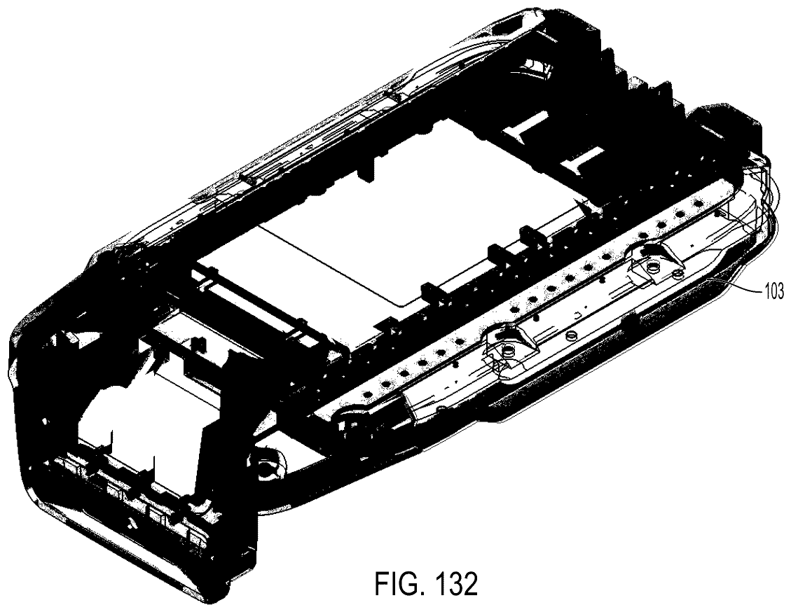

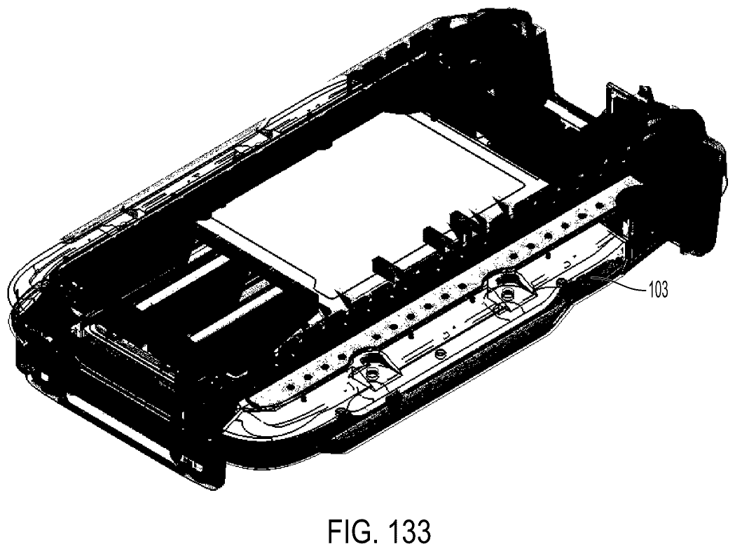

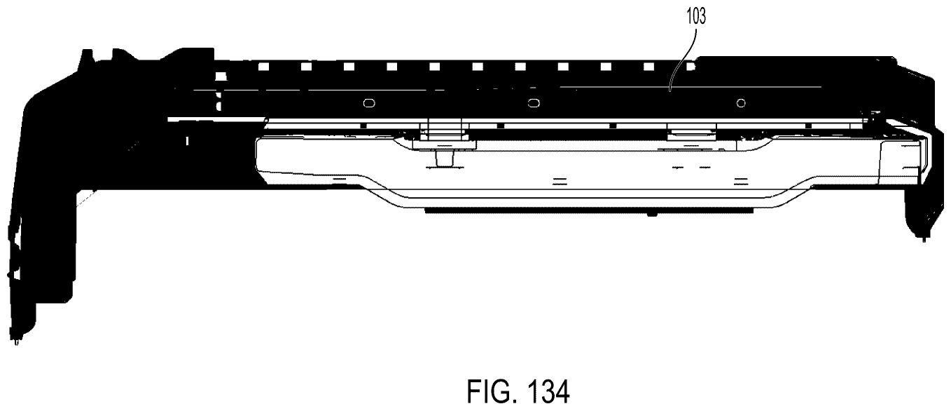

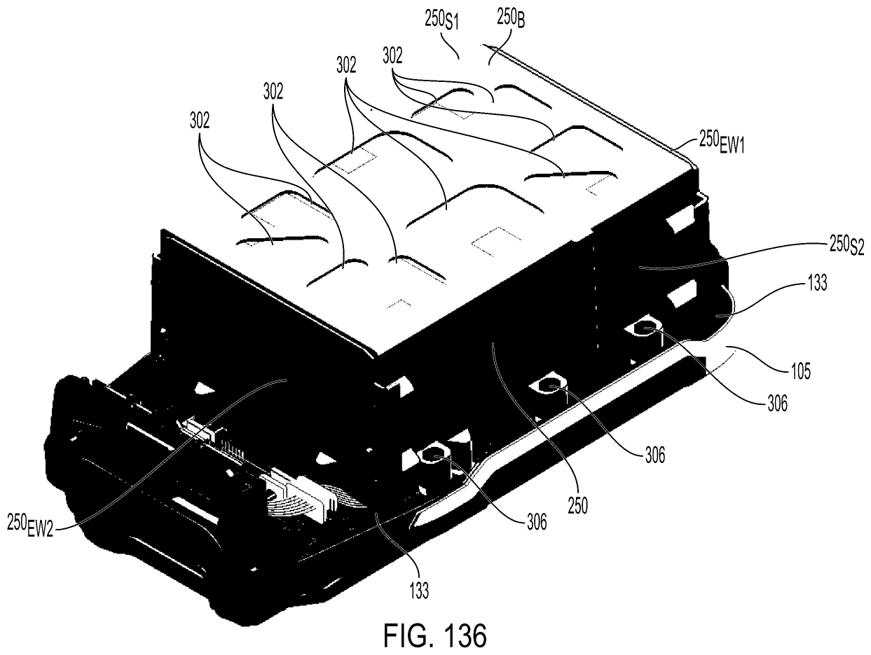

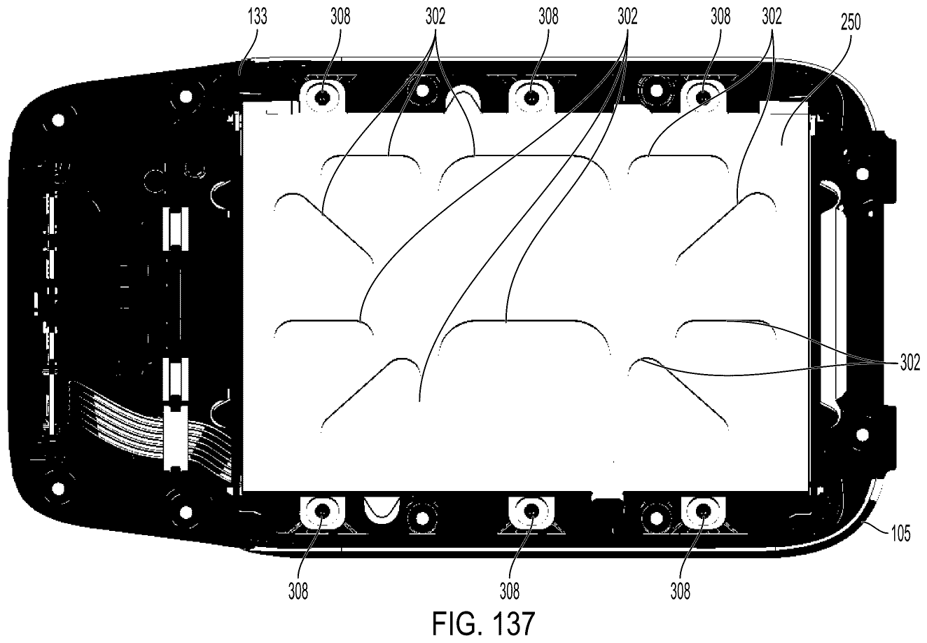

As shown in FIGS. 130, 132, and 135-137, the assembled cell holder subassembly 250 of FIGS. 125-129 may be configured to be removably connected to the upper housing portion 103. The upper housing portion 103 may be the first housing portion or second housing portion of the battery pack 100. As shown in FIG. 130, the upper housing portion 103 may include recessed/receiving portion 310 that is configured to receive portions of the cell holder subassembly 250 therein when the cell holder subassembly 250 is removably connected to the upper housing portion 10. The upper housing portion 103 may include fastener openings/holes 304 in a pattern corresponding to fastener openings/holes 306 of the cell holder subassembly 250. The fastener openings/holes 306 may be disposed on the two opposing side walls 252_{S1}, 252_{S2} of the module holder 252. Mechanical fasteners (e.g., screws, etc.) 308 may be inserted through the fastener openings/holes 304, 306 after they are aligned, for connecting the cell holder subassembly 250 to the upper housing portion 103. FIGS. 130-134 show various views of the upper housing portion 103 of the battery pack 100.

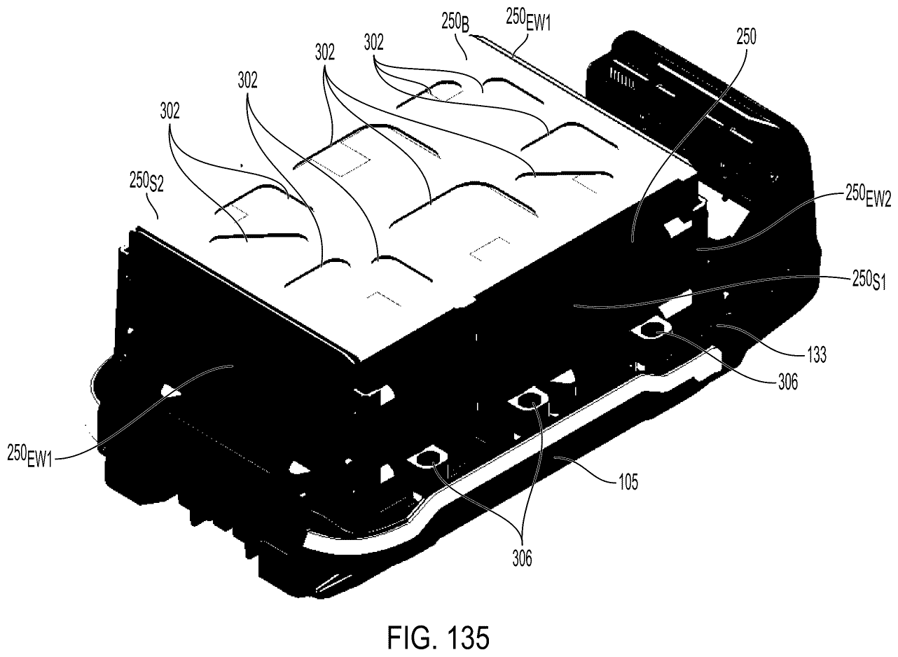

As shown in FIGS. 135-138, the base 252_{B} of the module holder 252/cell holder subassembly 250 may include a plurality of airflow openings 302 that are configured to allow airflow between the interior storage space 254 of the cell holder subassembly 250 and the internal cavity 104 of the housing 102 of the battery pack 100. In the illustrated embodiment, ten airflow openings 302 are shown. The number of airflow openings 302 may vary. The base 252_{B} with the airflow openings 302 may still be configured to support the battery cell modules 200 thereon.

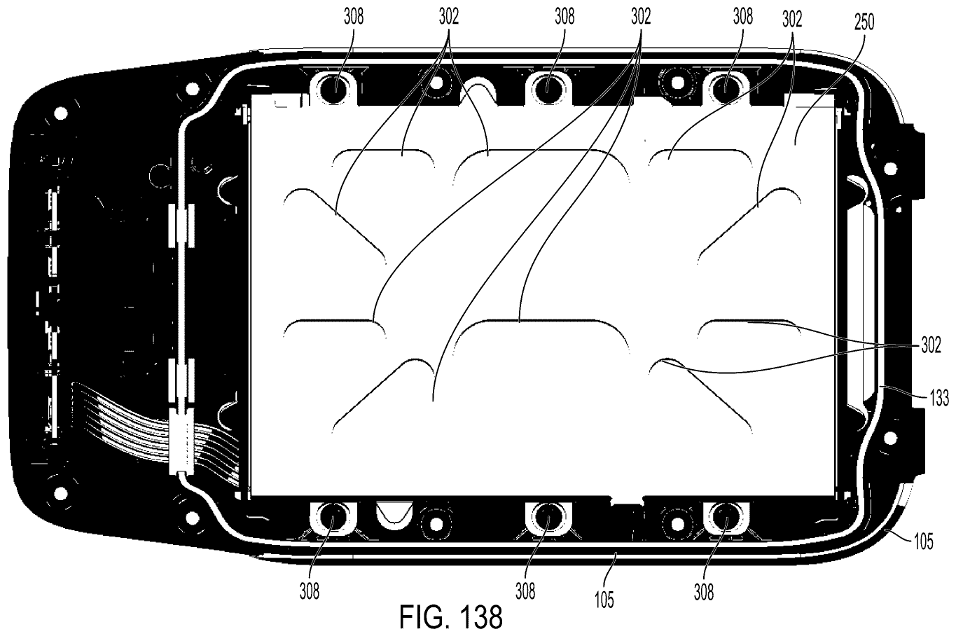

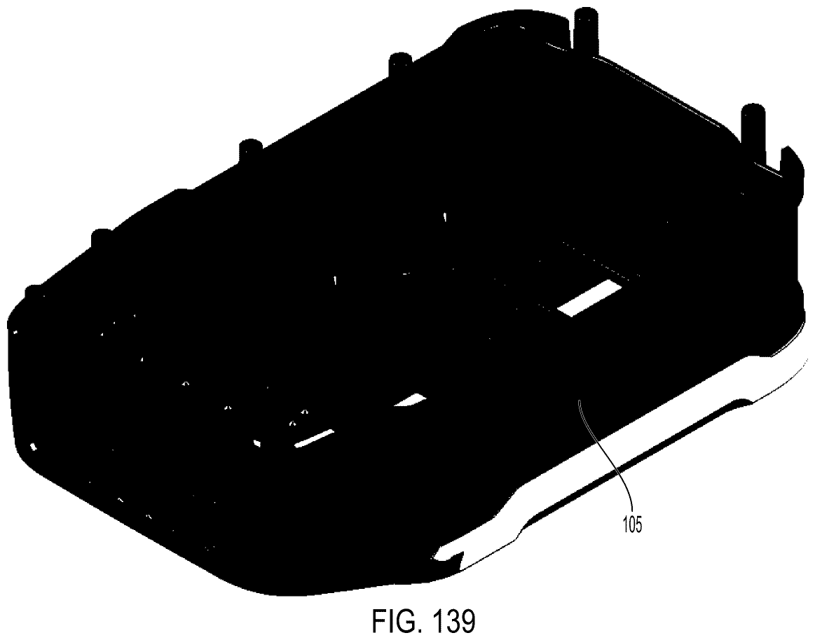

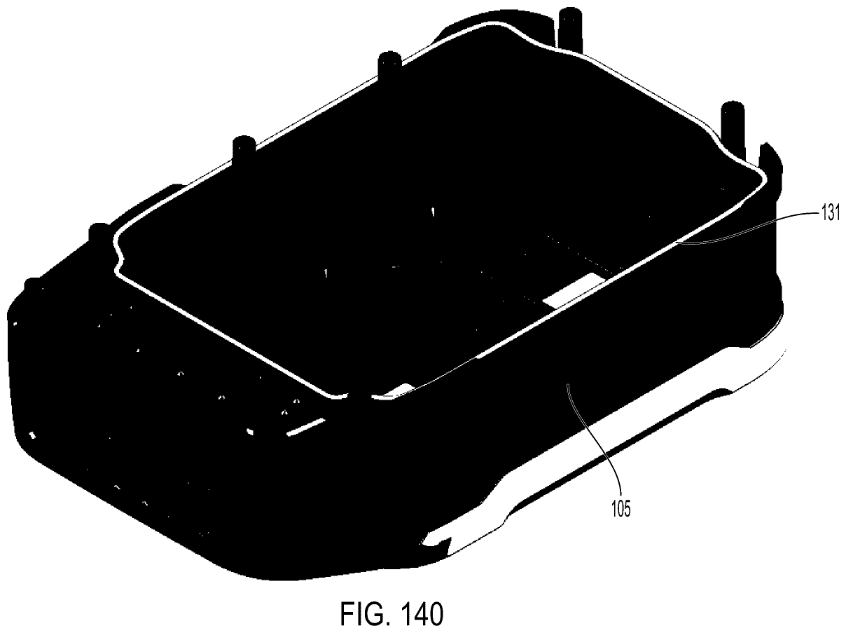

FIGS. 139-140 show various views of the lower housing portion 105 of the battery pack 100. As shown in FIG. 140, a seal or gasket 131 (e.g., a glue gasket) may be applied to the lower housing portion 105 of the battery pack 100. In another embodiment, as shown in FIG. 138, a seal or gasket 133 may be applied to the upper housing portion 103 of the battery pack 100. The seal or gasket 131/133 may be configured to extend peripherally around the inner cavity 104 of the battery pack 100.

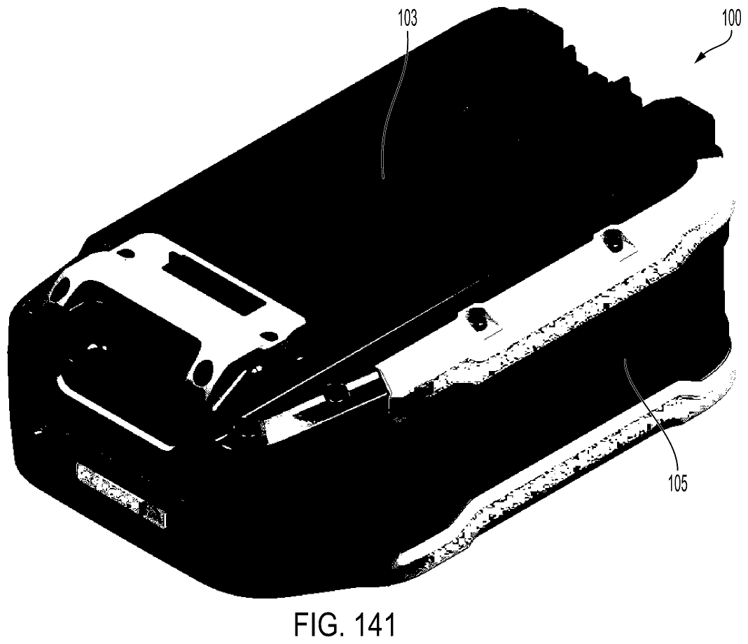

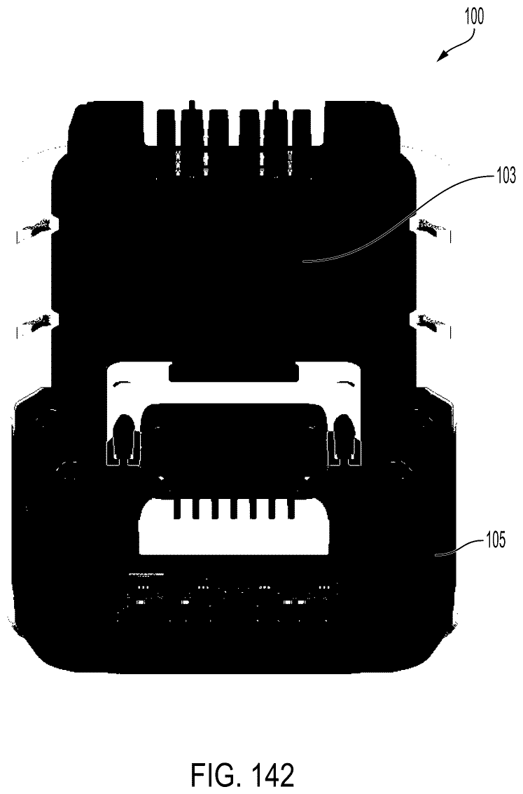

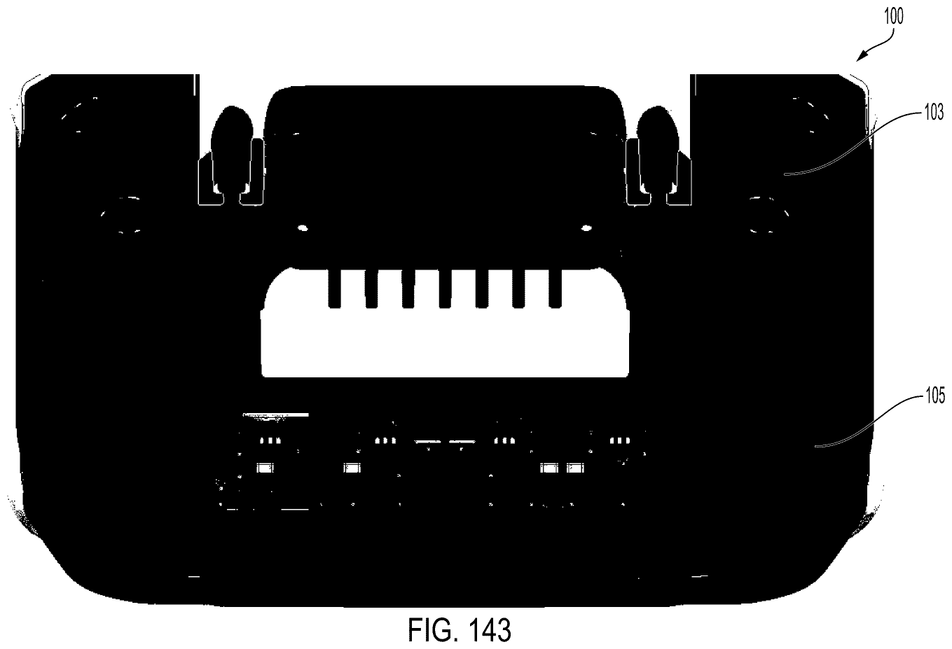

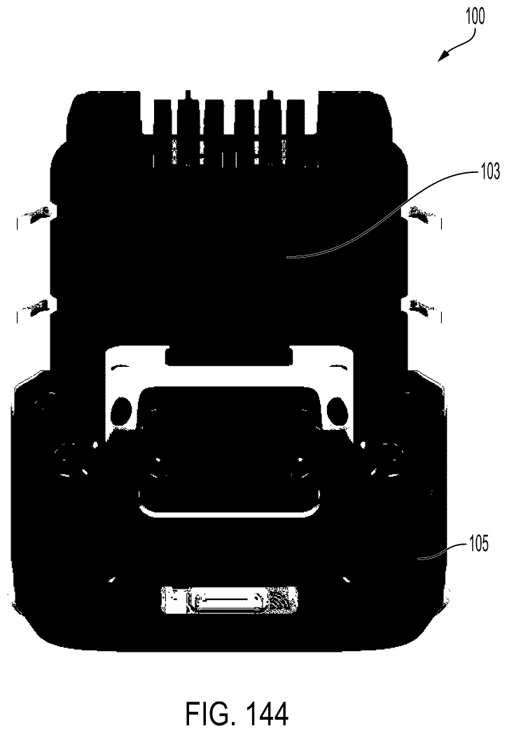

The upper housing portion 103 of the battery pack 100 may include fastener openings/holes and/or other engaging portions in a pattern corresponding to fastener openings/holes and/or other engaging portions of the lower housing portion 105 of the battery pack 100. Mechanical fasteners (e.g., screws, etc.) may be inserted through the fastener openings/holes of the upper housing portion 103 and the lower housing portion 105 after they are aligned, for connecting the upper housing portion 103 and the lower housing portion 105 of the battery pack 100 together. FIGS. 141-145 shows the assembled battery pack 100.

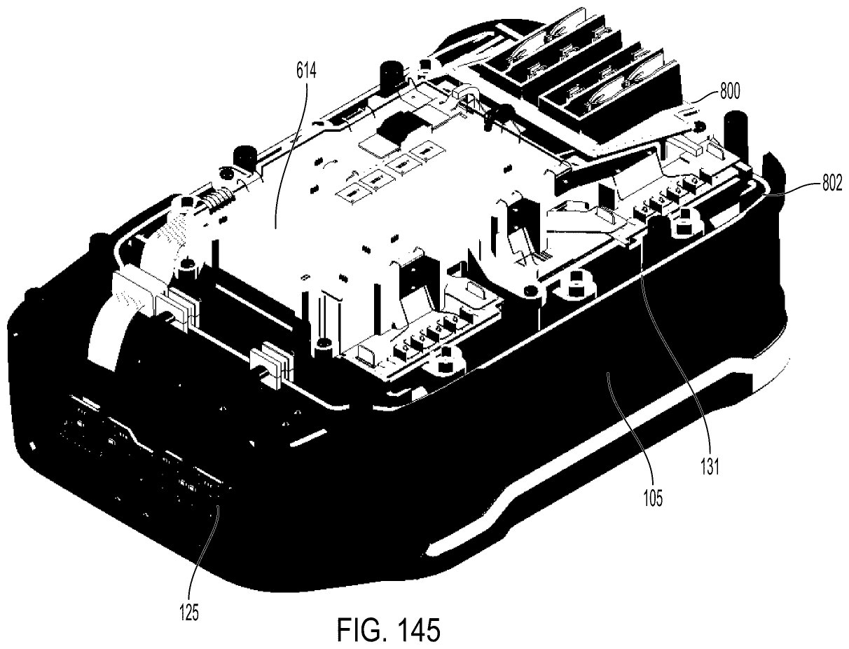

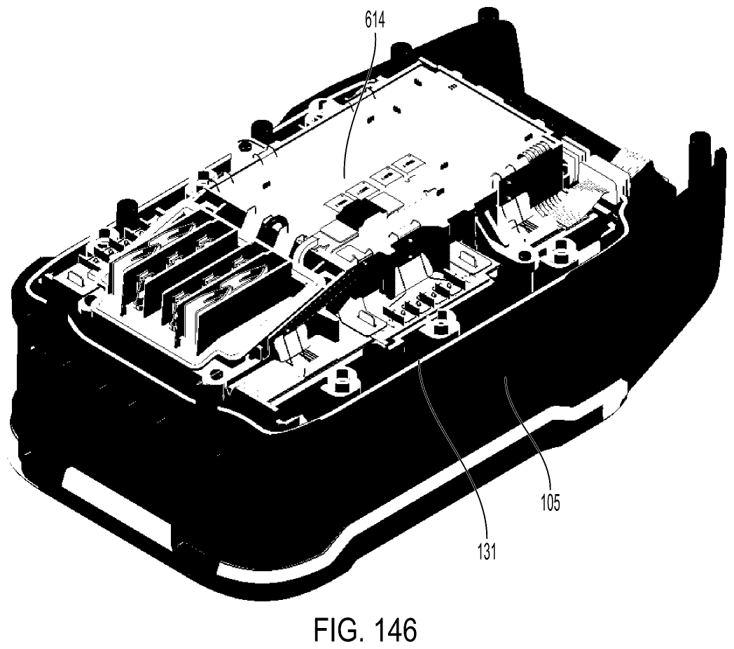

In one embodiment, as shown in FIGS. 135-138, the assembled cell holder subassembly 250 of FIGS. 125-129 may be configured to be removably connected to the upper housing portion 103 of the battery pack 100. In another embodiment, as shown in FIGS. 145-146, the assembled cell holder subassembly 250 of FIGS. 125-129 may be configured to be removably connected to the lower housing portion 105 of the battery pack 100.

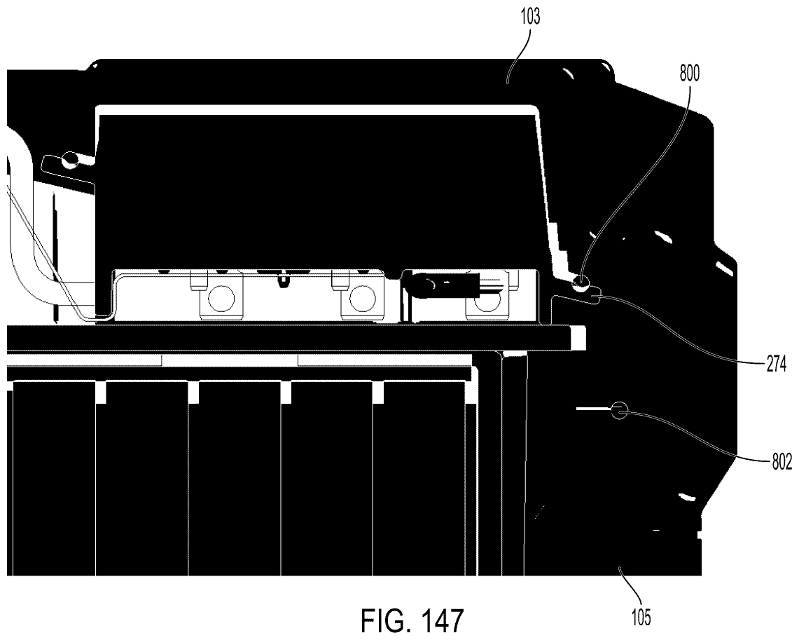

FIG. 147 shows a cross-sectional view of the battery pack 100 with the upper housing 103 and the lower housing 105 being engaged with each other. FIG. 147 shows some portions of the upper housing 103 may engage with the terminal block housing 274 at an engagement region, which includes a first seal or gasket 800. Other portions of the upper housing 13 may engage with portions of the lower housing 105 at an engagement region, which includes a second seal or gasket 802. The first and the second gasket 800 and 802 may also be shown in FIG. 145. The gaskets 800 and 802 may form a substantially water-sealed and/or air-sealed enclosure around the interior volume of the battery pack 100.

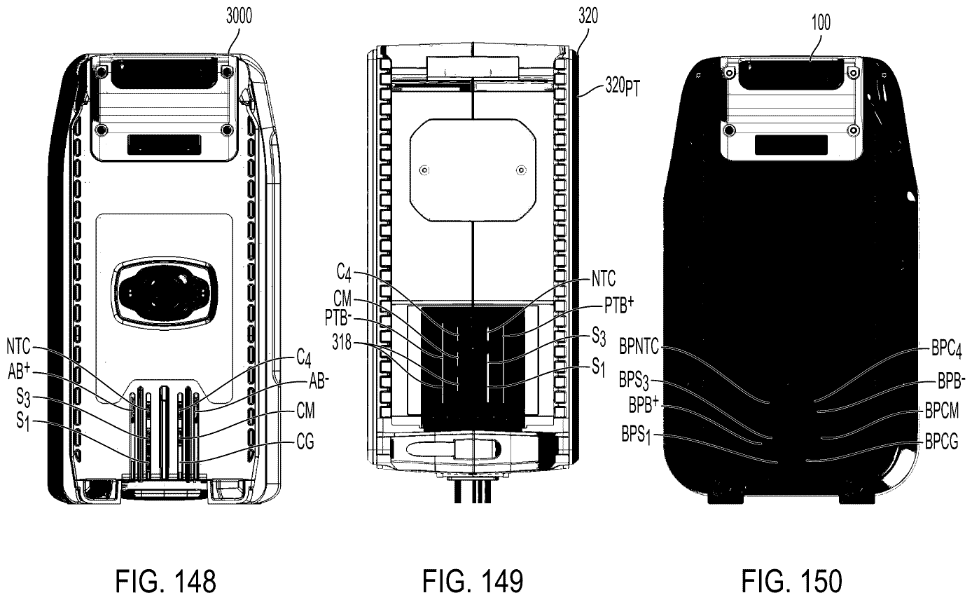

FIG. 148 shows an adaptor 3000 that may be configured to electrically interconnect a battery pack (not shown but from a distinct power tool system that would not otherwise mate with the electrical device/apparatus 320) with the electrical device/apparatus 320, such as the power tool (e.g., 320_{PT}) of a power tool system. That is, the adaptor 3000 may be configured to operatively couple the battery pack and the power tool 320_{PT}. The adaptor 3000 may include a first set of electrical terminals (not shown) that is connectable to the set of electrical terminals 312 of the battery pack so as to enable electrical coupling between the battery pack and the adaptor 3000. The first set of electrical terminals of the adaptor 3000 may be disposed in an internal cavity of the adaptor's housing. The battery pack terminals may engage and mate with adaptor battery pack terminals. The adaptor 3000 may also include adaptor device power terminals AB and AB⁺ (e.g., two discharge power terminals) and CG (e.g., charge power terminal along with AB+) and adaptor device signal terminals (e.g., five signal terminals C4, CM, S1, S3 and NTC). These device terminals are configured to be operatively coupled to the power tool 320 PT. The adaptor 3000 may also be configured to electrically connect the battery pack from the distinct power tool system to the charger 320_{C}.

FIGS. 149, 150, and 151 show the power tool 320_{PT}, the battery pack 100, and the charger 320_{C}. The power tool 320_{PT}, the battery pack 100, and the charger 320_{C} have been described in detail in the discussions above.

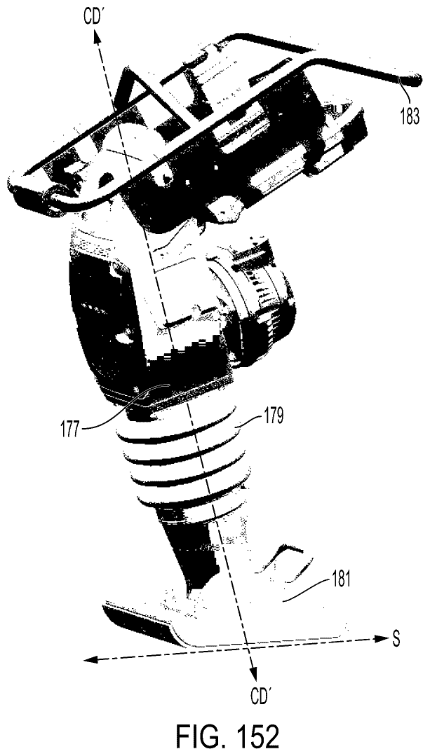

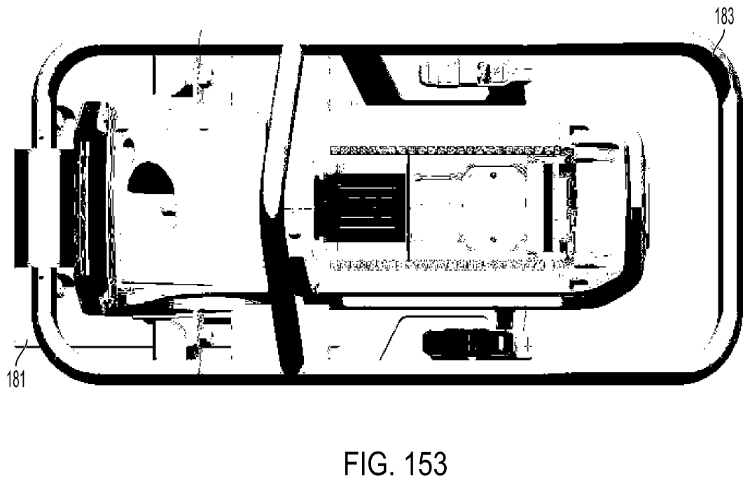

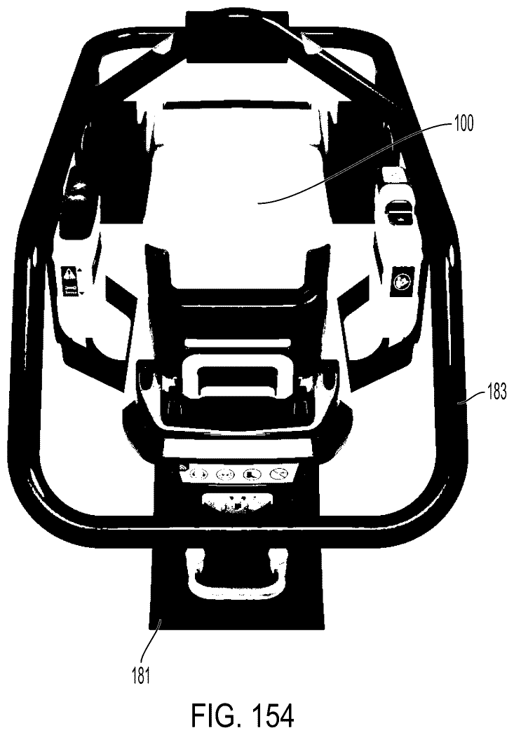

FIGS. 152-154 show an example cordless power tool (rammer) 175. The rammer (or electric rammer) 175 may include a primary housing 177 and a reciprocating leg portion 179 which may be coupled to a compacting foot 181. The compacting foot 181 may be adapted for compacting soil, hardcore, asphalt or any other material S to be compacted. The reciprocating leg portion 179 may include a reciprocating mechanism (not shown) which is arranged to drive the compacting foot 181 up and down along the longitudinal axis CD′-CD′ of the power tool 175. The rammer 175 may include a handle 183 by which a user can maneuver the rammer 175, and the battery pack 100 for powering the electric motor (not shown but located within the primary housing 177) of the rammer 175.

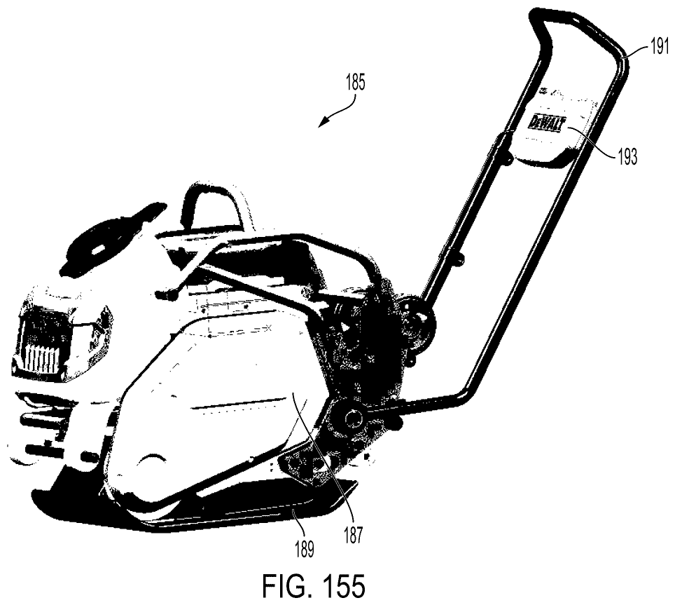

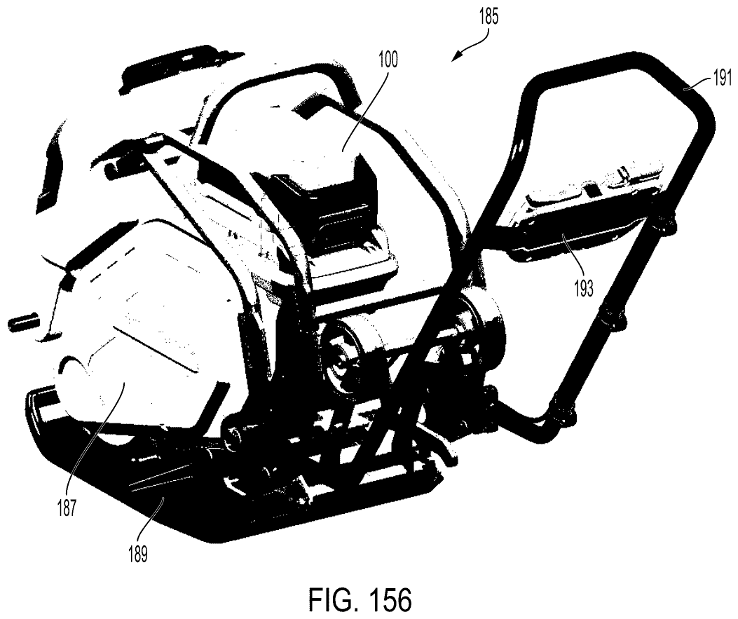

FIGS. 155-156 show another example cordless power tool (plate compactor) 185. The compactor 185 may include a main body 187 and a vibrating plate portion 189. The plate portion 189 may be adapted for compacting soil, gravel, sand, silt or any other material to be compacted. The compactor 185 also may include a handle 191 by which a user can maneuver the compactor 185, a motor, and the battery pack 100 for powering the motor of the compactor 185. The compactor 185 may include a user operable switch (may also be referred to as a “trigger” or “power switch”) and a control module (may also be referred to as “electronic control module”, or “motor control module”). The motor control module may include a controller and electronic switching components for regulating the supply of power from the battery pack 100 to the motor. The motor control module may be disposed within the housing of the main body of the compactor 185 or at any location within or on the compactor 185. The motor control module may also integrally include components to support a user operated input unit or user interface 193 (may be referred to as “input unit”) for receiving user function selections, such as an ON/OFF signal, variable-speed signal, and forward-reverse signal.

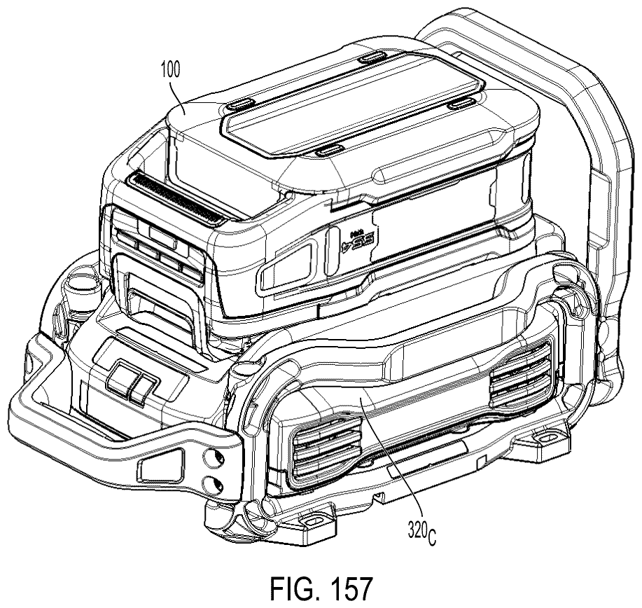

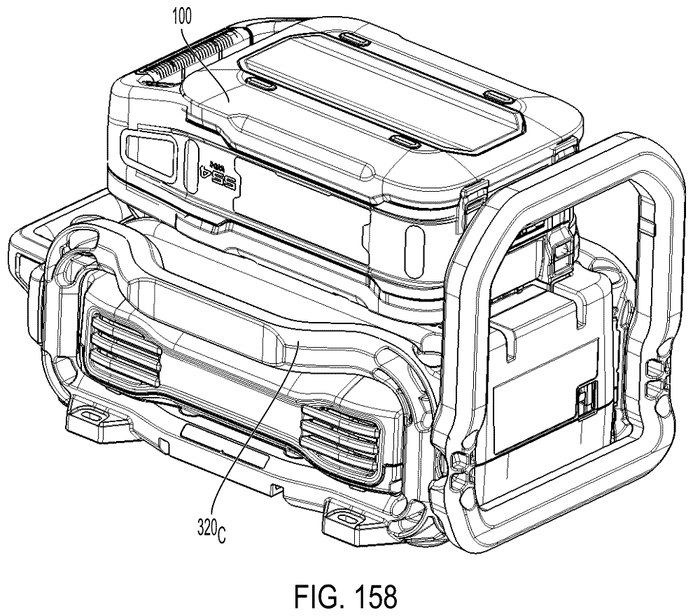

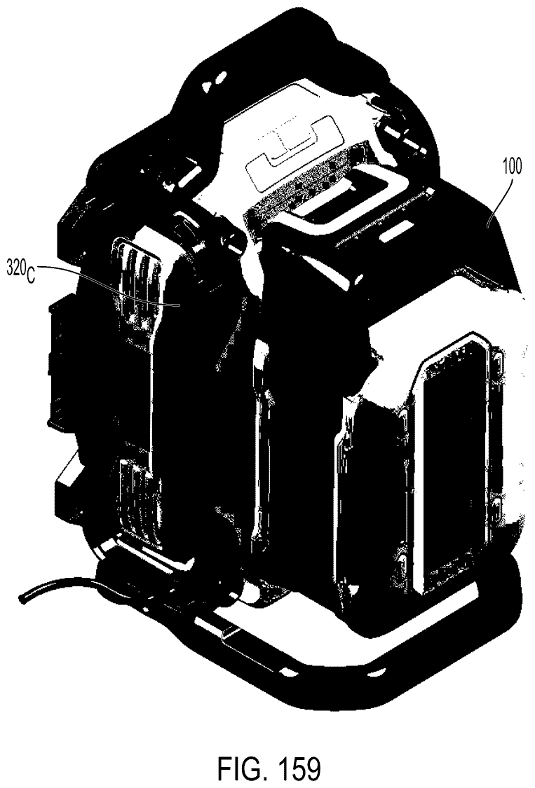

FIGS. 157-159 show the battery pack 100 connected to the charger 320_{C}. FIGS. 157-158 show the charger 320_{C} and the battery pack 100 in a horizontal orientation, while FIG. 159 shows the charger 320_{C} and the battery pack 100 in a vertical orientation.

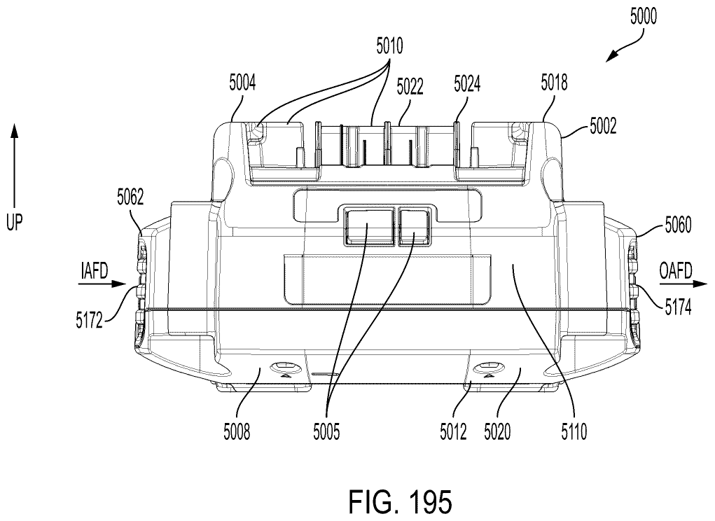

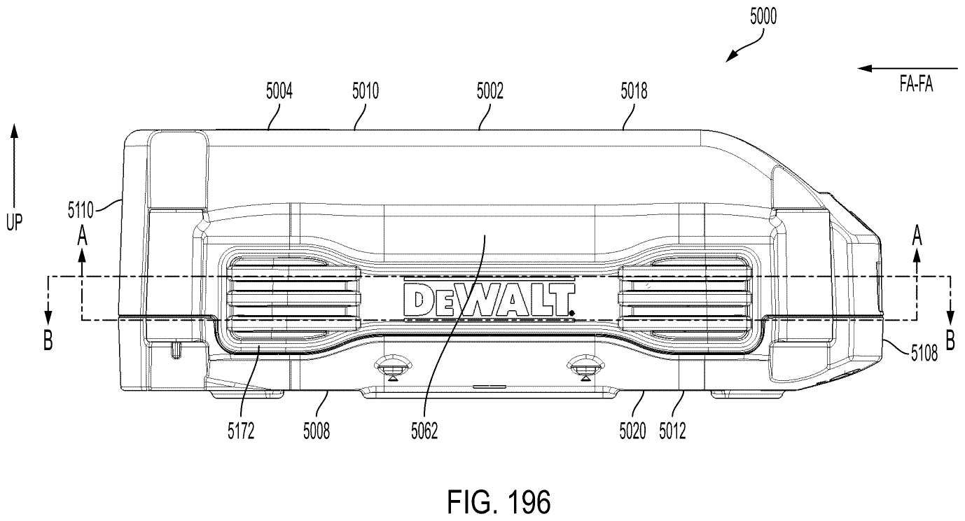

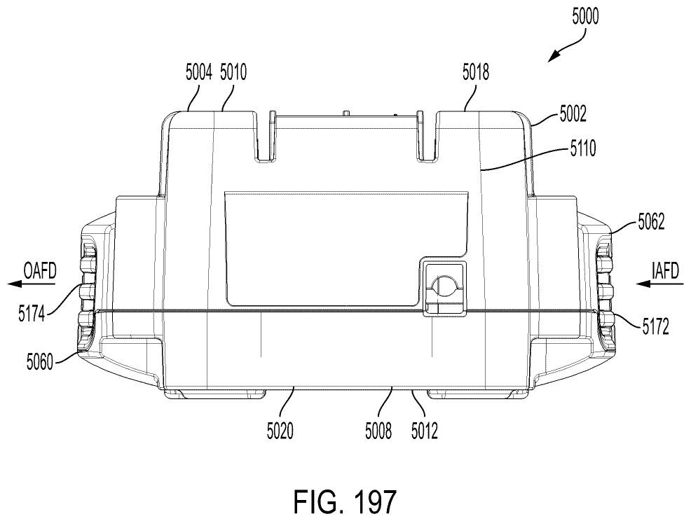

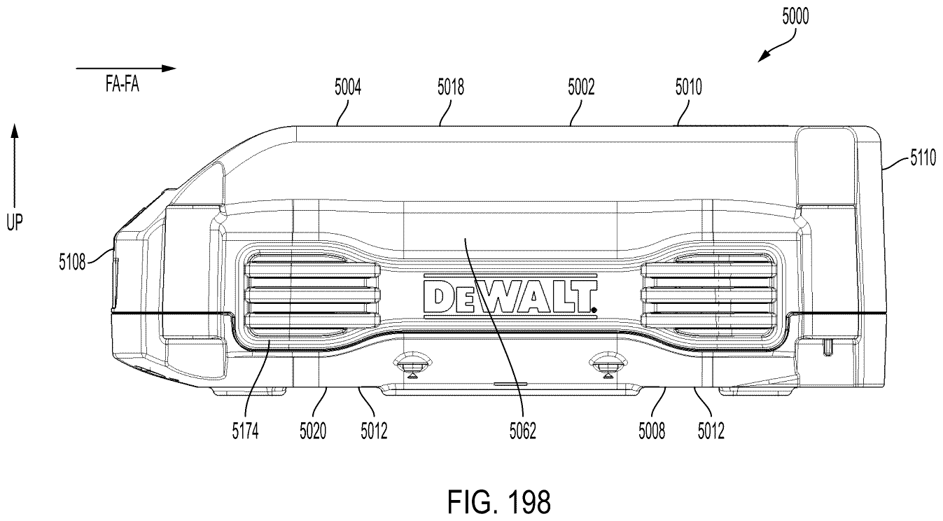

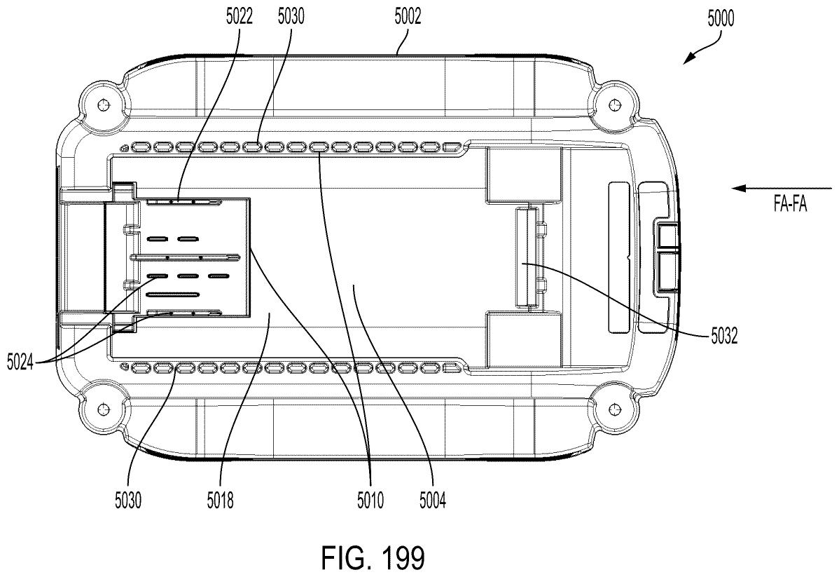

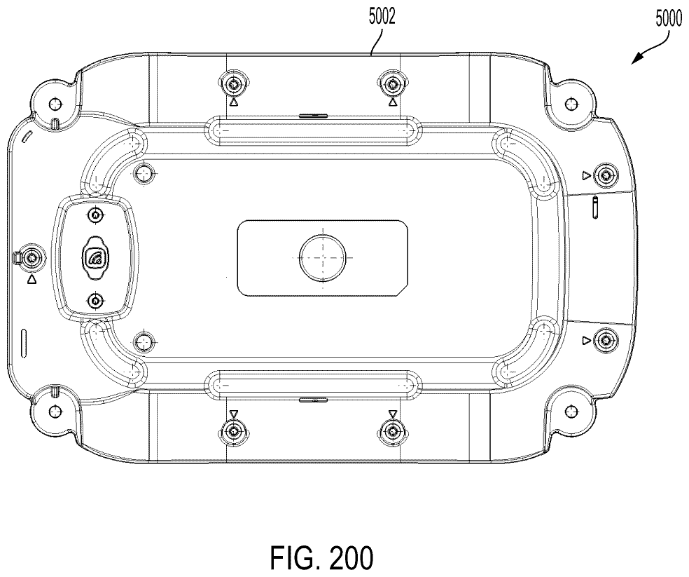

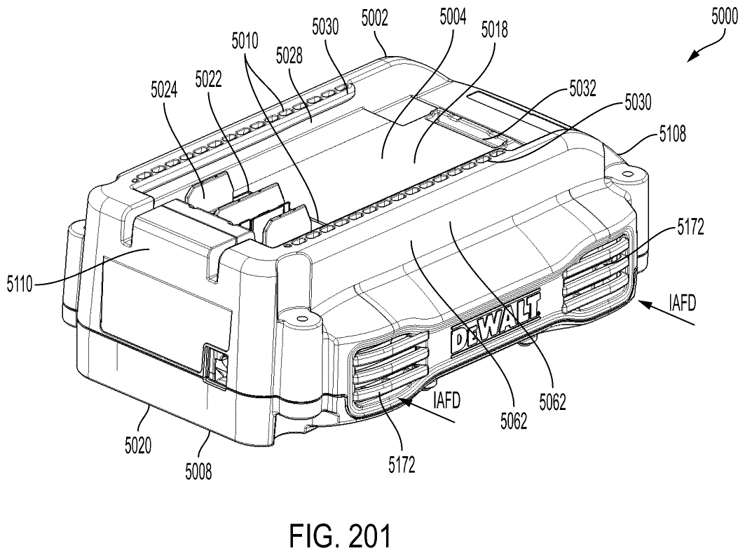

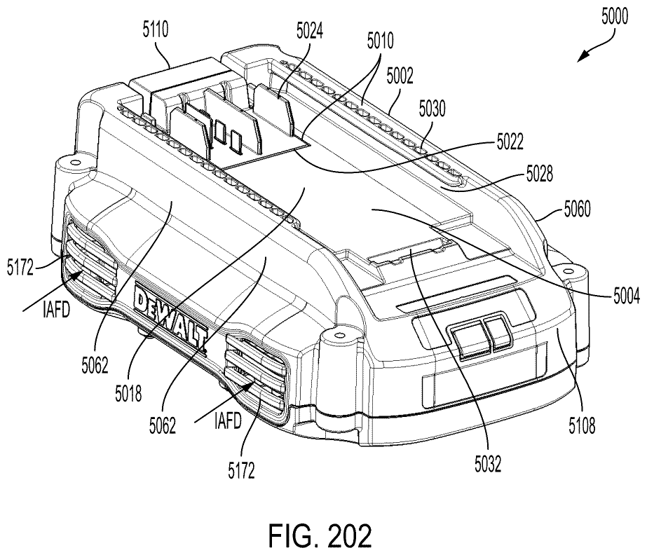

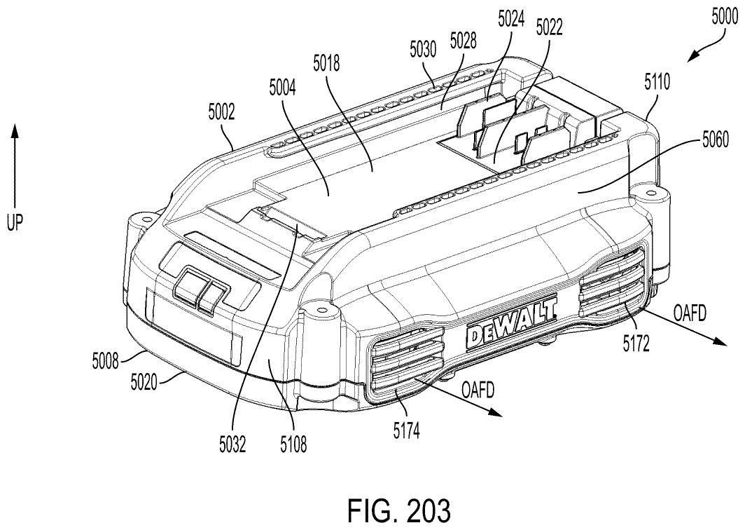

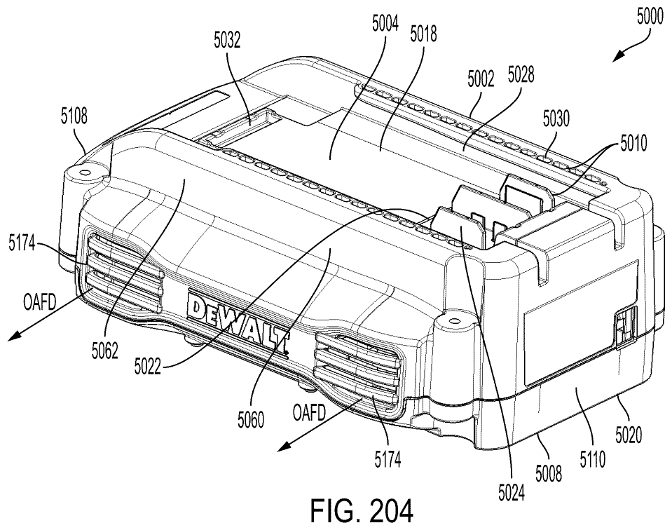

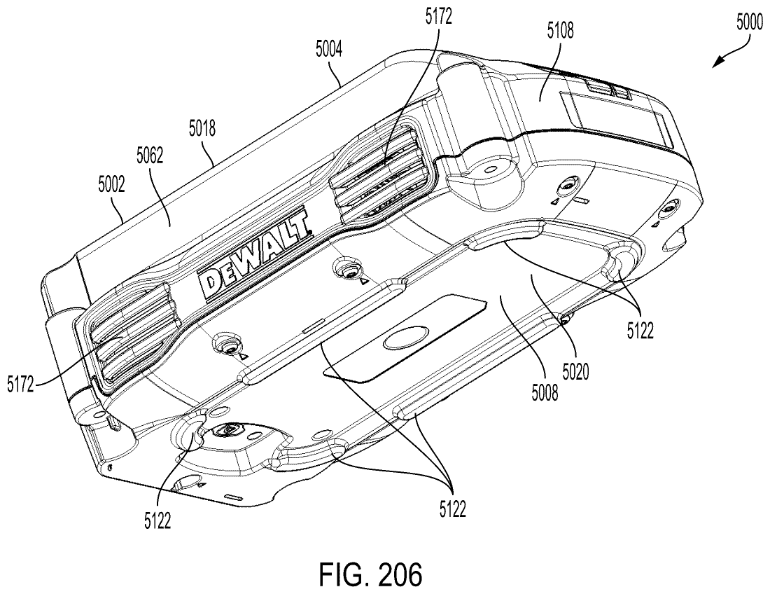

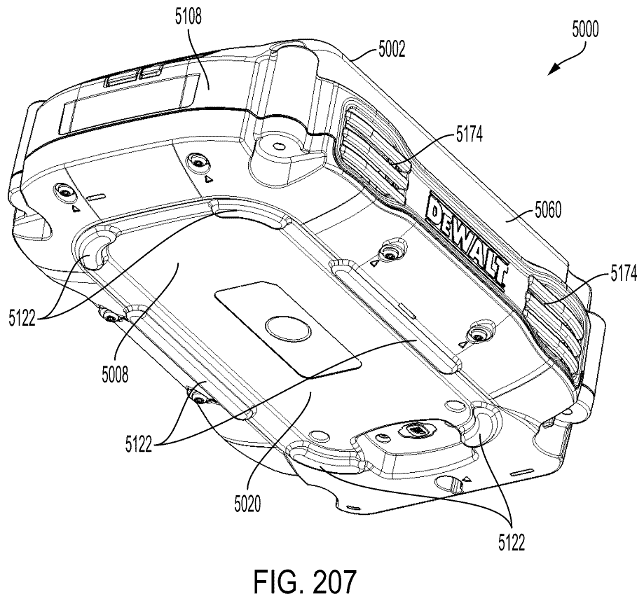

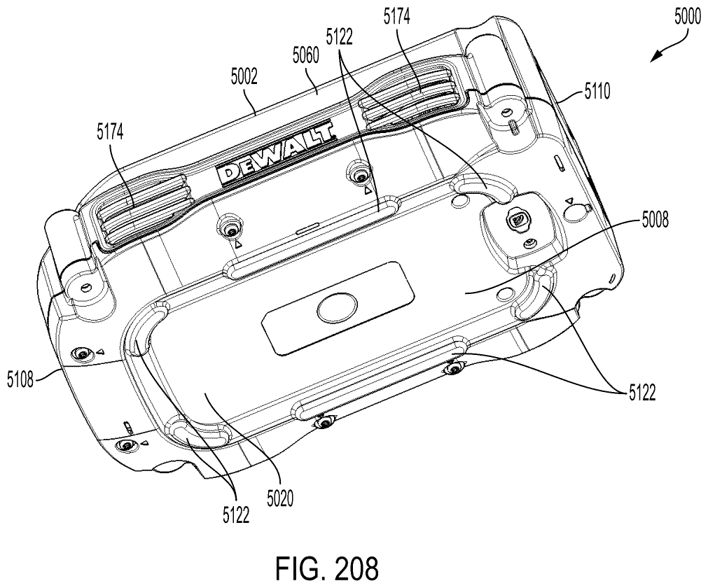

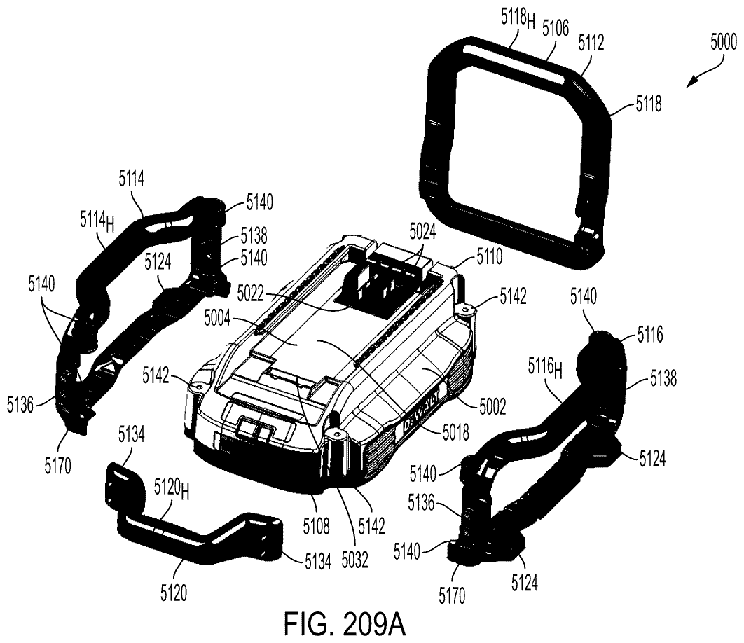

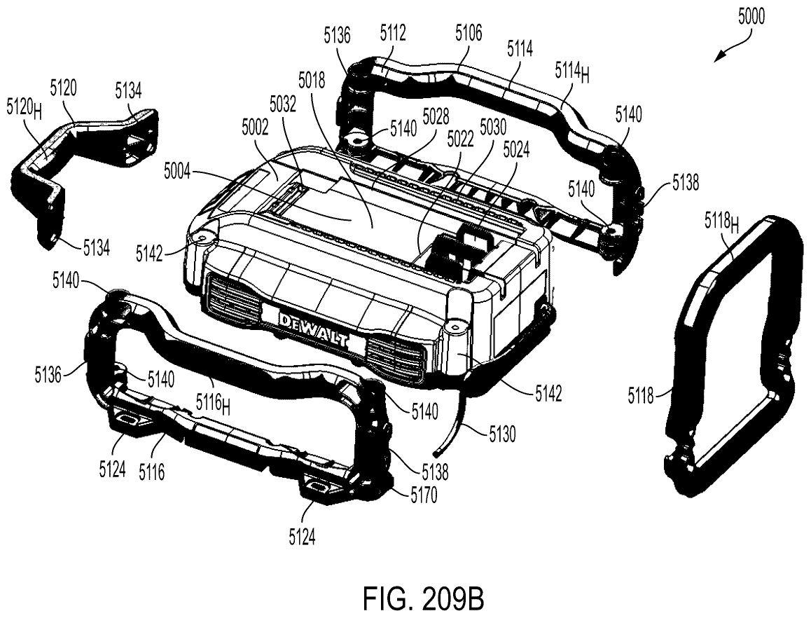

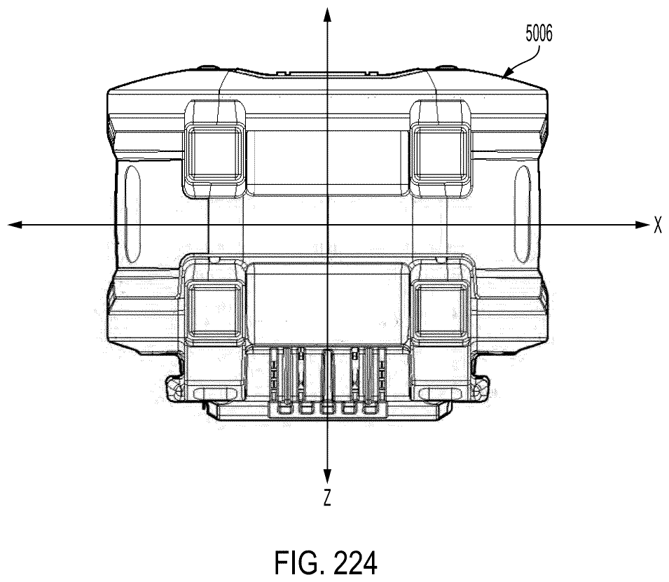

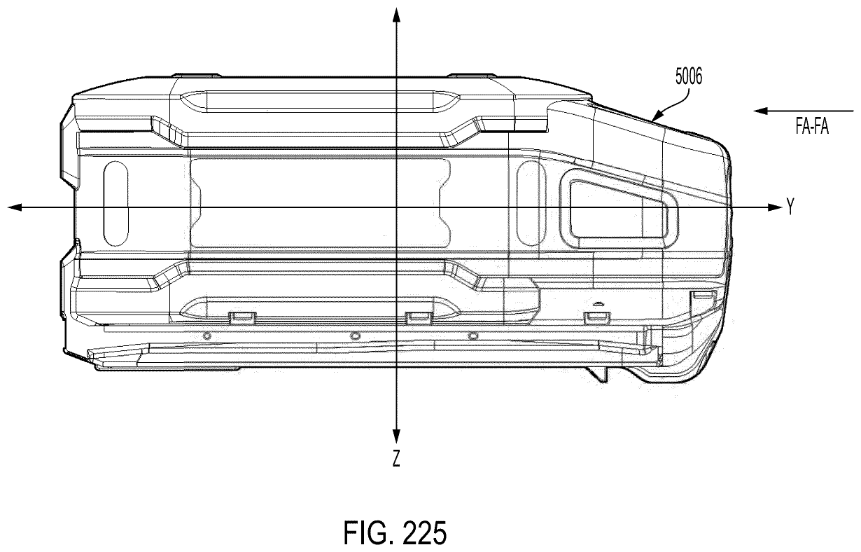

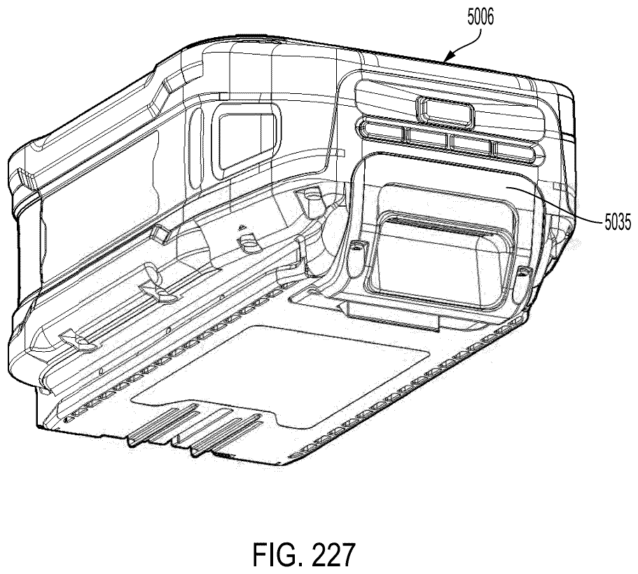

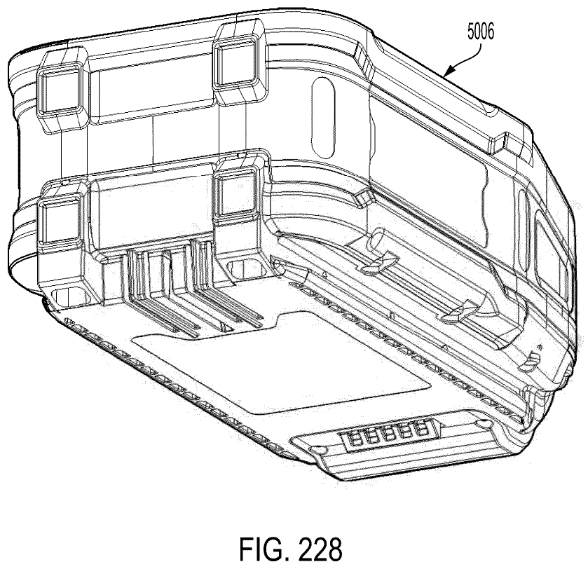

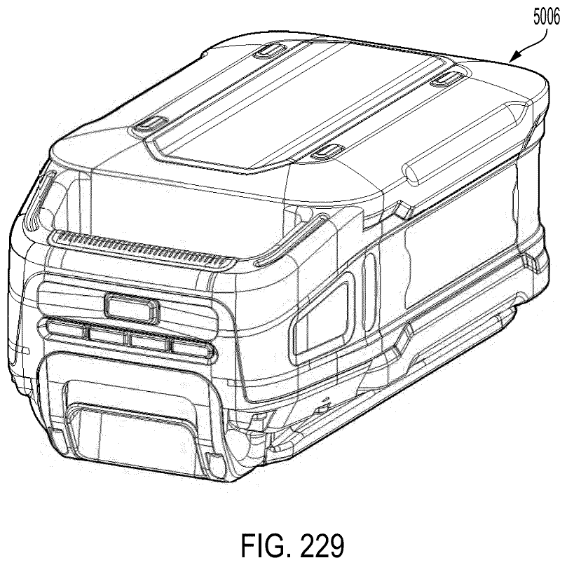

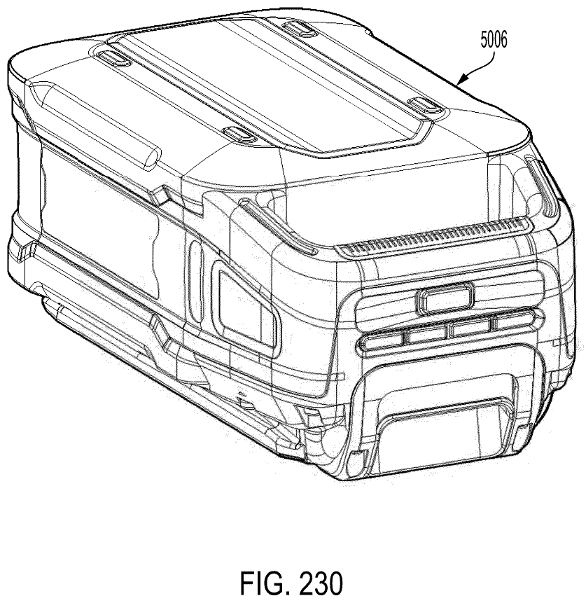

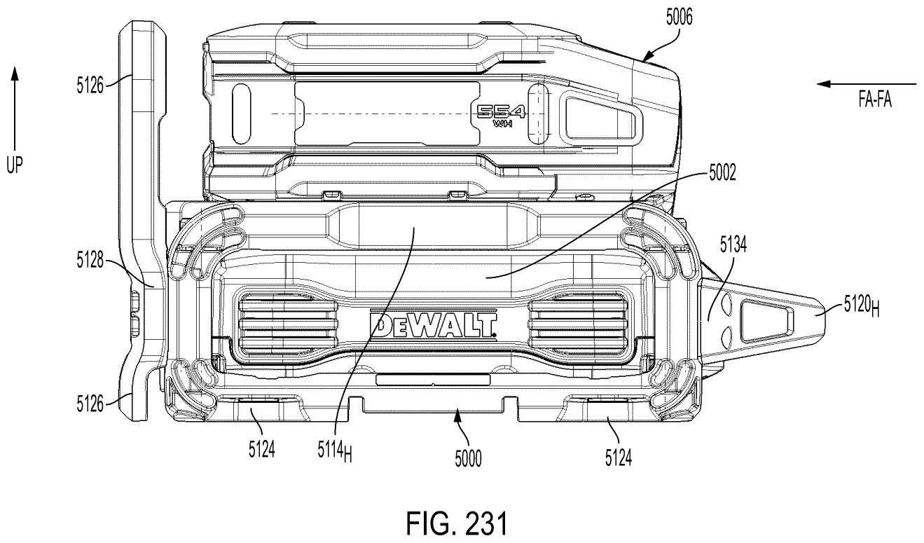

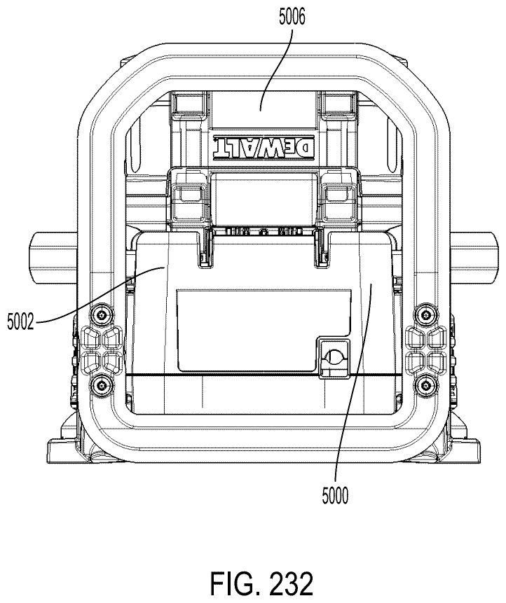

The present patent application provides a battery pack charger 5000 that is configured to be electrically and mechanically connectable to a battery pack 5006 and to be able to charge the battery pack 5006. FIGS. 195-208 show various views of the charger 5000. FIGS. 224-230 show various views of the battery pack 5006. The charger 5000 may be referred to as an electrical device. The charger 5000 may be configured for charging the battery pack 5006 (i.e., a rechargeable DC power supply) with an AC line power supply/source. A power cord 5130 (shown in FIG. 209B) may be configured to attach the charger 5000 to the AC line power supply/source.

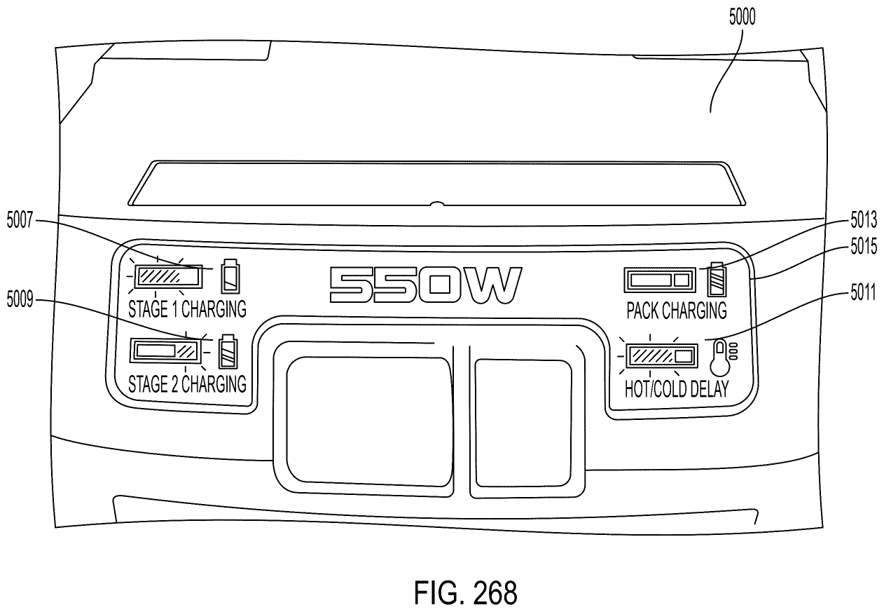

The charger 5000 may include an LED display having a plurality of LEDs thereon. When charging the battery pack 5006, the LEDs 5005 (as shown in FIG. 195) may illuminate to indicate the status of the battery pack 5006. For example, referring to FIG. 268, the LED display/user interface 5015 may include stage 1 charging indicator 5007, stage 2 charging indicator 5009, hot/cold delay indicator 5011, and a battery pack charging indicator 5013.

The charger 5000 may have different voltage charging points (voltages). For example, the charger 5000 may have a voltage charging point, such as a high voltage charging point (54V) to match the rated voltage (54V) of the battery pack 5006.

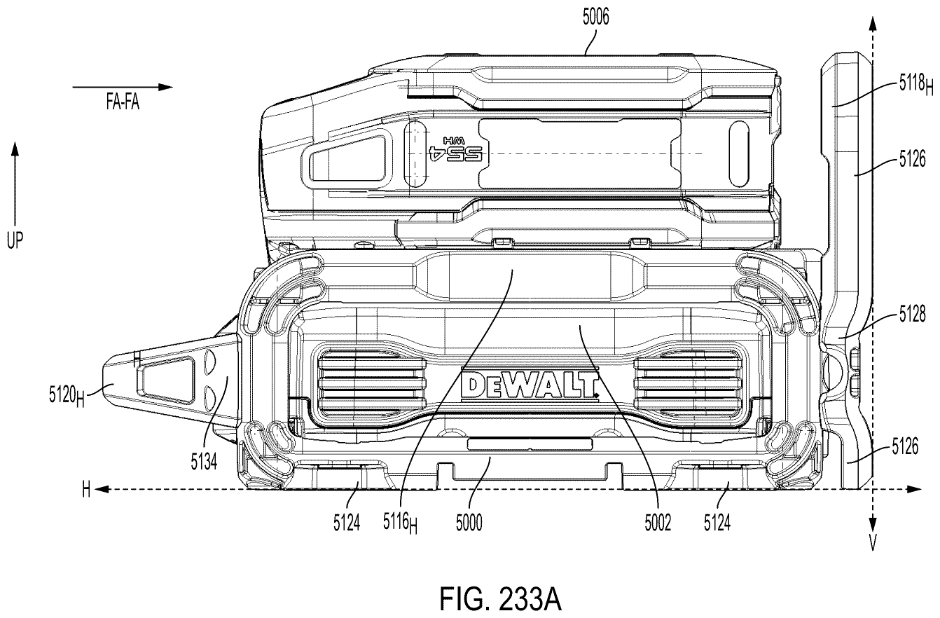

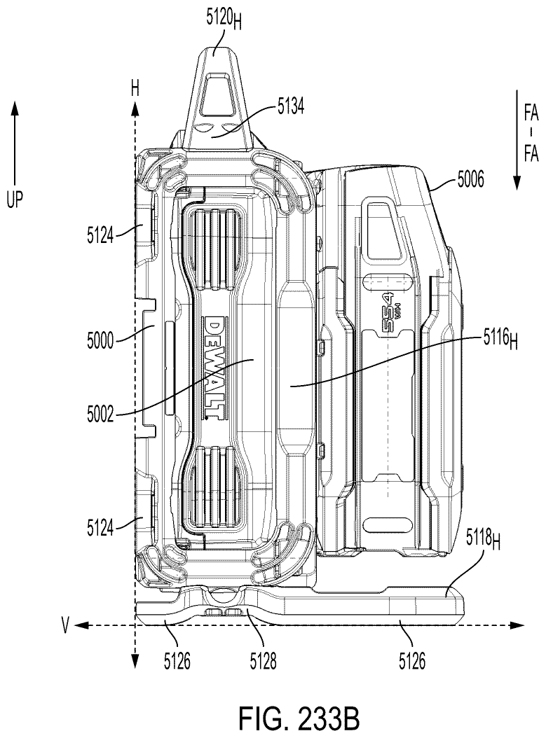

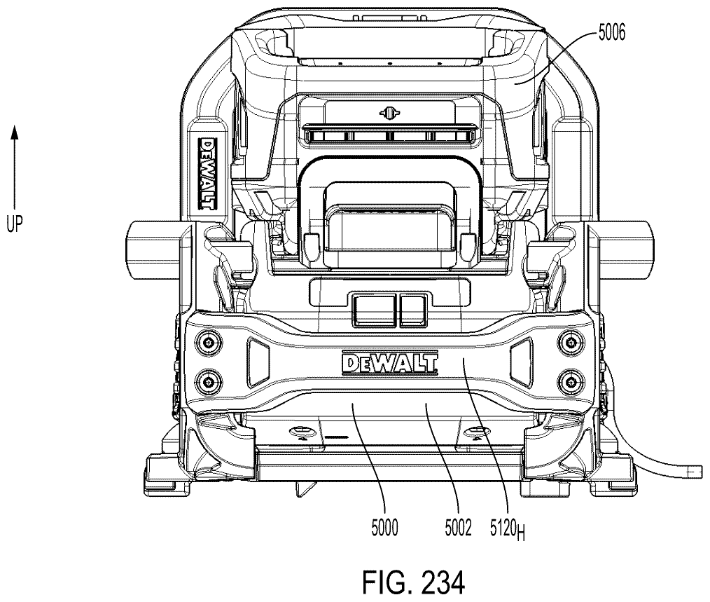

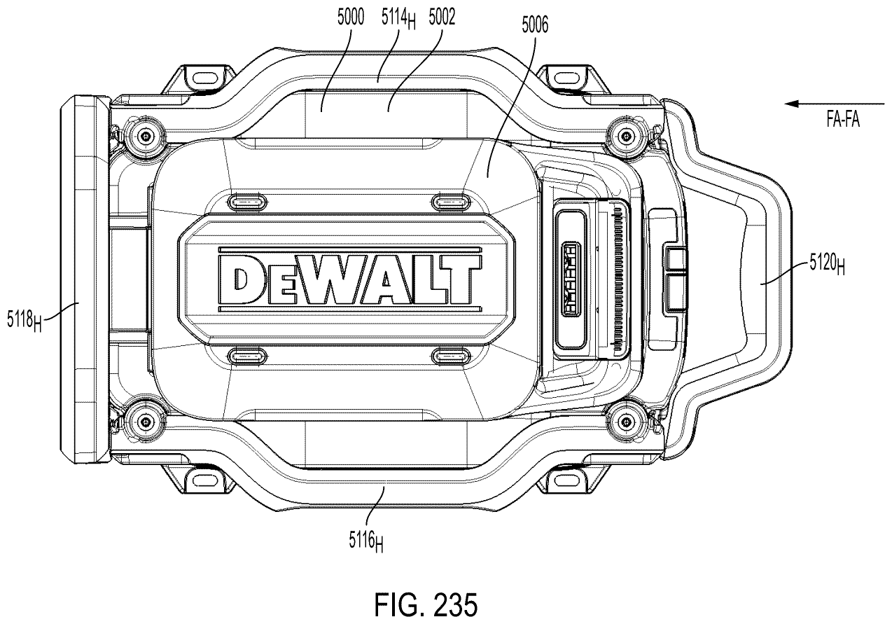

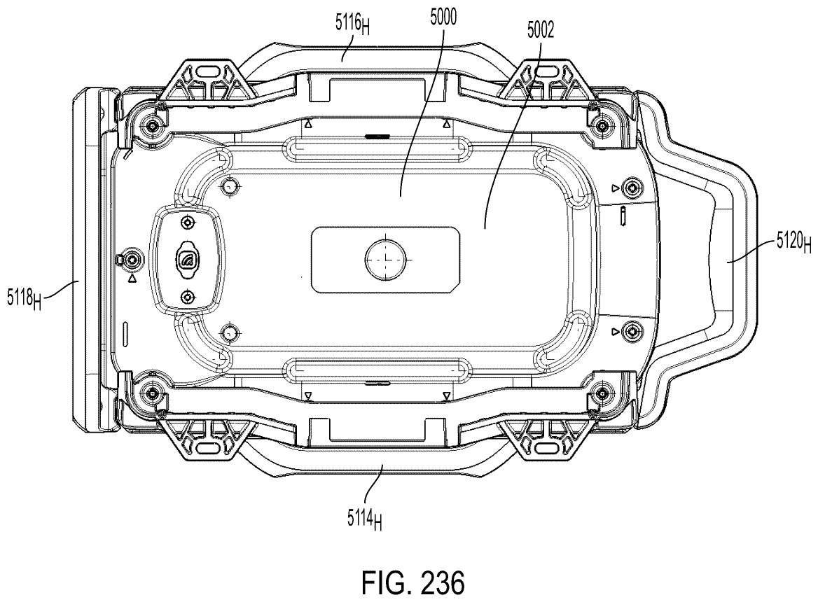

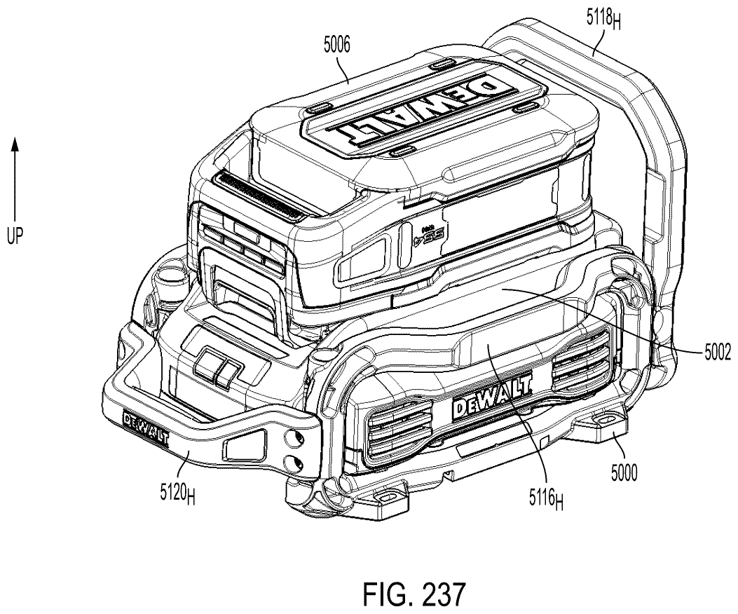

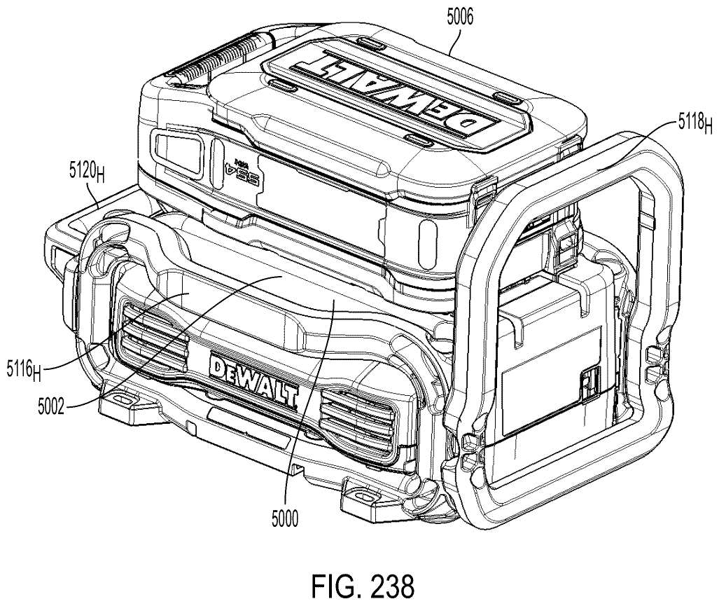

The charger 5000 may include a housing 5002. The housing 5002 may include a first side 5004 and a second side 5008, opposed to the first side 5004. The first side 5004 may include a top 5018 of the charger 5000 and the second side 5008 may include a bottom 5020 of the charger 5000, for example, when the charger 5000 is disposed such that the battery pack insertion direction FA-FA is generally horizontal as shown in FIG. 233A. The housing 5002 may include two pairs of opposing sides 5060, 5062 (referred to as third and fourth sides of the housing 5002), and 5108, 5110 (may be referred to fifth and sixth sides of the housing 5002). For example, the side 5108 may form the front of the charger 5000 and side 5110 may form the rear/back of the charger 5000. The housing 5002 may be made of Acrylonitrile Butadiene Styrene (ABS) material. The housing 5002 may be made of a high/hard impact plastic material.

The housing 5002 may include a first housing portion and a second housing portion that are connected together to form the charger housing 5002 with an internal cavity therein. The first and second housing portions may include upper/top and lower/bottom housing portions. The first and second housing portions may include left side and right side housing portions. On the first side 5004, the charger 5000 may include an open deck cavity formed by the housing 5002 for receiving the battery pack 5006.

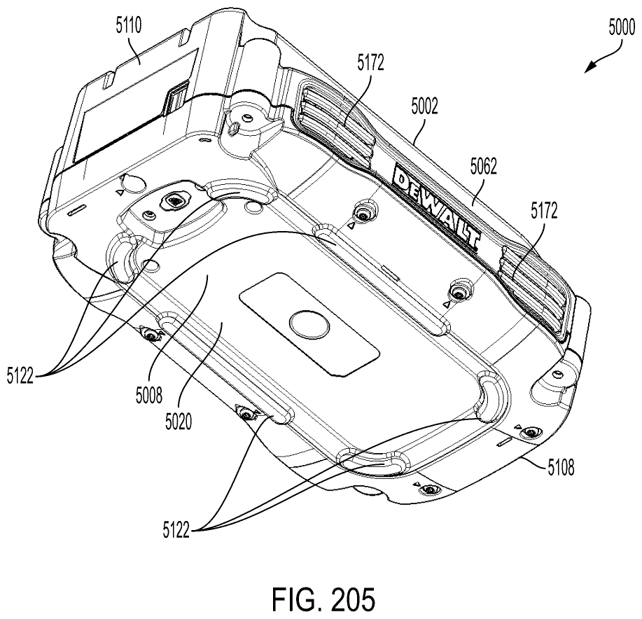

Referring to FIGS. 205-208, the second side 5008 of the housing 5002 (i.e., bottom 5020 of the charger 5000) may include feet 5122 thereon. The feet 5122 may function as spacers 5122 between the bottom 5020 of the charger 5000 and a top 5042 of a coupling plate 5016 when the coupling plate 5016 is attached on the second side 5008 of the housing 5002. The coupling plate 5016 will be described in detail in the discussions below. The spacers 5122 may be configured to space the top 5042 of the coupling plate 5016 (or position the top 5042 of the coupling plate 5016 by a certain distance) from the bottom 5020 of the charger 5000 when the coupling plate 5016 is attached on the second side 5008 of the housing 5002.

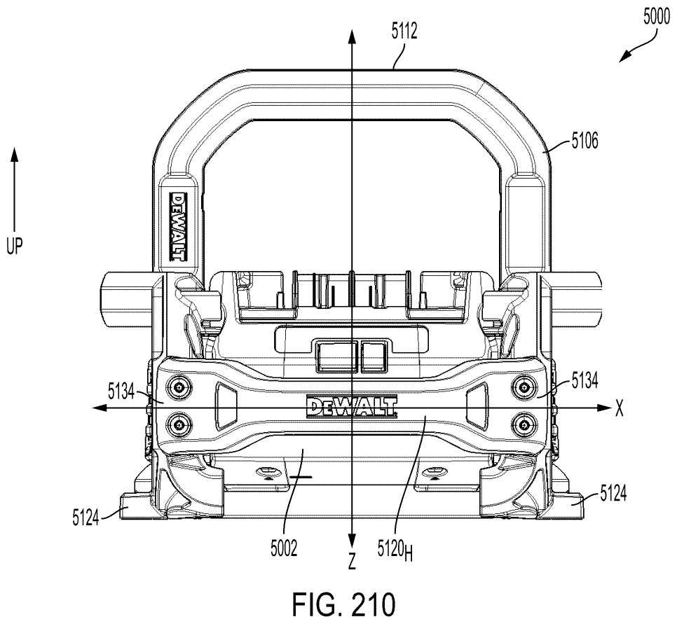

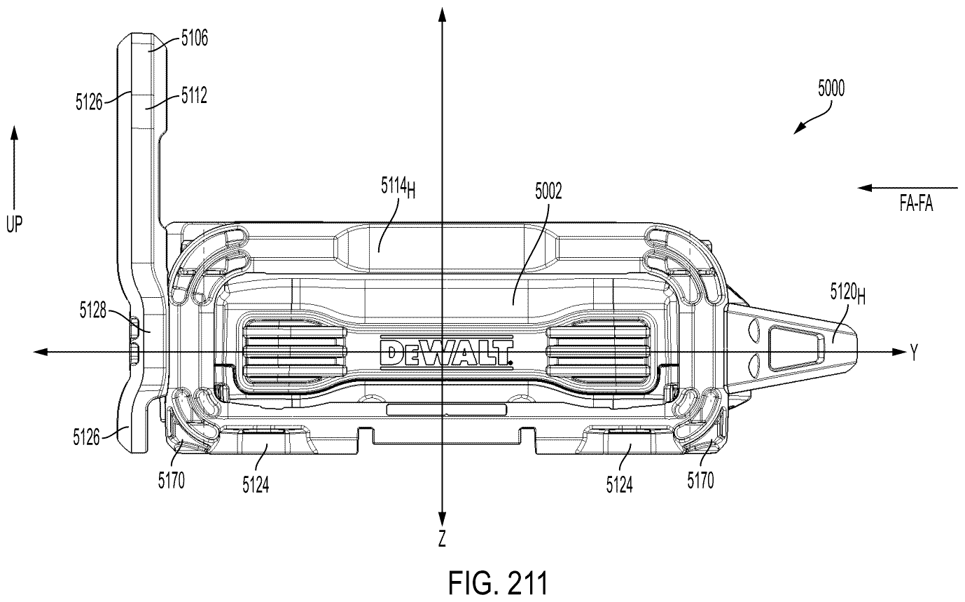

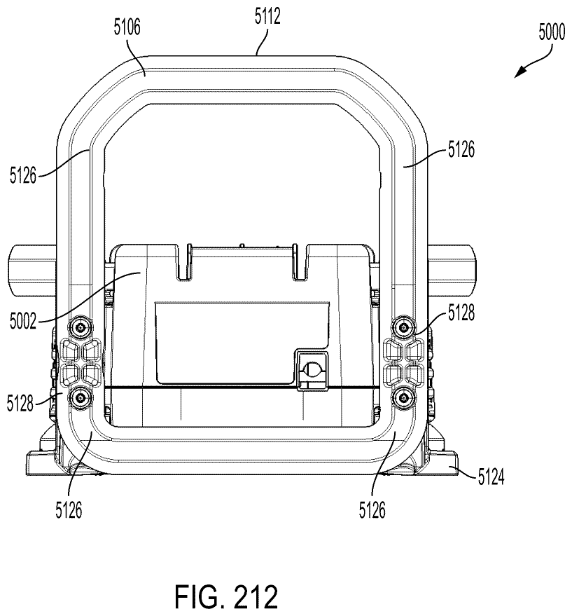

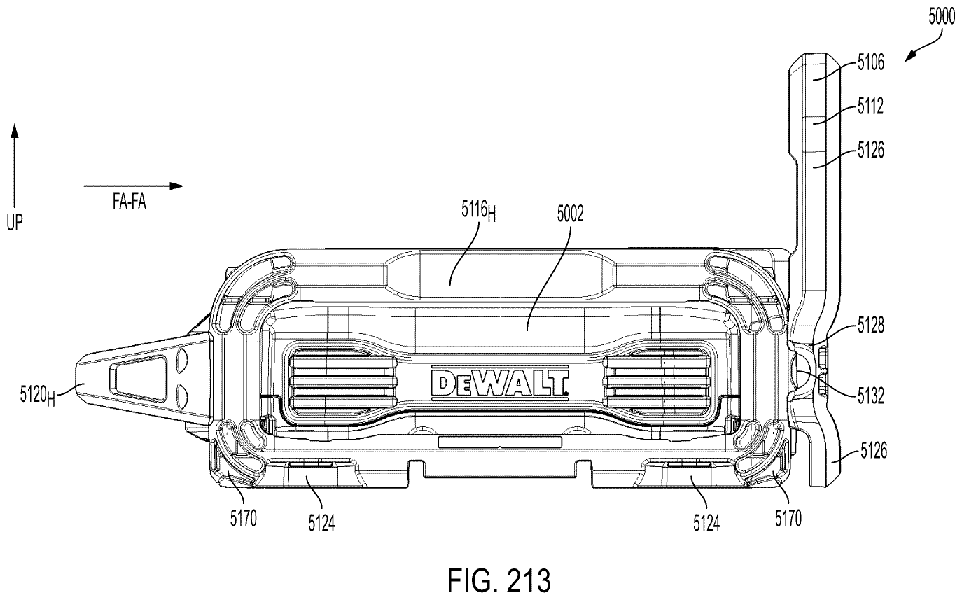

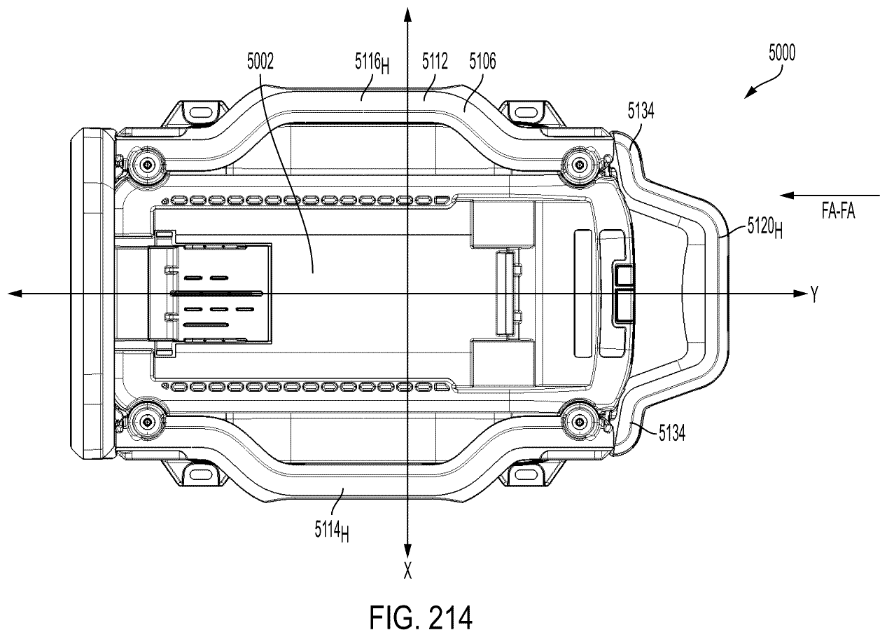

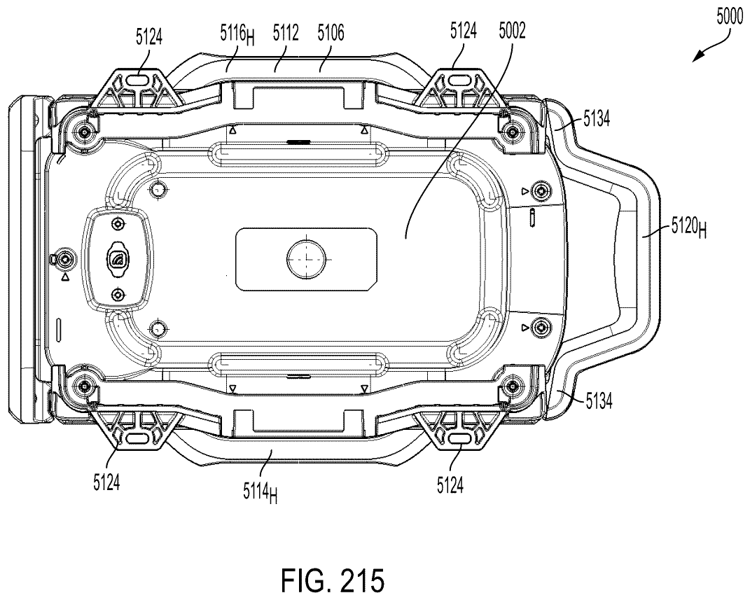

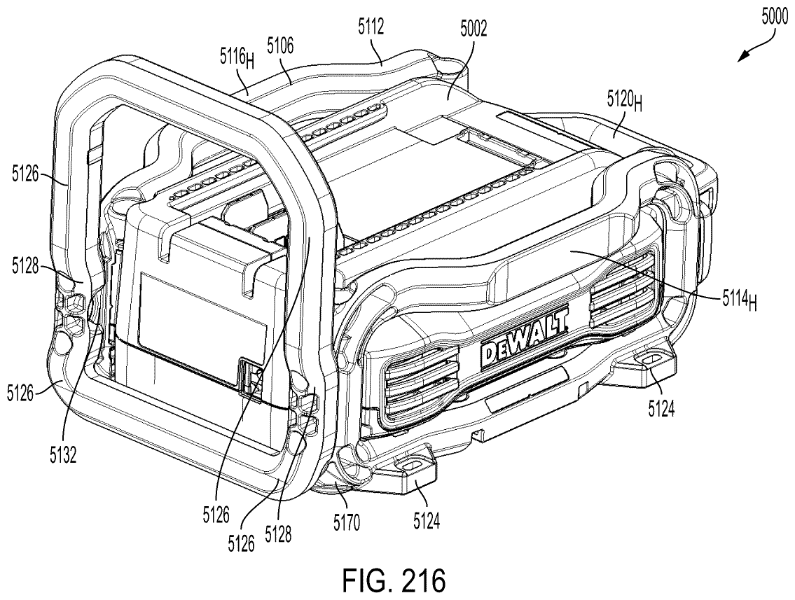

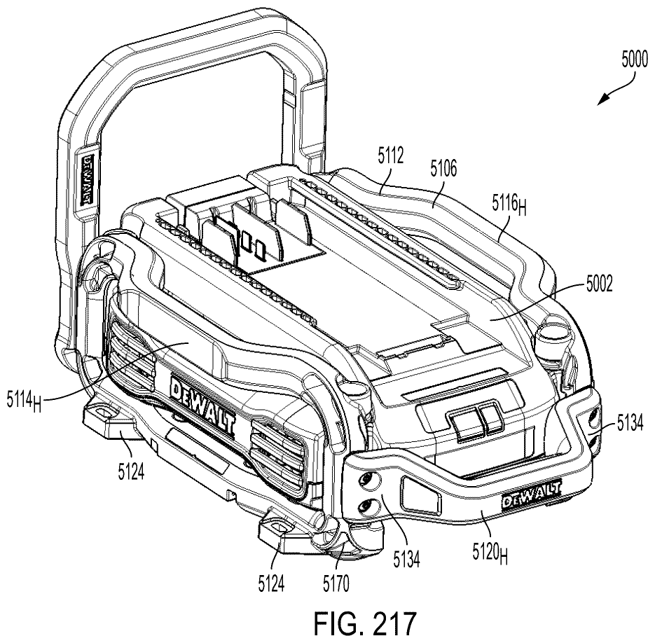

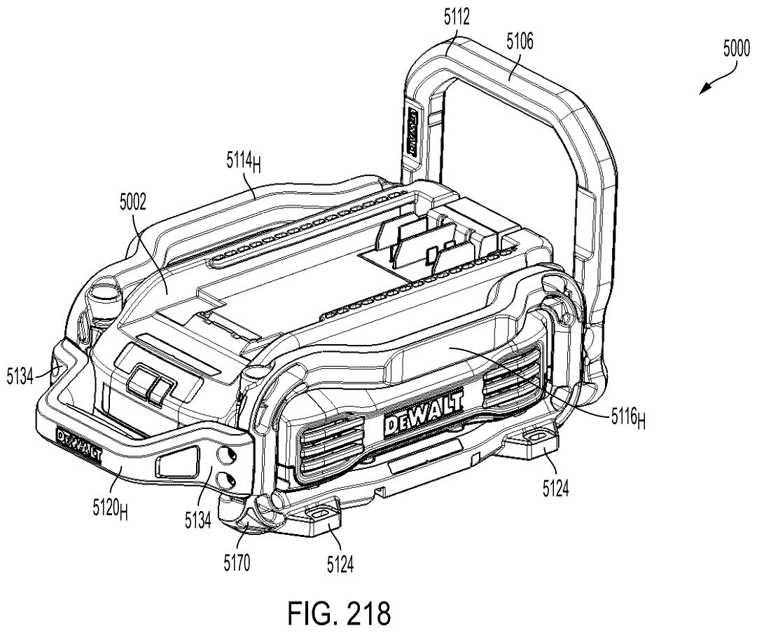

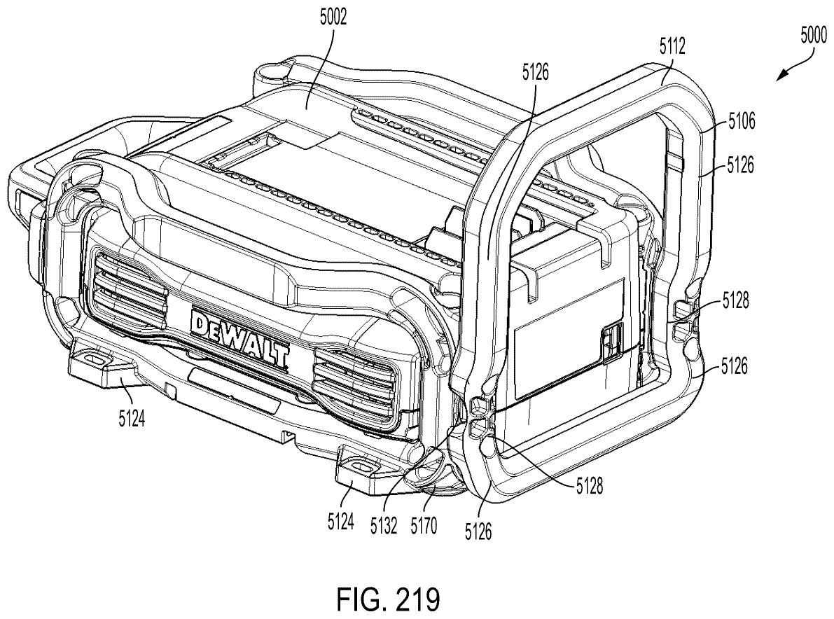

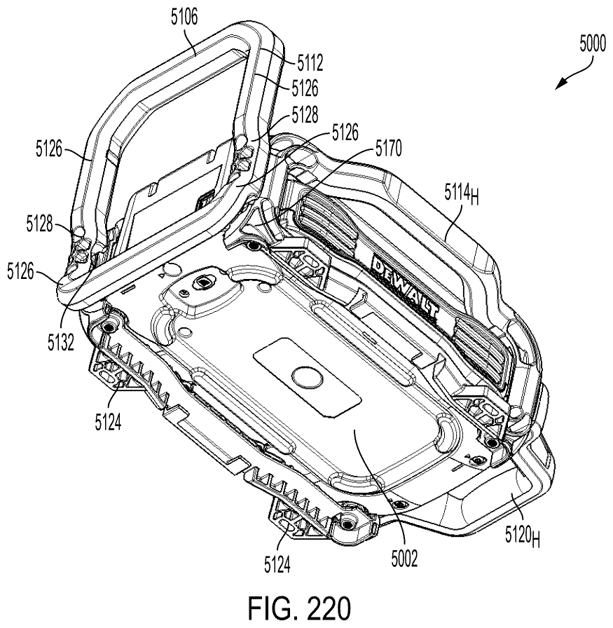

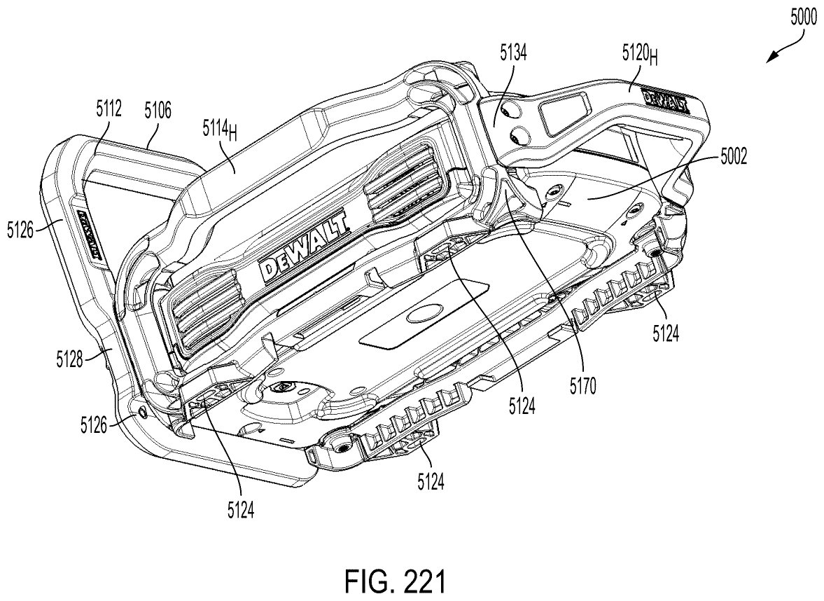

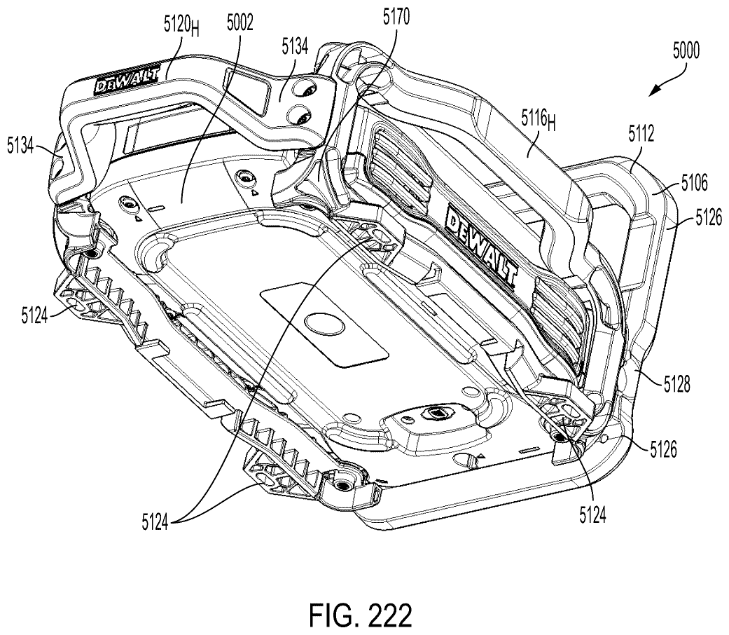

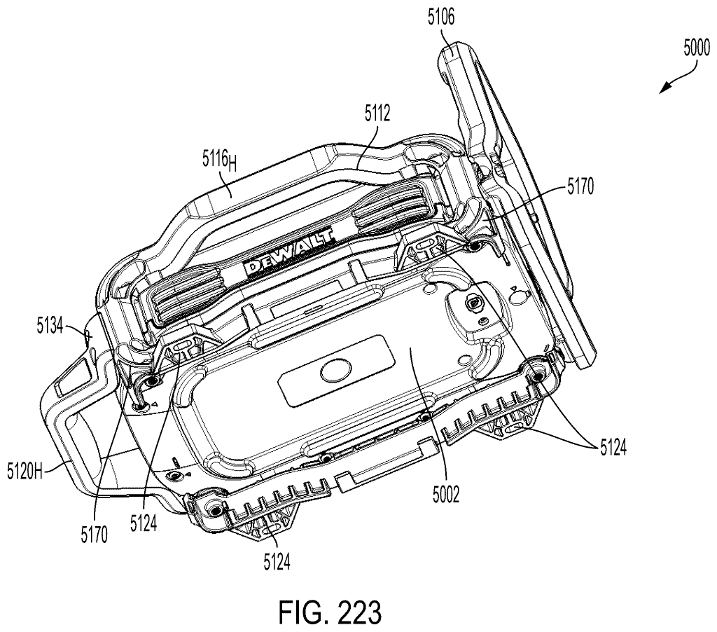

Referring to FIGS. 209A-223, the housing 5002 may be at least partially enclosed/surrounded by a roll cage 5106 to protect the charger 5000 from inadvertent damage. That is, the charger 5000 may include the roll cage 5106 affixed to the housing 5002. FIGS. 209A-209B show the roll cage 5106 separate from the charger 5000 and before the roll cage 5106 is attached to the charger 5000.

The roll cage 5106 may be configured to at least partially enclose/surround the charger 5000. The roll cage 5106 may include a roll cage frame 5112 defined by substantially tubular members 5114, 5116, 5118, 5120. The tubular members 5114, 5116, 5118 may have rectangular shaped configurations. The tubular members 5114, 5116, 5118 may have other shaped configurations. The tubular member 5120 may have a U-shaped configuration. The tubular members 5114, 5116, 5118, 5120 of the roll cage 5106 may be made of a metal material. The tubular members of the roll cage 5106 may be disposed on four sides of the charger 5000 for protecting the charger 5000. The four sides may include the pair of opposing sides 5108, 5110 (that include the front and rear of the charger 5000) and the pair of opposing sides 5060, 5062. The tubular members of the roll cage 5106 may be disposed on five sides of the charger 5000 for protecting the charger 5000. The five sides may include the pair of opposing sides 5108, 5110 (that include the front and rear of the charger 5000), the pair of opposing sides 5060, 5062, and the second side 5008 of the housing 5002 (that includes the bottom 5020 of the charger 5000).

The roll cage frame 5112 may include a pair of opposing side frame portions 5114, 5116 that are spaced from and substantially parallel to each other. Each of the pair of opposing side frame portions 5114, 5116 may include feet portions 5124 (at least two are shown for each) to provide stable support for the charger 5000 when it is in a first orientation (in which the battery pack insertion direction FA-FA is generally horizontal). Each of the pair of opposing side frame portions 5114, 5116 may include end feet portions 5170 (at least two are shown for each) to provide stable support for the charger 5000 when it is in the first orientation.

The roll cage frame 5112 may also include a rear frame portion 5118 that is disposed in a plane that is generally perpendicular to planes of the pair of opposing side frame portions 5114, 5116. The rear frame portion 5118 may include support portions 5126 and connector portions 5128. The connector portions 5128 may protrude inwardly towards the housing 5002 (compared to the support portions 5126) and the connector portions 5128 may be configured to connect the rear frame portion 5118 to the pair of opposing side frame portions 5114, 5116. The support portions 5126 may be disposed on either sides of each of the connector portion 5128. The support portions 5126 may be configured to provide stable support for the charger 5000 when the charger is in a second orientation in which the battery pack insertion direction FA-FA is generally vertical. The rear frame portion 5118 may also include a recess 5132 for passage of the power cord past the roll cage 5100, in general, and the end frame portion 5118 and the side frame portion 5116. A fore frame portion 5120 may include connector portions 5134 at its ends that are configured to connect the fore frame portion 5120 to the pair of opposing side frame portions 5114, 5116.

As shown in FIGS. 209A-209B, each pair of opposing side frame portions 5114, 5116 may have connector portions 5136 that are configured to connect the pair of opposing side frame portions 5114, 5116 to the fore frame portion 5120. The pair of opposing side frame portions 5114, 5116 may also have connector portions 5138 that are configured to connect the pair of opposing side frame portions 5114, 5116 to the rear frame portion 5118. The pair of opposing side frame portions 5114, 5116 may further have connector portions 5140 (that align with portions 5142 on the housing 5002) that are configured to connect the pair of opposing side frame portions 5114, 5116 to the housing 5002. The connector portions 5140 of the pair of opposing side frame portions 5114, 5116 may extend inwardly from their respective side frame portions 5114, 5116 toward the housing 5002 to align the connector portions 5142 on the housing 5002. Mechanical fasteners (e.g., screws, etc.) may be inserted through the corresponding connector portions after they are aligned, for connecting (1) the pair of opposing side frame portions 5114, 5116 to the fore frame portion 5120 (2) the pair of opposing side frame portions 5114, 5116 to the rear frame portion 5118, and (3) the pair of opposing side frame portions 5114, 5116 to the housing 5002.

As discussed in detail below, the roll cage 5106 may further provide grips or handles allowing a user or users to lift the charger 5000 for transport. The roll cage 5106 may include a plurality of handles 5114_{H}, 5116_{H}, 5118_{H}, 5120_{H} to enable carrying the charger 5000 with a battery pack insertion direction FA-FA being vertical (as shown in FIG. 233B) or with the battery pack insertion direction FA-FA being horizontal (as shown in FIG. 233A). For example, the roll cage 5106 may include at least one handle 5120_{H} to enable carrying the battery pack charger 5000 with a battery pack insertion direction FA-FA being vertical (as shown in FIG. 233B) and at least one handle 5114_{H}, 5116_{H} to enable carrying the battery pack charger 5000 with the battery pack insertion direction FA-FA being horizontal (as shown in FIG. 233A).

Each of the plurality of handles 5114_{H}, 5116_{H}, 5118_{H}, 5120_{H} may be ergonomically designed to be contoured to a user's hand. The plurality of handles 5114_{H}, 5116_{H}, 5118_{H}, 5120_{H} of the roll cage 5106 may include the first handle 5120_{H} positioned at the front side 5108 of the housing 5002. The first handle 5120_{H} may be part of the fore frame portion 5120. The first handle 5120_{H} may be configured to extend outwardly from the front side 5108 of the charger 5000. As shown in FIG. 233B, the first handle 5120_{H} may be configured for carrying the charger 5000 when the battery pack insertion direction FA-FA is vertical.

The plurality of handles 5114_{H}, 5116_{H}, 5118_{H}, 5120_{H} of the roll cage 5106 may also include a second handle 5118_{H} positioned at the rear side 5110 of the housing 5002 and a pair of side handles 5114_{H}, 5116_{H} positioned at each of the opposing sides 5060, 5062 of the housing 5002. The second handle 5118_{H} may be a part of the rear frame portion 5118. The pair of side handles 5114_{H}, 5116_{H} may be part of the pair of opposing side frame portions 5114 and 5116, respectively. The pair of side handles 5114_{H}, 5116_{H} of the roll cage 5106 may be configured for carrying the charger 5000 when the battery pack insertion direction FA-FA is horizontal. The second handle 5118_{H} may be optional.

Each of the side handles 5114_{H}, 5116_{H} of the roll cage 5106 may be configured to extend outwardly from their respective sides 5114, 5116 so as to accommodate user's fingers to allow the user to lift the charger 5000 for transport.

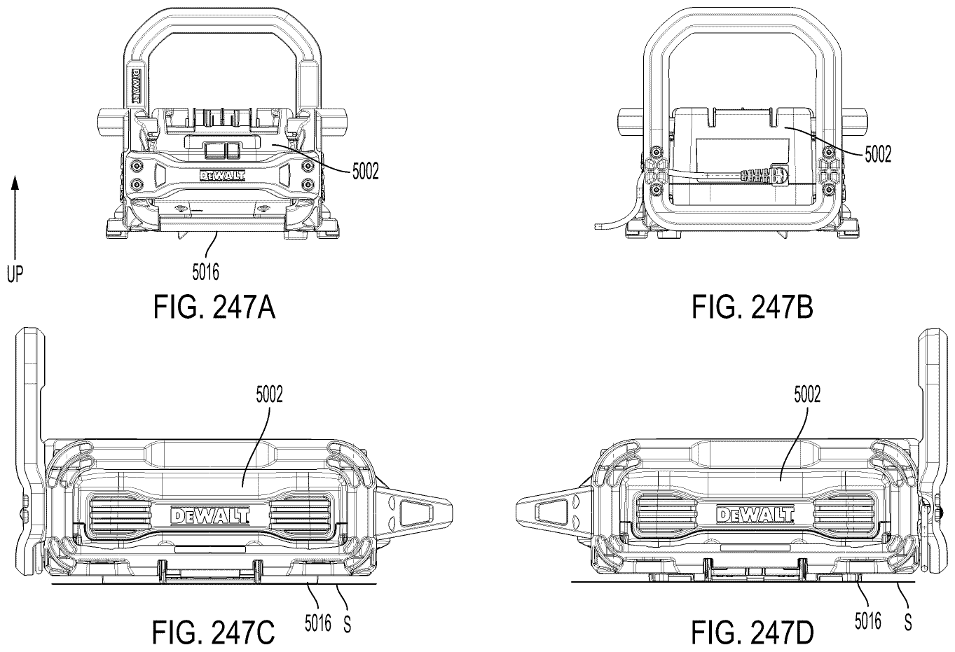

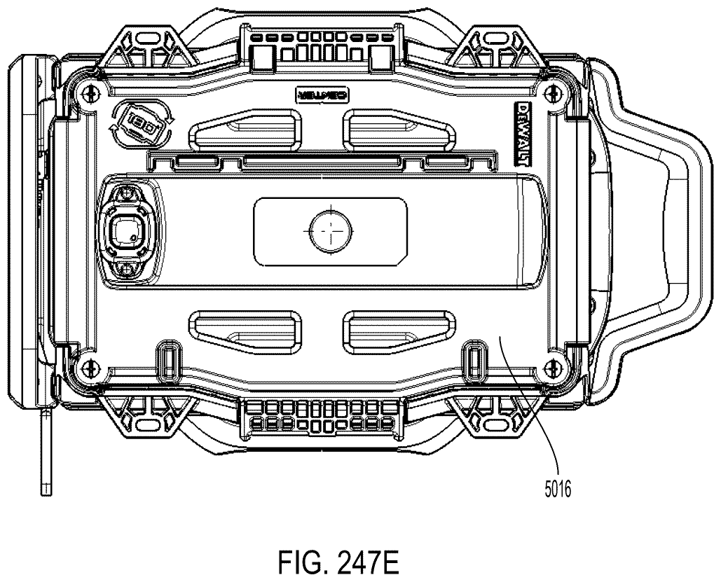

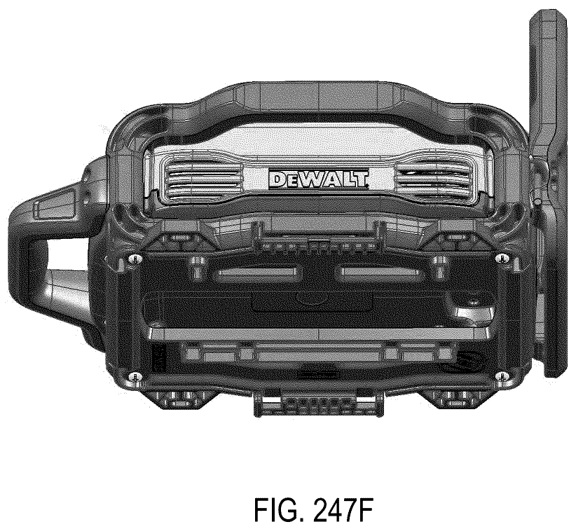

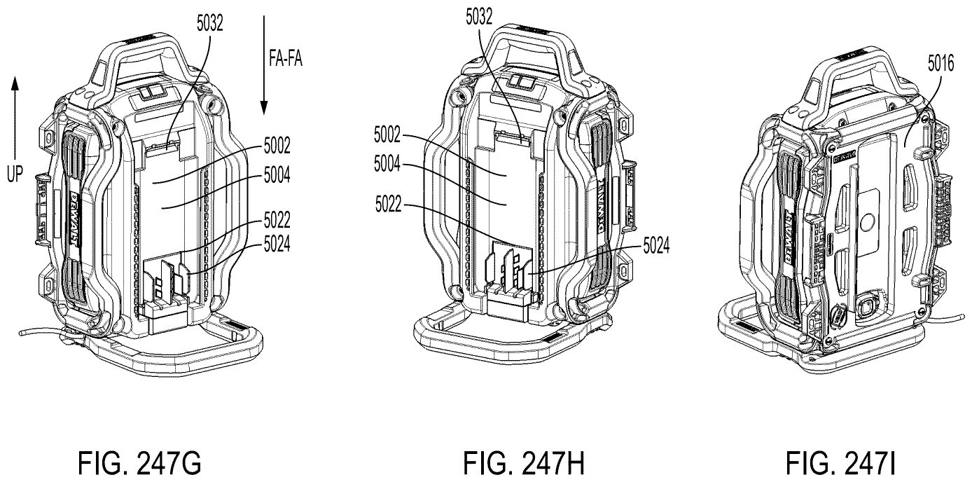

The feet portions 5124 of the side frame portions 5114, 5116 of the roll cage 5106 may be configured to provide stable support for the charger 5000 when the charger 5000 is in the first orientation. The feet portions 5124 of the roll cage 5106 may extend outwardly away from the side frame portions 5114, 5116 and/or the housing 5002 to provide stable support for the charger 5000 when the charger 5000 is in the first orientation. For example, as shown in FIGS. 247C and 247D, the bottom 5044 of the coupling plate 5016 may be configured to provide stable support for the first orientation when the coupling plate 5016 is attached to the charger 5000.

As shown in FIG. 233B, the roll cage 5106 may be configured to provide stable support for a second orientation of the charger 5000 in which the battery pack insertion direction FA-FA is generally vertical. The rear frame portion 5118 of the roll cage 5106 may be configured to provide stable support for the second orientation. The support portions 5126 of the rear frame portion 5118 may be configured to provide stable support for the charger 5000 when the charger 5000 is in the second orientation.

The first side 5004 of the charger 5000 may include a first interface 5010 configured to receive/mate/couple with the battery pack 5006 along a first axis FA-FA. The first axis FA-FA may include a horizontal insertion direction of the battery pack 5006 when the charger 5000 is positioned in a horizontal orientation (as shown in FIG. 233A). The first axis FA-FA may also include a vertical insertion direction of the battery pack 5006 when the charger 5000 is positioned in a vertical orientation (as shown in FIG. 233B).

The first interface 5010 of the charger 5000 may be configured to facilitate interconnections with the battery pack 5006. The first interface 5010 may include a terminal block 5022 and a plurality (or a set) of terminals 5024 configured for engagement along the first axis FA-FA with the battery pack 5006 and configured to provide an electrical interconnection with the battery pack 5006. The set of terminals 5024 of the charger 5000 may be disposed within the open deck cavity for providing electrical connections between the charger 5000 and the battery pack 5006. The charger terminals 5024 are configured to electrically couple to the set of battery pack terminals to provide power from the charger 5000 to the plurality of battery cells in the battery pack 5006. For example, the charger terminals 5024 may include charger power terminals 5024_{P} and charger signal terminals 5024_{S}. The set of charger terminals 5024 may include two power terminals 5024_{P} and five signal terminals 5024_{S}. The number of charger signal terminals may vary. The charger power terminals 5024_{P} may include a + terminal, and a − terminal. The charger signal terminals 5024_{S} may also be referred to as communications (COMM) terminals.

The first interface 5010 may also include a rail interface portion 5026 configured for engagement along the first axis FA-FA to the battery pack 5006 and configured to provide a physical interconnection with the battery pack 5006. The rail interface portion 5026 may include a pair of grooves 5028 and a pair of rails 5030. The first interface 5010 may also include a catch 5032. The grooves 5028, the rails 5030 and the catch 5032 may be disposed on the first side 5004 of the housing 5002.

The grooves 5028 of the charger 5000 may be configured to receive corresponding rails of the battery pack 5006 and the rails 5030 of the charger 5000 may be configured to be received in corresponding grooves of the battery pack 5006 when the battery pack 5006 slidingly engages/couples with the charger 5000. That is, the set of rails and the set of grooves of the battery pack 5006 may be configured to engage with the set of grooves 5028 and the set of rails 5030 of the charger 5000 to assist in mechanically coupling the battery pack 5006 and the charger 5000 together. The battery pack 5006 may include a slide type battery pack. The battery pack 5006 may have a capacity of 10 Ah, an impedance of equal to or less than approximately 3 milliohms, and a nominal voltage of 54V. The battery pack 5006 may include a plurality of battery cells connected in series (strings) and/or a plurality of strings of cells connected in parallel with one another.

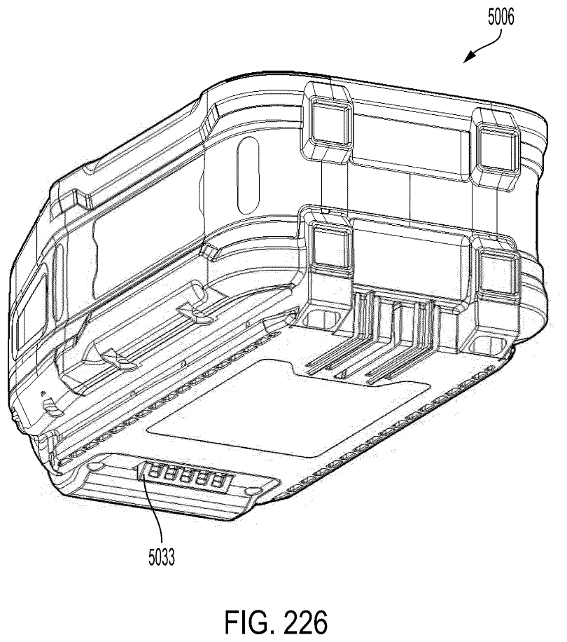

The catch 5032 of the charger 5000 may be configured to engage with a latch 5033 (as shown in FIG. 226) disposed on the battery pack 5006. The latch 5033 may be configured to move into and out of the cavity of the battery pack 5006 upon depression of a user actuated latch button 5035 of the battery pack 5006. The latch 5033 may be configured to be received in the catch 5032 of the charger 5000 when the battery pack 5006 is fully engaged with/coupled to the charger 5000 to mechanically couple the battery pack 5006 and the charger 5000. In order to disengage/decouple the battery pack 5006 from the charger 5000, the user actuated latch button 5035 is depressed to release the latch 5033 of the battery pack 5006 from the catch 5032 of the charger 5000. The battery pack 5006 can then be removed from the charger 5000. In another embodiment, the first interface 5010 may include a latch that may be configured to engage with a catch disposed on the battery pack 5006.

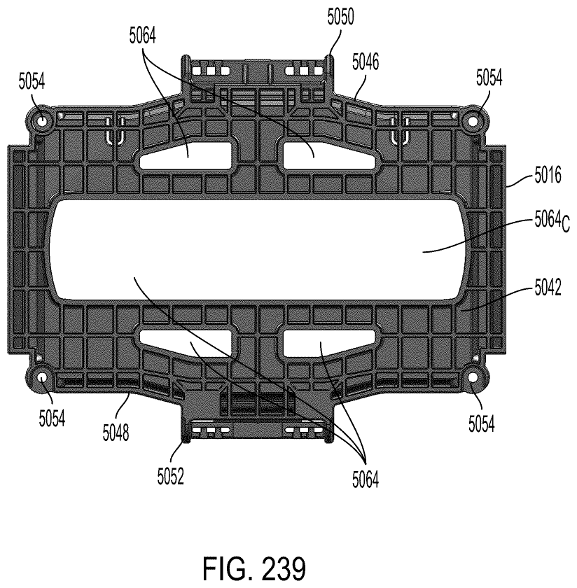

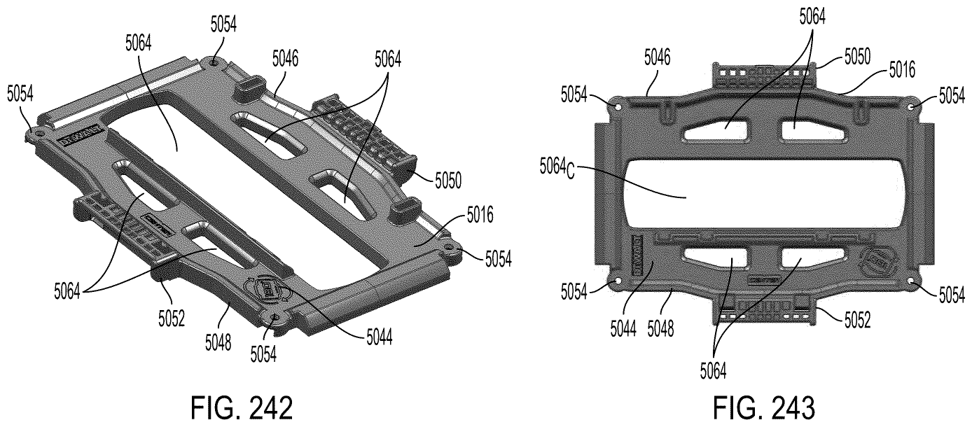

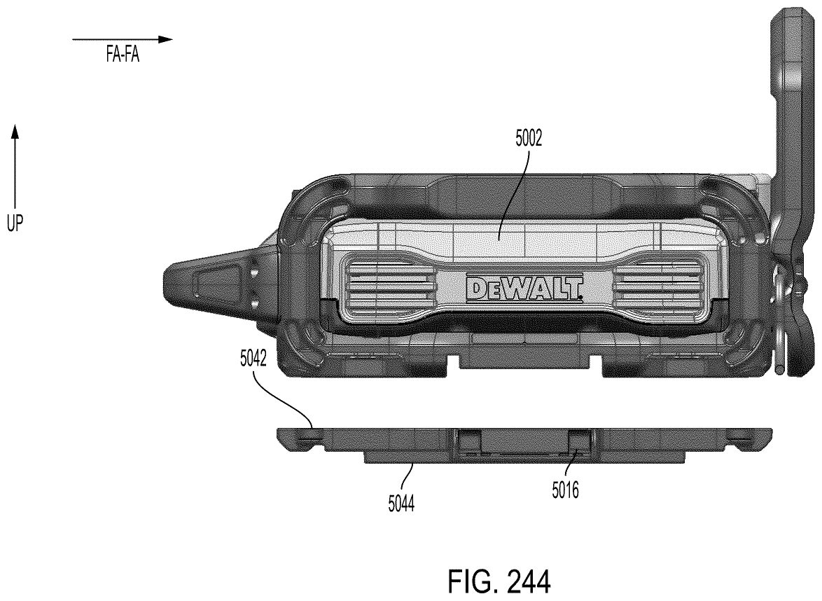

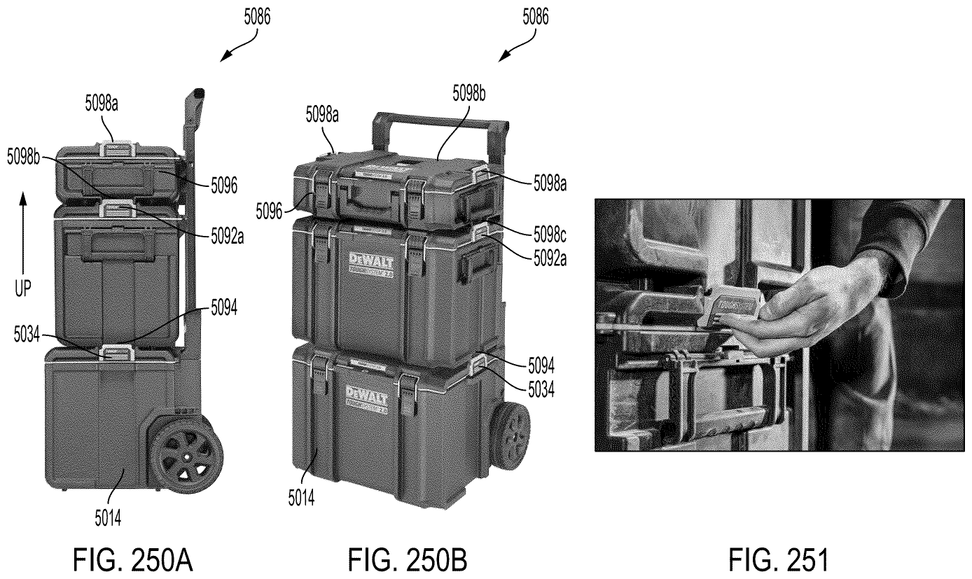

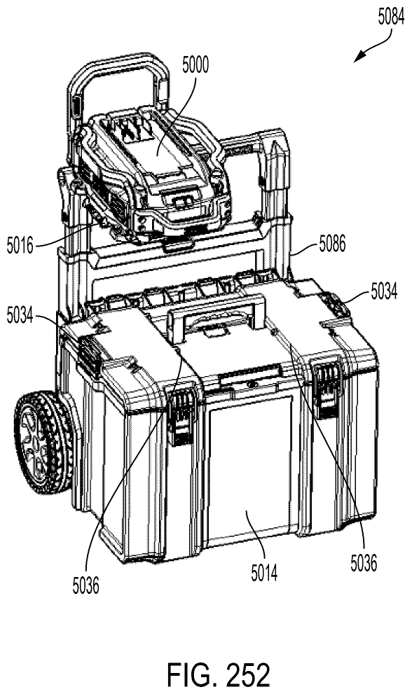

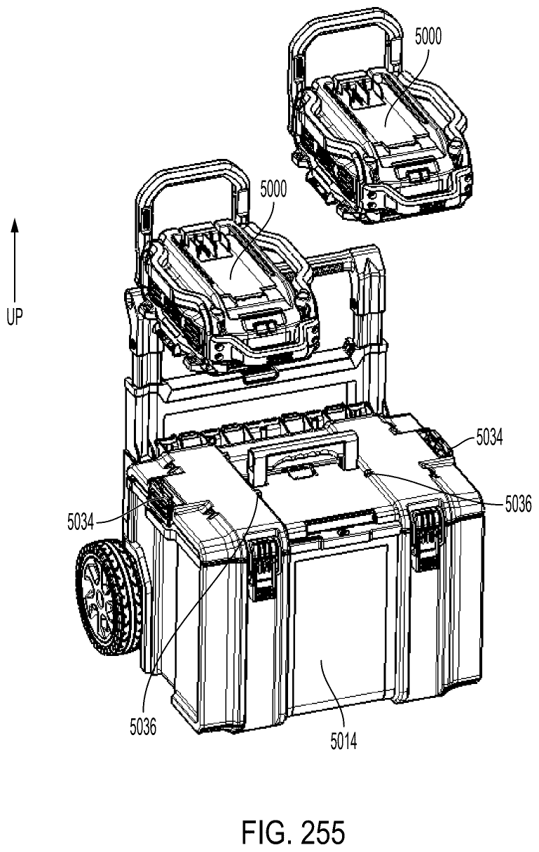

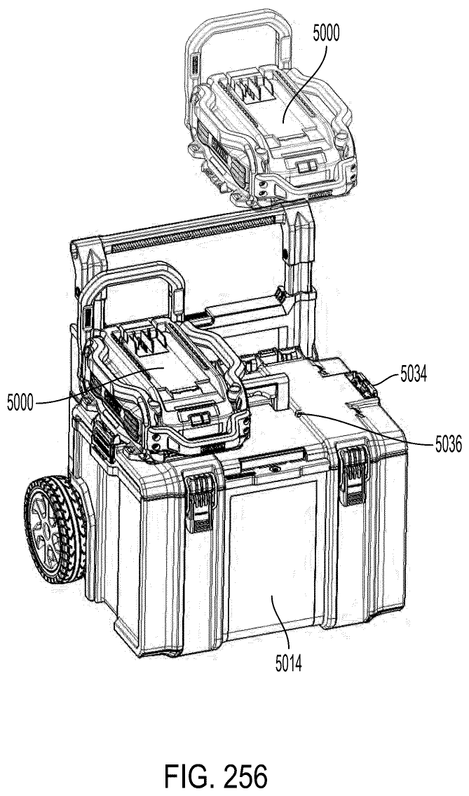

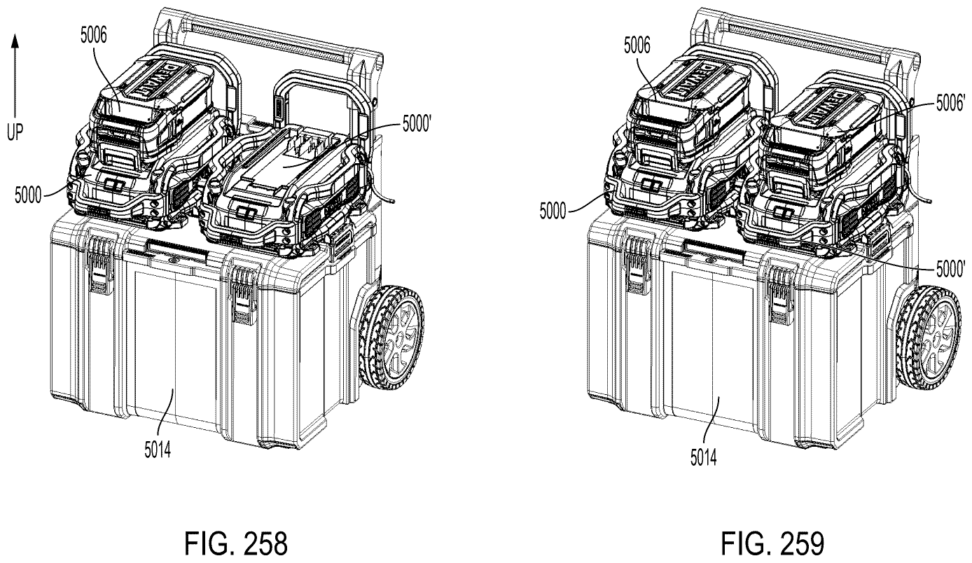

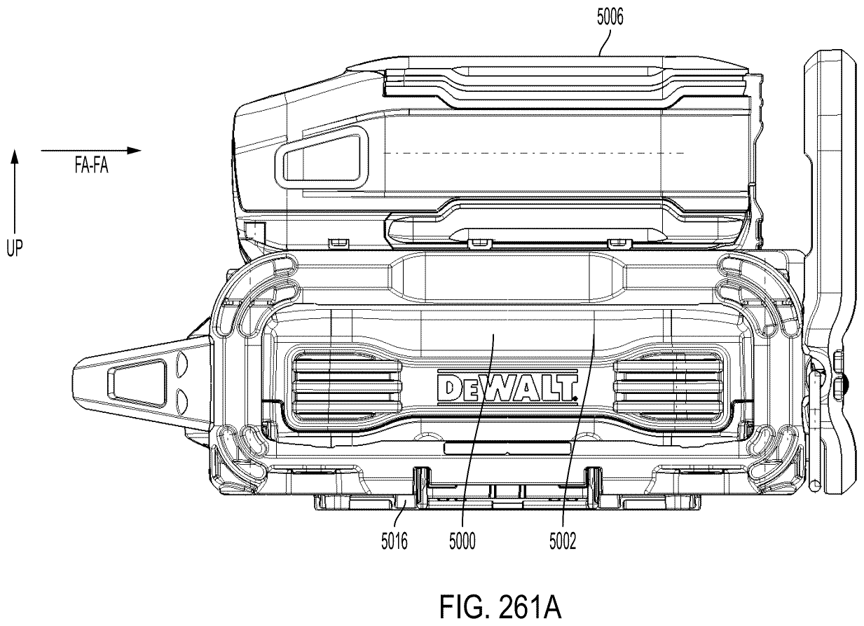

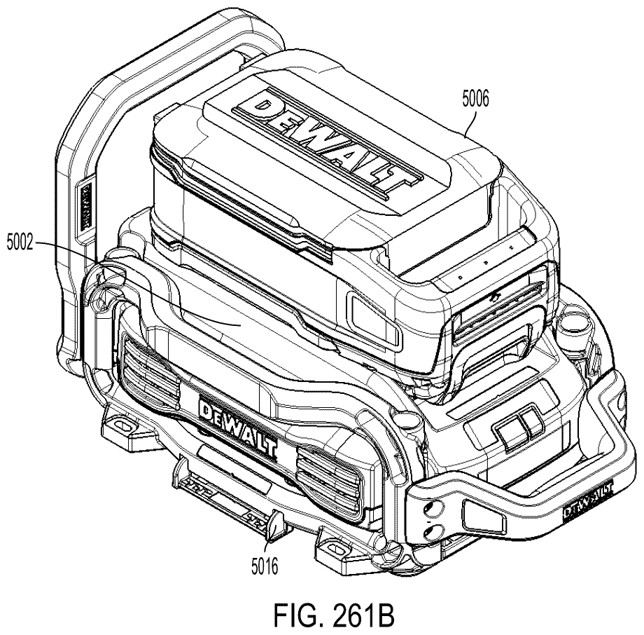

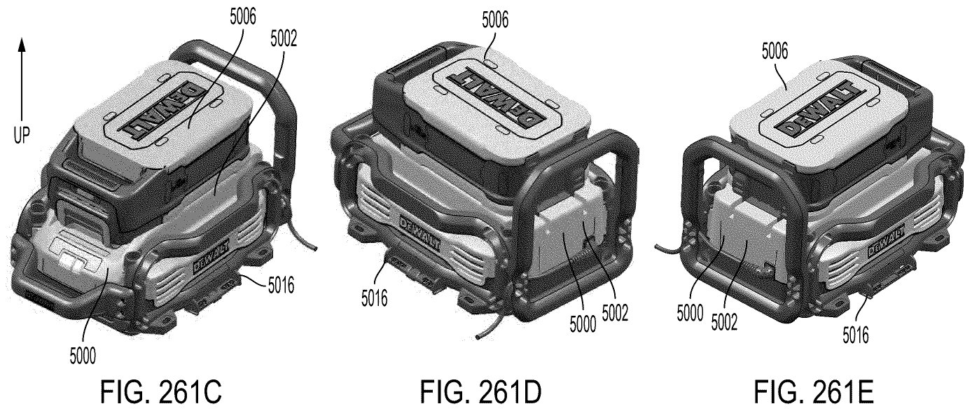

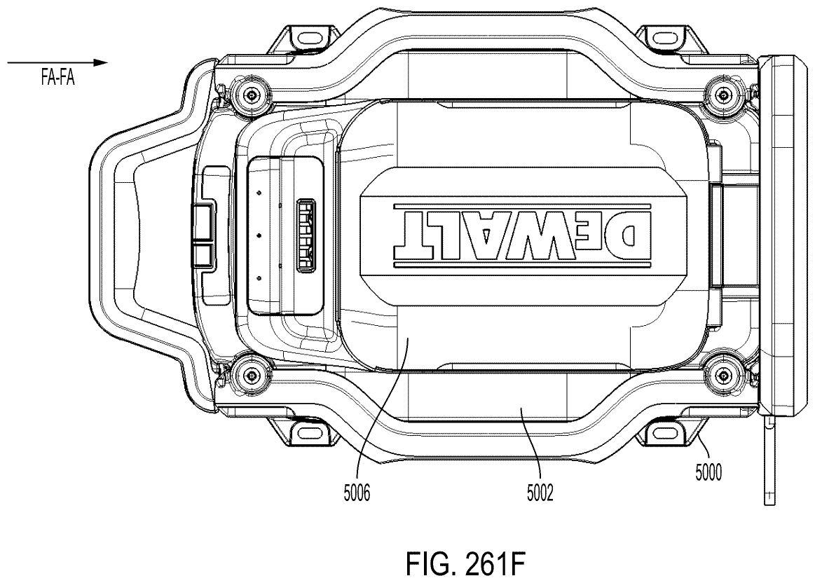

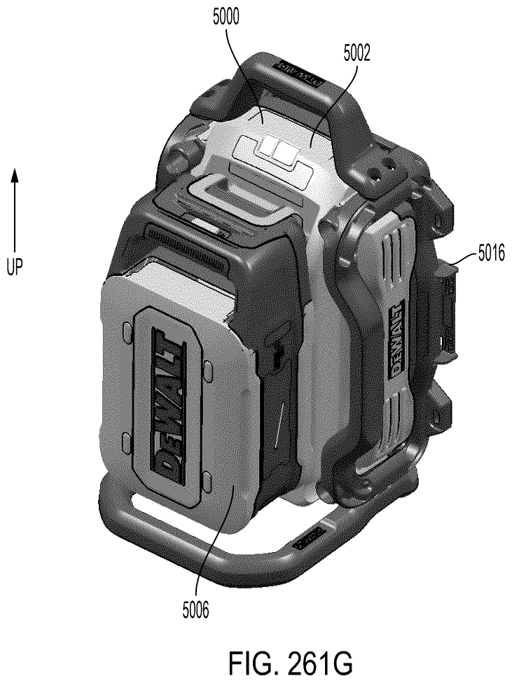

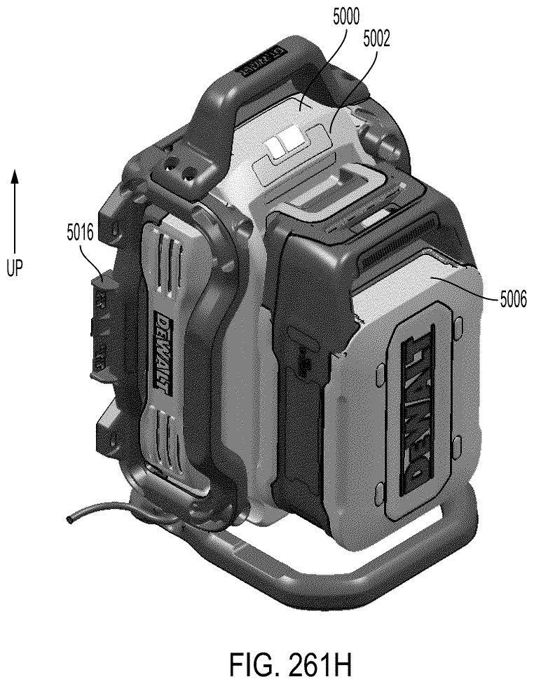

Referring to FIGS. 239-261I, the second side 5008 of the charger 5000 may include a second interface 5012 configured to mount to a storage container 5014. The second interface 5012 may include a coupling plate 5016 for coupling the housing 5002 of the charger 5000 to the storage container 5014.

Referring to FIGS. 239-243, the coupling plate 5016 may include the top 5042, a bottom 5044, a first side 5046 and a second side 5048, opposed to the first side 5046. The coupling plate 5016 may be made of Acrylonitrile Butadiene Styrene (ABS) material. The coupling plate 5016 may be made of a high/hard impact plastic material. The coupling plate 5016 may include a first connection element 5050 disposed on the first side 5046 of the coupling plate 5016. The coupling plate 5016 may include a second connection element 5052 disposed on the second side 5048 of the coupling plate 5016. The first connection element 5050 may also be referred to as plate/coupling plate connection element A. The second connection element 5052 may also be referred to as plate/coupling plate connection element B. The first connection element 5050 and the second connection element 5052 of the coupling plate 5016 may protrude outwardly from their respective sides 5046, 5048 to engage and mate with the corresponding connection elements of the storage container 5014 (as will clear from the discussions described in detail below).

The coupling plate 5016 may include a plurality of cutout regions 5064 that are configured to reduce the weight and amount of material required for the coupling plate 5016. The plurality of cutout regions 5064 may also function as airflow openings 5064 that are configured to allow airflow between the bottom 5020 of the charger 5000 and its surrounding environment. A central cutout region 5064_{C} may be configured to provide access to some components/parts disposed on the bottom 5020 of the charger 5000. The top 5042 of the coupling plate 5016 may include a plurality of longitudinal and transverse reinforcing ribs that intersect to define a plurality of undercut regions/channels between them. The plurality of undercut regions/channels may be configured to reduce the weight and amount of material required for the coupling plate 5016 while the plurality of reinforcing ribs may be configured to provide mechanical strength required by coupling plate 5016.

The top 5042 of the coupling plate 5016 may be configured to be removably connected to the second side 5008 (e.g., bottom 5020) of the charger 5000. In another embodiment, the coupling plate 5016 may be configured to be removably connected to the roll cage. In yet another embodiment, the coupling plate 5016 may be configured to be removably connected to both the roll cage and the charger 5000. The coupling plate 5016 may include fastener openings/holes 5054 in a pattern corresponding to fastener openings/holes 5142 on the bottom 5020 of the charger 5000 and/or fastener openings/holes 5140 on the side roll cage members 5114, 5116 of the charger 5000. Four holes are shown but the number of holes may vary. Mechanical fasteners (e.g., screws, etc.) 5058 may be inserted through the fastener openings/holes 5054, 5142 after they are aligned, for connecting the coupling plate 5016 to the charger 5000.

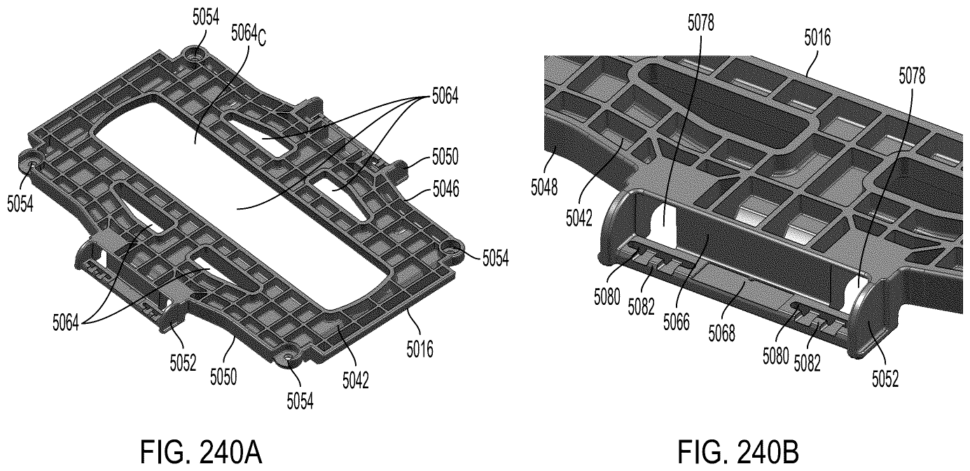

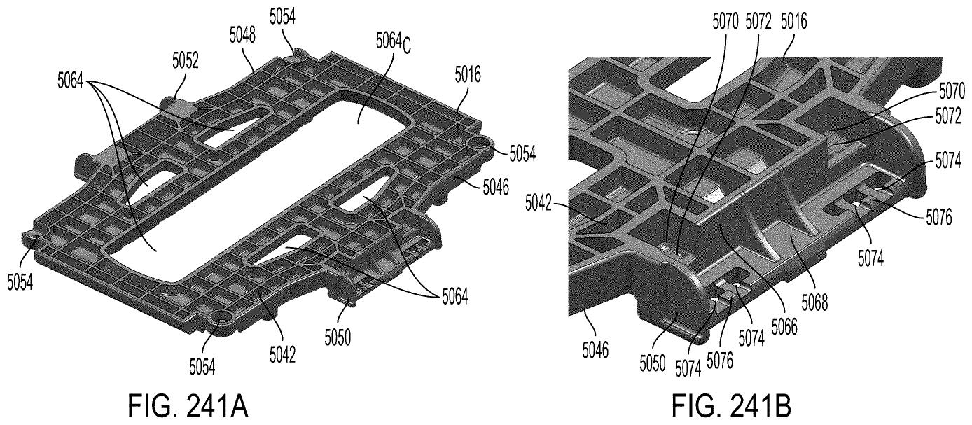

In an example embodiment, the first connection element 5050 and the second connection element 5052 may include an L-shaped configuration or a step shaped configuration having a vertical/first member 5066 and a horizontal/second member 5068. The first connection element 5050 may include a plurality of protrusions, a plurality of openings/recesses, and other interlocking elements (elements which may simply or also engage with each other). As shown in FIG. 241B, the first connection element 5050 may include end recesses 5070 with surfaces 5072 on the first member 5066, and openings 5074 and protrusions 5076 on the second member 5068. The second connection element 5052 may include a plurality of protrusions, a plurality of recesses/openings, and other interlocking elements. As shown in FIG. 240B, the second connection element 5052 includes end openings 5078 on the first member 5066 and recesses/openings 5080 and protrusions 5082 on the second member 5068. These configurations of the first connection element 5050 and the second connection element 5052 are exemplary. The first connection element 5050 and the second connection element 5052 may have any other interlocking configurations as long as the first connection element 5050 and the second connection element 5052 are configured to engage and mate with the corresponding connection elements of the storage container 5014.

The coupling plate 5016 may be configured to be removably attachable to the charger 5000 in either a first orientation or a second orientation. The coupling plate 5016 may be attachable to the second side 5008 (e.g., bottom 5020) of the housing 5002 in the first orientation. In a second orientation, the coupling plate 5016 may be rotated 180° about a second axis SA-SA generally perpendicular to the first axis FA-FA from the first orientation to the second orientation. That is, in the second orientation, the coupling plate second orientation is rotated 180° about a second axis SA-SA generally perpendicular to the first axis FA-FA from the coupling plate first orientation. The coupling plate 5016 may also be rotated 180° about the second axis SA-SA from the second orientation back to the first orientation.

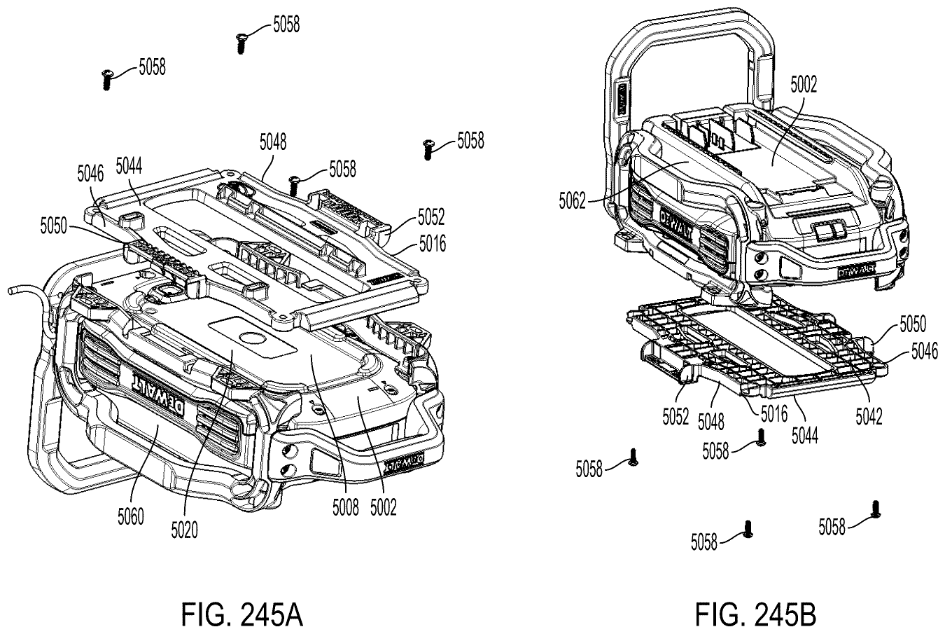

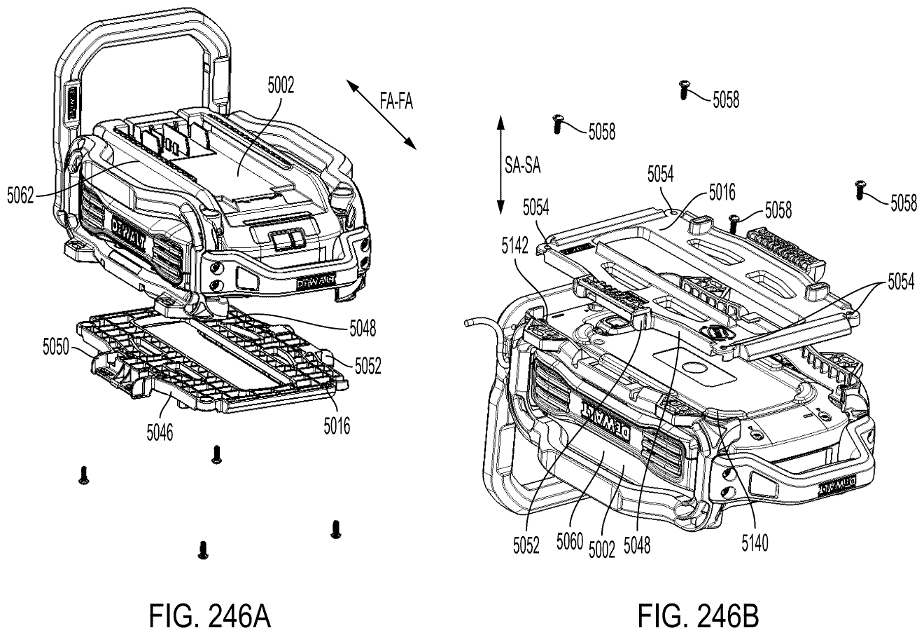

As shown in FIGS. 245A-245B, when the coupling plate 5016 is in the first orientation, the first side 5046 (having the first connection element 5050) of the coupling plate 5016 may be configured to be disposed on the same side as the third side 5060 of the charger 5000 and the second side 5048 (having the second connection element 5052) of the coupling plate 5016 may be configured to be disposed on the same side as the fourth side 5062 of the charger 5000. Alternatively, as shown in FIGS. 246A-246B, when the coupling plate 5016 is in the second orientation, the first side 5046 of the coupling plate 5016 may be configured to be disposed on the same side as the fourth side 5062 of the charger 5000 and the second side 5048 of the coupling plate 5016 may be configured to be disposed on the same side as the third side 5060 of the charger 5000.

The storage container 5014 may include a pair of first connection elements 5034 (5034_{A}, 5034_{A}) and a pair of second connection elements 5036 (5036_{B}, 5036_{B}). The pair of first connection elements 5034 and the pair of second connection elements 5036 may be disposed on a top portion 5038 of the storage container 5014. The first connection elements 5034 may also be referred to as container top connection element A. The second connection elements 5036 may also be referred to as container top connection element B.

The pair of first connection elements 5034 may be disposed at top end portions 5040, 5041 of the storage container 5014. One of the first connection elements 5034 may be disposed at one of the top end portion 5040 and the other of the first connection elements 5034 may be disposed at the other top end portion 5041. The pair of second connection elements 5036 may be disposed between the pair of first connection elements 5034 of the storage container 5014. The pair of second connection elements 5036 may be disposed in a top middle portion of the storage container 5014. The pair of second connection elements 5036 may be disposed between the top end portions 5040, 5041 of the storage container 5014.

The first connection element 5050 of the coupling plate 5016 may have a different configuration than the second connection element 5052 of the coupling plate 5016. As will be clear from the discussions below, the first connection element 5050 of the coupling plate 5016 may be configured to engage and mate with each of the pair of first connection elements 5034 of the storage container 5014. The second connection element 5052 of the coupling plate 5016 may be configured to engage and mate with each of the pair of second connection elements 5036 of the storage container 5014.

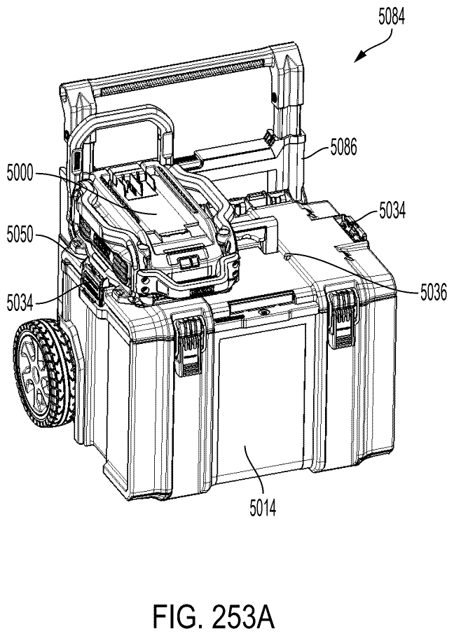

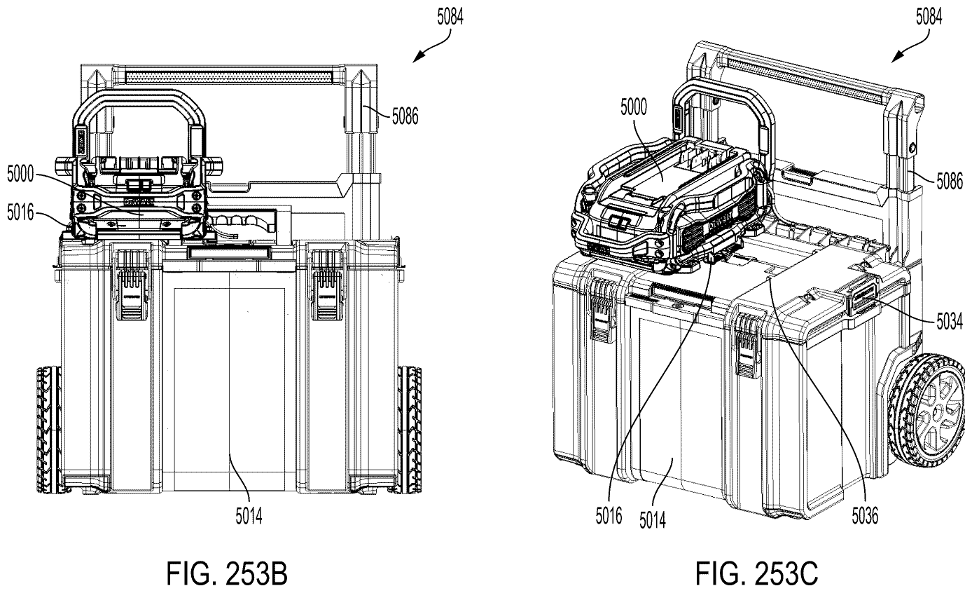

FIGS. 253A-255 show the coupling plate 5016 attached the charger 5000 in the first orientation. The first connection element 5050 of the coupling plate 5016 may be configured to mate with one of the pair of first connection elements 5034 of the storage container 5014 when the coupling plate 5016 is in the first orientation. The second connection element 5052 of the coupling plate 5016 may be configured to mate with one of the pair of second connection elements 5036 of the storage container 5014 when the coupling plate 5016 is in the first orientation.

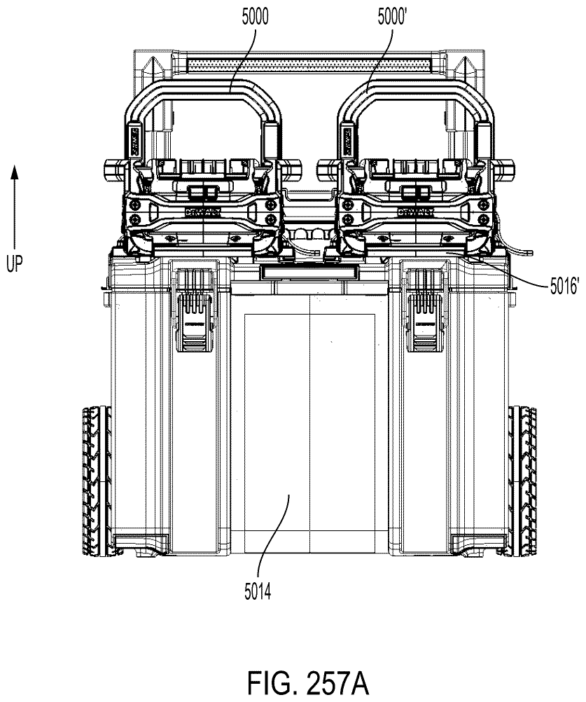

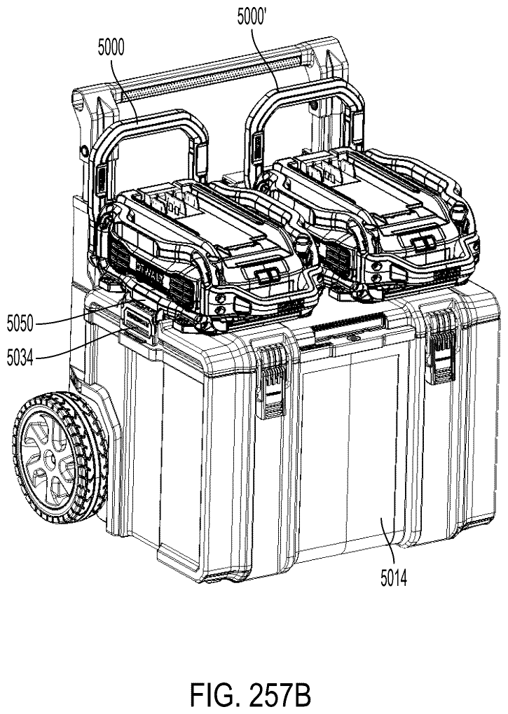

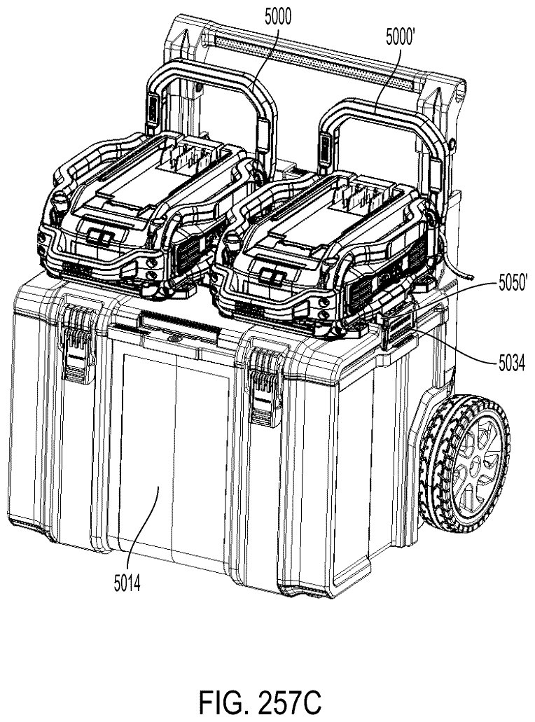

FIGS. 257A-259 show the coupling plate 5016′ attached the charger 5000′ in the second orientation. The first connection element 5050′ of the coupling plate 5016′ may be configured to mate with the other of the pair of first connection elements 5034 of the storage container 5014 when the coupling plate 5016′ is in the second orientation. The second connection element (not shown in the figures but the second connection element of the coupling plate 5016′ is similar to the second connection element 5052 of the coupling plate 5016 as shown and described in detail above) of the coupling plate 5016′ may be configured to mate with the other of the pair of second connection elements 5036 of the storage container 5014 when the coupling plate 5016′ is in the second orientation.

Although the coupling plate 5016′ attached to the charger 5000′ is shown to be in the second orientation in FIGS. 257A-259, a person of ordinary skill in the art would readily appreciate that the coupling plate 5016 of the charger 5000 may be connected to the storage container 5014 in the second orientation (instead of in the first orientation) by (a) disconnecting and removing the charger 5000′, with the coupling plate 5016′ in the second orientation, from the storage container 5014, (b) disconnecting and removing the charger 5000, with the coupling plate 5016 in the first orientation, from the storage container 5014, (c) disconnecting the coupling plate 5016 (in the first orientation) from the charger 5000, (d) rotating the coupling plate 5016 by 180° about the second axis SA-SA generally perpendicular to the first axis FA-FA from the first orientation to the second orientation, (e) connecting the coupling plate 5016 (in the second orientation) to the charger 5000, and (f) connecting the charger 5000, with the coupling plate 5016 in the second orientation, to the storage container 5014. By following these procedures, the charger 5000, with the coupling plate 5016 in the second orientation, may be attached to the storage container 5014, for example, at the same location in which the coupling plate 5016′ attached to the charger 5000′ is shown in FIGS. 257A-259.

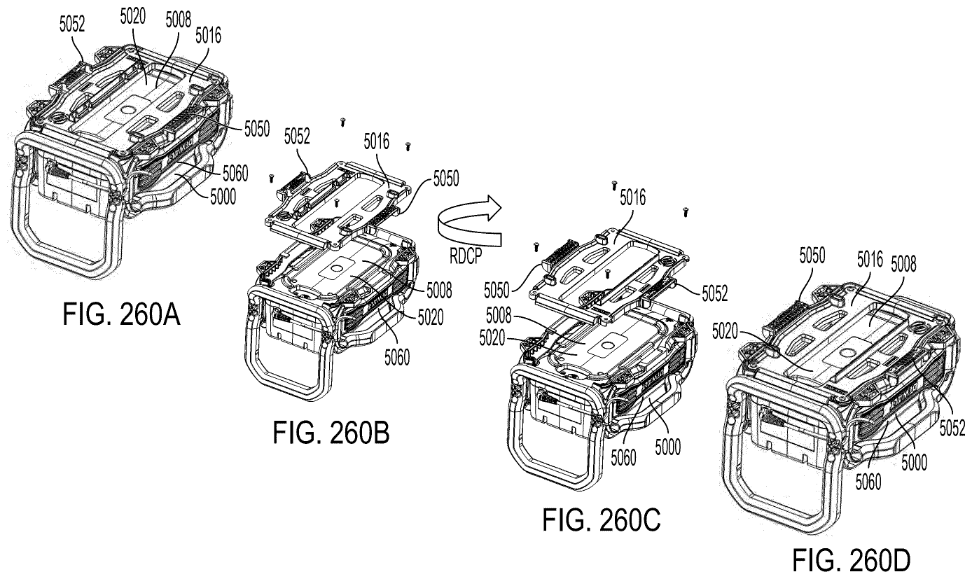

FIGS. 260A-260D show rear, bottom, left-side isometric views with the procedures of moving the coupling plate 5016 between the first orientation and the second orientation. FIG. 260A shows the battery charger 5000 with the coupling plate 5016 attached to the second side 5008 (e.g., bottom 5020) of the housing 5002, where the coupling plate 5016 is in the first orientation. In the first orientation, the first connection element 5050 of the coupling plate 5016 may be disposed on the third side 5060 of the charger 5000, while the second connection element 5052 of the coupling plate 5016 is disposed on the fourth side 5062 of the charger 5000. FIG. 260B shows the coupling plate 5016 in the first orientation disconnected from the battery charger 5000. The coupling plate 5016 is then rotated 180° about the second axis SA-SA (as shown by the arrow RDCP) generally perpendicular to the first axis FA-FA from the first orientation to the second orientation. FIG. 260C shows the coupling plate 5016 in the second orientation (disconnected from the battery charger 5000) and ready to be connected to the battery charger 5000. In the second orientation, the second connection element 5052 of the coupling plate 5016 may be disposed on the third side 5060 of the charger 5000, while the first connection element 5050 of the coupling plate is disposed on the fourth side 5062 of the charger 5000. FIG. 260D shows the battery charger 5000 with the coupling plate 5016 attached to the second side 5008 (e.g., bottom 5020) of the housing 5002, where the coupling plate 5016 is in the second orientation.

Similar procedures may be followed to move the coupling plate 5016 from the second orientation to the first orientation. In the second orientation, the second connection element 5052 of the coupling plate 5016 may be disposed on the third side 5060 of the charger 5000, while the first connection element 5050 of the coupling plate 5016 is disposed on the fourth side 5062 of the charger 5000. The coupling plate 5016 in the second orientation may be disconnected from the battery charger 5000. The coupling plate 5016 is then rotated 180° about the second axis SA-SA (as shown by the arrow RDCP) generally perpendicular to the first axis FA-FA from the second orientation to the first orientation. In the first orientation, the first connection element 5050 of the coupling plate 5016 may be disposed on the third side 5060 of the charger 5000, while the second connection element 5052 of the coupling plate 5016 is disposed on the fourth side 5062 of the charger 5000. The battery charger 5000 with the coupling plate 5016 attached to the second side 5008 (e.g., bottom 5020) of the housing 5002, where the coupling plate 5016 is in the first orientation.

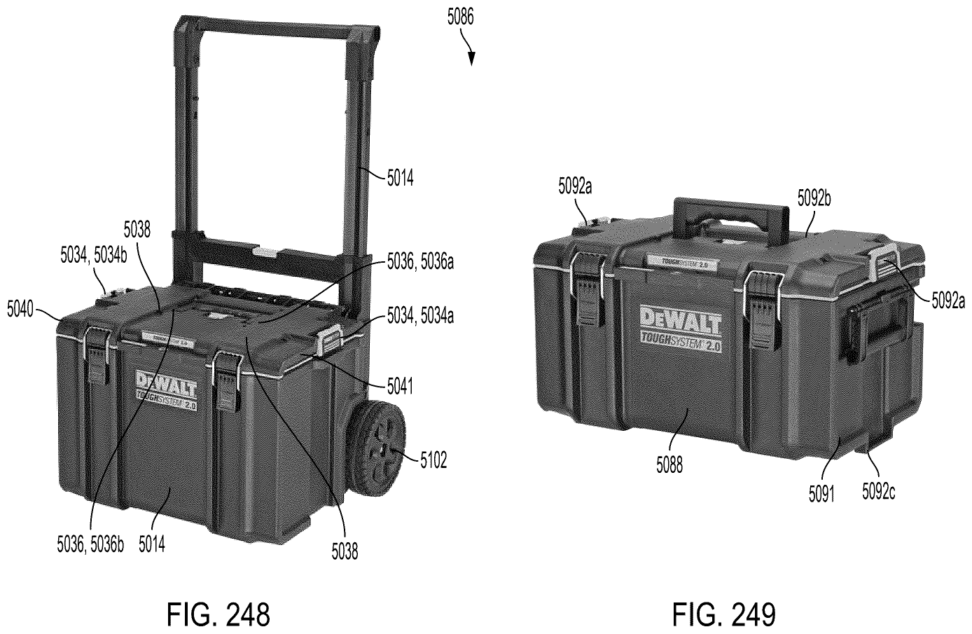

Referring to FIGS. 248-254B, the present patent application includes a battery pack charger system 5084. The battery pack charger system 5084 may include the battery pack charger 5000, a storage system 5086, and the coupling plate 5016. As shown in FIGS. 248-251, the storage system 5084 may include a plurality of storage containers 5014 and 5088 and an attachment system 5090. The attachment system 5090 may include a first set of components 5034, 5036 incorporated into the first storage container 5014 of the plurality of storage containers 5014 and 5088 and a second set of components 5092a, 5092b, 5092c incorporated into a second storage container 5088 of the plurality of storage containers. The second set of components 5092a, 5092b, 5092c of the second storage container 5088 may include a plurality of connecting elements 5092a , 5092b disposed on the top portion of the second storage container 5088 and a plurality of connecting elements 5092c disposed on the bottom portion of the second storage container 5088. The first set of components 5034 of the first storage container 5014 may be configured to mate with the second set of components 5092c of the second storage container 5088 to affix the first storage container 5014 to the second storage container 5088.

Referring to FIG. 249, the first set of components 5034, 5036 of the first storage container 5014 may include a pair of first connection elements 5034a, 5034b and a pair of second connection elements 5036a, 5036b. The pair of first connection elements 5034a, 5034b and the pair of second connection elements 5036a, 5036b may be disposed on the top portion 5038 of the storage container 5014. The pair of first connection elements 5034a, 5034b may be disposed at the end portions 5040, 5041 of the storage container 5014. The pair of second connection elements 5036a, 5036b are disposed between the pair of first connection elements 5034a, 5034b of the storage container 5014.

Referring to FIG. 249, the second set of components 5092a, 5092b, 5092c of the second storage container 5088 may include a pair of first connection elements 5092c. The pair of first connection elements 5092c may be disposed on a bottom portion 5091 of the second storage container 5088. The connection elements 5092a, 5092b of the second storage container 5088 may be similar (in construction and configuration) to and may be disposed at same locations as the connection elements 5034, 5036 of the first storage container 5014.

The pair of first connection elements 5034 of the first storage container 5014 are configured to engage and mate with the pair of first connection elements 5092c (e.g., on the bottom portion 5091) of the second storage container 5088 to affix the first storage container 5014 to the second storage container 5088.

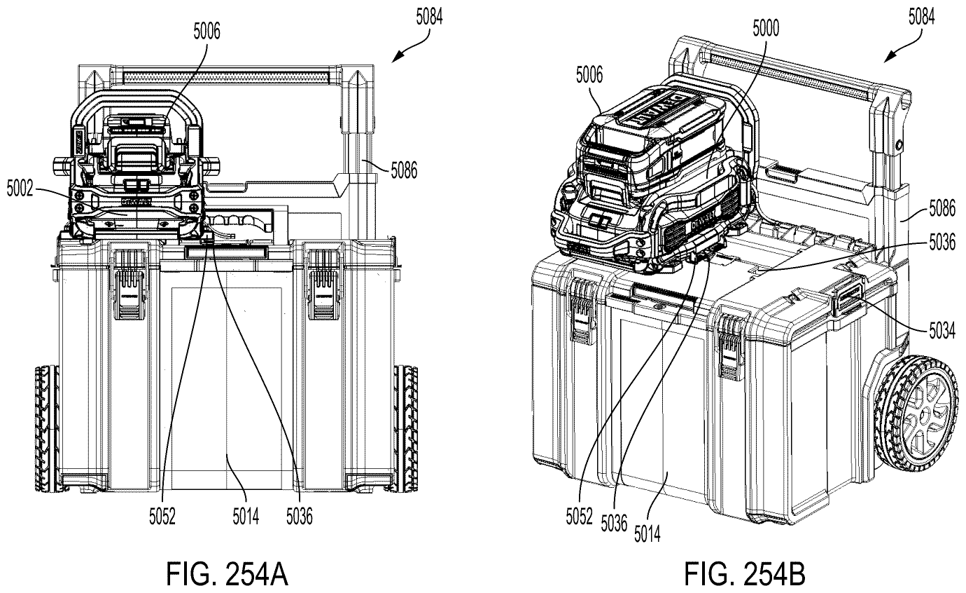

The coupling plate 5016 may include a third set of components 5050, 5052 configured to mate with a first subset 5034a, 5036a, respectively, of the first set of components 5034, 5036 of the first storage container 5014 for affixing the charger 5000 to the first storage container 5014 at a first location and with a second subset 5034b, 5036b, respectively, of the first set of components 5034, 5036 of the first storage container 5014 for affixing the charger 5000 to the first storage container 5014 at a second location. The second location is adjacent to the first location. In FIGS. 253A to 254B, the charger 5000 is in the first location. In FIGS. 257A to 259, the charger 5000 is in the first location and the charger 5000′ is in the second location.

As discussed in detail above, the first set of components 5034, 5036 may include the pair of first connection elements 5034a, 5034b and the pair of second connection elements 5036a, 5036b. The first subset 5034a, 5036a of the first set of components 5034, 5036 of the first storage container 5014 may include one of the pair 5034a of first connection elements 5034 and one of the pair 5036a of second connection elements 5036. The second subset of the first set of components 5034, 5036 of the first storage container 5014 may include the other of the pair 5034b of first connection elements 5034 and the other of the pair 5036b of second connection elements 5036.

The third set of components 5050, 5052 of the coupling plate 5016 includes a first connection element 5050 disposed on the first side 5046 of the coupling plate 5016 and a second connection element 5052 disposed on the second side 5048 of the coupling plate 5016.

Referring to FIGS. 260A-260B, the storage system 5086 may include a third storage container 5096. The third storage container 5096 may include a fourth set of components 5098a, 5098b, 5098c. One component 5098c of the fourth set of components 5098a, 5098b, 5098c of the third storage container 5096 may be configured to mate with the one component 5092a of the second set of components 5092 of the second storage container 5088 to affix the third storage container 5096 to the second storage container 5088. One component 5098c of the fourth set of components 5098a, 5098b, 5098c of the third storage container 5096 may be configured to mate with the One component 5034a of the first set of components 5034 of the first storage container 5014 to affix the first storage container 5014 to the third storage container 5096.

The first, the second and the third storage containers 5014, 5088, 5096 may have different sizes and/or configurations. The third storage container 5096 may be smaller than the second storage container 5088, which may be smaller than the first storage container 5014. The first, the second and the third storage containers 5014, 5088, 5096 may have the same size and/or configuration. The third storage container 5096 may be the same size as the second storage container 5088 and they both may be smaller than the first storage container 5014.

The first storage container 5014 may include a wheeled storage container. The first storage container 5014 may include wheels 5102 disposed toward a rear, lower/bottom portion thereof and a handle 5104 for rolling transport of the first storage container 5014. The wheels 5102 and the handle 5104 may be configured for rolling transport the assembly in a backwards tilted configuration. The handle 5104 may have telescopic configuration. The handle 5104 may be movable between a range of positions having an upper limit and a lower limit. Support legs of the handle 5104 may be configured to telescopically receive extension legs of the handle 5104 to enable such lowering and extension. The second and the third storage containers 5088, 5096 may include a non-wheeled storage containers. Each of the first, the second and the third storage containers 5014, 5088, 5096 may also include a base container having an upper opening into an interior storage space, and a top cover. The top cover may be pivotable and may be arranged to selectively permit or prevent access to the storage space of the base container.

The second and the third storage containers 5088, 5096 may include top connection elements at the top portion and bottom connection elements at the bottom portion thereof. The bottom connection elements may also be referred to as container bottom connection element, and the top connection elements may also be referred to as container top connection element. When the third storage container 5096 is positioned on top of the second storage container 5088, the top connection elements at the top portion of the second storage container 5088 are configured to connect to the bottom connection elements at the bottom portion of the third storage container 5096 to connect the storage containers 5088, 5096. Like the first storage container 5014 (with the container connection elements 5036), the second and the third storage containers 5088, 5096 may include top, middle container connections elements (i.e., connection elements that are disposed in the top portion of the storage container and between the end connections elements) that are configure to couple with the plate connection elements so as to connect the coupling plate 5016 (with the charger 5000 attached thereto) to either the second storage container 5088 or to the third storage container 5096.

The first connection element 5050 of the coupling plate 5016 may be configured to mate with one of the pair 5034a of the first connection elements 5034 of the first storage container 5014 when the battery pack charger 5000 is affixed to the first storage container 5014 at the first location. The second connection element 5052 of the coupling plate 5016 is configured to mate with one of the pair 5036a of the second connection elements 5036 of the first storage container 5014 when the battery pack charger 5000 is affixed to the first storage container 5014 at the first location.

The first connection element 5050 of the coupling plate 5016 may be configured to mate with the other of the pair 5034b of the first connection elements 5034 of the first storage container 5014 when the battery pack charger 5000 is affixed to the first storage container 5014 at the second location. The second connection element 5052 of the coupling plate 5016 is configured to mate with the other of the pair 5036b of the second connection elements 5036 of the first storage container 5014 when the battery pack charger 5000 is affixed to the first storage container 5014 at the second location.

The battery pack charger 5000 is a first battery pack charger and the coupling plate 5016 is a first coupling plate. The first connection element 5050 of the first coupling plate 5016 may be configured to mate with one of the pair 5034a of the first connection elements 5034 of the first storage container 5014 and the second connection element 5052 of the first coupling plate 5016 may be configured to mate with one of the pair 5036a of the second connection elements 5036 of the first storage container 5014 when the first battery pack charger 5000 and its associated coupling plate 5016 is affixed to the first storage container 5014 at the first location. The first connection element (not shown in the figures but the first connection element of the coupling plate 5016′ is similar to the first connection element 5050 of the coupling plate 5016 as shown and described in detail above) of the second coupling plate 5016′ is configured to mate with the other of the pair 5034b of first connection elements 5034 of the first storage container 5014 and a second connection element (not shown in the figures but the second connection element of the coupling plate 5016′ is similar to the second connection element 5052 of the coupling plate 5016 as shown and described in detail above) of the second coupling plate 5016′ is configured to mate with the other of the pair 5036b of the second connection elements 5036 of the first storage container 5014 when the second battery pack charger 5000′ and its associated coupling plate 5016′ is affixed to the first storage container 5014 at the second location.

The first coupling plate 5016 and the second coupling plate 5016′ are configured to be interchangeable with each other such that (1) the first coupling plate 5016 is configured to be used with either the first battery pack charger 5000 or the second battery pack charger 5000′ to affix the first battery pack charger 5000 or second battery pack charger 5000′ to the first storage container 5014 either at the first location or at the second location, and (2) the second coupling plate 5016′ is configured to be used with either the first battery pack charger 5000 or the second battery pack charger 5000′ to affix the first battery pack charger 5000 or the second battery pack charger 5000′ to the first storage container 5014 either at the first location or at the second location.

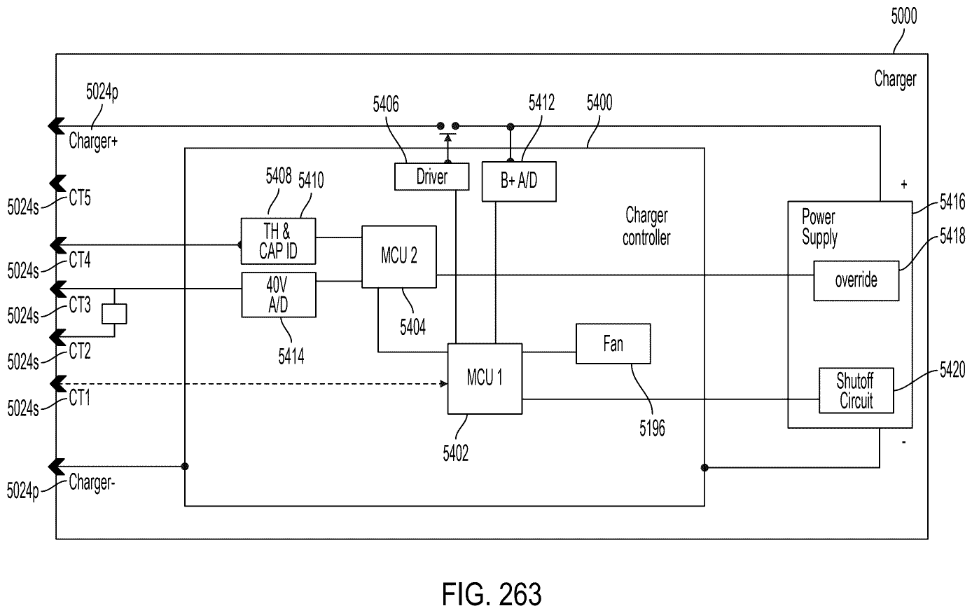

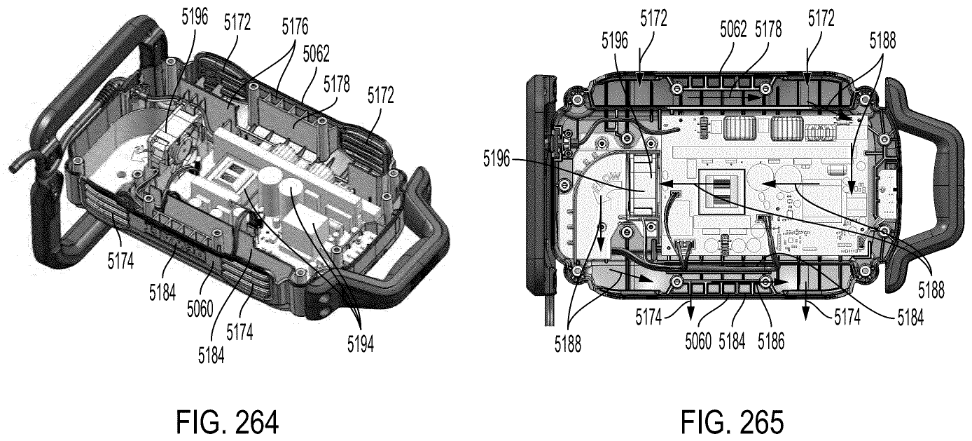

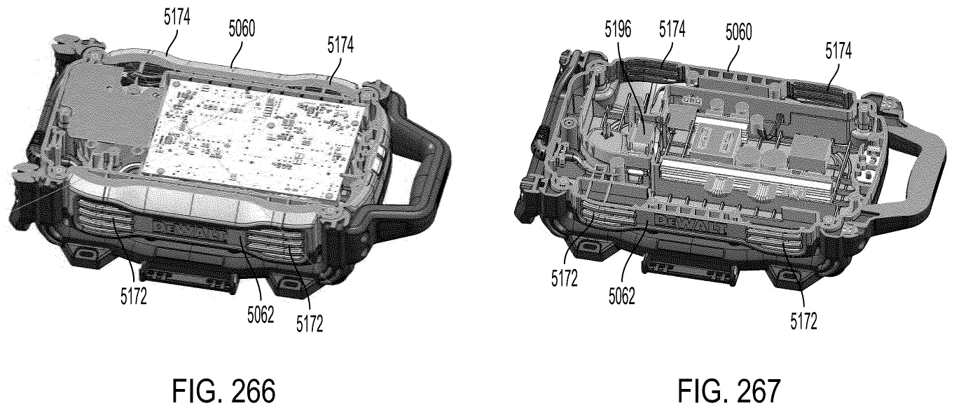

The charger 5000 may have a charger electronic control unit as shown in FIG. 263. The charger electronic control unit may be embodied in hardware or software as a digital microcontroller, a microprocessor or an analog circuit, a digital signal processor or by one or more digital ICs such as application specific integrated circuits (ASICs), for example. The charger electronic control unit may include various types of memory that may execute one or more software or firmware programs. Example memory may include RAM, FLASH and EEPROM. As an example, RAM may be used to store program variables during run time. As an example, FLASH memory may be used to store program code and calibration values. EEPROM may also be provided to store calibration values, data logging information, error codes, etc. The charger electronic control unit may be embodied as a microcontroller and referred to as a “controller” for purposes of brevity.

The charger electronic control unit in FIG. 263 may include a charger controller 5400. The charger controller may include two microcontrollers or microcontroller units 5402, 5404 (MCU1 and MCU2), a fan 5196, a driver 5406, a TH/thermal/temperature monitoring/sensing unit 5408, an ID/battery pack identification unit 5410, a B+ (charging) analog to digital (A/D) converter 5412, a 40V analog to digital (A/D) converter 5414, etc. The temperature monitoring/sensing device may include a negative temperature co-efficient (NTC) resistor, or thermistor, RT. The temperature sensing device/unit may be configured for monitoring of the battery pack temperature. A person of ordinary skill in the art would recognize that other components, such as capacitors, etc., or circuits can be used to provide a signal representative of the battery pack temperature. The charger electronic control unit in FIG. 263 may also include power supply module 5416 with an override circuit 5418 and a shutoff circuit 5420. The charger electronic control unit in FIG. 263 may also include charger+ terminal 5024_{P}, communications/signal terminals 5024_{S} (CT1, CT2, CT3, CT4, CT5) and charger-terminal 5024_{P}.

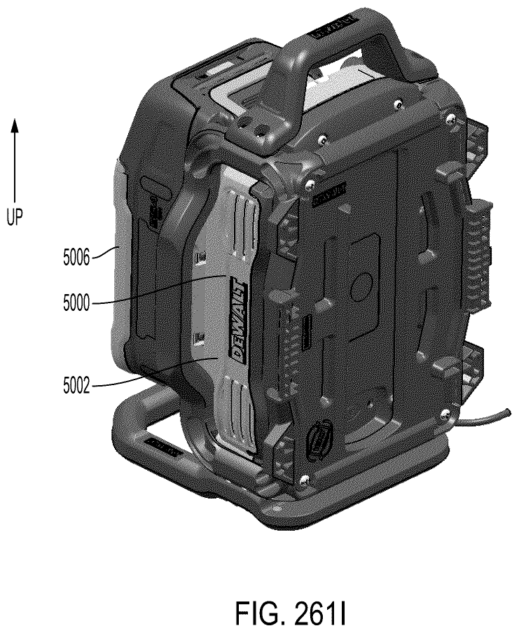

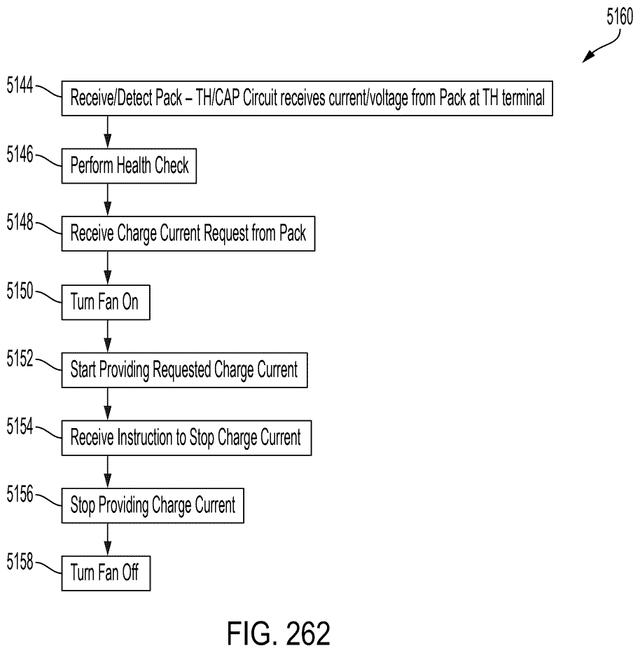

FIG. 262 shows a method 5160 of operation of the charger 5000. For example, at step 5144, a controller of the charger 5000 may be configured to detect whether the battery pack 5006 is received by the charger 5000 at the first interface 5010. The TH/CAP circuit, in FIG. 263, may be configured to receive current or voltage from the battery pack 5006 at TH terminal to make this determination. At step 5146, the controller of the charger 5000 may be configured to perform health check of the received battery pack 5006. At step 5148, the controller of the charger 5000 may be configured to receive a charge current request from the battery pack 5006. At step 5150, the controller of the charger 5000 may be configured to turn on the fan. At step 5152, the controller of the charger 5000 may be configured to start providing the requested current to the battery pack 5006. At step 5154, the controller of the charger 5000 may be configured to receive instructions to stop providing current. At step 5156, the controller of the charger 5000 may be configured to stop providing the current to the battery pack 5006. At step 5158, the controller of the charger 5000 may be configured to turn the fan off.

The charger 5000 may include a set of inlet vents 5172 on the first side 5062 of the housing 5002, a set of outlet vents 5174 on the second side 5060 of the housing 5002, a first baffle 5176 within the housing 5002 defining a first airflow pathway 5178, a second baffle 5184 within the housing 5002 defining a second airflow pathway 5186. The first baffle 5176 and the second baffle 5184 define a third airflow pathway 5188. The inlet airflow direction is shown with an arrow IAFD and the outlet airflow direction is sown with an arrow OAFD.

The set of inlet vents 5172 may include a pair of inlet vents 5172. The set of inlet vents 5174 is configured to permit air from an ambient environment to enter the housing 5002 as intake air. The inlet vents may also be referred to as intake vents.

The set of outlet vents 5174 may include a pair of outlet vents 5174. The outlet vents may also be referred to as exhaust vents. The airflow pathways may also be referred to as air/airflow passageways.

The charger 5000 may include a plurality of power supply charging components 5194 centrally positioned within the housing 5002 along the third airflow pathway 5188, and a fan 5196 within the housing 5002. The fan 5196 may be configured to draw air into the housing 5002 through the set of inlet vents 5172 along the first airflow pathway 5178, along the third airflow pathway 5188 past the plurality of power supply charging components 5194, through the fan 5196, along the second airflow pathway 5186 and forcing the air out of the housing 5002 through the set of outlet vents 5174. The fan 5196 may be configured to draw air from an exterior of the housing 5002 through the inlet vents 5172 into and through the airflow pathways 5178, 5186, 5188 and expel the air to the exterior of the housing 5002 through the outlet vents 5714. The fan 5196 may be configured for drawing air into the housing 5002 of the charger 5000 that is used to produce an air flow for cooling an electronics module having electronic controls for operation of the charger 5000.

The first airflow pathway 5178, the second airflow pathway 5186, and the third airflow pathway 5188 form an S-shaped airflow pathway. The fan 5196 is positioned upstream of the first airflow pathway 5178 and the third airflow pathway 5188. The second airflow pathway 5186 is disposed downstream of the fan 5196.

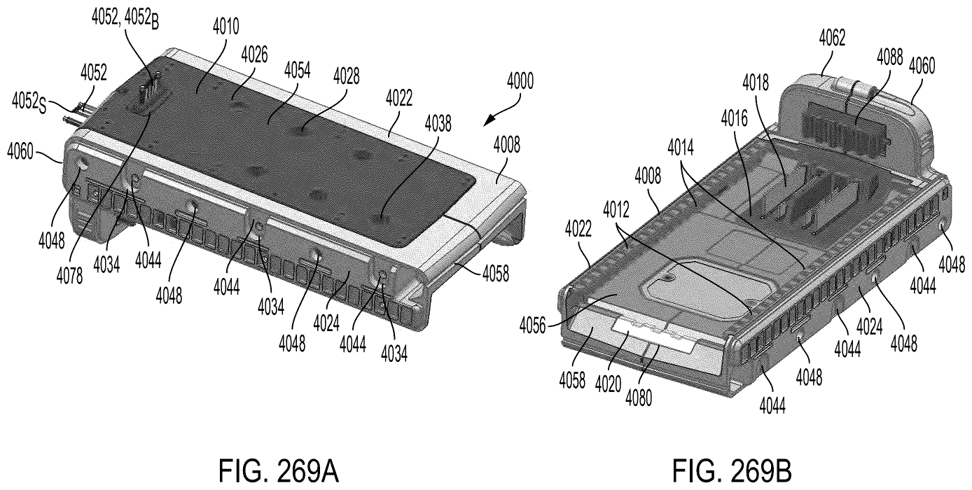

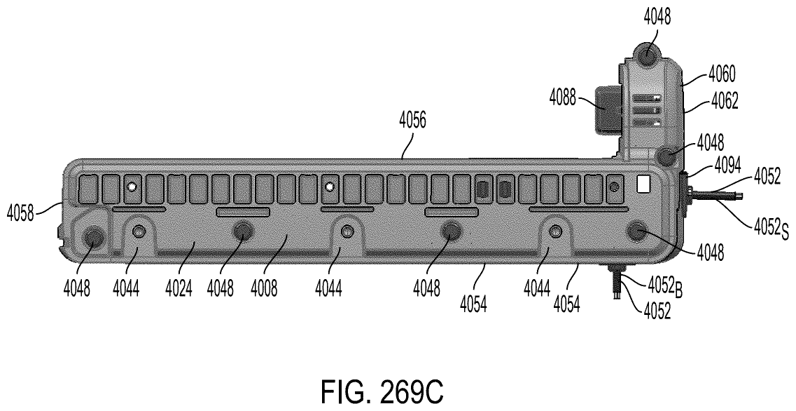

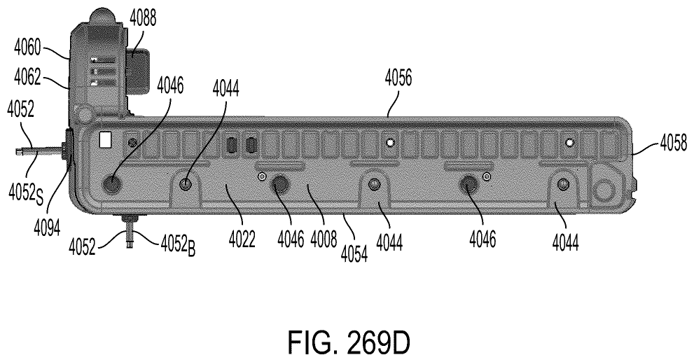

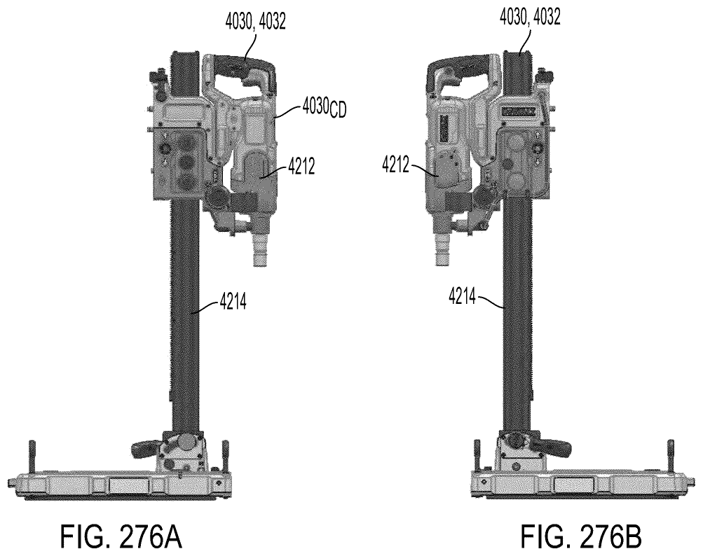

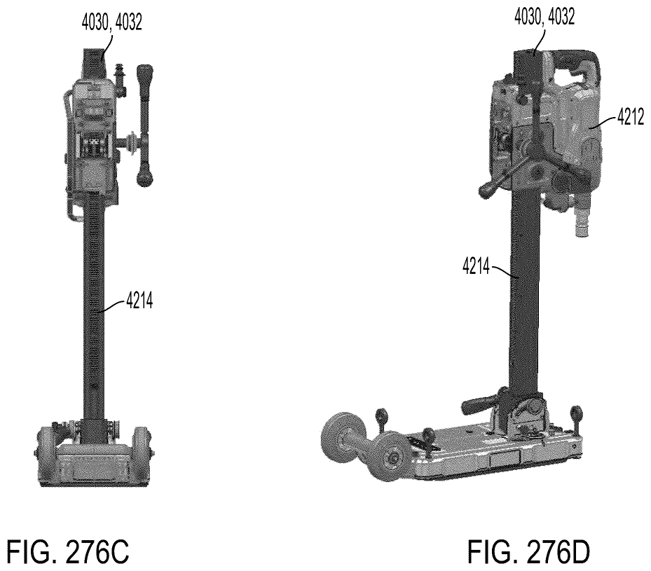

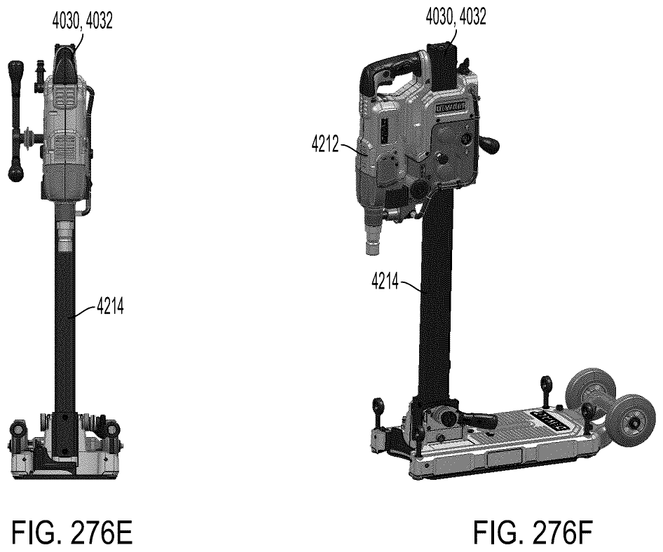

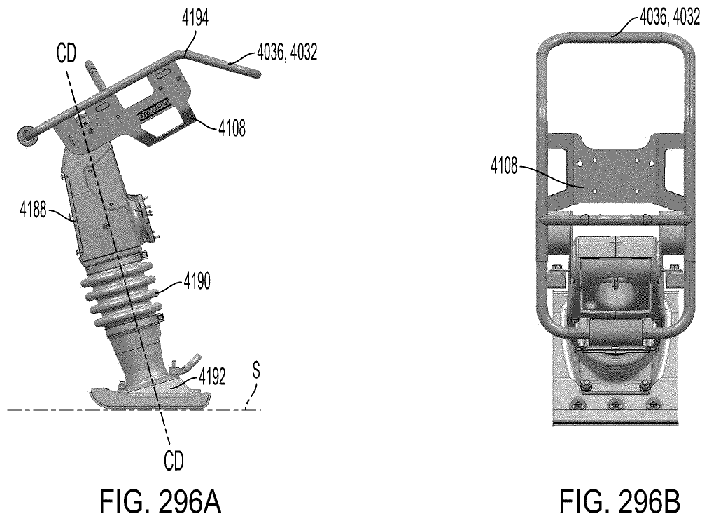

Referring to FIGS. 269A-IN36, the present patent application provides an interface system 4000 for enabling mating and operation between a set of cordless power tools 4032 and a battery pack 4006. The interface system 4000 comprises a housing 4008. The housing 4008 includes an interface 4010 for mating with the battery pack 4006. For example, the interface 4010 may be configured to enable the battery pack 4006 to be coupled to a cordless power tool 4030, 4036 in multiple orientations. The interface 4010 may include a set of rails 4012, a set of grooves 4014, a terminal block 4016 including a set of terminals 4018, and a catch 4020. The housing 4008 includes a first attachment feature 4028 configured to attach the housing 4008 to a first cordless power tool 4030 of the set of cordless power tools 4032 in a first orientation (as shown in FIGS. 276A-288) and a second attachment feature 4034 (as shown in FIG. 269A) configured to attach the housing 4008 to a second cordless power tool 4036 of the set of cordless power tools 4032 in a second orientation (as shown in FIGS. 296A-301B).

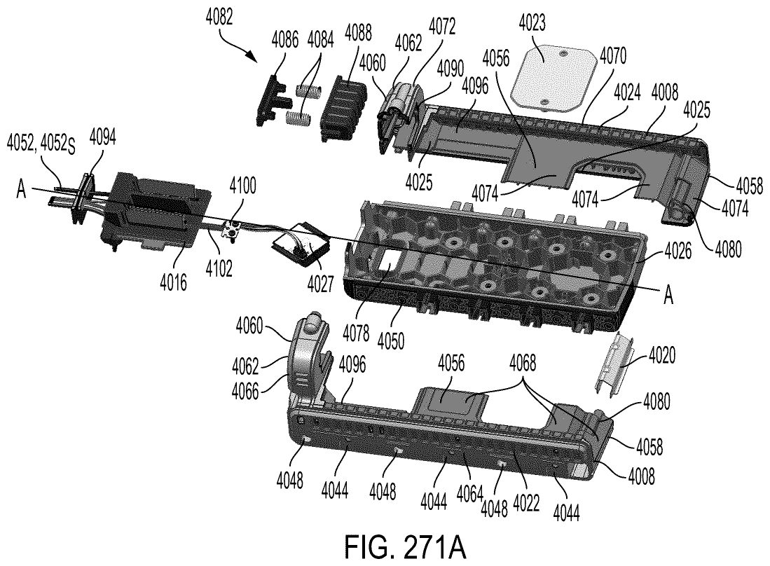

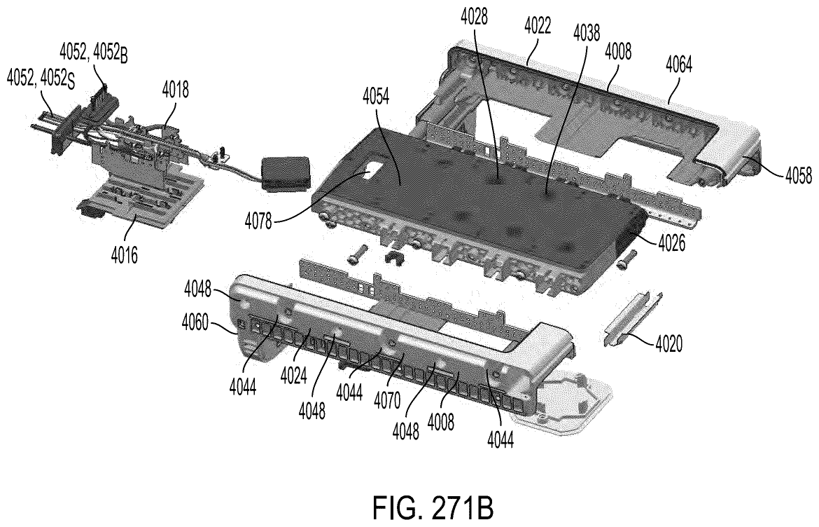

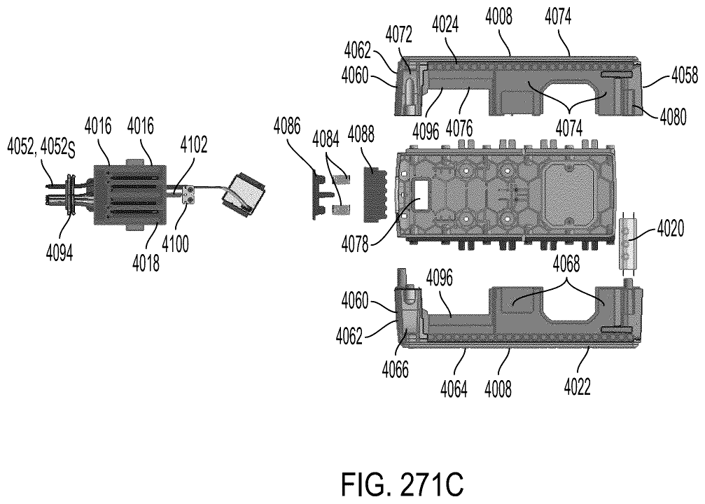

As shown in FIG. 271A, the housing 4008 may include a first housing portion 4022 and a second housing portion 4024 forming an internal cavity 4025. In one embodiment, the internal cavity may simply be an opening 4025. The housing 4008 may also include a core block 4026. The core block 4026 may be positioned in the internal cavity of the housing 4008. The core block 4026 may be positioned between the first housing portion 4022 and the second housing portion 4024. The first and second housing portions 4022, 4024 and the core block 4026 may be made of Acrylonitrile Butadiene Styrene (ABS) material. The first and second housing portions 4022, 4024 and the core block 4026 may be made of a high/hard impact plastic material.

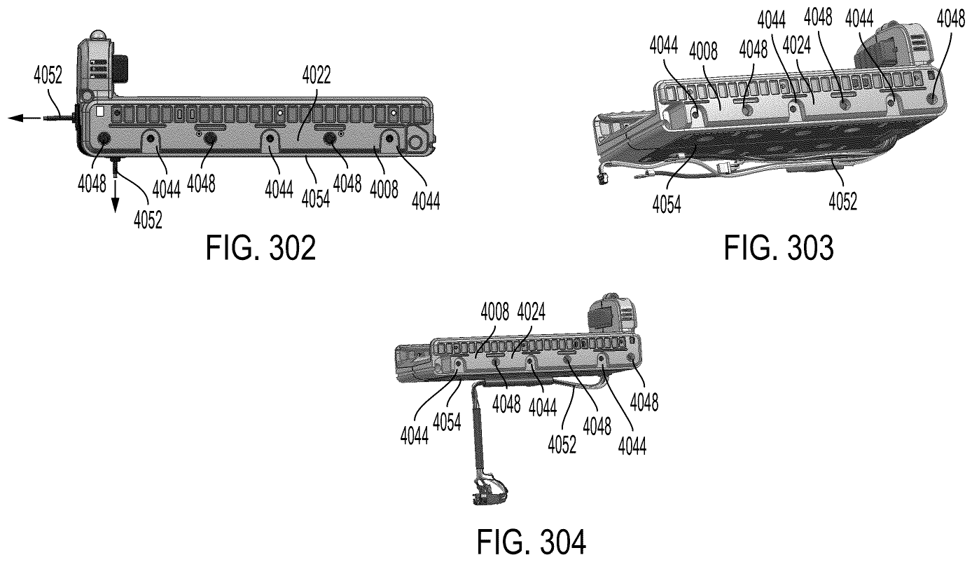

One of the first housing portion 4022 and the second housing portion 4024 may be a right side housing portion and the other of the first housing portion 4022 and the second housing portion 4024 may be a left side housing portion. In another embodiment, the first housing portion 4022 and the second housing portion 4024 may be upper and lower housing portions. In such an embodiment, the upper and lower housing portions may be configured such that the first attachment feature 4028 (e.g., a set of holes 4038 in the core block 4026) may still remain exposed to mate with a corresponding fixture 4040 on the first cordless power tool 4030 and such that a wire harness 4052, 4052B (if/when present) may extend outwardly and away from the interface 4010 so as to engage with a corresponding electrical interface of the first cordless power tool 4030. FIG. 302 shows a first example wiring scheme of the interface 4010. FIG. 303 shows a second example wiring scheme of the interface 4010. FIG. 304 shows a third example wiring scheme of the interface 4010.

One of the set of grooves 4014 and one of the set of rails 4012 may be formed on the first housing portion 4022. Another of the set of grooves 4014 and another of the set of rails 4012 may be formed on the second housing portion 4024. In another embodiment, one of the set of grooves 4014 and one of the set of rails 4012 may be formed on one side of the core block 4026 and another of the set of grooves 4014 and another of the set of rails 4012 may be formed on the other side of the core block 4026.

The first housing portion 4022 may include a first side housing portion 4064, a first rear housing portion 4066, and may also include a first top housing portion 4068. The second housing portion 4024 may include a second side housing portion 4070, a second rear housing portion 4072, and may also include a second top housing portion 4074.

The first and second rear housing portions 4066, 4072 may together form an internal cavity to receive an assembly 4082 and support 4094 for the wire harness 4052, 4052_{S}. The assembly 4082 may include a pair of springs 4084, a springs support 4086 and a portion 4088. The first and second rear housing portions 4066, 4072 may include openings 4090 to allow the portion 4088 to extend therethrough. These components (i.e., the spring system including the pair of springs 4084, the springs support 4086 and the portion 4088) may be configured to assist in ejection of the battery pack 4006 once the latch is released. The first and second rear housing portions 4066, 4072 may also include openings/recesses to allow the support 4094 for the wire harness 4052, 4052_{S} extend therethrough.

The first and second top housing portions 4068, 4074 may together provide a battery pack interface surface 4056. The battery pack interface surface 4056 may be configured to engage with/receive the battery pack 4006 thereon when the battery pack 4006 is engaged with the interface 4010. The battery pack interface surface 4056 may be part of the first and the second housings 4022 and 4024. The battery pack interface surface 4056 may be part of the core block 4026. The first and second top housing portions 4068, 4074 may include openings 4076 for the terminal block 4016 to extend therethrough. The first and second top housing portions 4068, 4074 may include openings/recesses 4080 for the catch 4020. The side, rear and top housing portions of each first and second housing portions may be integrally formed as a single piece housing portion assembly.

The terminal block 4016 including the set of terminals 4018 may be coupled to or disposed on or in the core block 4026. The terminal block 4016 may be configured to engage with a terminal block of the battery pack 4006 to electrically couple the battery pack 4006 to the interface 4010. The set of terminals 4018 of the interface 4010 may include two power terminals and a plurality of signal terminals. The plurality of signal terminals may include five signal terminals. The number of signal terminals may vary.

The catch 4020, coupled to the interface 4010 may be configured to engage with a latch disposed on the battery pack 4006. In another embodiment, the interface 4010 may include a latch that may be configured to engage with a catch disposed on the battery pack 4006. The latch may be configured to move into and out of a cavity of the battery pack upon depression of a user actuated latch button. The latch may be configured to be received in the catch when the battery pack 4006 is fully engaged with/coupled to the interface 4010. In order to disengage/decouple the battery pack 4006 from the interface 4010, the user actuated latch button is depressed to release the latch from the catch. The battery pack 4006 can then be removed from the interface 4010.

The interface 4010 may include the wire harness 4052 that is configured to be electrically coupled to either the first cordless power tool 4030 or the second cordless power tool 4036. There are two wire harnesses 4052_{B} and 4052_{S} shown in the illustrated embodiments. In one embodiment the interface 4010 may only include wire harnesses 4052_{B}. In another embodiment, the interface 4010 may only include wire harnesses 4052_{S}. In yet another embodiment, the interface 4010 may include two wire harnesses 4052_{B} and 4052_{S}.

The core block 4026 may include a tool interface surface 4054. The tool interface surface 4054 may be disposed opposing the battery pack interface surface 4056. The wire harness 4052, 4052_{B} may be configured to extend from the tool interface surface 4054. The tool interface surface 4054 may include an opening 4078 that is configured to allow the wire harness 4052, 4052_{B} to extend therethrough.

The interface 4010 may also include a front portion 4058 and a rear portion 4060. The catch 4020 may be disposed in the front portion 4058 of the interface 4010. The wire harness 4052 may be configured to extend from a rear surface 4062 of the rear portion 4060 of the interface 4010.

The interface 4010 may include receiving portions 4096 to receive the terminal block 4016 therein. The interface 4010 may also receive a terminal block positioning assembly 4098. The terminal block positioning assembly 4098 may include a bracket/support member 4100 that is fixedly attached to the core block 4026 and a spring 4102 that connects the terminal block 4016 to the bracket/support member 4100 so as to position the terminal block 4016 with respect to the core block 4026.

Referring to FIG. 271A, a communication module 4027 may be provided. The communication module 4027 may be a Bluetooth Low Energy Module (BLEM). The BLEM 4027 may be configured to function as a communications module between the interface and a hub/a tool/a battery pack. A cover 4023 may be configured to cover the BLEM 4027.

The battery pack 4006 may include a slide-type battery pack. For example, the battery pack 4006 may include a set of rails (one rail on each side of the battery pack 4006), a set of grooves (one on each side of the battery pack 4006) and a latch mechanism to secure the battery pack 4006 with the interface 4010.

The grooves 4014 of the interface 4010 may be configured to receive corresponding rails of the battery pack 4006 and the rails 4012 of the interface 4010 may be configured to be received in corresponding grooves of the battery pack 4006 when the battery pack 4006 slidingly engages/couples with the interface 4010. That is, the set of rails and the set of grooves of the battery pack 4006 may be configured to engage with a set of grooves 4014 and the set of rails 4012 of the interface 4010 to mechanically couple the battery pack 4006 and the interface 4010 together.

The battery pack may have a capacity of 10 Ah, an impedance of equal to or less than approximately 3 milliohms, and a nominal voltage of 54V.

The core block 4026 may include the first attachment feature 4028. The first attachment feature 4028 may include the set of holes 4038 in the core block 4026 configured to mate with a corresponding fixture 4040 on the first cordless power tool 4030.

The first and second housing portions 4022, 4024 may be attached to the core block 4026 such that the set of holes 4038 in the core block 4026 may remain exposed to mate with the corresponding fixture 4040 on the first cordless power tool 4030. The fixture 4040 on the first cordless power tool 4030 may include protrusions 4042 that are configured to align with and to be received in the set of holes 4038 in the core block 4026. The pattern of the protrusions 4042 on the fixture 4040 on the first cordless power tool 4030 may correspond to the pattern of the set of holes 4038 in the core block 4026. Mechanical fasteners (e.g., screws 4104, etc.) may be inserted though the set of holes 4038 in the core block 4026 and the protrusions 4042 on the fixture 4040 on the first cordless power tool 4030 after they are aligned, for connecting the core block 4026 to the fixture 4040 on the first cordless power tool 4030 and therein affixes the core block 4026 to the first cordless power tool 4030.

The set of holes 4038 in the core block 4026 are shown to have a circular shaped configuration and the protrusions are shown to have a corresponding shaped configuration. A person of ordinary skill in the art would readily appreciate that the set of holes 4038 in the core block 4026 and the protrusions 4042 in the fixture 4040 on the first cordless power tool 4030 may have corresponding shaped configurations. In another embodiment, the fixture 4040 on the first cordless power tool 4030 may include other (having different shapes, configurations, etc.) engagement portions that are configured to align and engage with corresponding engagement portions in the core block 4026. In the illustrated embodiment, the number of holes in the set of holes 4038 in the core block 4026 may be eight, and the number of protrusions 4042 on the fixture 4040 on the first cordless power tool 4030 may be six (two holes in the core block 4026 may be left unused during use). The number of holes in the set of holes 4038 in the core block 4026 and the number of protrusions 4042 on the fixture 4040 on the first cordless power tool 4030 may vary and may depend on the power tool.

The second attachment feature 4034 may include a set of holes 4044 in the housing 4008 configured to mate with a corresponding fixture 4046 on the second cordless power tool 4036. The corresponding fixture 4046 on the second cordless power tool 4036 may be a frame 4108. The frame 4108 may include openings. The pattern of the openings on the fixture 4046 on the second cordless power tool 4036 may correspond to the pattern of the set of holes 4044 in the housing 4008. Mechanical fasteners (e.g., screws, etc.) may be inserted though the holes 4044 in the housing 4008 and the openings on the fixture 4046 on the second cordless power tool 4036 after they are aligned, for connecting the interface 4010 to the fixture 4046 on the second cordless power tool 4036 and therein affixes the core block 4026 to the second cordless power tool 4036.

The set of holes 4044 in the housing 4008 is a first set of holes 4044. The first set of holes 4044 may be formed in the first and second housing portions 4022, 4024.

The holes 4044 in the housing 4008 are shown to have a circular shaped configuration and openings on the fixture 4046 on the second cordless power tool 4036 are shown to have a corresponding shaped configuration. A person of ordinary skill in the art would readily appreciate that the holes 4044 in the housing 4008 may have any other corresponding shaped configurations. In another embodiment, the fixture 4046 on the second cordless power tool 4036 may include other (having different shapes, configurations, etc.) engagement portions that are configured to align and engage with corresponding engagement portions in each of the first and second housing portions 4022, 4024. In the illustrated embodiment, the number of holes in each of the first and second housing portions 4022, 4024 may be three. The number of holes in each of the first and second housing portions 4022, 4024 and the number of openings on the fixture 4046 on the second cordless power tool 4036 may vary and may depend on the power tool.

The housing 4008 may also include a second set of holes 4048 that are configured to engage with a corresponding set of holes 4050 in the core block 4026 so as to connect the core block 4026 to the housing 4008.

The first cordless power tool 4030 of the set of cordless power tools 4032 may include a concrete or a core drill system 4030CD. The first cordless power tool 4030 may be a core drill. The drill may be configured to be attached to a stand and the interface/battery pack may be configured to be attached to the stand. That is, the drill may be configured to electrically and mechanically attach to the stand on one side and the battery pack (or a different battery pack along with an adaptor) may be configured to attach to the stand on an opposing side. Referring to FIG. 276A, the cordless drill system 4030CD comprises a drill 4212 and a drill stand 4214. The drill 4212 may include an electric motor, a transmission driven by the motor, and an output spindle rotatable by the transmission. The cordless drill system 4030CD may also include a tool bit holder coupled to the output spindle and configured to retain a drill bit therein. A battery pack 4006 may be configured to be coupleable to the battery pack interface 4010 for providing power to the motor. The drill may be configured to be removably coupleable to the stand 4214. The stand 4214 may be configured to move the drill in a manner similar to a drill press.

In the first orientation, the interface 4010 may be positioned in a generally vertical orientation. That is, the interface 4010 may be positioned to be generally parallel to a vertical axis. In the first orientation, a battery pack insertion direction (i.e., the direction in which the battery pack 4006 is inserted into the interface 4010) may be parallel to the generally vertical orientation of the interface 4010.

The procedures in which the interface 4010 may be attached to the first cordless power tool 4030 are shown and explained with respect to FIGS. 276A-288. In these procedures, the core block 4026 is first attached/connected to the fixture 4044 of the stand 4212. The remainder of the interface 4010 is then assembled by (a) positioning and attaching the terminal block 4016 and other electronic components to the core block 4026 that is already attached/connected to the fixture 4044 of the first cordless power tool 4030, and (b) coupling the first and second housing portions 4022, 4024 to the core block 4026 one after the other while the core block 4026 is still connected to the fixture 4044 of the first cordless power tool 4030.

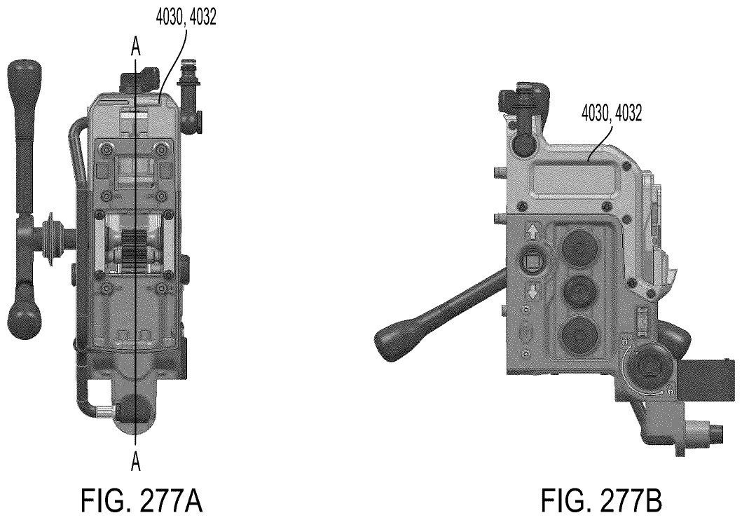

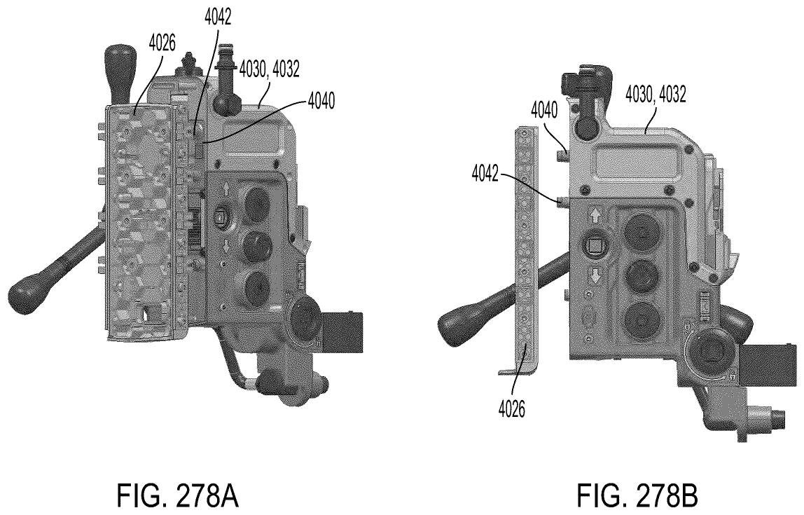

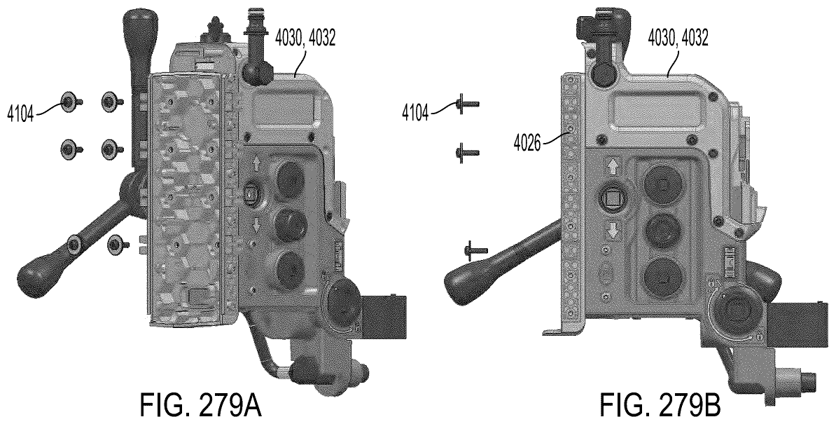

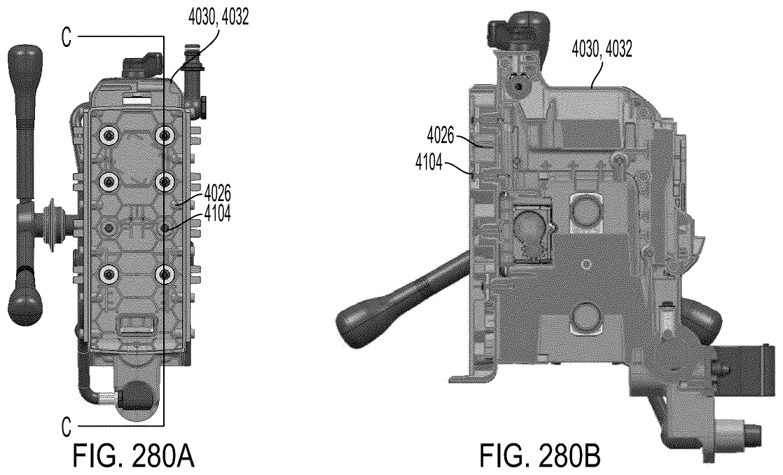

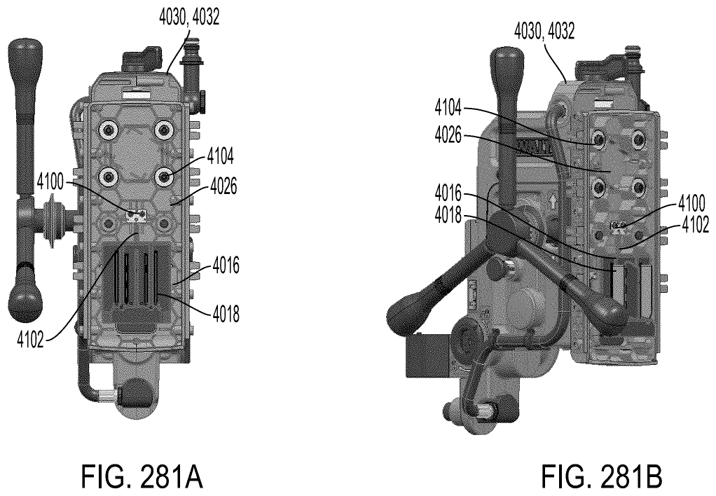

FIGS. 276A-276F and 277A and 277B show various views (some detailed views) of the first cordless power tool 4030. FIGS. 278A and 278B show the core block 4026 of the interface 4010 separated from and before being coupled to the first cordless power tool 4030. FIGS. 279A and 279B show various views of the core block 4026 mated to the first cordless power tool 4030. The protrusions 4042 on the fixture 4040 on the first cordless power tool 4030 may be configured to align with and to be received in the set of holes 4038 in the core block 4026. FIGS. 280A and 280B show various views of the core block 4026 fastened (e.g., via fasteners 4104) to the first cordless power tool 4030. That is, the fasteners 4104 may be inserted through the set of holes 4038 in the core block 4026 and the protrusions 4042 on the fixture 4040 on the first cordless power tool 4030 after they are aligned, for connecting the core block 4026 to the fixture 4040 on the first cordless power tool 4030. FIGS. 281A and 281B show various views of the terminal block 4016 (and the terminals 4018) coupled to the core block 4026. The terminal block positioning assembly 4098 (including the bracket/support member 4100 that is fixedly attached to the core block 4026, and the spring 4102 that connects the terminal block 4016 to the bracket/support member 4100) may be used to position the terminal block 4016 with respect to the core block 4026.

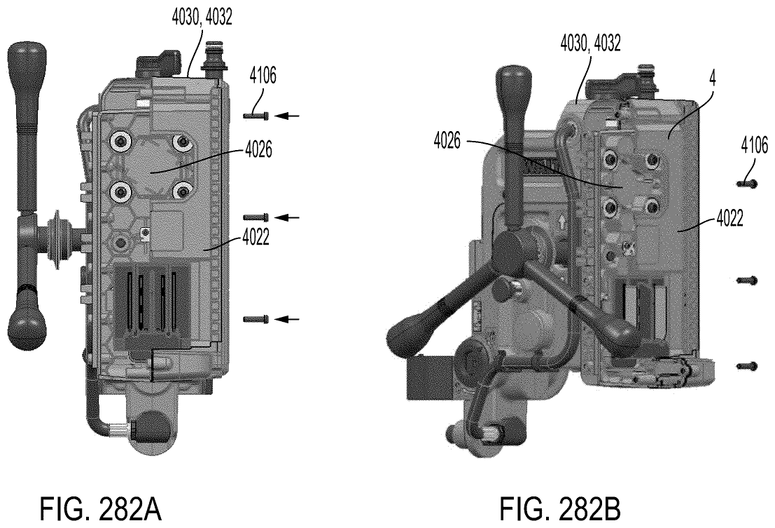

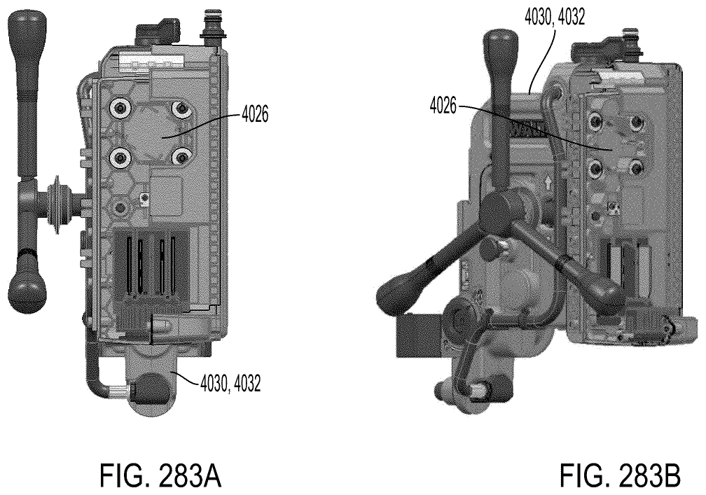

FIGS. 282A and 282B show various views of one of the first and second housing portions 4022, 4024 mated to the core block 4026. FIGS. 283A and 283B show various views of one of the first and second housing portions 4022, 4024 fastened to the core block 4026. The second set of holes 4048 of one of the first and second housing portions 4022, 4024 may be configured to align with the corresponding set of holes 4050 in the core block 4026 so as to connect the core block 4026 to one of the first and second housing portions 4022, 4024. Fasteners 4106 may be inserted through the second set of holes 4048 of one of the first and second housing portions 4022, 4024 and the corresponding set of holes 4050 in the core block 4026 after they are aligned, for connecting the core block 4026 to one of the first and second housing portions 4022, 4024.

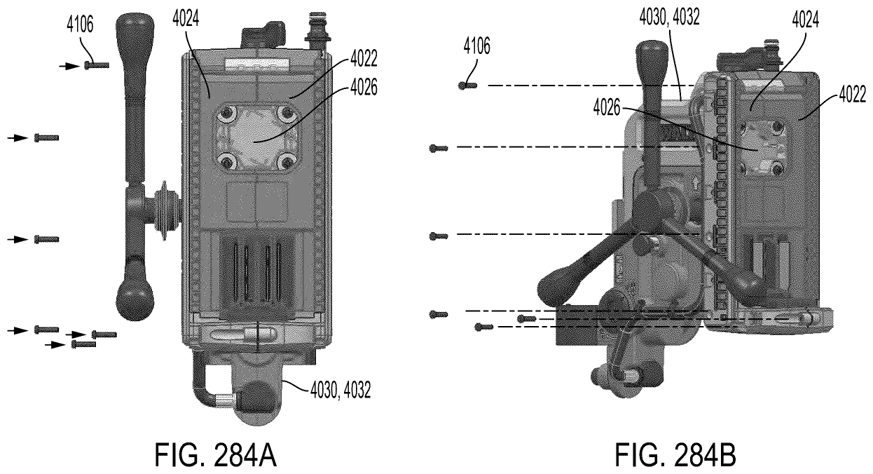

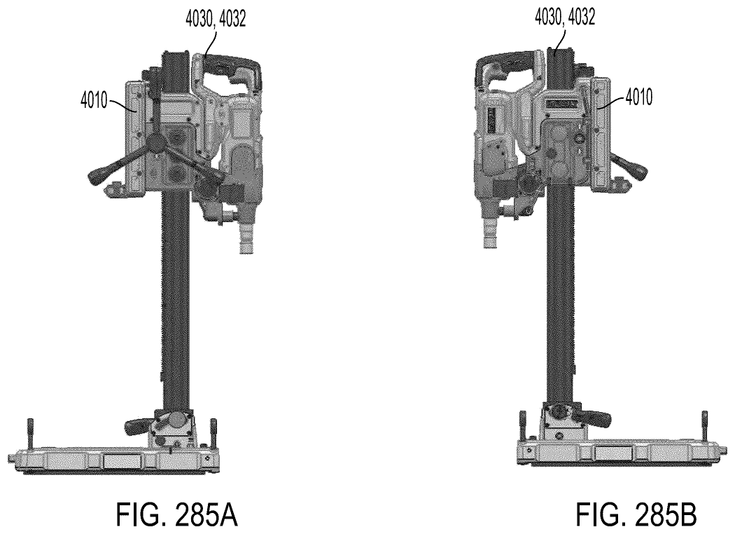

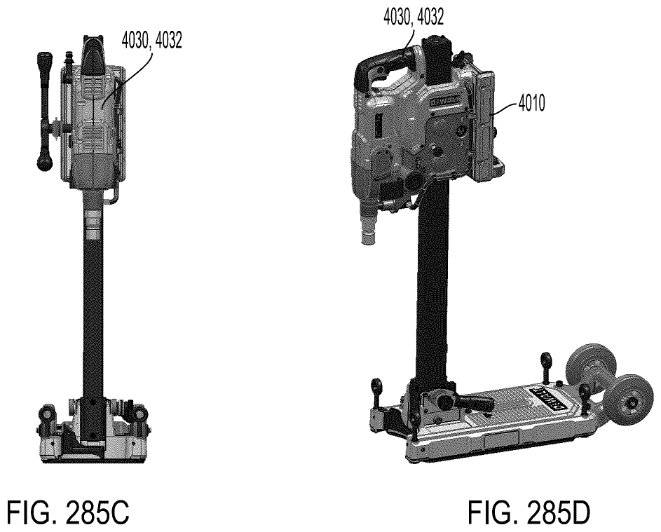

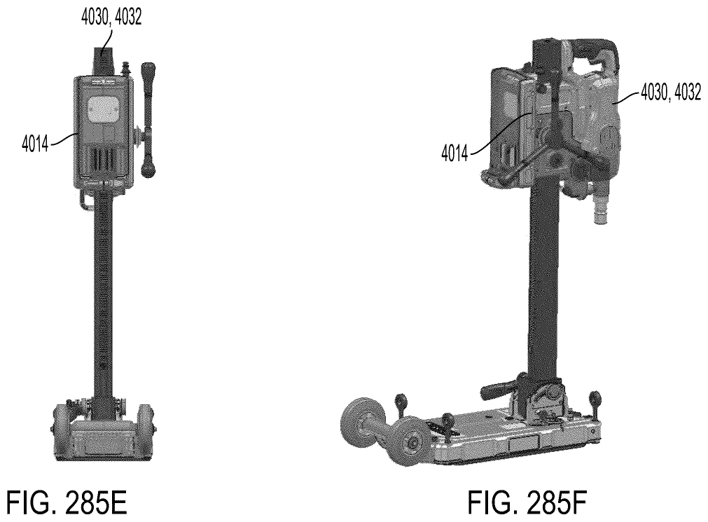

FIGS. 284A and 284B show various views of the other of the first and second housing portions 4022, 4024 mated to the core block 4026. The second set of holes 4048 of the other of the first and second housing portions 4022, 4024 may be configured to align with the corresponding set of holes 4050 in the core block 4026 so as to connect the core block 4026 to the other of the first and second housing portions 4022, 4024. Fasteners 4106 may be inserted through the second set of holes 4048 of the other of the first and second housing portions 4022, 4024 and the corresponding set of holes 4050 in the core block 4026 after they are aligned, for connecting the core block 4026 to the other of the first and second housing portions 4022, 4024. FIGS. 285A-285F show various views of the interface 4010 fastened to the first cordless power tool 4032.

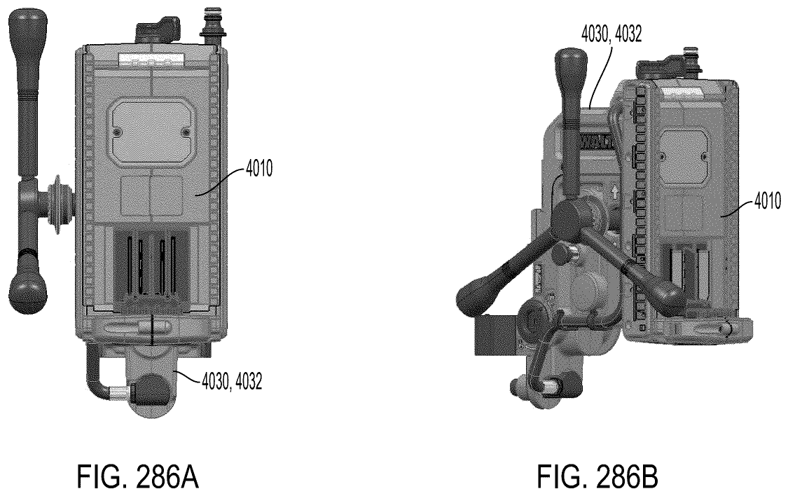

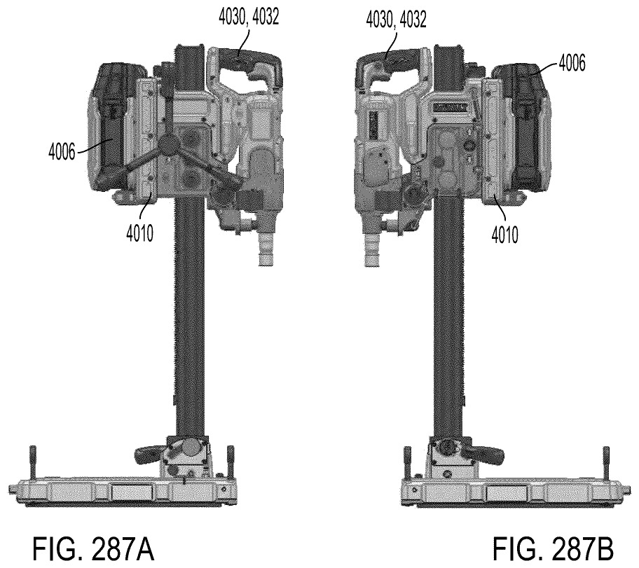

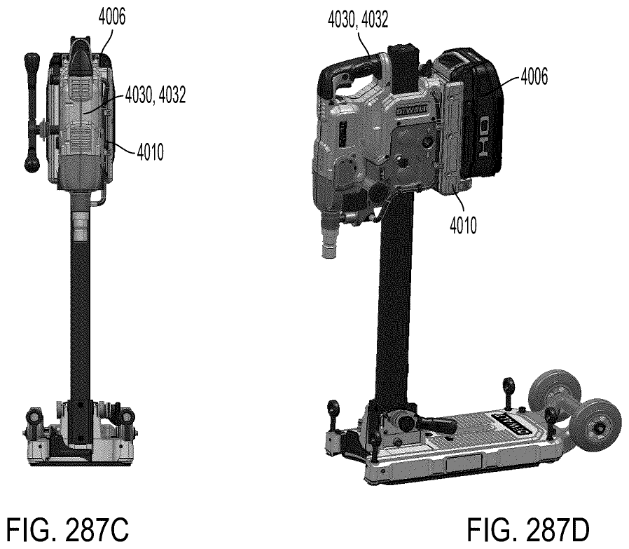

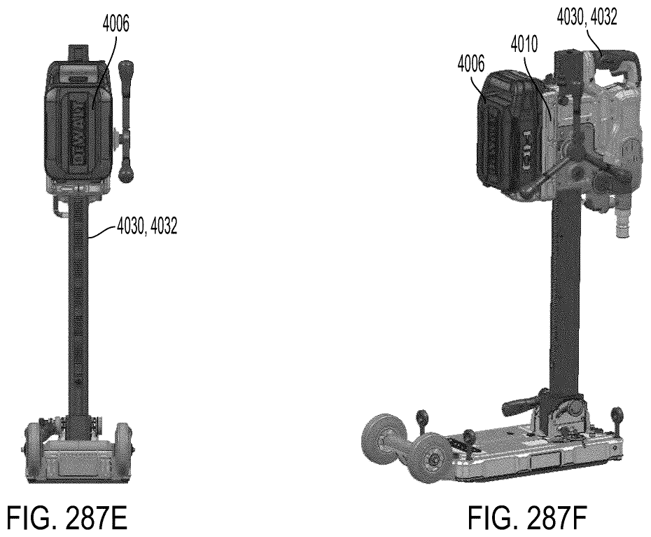

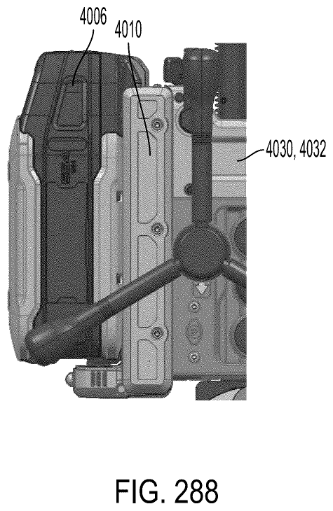

FIGS. 286A and 286B show various detailed views of the interface 4010 fastened to the first cordless power tool 4030. FIGS. 287A-287F show various views of the battery pack 4006 coupled to the interface 4010 and the first cordless power tool 4030. FIG. 288 shows a detailed view of the battery pack 4006, the interface 4010 and the first cordless power tool 4030.

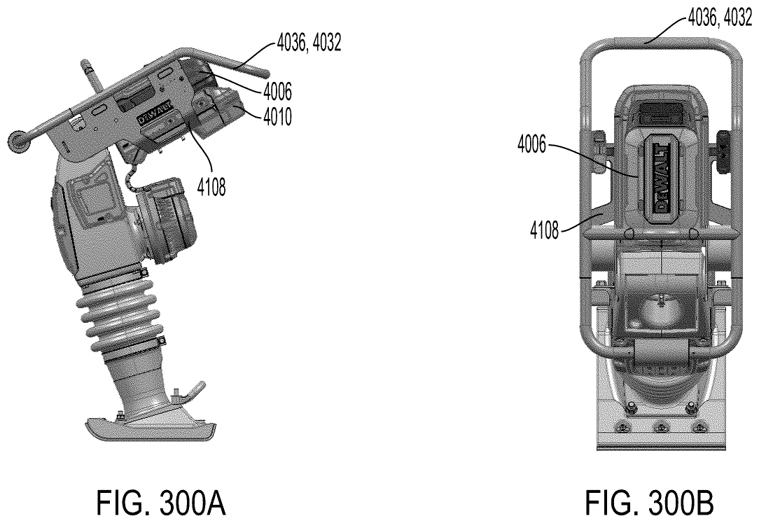

The second cordless power tool 4036 of the set of cordless power tools 4032 may include a rammer 4036R. Referring to FIG. 296A, the rammer (or electric rammer) 4036R may include a primary housing 4188 and a reciprocating leg portion 4190 which may be coupled to a compacting foot 4192. The compacting foot 4192 may be adapted for compacting soil, hardcore, asphalt or any other material S to be compacted. The reciprocating leg portion 4190 may include a reciprocating mechanism (not shown) which is arranged to drive the compacting foot 4192 up and down along the longitudinal axis CD-CD of the power tool 4036R. The rammer 4036R may include a handle 4194 by which a user can maneuver the rammer 4036R, and the battery pack 4006 (as shown in FIGS. 300A-300B) for powering the electric motor (not shown but located within the primary housing 4188) of the rammer 4036R.

In the second orientation, the interface 4010 may be positioned in a generally horizontal orientation. In the second orientation, the interface 4010 may be positioned in a generally angled orientation with respect to the vertical axis and a horizontal axis. The horizontal axis may generally be parallel to the ground or surface on which the power tool is disposed. The vertical axis may generally be perpendicular to the horizontal axis.

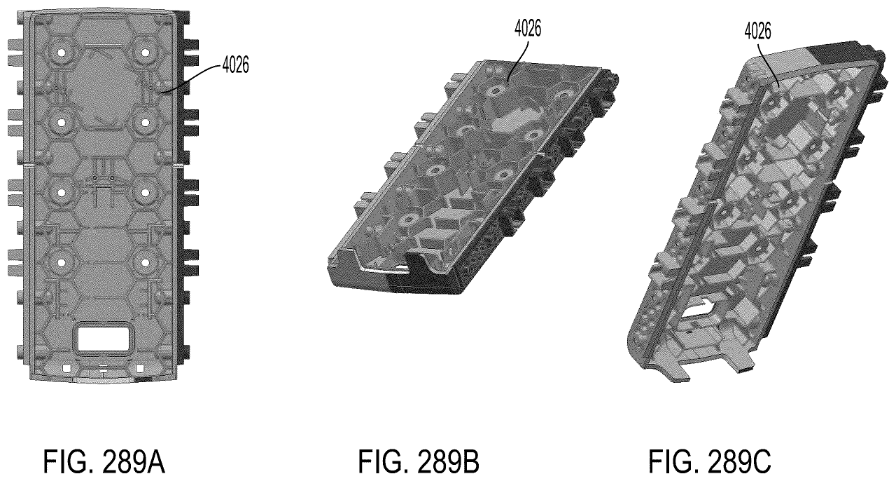

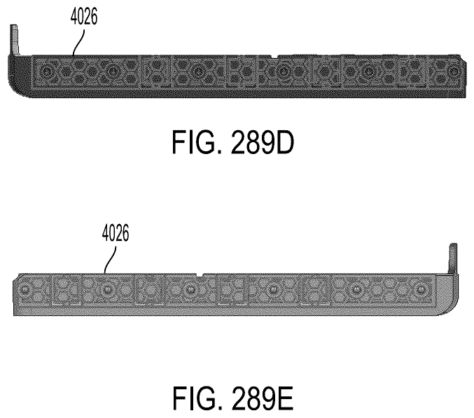

The procedures in which the interface 4010 may be attached to the second cordless power tool 4036 are shown and explained with respect to FIGS. 289A-300B. In these procedures, the interface 4010 is first assembled by (a) disposing the core block 4026, (b) positioning and placing the terminal block 4016 and other electronic components on the core block 4026, (c) coupling the first and second housing portions 4022, 4024 to the core block 4026 one after the other, and (d) connecting the assembled interface 4010 to the second cordless power tool 4036. This second method of attachment is different from the first method of attachment shown and explained with respect to FIGS. 276A-288 in which the core block 4026 is first attached to the fixture of the power tool. The interface 4010 is then assembled on the core block 4026 while the core block 4026 that is attached to the fixture of the power tool.

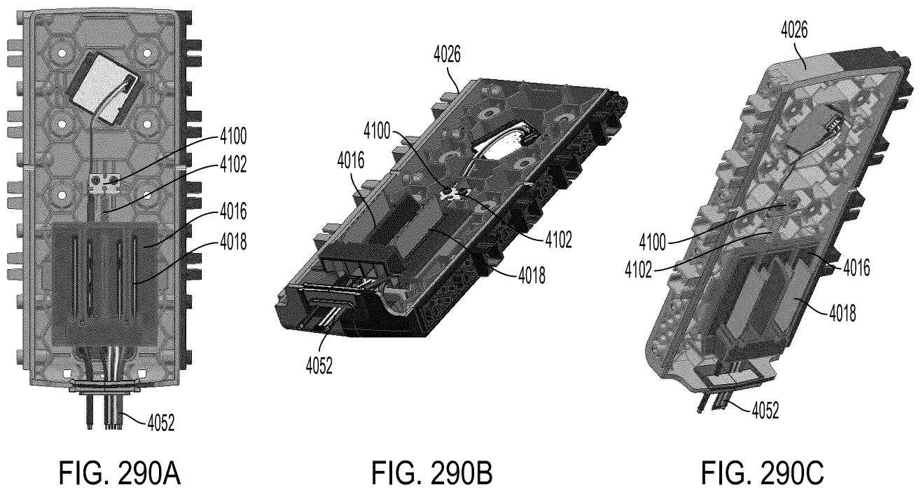

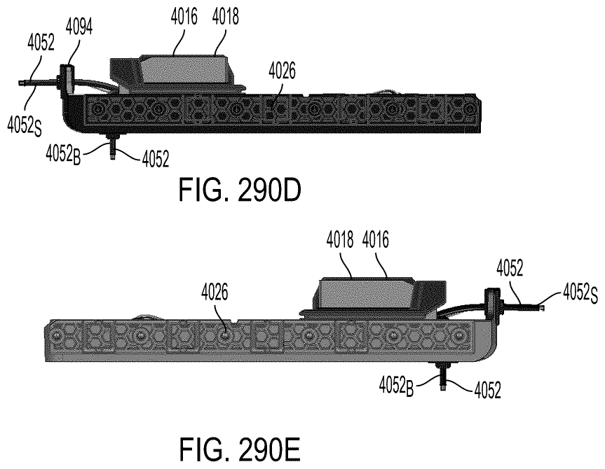

FIGS. 289A-289E show various views of the core block 4026 of the interface 4010. FIGS. 290A-290E show various views of the terminal block 4016 (along with the terminals 4018) placed on the core block 4026. The terminal block positioning assembly 4098 (including the bracket/support member 4100 that is fixedly attached to the core block 4026, and the spring 4102 that connects the terminal block 4016 to the bracket/support member 4100) may be used to position the terminal block 4016 with respect to the core block 4026.

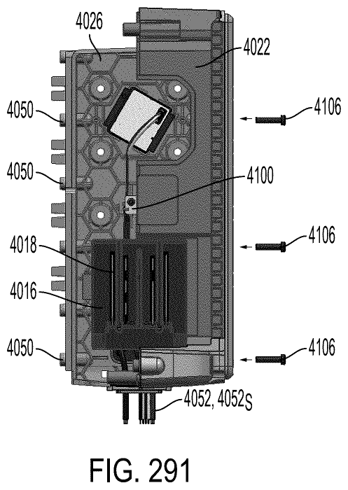

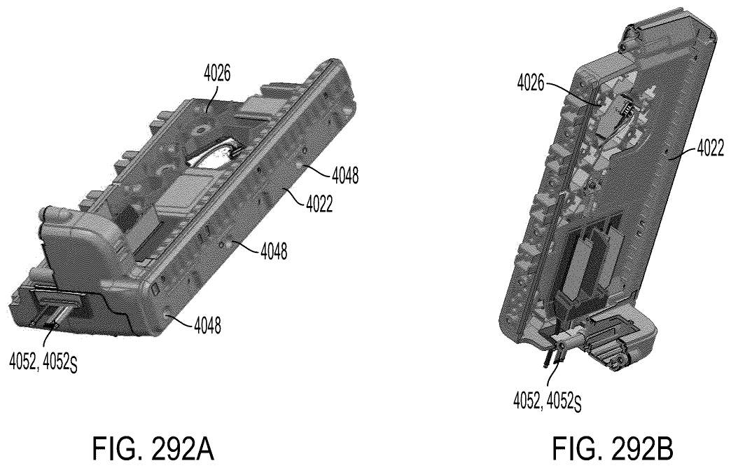

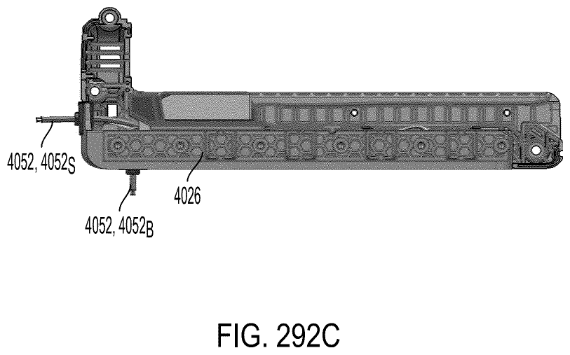

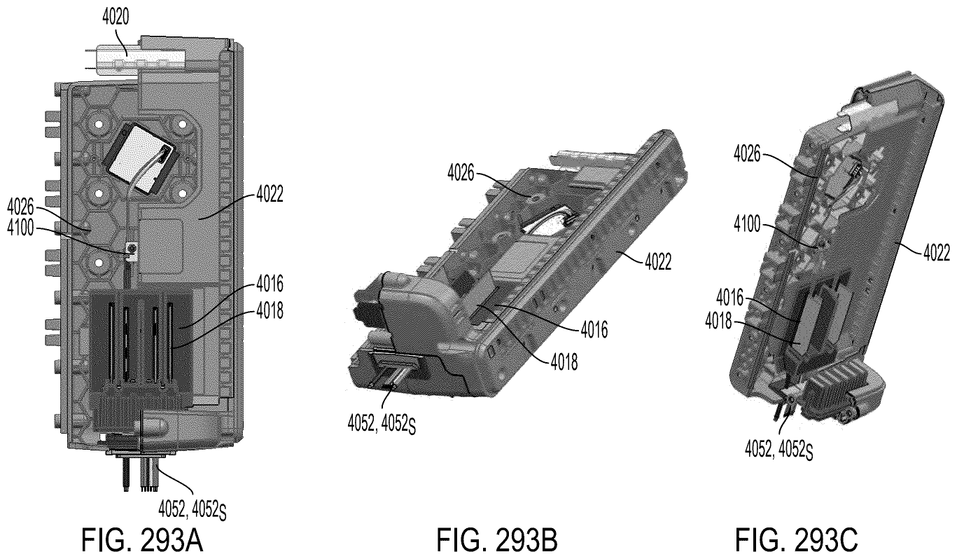

FIG. 291 shows one of the first and second housing members 4022, 4024 coupled to the core block 4026. FIGS. 292A-292C show various views of one of the first and second housing members 4022, 4024 fastened to the core block 4026. The second set of holes 4048 (as shown in FIG. 292A) of one of the first and second housing portions 4022, 4024 may be configured to align with the corresponding set of holes 4050 (as shown in FIG. 291) in the core block 4026 so as to connect the core block 4026 to one of the first and second housing portions 4022, 4024. Fasteners 4106 may be inserted through the second set of holes 4048 of one of the first and second housing portions 4022, 4024 and the corresponding set of holes 4050 in the core block 4026 after they are aligned, for connecting the core block 4026 to one of the first and second housing portions 4022, 4024. FIGS. 293A-293C show various views of the catch 4020 coupled to one of the first and second housing members 4022, 4024.

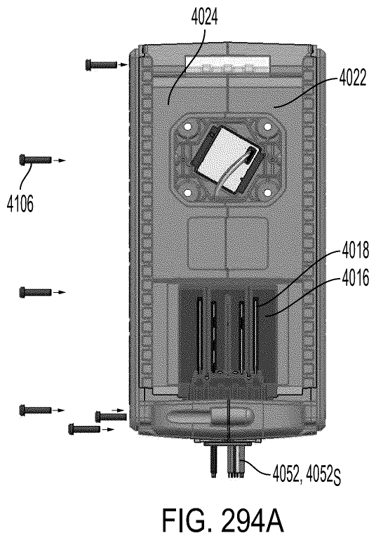

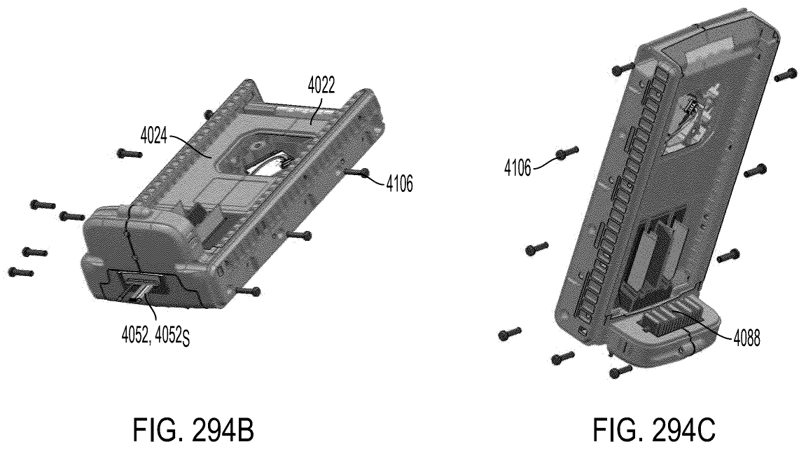

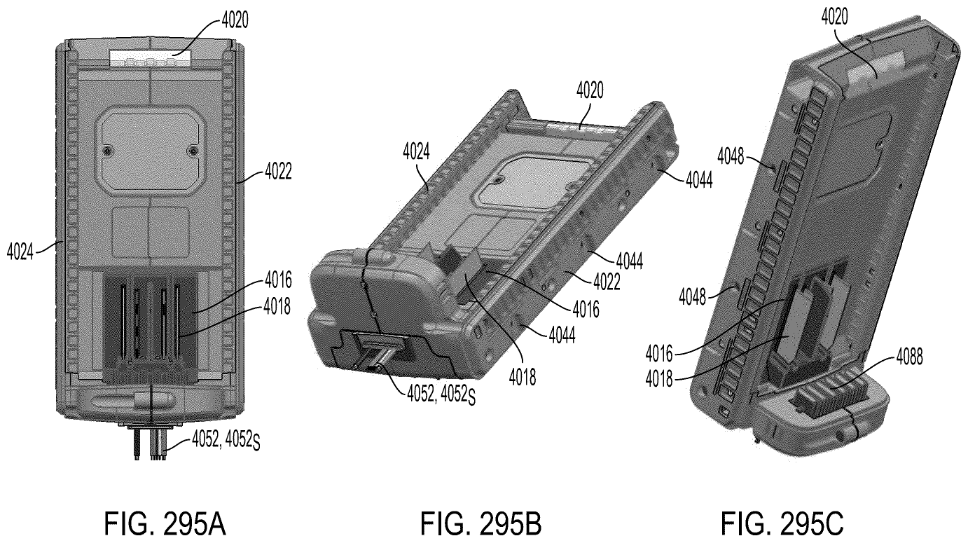

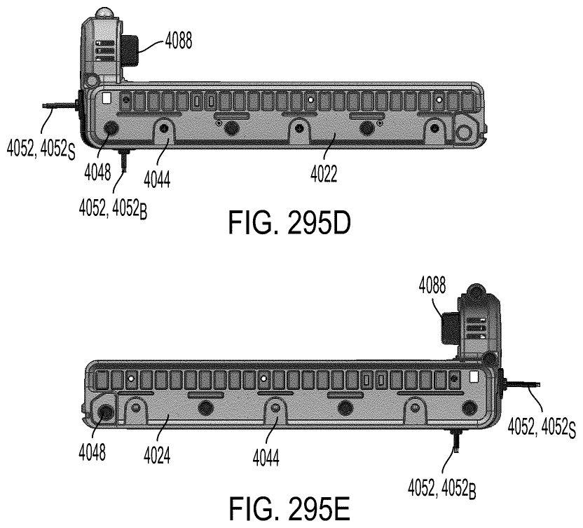

FIGS. 294A-294C show various views of the other of the first and second housing portions 4022, 4024 coupled to the core block 4026. The second set of holes 4048 of the other of the first and second housing portions 4022, 4024 may be configured to align with the corresponding set of holes 4050 in the core block 4026 so as to connect the core block 4026 to the other of the first and second housing portions 4022, 4024. Fasteners 4106 may be inserted through the second set of holes 4048 of the other of the first and second housing portions 4022, 4024 and the corresponding set of holes 4050 in the core block 4026 after they are aligned, for connecting the core block 4026 to the other of the first and second housing portions 4022, 4024. FIGS. 295A-295E show the other of the first and second housing portions 4022, 4024 fastened to the core block 4026.

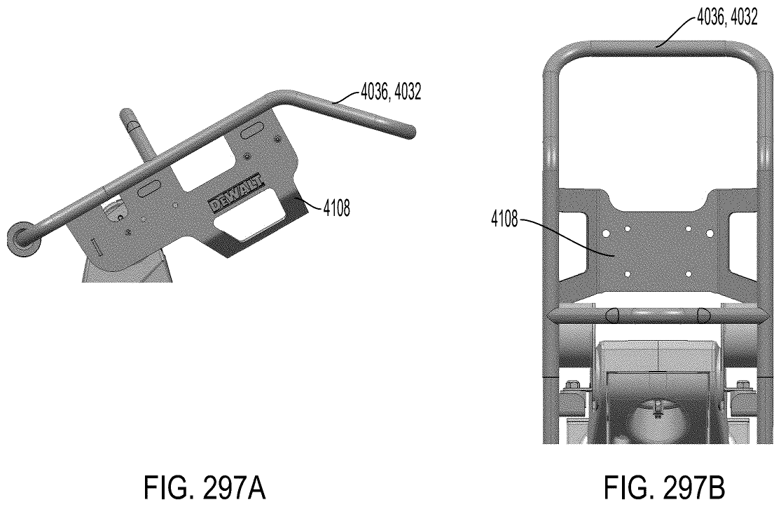

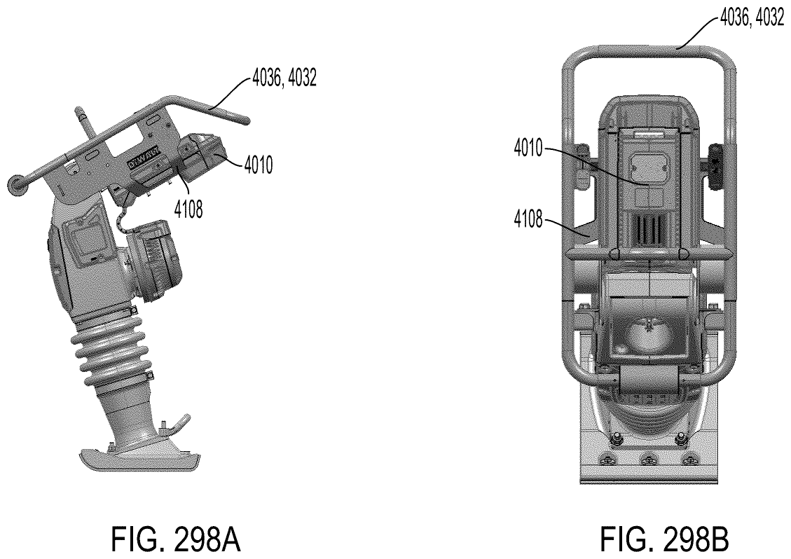

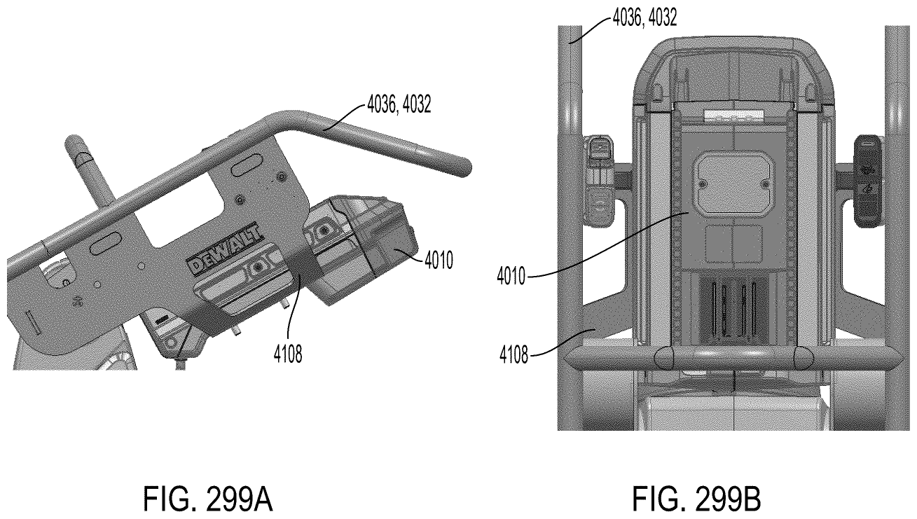

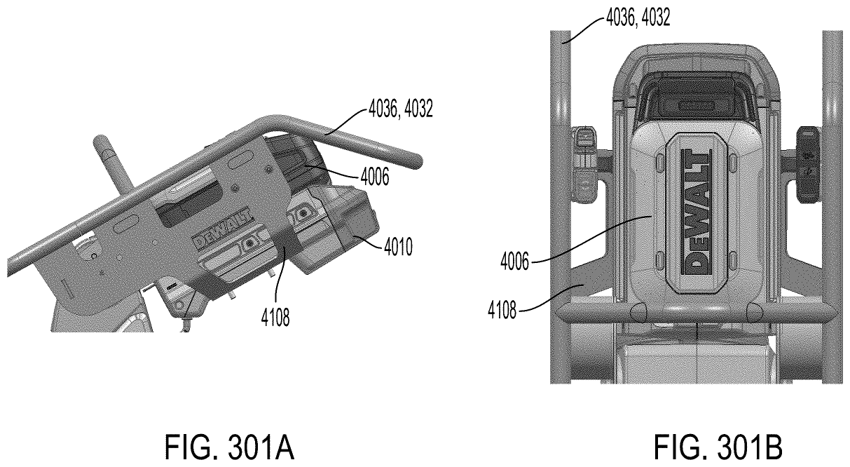

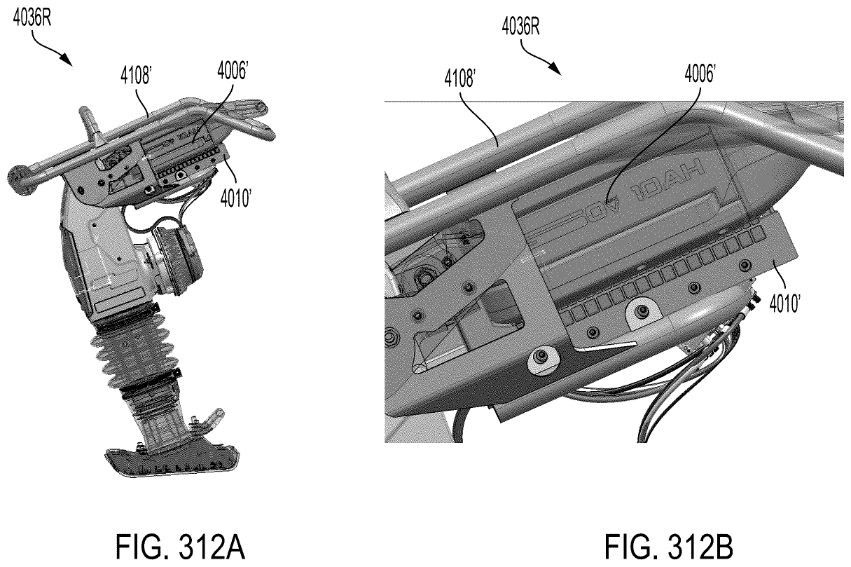

FIGS. 296A-296B and 297A-297B show various views (some detailed views) of the frame 4108 of the second cordless power tool 4036. FIGS. 298A-298B and 299A-299B show various views (some detailed views) of the interface 4010 fastened to the frame 4108 of the second cordless power tool 4036. FIGS. 300A-300B and 301A-301B show various views (some detailed views) of the battery pack 4006 coupled to the interface 4010 and the second cordless power tool 4036. FIGS. 312A-312B show various views (some detailed views) of an alternate example embodiment of the interface 4010 fastened to the frame 4108 of the second cordless power tool 4036, wherein the battery pack 4006 is coupled to the interface 4010.

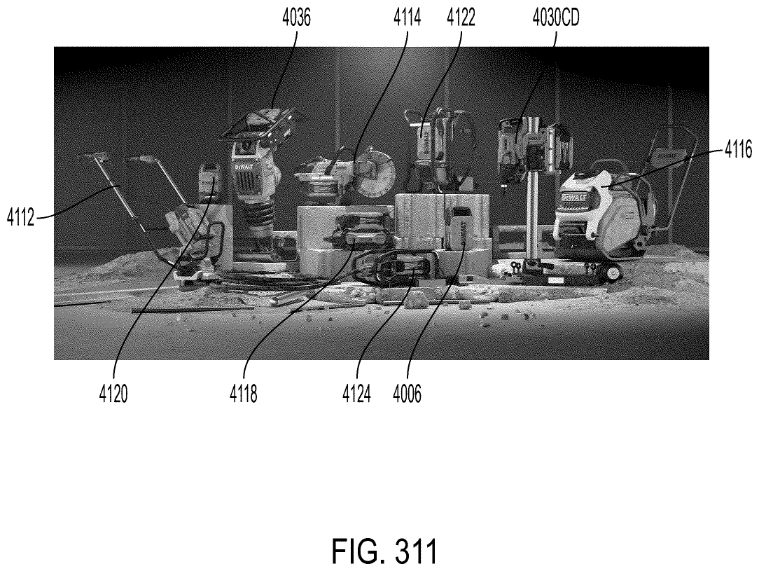

FIG. 311 shows an example power tool system 4032, including several example cordless power tools, battery packs 4006, charger 4118, and battery pack adaptor 4120, all incorporating the battery pack interface 4010 of the present patent application. The cordless power tools may include screed/concrete screed 4112, rammer 4036R, concrete vibrator power pack 4124, concrete vibrator backpack 4122, core drill stand 4030CD, plate compactor 4116, 12 inch cutoff saw 4114, etc.

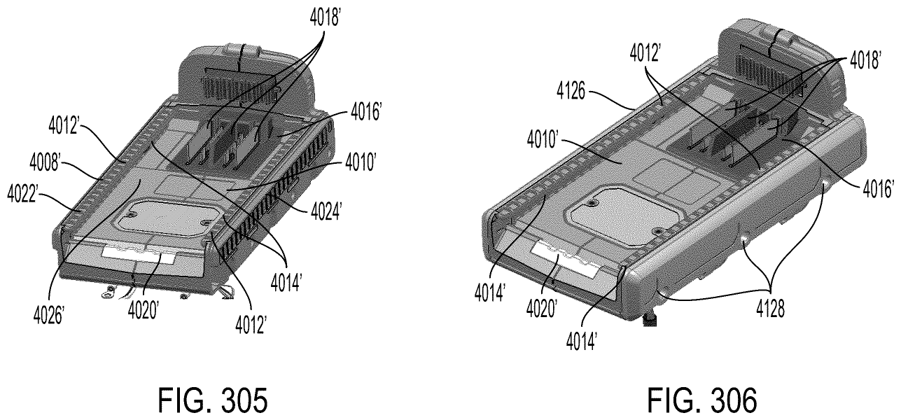

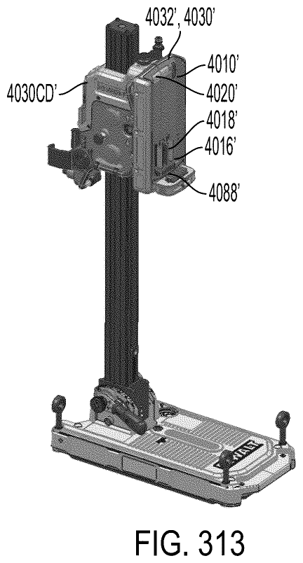

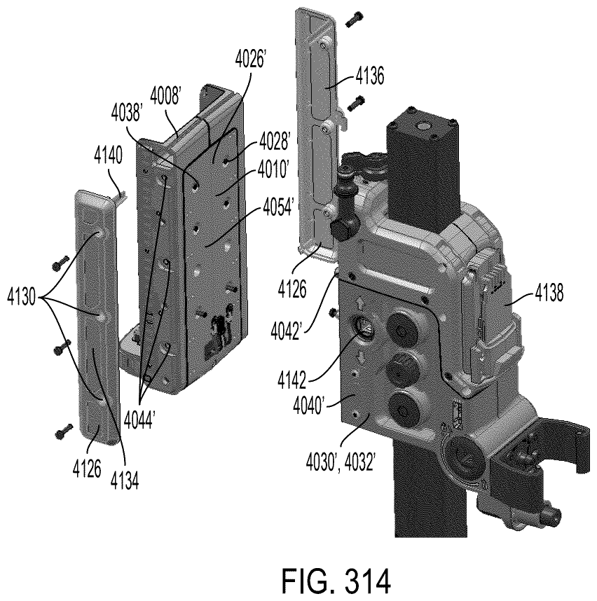

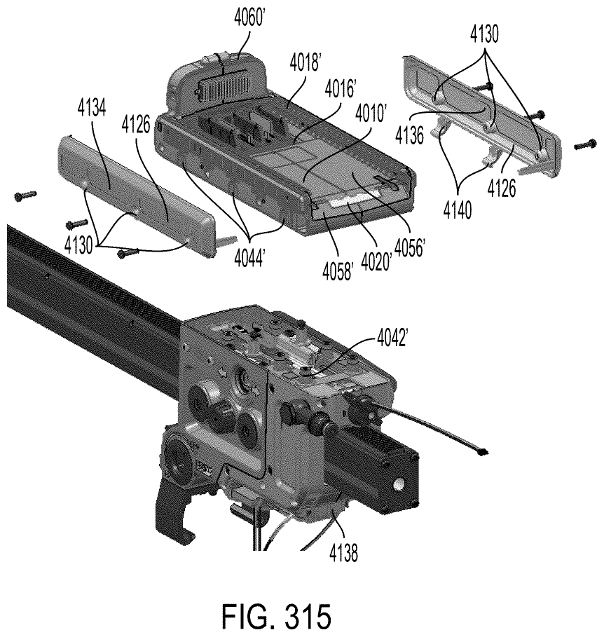

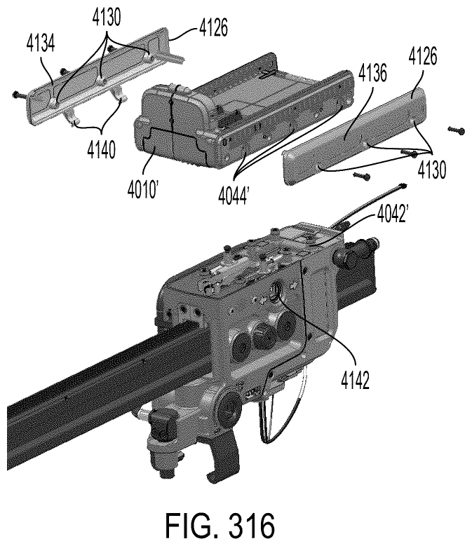

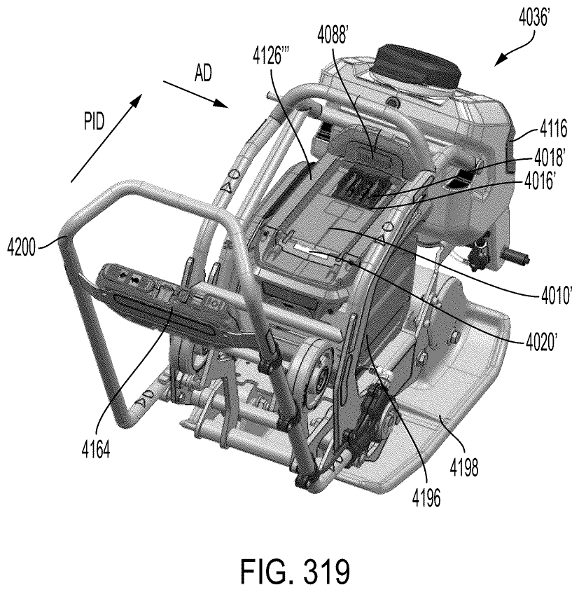

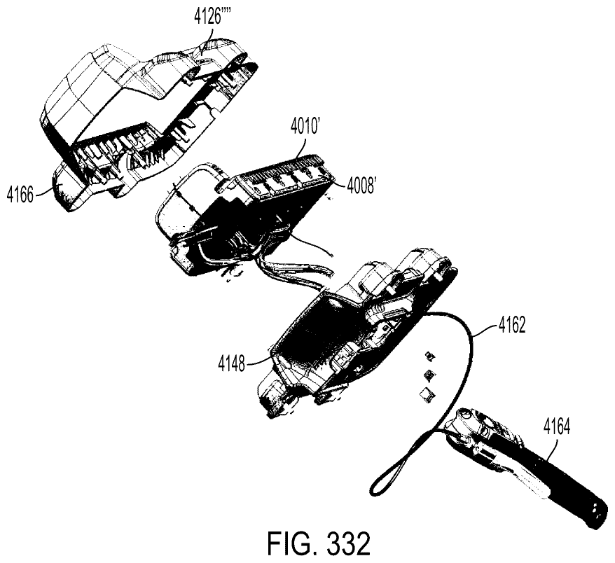

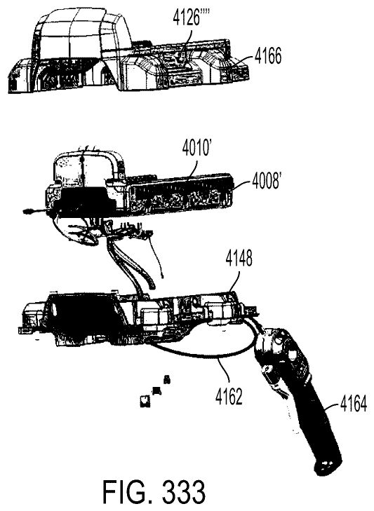

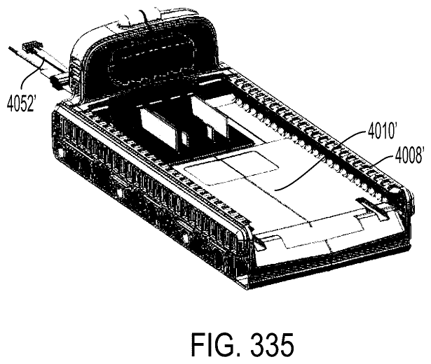

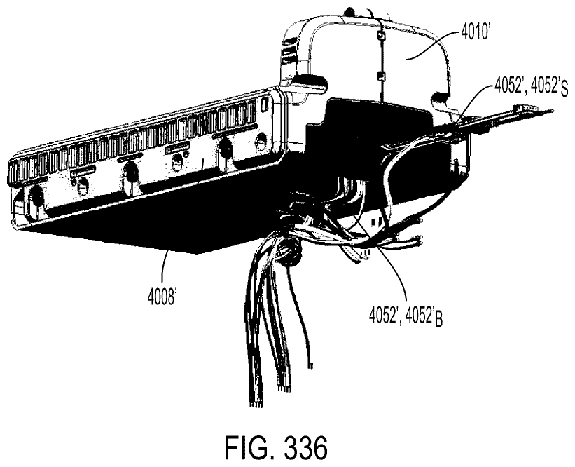

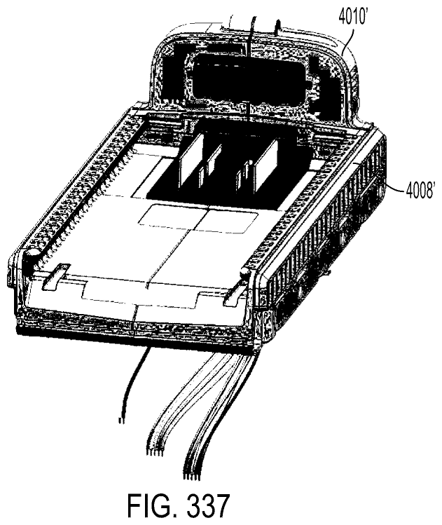

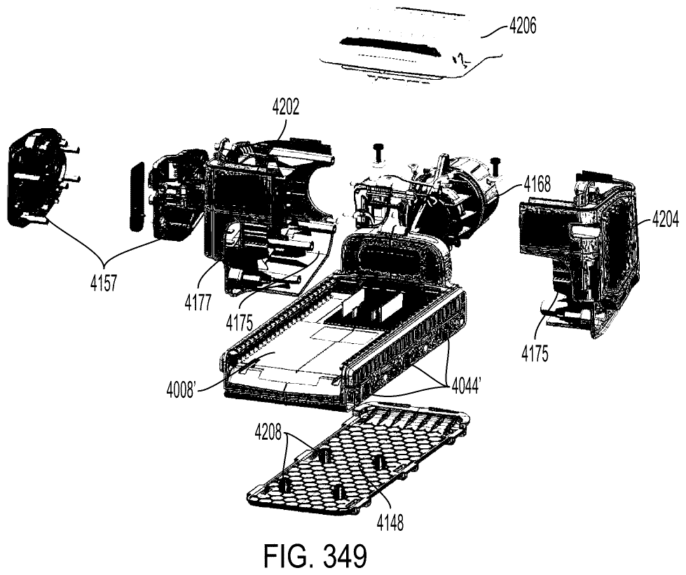

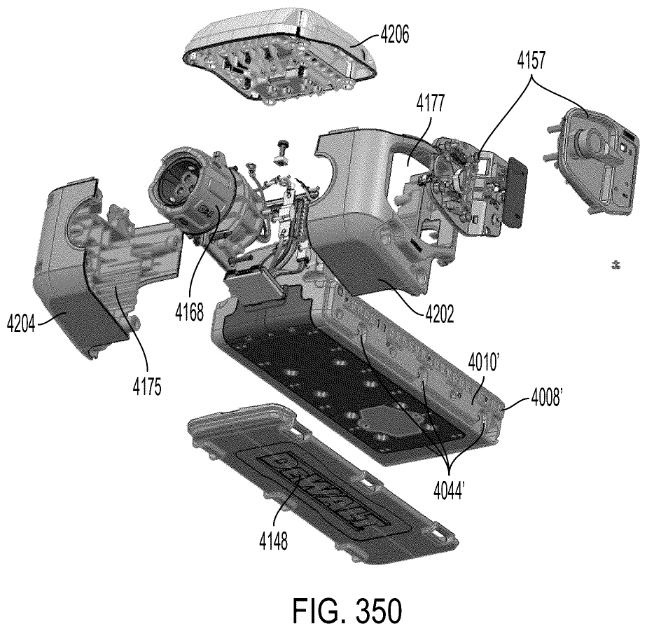

Referring to FIGS. 305-310B and 313-351, another embodiment of an interface system 4000′ for enabling mating and operation between a set of cordless power tools 4032′ and a battery pack is described. The interface system 4000′ may include a first housing 4008′ and a second housing 4126. The first housing 4008′ may include an interface 4010′ for mating with a battery pack 4006′. The interface 4010′ may include a set of rails 4012′, a set of grooves 4014′, a terminal block 4016′, and a catch 4020′. The terminal block 4016′ may include a set of terminals 4018′. The first housing 4008′ may include the first attachment feature 4028′ (not shown in FIGS. 305-309 but the first attachment feature 4028′ may have the same configuration/construction as the first attachment feature 4028) configured to attach the interface 4010′ to the first cordless power tool 4030′ of the set of cordless power tools 4032′ in a first orientation (as shown in FIGS. 313-318). The second housing 4126 may be attached to the first housing 4008′. The second housing 4126 may include a second attachment feature 4128 that may be configured to attach the interface 4010′ to the second cordless power tool 4036′ of the set of cordless power tools 4032′ in a second orientation (as shown in FIGS. 319-351). The second housing 4126 may be positioned between the first housing 4008′ and the second cordless power tool 4036′.

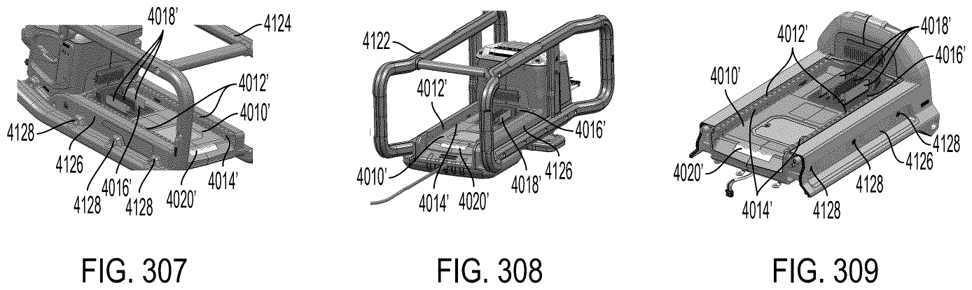

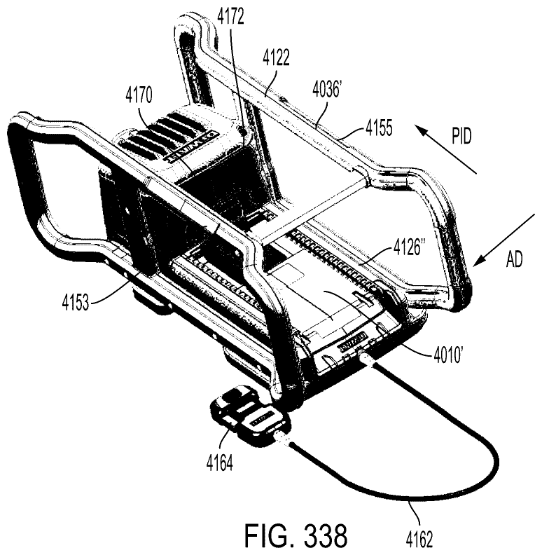

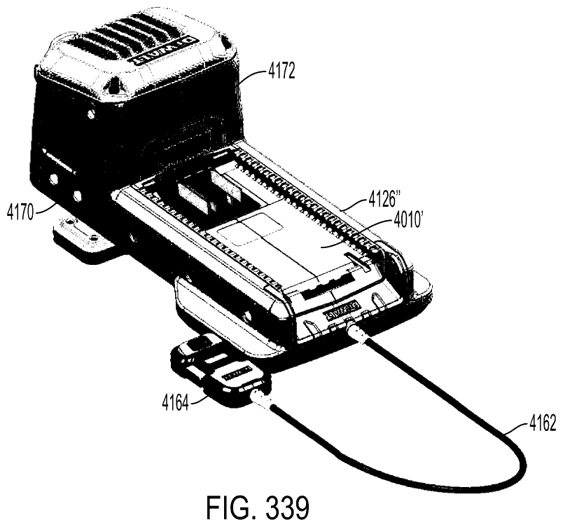

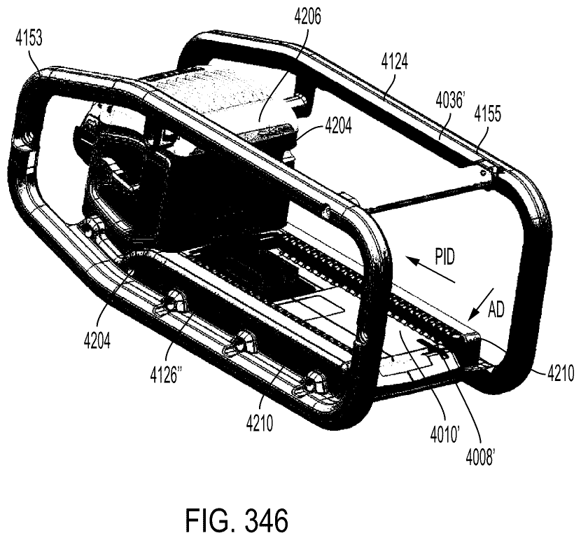

FIG. 305 shows the interface 4010′ without the second housing 4126. FIG. 306 shows a first example outer/second housing 4126 that is coupled to the interface 4010′. FIG. 307 shows the combination of a second example second housing 4126′ and interface 4010′ incorporated in a third example power tool (e.g., vibrator power pack 4124 that is also shown and described in detail in FIGS. 346-351). FIG. 308 shows the combination of a third example second housing 4126″ and the interface 4010′ incorporated in a fourth example power tool (e.g., concrete vibrator backpack 4122 that is also shown and described in detail in FIGS. 338-345). FIG. 309 shows a fourth example second example second housing 4126″ coupled to the interface 4010′.

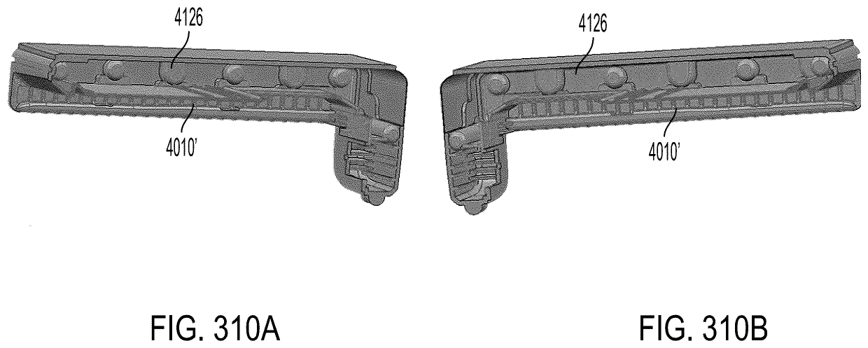

While FIGS. 305-309 show a method of coupling the second housing 4126 (e.g., clamshells) to the interface 4010′, for example, using a set of fasteners, FIGS. 310A-310B show a method of coupling the second housing 4126 (with first and second clamshell portions) to the interface 4010′, for example, using a molded connection (i.e., a connection in mold from tool).

As shown in FIG. 305, the first housing 4008′ comprises a first housing portion 4022′, a second housing portion 4024′, and a core block 4026′ that is positioned between and coupled to the first and second housing portions 4022′ 4024′. The core block 4026′ including the first attachment feature 4028′. The first attachment feature 4028′ includes a set of holes 4038′ in the core block 4026′ configured to mate with a corresponding fixture 4040′ on the first cordless power tool 4030′. The first housing 4008′ may comprise two housing portions forming an internal cavity and the core block 4026′ may be positioned in the internal cavity. The first attachment feature 4028′, the core block 4026′, the internal cavity of the first housing 4008′ and the set of holes 4038′ in the core block 4026′ are not shown in FIGS. 305-309 but they may have the same configuration/construction as the first attachment feature 4028, the core block 4026, the internal cavity 4025 of the first housing 4008 and the set of holes 4038 in the core block 4026.

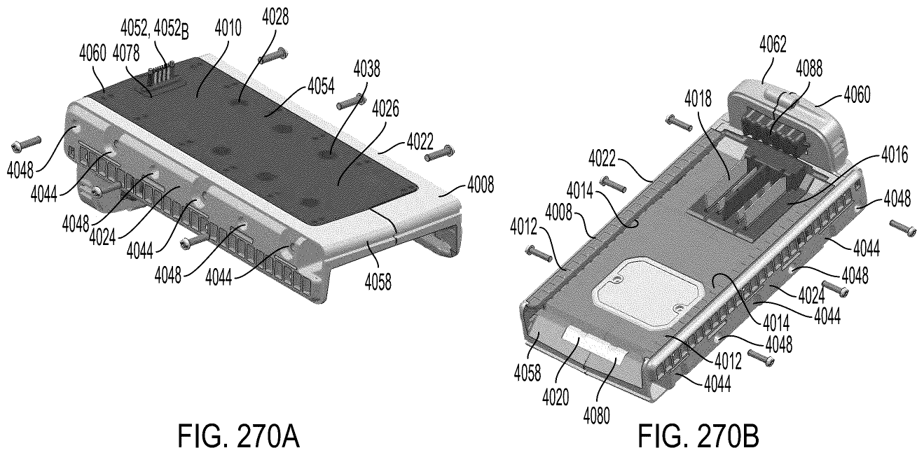

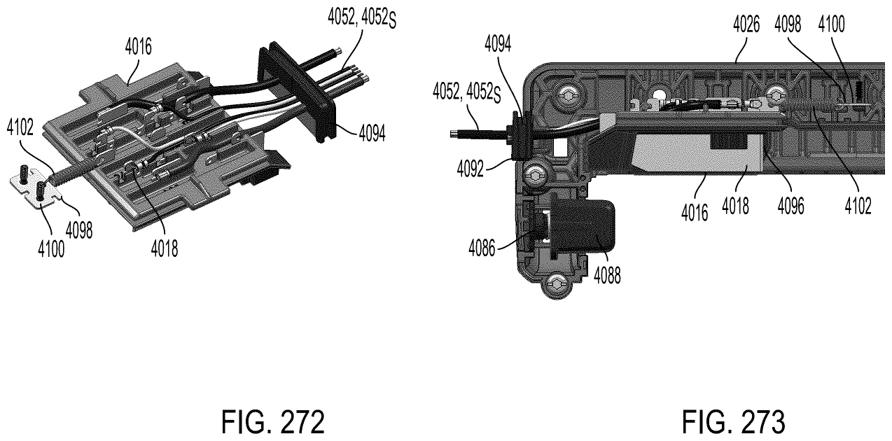

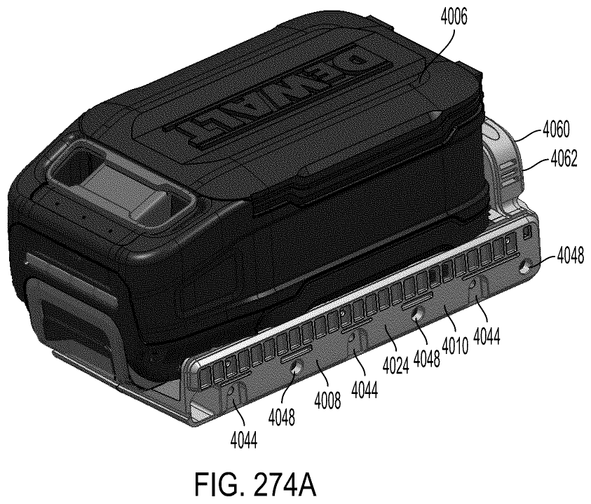

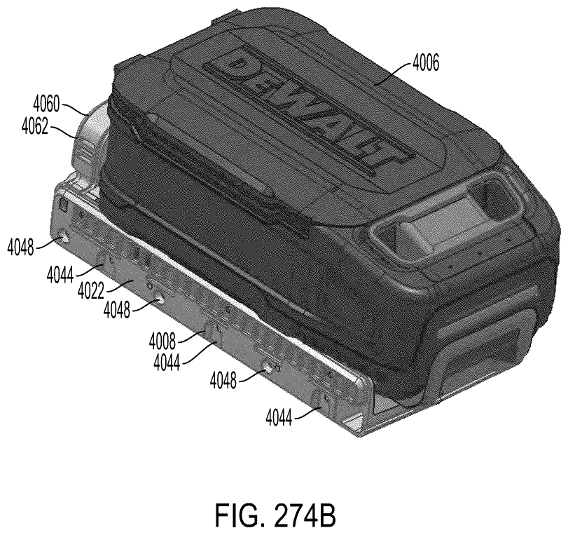

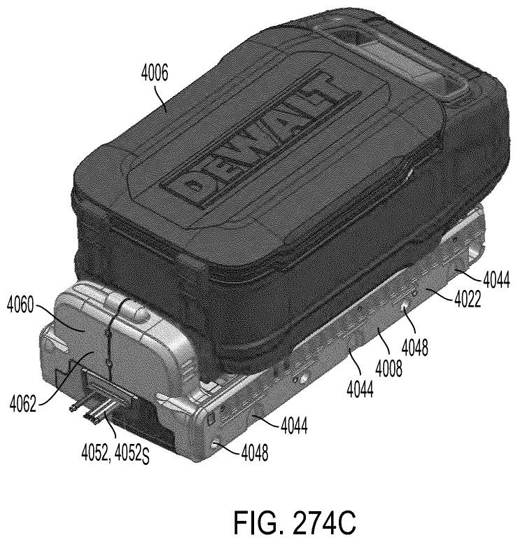

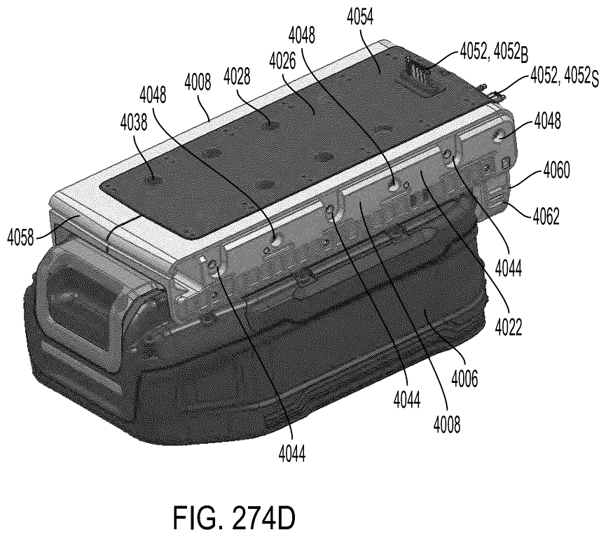

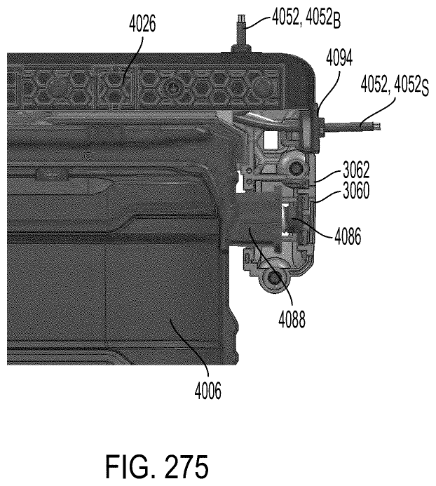

A terminal block 4016′ including the set of terminals 4018′ is coupled to or disposed on the core block 4026′. The core block 4026′ may also include the wire harness 4052′ that is configured to be electrically coupled to either the first cordless power tool 4030′ or the second cordless power tool 4036′. The core block 4026′ may include a tool interface side 4054′ that is opposing a battery pack interface side 4056′. The wire harness 4052′ is configured to extend from the tool interface side 4054′. The interface 4010′ may include a front portion 4058′ and a rear portion 4060′. The catch 4020′ is disposed in the front portion 4058′ of the interface 4010′. Other details of the core block, the first housing (including the first and second housing portions), the first attachment feature (including the set of holes), the fixture, the first cordless power tool, etc. are all described in detail with respect to the first embodiment shown and described with respect to FIGS. 269-304, and 311-312B and, therefore, will not be described in detail again here. The battery pack 4006′ that is configured to be used with the interface 4010′ is described in detail with respect to the above disclosed embodiment of the interface shown and described with respect to FIGS. 269-304, and 311-312B and, therefore, will not be described in detail again here.

The second attachment feature 4128 of the second housing 4126 may include a set of holes 4130 in the second housing 4126 configured to mate with a corresponding fixture 4132 on the second cordless power tool 4036′. As explained in detail with respect to FIGS. 319-351, portions of the second housing 4126 that are positioned between the first housing 4008′/the interface 4010′ and the second cordless power tool 4036′ are first housing portions of the second housing 4126. The second housing 4126 may include second housing portions that are positioned on the sides and/or ends surrounding the first housing and the interface 4010′.

FIGS. 313-316 show the first cordless power tool 4030′ with the interface 4010′ coupled thereto. The first cordless power tool 4030′ is a core/concrete drill system 4030CD′. The core/concrete drill 4030CD′ has been described in detail above. The second housing 4126 may include second housing side portions 4134, 4136. The second housing side portions 4134, 4136 may include engagement portions 4140 that are configured to engage with portions of the first housing 4008′ so as to couple the second housing 4126 to the interface 4010′ (and the first housing 4008′). The second housing 4126 and the interface 4010′ (and the first housing 4008′) may also be coupled to each other using fasteners passing through aligned holes 4130 (in the second housing 4126) and openings 4044′ (in the first housing 4008′).

A stand engaging portion 4142 may be configured to removably engage with a portion of the concrete drill stand to enable movement of the drill up and down. The stand engaging portion 4142 may include a gear 4142 that is configured to move the stand up and down.

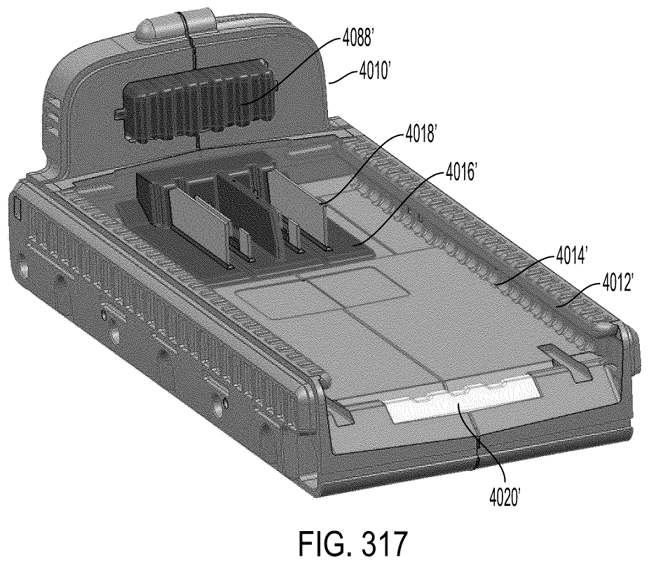

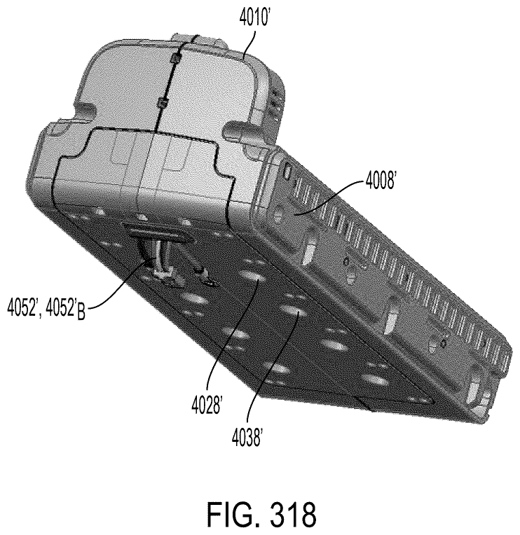

FIGS. 317-318 show the interface 4010′. The interface 4010′ (including the terminal block 4016′, the terminals 4018′, the wire harness 4052′, etc.) and the first housing 4008′ are generally the same as the interface 4010 and the housing 4008 and will not be described in detail.

The fixture 4040′ on the core/concrete drill stand may include protrusions 4042′ that are configured to align with and to be received in the set of holes 4038′ (of the first attachment feature 4028′) in the core block 4026′ so as to attach the interface 4010′ to the concrete drill stand in the first orientation. In the first orientation, the interface 4010′ is positioned in a generally vertical orientation. The generally vertical orientation may be parallel to a vertical axis.

The procedures in which the interface 4010′ and the second housing 4126 may be attached to the core/concrete drill stand are explained below. In these procedures, a tool engaging housing portion 4138 may be part of the fixture 4040′ of the concrete drill stand. The tool engaging portion 4138 may be part of the drill stand and may be a tool (drill) terminal housing. The tool (drill) with its foot may be connected to the tool engaging portion 4138. The stand may include an internal wiring harness/circuit inside that is configured to connect the battery pack 4006 to the tool.

The core block 4026′ is attached/connected to the fixture 4040′ of the concrete drill 4030CD'. The second housing side portions 4134, 4136 of the second housing 4126 are then connected to the interface 4010′ (and the first housing 4008′) while the interface 4010′ is connected to the fixture 4040′ of the concrete drill stand.

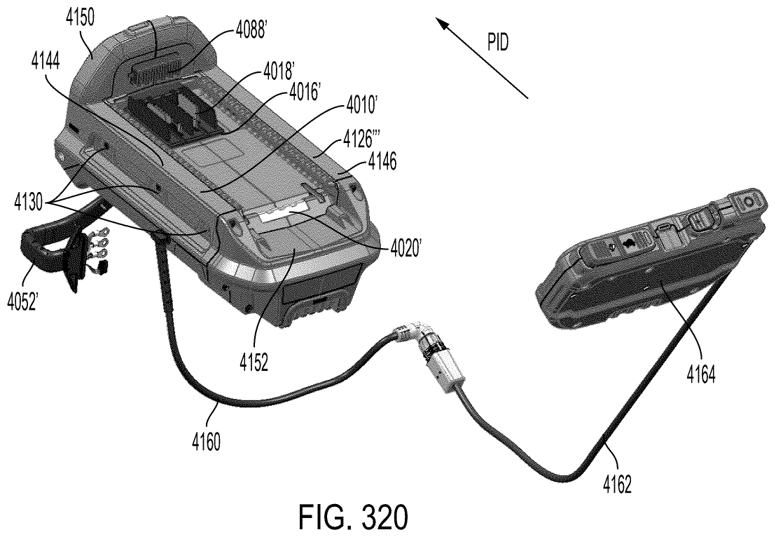

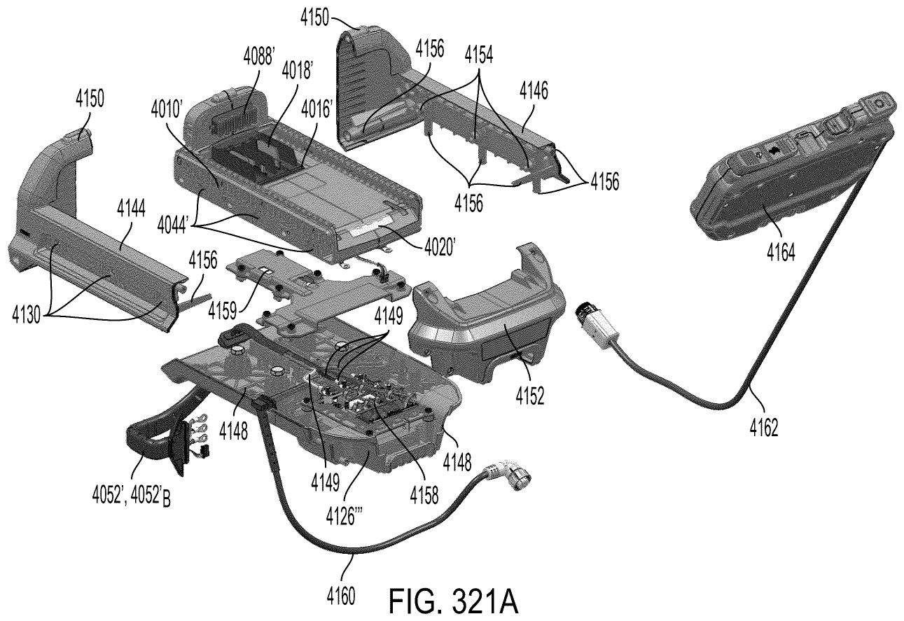

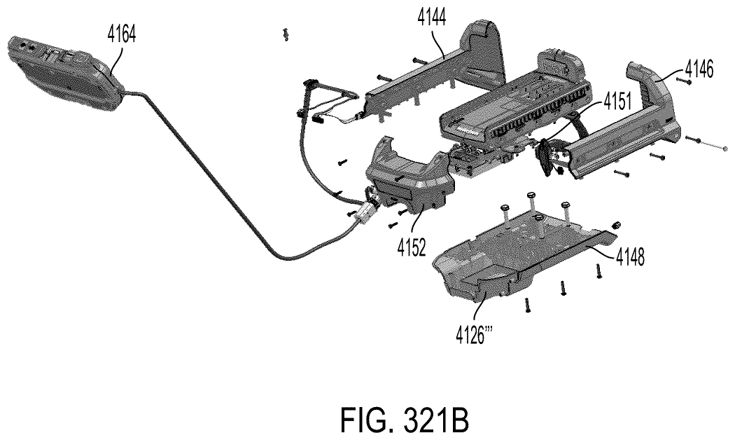

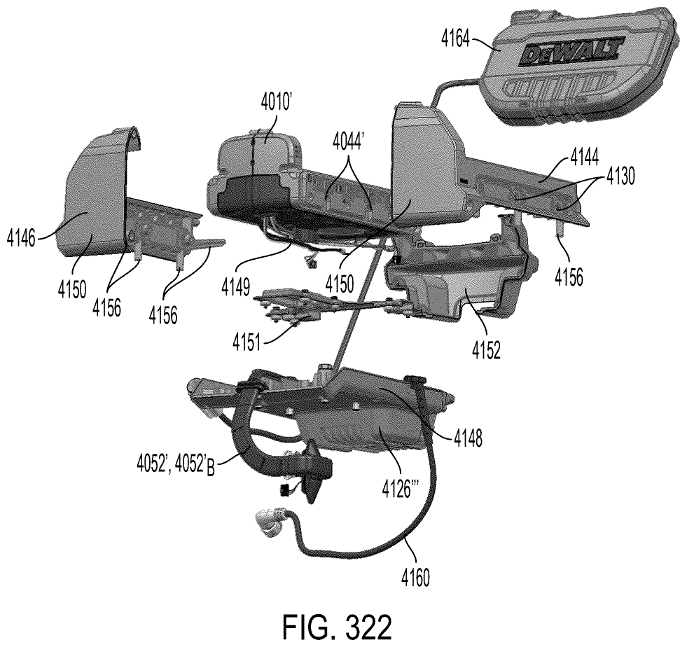

FIG. 319 shows a perspective view of the second cordless power tool 4036′ (with the interface 4010′ mounted thereon). FIG. 320 shows an assembled view of portions of the plate compactor 4116, the interface 4010′, and portions of the second façade/outer housing 4126″′. FIGS. 321A-322 show exploded views of the portions of the compactor or plate compactor 4116, the interface 4010′, and portions of the second facade/outer housing 4126″′. The second cordless power tool 4036′ may be a compactor or plate compactor 4116, as illustrated in FIGS. 319-322.

The compactor 4116 may include a main body 4196 and a vibrating plate portion 4198. The plate portion 4198 may be adapted for compacting soil, gravel, sand, silt or any other material to be compacted. The compactor 4116 also may include a handle 4200 by which a user can maneuver the compactor 4116, a motor, and a battery pack (e.g., the battery pack 4006) for powering the motor of the compactor 4116. The compactor 4116 may include a user operable switch (may also be referred to as a “trigger” or “power switch”) and a control module (may also be referred to as “electronic control module”, or “motor control module”). The motor control module may include a controller and electronic switching components for regulating the supply of power from the battery pack 4006 to the motor. The motor control module may be disposed within the housing of the main body of the compactor 4116 or at any location within or on the compactor 4116. The motor control module may also integrally include components to support a user operated input unit or user interface 4164 (may be referred to as “input unit” or “control unit”) for receiving user function selections, such as an ON/OFF signal, variable-speed signal, and forward-reverse signal. LEDs may be integrated in the user interface 4164. The LEDs may be configured to provide feedback, such as variable speed, service/maintenance, errors, other information etc. to the user. The handle 4200 of the compactor 4116 may be detachable by the user.

Referring to FIGS. 321A-322, a plurality of wires 4149 may be configured to be received in a second housing bottom portion 4148. The second housing bottom portion 4148 may be part of the second façade/outer housing 4126″′. A wire cover 4151 may be configured to cover the wires 4149 received in the second housing bottom portion 4148. The wire cover 4151 may be configured to be mounted on the second housing bottom portion 4148.

The second housing 4126″′ may include second housing side portions 4144, 4146, second housing end portions 4150, 4152 and the second housing bottom portion 4148. The second housing end portion 4150 may be integrally formed with respective second housing side portions 4144, 4146. The second housing side portions 4144, 4146 may include engagement portions 4154 that are configured to engage with portions of the first housing 4008′ so as to couple the second housing 4126″′ to the interface 4010′ (and the first housing 4008′). The second housing 4126″′ may also include engagement portions 4156 that are configured to engage with other portions of the second housing 4126″′ so as to couple the second housing side portions 4144, 4146, second housing end portions 4150, 4152 and the second housing bottom portion 4148 of the second housing 4126″′ to each other. The second housing 4126″′ and the interface 4010′ (and the first housing 4008′) may also be connected to each other using fasteners passing through aligned holes 4130 (in the second housing 4126″′) and openings 4044′ (in the first housing 4008′).

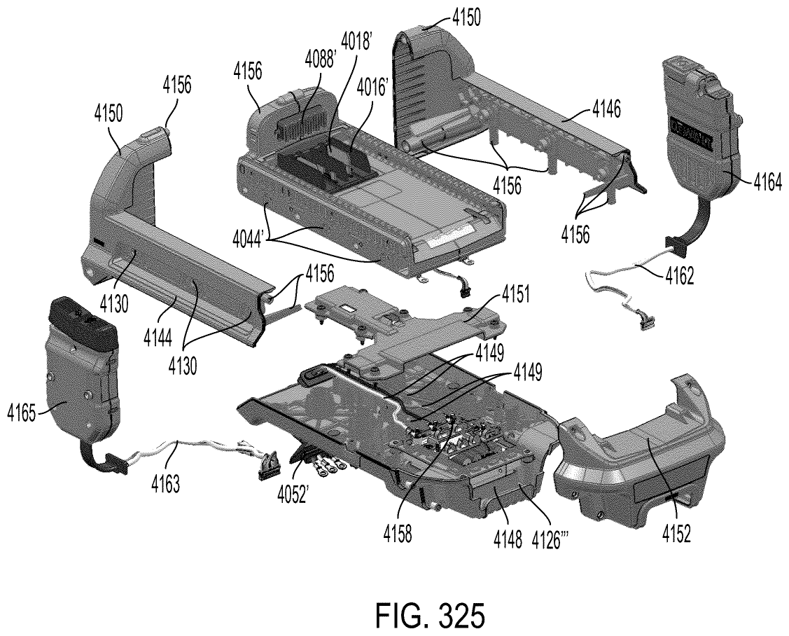

The second housing 4126″′ may be configured to receive an electronics module 4158 in the second housing bottom portion 4148. The electronics module 4158 may include a wire harness 4160 that is configured to be coupled with a wire harness 4162 of the user interface 4164 of the second cordless power tool 4036′. Referring to FIG. 325, the plurality of wires 4149 may be configured to be received in the second housing bottom portion 4148. The second housing bottom portion 4148 may be part of the second façade/outer housing 4126″′. A wire cover 4151 may be configured to cover the wires 4149 received in the second housing bottom portion 4148. The wire cover 4151 may be configured to be mounted on the second housing bottom portion 4148. The cover 4151 may also be configured to cover the wire harness 4160 and portions of the electronics module 4158.

The procedures in which the interface 4010′ and the second housing 4126″′ may be attached to the plate compactor 4116 are explained below. In these procedures, the interface 4010′ and the second housing 4126″′ are first connected to each other. The second housing 4126″′ (with the interface 4010′) is connected to the plate compactor 4116.

The second attachment feature 4128 (and the openings 4130) of the second housing 4126″′ may be configured to attach the interface 4010′ to the compactor 4116 in a second orientation (as shown in FIG. 319). The second housing bottom portion 4148 of the second housing 4126″′ may be positioned between (a) a combination of the first housing 4008′ and the interface 4010′ and (b) the compactor 4116. In the second orientation, the interface 4010′ may be positioned in a generally angled orientation with respect to the horizontal axis and the vertical axis. In the second orientation, the interface 4010′ may be in a generally horizontal orientation. Referring to FIG. 319, the direction of attachment AD of the interface 4010′ to the plate compactor 4116 may be perpendicular to a direction of insertion PID of the battery pack 4006 on to the interface 4010′.

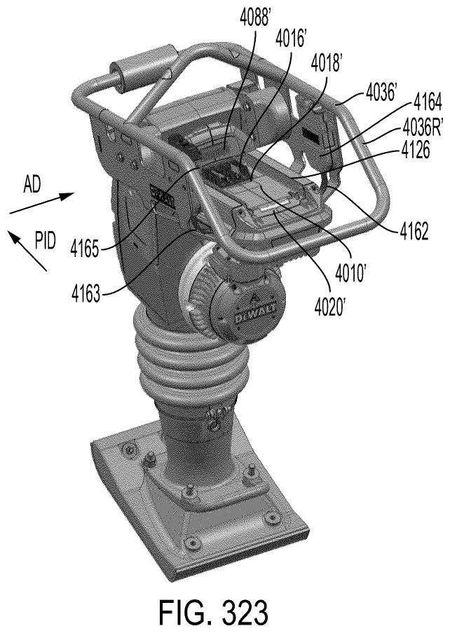

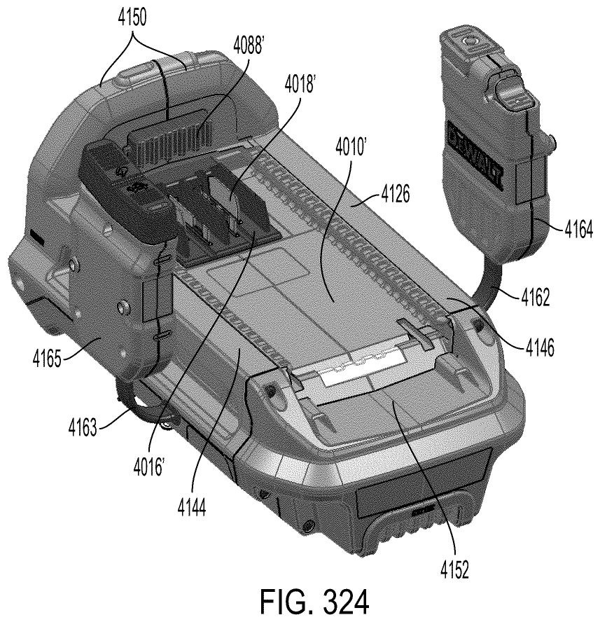

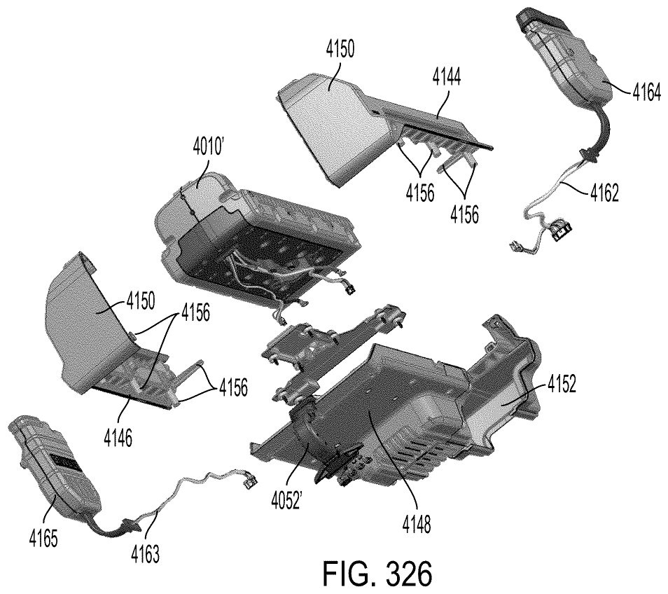

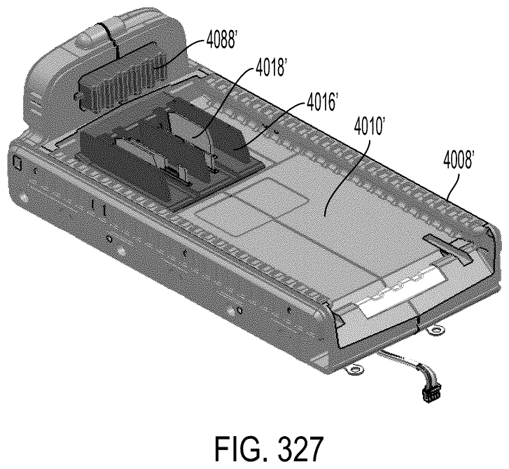

FIG. 323 shows a perspective view of the second cordless power tool 4036′ with the interface 4010′ mounted thereon. FIG. 324 shows an assembled view of the portions of the second cordless power tool 4036′, the interface 4010′, and portions of the façade/outer housing 4126″′. FIGS. 325-326 show exploded views of the portions of the second cordless power tool 4036′, the interface 4010′, and portions of the façade/outer housing 4126″′. FIG. 327 shows show a perspective view of the interface 4010′. The rammer 4036R′ has been described in detail above. The second cordless power tool 4036′ may be a rammer 4036R', as illustrated in FIGS. 323-326.

The second housing 4126″′ of the rammer 4036R′ is very similar to the second housing 4126″′ of the plate compactor 4116 (in FIGS. 319-322), except for the differences noted below. The rammer 4036R′ may include two user interfaces 4164, 4165 that are connected to the interface 4010′ via two wire harnesses 4162, 4163. The procedures in which the interface 4010′ and the second housing 4126″′ may be attached to the rammer 4036R′ are also similar to those explained above with respect to the plate compactor 4116. The user interface 4164, 4165 may also be referred to as control units.

The second attachment feature 4128 (and the openings 4130) of the second housing 4126″′ may be configured to attach the interface 4010′ to the rammer 4036R′ in the second orientation (as shown in FIG. 323). The second housing bottom portion 4148 of the second housing 4126″′ may be positioned between (a) a combination of the first housing 4008′ and the interface 4010′ and (b) the rammer 4036R'. In the second orientation, the interface 4010′ may be positioned in a generally angled orientation with respect to the horizontal axis and the vertical axis. Alternatively, in the second orientation, the interface 4010′ may be in a generally horizontal orientation. The direction of attachment AD of the interface 4010′ to the rammer 4036R′ may be perpendicular to a direction of insertion PID of the battery pack 4006 on to the interface 4010′.

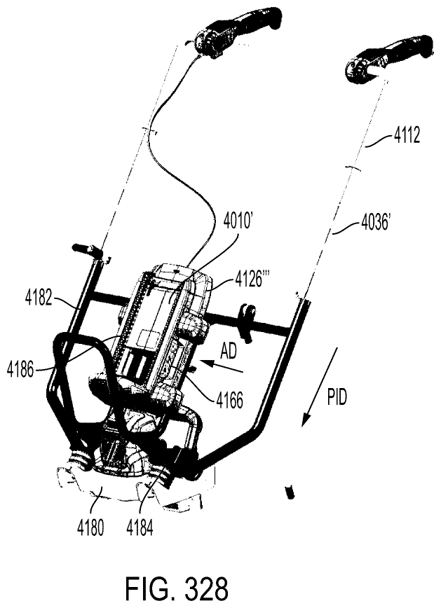

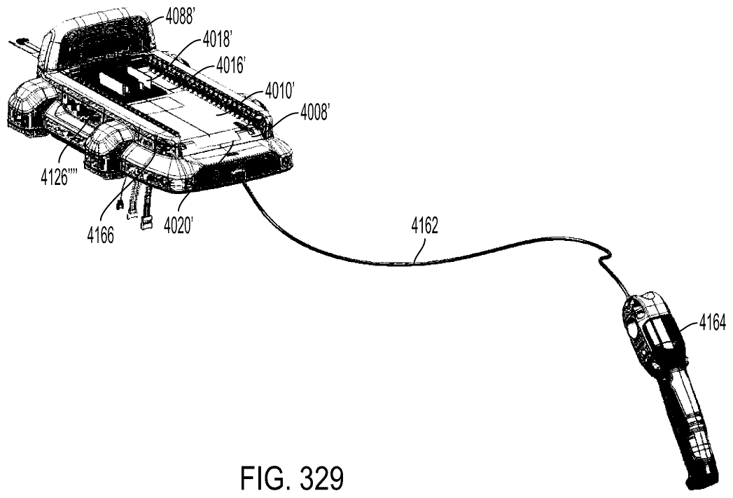

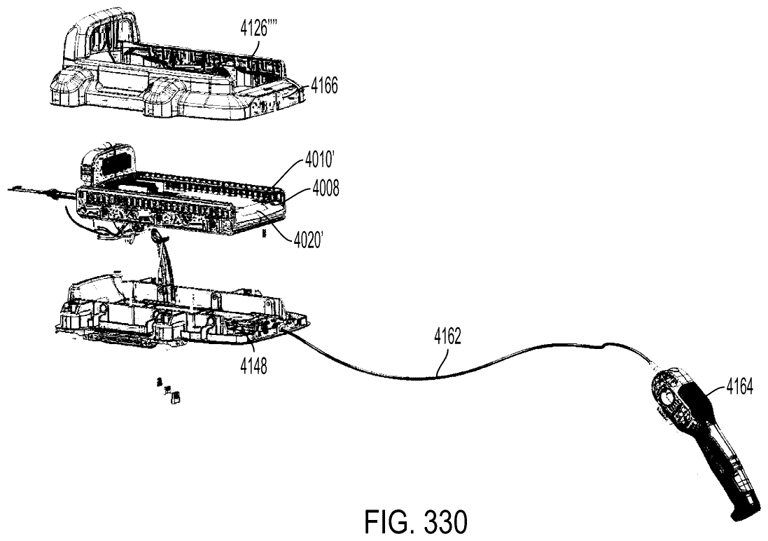

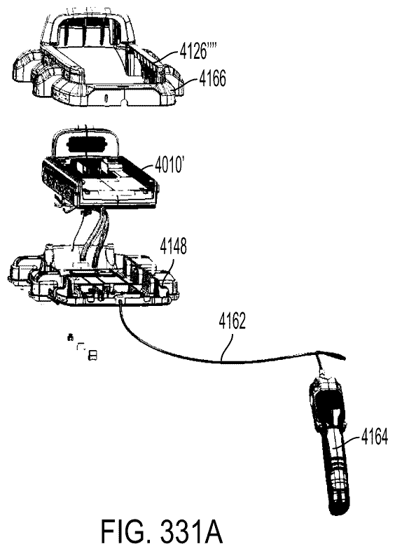

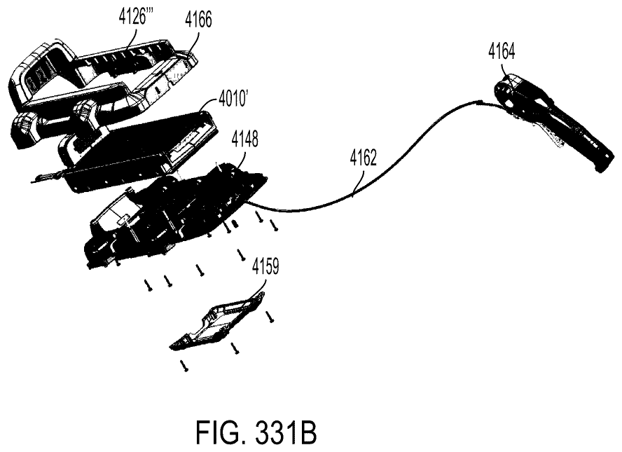

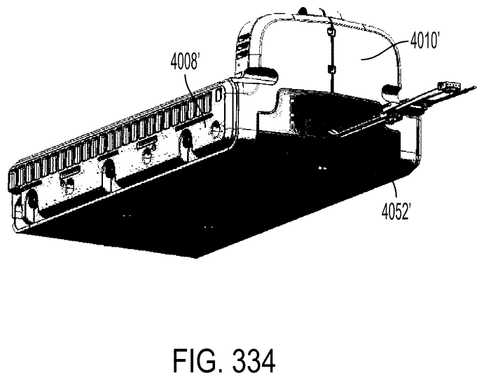

FIG. 328 shows a perspective view of the second cordless power tool 4036′ with the interface 4010′ mounted thereon. FIG. 329 shows an assembled view of portions of the second cordless power tool 4036′, the interface 4010′, and portions of the façade/outer housing 4126″″. FIGS. 330-333 show exploded views of portions of the second cordless power tool 4036′/4112, the interface 4010′, and portions of the façade/outer housing 4126″″. FIGS. 334-337 show various views of the interface 4010′. The second cordless power tool 4036′ may be a screed 4112, as illustrated in FIGS. 328-333. As shown in FIG. 331B, a housing portion 4159 may be mounted to the façade/outer housing 4126″″.

The screed (or vibrating screed tool) 4112 may be configured for leveling and smoothing a working material (e.g., wet concrete). The screed 4112 can include a base 4180, a frame assembly 4182 mounted to the base 4180 via a vibration dampening mechanism 4184, and a housing 4186 disposed on the frame assembly 4182 and supporting the removable power source (e.g., battery pack) 4006. The housing 4186 may house a motor (not shown) operatively coupled to the base 4180 and an eccentric vibration mechanism (not shown) coupled to the motor. The screed 4112 may include a beam (not shown) removably connected to the base 4180 and the motor and be configured to be vibrated by the eccentric vibration mechanism 4184 to provide a beam acceleration.

The second housing 4126″″ may include a top housing portion 4166 and the bottom housing portion 4148. The top housing portion 4166 and the bottom housing portion 4148 may have inter-engaging portions to connect them together. When the top housing portion 4166 and the bottom housing portion 4148 are connected together, the interface 4010′ (and the first housing 4008′) are received between them. The top housing portion 4166 may be configured to surround the sides and the edges of the interface 4010′ (and the first housing 4008′). The second housing 4126″″ may be configured to be coupled with the wire harness 4162 of the user interface 4164 of the screed 4112.

The procedures in which the interface 4010′ and the second housing 4126″″ may be attached to the screed 4112 are explained below. In these procedures, the interface 4010′ and the second housing 4126″″ are first connected to each other. The second housing 4126″″ (with the interface 4010′) is connected to the screed 4112.

The second attachment feature (and the openings) of the second housing 4126″″ may be configured to attach the interface 4010′ to the screed 4112 in a second orientation (as shown in FIG. 328). The openings and the second attachment feature may be configured to extend through the bottom housing portion 4148 of the second housing 4126″″. The bottom housing portion 4148 of the second housing 4126″″ may be positioned between (a) a combination of the first housing 4008′ and the interface 4010′ and (b) the screed 4112. In the second orientation, the interface 4010′ may be positioned in a generally angled orientation with respect to the horizontal axis and the vertical axis. In the second orientation, the interface 4010′ may be in a generally horizontal orientation. The direction of attachment AD of the interface 4010′ to the screed 4112 may be perpendicular to the direction of insertion PID of the battery pack 4006 on to the interface 4010′.

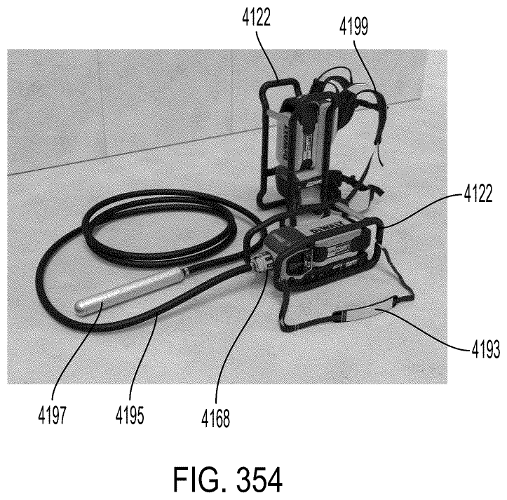

A concrete vibrator system may include a vibrating head 4197 including a head housing and a rotating shaft received in the housing. The shaft may include an eccentric portion that has an eccentric axis that is parallel to and offset from the shaft axis. The concrete vibrator system may also include a motor configured to drive the rotating shaft so that a vibrating head 4197 vibrates. The concrete vibrator system may include a power unit and a control module. The power unit may include a power unit housing having the battery receptacle/interface 4010′ and the battery pack 4006′ configured to be received in the battery receptacle/interface 4010′. The control module may be configured to control power delivery from the battery pack 4006′ to the motor. The concrete vibrator system may include a hose 4195 configured to couple the power unit to the vibrating head 4197. The motor may be received in the head housing and the hose 4195 may be configured to electrically couple the power unit to the motor. The motor may be received in the power unit housing and the hose may comprise a flexible shaft configured to couple the motor to the rotating shaft in the head. The hose 4195 and the vibrating head 4197 are shown in FIG. 354.

The concrete vibrator system may further comprise a backpack configured to carry a power delivery module. The concrete vibrator system with the backpack may be referred to as concrete vibrator backpack and it is as shown in and described in detail with respect to FIGS. 338-343.

The concrete vibrator system may further comprise a floor mountable frame configured to be coupled to the power delivery module. The concrete vibrator system with the floor mountable frame may be referred to as concrete vibrator power pack and is as shown in and described in detail with respect to FIGS. 346-351.

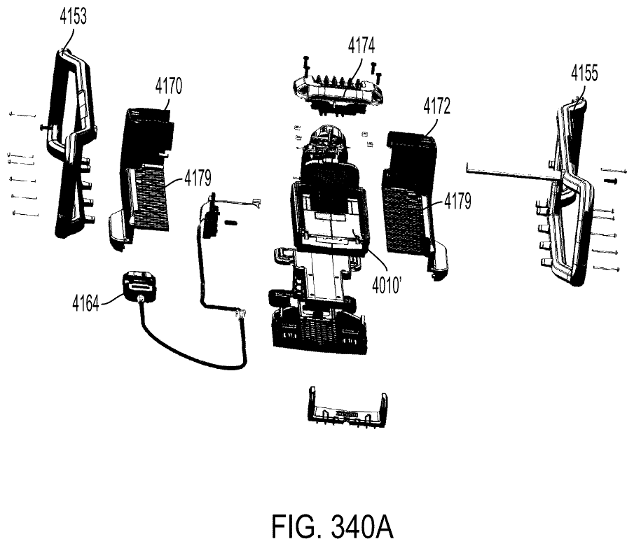

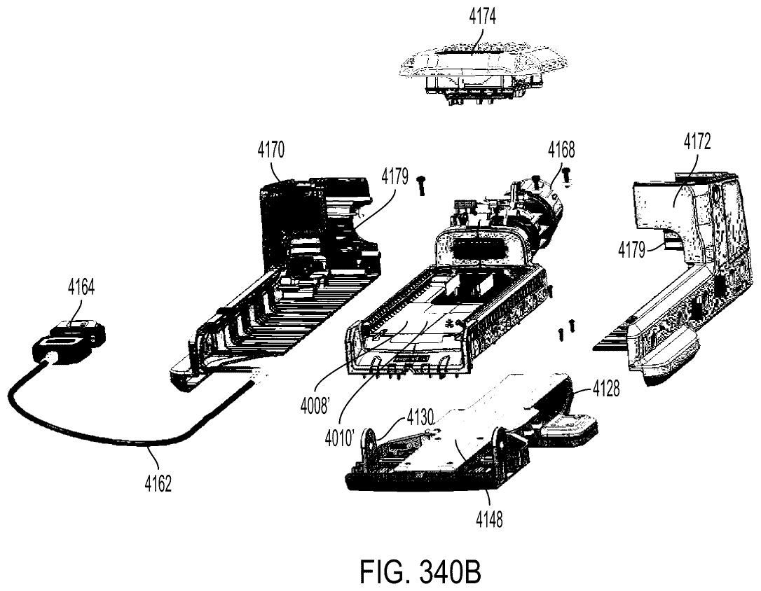

FIG. 338 shows a perspective view of the second cordless power tool 4036′ with the interface 4010′ mounted thereon. FIG. 339 shows an assembled view of the portions of the second cordless power tool 4036′, the interface 4010′, and portions of the façade/outer housing 4126″. Referring to FIGS. 338 and 340A, the façade/outer housing 4126″ may also include façade/protection cage portions 4153 and 4155.

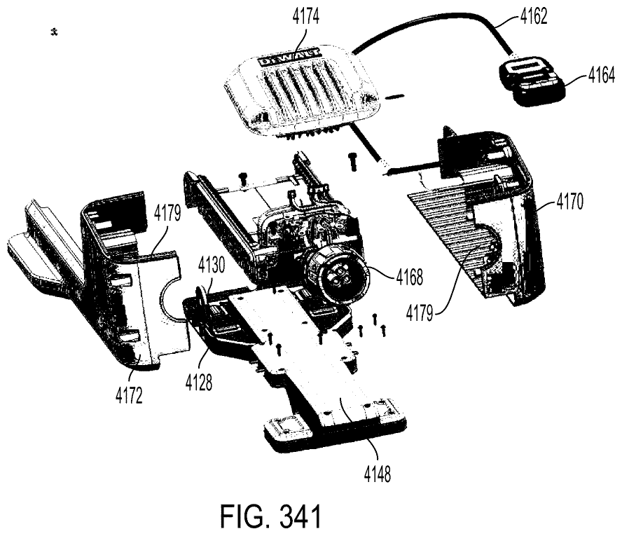

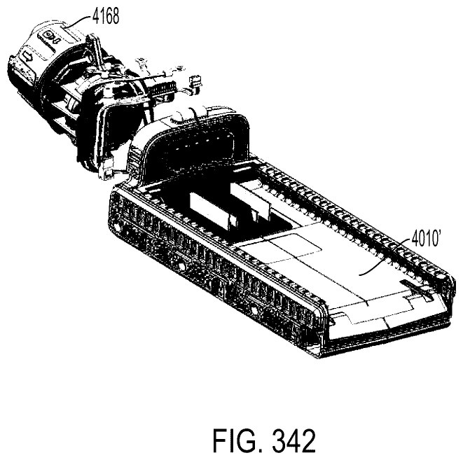

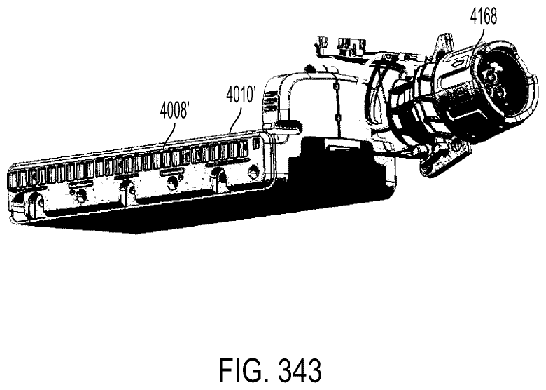

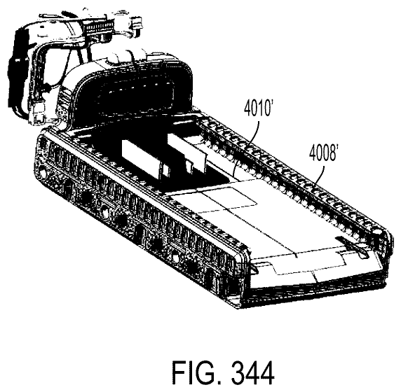

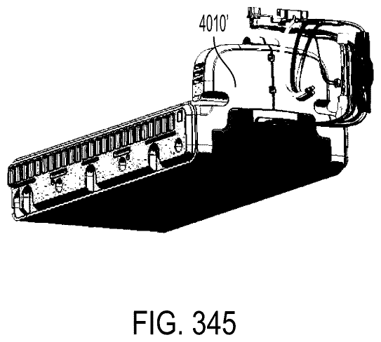

FIGS. 340A-341 show exploded views of the portions of the second cordless power tool 4036′, the interface 4010′, and portions of the façade/outer housing 4126″. FIGS. 342-343 show various views of the interface 4010′ and removably attachable portions 4168 of the second cordless power tool 4036′. FIGS. 344-345 show various views of the interface 4010′. The second cordless power tool 4036′ may be a concrete vibrator backpack 4122, as illustrated in FIGS. 338-343.

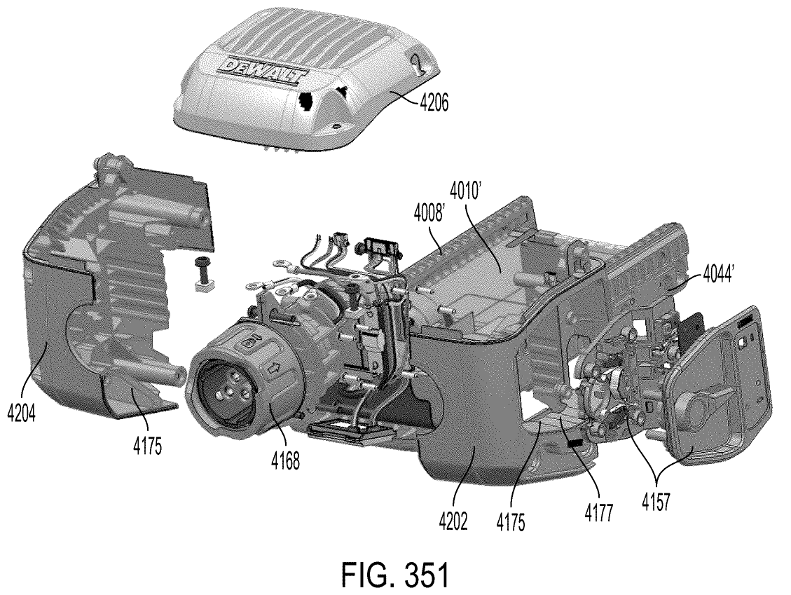

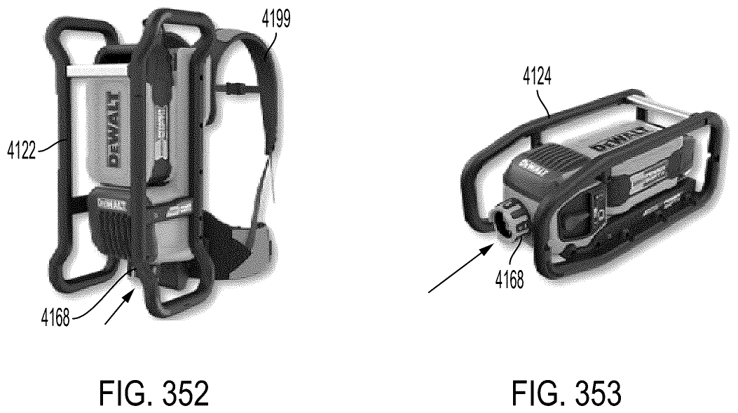

As shown in FIGS. 352-354, the removably attachable portions 4168 of the concrete vibrator backpack 4122 or the concrete vibrator powerpack 4124 may include an electrical connection between the concrete vibrator backpack 4122 or the concrete vibrator powerpack 4124 to the vibrating element/head 4197. The hose 4195 may be configured to couple the power unit to the vibrating head 4197. The length of the hose 4195 may vary. The diameter of the vibrating head 419 may vary.

The second housing 4126″ may include a first housing portion 4170, a second housing portion 4172, a third housing portion 4174, and a bottom housing portion 4148. The first housing portion 4170, the second housing portion 4172, and the third housing portion 4174 may have inter-engaging portions to connect them together and/or they may be connected to each other using aligned holes/openings and fasteners. The first housing portion 4170, the second housing portion 4172, and the third housing portion 4174 together form an internal cavity 4179. The removably attachable portions 4168 of the concrete vibrator backpack 4122 may be received in the internal cavity 4179. When the first housing portion 4170, the second housing portion 4172 and the bottom housing portion 4148 are connected to each other, they are configured to receive and support the interface 4010′ therein/thereon.

The second housing 4126″ may be configured to be coupled with the wire harness 4162 of the user interface 4164 of the concrete vibrator backpack 4122.

The procedures in which the interface 4010′ and the second housing 4126″ may be attached to the concrete vibrator backpack 4122 are explained below. In these procedures, the interface 4010′ and the second housing 4126″ are first connected to each other. The second housing 4126″ (with the interface 4010′) is connected to the concrete vibrator backpack 4122.

The second attachment feature 4128 (and the openings 4130) of the second housing 4126″ may be configured to attach the interface 4010′ to the concrete vibrator backpack 4122 in a second orientation (as shown in FIG. 338). The bottom housing portion 4148 of the second housing 4126″ may be positioned between (a) a combination of the first housing 4008′ and the interface 4010′ and (b) the concrete vibrator backpack 4122. In the second orientation, the interface 4010′ may be positioned in a generally angled orientation with respect to the horizontal axis and the vertical axis. In the second orientation, the interface 4010′ may be in a generally horizontal orientation. In the second orientation, the interface 4010′ may be positioned in a generally vertical orientation in use. In another embodiment, the orientation in use may vary based on application(s) of the tool. In yet another embodiment, the orientation in use may vary based on the use of the tool by user(s). The direction of attachment AD of the interface 4010′ to the concrete vibrator backpack 4122 may be perpendicular to the direction of insertion PID of the battery pack 4006 on to the interface 4010′.

As shown in FIG. 354, the concrete vibrator backpack 4122 may include a harness assembly 4199 that is configured to permit a user to mount the concrete vibrator backpack 4122 to the user's back. The concrete vibrator powerpack 4124 may include a harness assembly 4193. Referring to FIGS. 341 and 354, the second housing portion 4148 may include the harness assembly 4199. Referring to FIG. 341, the third housing portion 4174 may include an electronic control module.

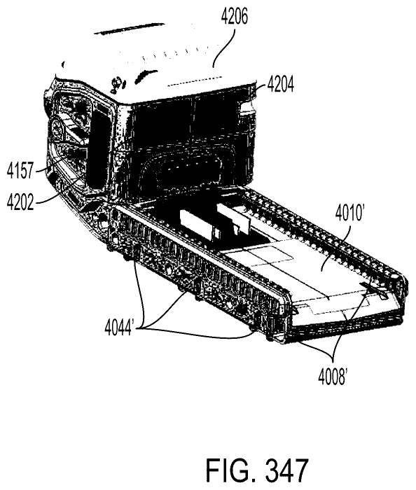

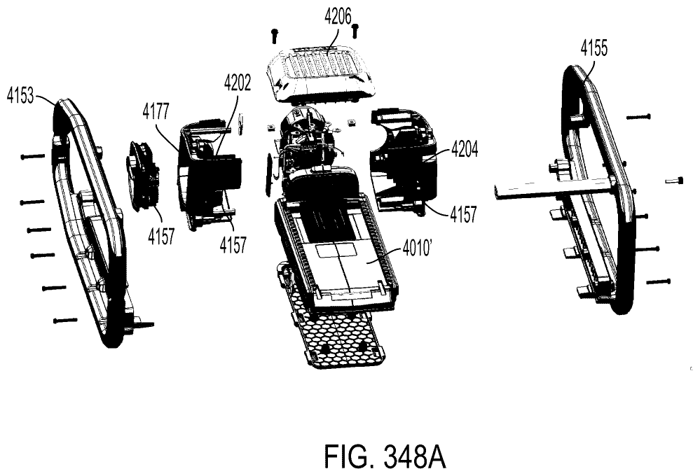

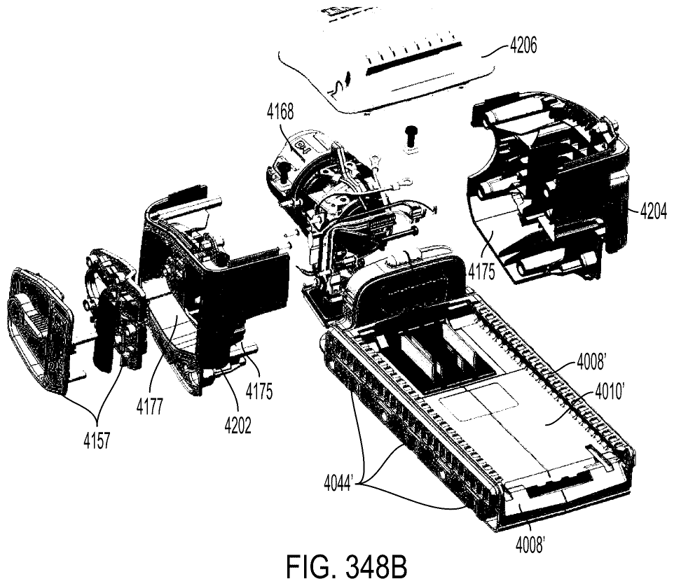

FIG. 346 shows a perspective view of the second cordless power tool 4036′ with the interface 4010′ mounted thereon. FIG. 347 shows show an assembled view of the portions of the second cordless power tool 4036′, the interface 4010′, and portions of the façade/outer housing 4126″. Referring to FIGS. 346 and 348A, the façade/outer housing 4126″ may also include façade/protection cage portions 4153 and 4155. Also, a control unit 4157 is shown in FIG. 348A. FIGS. 348A-351 show exploded views of the portions of the second cordless power tool 4036′, the interface 4010′, and portions of the façade/outer housing 4126″. The second cordless power tool 4036′ may be a vibrator powerpack 4124, as illustrated in FIGS. 346-351.

The second housing 4126″ may include a first housing portion 4202, a second housing portion 4204, a third housing portion 4206, and the bottom housing portion 4148. The first housing portion 4202, the second housing portion 4204, and the third housing portion 4206 may have inter-engaging portions to connect them together and/or they may be connected to each other using aligned holes/openings and fasteners. The first housing portion 4202, the second housing portion 4204, the third housing portion 4206, and portions of the bottom housing portion 4148 together form an internal cavity 4175 (as shown in FIG. 348B). The removably attachable portions 4168 of the concrete vibrator powerpack 4124 may be received in the internal cavity.

The protrusions 4208 on the bottom housing portion 4148 may be configured to engage with the set of holes 4038′ disposed on the core block 4026′ of the interface 4010′ so as to couple the interface 4010′ to the bottom housing portion 4148. The first housing portion 4202 may also include another internal cavity 4177 therein and a cover. The internal cavity 4177 of the first housing portion 4202 may receive some user engageable portions and their corresponding electronic modules therein. Some user engageable portions and their corresponding electronic modules may include the control unit 4157.

The second housing 4126″ may also include side housing members 4210. The side housing members 4210 of the second housing 4126″ may include the second attachment feature 4128 (and the openings 4130) that are configured to attach the interface 4010′ to the concrete vibrator powerpack 4124 in a second orientation (as shown in FIG. 346). There may not be anything on the side of the bottom housing portion opposed to the interface and the bottom housing portion may be simply connected to the first housing. In the second orientation, the interface 4010′ may be positioned in a generally angled orientation with respect to the horizontal axis and the vertical axis. In the second orientation, the interface 4010′ may be in a generally horizontal orientation. In the second orientation, the interface 4010′ may be positioned in a generally vertical orientation in use. The direction of attachment AD of the interface 4010′ to the concrete vibrator powerpack 4124 may be perpendicular to the direction of insertion PID of the battery pack 4006 on to the interface 4010′.

In another embodiment, the holes 4044′ of the first housing 4008′ may also be configured to attach the interface 4010′ to the concrete vibrator powerpack 4124 in the second orientation (as shown in FIG. 346).

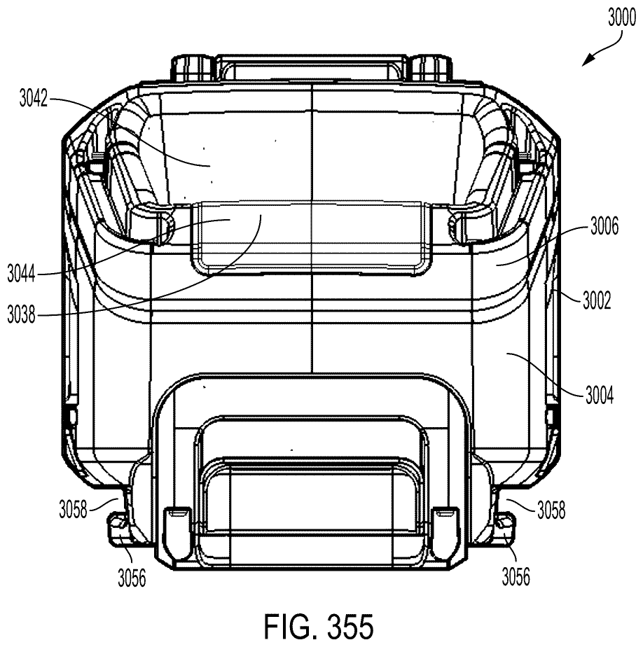

FIG. 355 shows a rear end view of a battery pack adaptor 3000 in accordance with an embodiment of the present patent application. The battery pack adaptor 3000 may interchangeably referred to as an adaptor or an electronic device.

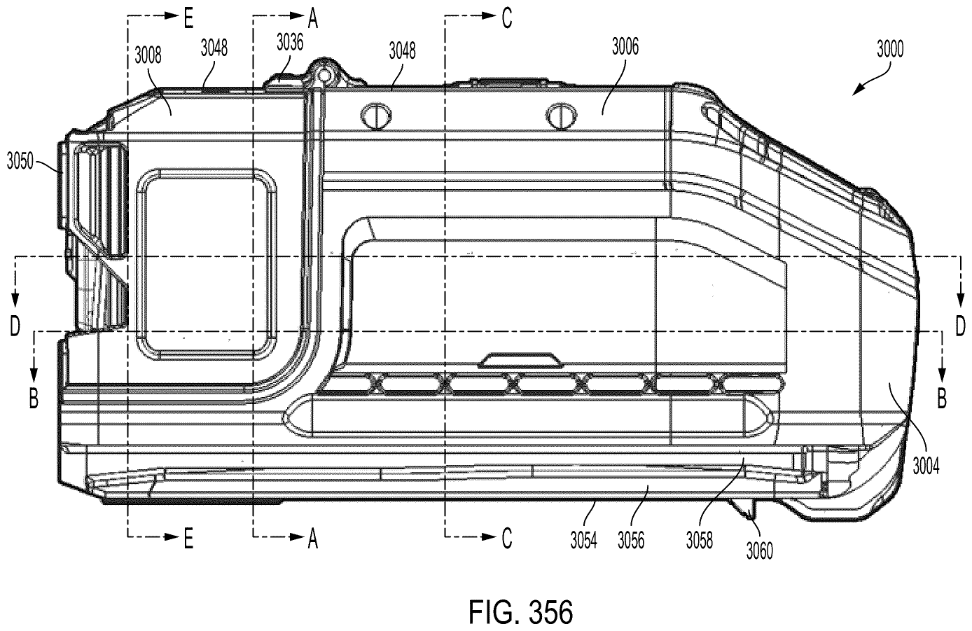

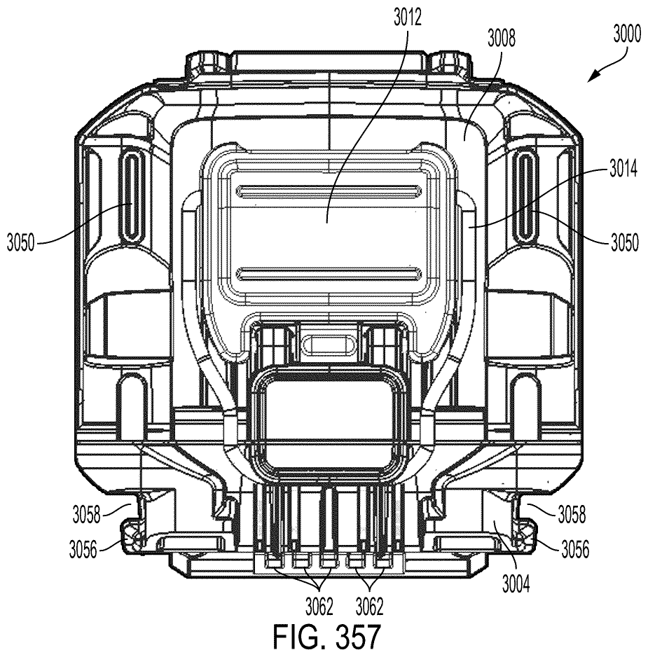

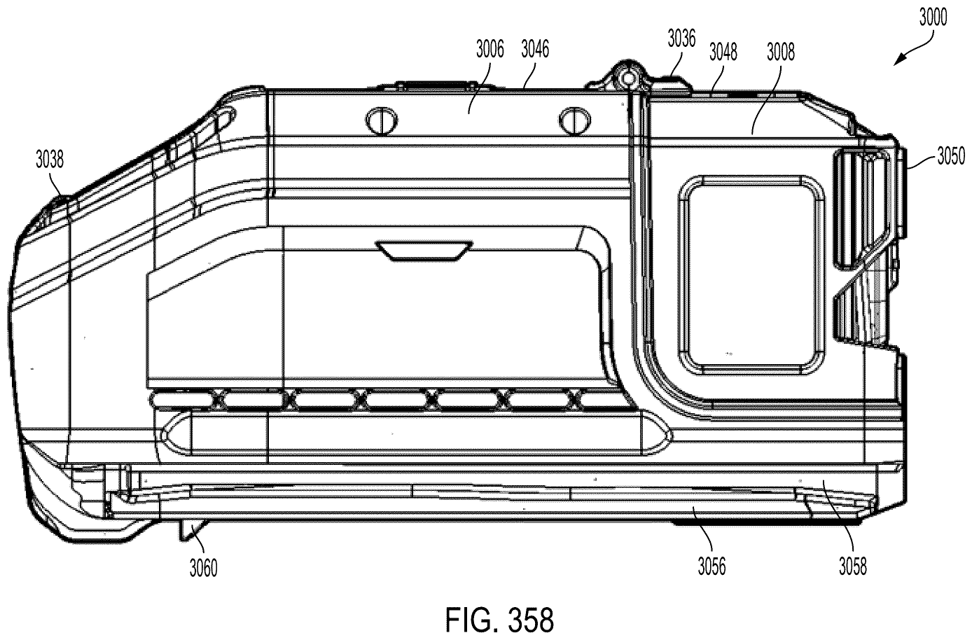

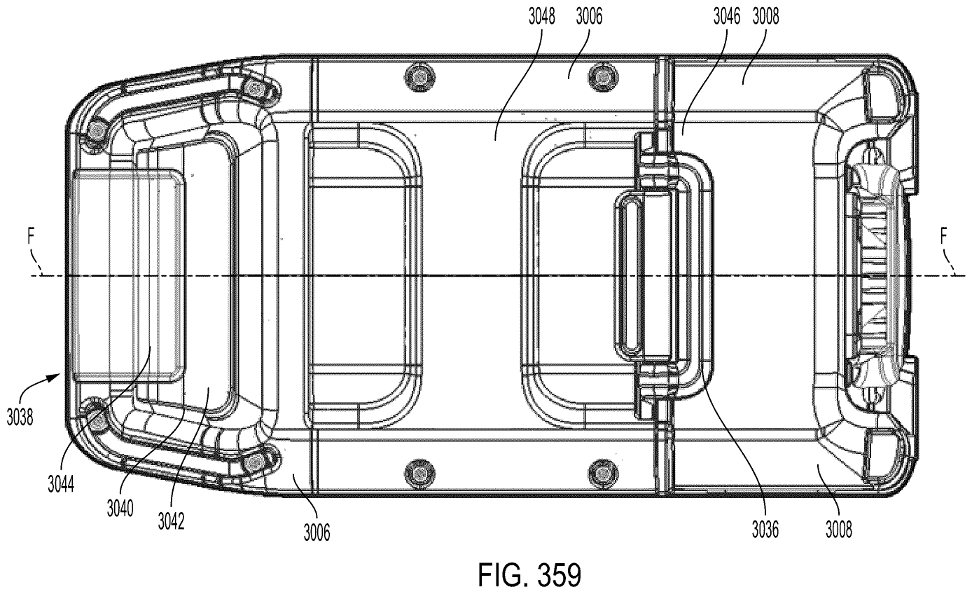

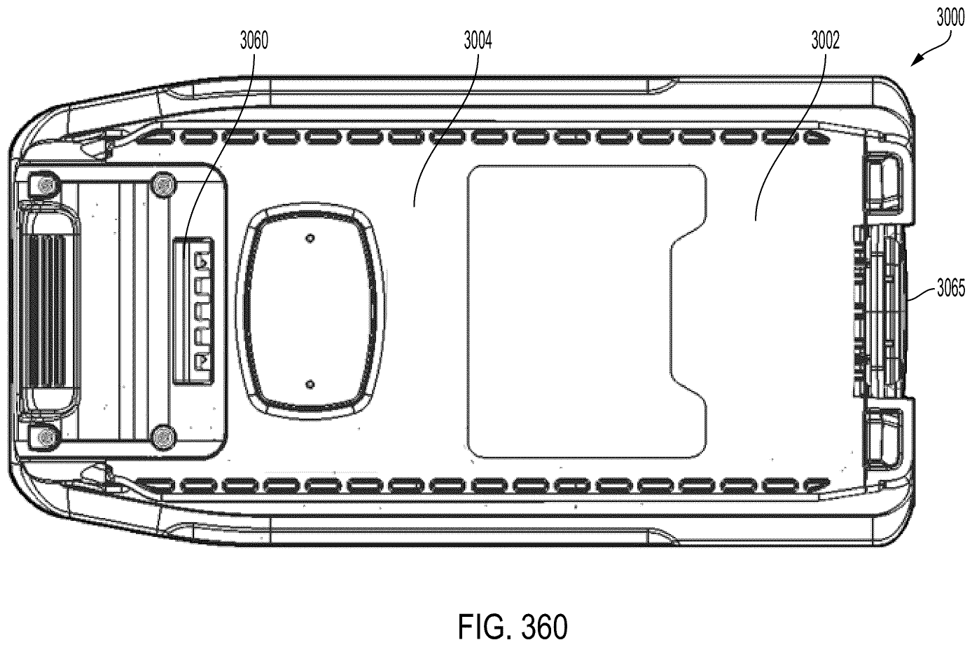

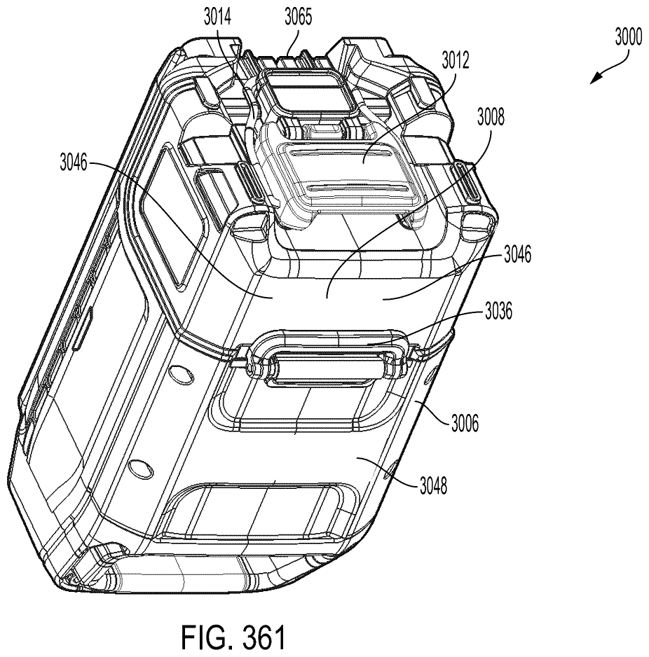

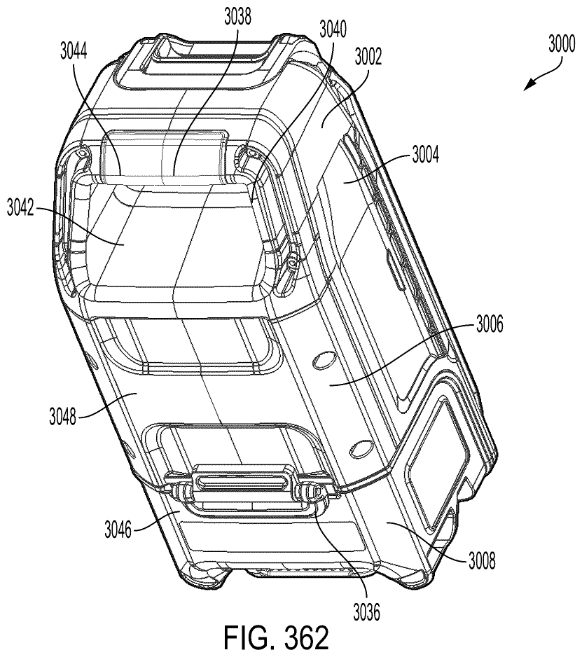

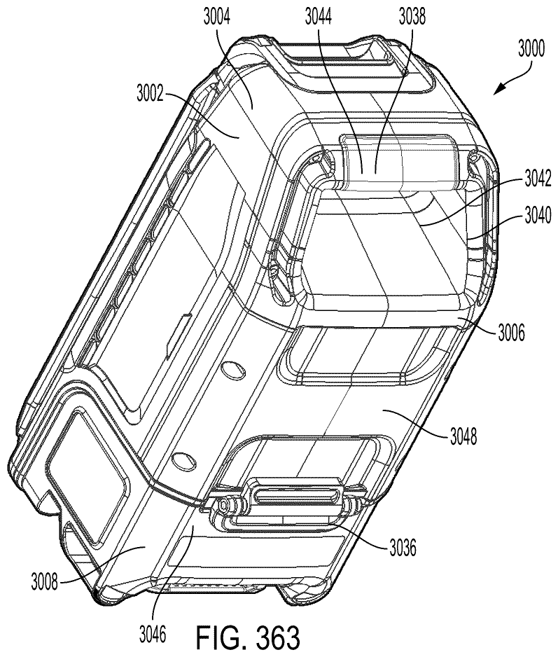

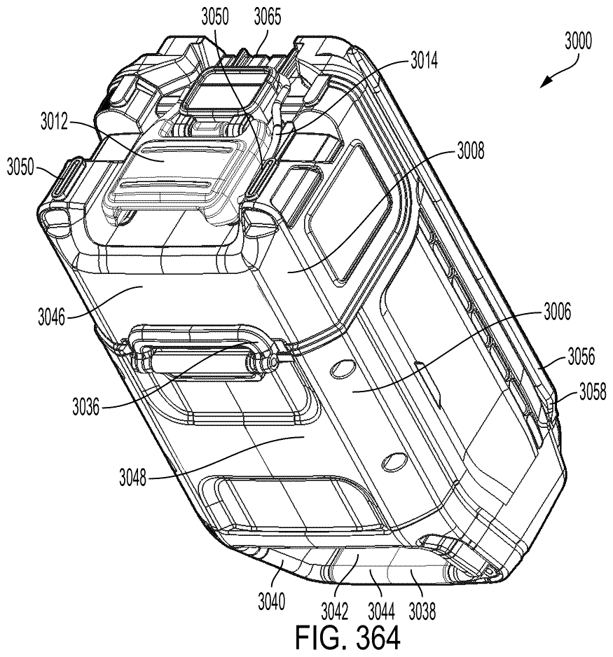

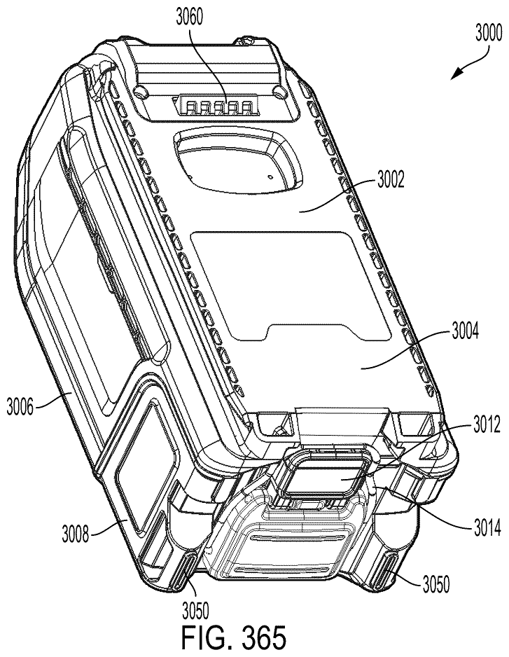

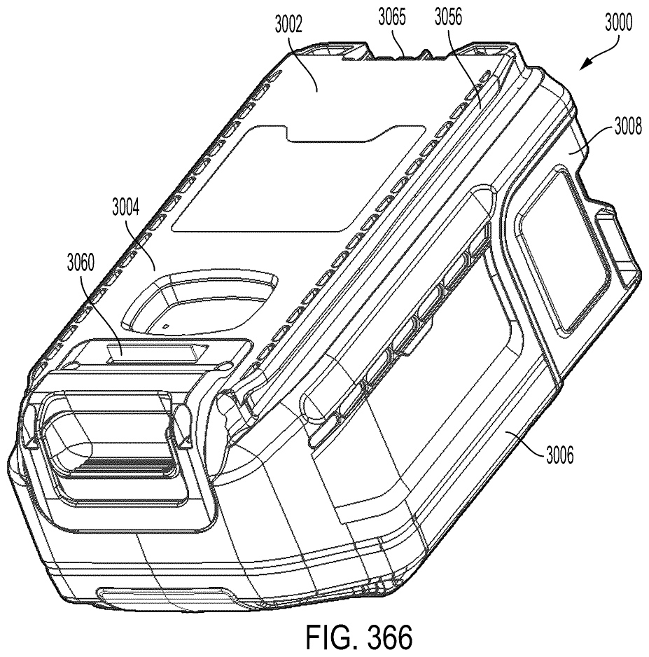

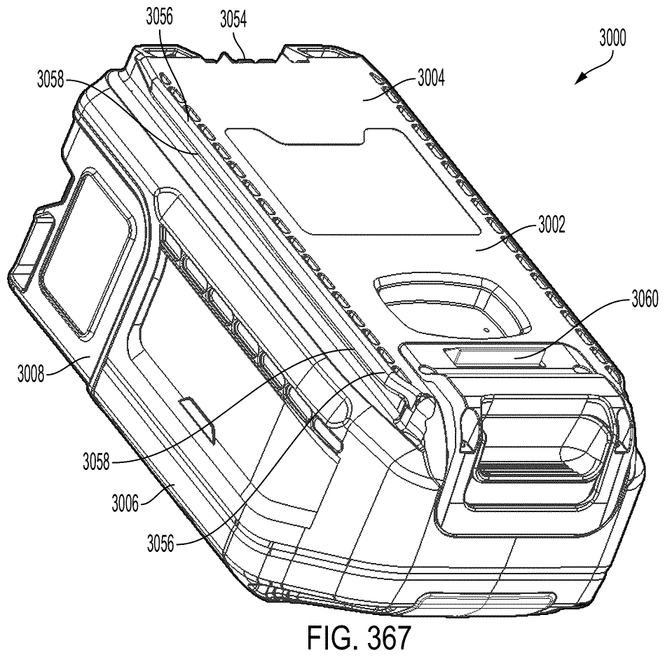

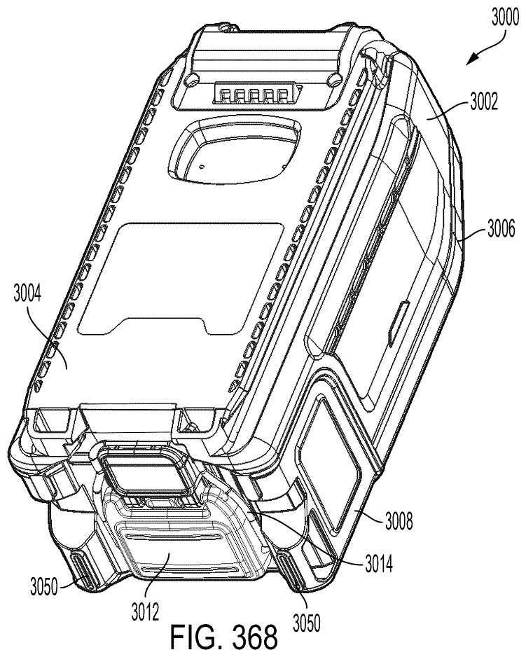

FIGS. 356, 357, 358, 359 and 360 show a left side view, a front end view, a right side view, a top elevational view, and a bottom elevational view, respectively, of the adaptor 3000. FIGS. 361-368 show perspective views of the of the adaptor 3000.

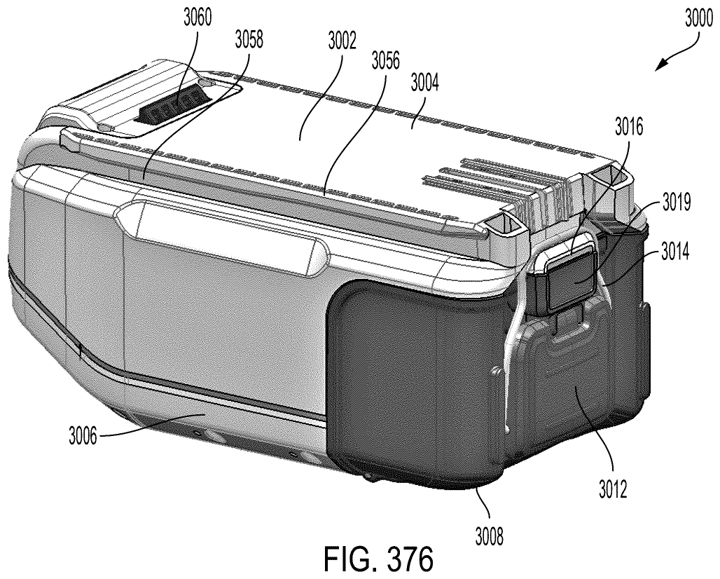

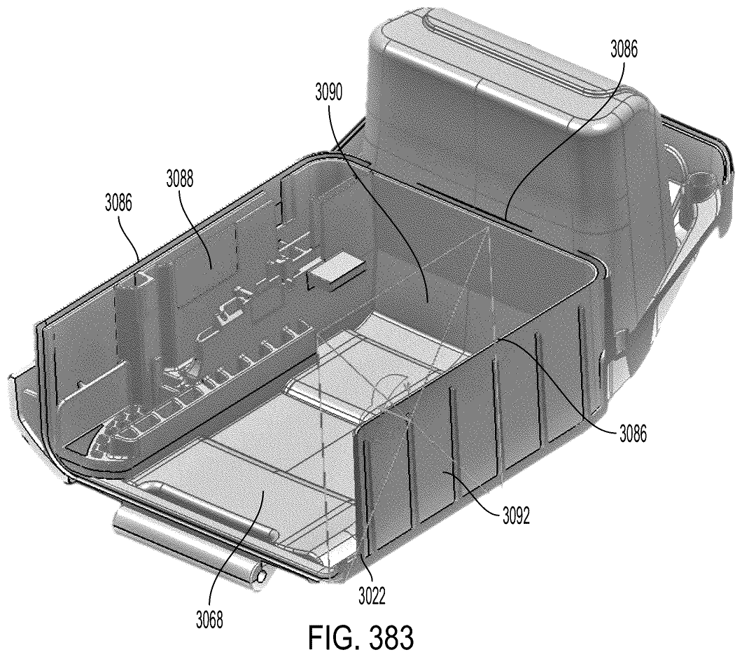

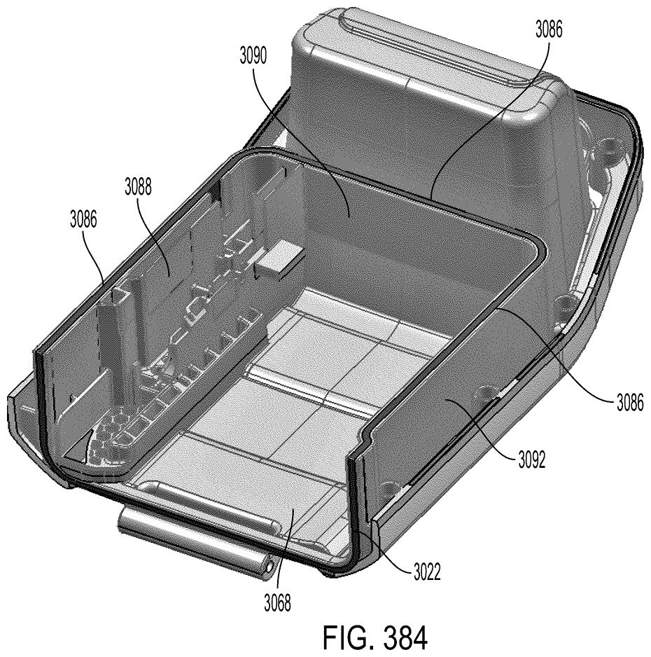

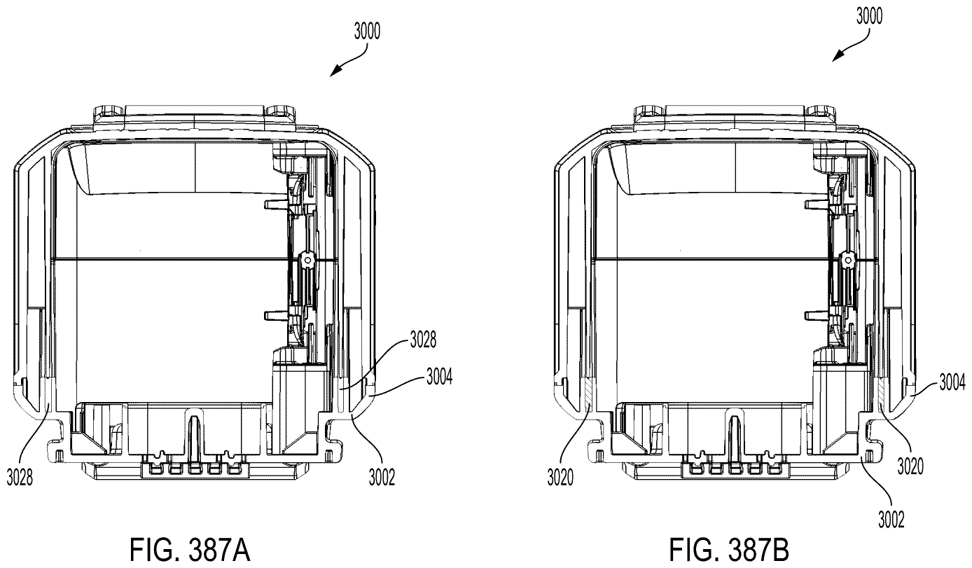

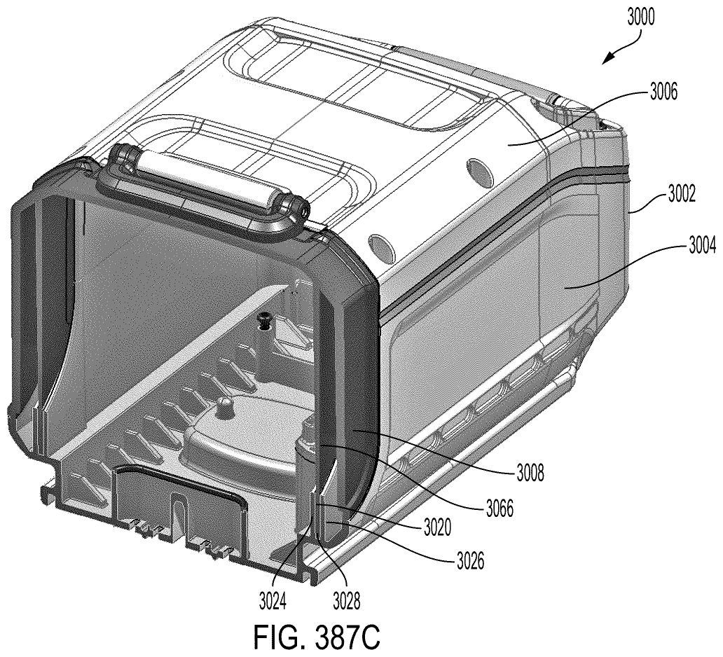

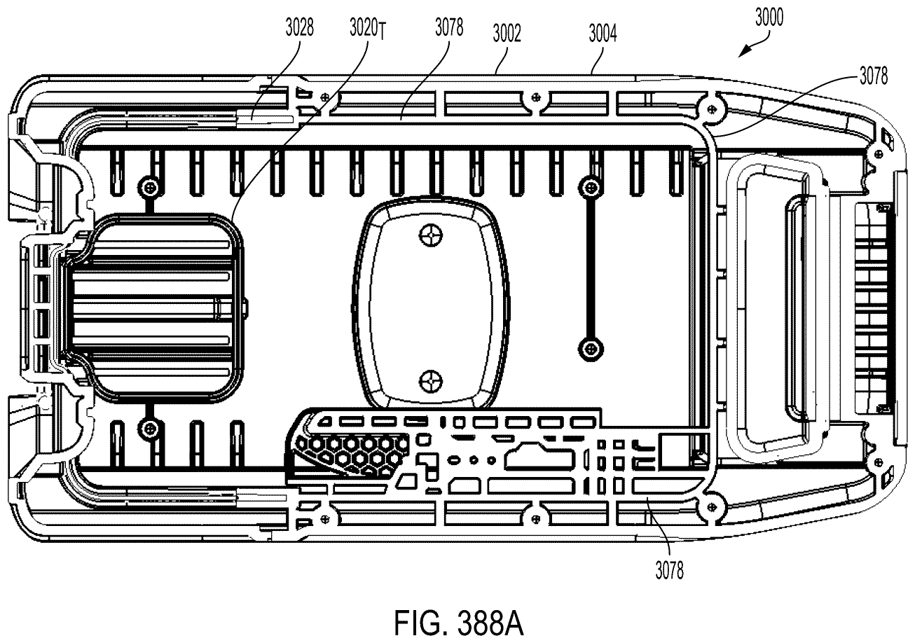

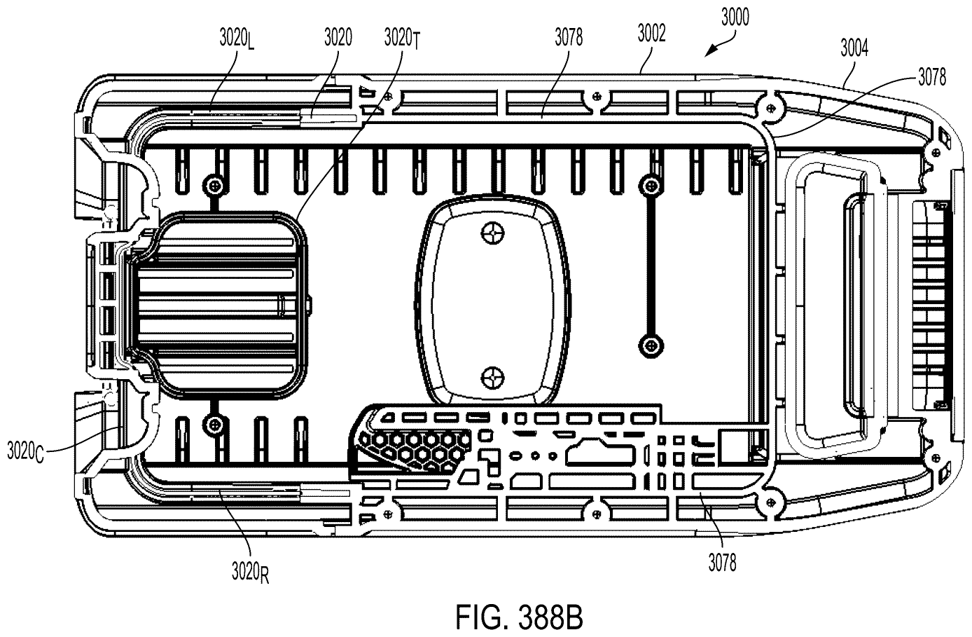

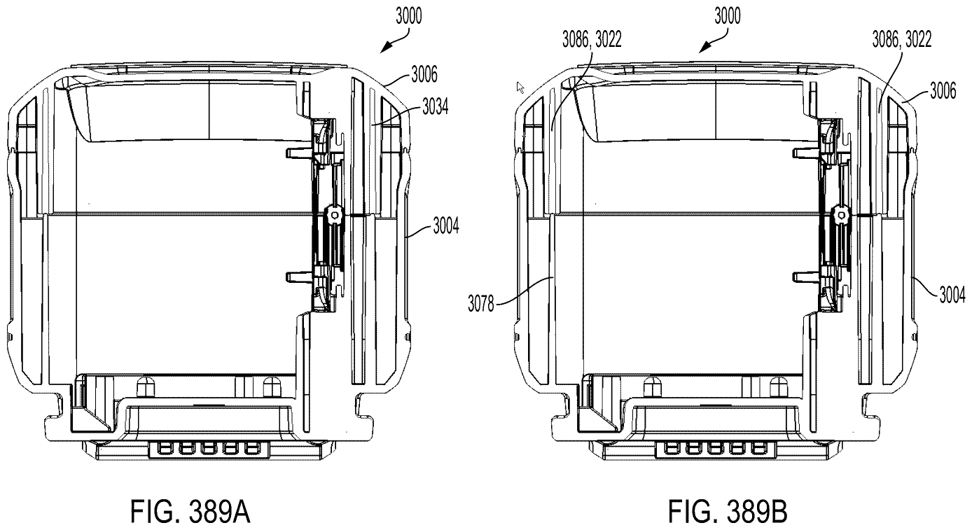

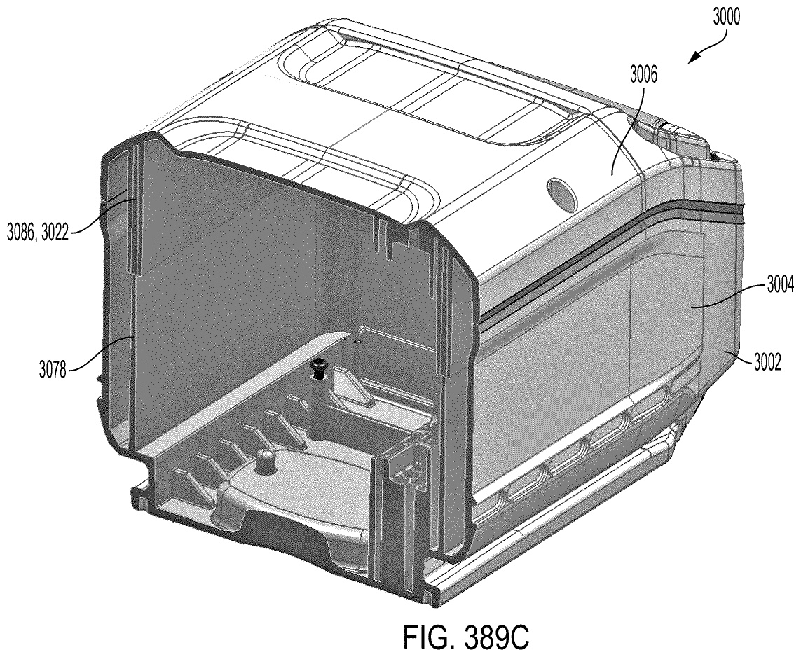

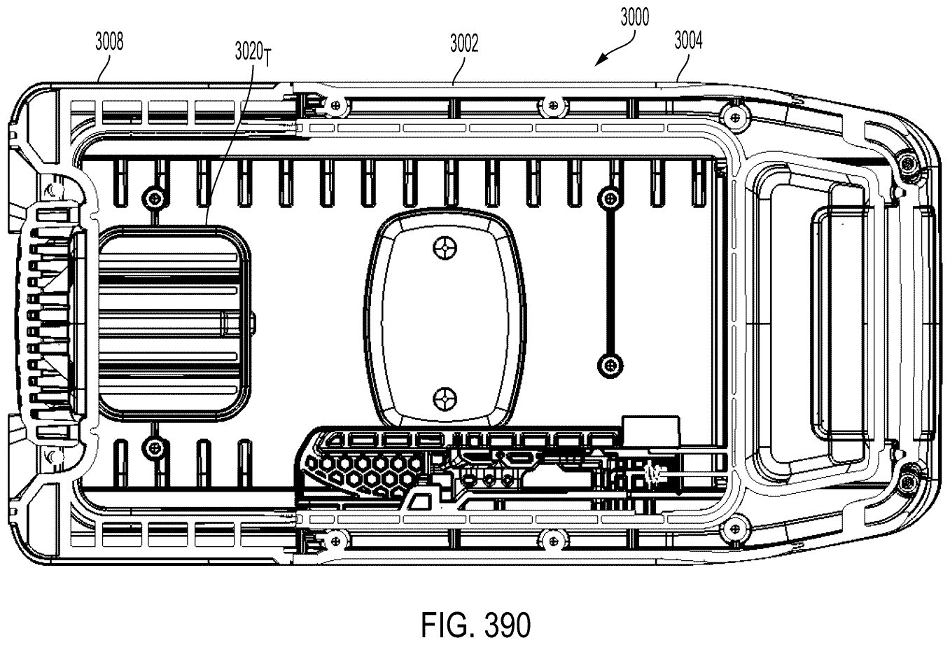

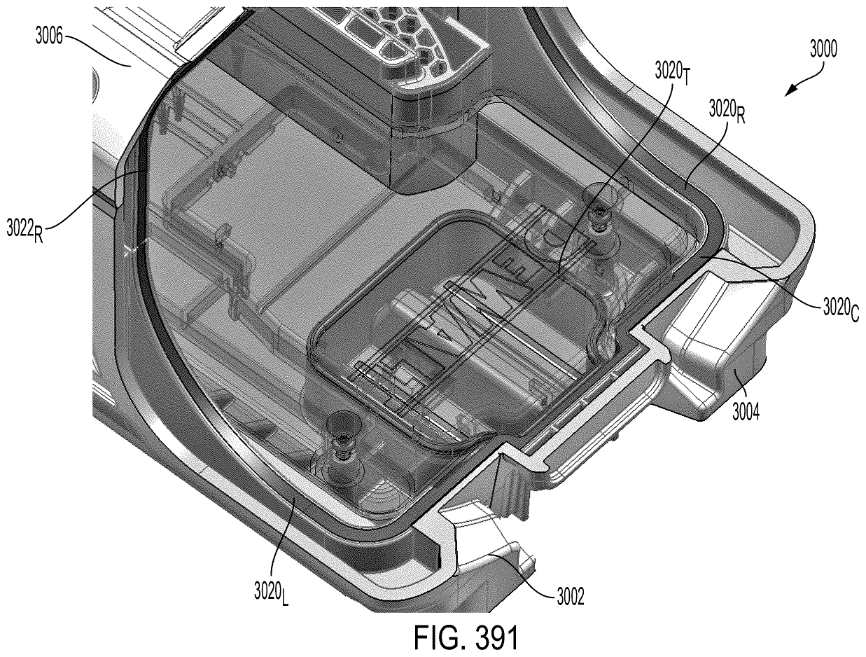

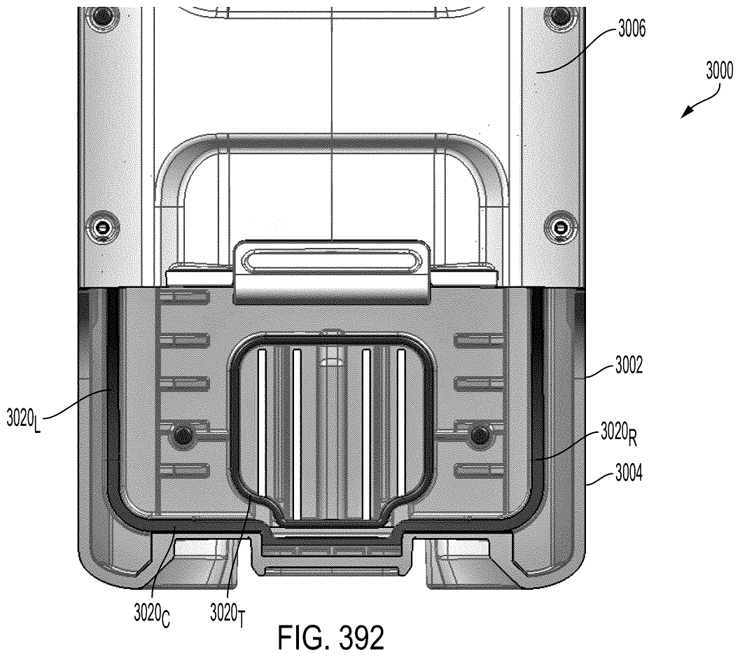

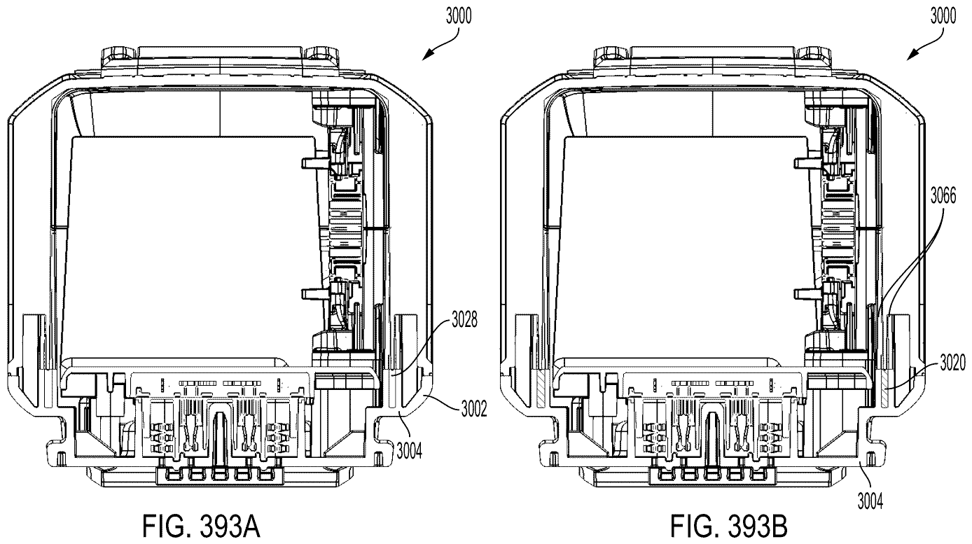

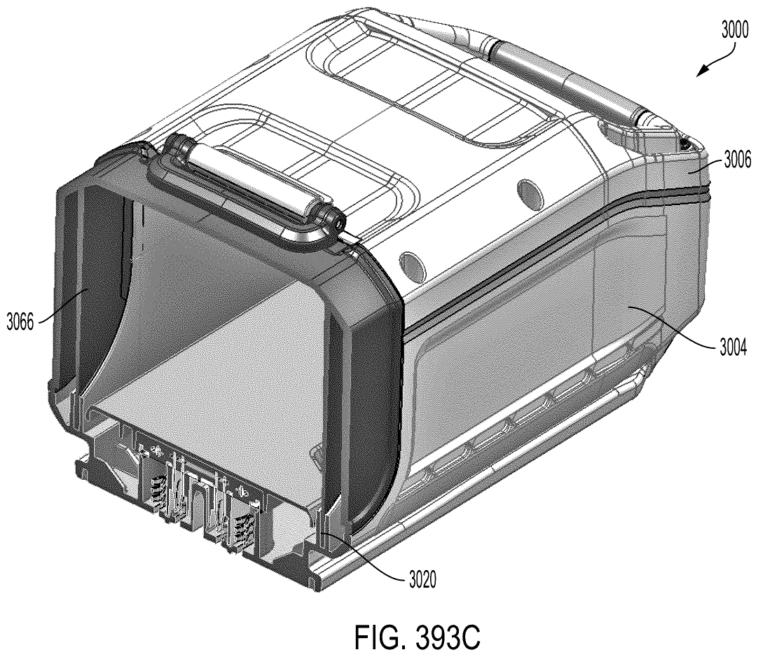

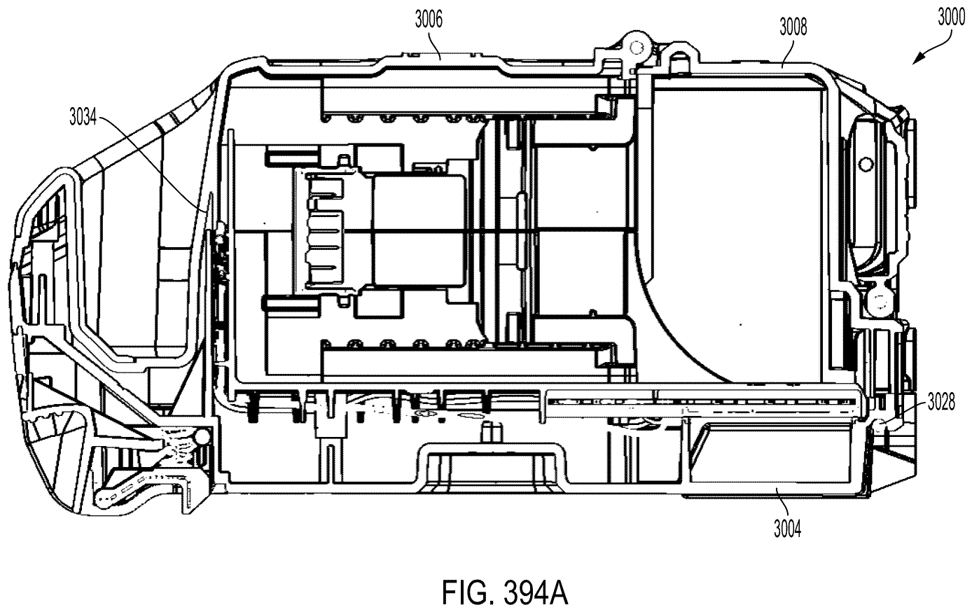

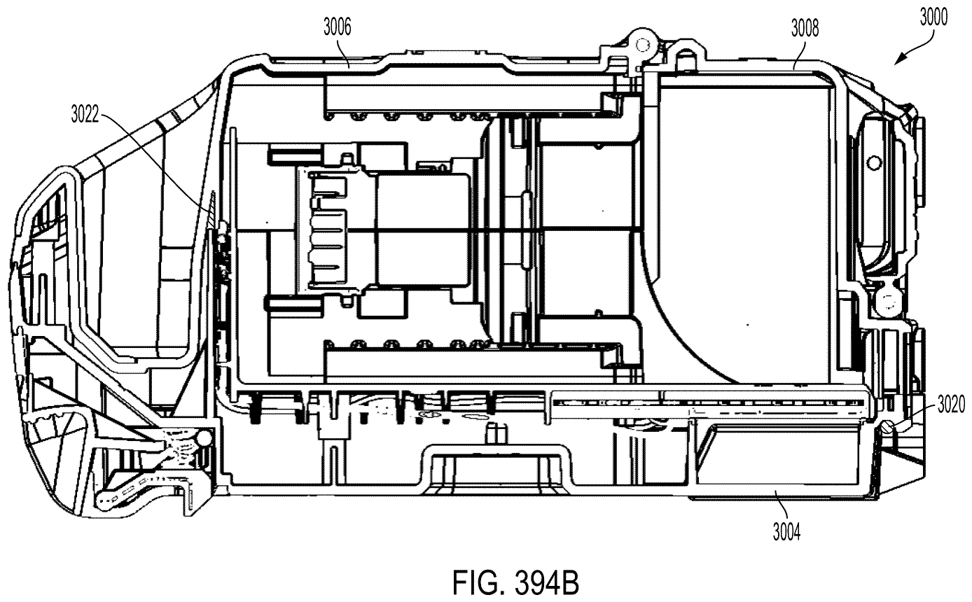

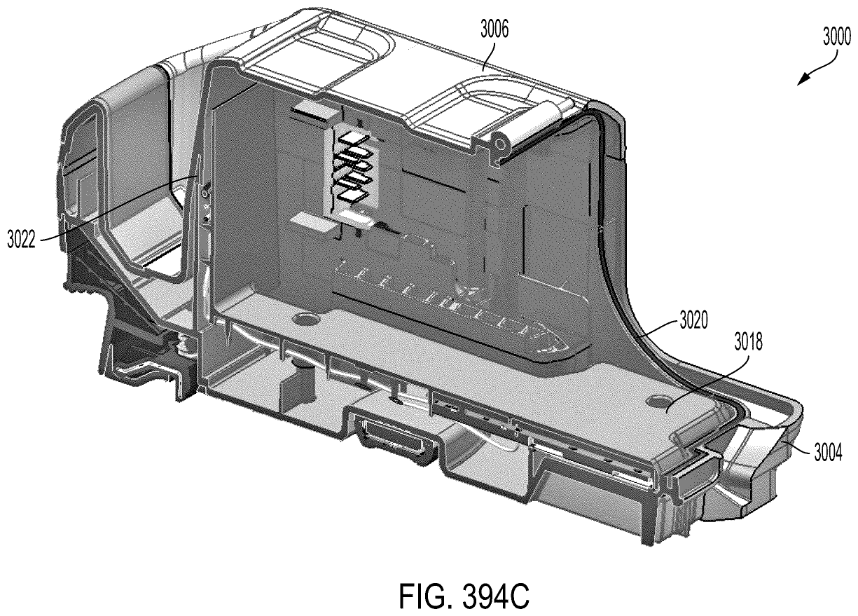

In one embodiment of the present patent application, referring to FIGS. 376-394C, the adaptor 3000 may include a housing 3002, a first gasket 3020, and a second gasket 3022. The housing 3002 may include a first portion 3004 and a second portion 3006 coupled to the first portion 3004. The housing 3002 may be formed of a material having a first durometer. The housing 3002 may also include an internal cavity 3010. The first portion 3004 of the housing 3002 may include an inner wall 3024 in the internal cavity 3010 and an outer wall 3026 in the internal cavity 3010. A first pocket space 3028 may be formed between the first portion outer wall 3026 and the first portion inner wall 3024. The first gasket 3020 may be formed of a material having a second durometer. The second durometer is lower than the first durometer. The first gasket 3020 may be insert molded in the first pocket space 3028. The second portion 3006 of the housing 3002 includes an inner wall 3030 in the internal cavity 3010 and an outer wall 3032 in the internal cavity 3010. A second pocket space 3034 is formed between the second portion outer wall 3032 and the second portion inner wall 3030. The second gasket 3022 may be formed of the material having the second durometer. The second gasket 3022 may be insert molded in the second pocket space 3034.

The adaptor 3000 may be configured to electrically interconnect a battery pack 3100 with an electrical apparatus, such as a power tool of a power tool system. That is, the adaptor 3000 may be configured to operatively couple the battery pack 3100 and the power tool. The battery pack 3100 may be the multi-voltage capable (low voltage/high voltage) battery pack MVBP, which has been described in detail in the discussions in the present patent application. The power tool may be the high-power, high-voltage power tool (HPHVPT), which has been described in detail in the discussions in the present patent application.

The adaptor 3000 may be operatively associated with the battery pack 3100 and (the housing of) the power tool to complete an electrical circuit between the battery pack and the motor (of the power tool) that is carried by the power tool housing. The battery pack 3100 may be a non-dedicated battery pack 3100 but has a voltage compatible with the HPHVPT. As used herein, the term “non-dedicated” as used to describe the battery pack shall mean any battery pack that was not particularly designed for use with a specific tool housing and therefore is not directly attachable to the power tool/power tool housing either physically or electrically. That is, the battery pack may be designed for use with a specific tool housing just not the tool housing that requires the adaptor. The power tool system/assembly may include a battery pack from a first power tool system and a power tool housing from a second power tool system. For example, the second power tool system may include the HPHVPT, the HVBP, and a high-voltage battery charger (HVC). The first power tool system may include the low-voltage power tool (LVPT), the LPHVPT, the LVBP, the MVBP, and/or the LVC. The adaptor 3000 may be configured to enable the MVBP of the first power tool system to output electrical energy. The adaptor 3000 may be configured to electrically interconnect the MVBP of the first power tool system with (the motor of) the HPHVPT of the second power tool system. The MVBP of the first power tool system may be a MVBP having a nominal voltage of 54V, as described in detail in the discussions above.

The battery pack 3100, the adaptor 3000 and the HPHVPT may all mechanically and electrically couple together. In this manner, the battery pack 3100 may be used to provide power to the HPHVPT through the use of the adaptor 3000. This may also allow an existing power tool to receive power from the battery pack 3100 without any modification to the existing power tool to enable the existing power tool to connect to the battery pack 3100 as long as the battery pack, the power tool and the adaptor all have a common interface. The adaptor 3000 may be, thus, used to allow the battery pack to provide power to the power tool without modification to either the battery pack or the power tool.

The adaptor 3000 may generally be configured to be used with battery packs having different configurations. The adaptor 3000 may be configured to enable a first battery pack or a second battery pack to connect to the power tool. For example, the first battery pack may have a first configuration. The first configuration may include a first physical configuration and/or a first electrical configuration. The second battery pack may have a second configuration. The second configuration may include a second physical configuration and/or a second electrical configuration. The second configuration may be different from the first configuration.

For example, the HPHVPT may be configured to use a single (or a first) HVBP as a power source. However, the adaptor 3000 may also serve to electrically connect a different (or a second) high-voltage battery pack (e.g., MVBP) to the housing of the HPHVPT so that the HPHVPT is supplied with the same or substantially the same voltage as the first HVBP. The adaptor 3000 may be configured to allow for backward compatibility. A user may use old/legacy battery packs (with the same or substantially the same voltage, for example, the MVBP) with the HPHVPT. The first HVBP may have a nominal voltage of 54 volts and the second MVBP may have a nominal voltage of 54 volts. A battery pack having the nominal voltage of 54 volts may also be referred to as a high-voltage battery pack. The first and second HVBPs and the MVBP may have different physical volumes. The first and second HVBPs and the MVBP may have the same battery cell configuration. The first and second HVBPs and the MVBP may have different battery cell configurations. The battery cell configurations may generally include pouch cell configuration, tabless cell configuration, or cylindrical cell configuration, etc. The first and second high-voltage battery packs may have different battery interfaces.

The low-voltage battery pack may comprise (at least) a predetermined number of cells connected in series. The high-voltage battery pack may comprise (at least) triple the predetermined number of cells connected in series.

The low-voltage battery pack may incorporate, for example, double the predetermined number of cells, rather than the predetermined number of cells. In this case, the double the predetermined number of cells may comprise the predetermined number of pairs of cells connected in parallel, and the predetermined number of pairs of parallel-connected cells are connected in series to output a voltage of 18 volts. Likewise, the high-voltage battery pack may incorporate, for example, six times the predetermined number of cells, rather than triple the predetermined number of cells. In this case, the six times the predetermined number of cells comprise triple the predetermined number of pairs of cells connected in parallel and triple the predetermined number of pairs of parallel-connected cells are connected in series to output a voltage of 54 volts. As will be understood, however, the terms low-voltage and high-voltage are relative terms and are merely meant to indicate two battery packs, which normally supply currents at different voltages.

The adaptor 3000 may include the housing 3002. The housing 3002 of the adaptor 3000 may include the first housing portion 3004, the second housing portion 3006, and a door 3008. The door 3008 may be interchangeably referred to as the third portion or third housing portion of the housing. The first and second housing portions may be interchangeably referred to as the first and second portions of the housing. One of the first housing portion 3004 or the second housing portion 3006 may form the base/bottom of the adaptor 3000. The other of the first housing portion 3004 or the second housing portion 3006 may form the top of the adaptor 3000. The battery pack 3100 may be enclosed in the adaptor 3000 (including the first housing portion 3004, the second housing portion 3006, and the door 3008). The first and second housing portions 3004, 3006 may together form the internal cavity 3010 in the adaptor 3000. The first portion 3004 and the second portion 3006 may form an opening to the internal cavity 3010. The door 3008 may be configured to cover the opening to the internal cavity 3010. The internal cavity 3010 may be configured to receive the battery pack 3100 therein. The battery pack 3100 may be received in the internal cavity 3010 of the adaptor 3000. The adaptor 3000 may be sized and configured to receive the battery pack 3100 having a nominal voltage of 54 volts in the internal cavity 3010 in the adaptor 3000.

The first, second and third housing portions 3004, 3006, 3008 may be formed from a plastic material or other material. The first, second and third housing portions 3004, 3006, 3008 may be formed from a hard plastic material. The first, second and third housing portions 3004, 3006, 3008 of the housing 3002 is formed of a material having a first durometer. The first, second and third housing portions 3004, 3006, 3008 may be formed by molding procedure. The first, second and third housing portions 3004, 3006, 3008 may be formed by injection molding procedure.

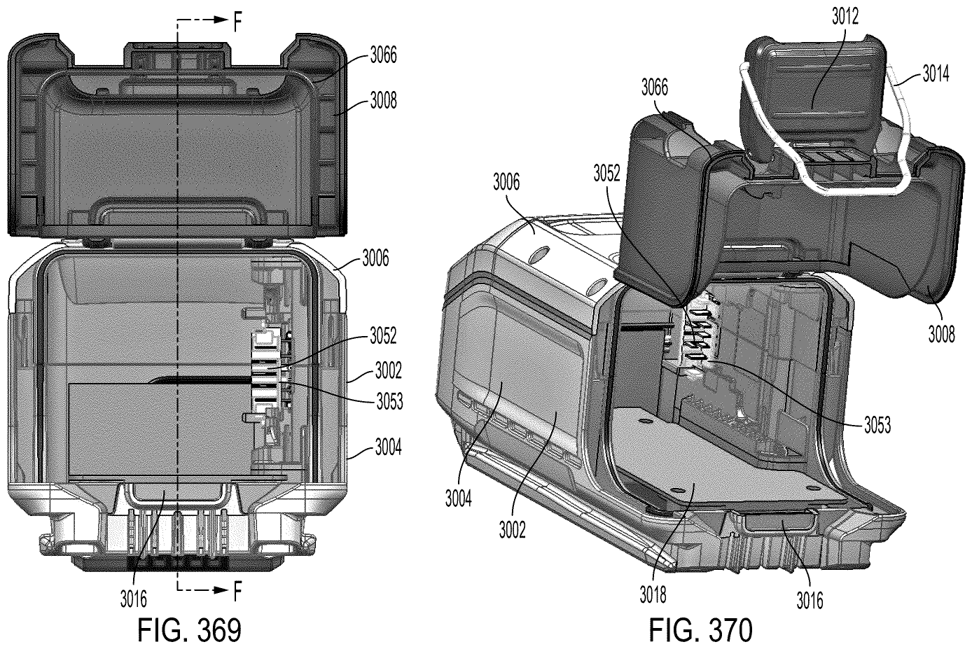

FIGS. 369-370 show the door 3008 of the battery pack adaptor 3000 in an open position, and the internal cavity 3010 in the housing 3002 ready to receive a battery pack (not shown here). FIG. 370 also shows an actuation lever 3012, an over center latch 3014, and a catch 3016. The catch 3016 may be disposed on portions of the housing 3002 and may be configured to engage with the over center latch 3014 disposed on the door 3008.

Referring to FIGS. 369-376, the third housing portion/door 3008 may be an access door, a movable door or a pivotable door. The door 3008 may be pivotally mounted for movement about a generally horizontal pivot axis between the open position in which the door 3008 allows access to the internal cavity 3010 of the adaptor 3000 and the closed position in which the door 3008 closes access to the internal cavity 3010 of the adaptor 3000. The door 3008 may be movably or hingedly attached/connected (e.g., via a pivot pin) to one of the first housing portion 3004 and the second housing portion 3006. In the illustrated embodiment, the door 3008 may be operatively connected to the second housing portion 3006. The door 3008 may be releasably connected/locked to the first housing portion 3004.

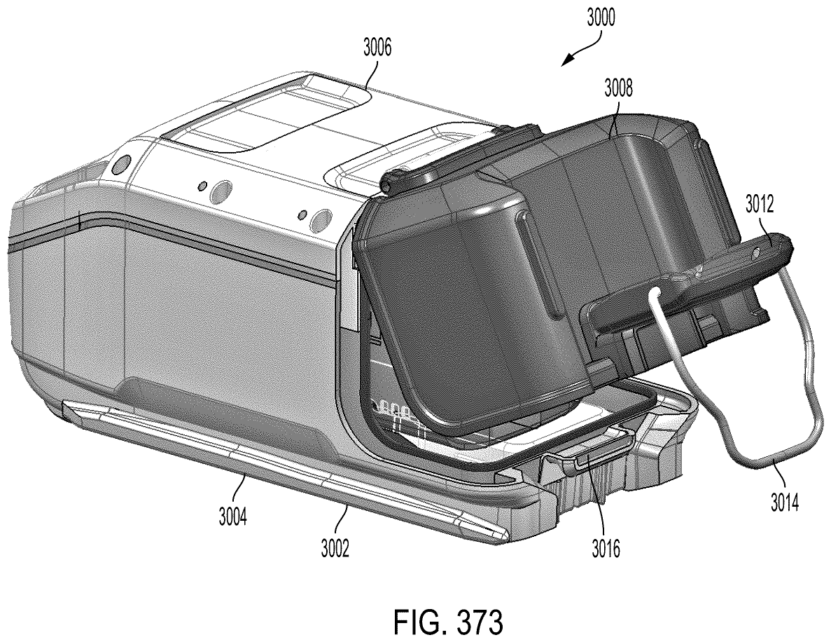

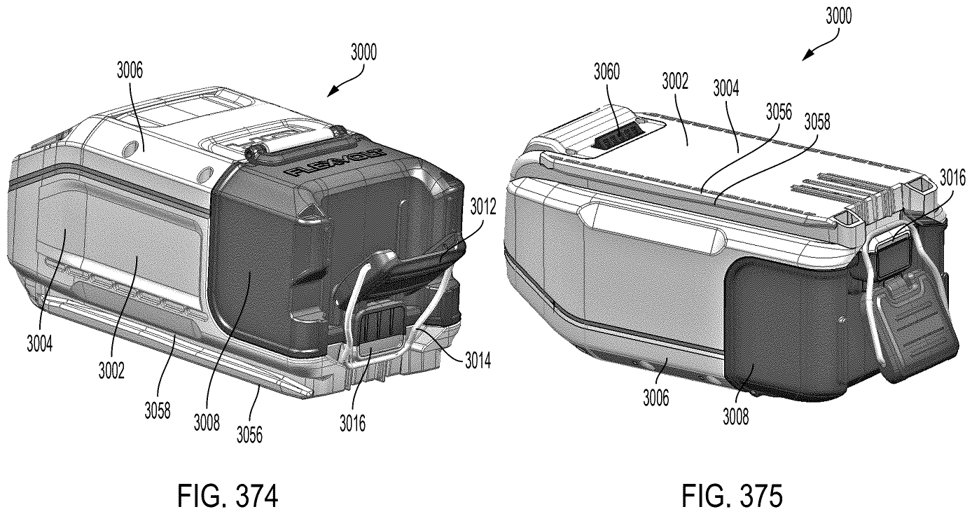

The door 3008 may be moved between the open position, the closed position, and one or more intermediate positions that are between the open and the closed positions. In the open position, the door 3008 may be configured to provide access to the cavity 3010 of the adaptor 3000 to either place/insert the battery pack 3100 in the cavity 3010 of the adaptor 3000 or remove the battery pack 3100 from the cavity 3010 of the adaptor 3000. In the closed position, the door 3008 may be configured to prevent access to the cavity 3010 of the adaptor 3000 and/or the battery pack 3100 positioned therein. The door 3008 may be moved between the closed position (as shown in FIGS. 374-378) and the open position (as shown in FIGS. 369-372), for example, using a hinge assembly/mechanism. FIG. 373 shows the battery pack 3100 received in the internal cavity 3010 of the housing 3002 and the door 3008 of the adaptor 3000 in an intermediate position of the door 3008 between the lowered, closed position and the raised, open position. The illustrated intermediate position is closer to the closed position of the door 3008. In one embodiment, a hinge assembly is designed to be installed on the door 3008. For example, a door hinge mechanism may be configured to mount the door 3008 for pivotal/swinging movement between at least the first (e.g., closed) and the second (e.g., open) positions. The pivoting door and the hinge mechanism for mounting them are well-known, and, therefore, are not described in detail here.

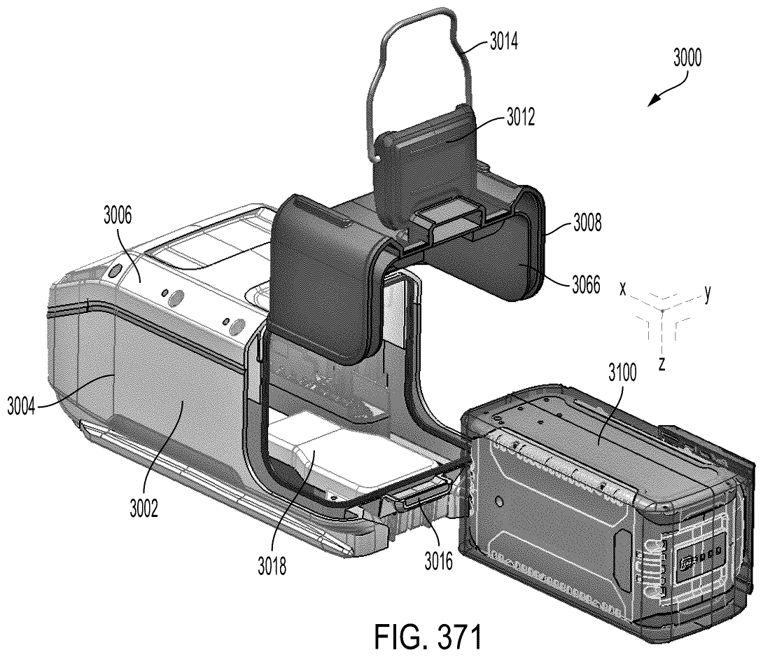

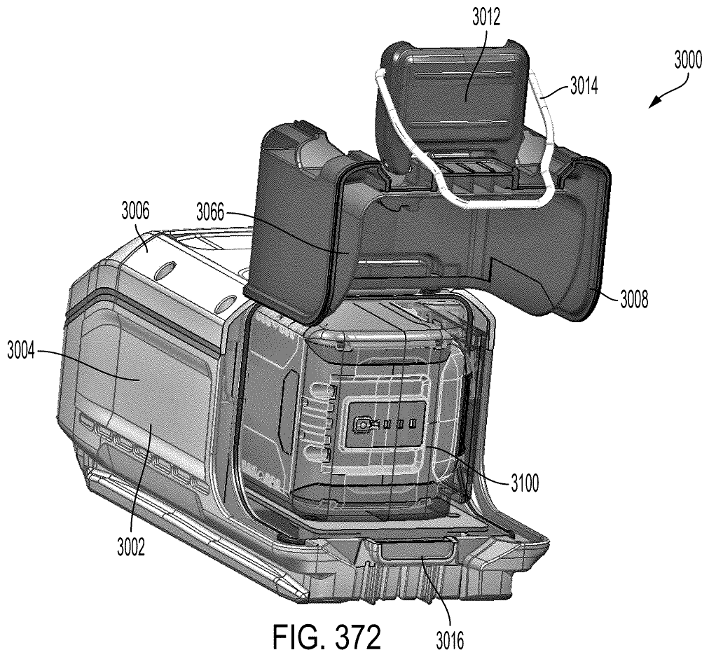

As shown in FIGS. 370-378, the adaptor 3000 may include a door latch that includes the actuation lever 3012 and the latch 3014 disposed on the door 3008 and the catch 3016 disposed on one of the housing portions 3004, 3006. In the illustrated embodiment, the catch/striker/receiver 3016 may be disposed on the first housing portion 3004 and the door 3008 may be pivotably connected to the second housing portion 3006. The latch 3014 may include a wire or a rod bent to form a loop. FIG. 370 shows that the door 3008, in its open position, with the actuation lever 3012 and the over center latch 3014. FIG. 370 also shows the adaptor 3000 without the battery pack 3100 received therein. FIG. 371 shows the battery pack 3100 being inserted into the internal cavity 3010 of the housing 3002. FIGS. 372-373 shows the battery pack 3100 after it is inserted into the internal cavity 3010 of the housing 3002, where the door 3008 is in its open position in FIG. 372 and where the door 3008 is in its intermediate portion in FIG. 373. FIGS. 374-376 show the door 3008 in the closed position and the over center latch 3014 of the door being coupled to the catch 3016 of the housing 3002 to retain the door 3008 in the closed position. FIG. 376 also shows chamfers 3019 to push out the latch 3014 with the power tool terminal block 3065. The face/chamfer 3019 may be configured to interact with the power tool terminal block 3065 to push out the adapter 3000 when the latching system 3060 is compressed to remove the adapter 3000 from the tool.

The door latch (i.e., the actuation lever 3012, the latch 3014 and the catch 3016) may be configured to releasably connect the door 3008 to one of the first portion 3004 and the second portion 3006. The door latch may be configured to lock the door 3008 when the door 3008 is in its closed position. For example, the latch 3014 may be configured to engage with the catch 3016. The door latch may include a draw latch or a toggle latch that is generally characterized by having a component (e.g., latch 3014) under consistent tension. The door latch may provide strong closing forces to maintain seals against leaks and ingress of dust and water into the adaptor 3000. The door latch may also be designed to prevent accidental release of the latch 3014. The door latch is engaged when both the latch 3014 and the catch 3016 are engaged with each other under tension. The latch 3014 may be attached to the actuation lever 3012, for example, through a pin. Tension is created or released when the actuation lever 3012 is pushed or pulled. The actuation lever 3012 may be designed to produce a mechanical advantage so that sufficient tension can be created while requiring minimal actuation force for releasing the latch 3014. The door latch may include an over center latch. The over center latch includes an over center position/point. When the actuation lever 3012 is moved past its over center position, the latch 3014 becomes activated. At this point, the closing force is provided by the latch 3014 and the catch 3016.

The adaptor 3000 may include a potting boat or support member 3018 in the cavity 3010. The potting boat 3018 may be configured to support the battery pack 3100 in the cavity 3010 of the adaptor 3000. The battery pack 3100 may be positioned on its side as it is being received on the support member 3018. The side positioned configuration of the battery pack 3100 allows the battery pack terminals to engage with the terminals 3052 of an adaptor battery pack terminal block 3053 (as shown in FIGS. 369-370) in the cavity 3010 of the adaptor 3000 when the battery pack 3100 is fully received in the adaptor 3000.

The housing 3002 of the adaptor 3000 may be configured to protect or store the battery pack 3100 from external shocks, separate from the housing of the battery pack 3100. The adaptor 3000 may include a pivot point 3036 for the door 3008. The pivot point 3036 may be provided on the housing 3002. The pivot point 3036 may be configured to lay flat against surface 3046 of the door 3008 or surface 3048 of the second housing portion 3006. The pivot point 3036 may be configured to be stored in a recess formed in the surface 3046 of the door 3008 or in the surface 3048 of the second housing portion 3006.

The adaptor 3000 may also include a handle 3038 that is integrally formed with the second housing portion 3006. The handle 3038 may include an inner wall 3040 defining an aperture 3042 between the second housing portion 3006 and the handle 3038. The aperture 3042 may be sized to receive a user's hand so that the user can grasp a grip portion 3044 of the handle 3038. The handle 3038 may be configured to enable a user to lift, carry or move the adaptor 3000 with or without the battery pack 3100 stored in the adaptor 3000.

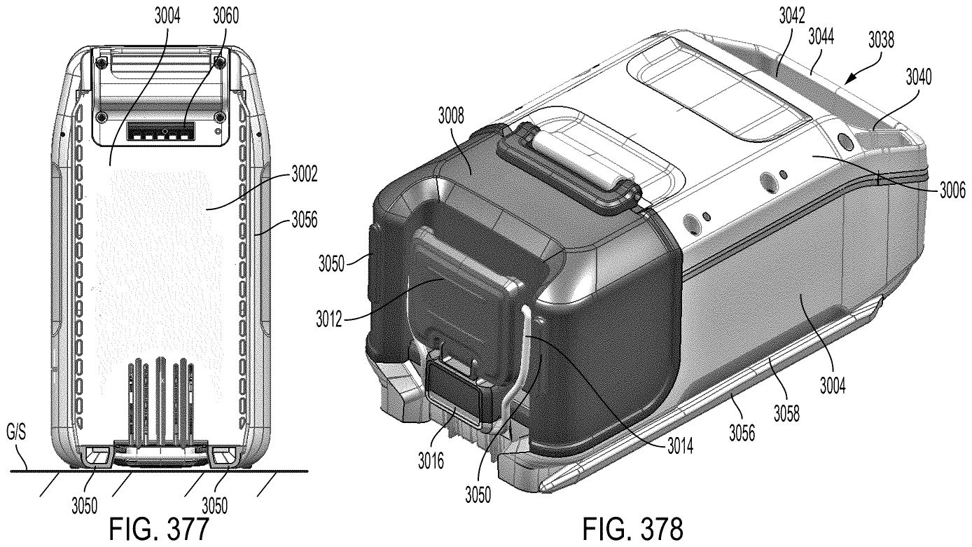

Referring to FIGS. 377-378, the adaptor 3000 may include a plurality of feet/support members 3050. The feet 3050 may be disposed on the door 3008 as shown in FIG. 378. The plurality of feet/support members 3050 may also be interchangeably referred to as the support base (i.e., in the form of feet-like protrusions on the door 3008). As shown in FIG. 377, the feet/support members 3050 may be configured to enable the adaptor 3000 to be supported or to stand on a surface S, such as the ground G, to avoid damage to the terminals 3064 of the adaptor tool terminal block 3065. For example, FIG. 377 shows the adaptor 3000 being positioned in a vertical configuration on the ground/surface G/S.

The adaptor 3000 may include the adaptor battery pack terminal block 3053 having a plurality of tool engaging terminals 3052 that are configured to engage with terminals of the battery pack 3100. The adaptor 3000 may be configured to receive the battery pack 3100 in the cavity 3010 therein. The battery pack 3100 may be configured to be placed (on its side) on the support member 3018 and slid into the cavity 3010 of the adaptor 3000. The battery pack 3100 may be configured to slide into the cavity 3010 of the adaptor 3000 until a latch system (having a first component disposed on the battery pack 3100 and a second components on the adaptor 3000) for fixing the battery pack 3100 to the adaptor 3000 is engaged, thus securing the battery pack 3100 to the adaptor 3000. The latch system may be optional. At the same time, electrical terminals/contacts of the battery pack 3100 may be configured to couple with electrical terminals/contacts 3052 in the adaptor 3000 to electrically couple the two components.

The adaptor 3000 may include the first set of electrical terminals 3052 that is connectable to the second set of electrical terminals of the battery pack 3100 so as to enable electrical connection between the battery pack 3100 and the adaptor 3000. The first set of electrical terminals 3052 may be disposed in the internal cavity 3010 of the housing 3002. The battery pack terminals may engage and mate with adaptor battery pack terminals 3052.

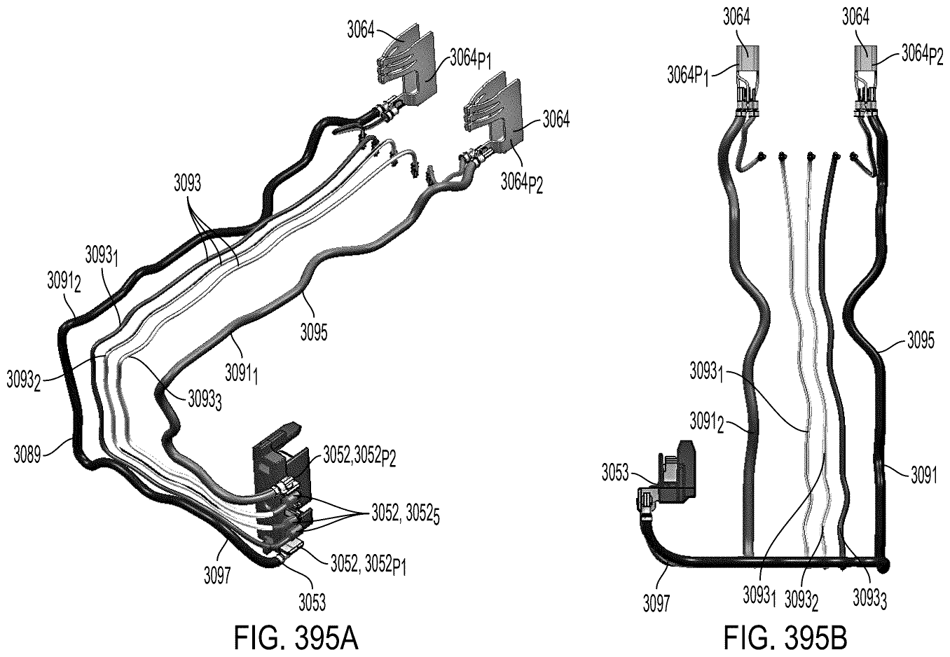

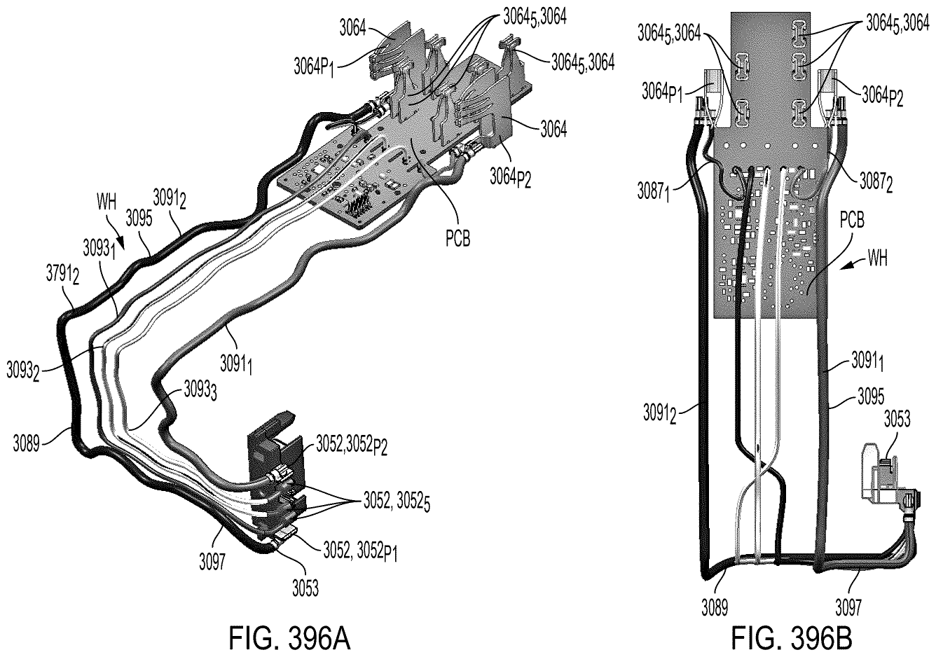

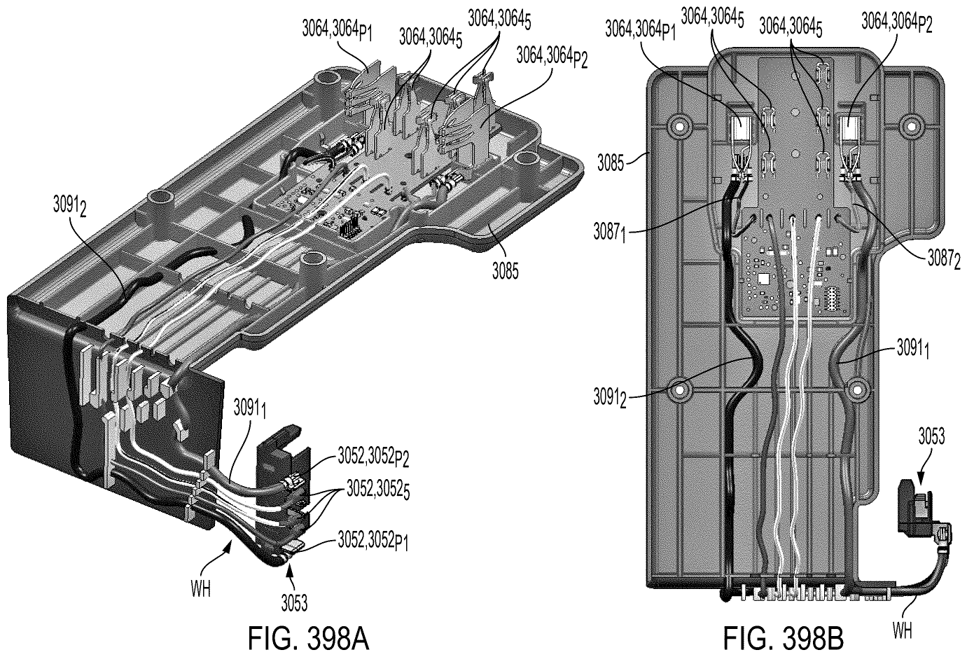

FIGS. 395A-395B show the first set of terminals 3052 of an adaptor battery pack terminal block 3053 that mates with terminals of the battery pack 3100 and terminals 3064 of an adaptor tool terminal block 3065 that mate with terminals of a power tool. At one end, power and signal wires of the wire harness WH are connected to the first set of terminals 3052 of the adaptor battery pack terminal block 3053 that mates with the terminals of the battery pack 3100. At the opposing end, the power wires of the wire harness are coupled to the power terminals 3064_{P} of the adaptor tool terminal block 3065 that mate with the power terminals of the power tool. FIGS. 396A-396B show the adaptor battery pack terminal block 3053, the power terminals 3064_{P} and the signal terminals 3064_{S} of the adaptor tool terminal block 3065, and a printed circuit board (PCB). The terminal ends (e.g., at the opposing end) of the signal wires of the wire harness WH and the signal terminals 3064_{S} of the adaptor tool terminal block 3065 are soldered to the PCB. Referring to FIGS. 395A-400B, the adaptor battery pack terminals 3052 may include adaptor battery pack power terminals 3052_{P} (two adaptor tool power terminals 3052_{P1} and 3052_{P2} are shown) and may include adaptor battery pack signal terminals 3052_{S} (three adaptor battery pack signal terminals 3052_{S} are shown). These adaptor battery pack terminals 3052 will be described in detail below.

The adaptor 3000 may include the adaptor tool terminal block 3065 having a plurality of tool engaging terminals 3064 that are configured to engage with terminals of a power tool. The housing 3002 of the adaptor 3000 may include a power tool interface 3054 (as shown in FIG. 356) configured for mechanically coupling with a corresponding battery pack interface (e.g., interface C) of an electrical device, for example, the HPHVPT or the HVC. The power tool interface 3054 of the adaptor 3000 may be disposed on the first housing portion 3004. The power tool interface 3054 of the adaptor 3000 may be designed to mimic the interface of a battery pack designed and configured to mate and operate with the power tool. The power tool interface 3054 of the adaptor 3000 may also include a rail and groove system including a pair of rails 3056 and a pair of grooves 3058. Other types of interfaces are contemplated and encompassed by the present patent application. The power tool interface 3054 of the adaptor 3000 may also include a latching system 3060 for fixing the battery pack adaptor 3000 to the HPHVPT or the HVC.

The housing 3002 of the adaptor 3000 may include a plurality of slots 3062 that correspond to a plurality of terminals of the electrical device (the HPHVPT or the HVC). The plurality of electrical device terminals may form a set of electrical device terminals. The electrical device terminals may be received by the battery adaptor terminal slots 3062 and engage and mate with adaptor tool terminals 3064. Referring to FIGS. 395A-400B, the adaptor tool terminals 3064 may include adaptor tool power terminals 3064_{P} (two adaptor tool power terminals 3064_{P1} and 3064_{P2} are shown) and may include adaptor tool signal terminals 3064_{S} (five adaptor tool power terminals 3064_{S} are shown). These adaptor battery pack terminals 3064 will be described in detail below.

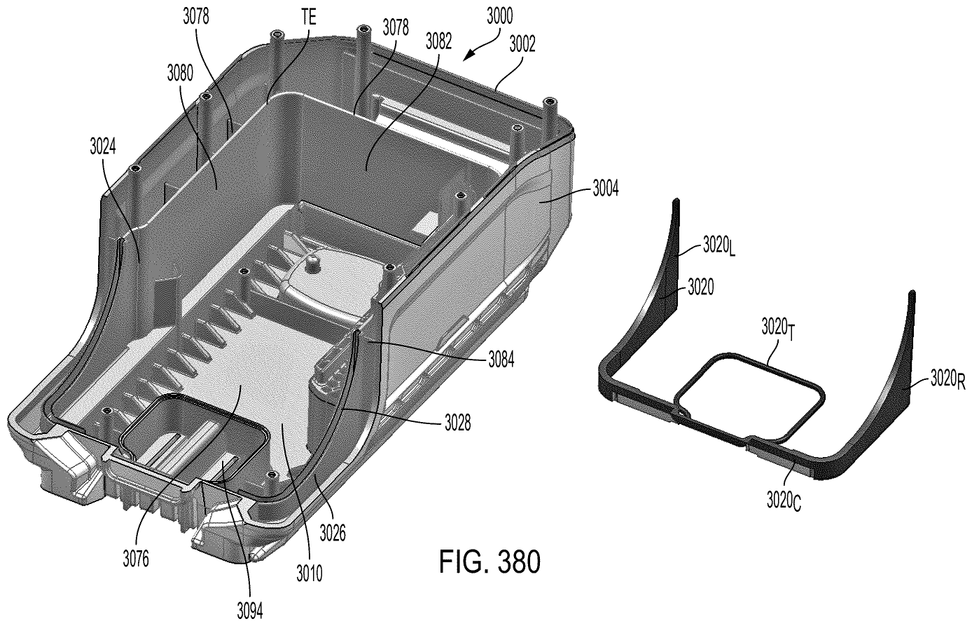

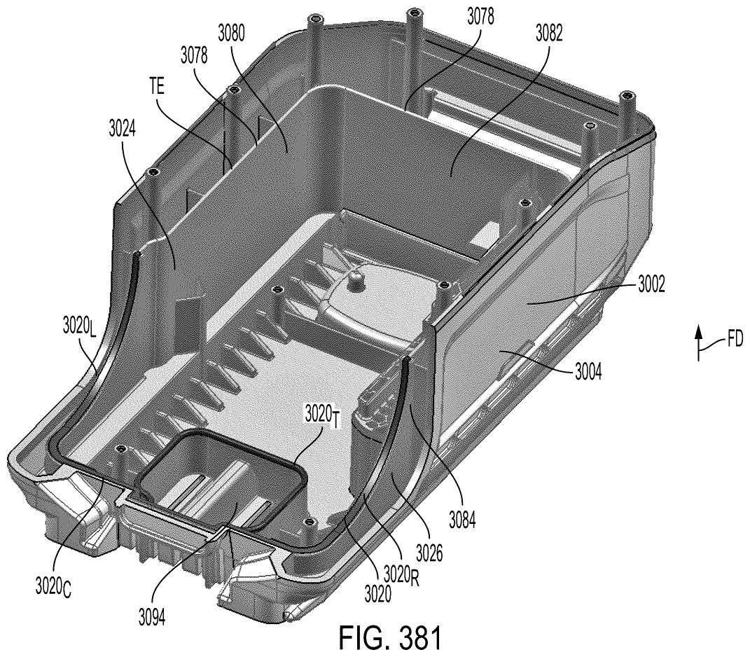

Referring to FIGS. 380-381, the first housing portion 3004 may include the inner wall 3024 and the outer wall 3026 in the internal cavity 3010. The first housing portion 3004 (including the inner wall 3024 and the outer wall 3026) is formed by a material having a first durometer. The first housing portion 3004 may also include a bottom wall 3076 connected to the inner wall 3024 and the outer wall 3026 in a U-shaped cross-sectional configuration with the pocket space 3028 formed between the inner and outer walls 3024, 3026. The inner wall 3024 and the outer wall 3026 may be formed of a high durometer material.

The first pocket space 3028 may be formed between the first portion outer wall 3026 and the first portion inner wall 3024 of the housing 3002. The first gasket 3020 may interchangeably referred to as a seal, an innermold or a seal member. The first gasket 3020 may be formed of a material having a second durometer.

The first gasket 3020 may include a first left gasket portion 3020_{L}, a first right gasket portion 3020_{R}, a first center gasket portion 3020_{C} and a first terminal gasket portion 3020_{T}. The first terminal gasket portion 3020_{T} may be configured to surround and seal the tool terminal portion 3094 of the adaptor 3000. The first left gasket portion 3020_{L}, the first right gasket portion 3020_{R}, and the first center gasket portion 3020_{C} may be configured to engage with the rib 3066 disposed/positioned on the door 3008 to form a sealed interface between the door 3008 and the first housing portion 3004 when the door 3008 is in its closed configuration.

The first housing portion 3004 may also include a rib/interlock wall/member 3078 (e.g., extending at least partially along two sides 3080, 3084 and completely along third side 3082 of the first housing portion 3004) that may be configured to engage with the gasket portions 3086 (e.g., extending along three sides 3088, 3090, 3092) of the second housing portion 3006 to form a sealed interface between the first and second housing portions 3004, 3006. The rib/interlock wall/member 3078 of the first housing portion 3004 may include the first durometer material. The gasket portions 3086 of the second housing portion 306 may include the second durometer material.

The first durometer material may be a hard durometer material. The first durometer material may be a high durometer material. The first durometer material may include glass filled nylon (GFN). The first durometer material may include polycarbonate (PC) material. The first durometer material may include Acrylonitrile Butadiene Styrene (ABS) material. The first durometer material may include a high/hard impact plastic material. The first (hard) durometer material may be any material that has a shore A durometer higher than the shore A durometer of the second durometer material. In one embodiment, the first durometer material may have a Shore A durometer of 80, while the second durometer material may have a Shore A durometer of 60.

In another embodiment, the first durometer material may have a Shore A durometer of 60, while the second durometer material may have a Shore A durometer of 50. The second durometer may be lower than the first durometer. The second durometer material may be a low durometer material. The second durometer material may be soft durometer material. The second durometer material may include a thermoplastic elastomer (TPE) material. The second durometer material may include a rubber material.

The first gasket 3020 may be insert molded in the first pocket space 3028. The first gasket 3020 may be formed by a molding procedure, for example, an injection molding procedure in the first pocket space 3028 formed between the first portion inner wall 3024 and the first portion outer wall 3026.

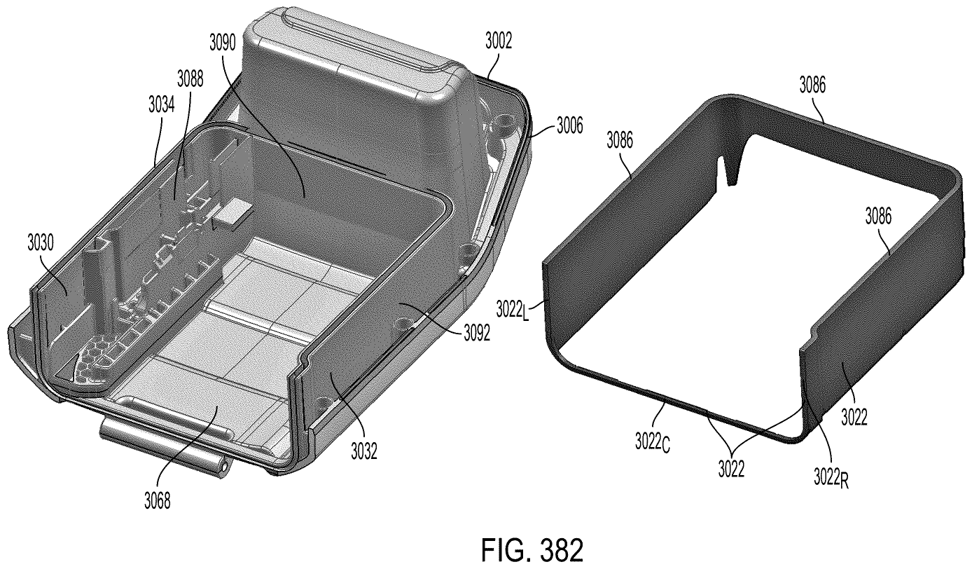

Referring to FIGS. 382-384, the second portion 3006 of the housing 3002 may include the inner wall 3030 and the outer wall 3032 in the internal cavity 3010. The second pocket space 3034 may be formed between the second portion outer wall 3032 and the second portion inner wall 3030. That is, the inner wall 3030 and the outer wall 3032 may at least in part define/form the second pocket space 3034. The pocket space may be interchangeably referred to as a pocket, a space, or a chamber. The second housing portion 3006 may also include a bottom wall 3068 connected to the inner wall 3030 and the outer wall 3032 in a U-shaped cross-sectional configuration with the pocket space 3034 formed between the inner and outer walls 3030, 3032. The inner wall 3030 and the outer wall 3032 may be formed of a high durometer material.

The second portion 3006 may include a seal assembly including the second gasket 3022 and its corresponding second pocket space 3034. As will be clear from the discussions below, the second gasket 3022 may include seal/gasket members 3022_{R}, 3022_{L}, 3022_{C}, and 3086. The second gasket 3022 may be formed by an injection molding process. The second gasket 3022 may be formed by an injection molding process of a low durometer material in the pocket/chamber/space 3034 of the seal assembly.

The second gasket 3022 may be formed of the material having the second durometer. The second gasket 3022 may be interchangeably referred to as a seal, an innermold or a seal member. The second gasket 3022 may be insert molded in the second pocket space 3034. The second gasket 3022 may be formed by a molding procedure, for example, an injection molding procedure in the second pocket space 3034 formed between the second portion inner wall 3030 and the second portion outer wall 3032.

The second gasket 3022 may include the second left gasket portion 3022_{L}, the second right gasket portion 3022_{R}, and the second center gasket portion 3022_{C}. The second left gasket portion 3022_{L}, the second right gasket portion 3022_{R}, and the second center gasket portion 3022_{C} may be configured to engage with the rib 3066 disposed/positioned on the door 3008 to form a sealed interface between the door 3008 and the second housing portion 3004 when the door 3008 is in its closed configuration.

The second gasket 3022 may also include the gasket portions 3086. The gasket portions 3086 extend along three sides 3088, 3090, 3092 of the second housing portion 3006 and engage with the rib/interlock wall/member 3078 of the first housing portion 3004 so as to form a sealed interface between the first and second housing portions 3004, 3006.

The innermold seal 3020, 3022 with a soft durometer seal may allow for the reduction of water and particulate ingress while being a permanent feature of the adaptor 3000. This may reduce part complexity while upholding the need for a seal for contamination ingress.

The second housing portion 3006 may be configured to be mated with first housing portion 3004 at a mating line ML. A seal may be formed between the first housing portion 3004 and the second housing portion 3006 at the mating line ML. One of the first housing portion 3004 and the second portion 3006 include the rib 3078 along at least a portion of the mating line ML and the other of the first housing portion 3004 and the second housing portion 3006 may include the injection molded gasket (i.e., gasket portions 3086) along at least a portion of the mating line ML. The rib 3078 may be interchangeably referred to as interlock element/wall.

In the illustrated embodiment, the rib 3066 of the door 3008 may be configured to engage the first gasket 3020 insert molded into the first pocket space 3028 of the first portion 3004 of the housing 3002 and engage the second gasket 3022 insert molded into the second pocket space 3034 of the second portion 3006 of the housing 3002.

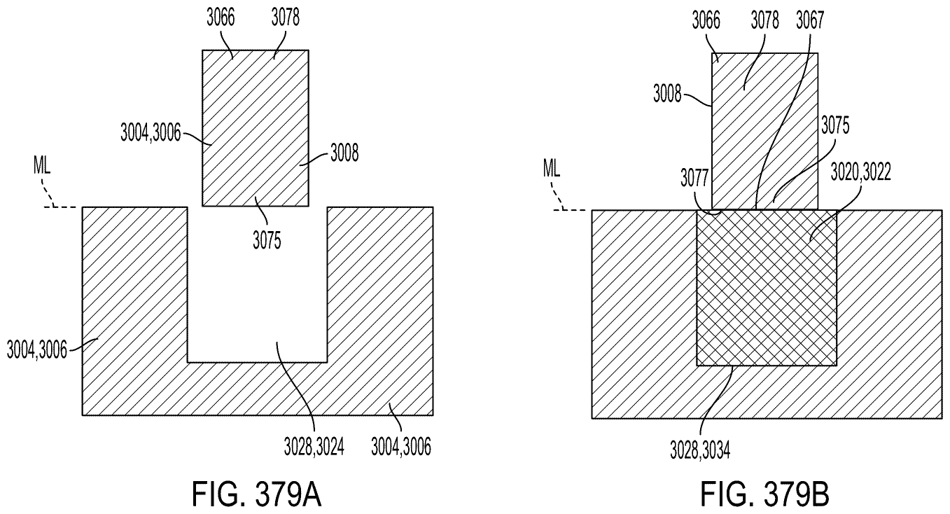

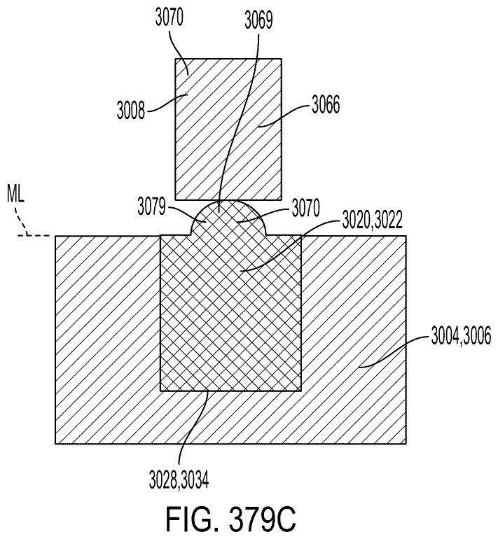

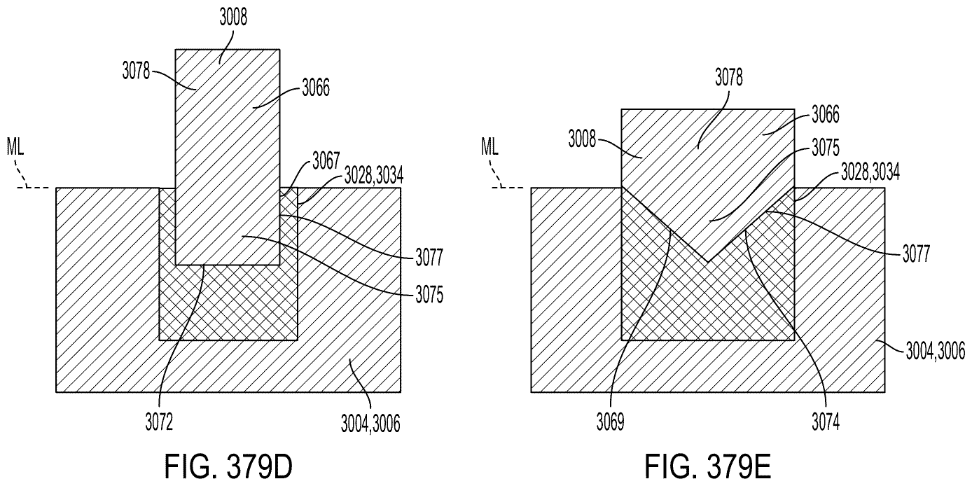

FIG. 379A shows the first housing portion 3004 and the second housing portion 3006 of the adaptor 3000 before a soft durometer material innermold/gasket 3020/3022 is received by one of the first housing portion 3004 and the second housing portion 3006 of the adaptor 3000. FIG. 379A shows the door 3008 and one of the first housing portion 3004 and the second housing portion 3006 of the adaptor 3000 before a soft durometer material innermold/gasket 3020/3022 is received by one of the first housing portion 3004 and the second housing portion 3006 of the adaptor 3000. That is, FIG. 379A shows two of the first, the second, and the third portions 3004, 3006, 3008 of the housing 3002 of the adaptor 3000 before receiving a material having the second durometer by at least one of the first housing portion 3004 and the second housing portion 3006 of the adaptor 3000. The first, the second, and the third portions 3004, 3006, 3008 of the housing 3002 of the adaptor 3000 may be made of a material having the first durometer.

FIGS. 379A-379E show schematic cross-sectional views of several embodiments of an innermold seal insert/gasket made from the material having the second durometer engaging with portions made of the material having the first durometer to provide a sealed interface between the first portion 3004 and the second portion 3006 of the housing 3002 of the adaptor 3000 or an innermold seal insert/gasket made from the material having the second durometer engaging with portions made of the material having the first durometer to provide a sealed interface between the third portion/door 3008 and at least one of the first portion 3004 and the second portion 3006 of the housing 3002 of the adaptor 3000.

The rib 3066 on the door 3008 or the rib 3078 on the second portion 3006 may include a gasket engaging portion 3075 having a cross-sectional configuration that is selected from the group consisting of a rectangular cross-sectional configuration, a square cross-sectional configuration, and a V-shaped cross-sectional configuration. The first gasket 3020 may include a geometry that is selected from the group consisting of a rectangular cross-sectional geometry, a square cross-sectional geometry, a V-shaped cross-sectional geometry, and a U-shaped cross-sectional geometry. The first gasket 3020 may include a first rib engaging surface 3077. The first gasket 3020 may include a first rounded rib engaging portion 3079.

The second gasket 3022 may include a geometry that is selected from the group consisting of a rectangular geometry, a square geometry, a rounded geometry, a V-shaped cross-sectional geometry, and a U-shaped cross-sectional geometry. The second gasket 3022 may include a second rib engaging surface 3067. The second gasket 3022 may include a second rounded rib engaging portion 3069 thereon.

In the embodiment of FIG. 379B, the gaskets 3020, 3022 in the housing portions 3004, 3006 may have a square or rectangular cross-sectional geometry. The rib/interlocking element/wall 3066 of the door 3008 or the rib 3078 of the housing portion may have a square or rectangular cross-sectional geometry.

In the embodiment of FIG. 379C, the gaskets 3020, 3022 in the housing portions 3004, 3006 may have a rounded protrusion 3070 that extends out of the pocket 3028, 3034. The rib/interlocking element/wall 3066 of the door 3008 or the rib 3078 of the housing portion may have a square or rectangular geometry.

In the embodiment of FIG. 379D, the gaskets 3020, 3022 in the housing portions 3004, 3006 may have a U-shaped geometry with a recess 3072 for receiving the rib 3066 of the door 3008 or the rib 3078 of the housing portion. The rib 3066 of the door 3008 or the rib 3078 of the housing portion may have a square or rectangular geometry.

In the embodiment of FIG. 379E, the gaskets 3020, 3022 in the housing portions 3004, 3006 may have a V-shaped geometry with a V-shaped recess 3074 for receiving the rib 3066 of the door 3008 or the rib 3078 of the housing portion. The rib 3066 of the door 3008 or the rib 3078 of the housing portion may have a V-shaped geometry.

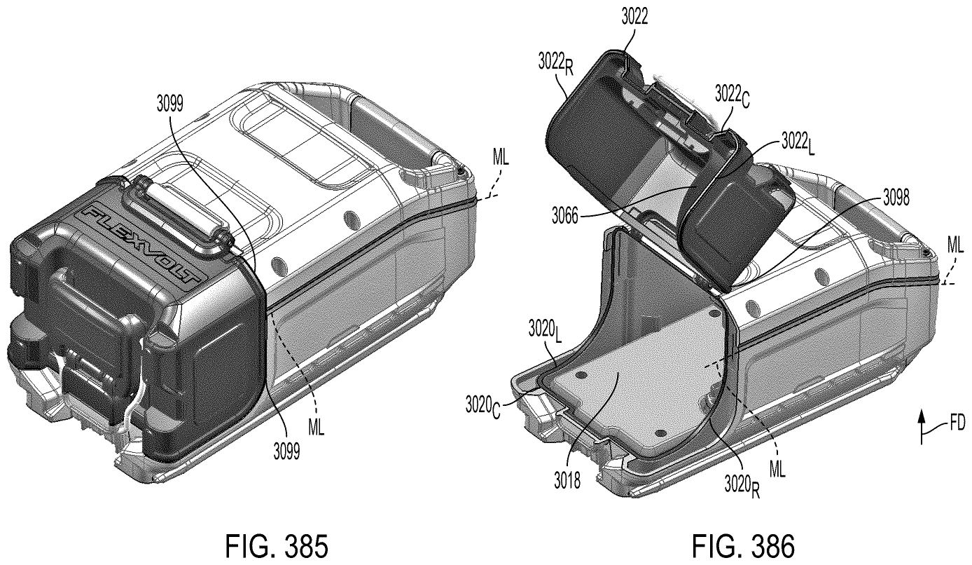

In the above discussions, the gasket positioned/disposed in one or both of the housing portions 3004, 3006 is being engaged with the rib disposed/formed on the door 3008 so as to form a sealed interface 3099 (as shown in FIG. 385) between the door 3008 and the housing portions 3004, 3006 when the door 3008 is in its closed position. Also, the gasket disposed in one of the housing portions may engage with the rib disposed/formed in the other of the housing portions so as to form a sealed interface between the housing portions 3004, 3006.

In yet another embodiment, the first housing portion 3004 may include the seal 3020 and also include seal portions extending along the sides 3080, 3082, and 3084. The seal portions along these sides of the first housing portion 3004 may be configured to engage with a rib formed on the housing portion 3006 so as to form a sealed interface between the housing portions 3004, 3006. In such an embodiment, the second housing portion 3006 may still include seal portions 3022_{L}, 3022_{C} and 3022_{R} that are configured to engage with the rib 3066 disposed on the door 3008 so as to form a sealed interface between the door 3008 and the housing portion 3006 when the door 3008 is in its closed position. As shown in FIGS. 385-386, the rib 3066 may be disposed on an inner cavity of the door 3008 and may be offset and parallel to the side walls of the door 3008.

As shown in FIGS. 380-381 and 385-386, the rib 3078 of the first portion 3004 may extend towards the second portion 3006 in a first direction FD and terminating in a terminal end TE at or generally about the mating line ML. The terminal end TE may include a different geometries. For example, as shown in and described with respect to FIGS. 379A-379E, the terminal end TE may include a square geometry, a rectangular geometry, V-shaped geometry or any other cross-sectional geometry as would be appreciated by a person of ordinary skill in the art.

The first housing portion 3004 may include the rib 3078 that is configured to fit within the boundary of the pocket space 3034. Received in at least a portion of the pocket space 3034 is the seal or gasket 3086 that is composed of a soft or low durometer material, such as rubber, a rubber-like materials, or a thermoplastic elastomer (TPE) material, to create a sealing face/interface between the first housing portion 3004 and the second housing portion 3006. The seal 3086 may be injection molded in between walls 3030, 3032 of the higher durometer material of the housing portion 3006 to hold the seal 3086 in place. When the first housing portion 3004 is coupled to the second housing portion 3006, the rib 3078 at least partially compresses the sealing face of the gasket 3086 to form a seal between the first and second housing portions 3004, 3006.

Referring to FIGS. 395A-400B, the adaptor 3000 may include a wire assembly having a wire harness WH. The wire assembly may also include the adaptor battery pack terminal block 3053 for the battery pack 3100 received/disposed in (the internal cavity 3010 of) the housing 3002 of the adaptor 3000. The terminals of the terminal block 3053 may include two power terminals 3052_{P1}-3052_{P2} (e.g., one power terminal for positive power terminal B+ of the battery pack 3100 and one power terminal for negative power terminal B− of the battery pack 3100) and the plurality of signal terminals 3052_{S} (e.g., three are shown in the illustrated embodiment wherein one signal terminal may be for a thermistor, one signal terminal may be for battery pack ID, and one signal terminal may be to monitor the voltage of some or all of the battery cells). The terminal block 3053 may be received inside the housing 3002 of the adaptor 3000 and may be configured to mate with the terminals of the battery pack 3100 received in the housing 3002. The battery pack 3100 received in the housing 3002, may be configured to be not directly attachable/connectable to the power tool either physically or electrically.

The wire assembly may also include the adaptor tool terminal block 3065 having the plurality of tool engaging terminals 3064 that are configured to engage with the terminals of the power tool. The adaptor tool terminal block 3065 may disposed within the housing 3002 of the adaptor 3000 so that its (power tool) terminals 3064 may pass through the housing 3002 of the adaptor 3000 and may be exposed, through a set of slots in the housing 3002, to outside the housing 3002 of the adaptor 3000 to enable the power tool terminals 3064 to engage the plurality of tool engaging terminals.

The wire harness WH may also include power wires 3091₁ and 3091₂ that may be configured to extend from the two power terminals 3052_{P1}-3052_{P2} and signal wires 3093 (e.g., 3093₁, 3093₂, 3093₃) that may extend from the three signal terminals 3052_{S}, The two power wires 3091₁ and 3091₂ and the three signal wires 3093₁, 3093₂, 3093₃ may all be in an L-shaped configuration having a long leg 3095 and a short leg 3097. The terminal block 3053 may be coupled to short leg 3097 of the L-shaped configuration of the wires. In one embodiment, the long leg 3095 of the L-shaped configuration of the wires may be positioned/disposed along a first plane and the short leg 3097 of the L-shaped configuration of the wires may be positioned/disposed along a second plane. The first plane and the second plane may be substantially perpendicular to each other. The wires in the second plane may also have an L-shaped configuration as shown in the illustrated embodiment. For example, the wires in the second plane may include a transition portion 3089 and the short leg 3097. The transition portion 3089 and the short leg 3097 may be positioned/disposed in the second plane and may be substantially perpendicular to each other.

Along the long leg 3095 of the L-shaped configuration of the wires, the power wires 3091₁ and 3091₂ may terminate in the pair of power terminals 3064_{P1} and 3064_{P2} that are coupled to the adaptor housing 3002 and that are configured to mate with power terminals in the power tool. Along the long leg 3095 of the L-shaped configuration of the wires, the signal wires 3093₁, 3093₂, 3093₃ may terminate in the plurality of signal terminals that are configured to mate with signal terminals in the power tool.

The present patent application provides a method of assembling a wiring assembly of an adaptor 3000. The adaptor includes the adaptor tool terminal block 3065 having the plurality of tool engaging terminals 3064 that are configured to engage with terminals of the power tool, the adaptor battery pack terminal block 3053 having the plurality of battery pack engaging terminals 3052 that are configured to engage with terminals of the battery pack. The wiring assembly may also include a printed circuit board PCB, a potting boat 3085, a potting material 3081, a terminal holder 3083, and the wire harness WH having the plurality of power wires 3091₁ and 3091₂ and the plurality of signal wires 3093₁, 3093₂, 3093₃. Each power wire 3091₁ and 3091₂ includes a first terminal end and a second terminal end. Each signal wire 3093₁, 3093₂, 3093₃ includes a first terminal end and a second terminal end. The plurality of battery pack engaging terminals 3052 of the adaptor battery pack terminal block 3053 includes power terminals and signal terminals. The plurality of tool engaging terminals 3064 of the adaptor tool terminal block 3065 includes power terminals and signal terminals.

The method comprises the steps of: (a) connecting the first terminal ends of the power wires 3091₁ and 3091₂ to the power terminals 3064_{P1} and 3064_{P2} of the adaptor tool terminal block 3065, (b) connecting the second terminal ends of the power wires 3091₁ and 3091₂ to the power terminals 3052_{P1} and 3052_{P2} of the adaptor battery pack terminal block 3053, (c) connecting the first terminal ends of the signal wires 3093₁, 3093₂, 3093₃ to the printed circuit board PCB, (d) connecting the second terminal ends of the signal wires 3093₁, 3093₂, 3093₃ to the signal terminals 3052_{S} of the adaptor battery pack terminal block 3053, (e) connecting the signal terminals 3064_{S} of the plurality of tool engaging terminals 3064 to the printed circuit board PCB, (f) disposing the wire harness WH, the adaptor tool terminal block 3065, and the adaptor battery pack terminal block 3053 in the potting boat 3085, (g) positioning the terminal holder 3083 over the power terminals 3064_{P1} and 3064_{P2} and the signal terminals 3064_{S} of the adaptor tool terminal block 3065, and (h) encapsulating the printed circuit board PCB, either partially or entirely, by the potting material 3081.

FIGS. 395A-400B illustrate assembly of the wire assembly of the adaptor 3000. At procedure/step 1, as shown in FIGS. 395A-395B, the wires (e.g., power wires 3091₁ and 3091₂) of the wire harness WH may be configured to be coupled to the power terminals 3052_{P1}-3052_{P2} of the terminal block 3053 at one terminal end and to the power terminals 3064_{P1} and 3064_{P2} that mate with the power tool at the other terminal end. The signal wires 3093₁, 3093₂, 3093₃ of the wire harness WH may be configured to be coupled to the terminal block 3053 at one terminal end and may be configured to be coupled to the PCB at the other terminal end.

At procedure/step 2, as shown in FIGS. 396A-396B, the signal wires 3093₁, 3093₂, 3093₃ of the wire harness WH may be configured to be coupled to the PCB at the other end. That is, the terminal ends of the signal wires 3093₁, 30932, 3093₃ may be soldered to the PCB. At procedure 2, the adaptor tool signal terminals 3064_{S} may also be soldered to the PCB.

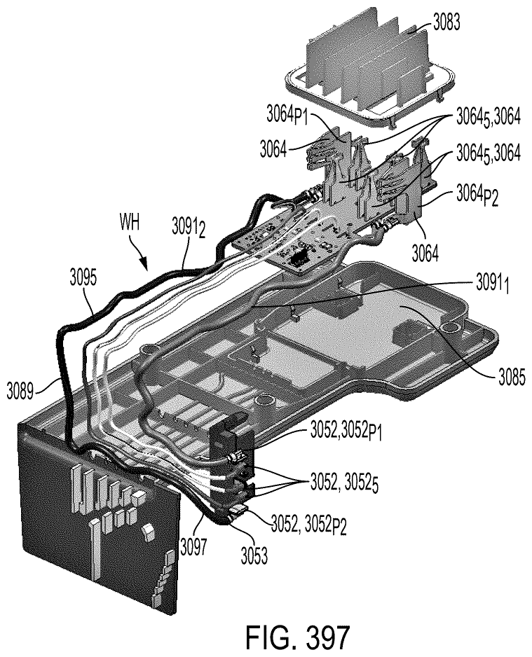

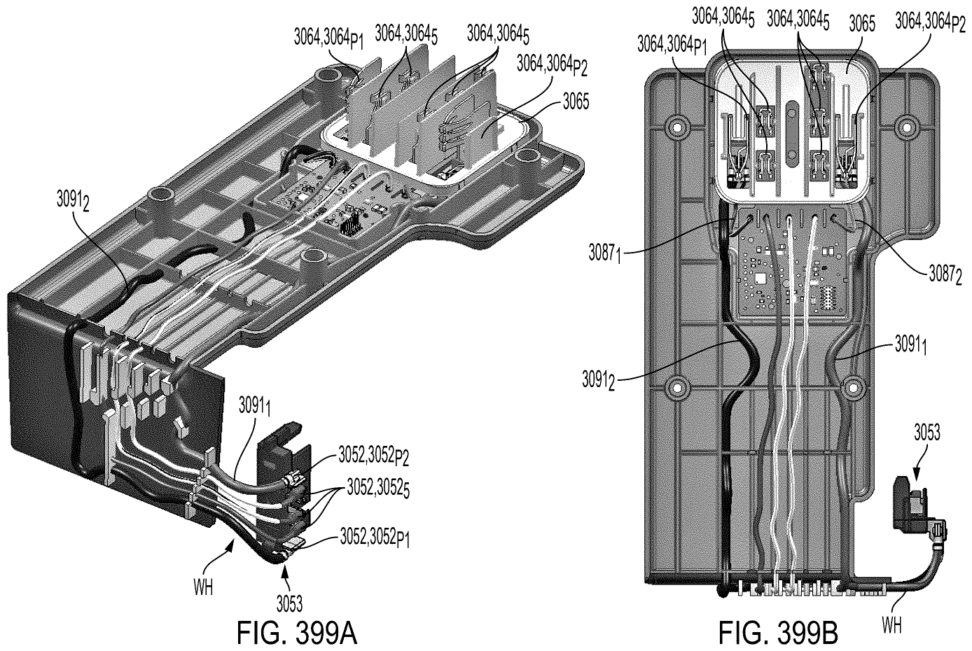

At procedure/step 3, as shown in FIG. 397 and 399A-399B, the PCB, the power wires 3091₁, 3091₂, the signal wires 3093₁, 3093₂, 3093₃, the adaptor tool signal terminals 3064_{S} on the PCB, the adaptor tool power terminals 3064_{P1} and 3064_{P2}, the adaptor battery pack power terminals 3052_{P1}-3052_{P2}, and the adaptor battery pack signal terminals 3052_{S} may all be received in the potting boat 3085.

At procedure/step 4, as shown in FIGS. 397 and 399A-399B, a terminal holder (or PCB holder) 3083 may be positioned and installed over the adaptor tool signal terminals 3064_{S} and the adaptor tool power terminals 3064_{P1} and 3064_{P2}.

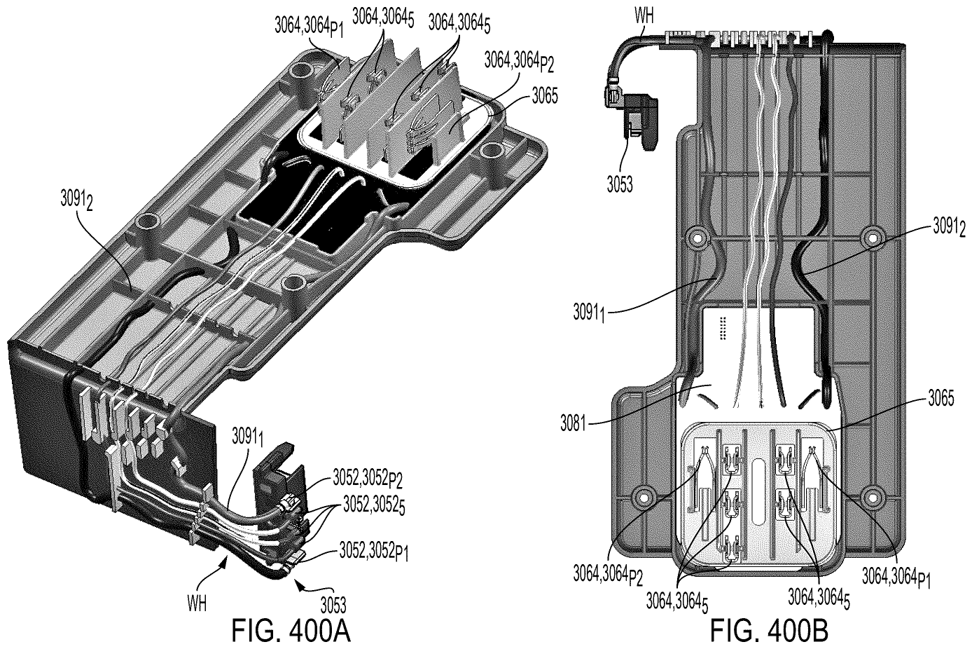

At procedure/step 5, as shown in FIGS. 400A-400B, potting material or compound 3081 may be added to the potting boat 3085 to replace a plastic terminal block housing so that no plastic material is used. The potting material/compound 3081 may be a thermal potting material/compound. This may make assembly more flexible and easier and may improve heat dissipation due to thermal properties of the potting compound.

The present patent application and its various embodiments as described above uniquely address the observed, noted and researched findings and improve on the prior and current state of the art systems. The listed products, features and embodiments as described in the present patent application should not be considered as limiting in any way.

Although the present patent application has been described in detail for the purpose of illustration, it is to be understood that such detail is solely for that purpose and that the present patent application is not limited to the disclosed embodiments, but, on the contrary, is intended to cover modifications and equivalent arrangements that are within the spirit and scope of the appended claims. In addition, it is to be understood that the present patent application contemplates that, to the extent possible, one or more features of any embodiment can be combined with one or more features of any other embodiment.

The illustration of the embodiments of the present patent application should not be taken as restrictive in any way since a myriad of configurations and methods utilizing the present patent application can be realized from what has been disclosed or revealed in the present patent application. The systems, features and embodiments described in the present patent application should not be considered as limiting in any way. The illustrations are representative of possible construction and mechanical embodiments and methods to obtain the desired features. The location and/or the form of any minor design detail or the material specified in the present patent application can be changed and doing so will not be considered new material since the present patent application covers those executions in the broadest form.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by a person of ordinary skill in the art in the context of the various elements, components, regions, layers and/or sections being described.

The foregoing illustrated embodiments have been provided to illustrate the structural and functional principles of the present patent application and are not intended to be limiting. To the contrary, the present patent application is intended to encompass all modifications, alterations and substitutions within the spirit and scope of the appended claims.

What is claimed is:

1. A cordless power tool system comprising:
a first power tool having a first power tool rated voltage and a first power tool interface;
a second power tool having a second power tool rated voltage and a second power tool interface that is different from the first power tool interface;
a third power tool having a third power tool rated voltage and a third power tool interface that is different from the first power tool interface and from the second power tool interface;
a first battery pack having a first battery pack nominal voltage that is substantially the same as the first power tool rated voltage and the second power tool rated voltage and a first battery pack interface that is connectable to the first power tool interface to provide power to the first power tool, but that is not connectable to the second power tool interface or the third power tool interface;
a second battery pack having a second battery pack interface that is connectable to the second power tool interface of the second power tool and to the third power tool interface of the third power tool but that is not connectable to the first power tool interface, wherein the second battery pack has a second battery pack nominal voltage that is substantially the same as the second power tool rated voltage when connected to the second power tool, and has a third battery pack nominal voltage that is substantially the same as the third power tool rated voltage when connected to the third power tool,
wherein the second battery pack is configured to be coupled to the first power tool to provide power to the first power tool.

2. The cordless power tool system of claim 1, further comprising an adaptor having a first adaptor interface configured to be connected to the first power tool interface of the first power tool and a second adaptor interface configured to be connected to the second battery pack interface of the second battery pack to couple the second battery pack to the first power tool.

3. The cordless power tool system of claim 2, wherein the second battery pack interface of the second battery pack is not able to be connected to the first power tool interface of the first power tool without the adaptor.

4. The cordless power tool system of claim 2, wherein the first power tool rated voltage and the second power tool rated voltage are the same.

5. The cordless power tool system of claim 2, wherein the first battery pack nominal voltage and the second battery pack nominal voltage are the same.

6. The cordless power tool system of claim 1, further comprising a third battery pack having the third battery pack nominal voltage and having a third battery pack interface that is connectable to the third power tool interface of the third power tool but is not connectable to the first power tool interface of the first power tool or the second power tool interface of the second power tool.

7. The cordless power tool system of claim 1, wherein the first power tool comprises at least one of a concrete drill, a concrete saw, a concrete vibrator, a plate compactor, a rammer, or a screed.

8. The cordless power tool system of claim 7, wherein the second power tool comprises at least one of a circular saw, a drill, a grinder, a miter saw, a reciprocating saw, a rotary hammer, or a table saw.

9. The cordless power tool system of claim 8, wherein the third power tool comprises at least one of a band saws, a chop saw, a circular saw, a cutout tool, a compressor, a drill, a hammer drill, a fan, a grinder, a hammer, a dust extractor, an impact driver, an impact wrench, an inflator, a jigsaw, a joiner, a light, a magnetic drill press, a nailer, an oscillating tool, a planer, a polisher, a ratchet, a reciprocating saw, a rotary hammer, a router, a sander, a screwdriver, a screwgun, a vacuum, a blower, a chain saw, an edger, a hedge trimmer, a pressure washer, a mower, a snow thrower, a string trimmer, a tiller, or an auger.
